(19) United States
(12) Patent Application Publication
(10) Pub. No.: US 2004/0063738 A1
(43) Pub. Date: Apr. 1, 2004

(54) Substituted heterocyclic phthalic acid diamide arthropodicides

(76) Inventors: George Philip Lahm, Wilmington, DE (US); Thomas Paul Selby, Wilmington, DE (US)

Correspondence Address: E I du Pont de Nemours & Company, Legal Patents, Wilmington, DE, 19898, US

(21) Appl. No.: 10/415,566

(22) PCT Filed: Dec. 5, 2001
(86) PCT No.: PCT/US01/47572

(51) Int. Cl. A01N 43/54; A01N 43/40; A01N 43/56; A01N 43/36

(52) U.S. Cl. 514/275; 514/351; 514/406; 514/426; 544/330; 546/304; 548/367.4; 548/557

(57) ABSTRACT

Compounds of (I), and their N-oxides and agriculturally suitable salts, are disclosed which are useful for controlling invertebrate pests (Formula) wherein J is selected from the group consisting of J-1, J-2, J-3, J-4, J-5, J-6, J-7 and J-8 (I) and R1, R2, R3, R4, R5, R7, R9 and n are as defined in the disclosure. Also disclosed are compositions for controlling an invertebrate pest comprising a biologically effective amount of a compound of (I) and methods for controlling an invertebrate pest comprising contacting the invertebrate pest or its environment with a biologically effective amount of a compound of (I) (e.g., as a composition described herein).

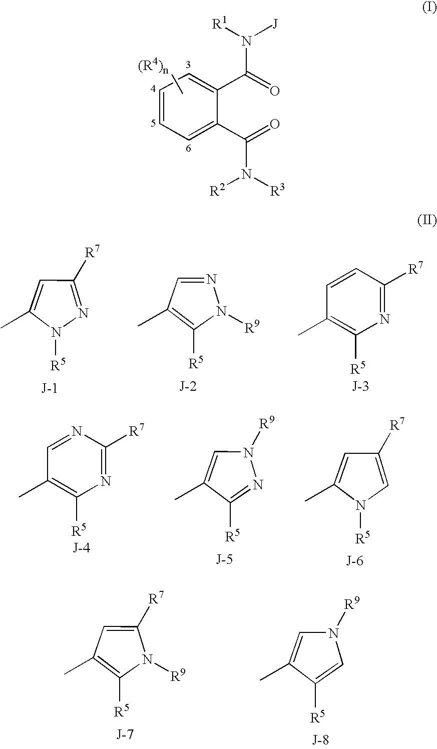

### BACKGROUND OF THE INVENTION

This invention relates to certain heterocyclic phthalic acid diamides, their N-oxides, agriculturally suitable salts and compositions, and methods of their use as arthropodicides in both agronomic and nonagronomic environments.

The control of invetebrate pests is extremely important in achieving high crop efficiency. Damage by invertebrate pests to growing and stored agronomic crops can cause significant reduction in productivity and thereby result in increased costs to the consumer. The control of invertebrate pests in forestry, greenhouse crops, ornamentals, nursery crops, stored food and fiber products, livestock, household, and public and animal health is also important. Many products are commercially available for these purposes, but the need continues for new compounds that are more effective, less costly, less toxic, environmentally safer or have different modes of action.

EP919542 discloses phthalic acid diamides of Formula i as insecticides

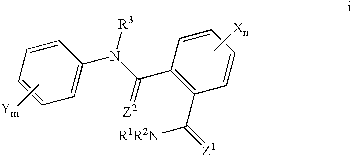

wherein, inter alia,

Z¹ and Z² are O or S; and

R¹, R² and R³ are, among others, H, alkyl or substituted alkyl

WO01/02354 discloses phthalic acid diamides of Formula ii as insecticides

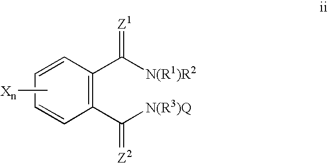

wherein, inter alia,

Q is an optionally substituted heterocycle containing O, S or N;

Z¹ and Z² are O or S; and

R¹, R² and R³ are, among others, H, alkyl or substituted alkyl.

### SUMMARY OF THE INVENTION

This invention pertains to compounds of Formula I and N-oxides and agriculturally suitable salts thereof

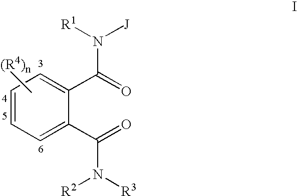

wherein

J is selected from the group consisting of J-1, J-2, J-3, J-4, J-5, J-6, J-7 and J-8

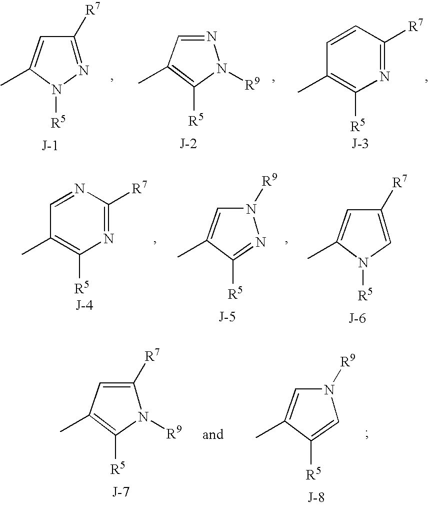

R¹ is H, C₁-C₆ alkyl, C₂-C₆ alkoxycarbonyl or C₂-C₆ alkylcarbonyl;

R² is H or C₁-C₆ alkyl;

R³ is H; C₁-C₆ alkyl, C₂-C₆ alkenyl, C₂-C₆ alkynyl, C₃-C₆ cycloalkyl, or C₄-C₈ cycloalkylalkyl, each optionally substituted with one or more substituents selected from the group consisting of halogen, CN, NO₂, hydroxy, C₁-C₄ alkyl, C₁-C₄ alkoxy, C₁-C₄ haloalkoxy, C₁-C₄ alkylthio, C₁-C₄ alkylsulfinyl, C₁-C₄ alkylsulfonyl, C₂-C₆ alkoxycarbonyl or C₂-C₆ alkylcarbonyl;

one R⁴ group is attached to the phenyl ring at the 3-position or 6-position, and said R⁴ is C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, or C₁-C₄ haloalkylsulfonyl; and

an optional second R⁴ is H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₁-C₄ alkoxyalkyl, C₁-C₄ hydroxyalkyl, C(O)R¹⁰, CO₂R¹⁰, C(O)NR¹⁰R¹¹, NR¹⁰R¹¹, N(R¹¹)COR¹⁰, N(R¹¹)CO₂R¹⁰ or C₃-C₆ trialkylsilyl;

R⁵ is H, C₁-C₄ alkyl, C₁-C₄ haloalkyl, or

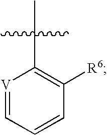

V is N, CH, CF, CCl, CBr or CI;

each R⁶ and R⁷ is independently H, C₁-C₆ alkyl, C₃-C₆ cycloalkyl, C₁-C₆ haloalkyl, halogen, CN, C₁-C₄ alkoxy, C₁-C₄ haloalkoxy or C₁-C₄ haloalkylthio;

R⁹ is H, C₁-C₆ alkyl, C₁-C₆ haloalkyl, C₃-C₆ alkenyl, C₃-C₆ haloalkenyl, C₃-C₆ alkynyl or C₃-C₆ haloalkynyl; provided R⁷ and R⁹ are not both H;

R¹⁰ is H or C₁-C₄ alkyl or C₁-C₄ haloalkyl;

R¹¹ is H or C₁-C₄ alkyl; and

n is 1 or 2.

This invention also pertains to a composition for controlling an invertebrate pest comprising a biologically effective amount of a compound of Formula I and at least one additional component selected from the group consisting of surfactants, solid diluents and liquid diluents. This invention also pertains to a composition comprising a biologically effective amount of a compound of Formula I and an effective amount of at least one additional biologically active compound or agent.

This invention also pertains to a method for controlling an invertebrate pest comprising contacting the invertebrate pest or its environment with a biologically effective amount of a compound of Formula I (e.g., as a composition described herein). This invention also relates to such method wherein the invertebrate pest or its environment is contacted with a biologically effective amount of a compound of Formula I or a composition comprising a compound of Formula I and a biologically effective amount of at least one additional compound or agent for controlling invertebrate pests.

### DETAILS OF THE INVENTION

In the above recitations, the term “alkyl”, used either alone or in compound words such as “alkylthio” or “haloalkyl” includes straight-chain or branched alkyl, such as methyl, ethyl, n-propyl, i-propyl, or the different butyl, pentyl or hexyl isomers. “Alkenyl” can include straight-chain or branched alkenes such as 1-propenyl, 2-propenyl, and the different butenyl, pentenyl and hexenyl isomers. “Alkenyl” also includes polyenes such as 1,2-propadienyl and 2,4-hexadienyl. “Alkynyl” includes straight-chain or branched alkynes such as 1-propynyl, 2-propynyl and the different butynyl, pentynyl and hexynyl isomers. “Alkynyl” can also include moieties comprised of multiple triple bonds such as 2,5-hexadiynyl. “Alkoxy” includes, for example, methoxy, ethoxy, n-propyloxy, isopropyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkylthio” includes branched or straight-chain alkylthio moieties such as methylthio, ethylthio, and the different propylthio, butylthio, pentylthio and hexylthio isomers. “Cycloalkyl” includes, for example, cyclopropyl, cyclobutyl, cyclopentyl and cyclohexyl. “Cycloalkylalkyl” indicates an alkyl group substituted with a cycloalky group and includes, for example, cyclopropylmethyl, cyclobutylethyl, cyclopentylpropyl and cyclohexylmethyl.

The term “heteroaromatic ring” denotes fully aromatic rings in which at least one ring atom is not carbon and can contain 1 to 4 heteroatoms independently selected from the group consisting of nitrogen, oxygen and sulfur, provided that each heteroaromatic ring contains no more than 4 nitrogens, no more than 2 oxygens and no more than 2 sulfurs (where aromatic indicates that the Hückel rule is satisfied). The heteroaromatic ring can be attached through any available carbon or nitrogen by replacement of hydrogen on said carbon or nitrogen.

The term “halogen”, either alone or in compound words such as “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The terms “haloalkenyl”, “haloalkynyl”, “haloalkoxy”, and the like, are defined analogously to the term “haloalkyl”. Examples of “haloalkenyl” include (Cl)₂C═CHCH₂ and CF₃CH₂CH═CHCH₂. Examples of “haloalkynyl” include HC≡CCHCl, CF₃C≡C, CCl₃C≡C and FCH₂C≡CCH₂. Examples of “haloalkoxy” include CF₃O, CCl₃CH₂O, HCF₂CH₂CH₂O and CF₃CH₂O.

The total number of carbon atoms in a substituent group is indicated by the “Cᵢ-Cⱼ” prefix where i and j are numbers from 1 to 6. For example, C₁-C₃ alkylsulfonyl designates methylsulfonyl through propylsulfonyl; C₂ alkoxyalkyl designates CH₃OCH₂; C₃ alkoxyalkyl designates, for example, CH₃CH(OCH₃), CH₃OCH₂CH₂ or CH₃CH₂OCH₂; and C₄ alkoxyalkyl designates the various isomers of an alkyl group substituted with an alkoxy group containing a total of four carbon atoms, examples including CH₃CH₂CH₂OCH₂ and CH₃CH₂OCH₂CH₂. In the above recitations, when a compound of Formula I contains a heteroaromatic ring, all substituents are attached to this ring through any available carbon or nitrogen by replacement of a hydrogen on said carbon or nitrogen.

When a group contains a substituent which can be hydrogen, for example R³, then, when this substituent is taken as hydrogen, it is recognized that this is equivalent to said group being unsubstituted.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. Accordingly, the compounds of the invention may be present as a mixture of stereoisomers, individual stereoisomers, or as an optically active form.

The present invention comprises of compounds selected from Formula I, N-oxides and agriculturally suitable salts thereof. One skilled in the art will appreciate that not all nitrogen containing heterocycles can form N-oxides since the nitrogen requires an available lone pair for oxidation to the oxide; one skilled in the art will recognize those nitrogen containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethydioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-19, A. J. Boulton and A. McKillop, Eds., Pergamon Press; M. R. Grimmett and B. R. T. Keene in Advances in Heterocyclic Chemistry, vol. 43, pp 139-151, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

The salts of the compounds of the invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids.

Of note are compounds of Formula I wherein R⁵ is

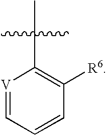

The wavy line represents the remainder of the J group to which said R⁵ moiety is attached.

Preferred compounds for reasons of better activity, cost and/or ease of synthesis are:

Preferred 1. Compounds of Formula I wherein V is N.

Preferred 2. Compounds of Formula I wherein V is CH, CF, CCl or CBr.

Preferred 3. Compounds of Preferred 1 or Preferred 2 wherein

R¹ and R² are both H;

R³ is C₁-C₄ alkyl optionally substituted with halogen, CN, OCH₃, S(O)ₚCH₃;

one R⁴ group is attached to the phenyl ring at the 3-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ allyl, C₁-C₄ haloalkyl, halogen or CN;

R⁷ is H, CH₃, CF₃, OCHF₂ or halogen; and

p is 0, 1 or 2.

Preferred 4. Compounds of Preferred 3 wherein

J is J-1;

R³ is C₁-C₄ alkyl;

one R⁴ group is attached to the phenyl ring at the 3-position and said R⁴ is CH₃, Cl, Br or I;

a second R⁴ is H, F, Cl, Br, I or CF₃;

R⁶ is Cl or Br; and

R⁷ is halogen or CF₃.

Preferred 5. Compounds of Preferred 4 wherein

V is N;

R³ is methyl, ethyl, isopropyl or tertiary butyl;

one R⁴ group is attached to the phenyl ring at the 3-position and said R⁴ is CH₃ or I;

R⁶ is Cl or Br; and

R⁷ is Br, Cl or CF₃.

Preferred 6. Compounds of Preferred 3 wherein

J is J-2;

R³ is C₁-C₄ alkyl;

one R⁴ group is attached to the phenyl ring at the 3-position and said R⁴ is CH₃, Cl, Br or I;

a second R⁴ is H, F, Cl, Br, I or CF₃;

R⁶ is Cl or Br; and

R⁹ is CF₃, CHF₂, CH₂CF₃, CF₂CHF₂.

Preferred 7. Compounds of Preferred 3 wherein

J is J-3;

R³ is C₁-C₄ alkyl;

one R⁴ group is attached to the phenyl ring at the 3-position and said R⁴ is CH₃, Cl, Br or I;

a second R⁴ is H, F, Cl, Br, I or CF₃;

R⁶ is Cl or Br; and

R⁷ is halogen or CF₃.

Preferred 8. Compounds of Preferred 3 wherein

J is J-4;

R³ is C₁-C₄ alkyl;

one R⁴ group is attached to the phenyl ring at the 3-position and said R⁴ is CH₃, Cl, Br or I;

a second R⁴ is H, F, Cl, Br, I or CF₃;

R⁶ is Cl or Br; and

R⁷ is CF₃.

Preferred 9. Compounds of Preferred 3 wherein

J is J-5;

R³ is C₁-C₄ alkyl;

one R⁴ group is attached to the phenyl ring at the 3-position and said R⁴ is CH₃, Cl, Br or I;

a second R⁴ is H, F, Cl, Br, I or CF₃;

R⁶ is Cl or Br; and

R⁹ is CF₃, CHF₂, CH₂CF₃, CF₂CHF₂.

Preferred 10. Compounds of Preferred 3 wherein

J is J-6;

R³ is C₁-C₄ alkyl;

one R⁴ group is attached to the phenyl ring at the 3-position and said R⁴ is CH₃, Cl, Br or I;

a second R⁴ is H, F, Cl, Br, I or CF₃;

R⁶ is Cl or Br; and

R⁷ is halogen or CF₃.

Preferred 11. Compounds of Preferred 3 wherein

J is J-7;

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br;

R⁷ is H, halogen or CF₃ and

R⁹ is H, CF₃, CHF₂, CH₂CF₃, CF₂CHF₂.

Preferred 12. Compounds of Preferred 3 wherein

J is J-8;

R³ is C₁-C₄ alkyl;

one R⁴ group is attached to the phenyl ring at the 3-position and said R⁴ is CH₃, Cl, Br or I;

a second R⁴ is H, F, Cl, Br, I or CF₃;

R⁶ is Cl or Br;

R⁷ is H, halogen or CF₃ and

R⁹ is H, CF₃, CHF₂, CH₂CF₃, CF₂CHF₂.

Specifically preferred are compounds selected from the group consisting of:

N¹-[1-(3-chloro-2-pyridinyl)-3-(trifluoromethyl)-1H-pyrazol-5-yl]-3-methyl-N²-(1-methylethyl)-1,2-benzenedicarboxamide,

N¹-[1-(3-bromo-1-(3-chloro-2-pyridinyl)-1H-pyrazol-5-yl]-3-methyl-N²-(1-methylethyl)-1,2-benzenedicarboxamide,

N¹-[1-(3-chloro-2-pyridinyl)-3-(trifluoromethyl)-1H-pyrazol-5-yl]-3-iodo-N²-(1-methylethyl)-1,2-benzenedicarboxamide, and

N¹-[1-(3-bromo-1-(3-chloro-2-pyridinyl)-1H-pyrazol-5-yl]-3-iodo-N²-(1-methylethyl)-1,2-benzenedicarboxamide.

The preferred compositions of the present invention are those that comprise the above preferred compounds.

The preferred methods of use are those involving the above preferred compounds.

Of note are compounds of Formula 1d and N-oxides and agriculturally suitable salts thereof

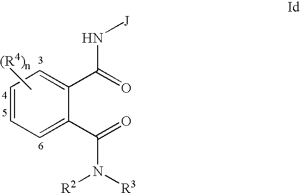

wherein

J is selected from the group consisting of

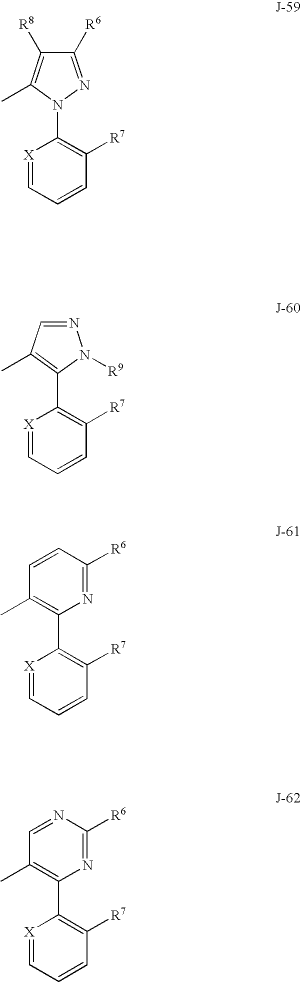

R¹ is H, C₁-C₆ alkyl, C₂-C₆ alkoxycarbonyl or C₂-C₆ alkylcarbonyl;

R² is H or C₁-C₆ alkyl;

R³ is H; C₁-C₆ alkyl, C₂-C₆ alkenyl, C₂-C₆ alkynyl, or C₃-C₆ cycloalkyl, each optionally substituted with one or more substituents selected from the group consisting of halogen, CN, NO₂, hydroxy, C₁-C₄ alkyl, C₁-C₄ alkoxy, C₁-C₄ haloalkoxy, C₁-C₄ alkylthio, C₁-C₄ alkylsulfinyl, C₁-C₄ alkylsulfonyl, C₂-C₆ alkoxycarbonyl, C₂-C₆ alkylcarbonyl, C₃-C₆ trialkylsilyl, or a phenyl, phenoxy or 5- or 6-membered heteroaromatic ring, each ring optionally substituted with one to three substituents independently selected from the group consisting of C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₄-C₈ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl; C₁-C₄ alkoxy; C₁-C₄ alkylamino; C₂-C₈ dialkylamino; C₃-C₆ cycloalkylamino; C₂-C₆ alkoxycarbonyl or C₂-C₆ alkylcarbonyl;

each R⁴ is independently H, C₁-C₆ alkyl, C₂-C₆ alkenyl, C₂-C₆ alkynyl, C₃-C₆ cycloalkyl, C₁-C₆ haloalkyl, C₁-C₄ alkoxyalkyl, CN, halogen, C₁-C₄ alkoxy, C₁-C₄ haloalkoxy, S(O)ₙR¹², C₁-C₄ hydroxyalkyl, C(O)R¹⁰, CHO, CO₂R¹⁰, C(O)NR¹⁰R¹¹, NO₂, NR¹⁰R¹¹ or N(R¹¹)CO₂R¹⁰;

each R⁶ is independently C₁-C₆ alkyl, C₁-C₆ haloalkyl, halogen, CN, C₁-C₄ alkoxy, C₁-C₄ haloalkoxy or C₁-C₄ haloalkylthio;

R⁷ is C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl;

R⁸ is H, C₁-C₆ alkyl, C₁-C₆ haloalkyl, halogen, C₁-C₄ alkoxy or C₁-C₄ haloalkoxy;

R⁹ is C₂-C₆ alkyl, C₁-C₆ haloalkyl, C₃-C₆ alkenyl, C₃-C₆ haloalkenyl, C₃-C₆ alkynyl or C₃-C₆ haloalkynyl;

R¹⁰ is H or C₁-C₄ alkyl or C₁-C₄ haloalkyl;

R¹¹ is H or C₁-C₄ alkyl;

R¹² is C₁-C₄ alkyl or C₁-C₄ haloalkyl;

n is 0, 1 or 2; and

X is N, CH, CF, CCl or CBr.

Of particular note are selected compounds of Formula1d:

Selection A. Compounds of Formula1d wherein X is N.

Selection B. Compounds of Formula1d wherein X is CH, CF, CCl or CBr.

Selection C. The compounds of Selection A or Selection B wherein

J is J-59;

R¹, R² and R⁸ are all H;

R³ is C₁-C₄ alkyl optionally substituted with halogen, CN, OCH₃, S(O)ₚCH₃;

one R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is CH₃, CF₃ or halogen; and

p is 0, 1 or 2.

Selection D. Compounds of Selection C wherein

R³ is C₁-C₄ alkyl;

one R⁴ is CH₃, Cl or Br;

a second R⁴ is H, F, Cl, Br, I or CF₃;

R⁶ is CF₃; and

R⁷ is Cl or Br.

Selection E. The compounds of Selection A or Selection B wherein

J is J-60;

R¹ and R² are both H;

R³ is C₁-C₄ alkyl optionally substituted with halogen, CN, OCH₃, S(O)ₚCH₃;

one R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁹ is C₂-C₆ alkyl or C₁-C₆ haloalkyl; and

p is 0, 1 or 2.

Selection F. Compounds of Selection E wherein

R³ is C₁-C₄ alkyl;

one R⁴ is CH₃, Cl or Br;

a second R⁴ is H, F, Cl, Br, I or CF₃;

R⁹ is CF₃, CHF₂, CH₂CF₃, CF₂CHF₂; and

R⁷ is Cl or Br.

Selection G. The compounds of Selection A or Selection B wherein

J is J-61;

R¹, R² and R⁸ are all H;

R³ is C₁-C₄ alkyl optionally substituted with halogen, CN, OCH₃, S(O)ₚCH₃;

one R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is CH₃, CF₃ or halogen; and

p is 0, 1 or 2.

Selection H. Compounds of Selection G wherein

R³ is C₁-C₄ alkyl;

one R⁴ is CH₃, Cl or Br;

a second R⁴ is H, F, Cl, Br, I or CF₃;

R⁶ is CF₃; and

R⁷ is Cl or Br.

Selection I. The compounds of Selection A or Selection B wherein

J is J-62;

R¹, R² and R⁸ are all H;

R³ is C₁-C₄ alkyl optionally substituted with halogen, CN, OCH₃, S(O)ₚCH₃;

one R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is CH₃, CF₃ or halogen; and

p is 0, 1 or 2.

Selection J. Compounds of Selection I wherein

R³ is C₁-C₄ alkyl;

one R⁴ is CH₃, Cl or Br;

a second R⁴ is H, F, Cl, Br, I or CF₃;

R⁶ is CF₃; and

R⁷ is Cl or Br.

Also of note are compositions comprising a biologically effective amount of a compound of Formula 1d and at least one additional component selected from the group consisting of surfactants, solid diluents and liquid diluents. Also of note are said compositions further comprising at least one additional biologically active compound or agent. Selected compositions are those comprising the selected compounds above.

Also of note is a method for controlling lepidopteran, homopteran and coleopteran insects comprising contacting the insects or their environment with a biologically effective amount of a compound of Formula 1d, its N-oxide or an agriculturally suitable salt thereof. Selected methods are those comprising the selected compounds above.

The compounds of Formula I can be prepared by one or more of the following methods and variations described in Schemes 1 and 2. The definitions of J, R¹, R², R³, R⁴ and n in the compounds of Formulae 1-9 are as defined above in the Summary of the Invention.

Phthalic acid diamides of formula Ib and Ic can be made by the method described in Scheme 1. Heating a phthalic anhydride of formula 2 with an aminoheterocycle of Formula H₂N-J in an inert solvent such as glacial acetic acid affords a phthalimide of Formula 3. Ring-opening of phthalimide 3 with an amine of the Formula HNR²R³ in an inert solvent such as dioxane or tetrahydrofuran at room temperture or heating at reflux gives a phthalic acid diamide of formula 1b. Alkylation of a compound of formula Ib with a suitable alkylating agent (e.g. an alkyl halide or an alkyl methane- or 4-toluene-sulfonate) or acylating agent (e.g. an alkylchloroformate or acid chloride) in the presence of a base such as sodium hydride or n-butyl lithium in an inert solvent such as tetrahydrofuran or N,N-dimethylformamide affords a phthalic acid diamide of formula Ic wherein R¹ is a substituent other than hydrogen. Phthalic anhydrides of Formula 2 can be made by methods taught in J. Org. Chem., 1987, 52, 129, J. Am. Chem. Soc., 1929, 51, 1865, and J. Am. Chem. Soc., 1941, 63, 1542. Aminoheterocycles of formula H₂N-J can be made by methods as described in Rodd's Chemistry of Organic Compounds: Heterocyclic Compounds, volume IV, parts C, F and IJ (1989), Comprehensive Heterocyclic Chemistry, volumes 2, 3, 4, 5 and 6 (1984) and Comprehensive Heterocyclic Chemistry II, volumes 3, 4, 5 and 6 (1996).

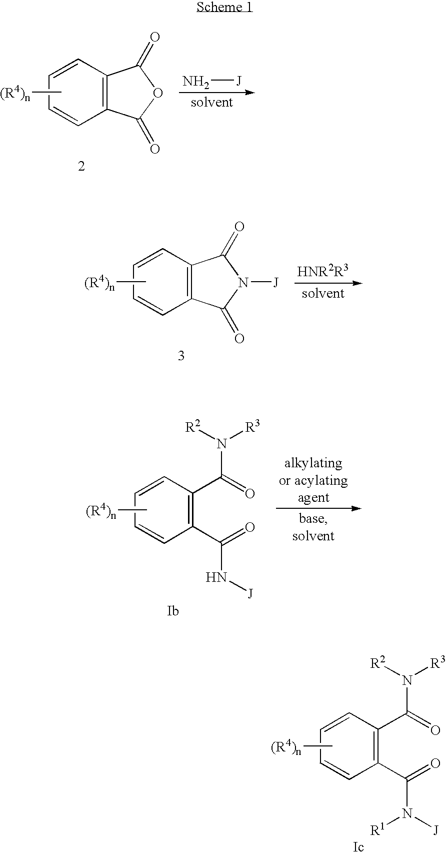

Another method for making compounds of Formula I is summarized in Scheme 2. Lithiation of a benzamide of Formula 4 with n-butyl lithium in an inert solvent such as tetrahydrofuran followed by reaction with a carbamoyl chloride of Formula 5 provides a phthalic acid diamide of Formula I wherein R¹ is other than hydrogen. Reaction of a benzamide of Formula 4 with n-butyl lithium in an inert solvent such as tetrahydrofuran followed by reaction with an isocyanate of Formula 6 provides a phthalic acid diamide of Formula I wherein R¹ is hydrogen. Alternatively, lithiation of a benzamide of Formula 7 with n-butyl lithium in an inert solvent such as tetrahydrofuran followed by reaction with a carbamoyl chloride chloride of Formula 8 provides a phthalic acid diamide of Formula I wherein R² is other than hydrogen. Reaction of a benzamide of Formula 7 with n-butyl lithium in an inert solvent such as tetrahydrofuran followed by reaction with an isocyanate of Formula 9 provides a phthalic acid diamide of Formula 1 wherein R² is hydrogen.

Benzamides of Formulae 4 and 7 are readily made from the corresponding benzoic acids via a benzoyl chloride intermediate or by direct coupling of a benzoic acid and amine in the presence of a suitable acid/amine coupling agent such as 1,3-dicyclohexylcarbodiimide or 1,1′-carbonyldiimidazole in an inert solvent such as dichloromethane or N,N-dimethylformamide. Benzoic acids are readily converted to the acid chlorides on treatment with thionyl chloride or oxalyl chloride in an inert solvent such as dichloromethane or toluene. The benzoyl chloride is subsequently coupled with an amine of formula HNR² R³ or HN R¹J in an inert solvent such as tetrahydrofuran or dichloromethane. An additional base such as tertiary amines, pyridine or polymer-bound bases may be used to neutralize the hydrochloric acid produced in the reaction.

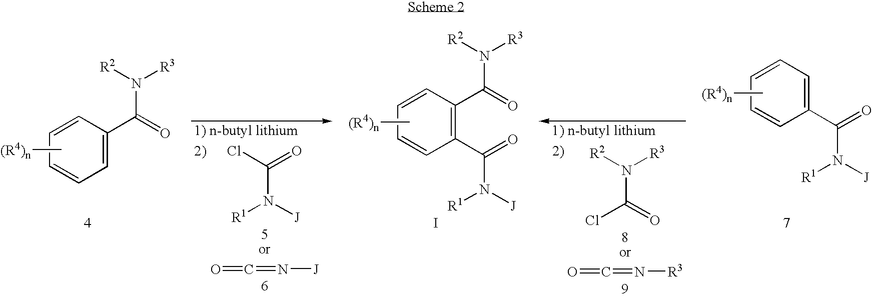

It is recognized that some reagents and reaction conditions described above for preparing compounds of Formula I may not be compatible with certain functionalities present in the intermediates. In these instances, the incorporation of protection and deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: N.Y., 1991). One skilled in the art will recognize that, in some cases, after the introduction of a given reagent as it is depicted in any individual scheme, it may be necessary to perform additional routine synthetic steps not described in detail to complete the synthesis of compounds of Formula I. One skilled in the art will also recognize that it may be necessary to perform a combination of the steps illustrated in the above schemes in an order other than that implied by the particular sequence presented to prepare the compounds of Formula I.

One skilled in the art will also recognize that compounds of Formula I and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Examples are, therefore, to be construed as merely illustrative and not limiting of the disclosure in any way whatsoever. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane; s is singlet, d is doublet, t is triplet, q is quartet, m is multiplet, dd is doublet of doublets, dt is doublet of triplets, br s is broad singlet.

### EXAMPLE 1

Step A: Preparation of 5-Nitro-2-(2,2,2-trifluoroethoxy)pyridine

To a solution of 2,2,2-trifluoroethanol (5 g, 50 mmol) stirring in 50 mL of tetrahydrofuran, sodium hydride (2 g of ca. 60% oil dispersion, ca. 50 mmol) was added portionwise with foaming and an exotherm. After formation of a solution and stirring at room temperature, 2-chloro-5-nitropyridine (5 g, 32 mmol) was added portionwise, accompanied by an exotherm. After stirring at room temperature overnight, the reaction mixture was partitioned between 100 mL of ethyl acetate and 75 mL of water. The organic layer was separated, washed with brine and dried over magnesium sulfate. Evaporation of solvent in vacuo gave an orange oil. A solid was crystallized from hexanes, filtered and dried to give 5 g of 5-nitro-2-(2,2,2-trifluoroethoxy)pyridine (used directly in the next step).

¹H NMR (CDCl₃): 9.07 (s, 1H), 8.45 (d, 1H), 7.01 (d, 1H), 4.9 (q, 2H) ppm.

Step B: Preparation of 5-Amino-2-(2,2,2-trifluoroethoxy)pyridine

To a solution of 5 g of 5-nitro-2-(2,2,2-trifluoroethoxy)pyridine in 75 mL of ethyl acetate, 0.5 g of 10% palladium on carbon was added under nitrogen and the mixture was allowed to shake on a paar hydrogenator under hydrogen at 3.1×10⁵ Pa for 4 hours at room temperature. The reaction mixture was filtered through celite and the celite washed thoroughly with ethyl acetate. Evaporation of solvent in vacuo gave a dark oil. A solid was triturated from hexane, filtered and dried to afford 3.3 g of 5-amino-2-(2,2,2trifluoroethoxy)pyridine, isolated as a crude dark solid. ¹H NMR (CDCl₃): 7.60 (s, 1H), 7.05 (d, 1H), 6.70 (d, 1H), 4.65 (q, 2H) 3.44 (br s, NH₂) ppm.

Step C: Preparation of 3-iodo-N-(2.2.2-trifluoroethoxy)pyridin-5-yl Phthalimide

A stirred solution of 3-iodophthalic anhydride (1.3 g, 4.7 mmol) and 5-amino-2-(2,2,2trifluoroethoxy)pyridine (1.1 g, 5.7 mmol) stirring in 15 mL of glacial acetic acid was heated at reflux for 3 hrs. The solvent was removed in vacuo and the remaining residue partitioned between 100 mL of ethyl acetate and 75 mL of water. The organic layer was separated, washed with aqueous sodium bicarbonate and brine and dried over magnesium sulfate. Evaporation of solvent in vacuo gave a solid residue which was suspended in hexanes and filtered to afford 2 g of 3-iodo-N-(2,2,2-trifluoroethoxy)pyridin-5-yl phthalimide, isolated as a crude solid and used directly in the next step. ¹H NMR (CDCl₃): 8.3 (s, 1H), 8.2 (d, 1H), 7.95 (d, 1H), 7.75 (d, 1H) 7.5 (t, 1H), 7.01 (d, 1H), 4.8 (q, 2H) ppm.

Step D: Preparation of 3-Iodo-N²-(1-methylethyl)-N¹-[6-(2,2,2-trifluoroethoxy)-3-pyridinyl]-1,2-benzenedicarboxamide and 6-Iodo-N²-(1-methylethyl)-N¹-[6-(2,2,2-trifluoroethoxy)-3-pyridinyl]-1,2-benzenedicarboxamide

To a stirred solution of 3-iodo-N-(2,2,2-trifluoroethoxy)pyridin-5-yl phthalimide (0.5 g, 1.1 mmol) in 10 mL of 1,4-dioxane, isopropylamine (1.5 g, 25 mmol) was added and the reaction solution heated near reflux overnight. The reaction mixture was partitioned between 100 mL of ethyl acetate and 75 mL of water. The organic layer was separated, washed with water and brine, and dried over magnesium sulfate. Evaporation of solvent in vacuo gave a solid residue which was chromatograghed on silica gel to afford 27 mg of 3-iodo-N²-(1-methylethyl)-N¹-[6-(2,2,2-trifluoroethoxy)-3-pyridinyl]-1,2-benzenedicarboxamide [mp: 220-225° C.; ¹H NMR (DMSO-D₆): δ10.25 (s, 1H), 8.46 (s, 1H), 8.2 (d, 1H), 8.05 (d, 1H), 8.0 (d, 1H), 7.65 (d, 1H), 7.25 (t, 1H), 7.0 (d, 1H), 4.96 (q, 2H), 3.95 (m, 1H), 1.07 (d, 6H)] and 25 mg of 6-iodo-N²-(1-methylethyl)-N¹-[6-(2,2,2-trifluoroethoxy)-3-pyridinyl]-1,2-benzenedicarboxamide [mp: 200-203° C.; ¹H NMR (DMSO-D₆): δ 8.8 (s, 1H), 8.4 (s, 1H), 8.05 (d, 1H), 7.85 (d, 1H), 7.35 (d, 1H), 7.05 (t, 1H), 6.85 (d, 1H), 6.35 (d, 1H), 4.75 (q, 2H), 4.1 (m, 1H), 1.1 (d, 6H)].

### EXAMPLE 2

Step A: Preparation of 1-(2-Chlorophenyl)-5-(2-furanyl)-3-(trifluoromethyl)-1H-pyrazole

To a solution containing 4,4,4-trifluoro-1-(2-furyl)-1,3-butanedione (30.0 g, 146 mmol) in glacial acetic acid (65 mL) was added sodium acetate (12.1 g, 148 mmol). The mixture was cooled to about 25° C., 2-chlorophenylhydrazine hydrochloride (25.6 g, 145 mmol) was added portionwise and, following a mild exotherm, the mixture was heated to 60° C. for 4 h, then cooled to 25° C. The mixture was diluted with dichloromethane (400 mL) and the organic phase was washed with water (3×250 mL), saturated aqueous sodium carbonate (2×250 mL) and brine, then dried over magnesium sulfate and evaporated under reduced pressure to yield 43.2 g of the title compound as a brown oil. ¹H NMR (CDCl₃): δ 7.6 (m, 5H), 6.9 (1H), 5.7 (d, 1H).

Step B: Preparation of 1-(2-Chlorophenyl)-3-(trifluoromethyl)-1H-pyrazole-5-carboxylic Acid

To a suspension containing the title compound of Step A (43.2 g, 138 mmol) in acetonitrile (415 mL) was added sodium dihydrogenphosphate monohydrate (92.4 g, 669 mmol) over about 0.25 h. After stirring at room temperature for 0.5 h, the mixture was cooled to about 5° C. and a solution containing sodium chlorite (181.7 g, 2.0 mmol) in 430 mL of water was added dropwise over 1 h while keeping the reaction temperature at less than 10° C. [Note: an aqueous sodium hydroxide scrubber was attached to scrub an evolving yellow off-gas.] Following completion of addition the suspension was stirred at 5° C. for about 1 h, at 25° C. overnight, then acidified to pH=1 by dropwise addition of concentrated hydrochloric acid (150 mL), then extracted with ethyl acetate (1×500 mL, then 2×250 mL). The combined ethyl acetate extracts were added dropwise to an aqueous sodium metasufite solution (228.5 g in 1.05 L water) at a reaction temperature of less than 20° C. The suspension was partitioned and the aqueous layer extracted with ethyl acetate (2×100 mL). The organic layers were combined, dried over magnesium sulfate and evaporated under reduced pressure. The residue was triturated with hexane:diethyl ethert (99:1, 100 mL) to yield 32.9 g of the title compound as a solid.

¹H NMR (DMSO-D₆): δ 13.9 (bs, 1H), 7.7(m,5H).

Step C: Preparation of 1-(2-chlorophenyl)-3-(trifluoromethyl)-1H-pyrazol-5-amine

To a solution of the title compound of Step B (1.0 g, 3.44 mmol, 1.0 equivalent) in chloroform (20 mL), in a 50 mL round bottom flask was added thionyl chloride (1.26 mL, 17.2 mmol, 5.0 equivalents) and anhydrous N,N-dimethylformamide (2 drops). The resulting mixture was refluxed for 18 hours under a nitrogen atmosphere. After 18 hours the reaction was shown to be complete from an aliquot (0.5 mL) that was added to methanol (2 mL) and potassium carbonate and shaken for 5 minutes. No carboxylic acid was detected from the aliquot and only the methyl ester derivative was present (thin-layer chromatography (TLC) analysis R_{ƒ}=0.75, 1:1 ethyl acetate:hexanes). The mixture was then concentrated under reduced pressure and dried in vacuo for 4 hours. The resulting pale yellow oil was diluted with chloroform (30 mL) and transferred to a 100 mL round bottom flask. To the flask was added tetrabutylammonium bromide (3.0 mg, 0.01 mmol, 0.003 equivalents) at 0° C. followed by a solution of sodium azide (0.9 g, 13.8 mmol, 4.0 equiv) in water (5 mL). The mixture was stirred vigorously for 2 hours, after which the organic layer was separated and washed with water (2×20 mL), brine (20 mL), dried (Na₂SO₄), and filtered into a 100 mL round bottom flask. To the flask was added trifluoroacetic acid (0.69 mL, 8.94 mmol, 2.6 equivalents) and the mixture was stirred at reflux for 42 hours. To monitor the reaction, an aliquot (0.5 mL) was added to chloroform (1 mL) and washed with saturated sodium bicarbonate (2 mL). By TLC analysis after 6 h, both the acyl azide (R_{f}=0.90, 2:1 ethyl acetate:hexanes) and product (R_{ƒ}=0.45, 2:1 ethyl acetate:hexanes) were present. The mixture was then allowed to cool, washed with saturated sodium bicarbonate (2×15 mL), dried (Na₂SO₄), and concentrated under reduced pressure. Column chromatography (2:1 ethyl acetate:hexanes) provided 0.68 g of the title compound as a pale yellow solid in an overall yield of 76%. The ¹H NMR spectrum was consistant with the structure. ¹H NMR (CDCl₃): δ 7.52-7.35 (4H, m), 6.96 (1H, br), 6.60 (1H, s).

Step D: Preparation of 2-[1-(2-Chlorophenyl)-3-(trifluoromethyl)-1H-pyrazol-5-yl]-4-iodo-1H-isoindole-1,3(2H)-dione

To a solution of the title compound of Step C (1.7 g, 6.51 mmol, 1.0 equivalent) in glacial acetic acid (9 mL) in a 75 mL sealed tube reaction vessel was added 3-iodophthalic anhydride (1.78 g, 6.51 mmol, 1.0 equivalent). The reaction vessel was sealed and heated at 130° C. for 6 h, then allowed to cool to room temperature. The mixture was transferred to a 250 mL separatory funnel and water was added (50 mL), upon which a white precipitate formed. The product was extracted with ether (2×50 mL), and the combined extracts were washed with water (3×50 mL), brine (50 mL), dried (Na₂SO₄), and concentrated under reduced pressure to yield 2.46 g of the title compound as a white solid. This material was used in the next step without purification.

Step E: Preparation of N²-[1-(2-Chlorophenyl)-3-(trifluoromethyl)-1H-pyrazol-5-yl]-3-iodo-N¹-(1-methylethyl)-1,2-benzenedicarboxamide and N¹-[1-(2-Chlorophenyl)-3-(trifluoromethyl)-1H-pyrazol-5-yl]-3-iodo-N²-(1-methylethyl)-1,2-benzenedicarboxamide

To the neat crude material from Step D (110 mg) in a 1.2 mL glass vial was added isopropyl amine (0.5 mL). After 2 minutes the reaction was complete by TLC. The isopropyl amine was removed to give a crude oil which was purified by preparative TLC (1:2 ethyl acetate:hexanes) to afford 24 mg of N²-[1-(2-Chlorophenyl)-3-(trifluoromethyl)-1H-pyrazol-5-yl]-3-iodo-N¹-(1-methylethyl)-1,2-benzenedicarboxamide (yield 18%) (mp 234-235° C.); TLC analysis R^{ƒ}=0.32, (1:1 ethyl acetate:hexanes); ¹H NMR (CDCl₃): δ 7.88 (1H, d), 7.66 (1H, br), 7.57-7.52 (2H, m), 7.50-7.43 (3H, m), 7.16-7.11 (2H, m), 5.98 (1H, bd), 4.10 (1H, m), 1.17 (6H, d); and 37 mg of N¹-[1-(2-Chlorophenyl)-3-(trifluoromethyl)-1H-pyrazol-5-yl]-3-iodo-N²-(1-methylethyl)-1,2-benzenedicarboxamide (yield 29%); (mp 226-228° C.); TLC analysis R_{ƒ}=0.58, (1:1 ethyl acetate:hexanes) ¹H NMR (CDCl₃): δ 8.94 (1H, s), 7.93 (1H, d), 7.78 (1H, d), 7.63-7.47 (4H, m), 7.17 (1H, t), 7.12 (1H, s), 6.63 (1H, bd), 4.07 (1H, m), 1.18 (6H, d).

By the procedures described herein together with methods known in the art, the following compounds of Tables 1 to 25 can be prepared. The following abbreviations are used in the Tables: t is tertiary, s is secondary, n is normal, i is iso, c is cyclo, Me is methyl, Et is ethyl, Pr is propyl, i-Pr is isopropyl, t-Bu is tertiary butyl, Ph is phenyl and CN is cyano.

TABLE 1

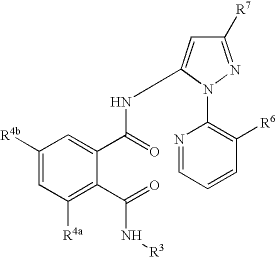

| R^{4a} | R^{4b} | R⁷ | R³ | R⁶ | R^{4a} | R^{4b} | R⁷ | R³ | R⁶ | R^{4a} | R^{4b} | R⁷ | R³ | R⁶ |
|---|---|---|---|---|---|---|---|---|---|---|---|---|---|---|
| CH₃ | F | CF₃ | Me | Cl | Cl | F | CF₃ | Me | Cl | Br | F | CF₃ | Me | Cl |
| CH₃ | F | CF₃ | Et | Cl | Cl | F | CF₃ | Et | Cl | Br | F | CF₃ | Et | Cl |
| CH₃ | F | CF₃ | i-Pr | Cl | Cl | F | CF₃ | i-Pr | Cl | Br | F | CF₃ | i-Pr | Cl |
| CH₃ | F | CF₃ | t-Bu | Cl | Cl | F | CF₃ | t-Bu | Cl | Br | F | CF₃ | t-Bu | Cl |
| CH₃ | F | CF₃ | Me | Br | Cl | F | CF₃ | Me | Br | Br | F | CF₃ | Me | Br |
| CH₃ | F | CF₃ | Et | Br | Cl | F | CF₃ | Et | Br | Br | F | CF₃ | Et | Br |
| CH₃ | F | CF₃ | i-Pr | Br | Cl | F | CF₃ | i-Pr | Br | Br | F | CF₃ | i-Pr | Br |
| CH₃ | F | CF₃ | t-Bu | Br | Cl | F | CF₃ | t-Bu | Br | Br | F | CF₃ | t-Bu | Br |
| CH₃ | F | Cl | Me | Cl | Cl | F | Cl | Me | Cl | Br | F | Cl | Me | Cl |
| CH₃ | F | Cl | Et | Cl | Cl | F | Cl | Et | Cl | Br | F | Cl | Et | Cl |
| CH₃ | F | Cl | i-Pr | Cl | Cl | F | Cl | i-Pr | Cl | Br | F | Cl | i-Pr | Cl |
| CH₃ | F | Cl | t-Bu | Cl | Cl | F | Cl | t-Bu | Cl | Br | F | Cl | t-Bu | Cl |
| CH₃ | F | Cl | Me | Br | Cl | F | Cl | Me | Br | Br | F | Cl | Me | Br |
| CH₃ | F | Cl | Et | Br | Cl | F | Cl | Et | Br | Br | F | Cl | Et | Br |
| CH₃ | F | Cl | i-Pr | Br | Cl | F | Cl | i-Pr | Br | Br | F | Cl | i-Pr | Br |
| CH₃ | F | Cl | t-Bu | Br | Cl | F | Cl | t-Bu | Br | Br | F | Cl | t-Bu | Br |
| CH₃ | F | Br | Me | Cl | Cl | F | Br | Me | Cl | Br | F | Br | Me | Cl |
| CH₃ | F | Br | Et | Cl | Cl | F | Br | Et | Cl | Br | F | Br | Et | Cl |
| CH₃ | F | Br | i-Pr | Cl | Cl | F | Br | i-Pr | Cl | Br | F | Br | i-Pr | Cl |
| CH₃ | F | Br | t-Bu | Cl | Cl | F | Br | t-Bu | Cl | Br | F | Br | t-Bu | Cl |
| CH₃ | F | Br | Me | Br | Cl | F | Br | Me | Br | Br | F | Br | Me | Br |
| CH₃ | F | Br | Et | Br | Cl | F | Br | Et | Br | Br | F | Br | Et | Br |
| CH₃ | F | Br | i-Pr | Br | Cl | F | Br | i-Pr | Br | Br | F | Br | i-Pr | Br |
| CH₃ | F | Br | t-Bu | Br | Cl | F | Br | t-Bu | Br | Br | F | Br | t-Bu | Br |
| CH₃ | Cl | CF₃ | Me | Cl | Cl | Cl | CF₃ | Me | Cl | Br | Cl | CF₃ | Me | Cl |
| CH₃ | Cl | CF₃ | Et | Cl | Cl | Cl | CF₃ | Et | Cl | Br | Cl | CF₃ | Et | Cl |
| CH₃ | Cl | CF₃ | i-Pr | Cl | Cl | Cl | CF₃ | i-Pr | Cl | Br | Cl | CF₃ | i-Pr | Cl |
| CH₃ | Cl | CF₃ | t-Bu | Cl | Cl | Cl | CF₃ | t-Bu | Cl | Br | Cl | CF₃ | t-Bu | Cl |
| CH₃ | Cl | CF₃ | Me | Br | Cl | Cl | CF₃ | Me | Br | Br | Cl | CF₃ | Me | Br |
| CH₃ | Cl | CF₃ | Et | Br | Cl | Cl | CF₃ | Et | Br | Br | Cl | CF₃ | Et | Br |
| CH₃ | Cl | CF₃ | i-Pr | Br | Cl | Cl | CF₃ | i-Pr | Br | Br | Cl | CF₃ | i-Pr | Br |
| CH₃ | Cl | CF₃ | t-Bu | Br | Cl | Cl | CF₃ | t-Bu | Br | Br | Cl | CF₃ | t-Bu | Br |
| CH₃ | Cl | Cl | Me | Cl | Cl | Cl | Cl | Me | Cl | Br | Cl | Cl | Me | Cl |
| CH₃ | Cl | Cl | Et | Cl | Cl | Cl | Cl | Et | Cl | Br | Cl | Cl | Et | Cl |
| CH₃ | Cl | Cl | i-Pr | Cl | Cl | Cl | Cl | i-Pr | Cl | Br | Cl | Cl | i-Pr | Cl |
| CH₃ | Cl | Cl | t-Bu | Cl | Cl | Cl | Cl | t-Bu | Cl | Br | Cl | Cl | t-Bu | Cl |
| CH₃ | Cl | Cl | Me | Br | Cl | Cl | Cl | Me | Br | Br | Cl | Cl | Me | Br |
| CH₃ | Cl | Cl | Et | Br | Cl | Cl | Cl | Et | Br | Br | Cl | Cl | Et | Br |
| CH₃ | Cl | Cl | i-Pr | Br | Cl | Cl | Cl | i-Pr | Br | Br | Cl | Cl | i-Pr | Br |
| CH₃ | Cl | Cl | t-Bu | Br | Cl | Cl | Cl | t-Bu | Br | Br | Cl | Cl | t-Bu | Br |
| CH₃ | Cl | Br | Me | Cl | Cl | Cl | Br | Me | Cl | Br | Cl | Br | Me | Cl |
| CH₃ | Cl | Br | Et | Cl | Cl | Cl | Br | Et | Cl | Br | Cl | Br | Et | Cl |
| CH₃ | Cl | Br | i-Pr | Cl | Cl | Cl | Br | i-Pr | Cl | Br | Cl | Br | i-Pr | Cl |
| CH₃ | Cl | Br | t-Bu | Cl | Cl | Cl | Br | t-Bu | Cl | Br | Cl | Br | t-Bu | Cl |
| CH₃ | Cl | Br | Me | Br | Cl | Cl | Br | Me | Br | Br | Cl | Br | Me | Br |
| CH₃ | Cl | Br | Et | Br | Cl | Cl | Br | Et | Br | Br | Cl | Br | Et | Br |
| CH₃ | Cl | Br | i-Pr | Br | Cl | Cl | Br | i-Pr | Br | Br | Cl | Br | i-Pr | Br |
| CH₃ | Cl | Br | t-Bu | Br | Cl | Cl | Br | t-Bu | Br | Br | Cl | Br | t-Bu | Br |
| CH₃ | CF₃ | Me | Cl | Cl | Br | CF₃ | Me | Cl | Br | Br | CF₃ | Me | Cl | |
| CH₃ | Br | CF₃ | Et | Cl | Cl | Br | CF₃ | Et | Cl | Br | Br | CF₃ | Et | Cl |
| CH₃ | Br | CF₃ | i-Pr | Cl | Cl | Br | CF₃ | i-Pr | Cl | Br | Br | CF₃ | i-Pr | Cl |
| CH₃ | Br | CF₃ | t-Bu | Cl | Cl | Br | CF₃ | t-Bu | Cl | Br | Br | CF₃ | t-Bu | Cl |
| CH₃ | Br | CF₃ | Me | Br | Cl | Br | CF₃ | Me | Br | Br | Br | CF₃ | Me | Br |
| CH₃ | Br | CF₃ | Et | Br | Cl | Br | CF₃ | Et | Br | Br | Br | CF₃ | Et | Br |
| CH₃ | Br | CF₃ | i-Pr | Br | Cl | Br | CF₃ | i-Pr | Br | Br | Br | CF₃ | i-Pr | Br |
| CH₃ | Br | CF₃ | t-Bu | Br | Cl | Br | CF₃ | t-Bu | Br | Br | Br | CF₃ | t-Bu | Br |
| CH₃ | Br | Cl | Me | Cl | Cl | Br | Cl | Me | Cl | Br | Br | Cl | Me | Cl |
| CH₃ | Br | Cl | Et | Cl | Cl | Br | Cl | Et | Cl | Br | Br | Cl | Et | Cl |
| CH₃ | Br | Cl | i-Pr | Cl | Cl | Br | Cl | i-Pr | Cl | Br | Br | Cl | i-Pr | Cl |
| CH₃ | Br | Cl | t-Bu | Cl | Cl | Br | Cl | t-Bu | Cl | Br | Br | Cl | t-Bu | Cl |
| CH₃ | Br | Cl | Me | Br | Cl | H | CF₃ | Me | Cl | Br | Br | Cl | Me | Br |
| CH₃ | Br | Cl | Et | Br | Cl | H | CF₃ | Et | Cl | Br | Br | Cl | Et | Br |
| CH₃ | Br | Cl | i-Pr | Br | Cl | H | CF₃ | i-Pr | Cl | Br | Br | Cl | i-Pr | Br |
| CH₃ | Br | Cl | t-Bu | Br | Cl | H | CF₃ | t-Bu | Cl | Br | Br | Cl | t-Bu | Br |
| CH₃ | Br | Br | Me | Cl | Cl | H | CF₃ | Me | Br | Br | Br | Br | Me | Cl |
| CH₃ | Br | Br | Et | Cl | Cl | H | CF₃ | Et | Br | Br | Br | Br | Et | Cl |
| CH₃ | Br | Br | i-Pr | Cl | Cl | H | CF₃ | i-Pr | Br | Br | Br | Br | i-Pr | Cl |
| CH₃ | Br | Br | t-Bu | Cl | Cl | H | CF₃ | t-Bu | Br | Br | Br | Br | t-Bu | Cl |
| CH₃ | Br | Br | Me | Br | Cl | H | Cl | Me | Cl | Br | Br | Br | Me | Br |
| CH₃ | Br | Br | Et | Br | Cl | H | Cl | Et | Cl | Br | Br | Br | Et | Br |
| CH₃ | Br | Br | i-Pr | Br | Cl | H | Cl | i-Pr | Cl | Br | Br | Br | i-Pr | Br |
| CH₃ | Br | Br | t-Bu | Br | Cl | H | Cl | t-Bu | Cl | Br | Br | Br | t-Bu | Br |
| CH₃ | I | CF₃ | Me | Cl | Cl | H | Cl | Me | Br | Br | I | CF₃ | Me | Cl |
| CH₃ | I | CF₃ | Et | Cl | Cl | H | Cl | Et | Br | Br | I | CF₃ | Et | Cl |
| CH₃ | I | CF₃ | i-Pr | Cl | Cl | H | Cl | i-Pr | Br | Br | I | CF₃ | i-Pr | Cl |
| CH₃ | I | CF₃ | t-Bu | Cl | Cl | H | Cl | t-Bu | Br | Br | I | CF₃ | t-Bu | Cl |
| CH₃ | I | CF₃ | Me | Br | Cl | H | Br | Me | Cl | Br | I | CF₃ | Me | Br |
| CH₃ | I | CF₃ | Et | Br | Cl | H | Br | Et | Cl | Br | I | CF₃ | Et | Br |
| CH₃ | I | CF₃ | i-Pr | Br | Cl | H | Br | i-Pr | Cl | Br | I | CF₃ | i-Pr | Br |
| CH₃ | I | CF₃ | t-Bu | Br | Cl | H | Br | t-Bu | Cl | Br | I | CF₃ | t-Bu | Br |
| CH₃ | I | Cl | Me | Cl | Cl | H | Br | Me | Br | Br | I | Cl | Me | Cl |
| CH₃ | I | Cl | Et | Cl | Cl | H | Br | Et | Br | Br | I | Cl | Et | Cl |
| CH₃ | I | Cl | i-Pr | Cl | Cl | H | Br | i-Pr | Br | Br | I | Cl | i-Pr | Cl |
| CH₃ | I | Cl | t-Bu | Cl | Cl | H | Br | t-Bu | Br | Br | I | Cl | t-Bu | Cl |
| CH₃ | I | Cl | Me | Br | Cl | Br | Cl | Me | Br | Br | I | Cl | Me | Br |
| CH₃ | I | Cl | Et | Br | Cl | Br | Cl | Et | Br | Br | I | Cl | Et | Br |
| CH₃ | I | Cl | i-Pr | Br | Cl | Br | Cl | i-Pr | Br | Br | I | Cl | i-Pr | Br |
| CH₃ | I | Cl | t-Bu | Br | Cl | Br | Cl | t-Bu | Br | Br | I | Cl | t-Bu | Br |
| CH₃ | I | Br | Me | Cl | Cl | Br | Br | Me | Cl | Br | I | Br | Me | Cl |
| CH₃ | I | Br | Et | Cl | Cl | Br | Br | Et | Cl | Br | I | Br | Et | Cl |
| CH₃ | I | Br | i-Pr | Cl | Cl | Br | Br | i-Pr | Cl | Br | I | Br | i-Pr | Cl |
| CH₃ | I | Br | t-Bu | Cl | Cl | Br | Br | t-Bu | Cl | Br | I | Br | t-Bu | Cl |
| CH₃ | I | Br | Me | Br | Cl | Br | Br | Me | Br | Br | I | Br | Me | Br |
| CH₃ | I | Br | Et | Br | Cl | Br | Br | Et | Br | Br | I | Br | Et | Br |
| CH₃ | I | Br | i-Pr | Br | Cl | Br | Br | i-Pr | Br | Br | I | Br | i-Pr | Br |
| CH₃ | I | Br | t-Bu | Br | Cl | Br | Br | t-Bu | Br | Br | I | Br | t-Bu | Br |
| CH₃ | CF₃ | CF₃ | Me | Cl | Cl | I | CF₃ | Me | Cl | Br | CF₃ | CF₃ | Me | Cl |
| CH₃ | CF₃ | CF₃ | Et | Cl | Cl | I | CF₃ | Et | Cl | Br | CF₃ | CF₃ | Et | Cl |
| CH₃ | CF₃ | CF₃ | i-Pr | Cl | Cl | I | CF₃ | i-Pr | Cl | Br | CF₃ | CF₃ | i-Pr | Cl |
| CH₃ | CF₃ | CF₃ | t-Bu | Cl | Cl | I | CF₃ | t-Bu | Cl | Br | CF₃ | CF₃ | t-Bu | Cl |
| CH₃ | CF₃ | CF₃ | Me | Br | Cl | I | CF₃ | Me | Br | Br | CF₃ | CF₃ | Me | Br |
| CH₃ | CF₃ | CF₃ | Et | Br | Cl | I | CF₃ | Et | Br | Br | CF₃ | CF₃ | Et | Br |
| CH₃ | CF₃ | CF₃ | i-Pr | Br | Cl | I | CF₃ | i-Pr | Br | Br | CF₃ | CF₃ | i-Pr | Br |
| CH₃ | CF₃ | CF₃ | t-Bu | Br | Cl | I | CF₃ | t-Bu | Br | Br | CF₃ | CF₃ | t-Bu | Br |
| CH₃ | CF₃ | Cl | Me | Cl | Cl | I | Cl | Me | Cl | Br | CF₃ | Cl | Me | Cl |
| CH₃ | CF₃ | Cl | Et | Cl | Cl | I | Cl | Et | Cl | Br | CF₃ | Cl | Et | Cl |
| CH₃ | CF₃ | Cl | i-Pr | Cl | Cl | I | Cl | i-Pr | Cl | Br | CF₃ | Cl | i-Pr | Cl |
| CH₃ | CF₃ | Cl | t-Bu | Cl | Cl | I | Cl | t-Bu | Cl | Br | CF₃ | Cl | t-Bu | Cl |
| CH₃ | CF₃ | Cl | Me | Br | Cl | I | Cl | Me | Br | Br | CF₃ | Cl | Me | Br |
| CH₃ | CF₃ | Cl | Et | Br | Cl | I | Cl | Et | Br | Br | CF₃ | Cl | Et | Br |
| CH₃ | CF₃ | Cl | i-Pr | Br | Cl | I | Cl | i-Pr | Br | Br | CF₃ | Cl | i-Pr | Br |
| CH₃ | CF₃ | Cl | t-Bu | Br | Cl | I | Cl | t-Bu | Br | Br | CF₃ | Cl | t-Bu | Br |
| CH₃ | CF₃ | Br | Me | Cl | Cl | I | Br | Me | Cl | Br | CF₃ | Br | Me | Cl |
| CH₃ | CF₃ | Br | Et | Cl | Cl | I | Br | Et | Cl | Br | CF₃ | Br | Et | Cl |
| CH₃ | CF₃ | Br | i-Pr | Cl | Cl | I | Br | i-Pr | Cl | Br | CF₃ | Br | i-Pr | Cl |
| CH₃ | CF₃ | Br | t-Bu | Cl | Cl | I | Br | t-Bu | Cl | Br | CF₃ | Br | t-Bu | Cl |
| CH₃ | CF₃ | Br | Me | Br | Cl | I | Br | Me | Br | Br | CF₃ | Br | Me | Br |
| CH₃ | CF₃ | Br | Et | Br | Cl | I | Br | Et | Br | Br | CF₃ | Br | Et | Br |
| CH₃ | CF₃ | Br | i-Pr | Br | Cl | I | Br | i-Pr | Br | Br | CF₃ | Br | i-Pr | Br |
| CH₃ | CF₃ | Br | t-Bu | Br | Cl | I | Br | t-Bu | Br | Br | CF₃ | Br | t-Bu | Br |
| CH₃ | Cl | Cl | n-Pr | Cl | Cl | CF₃ | CF₃ | Me | Cl | I | Cl | CF₃ | Me | Cl |
| CH₃ | Cl | Cl | n-Bu | Cl | Cl | CF₃ | CF₃ | Et | Cl | I | Cl | CF₃ | Et | Cl |
| CH₃ | Cl | Cl | s-Bu | Cl | Cl | CF₃ | CF₃ | i-Pr | Cl | I | Cl | CF₃ | i-Pr | Cl |
| CH₃ | Cl | Cl | i-Bu | Cl | Cl | CF₃ | CF₃ | t-Bu | Cl | I | Cl | CF₃ | t-Bu | Cl |
| CH₃ | H | CF₃ | Me | Cl | Cl | CF₃ | CF₃ | Me | Br | I | Cl | CF₃ | Me | Br |
| CH₃ | H | CF₃ | Et | Cl | Cl | CF₃ | CF₃ | Et | Br | I | Cl | CF₃ | Et | Br |
| CH₃ | H | CF₃ | i-Pr | Cl | Cl | CF₃ | CF₃ | i-Pr | Br | I | Cl | CF₃ | i-Pr | Br |
| CH₃ | H | CF₃ | t-Bu | Cl | Cl | CF₃ | CF₃ | t-Bu | Br | I | Cl | CF₃ | t-Bu | Br |
| CH₃ | H | CF₃ | Me | Br | Cl | CF₃ | Cl | Me | Cl | I | Cl | Cl | Me | Cl |
| CH₃ | H | CF₃ | Et | Br | Cl | CF₃ | Cl | Et | Cl | I | Cl | Cl | Et | Cl |
| CH₃ | H | CF₃ | i-Pr | Br | Cl | CF₃ | Cl | i-Pr | Cl | I | Cl | Cl | i-Pr | Cl |
| CH₃ | H | CF₃ | t-Bu | Br | Cl | CF₃ | Cl | t-Bu | Cl | I | Cl | Cl | t-Bu | Cl |
| CH₃ | H | Cl | Me | Cl | Cl | CF₃ | Cl | Me | Br | I | Cl | Cl | Me | Br |
| CH₃ | H | Cl | Et | Cl | Cl | CF₃ | Cl | Et | Br | I | Cl | Cl | Et | Br |
| CH₃ | H | Cl | i-Pr | Cl | Cl | CF₃ | Cl | i-Pr | Br | I | Cl | Cl | i-Pr | Br |
| CH₃ | H | Cl | t-Bu | Cl | Cl | CF₃ | Cl | t-Bu | Br | I | Cl | Cl | t-Bu | Br |
| CH₃ | H | Cl | Me | Br | Cl | CF₃ | Br | Me | Cl | I | Cl | Br | Me | Cl |
| CH₃ | H | Cl | Et | Br | Cl | CF₃ | Br | Et | Cl | I | Cl | Br | Et | Cl |
| CH₃ | H | Cl | i-Pr | Br | Cl | CF₃ | Br | i-Pr | Cl | I | Cl | Br | i-Pr | Cl |
| CH₃ | H | Cl | t-Bu | Br | Cl | CF₃ | Br | t-Bu | Cl | I | Cl | Br | t-Bu | Cl |
| CH₃ | H | Br | Me | Cl | Cl | CF₃ | Br | Me | Br | I | Cl | Br | Me | Br |
| CH₃ | H | Br | Et | Cl | Cl | CF₃ | Br | Et | Br | I | Cl | Br | Et | Br |
| CH₃ | H | Br | i-Pr | Cl | Cl | CF₃ | Br | i-Pr | Br | I | Cl | Br | i-Pr | Br |
| CH₃ | H | Br | t-Bu | Cl | Cl | CF₃ | Br | t-Bu | Br | I | Cl | Br | t-Bu | Br |
| CH₃ | H | Br | Me | Br | Cl | Cl | Cl | n-Pr | Cl | I | H | CF₃ | Me | Cl |
| CH₃ | H | Br | Et | Br | Cl | Cl | Cl | n-Bu | Cl | I | H | CF₃ | Et | Cl |
| CH₃ | H | Br | i-Pr | Br | Cl | Cl | Cl | s-Bu | Cl | I | H | CF₃ | i-Pr | Cl |
| CH₃ | H | Br | t-Bu | Br | Cl | Cl | Cl | i-Bu | Cl | I | H | CF₃ | t-Bu | Cl |

TABLE 2

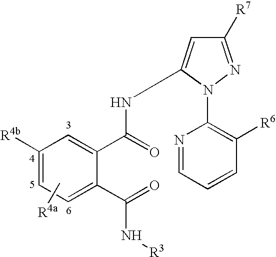

| R³ | R^{4a} | R^{4b} | R⁷ | R⁶ | R³ | R^{4a} | R^{4b} | R⁷ | R⁶ |
|---|---|---|---|---|---|---|---|---|---|
| Me | 3-Me | H | CF₃ | F | Me | 3-Cl | H | CF₃ | F |
| Et | 3-Me | 5-Me | OCF₃ | F | Et | 3-Cl | 5-Me | OCF₃ | F |
| i-Pr | 3-Me | H | OCF₃ | F | i-Pr | 3-Cl | H | OCF₃ | F |
| t-Bu | 3-Me | 5-Cl | Br | F | t-Bu | 3-Cl | 5-Cl | Br | F |
| Me | 3-Me | H | Br | F | Me | 3-Cl | H | Br | F |
| Et | 3-Me | H | Cl | F | Et | 3-Cl | H | Cl | F |
| i-Pr | 3-Me | 5-Br | Cl | F | i-Pr | 3-Cl | 5-Br | Cl | F |
| t-Bu | 3-Me | H | I | F | t-Bu | 3-Cl | H | I | F |
| propargyl | 3-Me | H | CF₃ | F | propargyl | 3-Cl | H | CF₃ | F |
| c-propyl | 3-Me | H | OCF₃ | F | c-propyl | 3-Cl | H | OCF₃ | F |
| i-Pr | 3-Me | 5-Cl | CF₃ | F | i-Pr | 3-Cl | 5-Cl | CF₃ | F |
| t-Bu | 3-Me | H | SCF₃ | F | t-Bu | 3-Cl | H | SCF₃ | F |
| Me | 3-Me | 5-Cl | SCHF₂ | F | Me | 3-Cl | 5-Cl | SCHF₂ | F |
| Et | 3-Me | H | OCHF₂ | F | Et | 3-Cl | H | OCHF₂ | F |
| i-Pr | 3-Me | H | CF₃ | F | i-Pr | 3-Cl | H | CF₃ | F |
| t-Bu | 3-Me | H | C₂F₅ | F | t-Bu | 3-Cl | H | C₂F₅ | F |
| propargyl | 3-Me | H | C₂F₅ | F | propargyl | 3-Cl | H | C₂F₅ | F |
| c-propyl | 3-Me | H | CF₃ | F | c-propyl | 3-Cl | H | CF₃ | F |
| i-Pr | 3-Me | H | Me | F | i-Pr | 3-Cl | H | Me | F |
| t-Bu | 3-Me | 5-Br | CN | F | t-Bu | 3-Cl | 5-Br | CN | F |
| Me | 3-Me | H | CF₃ | Cl | Me | 3-Cl | H | CF₃ | Cl |
| Et | 3-Me | 5-Me | OCF₃ | Cl | Et | 3-Cl | 5-Me | OCF₃ | Cl |
| i-Pr | 3-Me | H | OCF₃ | Cl | i-Pr | 3-Cl | H | OCF₃ | Cl |
| t-Bu | 3-Me | 5-Cl | Br | Cl | t-Bu | 3-Cl | 5-Cl | Br | Cl |
| Me | 3-Me | H | Br | Cl | Me | 3-Cl | H | Br | Cl |
| Et | 3-Me | H | Cl | Cl | Et | 3-Cl | H | Cl | Cl |
| i-Pr | 3-Me | 5-Br | Cl | Cl | i-Pr | 3-Cl | 5-Br | Cl | Cl |
| t-Bu | 3-Me | H | I | Cl | t-Bu | 3-Cl | H | I | Cl |
| propargyl | 3-Me | H | CF₃ | Cl | propargyl | 3-Cl | H | CF₃ | Cl |
| c-propyl | 3-Me | H | OCF₃ | Cl | c-propyl | 3-Cl | H | OCF₃ | Cl |
| i-Pr | 3-Me | 5-Cl | CF₃ | Cl | i-Pr | 3-Cl | 5-Cl | CF₃ | Cl |
| t-Bu | 3-Me | H | SCF₃ | Cl | t-Bu | 3-Cl | H | SCF₃ | Cl |
| Me | 3-Me | 5-Cl | SCHF₂ | Cl | Me | 3-Cl | 5-Cl | SCHF₂ | Cl |
| Et | 3-Me | H | OCHF₂ | Cl | Et | 3-Cl | H | OCHF₂ | Cl |
| i-Pr | 3-Me | H | CF₃ | Cl | i-Pr | 3-Cl | H | CF₃ | Cl |
| t-Bu | 3-Me | H | C₂F₅ | Cl | t-Bu | 3-Cl | H | C₂F₅ | Cl |
| propargyl | 3-Me | H | C₂F₅ | Cl | propargyl | 3-Cl | H | C₂F₅ | Cl |
| c-propyl | 3-Me | H | CF₃ | Cl | c-propyl | 3-Cl | H | CF₃ | Cl |
| i-Pr | 3-Me | H | Me | Cl | i-Pr | 3-Cl | H | Me | Cl |
| t-Bu | 3-Me | 5-Br | CN | Cl | t-Bu | 3-Cl | 5-Br | CN | Cl |
| Me | 3-Me | H | CF₃ | CF₃ | Me | 3-Cl | H | CF₃ | CF₃ |
| Et | 3-Me | 5-Me | OCF₃ | CF₃ | Et | 3-Cl | 5-Me | OCF₃ | CF₃ |
| i-Pr | 3-Me | H | OCF₃ | CF₃ | i-Pr | 3-Cl | H | OCF₃ | CF₃ |
| t-Bu | 3-Me | 5-Cl | Br | CF₃ | t-Bu | 3-Cl | 5-Cl | Br | CF₃ |
| Me | 3-Me | H | Br | CF₃ | Me | 3-Cl | H | Br | CF₃ |
| Et | 3-Me | H | Cl | CF₃ | Et | 3-Cl | H | Cl | CF₃ |
| i-Pr | 3-Me | 5-Br | Cl | CF₃ | i-Pr | 3-Cl | 5-Br | Cl | CF₃ |
| t-Bu | 3-Me | H | I | CF₃ | t-Bu | 3-Cl | H | I | CF₃ |
| propargyl | 3-Me | H | CF₃ | CF₃ | propargyl | 3-Cl | H | CF₃ | CF₃ |
| c-propyl | 3-Me | H | OCF₃ | CF₃ | c-propyl | 3-Cl | H | OCF₃ | CF₃ |
| i-Pr | 3-Me | 5-Cl | CF₃ | CF₃ | i-Pr | 3-Cl | 5-Cl | CF₃ | CF₃ |
| t-Bu | 3-Me | H | SCF₃ | CF₃ | t-Bu | 3-Cl | H | SCF₃ | CF₃ |
| Me | 3-Me | 5-Cl | SCHF₂ | CF₃ | Me | 3-Cl | 5-Cl | SCHF₂ | CF₃ |
| Et | 3-Me | H | OCHF₂ | CF₃ | Et | 3-Cl | H | OCHF₂ | CF₃ |
| i-Pr | 3-Me | H | CF₃ | CF₃ | i-Pr | 3-Cl | H | CF₃ | CF₃ |
| t-Bu | 3-Me | H | C₂F₅ | CF₃ | t-Bu | 3-Cl | H | C₂F₅ | CF₃ |
| propargyl | 3-Me | H | C₂F₅ | CF₃ | propargyl | 3-Cl | H | C₂F₅ | CF₃ |
| c-propyl | 3-Me | H | CF₃ | CF₃ | c-propyl | 3-Cl | H | CF₃ | CF₃ |
| i-Pr | 3-Me | H | Me | CF₃ | i-Pr | 3-Cl | H | Me | CF₃ |
| t-Bu | 3-Me | 5-Br | CN | CF₃ | t-Bu | 3-Cl | 5-Br | CN | CF₃ |
| Me | 3-Me | H | CF₃ | Br | Me | 3-Cl | H | CF₃ | Br |
| Et | 3-Me | 5-Me | OCF₃ | Br | Et | 3-Cl | 5-Me | OCF₃ | Br |
| i-Pr | 3-Me | H | OCF₃ | Br | i-Pr | 3-Cl | H | OCF₃ | Br |
| t-Bu | 3-Me | 5-Cl | Br | Br | t-Bu | 3-Cl | 5-Cl | Br | Br |
| Me | 3-Me | H | Br | Br | Me | 3-Cl | H | Br | Br |
| Et | 3-Me | H | Cl | Br | Et | 3-Cl | H | Cl | Br |
| i-Pr | 3-Me | 5-Br | Cl | Br | i-Pr | 3-Cl | 5-Br | Cl | Br |
| t-Bu | 3-Me | H | I | Br | t-Bu | 3-Cl | H | I | Br |
| propargyl | 3-Me | H | CF₃ | Br | propargyl | 3-Cl | H | CF₃ | Br |
| c-propyl | 3-Me | H | OCF₃ | Br | c-propyl | 3-Cl | H | OCF₃ | Br |
| i-Pr | 3-Me | 5-Cl | CF₃ | Br | i-Pr | 3-Cl | 5-Cl | CF₃ | Br |
| t-Bu | 3-Me | H | SCF₃ | Br | t-Bu | 3-Cl | H | SCF₃ | Br |
| Me | 3-Me | 5-Cl | SCHF₂ | Br | Me | 3-Cl | 5-Cl | SCHF₂ | Br |
| Et | 3-Me | H | OCHF₂ | Br | Et | 3-Cl | H | OCHF₂ | Br |
| i-Pr | 3-Me | H | CF₃ | Br | i-Pr | 3-Cl | H | CF₃ | Br |
| t-Bu | 3-Me | H | C₂F₅ | Br | t-Bu | 3-Cl | H | C₂F₅ | Br |
| propargyl | 3-Me | H | C₂F₅ | Br | propargyl | 3-Cl | H | C₂F5 | Br |
| c-propyl | 3-Me | H | CF₃ | Br | c-propyl | 3-Cl | H | CF₃ | Br |
| i-Pr | 3-Me | H | Me | Br | i-Pr | 3-Cl | H | Me | Br |
| t-Bu | 3-Me | 5-Br | CN | Br | t-Bu | 3-Cl | 5-Br | CN | Br |
| Me | 6-Me | H | OCHF₂ | F | Me | 6-Cl | H | OCHF₂ | F |
| Et | 6-Me | H | OCHF₂ | F | Et | 6-Cl | H | OCHF₂ | F |
| i-Pr | 6-Me | H | OCHF₂ | F | i-Pr | 6-Cl | H | OCHF₂ | F |
| t-Bu | 6-Me | H | OCHF₂ | F | t-Bu | 6-Cl | H | OCHF₂ | F |
| Me | 6-Me | H | SCHF₂ | F | Me | 6-Cl | H | SCHF₂ | F |
| Et | 6-Me | H | SCHF₂ | F | Et | 6-Cl | H | SCHF₂ | F |
| i-Pr | 6-Me | H | SCHF₂ | F | i-Pr | 6-Cl | H | SCHF₂ | F |
| t-Bu | 6-Me | H | SCHF₂ | F | t-Bu | 6-Cl | H | SCHF₂ | F |
| Me | 6-Me | H | OCF₃ | F | Me | 6-Cl | H | OCF₃ | F |
| Et | 6-Me | H | OCF₃ | F | Et | 6-Cl | H | OCF₃ | F |
| i-Pr | 6-Me | H | OCF₃ | F | i-Pr | 6-Cl | H | OCF₃ | F |
| t-Bu | 6-Me | H | OCF₃ | F | t-Bu | 6-Cl | H | OCF₃ | F |
| Me | 6-Me | H | SCF₃ | F | Me | 6-Cl | H | SCF₃ | F |
| Et | 6-Me | H | SCF₃ | F | Et | 6-Cl | H | SCF₃ | F |
| i-Pr | 6-Me | H | SCF₃ | F | i-Pr | 6-Cl | H | SCF₃ | F |
| t-Bu | 6-Me | H | SCF₃ | F | t-Bu | 6-Cl | H | SCF₃ | F |
| Me | 6-Me | H | C₂F₅ | F | Me | 6-Cl | H | C₂F₅ | F |
| Et | 6-Me | H | C₂F₅ | F | Et | 6-Cl | H | C₂F₅ | F |
| i-Pr | 6-Me | H | C₂F₅ | F | i-Pr | 6-Cl | H | C₂F₅ | F |
| t-Bu | 6-Me | H | C₂F₅ | F | t-Bu | 6-Cl | H | C₂F₅ | F |
| Me | 6-Me | H | n-C₃F₇ | F | Me | 6-Cl | H | n-C₃F₇ | F |
| Et | 6-Me | H | n-C₃F₇ | F | Et | 6-Cl | H | n-C₃F₇ | F |
| i-Pr | 6-Me | H | n-C₃F₇ | F | i-Pr | 6-Cl | H | n-C₃F₇ | F |
| t-Bu | 6-Me | H | n-C₃F₇ | F | t-Bu | 6-Cl | H | n-C₃F₇ | F |
| Me | 6-Me | H | i-C₃F₇ | F | Me | 6-Cl | H | i-C₃F₇ | F |
| Et | 6-Me | H | i-C₃F₇ | F | Et | 6-Cl | H | i-C₃F₇ | F |
| i-Pr | 6-Me | H | i-C₃F₇ | F | i-Pr | 6-Cl | H | i-C₃F₇ | F |
| t-Bu | 6-Me | H | i-C₃F₇ | F | t-Bu | 6-Cl | H | i-C₃F₇ | F |
| Me | 6-Me | H | CN | F | Me | 6-Cl | H | CN | F |
| Et | 6-Me | H | CN | F | Et | 6-Cl | H | CN | F |
| i-Pr | 6-Me | H | CN | F | i-Pr | 6-Cl | H | CN | F |
| t-Bu | 6-Me | H | CN | F | t-Bu | 6-Cl | H | CN | F |
| Me | 6-Me | H | OCHF₂ | Cl | Me | 6-Cl | H | OCHF₂ | Cl |
| Et | 6-Me | H | OCHF₂ | Cl | Et | 6-Cl | H | OCHF₂ | Cl |
| i-Pr | 6-Me | H | OCHF₂ | Cl | i-Pr | 6-Cl | H | OCHF₂ | Cl |
| t-Bu | 6-Me | H | OCHF₂ | Cl | t-Bu | 6-Cl | H | OCHF₂ | C~ |
| Me | 6-Me | H | SCHF₂ | Cl | Me | 6-Cl | H | SCHF₂ | Cl |
| Et | 6-Me | H | SCHF₂ | Cl | Et | 6-Cl | H | SCHF₂ | Cl |
| i-Pr | 6-Me | H | SCHF₂ | Cl | i-Pr | 6-Cl | H | SCHF₂ | Cl |
| t-Bu | 6-Me | H | SCHF₂ | Cl | t-Bu | 6-Cl | H | SCHF₂ | Cl |
| Me | 6-Me | H | OCF₃ | Cl | Me | 6-Cl | H | OCF₃ | Cl |
| Et | 6-Me | H | OCF₃ | Cl | Et | 6-Cl | H | OCF₃ | Cl |
| i-Pr | 6-Me | H | OCF₃ | Cl | i-Pr | 6-Cl | H | OCF₃ | Cl |
| t-Bu | 6-Me | H | OCF₃ | Cl | t-Bu | 6-Cl | H | OCF₃ | Cl |
| Me | 6-Me | H | SCF₃ | Cl | Me | 6-Cl | H | SCF₃ | Cl |
| Et | 6-Me | H | SCF₃ | Cl | Et | 6-Cl | H | SCF₃ | Cl |
| i-Pr | 6-Me | H | SCF₃ | Cl | i-Pr | 6-Cl | H | SCF₃ | Cl |
| t-Bu | 6-Me | H | SCF₃ | Cl | t-Bu | 6-Cl | H | SCF₃ | Cl |
| Me | 6-Me | H | C₂F₅ | Cl | Me | 6-Cl | H | C₂F₅ | Cl |
| Et | 6-Me | H | C₂F₅ | Cl | Et | 6-Cl | H | C₂F₅ | Cl |
| i-Pr | 6-Me | H | C₂F₅ | Cl | i-Pr | 6-Cl | H | C₂F₅ | Cl |
| t-Bu | 6-Me | H | C₂F₅ | Cl | t-Bu | 6-Cl | H | C₂F₅ | Cl |
| Me | 6-Me | H | n-C₃F₇ | Cl | Me | 6-Cl | H | n-C₃F₇ | Cl |
| Et | 6-Me | H | n-C₃F₇ | Cl | Et | 6-Cl | H | n-C₃F₇ | Cl |
| i-Pr | 6-Me | H | n-C₃F₇ | Cl | i-Pr | 6-Cl | H | n-C₃F₇ | Cl |
| t-Bu | 6-Me | H | n-C₃F₇ | Cl | t-Bu | 6-Cl | H | n-C₃F₇ | Cl |
| Me | 6-Me | H | i-C₃F₇ | Cl | Me | 6-Cl | H | i-C₃F₇ | Cl |
| Et | 6-Me | H | i-C₃F₇ | Cl | Et | 6-Cl | H | i-C₃F₇ | Cl |
| i-Pr | 6-Me | H | i-C₃F₇ | Cl | i-Pr | 6-Cl | H | i-C₃F₇ | Cl |
| t-Bu | 6-Me | H | i-C₃F₇ | Cl | t-Bu | 6-Cl | H | i-C₃F₇ | Cl |
| Me | 6-Me | H | CN | Cl | Me | 6-Cl | H | CN | Cl |
| Et | 6-Me | H | CN | Cl | Et | 6-Cl | H | CN | Cl |
| i-Pr | 6-Me | H | CN | Cl | i-Pr | 6-Cl | H | CN | Cl |
| t-Bu | 6-Me | H | CN | Cl | t-Bu | 6-Cl | H | CN | Cl |
| Me | 6-Me | H | OCHF₂ | Br | Me | 6-Cl | H | OCHF₂ | Br |
| Et | 6-Me | H | OCHF₂ | Br | Et | 6-Cl | H | OCHF₂ | Br |
| i-Pr | 6-Me | H | OCHF₂ | Br | i-Pr | 6-Cl | H | OCHF₂ | Br |
| t-Bu | 6-Me | H | OCHF₂ | Br | t-Bu | 6-Cl | H | OCHF₂ | Br |
| Me | 6-Me | H | SCHF₂ | Br | Me | 6-Cl | H | SCHF₂ | Br |
| Et | 6-Me | H | SCHF₂ | Br | Et | 6-Cl | H | SCHF₂ | Br |
| i-Pr | 6-Me | H | SCHF₂ | Br | i-Pr | 6-Cl | H | SCHF₂ | Br |
| t-Bu | 6-Me | H | SCHF₂ | Br | t-Bu | 6-Cl | H | SCHF₂ | Br |
| Me | 6-Me | H | OCF₃ | Br | Me | 6-Cl | H | OCF₃ | Br |
| Et | 6-Me | H | OCF₃ | Br | Et | 6-Cl | H | OCF₃ | Br |
| i-Pr | 6-Me | H | OCF₃ | Br | i-Pr | 6-Cl | H | OCF₃ | Br |
| t-Bu | 6-Me | H | OCF₃ | Br | t-Bu | 6-Cl | H | OCF₃ | Br |
| Me | 6-Me | H | SCF₃ | Br | Me | 6-Cl | H | SCF₃ | Br |
| Et | 6-Me | H | SCF₃ | Br | Et | 6-Cl | H | SCF₃ | Br |
| i-Pr | 6-Me | H | SCF₃ | Br | i-Pr | 6-Cl | H | SCF₃ | Br |
| t-Bu | 6-Me | H | SCF₃ | Br | t-Bu | 6-Cl | H | SCF₃ | Br |
| Me | 6-Me | H | C₂F₅ | Br | Me | 6-Cl | H | C₂F₅ | Br |
| Et | 6-Me | H | C₂F₅ | Br | Et | 6-Cl | H | C₂F₅ | Br |
| i-Pr | 6-Me | H | C₂F₅ | Br | i-Pr | 6-Cl | H | C₂F₅ | Br |
| t-Bu | 6-Me | H | C₂F₅ | Br | t-Bu | 6-Cl | H | C₂F₅ | Br |
| Me | 6-Me | H | n-C₃F₇ | Br | Me | 6-Cl | H | n-C₃F₇ | Br |
| Et | 6-Me | H | n-C₃F₇ | Br | Et | 6-Cl | H | n-C₃F₇ | Br |
| i-Pr | 6-Me | H | n-C₃F₇ | Br | i-Pr | 6-Cl | H | n-C₃F₇ | Br |
| t-Bu | 6-Me | H | n-C₃F₇ | Br | t-Bu | 6-Cl | H | n-C₃F₇ | Br |
| Me | 6-Me | H | i-C₃F₇ | Br | Me | 6-Cl | H | i-C₃F₇ | Br |
| Et | 6-Me | H | i-C₃F₇ | Br | Et | 6-Cl | H | i-C₃F₇ | Br |
| i-Pr | 6-Me | H | i-C₃F₇ | Br | i-Pr | 6-Cl | H | i-C₃F₇ | Br |
| t-Bu | 6-Me | H | i-C₃F₇ | Br | t-Bu | 6-Cl | H | i-C₃F₇ | Br |
| Me | 6-Me | H | CN | Br | Me | 6-Cl | H | CN | Br |
| Et | 6-Me | H | CN | Br | Et | 6-Cl | H | CN | Br |
| i-Pr | 6-Me | H | CN | Br | i-Pr | 6-Cl | H | CN | Br |
| t-Bu | 6-Me | H | CN | Br | t-Bu | 6-Cl | H | CN | Br |
| Me | 6-Me | H | OCHF₂ | CF₃ | Me | 6-Cl | H | OCHF₂ | CF₃ |
| Et | 6-Me | H | OCHF₂ | CF₃ | Et | 6-Cl | H | OCHF₂ | CF₃ |
| i-Pr | 6-Me | H | OCHF₂ | CF₃ | i-Pr | 6-Cl | H | OCHF₂ | CF₃ |
| t-Bu | 6-Me | H | OCHF₂ | CF₃ | t-Bu | 6-Cl | H | OCHF₂ | CF₃ |
| Me | 6-Me | H | SCHF₂ | CF₃ | Me | 6-Cl | H | SCHF₂ | CF₃ |
| Et | 6-Me | H | SCHF₂ | CF₃ | Et | 6-Cl | H | SCHF₂ | CF₃ |
| i-Pr | 6-Me | H | SCHF₂ | CF₃ | i-Pr | 6-Cl | H | SCHF₂ | CF₃ |
| t-Bu | 6-Me | H | SCHF₂ | CF₃ | t-Bu | 6-Cl | H | SCHF₂ | CF₃ |
| Me | 6-Me | H | OCF₃ | CF₃ | Me | 6-Cl | H | OCF₃ | CF₃ |
| Et | 6-Me | H | OCF₃ | CF₃ | Et | 6-Cl | H | OCF₃ | CF₃ |
| i-Pr | 6-Me | H | OCF₃ | CF₃ | i-Pr | 6-Cl | H | OCF₃ | CF₃ |
| t-Bu | 6-Me | H | OCF₃ | CF₃ | t-Bu | 6-Cl | H | OCF₃ | CF₃ |
| Me | 6-Me | H | SCF₃ | CF₃ | Me | 6-Cl | H | SCF₃ | CF₃ |
| Et | 6-Me | H | SCF₃ | CF₃ | Et | 6-Cl | H | SCF₃ | CF₃ |
| i-Pr | 6-Me | H | SCF₃ | CF₃ | i-Pr | 6-Cl | H | SCF₃ | CF₃ |
| t-Bu | 6-Me | H | SCF₃ | CF₃ | t-Bu | 6-Cl | H | SCF₃ | CF₃ |
| Me | 6-Me | H | C₂F₅ | CF₃ | Me | 6-Cl | H | C₂F₅ | CF₃ |
| Et | 6-Me | H | C₂F₅ | CF₃ | Et | 6-Cl | H | C₂F₅ | CF₃ |
| i-Pr | 6-Me | H | C₂F₅ | CF₃ | i-Pr | 6-Cl | H | C₂F₅ | CF₃ |
| t-Bu | 6-Me | H | C₂F₅ | CF₃ | t-Bu | 6-Cl | H | C₂F₅ | CF₃ |
| Me | 6-Me | H | n-C₃F₇ | CF₃ | Me | 6-Cl | H | n-C₃F₇ | CF₃ |
| Et | 6-Me | H | n-C₃F₇ | CF₃ | Et | 6-Cl | H | n-C₃F₇ | CF₃ |
| i-Pr | 6-Me | H | n-C₃F₇ | CF₃ | i-Pr | 6-Cl | H | n-C₃F₇ | CF₃ |
| t-Bu | 6-Me | H | n-C₃F₇ | CF₃ | t-Bu | 6-Cl | H | n-C₃F₇ | CF₃ |
| Me | 6-Me | H | i-C₃F₇ | CF₃ | Me | 6-Cl | H | i-C₃F₇ | CF₃ |
| Et | 6-Me | H | i-C₃F₇ | CF₃ | Et | 6-Cl | H | i-C₃F₇ | CF₃ |
| i-Pr | 6-Me | H | i-C₃F₇ | CF₃ | i-Pr | 6-Cl | H | i-C₃F₇ | CF₃ |
| t-Bu | 6-Me | H | i-C₃F₇ | CF₃ | t-Bu | 6-Cl | H | i-C₃F₇ | CF₃ |
| Me | 6-Me | H | CN | CF₃ | Me | 6-Cl | H | CN | CF₃ |
| Et | 6-Me | H | CN | CF₃ | Et | 6-Cl | H | CN | CF₃ |
| i-Pr | 6-Me | H | CN | CF₃ | i-Pr | 6-Cl | H | CN | CF₃ |
| t-Bu | 6-Me | H | CN | CF₃ | t-Bu | 6-Cl | H | CN | CF₃ |
| Me | 6-Me | Cl | OCHF₂ | F | Me | 6-Cl | Cl | OCHF₂ | F |
| Et | 6-Me | Cl | OCHF₂ | F | Et | 6-Cl | Cl | OCHF₂ | F |
| i-Pr | 6-Me | Cl | OCHF₂ | F | i-Pr | 6-Cl | Cl | OCHF₂ | F |
| t-Bu | 6-Me | Cl | OCHF₂ | F | t-Bu | 6-Cl | Cl | OCHF₂ | F |
| Me | 6-Me | Cl | SCHF₂ | F | Me | 6-Cl | Cl | SCHF₂ | F |
| Et | 6-Me | Cl | SCHF₂ | F | Et | 6-Cl | Cl | SCHF₂ | F |
| i-Pr | 6-Me | Cl | SCHF₂ | F | i-Pr | 6-Cl | Cl | SCHF₂ | F |
| t-Bu | 6-Me | Cl | SCHF₂ | F | t-Bu | 6-Cl | Cl | SCHF₂ | F |
| Me | 6-Me | Cl | OCF₃ | F | Me | 6-Cl | Cl | OCF₃ | F |
| Et | 6-Me | Cl | OCF₃ | F | Et | 6-Cl | Cl | OCF₃ | F |
| i-Pr | 6-Me | Cl | OCF₃ | F | i-Pr | 6-Cl | Cl | OCF₃ | F |
| t-Bu | 6-Me | Cl | OCF₃ | F | t-Bu | 6-Cl | Cl | OCF₃ | F |
| Me | 6-Me | Cl | SCF₃ | F | Me | 6-Cl | Cl | SCF₃ | F |
| Et | 6-Me | Cl | SCF₃ | F | Et | 6-Cl | Cl | SCF₃ | F |
| i-Pr | 6-Me | Cl | SCF₃ | F | i-Pr | 6-Cl | Cl | SCF₃ | F |
| t-Bu | 6-Me | Cl | SCF₃ | F | t-Bu | 6-Cl | Cl | SCF₃ | F |
| Me | 6-Me | Cl | C₂F₅ | F | Me | 6-Cl | Cl | C₂F₅ | F |
| Et | 6-Me | Cl | C₂F₅ | F | Et | 6-Cl | Cl | C₂F₅ | F |
| i-Pr | 6-Me | Cl | C₂F₅ | F | i-Pr | 6-Cl | Cl | C₂F₅ | F |
| t-Bu | 6-Me | Cl | C₂F₅ | F | t-Bu | 6-Cl | Cl | C₂F₅ | F |
| Me | 6-Me | Cl | n-C₃F₇ | F | Me | 6-Cl | Cl | n-C₃F₇ | F |
| Et | 6-Me | Cl | n-C₃F₇ | F | Et | 6-Cl | Cl | n-C₃F₇ | F |
| i-Pr | 6-Me | Cl | n-C₃F₇ | F | i-Pr | 6-Cl | Cl | n-C₃F₇ | F |
| t-Bu | 6-Me | Cl | n-C₃F₇ | F | t-Bu | 6-Cl | Cl | n-C₃F₇ | F |
| Me | 6-Me | Cl | i-C₃F₇ | F | Me | 6-Cl | Cl | i-C₃F₇ | F |
| Et | 6-Me | Cl | i-C₃F₇ | F | Et | 6-Cl | Cl | iC₃F₇ | F |
| i-Pr | 6-Me | Cl | i-C₃F₇ | F | i-pr | 6-Cl | Cl | i-C₃F₇ | F |
| t-Bu | 6-Me | Cl | i-C₃F₇ | F | t-Bu | 6-Cl | Cl | i-C₃F₇ | F |
| Me | 6-Me | Cl | CN | F | Me | 6-Cl | Cl | CN | F |
| Et | 6-Me | Cl | CN | F | Et | 6-Cl | Cl | CN | F |
| i-Pr | 6-Me | Cl | CN | F | i-Pr | 6-Cl | Cl | CN | F |
| t-Bu | 6-Me | Cl | CN | F | t-Bu | 6-Cl | Cl | CN | F |
| Me | 6-Me | Cl | OCHF₂ | Cl | Me | 6-Cl | Cl | OCHF₂ | Cl |
| Et | 6-Me | Cl | OCHF₂ | Cl | Et | 6-Cl | Cl | OCHF₂ | Cl |
| i-Pr | 6-Me | Cl | OCHF₂ | Cl | i-Pr | 6-Cl | Cl | OCHF₂ | Cl |
| t-Bu | 6-Me | Cl | OCHF₂ | Cl | t-Bu | 6-Cl | Cl | OCHF₂ | Cl |
| Me | 6-Me | Cl | SCHF₂ | Cl | Me | 6-Cl | Cl | SCHF₂ | Cl |
| Et | 6-Me | Cl | SCHF₂ | Cl | Et | 6-Cl | Cl | SCHF₂ | Cl |
| i-Pr | 6-Me | Cl | SCHF₂ | Cl | i-Pr | 6-Cl | Cl | SCHF₂ | Cl |
| t-Bu | 6-Me | Cl | SCHF₂ | Cl | t-Bu | 6-Cl | Cl | SCHF₂ | Cl |
| Me | 6-Me | Cl | OCF₃ | Cl | Me | 6-Cl | Cl | OCF₃ | Cl |
| Et | 6-Me | Cl | OCF₃ | Cl | Et | 6-Cl | Cl | OCF₃ | Cl |
| i-Pr | 6-Me | Cl | OCF₃ | Cl | i-Pr | 6-Cl | Cl | OCF₃ | Cl |
| t-Bu | 6-Me | Cl | OCF₃ | Cl | t-Bu | 6-Cl | Cl | OCF₃ | Cl |
| Me | 6-Me | Cl | SCF₃ | Cl | Me | 6-Cl | Cl | SCF₃ | Cl |
| Et | 6-Me | Cl | SCF₃ | Cl | Et | 6-Cl | Cl | SCF₃ | Cl |
| i-Pr | 6-Me | Cl | SCF₃ | Cl | i-Pr | 6-Cl | Cl | SCF₃ | Cl |
| t-Bu | 6-Me | Cl | SCF₃ | Cl | t-Bu | 6-Cl | Cl | SCF₃ | Cl |
| Me | 6-Me | Cl | C₂F₅ | Cl | Me | 6-Cl | Cl | C₂F₅ | Cl |
| Et | 6-Me | Cl | C₂F₅ | Cl | Et | 6-Cl | Cl | C₂F₅ | Cl |
| i-Pr | 6-Me | Cl | C₂F₅ | Cl | i-Pr | 6-Cl | Cl | C₂F₅ | Cl |
| t-Bu | 6-Me | Cl | C₂F₅ | Cl | t-Bu | 6-Cl | Cl | C₂F₅ | Cl |
| Me | 6-Me | Cl | n-C₃F₇ | Cl | Me | 6-Cl | Cl | n-C₃F₇ | Cl |
| Et | 6-Me | Cl | n-C₃F₇ | Cl | Et | 6-Cl | Cl | n-C₃F₇ | Cl |
| i-Pr | 6-Me | Cl | n-C₃F₇ | Cl | i-Pr | 6-Cl | Cl | n-C₃F₇ | Cl |
| t-Bu | 6-Me | Cl | n-C₃F₇ | Cl | t-Bu | 6-Cl | Cl | n-C₃F₇ | Cl |
| Me | 6-Me | Cl | i-C₃F₇ | Cl | Me | 6-Cl | Cl | i-C₃F₇ | Cl |
| Et | 6-Me | Cl | i-C₃F₇ | Cl | Et | 6-Cl | Cl | i-C₃F₇ | Cl |
| i-Pr | 6-Me | Cl | i-C₃F₇ | Cl | i-Pr | 6-Cl | Cl | i-C₃F₇ | Cl |
| t-Bu | 6-Me | Cl | i-C₃F₇ | Cl | t-Bu | 6-Cl | Cl | i-C₃F₇ | Cl |
| Me | 6-Me | Cl | CN | Cl | Me | 6-Cl | Cl | CN | Cl |
| Et | 6-Me | Cl | CN | Cl | Et | 6-Cl | Cl | CN | Cl |
| i-Pr | 6-Me | Cl | CN | Cl | i-Pr | 6-Cl | Cl | CN | Cl |
| t-Bu | 6-Me | Cl | CN | Cl | t-Bu | 6-Cl | Cl | CN | Cl |
| Me | 6-Me | Cl | OCHF₂ | Br | Me | 6-Cl | Cl | OCHF₂ | Br |
| Et | 6-Me | Cl | OCHF₂ | Br | Et | 6-Cl | Cl | OCHF₂ | Br |
| i-Pr | 6-Me | Cl | OCHF₂ | Br | i-Pr | 6-Cl | Cl | OCHF₂ | Br |
| t-Bu | 6-Me | Cl | OCHF₂ | Br | t-Bu | 6-Cl | Cl | OCHF₂ | Br |
| Me | 6-Me | Cl | SCHF₂ | Br | Me | 6-Cl | Cl | SCHF₂ | Br |
| Et | 6-Me | Cl | SCHF₂ | Br | Et | 6-Cl | Cl | SCHF₂ | Br |
| i-Pr | 6-Me | Cl | SCHF₂ | Br | i-Pr | 6-Cl | Cl | SCHF₂ | Br |
| t-Bu | 6-Me | Cl | SCHF₂ | Br | t-Bu | 6-Cl | Cl | SCHF₂ | Br |
| Me | 6-Me | Cl | OCF₃ | Br | Me | 6-Cl | Cl | OCF₃ | Br |
| Et | 6-Me | Cl | OCF₃ | Br | Et | 6-Cl | Cl | OCF₃ | Br |
| i-Pr | 6-Me | Cl | OCF₃ | Br | i-Pr | 6-Cl | Cl | OCF₃ | Br |
| t-Bu | 6-Me | Cl | OCF₃ | Br | t-Bu | 6-Cl | Cl | OCF₃ | Br |
| Me | 6-Me | Cl | SCF₃ | Br | Me | 6-Cl | Cl | SCF₃ | Br |
| Et | 6-Me | Cl | SCF₃ | Br | Et | 6-Cl | Cl | SCF₃ | Br |
| i-Pr | 6-Me | Cl | SCF₃ | Br | i-Pr | 6-Cl | Cl | SCF₃ | Br |
| t-Bu | 6-Me | Cl | SCF₃ | Br | t-Bu | 6-Cl | Cl | SCF₃ | Br |
| Me | 6-Me | Cl | C₂F₅ | Br | Me | 6-Cl | Cl | C₂F₅ | Br |
| Et | 6-Me | Cl | C₂F₅ | Br | Et | 6-Cl | Cl | C₂F₅ | Br |
| i-Pr | 6-Me | Cl | C₂F₅ | Br | i-Pr | 6-Cl | Cl | C₂F₅ | Br |
| t-Bu | 6-Me | Cl | C₂F₅ | Br | t-Bu | 6-Cl | Cl | C₂F₅ | Br |
| Me | 6-Me | Cl | n-C₃F₇ | Br | Me | 6-Cl | Cl | n-C₃F₇ | Br |
| Et | 6-Me | Cl | n-C₃F₇ | Br | Et | 6-Cl | Cl | n-C₃F₇ | Br |
| i-Pr | 6-Me | Cl | n-C₃F₇ | Br | i-Pr | 6-Cl | Cl | n-C₃F₇ | Br |
| t-Bu | 6-Me | Cl | n-C₃F₇ | Br | t-Bu | 6-Cl | Cl | n-C₃F₇ | Br |
| Me | 6-Me | Cl | i-C₃F₇ | Br | Me | 6-Cl | Cl | i-C₃F₇ | Br |
| Et | 6-Me | Cl | i-C₃F₇ | Br | Et | 6-Cl | Cl | i-C₃F₇ | Br |
| i-Pr | 6-Me | Cl | i-C₃F₇ | Br | i-Pr | 6-Cl | Cl | i-C₃F₇ | Br |
| t-Bu | 6-Me | Cl | i-C₃F₇ | Br | t-Bu | 6-Cl | Cl | i-C₃F₇ | Br |
| Me | 6-Me | Cl | CN | Br | Me | 6-Cl | Cl | CN | Br |
| Et | 6-Me | Cl | CN | Br | Et | 6-Cl | Cl | CN | Br |
| i-Pr | 6-Me | Cl | CN | Br | i-Pr | 6-Cl | Cl | CN | Br |
| t-Bu | 6-Me | Cl | CN | Br | t-Bu | 6-Cl | Cl | CN | Br |
| Me | 6-Me | Cl | OCHF₂ | CF₃ | Me | 6-Cl | Cl | OCHF₂ | CF₃ |
| Et | 6-Me | Cl | OCHF₂ | CF₃ | Et | 6-Cl | Cl | OCHF₂ | CF₃ |
| i-Pr | 6-Me | Cl | OCHF₂ | CF₃ | i-Pr | 6-Cl | Cl | OCHF₂ | CF₃ |
| t-Bu | 6-Me | Cl | OCHF₂ | CF₃ | t-Bu | 6-Cl | Cl | OCHF₂ | CF₃ |
| Me | 6-Me | Cl | SCHF₂ | CF₃ | Me | 6-Cl | Cl | SCHF₂ | CF₃ |
| Et | 6-Me | Cl | SCHF₂ | CF₃ | Et | 6-Cl | Cl | SCHF₂ | CF₃ |
| i-Pr | 6-Me | Cl | SCHF₂ | CF₃ | i-Pr | 6-Cl | Cl | SCHF₂ | CF₃ |
| t-Bu | 6-Me | Cl | SCHF₂ | CF₃ | t-Bu | 6-Cl | Cl | SCHF₂ | CF₃ |
| Me | 6-Me | Cl | OCF₃ | CF₃ | Me | 6-Cl | Cl | OCF₃ | CF₃ |
| Et | 6-Me | Cl | OCF₃ | CF₃ | Et | 6-Cl | Cl | OCF₃ | CF₃ |
| i-Pr | 6-Me | Cl | OCF₃ | CF₃ | i-Pr | 6-Cl | Cl | OCF₃ | CF₃ |
| t-Bu | 6-Me | Cl | OCF₃ | CF₃ | t-Bu | 6-Cl | Cl | OCF₃ | CF₃ |
| Me | 6-Me | Cl | SCF₃ | CF₃ | Me | 6-Cl | Cl | SCF₃ | CF₃ |
| Et | 6-Me | Cl | SCF₃ | CF₃ | Et | 6-Cl | Cl | SCF₃ | CF₃ |
| i-Pr | 6-Me | Cl | SCF₃ | CF₃ | i-Pr | 6-Cl | Cl | SCF₃ | CF₃ |
| t-Bu | 6-Me | Cl | SCF₃ | CF₃ | t-Bu | 6-Cl | Cl | SCF₃ | CF₃ |
| Me | 6-Me | Cl | C₂F₅ | CF₃ | Me | 6-Cl | Cl | C₂F₅ | CF₃ |
| Et | 6-Me | Cl | C₂F₅ | CF₃ | Et | 6-Cl | Cl | C₂F₅ | CF₃ |
| i-Pr | 6-Me | Cl | C₂F₅ | CF₃ | i-Pr | 6-Cl | Cl | C₂F₅ | CF₃ |
| t-Bu | 6-Me | Cl | C₂F₅ | CF₃ | t-Bu | 6-Cl | Cl | C₂F₅ | CF₃ |
| Me | 6-Me | Cl | n-C₃F₇ | CF₃ | Me | 6-Cl | Cl | n-C₃F₇ | CF₃ |
| Et | 6-Me | Cl | n-C₃F₇ | CF₃ | Et | 6-Cl | Cl | n-C₃F₇ | CF₃ |
| i-Pr | 6-Me | Cl | n-C₃F₇ | CF₃ | i-Pr | 6-Cl | Cl | n-C₃F₇ | CF₃ |
| t-Bu | 6-Me | Cl | n-C₃F7 | CF₃ | t-Bu | 6-Cl | Cl | n-C₃F7 | CF₃ |
| Me | 6-Me | Cl | i-C₃F₇ | CF₃ | Me | 6-Cl | Cl | i-C₃F₇ | CF₃ |
| Et | 6-Me | Cl | i-C₃F7 | CF₃ | Et | 6-Cl | Cl | iC₃F₇ | CF₃ |
| i-Pr | 6-Me | Cl | i-C₃F7 | CF₃ | i-Pr | 6-Cl | Cl | i-C₃F7 | CF₃ |
| t-Bu | 6-Me | Cl | i-C₃F₇ | CF₃ | t-Bu | 6-Cl | Cl | i-C₃F₇ | CF₃ |
| Me | 6-Me | Cl | CN | CF₃ | Me | 6-Cl | Cl | CN | CF₃ |
| Et | 6-Me | Cl | CN | CF₃ | Et | 6-Cl | Cl | CN | CF₃ |
| i-Pr | 6-Me | Cl | CN | CF₃ | i-Pr | 6-Cl | Cl | CN | CF₃ |
| t-Bu | 6-Me | Cl | CN | CF₃ | t-Bu | 6-Cl | Cl | CN | CF₃ |

TABLE 3

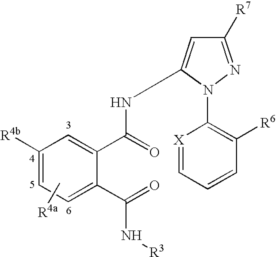

| R³ | R^{4a} | R^{4b} | R⁷ | R⁶ | X | R³ | R^{4a} | R^{4b} | R⁷ | R⁶ | X |
|---|---|---|---|---|---|---|---|---|---|---|---|
| Me | 6-Me | H | OCHF₂ | F | CH | Me | 6-Cl | H | OCHF₂ | F | CH |
| Et | 6-Me | H | OCHF₂ | F | CH | Et | 6-Cl | H | OCHF₂ | F | CH |
| i-Pr | 6-Me | H | OCHF₂ | F | CH | i-Pr | 6-Cl | H | OCHF₂ | F | CH |
| t-Bu | 6-Me | H | OCHF₂ | F | CH | t-Bu | 6-Cl | H | OCHF₂ | F | CH |
| Me | 6-Me | H | SCHF₂ | F | CH | Me | 6-Cl | H | SCHF₂ | F | CH |
| Et | 6-Me | H | SCHF₂ | F | CH | Et | 6-Cl | H | SCHF₂ | F | CH |
| i-Pr | 6-Me | H | SCHF₂ | F | CH | i-Pr | 6-Cl | H | SCHF₂ | F | CH |
| t-Bu | 6-Me | H | SCHF₂ | F | CH | t-Bu | 6-Cl | H | SCHF₂ | F | CH |
| Me | 6-Me | H | OCF₃ | F | CH | Me | 6-Cl | H | OCF₃ | F | CH |
| Et | 6-Me | H | OCF₃ | F | CH | Et | 6-Cl | H | OCF₃ | F | CH |
| i-Pr | 6-Me | H | OCF₃ | F | CH | i-Pr | 6-Cl | H | OCF₃ | F | CH |
| t-Bu | 6-Me | H | OCF₃ | F | CH | t-Bu | 6-Cl | H | OCF₃ | F | CH |
| Me | 6-Me | H | SCF₃ | F | CH | Me | 6-Cl | H | SCF₃ | F | CH |
| Et | 6-Me | H | SCF₃ | F | CH | Et | 6-Cl | H | SCF₃ | F | CH |
| i-Pr | 6-Me | H | SCF₃ | F | CH | i-Pr | 6-Cl | H | SCF₃ | F | CH |
| t-Bu | 6-Me | H | SCF₃ | F | CH | t-Bu | 6-Cl | H | SCF₃ | F | CH |
| Me | 6-Me | H | C₂F₅ | F | CH | Me | 6-Cl | H | C₂F₅ | F | CH |
| Et | 6-Me | H | C₂F₅ | F | CH | Et | 6-Cl | H | C₂F₅ | F | CH |
| i-Pr | 6-Me | H | C₂F₅ | F | CH | i-Pr | 6-Cl | H | C₂F₅ | F | CH |
| t-Bu | 6-Me | H | C₂F₅ | F | CH | t-Bu | 6-Cl | H | C₂F₅ | F | CH |
| Me | 6-Me | H | n-C₃F₇ | F | CH | Me | 6-Cl | H | n-C₃F₇ | F | CH |
| Et | 6-Me | H | n-C₃F₇ | F | CH | Et | 6-Cl | H | n-C₃F₇ | F | CH |
| i-Pr | 6-Me | H | n-C₃F₇ | F | CH | i-Pr | 6-Cl | H | n-C₃F₇ | F | CH |
| t-Bu | 6-Me | H | n-C₃F₇ | F | CH | t-Bu | 6-Cl | H | n-C₃F₇ | F | CH |
| Me | 6-Me | H | i-C₃F₇ | F | CH | Me | 6-Cl | H | i-C₃F₇ | F | CH |
| Et | 6-Me | H | i-C₃F₇ | F | CH | Et | 6-Cl | H | i-C₃F₇ | F | CR |
| i-Pr | 6-Me | H | i-C₃F₇ | F | CH | i-Pr | 6-Cl | H | i-C₃F₇ | F | CH |
| t-Bu | 6-Me | H | i-C₃F₇ | F | CH | t-Bu | 6-Cl | H | i-C₃F₇ | F | CH |
| Me | 6-Me | H | CN | F | CH | Me | 6-Cl | H | CN | F | CR |
| Et | 6-Me | H | CN | F | CH | Et | 6-Cl | H | CN | F | CR |
| i-Pr | 6-Me | H | CN | F | CH | i-Pr | 6-Cl | H | CN | F | CH |
| t-Bu | 6-Me | H | CN | F | CH | t-Bu | 6-Cl | H | CN | F | CR |
| Me | 6-Me | H | OCHF₂ | Cl | CH | Me | 6-Cl | H | OCHF₂ | Cl | CH |
| Et | 6-Me | H | OCHF₂ | Cl | CH | Et | 6-Cl | H | OCHF₂ | Cl | CH |
| i-Pr | 6-Me | H | OCHF₂ | Cl | CH | i-Pr | 6-Cl | H | OCHF₂ | Cl | CH |
| t-Bu | 6-Me | H | OCHF₂ | Cl | CH | t-Bu | 6-Cl | H | OCHF₂ | Cl | CH |
| Me | 6-Me | H | SCHF₂ | Cl | CH | Me | 6-Cl | H | SCHF₂ | Cl | CH |
| Et | 6-Me | H | SCHF₂ | Cl | CH | Et | 6-Cl | H | SCHF₂ | Cl | CH |
| i-Pr | 6-Me | H | SCHF₂ | Cl | CH | i-Pr | 6-Cl | H | SCHF₂ | Cl | CH |
| t-Bu | 6-Me | H | SCHF₂ | Cl | CH | t-Bu | 6-Cl | H | SCHF₂ | Cl | CH |
| Me | 6-Me | H | OCF₃ | Cl | CH | Me | 6-Cl | H | OCF₃ | Cl | CH |
| Et | 6-Me | H | OCF₃ | Cl | CH | Et | 6-Cl | H | OCF₃ | Cl | CH |
| i-Pr | 6-Me | H | OCF₃ | Cl | CH | i-Pr | 6-Cl | H | OCF₃ | Cl | CH |
| t-Bu | 6-Me | H | OCF₃ | Cl | CH | t-Bu | 6-Cl | H | OCF₃ | Cl | CH |
| Me | 6-Me | H | SCF₃ | Cl | CH | Me | 6-Cl | H | SCF₃ | Cl | CH |
| Et | 6-Me | H | SCF₃ | Cl | CH | Et | 6-Cl | H | SCF₃ | Cl | CH |
| i-Pr | 6-Me | H | SCF₃ | Cl | CH | i-Pr | 6-Cl | H | SCF₃ | Cl | CH |
| t-Bu | 6-Me | H | SCF₃ | Cl | CH | t-Bu | 6-Cl | H | SCF₃ | Cl | CH |
| Me | 6-Me | H | C₂F₅ | Cl | CH | Me | 6-Cl | H | C₂F₅ | Cl | CH |
| Et | 6-Me | H | C₂F₅ | Cl | CH | Et | 6-Cl | H | C₂F₅ | Cl | CH |
| i-Pr | 6-Me | H | C₂F₅ | Cl | CH | i-Pr | 6-Cl | H | C₂F₅ | Cl | CH |
| t-Bu | 6-Me | H | C₂F₅ | Cl | CH | t-Bu | 6-Cl | H | C₂F₅ | Cl | CH |
| Me | 6-Me | H | n-C₃F₇ | Cl | CH | Me | 6-Cl | H | n-C₃F₇ | Cl | CH |
| Et | 6-Me | H | n-C₃F₇ | Cl | CH | Et | 6-Cl | H | n-C₃F₇ | Cl | CH |
| i-Pr | 6-Me | H | n-C₃F₇ | Cl | CH | i-Pr | 6-Cl | H | n-C₃F₇ | Cl | CH |
| t-Bu | 6-Me | H | n-C₃F₇ | Cl | CH | t-Bu | 6-Cl | H | n-C₃F₇ | Cl | CH |
| Me | 6-Me | H | i-C₃F₇ | Cl | CH | Me | 6-Cl | H | i-C₃F₇ | Cl | CH |
| Et | 6-Me | H | i-C₃F₇ | Cl | CH | Et | 6-Cl | H | i-C₃F₇ | Cl | CH |
| i-Pr | 6-Me | H | i-C₃F₇ | Cl | CH | i-Pr | 6-Cl | H | i-C₃F₇ | Cl | CH |
| t-Bu | 6-Me | H | i-C₃F₇ | Cl | CH | t-Bu | 6-Cl | H | i-C₃F₇ | Cl | CH |
| Me | 6-Me | H | CN | Cl | CH | Me | 6-Cl | H | CH | Cl | CH |
| Et | 6-Me | H | CH | Cl | CH | Et | 6-Cl | H | CH | Cl | CH |
| i-Pr | 6-Me | H | CN | Cl | CH | i-Pr | 6-Cl | H | CN | Cl | CH |
| t-Bu | 6-Me | H | CN | Cl | CH | t-Bu | 6-Cl | H | CN | Cl | CH |
| Me | 6-Me | H | OCHF₂ | Br | CH | Me | 6-Cl | H | OCHF₂ | Br | CH |
| Et | 6-Me | H | OCHF₂ | Br | CH | Et | 6-Cl | H | OCHF₂ | Br | CH |
| i-Pr | 6-Me | H | OCHF₂ | Br | CH | i-Pr | 6-Cl | H | OCHF₂ | Br | CH |
| t-Bu | 6-Me | H | OCHF₂ | Br | CH | t-Bu | 6-Cl | H | OCHF₂ | Br | CH |
| Me | 6-Me | H | SCHF₂ | Br | CH | Me | 6-Cl | H | SCHF₂ | Br | CH |
| Et | 6-Me | H | SCHF₂ | Br | CH | Et | 6-Cl | H | SCHF₂ | Br | CH |
| i-Pr | 6-Me | H | SCHF₂ | Br | CH | i-Pr | 6-Cl | H | SCHF₂ | Br | CH |
| t-Bu | 6-Me | H | SCHF₂ | Br | CH | t-Bu | 6-Cl | H | SCHF₂ | Br | CH |
| Me | 6-Me | H | OCF₃ | Br | CH | Me | 6-Cl | H | OCF₃ | Br | CH |
| Et | 6-Me | H | OCF₃ | Br | CH | Et | 6-Cl | H | OCF₃ | Br | CH |
| i-Pr | 6-Me | H | OCF₃ | Br | CH | i-Pr | 6-Cl | H | OCF₃ | Br | CH |
| t-Bu | 6-Me | H | OCF₃ | Br | CH | t-Bu | 6-Cl | H | OCF₃ | Br | CH |
| Me | 6-Me | H | SCF₃ | Br | CH | Me | 6-Cl | H | SCF₃ | Br | CH |
| Et | 6-Me | H | SCF₃ | Br | CH | Et | 6-Cl | H | SCF₃ | Br | CH |
| i-Pr | 6-Me | H | SCF₃ | Br | CH | i-Pr | 6-Cl | H | SCF₃ | Br | CH |
| t-Bu | 6-Me | H | SCF₃ | Br | CH | t-Bu | 6-Cl | H | SCF₃ | Br | CH |
| Me | 6-Me | H | C₂F₅ | Br | CH | Me | 6-Cl | H | C₂F₅ | Br | CH |
| Et | 6-Me | H | C₂F₅ | Br | CH | Et | 6-Cl | H | C₂F₅ | Br | CH |
| i-Pr | 6-Me | H | C₂F₅ | Br | CH | i-Pr | 6-Cl | H | C₂F₅ | Br | CH |
| t-Bu | 6-Me | H | C₂F₅ | Br | CH | t-Bu | 6-Cl | H | C₂F₅ | Br | CH |
| Me | 6-Me | H | n-C₃F₇ | Br | CH | Me | 6-Cl | H | n-C₃F₇ | Br | CH |
| Et | 6-Me | H | n-C₃F₇ | Br | CH | Et | 6-Cl | H | n-C₃F₇ | Br | CH |
| i-Pr | 6-Me | H | n-C₃F₇ | Br | CH | i-Pr | 6-Cl | H | n-C₃F₇ | Br | CH |
| t-Bu | 6-Me | H | n-C₃F₇ | Br | CH | t-Bu | 6-Cl | H | n-C₃F₇ | Br | CH |
| Me | 6-Me | H | i-C₃F₇ | Br | CH | Me | 6-Cl | H | i-C₃F₇ | Br | CH |
| Et | 6-Me | H | i-C₃F₇ | Br | CH | Et | 6-Cl | H | i-C₃F₇ | Br | CH |
| i-Pr | 6-Me | H | i-C₃F₇ | Br | CH | i-Pr | 6-Cl | H | i-C₃F₇ | Br | CH |
| t-Bu | 6-Me | H | i-C₃F₇ | Br | CH | t-Bu | 6-Cl | H | i-C₃F₇ | Br | CH |
| Me | 6-Me | H | CN | Br | CH | Me | 6-Cl | H | CN | Br | CH |
| Et | 6-Me | H | CN | Br | CH | Et | 6-Cl | H | CN | Br | CH |
| i-Pr | 6-Me | H | CN | Br | CH | i-Pr | 6-Cl | H | CN | Br | CH |
| t-Bu | 6-Me | H | CN | Br | CH | t-Bu | 6-Cl | H | CN | Br | CH |
| Me | 6-Me | H | OCHF₂ | CF₃ | CH | Me | 6-Cl | H | OCHF₂ | CF₃ | CH |
| Et | 6-Me | H | OCHF₂ | CF₃ | CH | Et | 6-Cl | H | OCHF₂ | CF₃ | CH |
| i-Pr | 6-Me | H | OCHF₂ | CF₃ | CH | i-Pr | 6-Cl | H | OCHF₂ | CF₃ | CH |
| t-Bu | 6-Me | H | OCHF₂ | CF₃ | CH | t-Bu | 6-Cl | H | OCHF₂ | CF₃ | CH |
| Me | 6-Me | H | SCHF₂ | CF₃ | CH | Me | 6-Cl | H | SCHF₂ | CF₃ | CH |
| Et | 6-Me | H | SCHF₂ | CF₃ | CH | Et | 6-Cl | H | SCHF₂ | CF₃ | CH |
| i-Pr | 6-Me | H | SCHF₂ | CF₃ | CH | i-Pr | 6-Cl | H | SCHF₂ | CF₃ | CH |
| t-Bu | 6-Me | H | SCHF₂ | CF₃ | CH | t-Bu | 6-Cl | H | SCHF₂ | CF₃ | CH |
| Me | 6-Me | H | OCF₃ | CF₃ | CH | Me | 6-Cl | H | OCF₃ | CF₃ | CH |
| Et | 6-Me | H | OCF₃ | CF₃ | CH | Et | 6-Cl | H | OCF₃ | CF₃ | CH |
| i-Pr | 6-Me | H | OCF₃ | CF₃ | CH | i-Pr | 6-Cl | H | OCF₃ | CF₃ | CH |
| t-Bu | 6-Me | H | OCF₃ | CF₃ | CH | t-Bu | 6-Cl | H | OCF₃ | CF₃ | CH |
| Me | 6-Me | H | SCF₃ | CF₃ | CH | Me | 6-Cl | H | SCF₃ | CF₃ | CH |
| Et | 6-Me | H | SCF₃ | CF₃ | CH | Et | 6-Cl | H | SCF₃ | CF₃ | CH |
| i-Pr | 6-Me | H | SCF₃ | CF₃ | CH | i-Pr | 6-Cl | H | SCF₃ | CF₃ | CH |
| t-Bu | 6-Me | H | SCF₃ | CF₃ | CH | t-Bu | 6-Cl | H | SCF₃ | CF₃ | CH |
| Me | 6-Me | H | C₂F₅ | CF₃ | CH | Me | 6-Cl | H | C₂F₅ | CF₃ | CH |
| Et | 6-Me | H | C₂F₅ | CF₃ | CH | Et | 6-Cl | H | C₂F₅ | CF₃ | CH |
| i-Pr | 6-Me | H | C₂F₅ | CF₃ | CH | i-Pr | 6-Cl | H | C₂F₅ | CF₃ | CH |
| t-Bu | 6-Me | H | C₂F₅ | CF₃ | CH | t-Bu | 6-Cl | H | C₂F₅ | CF₃ | CH |
| Me | 6-Me | H | n-C₃F₇ | CF₃ | CH | Me | 6-Cl | H | n-C₃F₇ | CF₃ | CH |
| Et | 6-Me | H | n-C₃F₇ | CF₃ | CH | Et | 6-Cl | H | n-C₃F₇ | CF₃ | CH |
| i-Pr | 6-Me | H | n-C₃F₇ | CF₃ | CH | i-Pr | 6-Cl | H | n-C₃F₇ | CF₃ | CH |
| t-Bu | 6-Me | H | n-C₃F₇ | CF₃ | CH | t-Bu | 6-Cl | H | n-C₃F₇ | CF₃ | CH |
| Me | 6-Me | H | i-C₃F₇ | CF₃ | CH | Me | 6-Cl | H | i-C₃F₇ | CF₃ | CH |
| Et | 6-Me | H | i-C₃F₇ | CF₃ | CH | Et | 6-Cl | H | i-C₃F₇ | CF₃ | CH |
| i-Pr | 6-Me | H | i-C₃F₇ | CF₃ | CH | i-Pr | 6-Cl | H | i-C₃F₇ | CF₃ | CH |
| t-Bu | 6-Me | H | i-C₃F₇ | CF₃ | CH | t-Bu | 6-Cl | H | i-C₃F₇ | CF₃ | CH |
| Me | 6-Me | H | CN | CF₃ | CH | Me | 6-Cl | H | CN | CF₃ | CH |
| Et | 6-Me | H | CN | CF₃ | CH | Et | 6-Cl | H | CN | CF₃ | CH |
| i-Pr | 6-Me | H | CN | CF₃ | CH | i-Pr | 6-Cl | H | CN | CF₃ | CH |
| t-Bu | 6-Me | H | CN | CF₃ | CH | t-Bu | 6-Cl | H | CN | CF₃ | CH |
| Me | 6-Me | Cl | OCHF₂ | F | CH | Me | 6-Cl | Cl | OCHF₂ | F | CH |
| Et | 6-Me | Cl | OCHF₂ | F | CH | Et | 6-Cl | Cl | OCHF₂ | F | CH |
| i-Pr | 6-Me | Cl | OCHF₂ | F | CH | i-Pr | 6-Cl | Cl | OCHF₂ | F | CH |
| t-Bu | 6-Me | Cl | OCHF₂ | F | CH | t-Bu | 6-Cl | Cl | OCHF₂ | F | CH |
| Me | 6-Me | Cl | SCHF₂ | F | CH | Me | 6-Cl | Cl | SCHF₂ | F | CH |
| Et | 6-Me | Cl | SCHF₂ | F | CH | Et | 6-Cl | Cl | SCHF₂ | F | CH |
| i-Pr | 6-Me | Cl | SCHF₂ | F | CH | i-Pr | 6-Cl | Cl | SCHF₂ | F | CH |
| t-Bu | 6-Me | Cl | SCHF₂ | F | CH | t-Bu | 6-Cl | Cl | SCHF₂ | F | CH |
| Me | 6-Me | Cl | OCF₃ | F | CH | Me | 6-Cl | Cl | OCF₃ | F | CH |
| Et | 6-Me | Cl | OCF₃ | F | CH | Et | 6-Cl | Cl | OCF₃ | F | CH |
| i-Pr | 6-Me | Cl | OCF₃ | F | CH | i-Pr | 6-Cl | Cl | OCF₃ | F | CH |
| t-Bu | 6-Me | Cl | OCF₃ | F | CH | t-Bu | 6-Cl | Cl | OCF₃ | F | CH |
| Me | 6-Me | Cl | SCF₃ | F | CH | Me | 6-Cl | Cl | SCF₃ | F | CH |
| Et | 6-Me | Cl | SCF₃ | F | CH | Et | 6-Cl | Cl | SCF₃ | F | CH |
| i-Pr | 6-Me | Cl | SCF₃ | F | CH | i-Pr | 6-Cl | Cl | SCF₃ | F | CH |
| t-Bu | 6-Me | Cl | SCF₃ | F | CH | t-Bu | 6-Cl | Cl | SCF₃ | F | CH |
| Me | 6-Me | Cl | C₂F₅ | F | CH | Me | 6-Cl | Cl | C₂F₅ | F | CH |
| Et | 6-Me | Cl | C₂F₅ | F | CH | Et | 6-Cl | Cl | C₂F₅ | F | CH |
| i-Pr | 6-Me | Cl | C₂F₅ | F | CH | i-Pr | 6-Cl | Cl | C₂F₅ | F | CH |
| t-Bu | 6-Me | Cl | C₂F₅ | F | CH | t-Bu | 6-Cl | Cl | C₂F₅ | F | CH |
| Me | 6-Me | Cl | n-C₃F₂ | F | CH | Me | 6-Cl | Cl | n-C₃F₇ | F | CH |
| Et | 6-Me | Cl | n-C₃F₇ | F | CH | Et | 6-Cl | Cl | n-C₃F₇ | F | CH |
| i-Pr | 6-Me | Cl | n-C₃F₇ | F | CH | i-Pr | 6-Cl | Cl | n-C₃F₇ | F | CH |
| t-Bu | 6-Me | Cl | n-C₃F₇ | F | CH | t-Bu | 6-Cl | Cl | n-C₃F₇ | F | CH |
| Me | 6-Me | Cl | i-C₃F₇ | F | CH | Me | 6-Cl | Cl | i-C₃F₇ | F | CH |
| Et | 6-Me | Cl | i-C₃F₇ | F | CH | Et | 6-Cl | Cl | i-C₃F₇ | F | CH |
| i-Pr | 6-Me | Cl | i-C₃F₇ | F | CH | i-Pr | 6-Cl | Cl | i-C₃F₇ | F | CH |
| t-Bu | 6-Me | Cl | i-C₃F₇ | F | CH | t-Bu | 6-Cl | Cl | i-C₃F₂ | F | CH |
| Me | 6-Me | Cl | CN | F | CH | Me | 6-Cl | Cl | CN | F | CH |
| Et | 6-Me | Cl | CN | F | CH | Et | 6-Cl | Cl | CN | F | CH |
| i-Pr | 6-Me | Cl | CN | F | CH | i-Pr | 6-Cl | Cl | CN | F | CH |
| t-Bu | 6-Me | Cl | CN | F | CH | t-Bu | 6-Cl | Cl | CN | F | CH |
| Me | 6-Me | Cl | OCHF₂ | Cl | CH | Me | 6-Cl | Cl | OCHF₂ | Cl | CH |
| Et | 6-Me | Cl | OCHF₂ | Cl | CH | Et | 6-Cl | Cl | OCHF₂ | Cl | CH |
| i-Pr | 6-Me | Cl | OCHF₂ | Cl | CH | i-Pr | 6-Cl | Cl | OCHF₂ | Cl | CH |
| t-Bu | 6-Me | Cl | OCHF₂ | Cl | CH | t-Bu | 6-Cl | Cl | OCHF₂ | Cl | CH |
| Me | 6-Me | Cl | SCHF₂ | Cl | CH | Me | 6-Cl | Cl | SCHF₂ | Cl | CH |
| Et | 6-Me | Cl | SCHF₂ | Cl | CH | Et | 6-Cl | Cl | SCHF₂ | Cl | CH |
| i-Pr | 6-Me | Cl | SCHF₂ | Cl | CH | i-Pr | 6-Cl | Cl | SCHF₂ | Cl | CH |
| t-Bu | 6-Me | Cl | SCHF₂ | Ci | CH | t-Bu | 6-Cl | Cl | SCHF₂ | Cl | CH |
| Me | 6-Me | Cl | OCF₃ | Cl | CH | Me | 6-Cl | Cl | OCF₃ | Cl | CH |
| Et | 6-Me | Cl | OCF₃ | Cl | CH | Et | 6-Cl | Cl | OCF₃ | Cl | CH |
| i-Pr | 6-Me | Cl | OCF₃ | Cl | CH | i-Pr | 6-Cl | Cl | OCF₃ | Cl | CH |
| t-Bu | 6-Me | Cl | OCF₃ | Cl | CH | t-Bu | 6-Cl | Cl | OCF₃ | Cl | CH |
| Me | 6-Me | Cl | SCF₃ | Cl | CH | Me | 6-Cl | Cl | SCF₃ | Cl | CH |
| Et | 6-Me | Cl | SCF₃ | Cl | CH | Et | 6-Cl | Cl | SCF₃ | Cl | CH |
| i-Pr | 6-Me | Cl | SCF₃ | Cl | CH | i-Pr | 6-Cl | Cl | SCF₃ | Cl | CH |
| t-Bu | 6-Me | Cl | SCF₃ | Cl | CH | t-Bu | 6-Cl | Cl | SCF₃ | Cl | CH |
| Me | 6-Me | Cl | C₂F₅ | Cl | CH | Me | 6-Cl | Cl | C₂F₅ | Cl | CH |
| Et | 6-Me | Cl | C₂F₅ | Cl | CH | Et | 6-Cl | Cl | C₂F₅ | Cl | CH |
| i-Pr | 6-Me | Cl | C₂F₅ | Cl | CH | i-Pr | 6-Cl | Cl | C₂F₅ | Cl | CH |
| t-Bu | 6-Me | Cl | C₂F₅ | Cl | CH | t-Bu | 6-Cl | Cl | C₂F₅ | Cl | CH |
| Me | 6-Me | Cl | n-C₃F₇ | Cl | CH | Me | 6-Cl | Cl | n-C₃F₇ | Cl | CH |
| Et | 6-Me | Cl | n-C₃F₇ | Cl | CH | Et | 6-Cl | Cl | n-C₃F₇ | Cl | CH |
| i-Pr | 6-Me | Cl | n-C₃F₇ | Cl | CH | i-Pr | 6-Cl | Cl | n-C₃F₇ | Cl | CH |
| t-Bu | 6-Me | Cl | n-C₃F₇ | Cl | CH | t-Bu | 6-Cl | Cl | n-C₃F₇ | Cl | CH |
| Me | 6-Me | Cl | i-C₃F₇ | Cl | CH | Me | 6-Cl | Cl | i-C₃F₇ | Cl | CH |
| Et | 6-Me | Cl | i-C₃F₇ | Cl | CH | Et | 6-Cl | Cl | i-C₃F₇ | Cl | CH |
| i-Pr | 6-Me | Cl | i-C₃F₇ | Cl | CH | i-Pr | 6-Cl | Cl | i-C₃F₇ | Cl | CH |
| t-Bu | 6-Me | Cl | i-C₃F₇ | Cl | CH | t-Bu | 6-Cl | Cl | i-C₃F₇ | Cl | CH |
| Me | 6-Me | Cl | CN | Cl | CH | Me | 6-Cl | Cl | CN | Cl | CH |
| Et | 6-Me | Cl | CN | Cl | CH | Et | 6-Cl | Cl | CN | Cl | CH |
| i-Pr | 6-Me | Cl | CN | Cl | CH | i-Pr | 6-Cl | Cl | CN | Cl | CH |
| t-Bu | 6-Me | Cl | CN | Cl | CH | t-Bu | 6-Cl | Cl | CN | Cl | CH |
| Me | 6-Me | Cl | OCHF₂ | Br | CH | Me | 6-Cl | Cl | OCHF₂ | Br | CH |
| Et | 6-Me | Cl | OCHF₂ | Br | CH | Et | 6-Cl | Cl | OCHF₂ | Br | CH |
| i-Pr | 6-Me | Cl | OCHF₂ | Br | CH | i-Pr | 6-Cl | Cl | OCHF₂ | Br | CH |
| t-Bu | 6-Me | Cl | OCHF₂ | Br | CH | t-Bu | 6-Cl | Cl | OCHF₂ | Br | CH |
| Me | 6-Me | Cl | SCHF₂ | Br | CH | Me | 6-Cl | Cl | SCHF₂ | Br | CH |
| Et | 6-Me | Cl | SCHF₂ | Br | CH | Et | 6-Cl | Cl | SCHF₂ | Br | CH |
| i-Pr | 6-Me | Cl | SCHF₂ | Br | CH | i-Pr | 6-Cl | Cl | SCHF₂ | Br | CH |
| t-Bu | 6-Me | Cl | SCHF₂ | Br | CH | t-Bu | 6-Cl | Cl | SCHF₂ | Br | CH |
| Me | 6-Me | Cl | OCF₃ | Br | CH | Me | 6-Cl | Cl | OCF₃ | Br | CH |
| Et | 6-Me | Cl | OCF₃ | Br | CH | Et | 6-Cl | Cl | OCF₃ | Br | CH |
| i-Pr | 6-Me | Cl | OCF₃ | Br | CH | i-Pr | 6-Cl | Cl | OCF₃ | Br | CH |
| t-Bu | 6-Me | Cl | OCF₃ | Br | CH | t-Bu | 6-Cl | Cl | OCF₃ | Br | CH |
| Me | 6-Me | Cl | SCF₃ | Br | CH | Me | 6-Cl | Cl | SCF₃ | Br | CH |
| Et | 6-Me | Cl | SCF₃ | Br | CH | Et | 6-Cl | Cl | SCF₃ | Br | CH |
| i-Pr | 6-Me | Cl | SCF₃ | Br | CH | i-Pr | 6-Cl | Cl | SCF₃ | Br | CH |
| t-Bu | 6-Me | Cl | SCF₃ | Br | CH | t-Bu | 6-Cl | Cl | SCF₃ | Br | CH |
| Me | 6-Me | Cl | C₂F₅ | Br | CH | Me | 6-Cl | Cl | C₂F₅ | Br | CH |
| Et | 6-Me | Cl | C₂F₅ | Br | CH | Et | 6-Cl | Cl | C₂F₅ | Br | CH |
| i-Pr | 6-Me | Cl | C₂F₅ | Br | CH | i-Pr | 6-Cl | Cl | C₂F₅ | Br | CH |
| t-Bu | 6-Me | Cl | C₂F₅ | Br | CH | t-Bu | 6-Cl | Cl | C₂F₅ | Br | CH |
| Me | 6-Me | Cl | n-C₃F₇ | Br | CH | Me | 6-Cl | Cl | n-C₃F₇ | Br | CH |
| Et | 6-Me | Cl | n-C₃F₇ | Br | CH | Et | 6-Cl | Cl | n-C₃F₇ | Br | CH |
| i-Pr | 6-Me | Cl | n-C₃F₇ | Br | CH | i-Pr | 6-Cl | Cl | n-C₃F₇ | Br | CH |
| t-Bu | 6-Me | Cl | n-C₃F₇ | Br | CH | t-Bu | 6-Cl | Cl | n-C₃F₇ | Br | CH |
| Me | 6-Me | Cl | i-C₃F₇ | Br | CH | Me | 6-Cl | Cl | i-C₃F₇ | Br | CH |
| Et | 6-Me | Cl | i-C₃F₇ | Br | CH | Et | 6-Cl | Cl | i-C₃F₇ | Br | CH |
| i-Pr | 6-Me | Cl | i-C₃F₇ | Br | CH | i-Pr | 6-Cl | Cl | i-C₃F₇ | Br | CH |
| t-Bu | 6-Me | Cl | i-C₃F₇ | Br | CH | t-Bu | 6-Cl | Cl | i-C₃F₇ | Br | CH |
| Me | 6-Me | Cl | CN | Br | CH | Me | 6-Cl | Cl | CN | Br | CH |
| Et | 6-Me | Cl | CN | Br | CH | Et | 6-Cl | Cl | GN | Br | CH |
| i-Pr | 6-Me | Cl | CN | Br | CH | i-Pr | 6-Cl | Cl | CN | Br | CH |
| t-Bu | 6-Me | Cl | CN | Br | CH | t-Bu | 6-Cl | Cl | CN | Br | CH |
| Me | 6-Me | Cl | SCHF₂ | CF₃ | CH | Me | 6-Cl | Cl | OCHF₂ | CF₃ | CH |
| Et | 6-Me | Cl | SCHF₂ | CF₃ | CH | Et | 6-Cl | Cl | OCHF₂ | CF₃ | CH |
| i-Pr | 6-Me | Cl | OCHF₂ | CF₃ | CH | i-Pr | 6-Cl | Cl | OCHF₂ | CF₃ | CH |
| t-Bu | 6-Me | Cl | OCHF₂ | CF₃ | CH | t-Bu | 6-Cl | Cl | OCHF₂ | CF₃ | CH |
| Me | 6-Me | Cl | SCHF₂ | CF₃ | CH | Me | 6-Cl | Cl | SCHF₂ | CF₃ | CH |
| Et | 6-Me | Cl | SCHF₂ | CF₃ | CH | Et | 6-Cl | Cl | SCilF₂ | CF₃ | CH |
| i-Pr | 6-Me | Cl | SCHF₂ | CF₃ | CH | i-Pr | 6-Cl | Cl | SCHF₂ | CF₃ | CH |
| t-Bu | 6-Me | Cl | SCHF₂ | CF₃ | CH | t-Bu | 6-Cl | Cl | SCHF₂ | CF₃ | CH |
| Me | 6-Me | Cl | OCF₃ | CF₃ | CH | Me | 6-Cl | Cl | OCF₃ | CF₃ | CH |
| Et | 6-Me | Cl | OCF₃ | CF₃ | CH | Et | 6-Cl | Cl | OCF₃ | CF₃ | CH |
| i-Pr | 6-Me | Cl | OCF₃ | CF₃ | CH | i-Pr | 6-Cl | Cl | OCF₃ | CF₃ | CH |
| t-Bu | 6-Me | Cl | OCF₃ | CF₃ | CH | t-Bu | 6-Cl | Cl | OCF₃ | CF₃ | CH |
| Me | 6-Me | Cl | SCF₃ | CF₃ | CH | Me | 6-Cl | Cl | SCF₃ | CF₃ | CH |
| Et | 6-Me | Cl | SCF₃ | CF₃ | CH | Et | 6-Cl | Cl | SCF₃ | CF₃ | CH |
| i-Pr | 6-Me | Cl | SCF₃ | CF₃ | CH | i-Pr | 6-Cl | Cl | SCF₃ | CF₃ | CH |
| t-Bu | 6-Me | Cl | SCF₃ | CF₃ | CH | t-Bu | 6-Cl | Cl | SCF₃ | CF₃ | CU |
| Me | 6-Me | Cl | C₂F₅ | CF₃ | CH | Me | 6-Cl | Cl | SCF₅ | CF₃ | CH |
| Et | 6-Me | Cl | C₂F₅ | CF₃ | CH | Et | 6-Cl | Cl | C₂F₅ | CF₃ | CH |
| i-Pr | 6-Me | Cl | C₂F₅ | CF₃ | CH | i-Pr | 6-Cl | Cl | C₂F₅ | CF₃ | CH |
| t-Bu | 6-Me | Cl | C₂F₅ | CF₃ | CH | t-Bu | 6-Cl | Cl | C₂F₅ | CF₃ | CH |
| Me | 6-Me | Cl | n-C₃F₇ | CF₃ | CH | Me | 6-Cl | Cl | n-C₃F₇ | CF₃ | CH |
| Et | 6-Me | Cl | n-C₃F₇ | CF₃ | CH | Et | 6-Cl | Cl | n-C₃F₇ | CF₃ | CU |
| i-Pr | 6-Me | Cl | n-C₃F₇ | CF₃ | CH | i-Pr | 6-Cl | Cl | n-C₃F₇ | CF₃ | CH |
| t-Bu | 6-Me | Cl | n-C₃F₇ | CF₃ | CH | t-Bu | 6-Cl | Cl | n-C₃F₇ | CF₃ | CH |
| Me | 6-Me | Cl | i-C₃F₇ | CF₃ | CH | Me | 6-Cl | Cl | i-C₃F₇ | CF₃ | CH |
| Et | 6-Me | Cl | i-C₃F₇ | CF₃ | CH | Et | 6-Cl | Cl | i-C₃F₇ | CF₃ | CH |
| i-Pr | 6-Me | Cl | i-C₃F₇ | CF₃ | CH | i-Pr | 6-Cl | Cl | i-C₃F₇ | CF₃ | CH |
| t-Bu | 6-Me | Cl | i-C₃F₇ | CF₃ | CH | t-Bu | 6-Cl | Cl | i-C₃F₇ | CF₃ | CH |
| Me | 6-Me | Cl | CN | CF₃ | CH | Me | 6-Cl | Cl | CN | CF₃ | CH |
| Et | 6-Me | Cl | CN | CF₃ | CH | Et | 6-Cl | Cl | CN | CF₃ | CH |
| i-Pr | 6-Me | Cl | CN | CF₃ | CH | i-Pr | 6-Cl | Cl | CN | CF₃ | CH |
| t-Bu | 6-Me | Cl | CN | CF₃ | CH | t-Bu | 6-Cl | Cl | CN | CF₃ | CH |
| Me | 6-Me | H | OCHF₂ | F | CF | Me | 6-Cl | H | OCHF₂ | F | CF |
| Et | 6-Me | H | OCHF₂ | F | CF | Et | 6-Cl | H | OCHF₂ | F | CF |
| i-Pr | 6-Me | H | OCHF₂ | F | CF | i-Pr | 6-Cl | H | OCHF₂ | F | CF |
| t-Bu | 6-Me | H | OCHF₂ | F | CF | t-Bu | 6-Cl | H | OCHF₂ | F | CF |
| Me | 6-Me | H | SCHF₂ | F | CF | Me | 6-Cl | H | SCHF₂ | F | CF |
| Et | 6-Me | H | SCHF₂ | F | CF | Et | 6-Cl | H | SCHF₂ | F | CF |
| i-Pr | 6-Me | H | SCHF₂ | F | CF | i-Pr | 6-Cl | H | SCHF₂ | F | CF |
| t-Bu | 6-Me | H | SCHF₂ | F | CF | t-Bu | 6-Cl | H | SCHF₂ | F | CF |
| Me | 6-Me | H | OCF₃ | F | CF | Me | 6-Cl | H | OCF₃ | F | CF |
| Et | 6-Me | H | OCF₃ | F | CF | Et | 6-Cl | H | OCF₃ | F | CF |
| i-Pr | 6-Me | H | OCF₃ | F | CF | i-Pr | 6-Cl | H | OCF₃ | F | CF |
| t-Bu | 6-Me | H | OCF₃ | F | CF | t-Bu | 6-Cl | H | OCF₃ | F | CF |
| Me | 6-Me | H | SCF₃ | F | CF | Me | 6-Cl | H | SCF₃ | F | CF |
| Et | 6-Me | H | SCF₃ | F | CF | Et | 6-Cl | H | SCF₃ | F | CF |
| i-Pr | 6-Me | H | SCF₃ | F | CF | i-Pr | 6-Cl | H | SCF₃ | F | CF |
| t-Bu | 6-Me | H | SCF₃ | F | CF | t-Bu | 6-Cl | H | SCF₃ | F | CF |
| Me | 6-Me | H | C₂F₅ | F | CF | Me | 6-Cl | H | C₂F₅ | F | CF |
| Et | 6-Me | H | C₂F₅ | F | CF | Et | 6-Cl | H | C₂F₅ | F | CF |
| i-Pr | 6-Me | H | C₂F₅ | F | CF | i-Pr | 6-Cl | H | C₂F₅ | F | CF |
| t-Bu | 6-Me | H | C₂F₅ | F | CF | t-Bu | 6-Cl | H | C₂F₅ | F | CF |
| Me | 6-Me | H | n-C₃F₇ | F | CF | Me | 6-Cl | H | n-C₃F₇ | F | CF |
| Et | 6-Me | H | n-C₃F₇ | F | CF | Et | 6-Cl | H | n-C₃F₇ | F | CF |
| i-Pr | 6-Me | H | n-C₃F₇ | F | CF | i-Pr | 6-Cl | H | n-C₃F₇ | F | CF |
| t-Bu | 6-Me | H | n-C₃F₇ | F | CF | t-Bu | 6-Cl | H | n-C₃F₇ | F | CF |
| Me | 6-Me | H | i-C₃F₇ | F | CF | Me | 6-Cl | H | i-C₃F₇ | F | CF |
| Et | 6-Me | H | i-C₃F₇ | F | CF | Et | 6-Cl | H | i-C₃F₇ | F | CF |
| i-Pr | 6-Me | H | i-C₃F₇ | F | CF | i-Pr | 6-Cl | H | i-C₃F₇ | F | CF |
| t-Bu | 6-Me | H | i-C₃F₇ | F | CF | t-Bu | 6-Cl | H | i-C₃F₇ | F | CF |
| Me | 6-Me | H | CN | F | CF | Me | 6-Cl | H | CN | F | CF |
| Et | 6-Me | H | CN | F | CF | Et | 6-Cl | H | CN | F | CF |
| i-Pr | 6-Me | H | CN | F | CF | i-Pr | 6-Cl | H | CN | F | CF |
| t-Bu | 6-Me | H | CN | F | CF | t-Bu | 6-Cl | H | CN | F | CF |
| Me | 6-Me | H | OCHF₂ | Cl | CCl | Me | 6-Cl | H | OCHF₂ | Cl | CCl |
| Et | 6-Me | H | OCHF₂ | Cl | CCl | Et | 6-Cl | H | OCHF₂ | Cl | CCl |
| i-Pr | 6-Me | H | OCHF₂ | Cl | CCl | i-Pr | 6-Cl | H | OCHF₂ | Cl | CCl |
| t-Bu | 6-Me | H | OCHF₂ | Cl | CCl | t-Bu | 6-Cl | H | OCHF₂ | Cl | CCl |
| Me | 6-Me | H | SCHF₂ | Cl | CCl | Me | 6-Cl | H | SCHF₂ | Cl | CCl |
| Et | 6-Me | H | SCHF₂ | Cl | CCl | Et | 6-Cl | H | SCHF₂ | Cl | CCl |
| i-Pr | 6-Me | H | SCHF₂ | Cl | CCl | i-Pr | 6-Cl | H | SCHF₂ | Cl | CCl |
| t-Bu | 6-Me | H | SCHF₂ | Cl | CCl | t-Bu | 6-Cl | H | SCHF₂ | Cl | CCl |
| Me | 6-Me | H | OCF₃ | Cl | CCl | Me | 6-Cl | H | OCF₃ | Cl | CCl |
| Et | 6-Me | H | OCF₃ | Cl | CCl | Et | 6-Cl | H | OCF₃ | Cl | CCl |
| i-Pr | 6-Me | H | OCF₃ | Cl | CCl | i-Pr | 6-Cl | H | OCF₃ | Cl | CCl |
| t-Bu | 6-Me | H | OCF₃ | Cl | CCl | t-Bu | 6-Cl | H | OCF₃ | Cl | CCl |
| Me | 6-Me | H | SCF₃ | Cl | CCl | Me | 6-Cl | H | SCF₃ | Cl | CCl |
| Et | 6-Me | H | SCF₃ | Cl | CCl | Et | 6-Cl | H | SCF₃ | Cl | CCl |
| i-Pr | 6-Me | H | SCF₃ | Cl | CCl | i-Pr | 6-Cl | H | SCF₃ | Cl | CCl |
| t-Bu | 6-Me | H | SCF₃ | Cl | CCl | t-Bu | 6-Cl | H | SCF₃ | Cl | CCl |
| Me | 6-Me | H | C₂F₅ | Cl | CCl | Me | 6-Cl | H | C₂F₅ | Cl | CCl |
| Et | 6-Me | H | C₂F₅ | Cl | CCl | Et | 6-Cl | H | C₂F₅ | Cl | CCl |
| i-Pr | 6-Me | H | C₂F₅ | Cl | CCl | i-Pr | 6-Cl | H | C₂F₅ | Cl | CCl |
| t-Bu | 6-Me | H | C₂F₅ | Cl | CCl | t-Bu | 6-Cl | H | C₂F₅ | Cl | CC1 |
| Me | 6-Me | H | n-C₃F₇ | Cl | CCl | Me | 6-Cl | H | n-C₃F₇ | Cl | CCl |
| Et | 6-Me | H | n-C₃F₇ | Cl | CCl | Et | 6-Cl | H | n-C₃F₇ | Cl | CCl |
| i-Pr | 6-Me | H | n-C₃F₇ | Cl | CCl | i-Pr | 6-Cl | H | n-C₃F₇ | Cl | CCl |
| t-Bu | 6-Me | H | n-C₃F₇ | Cl | CCl | t-Bu | 6-Cl | H | n-C₃F₇ | Cl | CCl |
| Me | 6-Me | H | i-C₃F₇ | Cl | CCl | Me | 6-Cl | H | i-C₃F₇ | Cl | CCl |
| Et | 6-Me | H | i-C₃F₇ | Cl | CCl | Et | 6-Cl | H | i-C₃F₇ | Cl | CCl |
| i-Pr | 6-Me | H | i-C₃F₇ | Cl | CCl | i-Pr | 6-Cl | H | i-C₃F₇ | Cl | CCl |
| t-Bu | 6-Me | H | i-C₃F₇ | Cl | CCl | t-Bu | 6-Cl | H | i-C₃F₇ | Cl | CCl |
| Me | 6-Me | H | CN | Cl | CCl | Me | 6-Cl | H | CN | Cl | CCl |
| Et | 6-Me | H | CN | Cl | CCl | Et | 6-Cl | H | CN | Cl | CCl |
| i-Pr | 6-Me | H | CN | Cl | CCl | i-Pr | 6-Cl | H | CN | Cl | CCl |
| t-Bu | 6-Me | H | CN | Cl | CCl | t-Bu | 6-Cl | H | CN | Cl | CCl |
| Me | 3-Me | H | OCHF₂ | F | CH | Me | 3-Cl | H | OCHF₂ | F | CH |
| Et | 3-Me | H | OCHF₂ | F | CH | Et | 3-Cl | H | OCHF₂ | F | CH |
| i-Pr | 3-Me | H | OCHF₂ | F | CH | i-Pr | 3-Cl | H | OCHF₂ | F | CH |
| t-Bu | 3-Me | H | OCHF₂ | F | CH | t-Bu | 3-Cl | H | OCHF₂ | F | CH |
| Me | 3-Me | H | SCHF₂ | F | CH | Me | 3-Cl | H | SCHF₂ | F | CH |
| Et | 3-Me | H | SCHF₂ | F | CH | Et | 3-Cl | H | SCHF₂ | F | CH |
| i-Pr | 3-Me | H | SCHF₂ | F | CH | i-Pr | 3-Cl | H | SCHF₂ | F | CH |
| t-Bu | 3-Me | H | SCHF₂ | F | CH | t-Bu | 3-Cl | H | SCHF₂ | F | CH |
| Me | 3-Me | H | OCF₃ | F | CH | Me | 3-Cl | H | OCF₃ | F | CH |
| Et | 3-Me | H | OCF₃ | F | CH | Et | 3-Cl | H | OCF₃ | F | CH |
| i-Pr | 3-Me | H | OCF₃ | F | CH | i-Pr | 3-Cl | H | OCF₃ | F | CH |
| t-Bu | 3-Me | H | OCF₃ | F | CH | t-Bu | 3-Cl | H | OCF₃ | F | CH |
| Me | 3-Me | H | SCF₃ | F | CH | Me | 3-Cl | H | SCF₃ | F | CH |
| Et | 3-Me | H | SCF₃ | F | CH | Et | 3-Cl | H | SCF₃ | F | CH |
| i-Pr | 3-Me | H | SCF₃ | F | CH | i-Pr | 3-Cl | H | SCF₃ | F | CH |
| t-Bu | 3-Me | H | SCF₃ | F | CH | t-Bu | 3-Cl | H | SCF₃ | F | CH |
| Me | 3-Me | H | C₂F₅ | F | CH | Me | 3-Cl | H | C₂F₅ | F | CH |
| Et | 3-Me | H | C₂F₅ | F | CH | Et | 3-Cl | H | C₂F₅ | F | CH |
| i-Pr | 3-Me | H | C₂F₅ | F | CH | i-Pr | 3-Cl | H | C₂F₅ | F | CH |
| t-Bu | 3-Me | H | C₂F₅ | F | CH | t-Bu | 3-Cl | H | C₂F₅ | F | CH |
| Me | 3-Me | H | n-C₃F₇ | F | CH | Me | 3-Cl | H | n-C₃F₇ | F | CH |
| Et | 3-Me | H | n-C₃F₇ | F | CH | Et | 3-Cl | H | n-C₃F₇ | F | CH |
| i-Pr | 3-Me | H | n-C₃F₇ | F | CH | i-Pr | 3-Cl | H | n-C₃F₇ | F | CH |
| t-Bu | 3-Me | H | n-C₃F₇ | F | CH | t-Bu | 3-Cl | H | n-C₃F₇ | F | CH |
| Me | 3-Me | H | i-C₃F₇ | F | CH | Me | 3-Cl | H | i-C₃F₇ | F | CH |
| Et | 3-Me | H | i-C₃F₇ | F | CH | Et | 3-Cl | H | i-C₃F₇ | F | CH |
| i-Pr | 3-Me | H | i-C₃F₇ | F | CH | i-Pr | 3-Cl | H | i-C₃F₇ | F | CH |
| t-Bu | 3-Me | H | i-C₃F₇ | F | CH | t-Bu | 3-Cl | H | i-C₃F₇ | F | CH |
| Me | 3-Me | H | CN | F | CH | Me | 3-Cl | H | CN | F | CH |
| Et | 3-Me | H | CN | F | CH | Et | 3-Cl | H | CN | F | CH |
| i-Pr | 3-Me | H | CN | F | CH | i-Pr | 3-Cl | H | CN | F | CH |
| t-Bu | 3-Me | H | CN | F | CH | t-Bu | 3-Cl | H | CH | F | CH |
| Me | 3-Me | H | OCHF₂ | Cl | CH | Me | 3-Cl | H | OCHF₂ | Cl | CH |
| Et | 3-Me | H | OCHF₂ | Cl | CH | Et | 3-Cl | H | OCHF₂ | Cl | CH |
| i-Pr | 3-Me | H | OCHF₂ | Cl | CH | i-Pr | 3-Cl | H | OCHF₂ | Cl | CH |
| t-Bu | 3-Me | H | OCHF₂ | Cl | CH | t-Bu | 3-Cl | H | OCHF₂ | Cl | CH |
| Me | 3-Me | H | SCHF₂ | Cl | CH | Me | 3-Cl | H | SCHF₂ | Cl | CH |
| Et | 3-Me | H | SCHF₂ | Cl | CH | Et | 3-Cl | H | SCHF₂ | Cl | CH |
| i-Pr | 3-Me | H | SCHF₂ | Cl | CH | i-Pr | 3-Cl | H | SCHF₂ | Cl | CH |
| t-Bu | 3-Me | H | SCHF₂ | Cl | CH | t-Bu | 3-Cl | H | SCHF₂ | Cl | CH |
| Me | 3-Me | H | OCF₃ | Cl | CH | Me | 3-Cl | H | OCF₃ | Cl | CH |
| Et | 3-Me | H | OCF₃ | Cl | CH | Et | 3-Cl | H | OCF₃ | Cl | CH |
| i-Pr | 3-Me | H | OCF₃ | Cl | CH | i-Pr | 3-Cl | H | OCF₃ | Cl | CH |
| t-Bu | 3-Me | H | OCF₃ | Cl | CH | t-Bu | 3-Cl | H | OCF₃ | Cl | CH |
| Me | 3-Me | H | SCF₃ | Cl | CH | Me | 3-Cl | H | SCF₃ | Cl | CH |
| Et | 3-Me | H | SCF₃ | Cl | CH | Et | 3-Cl | H | SCF₃ | Cl | CH |
| i-Pr | 3-Me | H | SCF₃ | Cl | CH | i-Pr | 3-Cl | H | SCF₃ | Cl | CH |
| t-Bu | 3-Me | H | SCF₃ | Cl | CH | t-Bu | 3-Cl | H | SCF₃ | Cl | CH |
| Me | 3-Me | H | C₂F₅ | Cl | CH | Me | 3-Cl | H | C₂F₅ | Cl | CH |
| Et | 3-Me | H | C₂F₅ | Cl | CH | Et | 3-Cl | H | C₂F₅ | Cl | CH |
| i-Pr | 3-Me | H | C₂F₅ | Cl | CH | i-Pr | 3-Cl | H | C₂F₅ | Cl | CH |
| t-Bu | 3-Me | H | C₂F₅ | Cl | CH | t-Bu | 3-Cl | H | C₂F₅ | Cl | CH |
| Me | 3-Me | H | n-C₃F₇ | Cl | CH | Me | 3-Cl | H | n-C₃F₇ | Cl | ~H |
| Et | 3-Me | H | n-C₃F₇ | Cl | CH | Et | 3-Cl | H | n-C₃F₇ | Cl | CH |
| i-Pr | 3-Me | H | n-C₃F₇ | Cl | CH | i-Pr | 3-Cl | H | n-C₃F₇ | Cl | CH |
| t-Bu | 3-Me | H | n-C₃F₇ | Cl | CH | t-Bu | 3-Cl | H | n-C₃F₇ | Cl | CH |
| Me | 3-Me | H | i-C₃F₇ | Cl | CH | Me | 3-Cl | H | i-C₃F₇ | Cl | CH |
| Et | 3-Me | H | i-C₃F₇ | Cl | CH | Et | 3-Cl | H | i-C₃F₇ | Cl | CH |
| i-Pr | 3-Me | H | i-C₃F₇ | Cl | CH | i-Pr | 3-Cl | H | i-C₃F₇ | Cl | CH |
| t-Bu | 3-Me | H | i-C₃F₇ | Cl | CH | t-Bu | 3-Cl | H | i-C₃F₇ | Cl | CH |
| Me | 3-Me | H | CN | Cl | CH | Me | 3-Cl | H | CN | Cl | CH |
| Et | 3-Me | H | CN | Cl | CH | Et | 3-Cl | H | CN | Cl | CH |
| i-Pr | 3-Me | H | CN | Cl | CH | i-Pr | 3-Cl | H | CN | Cl | CH |
| t-Bu | 3-Me | H | CN | Cl | CH | t-Bu | 3-Cl | H | CN | Cl | CH |
| Me | 3-Me | H | OCHF₂ | Br | CH | Me | 3-Cl | H | OCHF₂ | Br | CH |
| Et | 3-Me | H | OCHF₂ | Br | CH | Et | 3-Cl | H | OCHF₂ | Br | CH |
| i-Pr | 3-Me | H | OCHF₂ | Br | CH | i-Pr | 3-Cl | H | OCHF₂ | Br | CH |
| t-Bu | 3-Me | H | OCHF₂ | Br | CH | t-Bu | 3-Cl | H | OCHF₂ | Br | CH |
| Me | 3-Me | H | SCHF₂ | Br | CH | Me | 3-Cl | H | SCHF₂ | Br | CH |
| Et | 3-Me | H | SCHF₂ | Br | CH | Et | 3-Cl | H | SCHF₂ | Br | CH |
| i-Pr | 3-Me | H | SCHF₂ | Br | CH | i-Pr | 3-Cl | H | SCHF₂ | Br | CH |
| t-Bu | 3-Me | H | SCHF₂ | Br | CH | t-Bu | 3-Cl | H | SCHF₂ | Br | CH |
| Me | 3-Me | H | OCF₃ | Br | CH | Me | 3-Cl | H | OCF₃ | Br | CH |
| Et | 3-Me | H | OCF₃ | Br | CH | Et | 3-Cl | H | OCF₃ | Br | CH |
| i-Pr | 3-Me | H | OCF₃ | Br | CH | i-Pr | 3-Cl | H | OCF₃ | Br | CH |
| t-Bu | 3-Me | H | OCF₃ | Br | CH | t-Bu | 3-Cl | H | OCF₃ | Br | CH |
| Me | 3-Me | H | SCF₃ | Br | CH | Me | 3-Cl | H | SCF₃ | Br | CH |
| Et | 3-Me | H | SCF₃ | Br | CH | Et | 3-Cl | H | SCF₃ | Br | CH |
| i-Pr | 3-Me | H | SCF₃ | Br | CH | i-Pr | 3-Cl | H | SCF₃ | Br | CH |
| t-Bu | 3-Me | H | SCF₃ | Br | CH | t-Bu | 3-Cl | H | SCF₃ | Br | CH |
| Me | 3-Me | H | C₂F₅ | Br | CH | Me | 3-Cl | H | C₂F₅ | Br | CH |
| Et | 3-Me | H | C₂F₅ | Br | CH | Et | 3-Cl | H | C₂F₅ | Br | CH |
| i-Pr | 3-Me | H | C₂F₅ | Br | CH | i-Pr | 3-Cl | H | C₂F₅ | Br | CH |
| t-Bu | 3-Me | H | C₂F₅ | Br | CH | t-Bu | 3-Cl | H | C₂F₅ | Br | CH |
| Me | 3-Me | H | n-C₃F₇ | Br | CH | Me | 3-Cl | H | n-C₃F₇ | Br | CH |
| Et | 3-Me | H | n-C₃F₇ | Br | CH | Et | 3-Cl | H | n-C₃F₇ | Br | CH |
| i-Pr | 3-Me | H | n-C₃F₇ | Br | CH | i-Pr | 3-Cl | H | n-C₃F₇ | Br | CH |
| t-Bu | 3-Me | H | n-C₃F₇ | Br | CH | t-Bu | 3-Cl | H | n-C₃F₇ | Br | CH |
| Me | 3-Me | H | i-C₃F₇ | Br | CH | Me | 3-Cl | H | i-C₃F₇ | Br | CH |
| Et | 3-Me | H | i-C₃F₇ | Br | CH | Et | 3-Cl | H | i-C₃F₇ | Br | CH |
| i-Pr | 3-Me | H | i-C₃F₇ | Br | CH | i-Pr | 3-Cl | H | i-C₃F₇ | Br | CH |
| t-Bu | 3-Me | H | i-C₃F₇ | Br | CH | t-Bu | 3-Cl | H | i-C₃F₇ | Br | CH |
| Me | 3-Me | H | CN | Br | CH | Me | 3-Cl | H | CN | Br | CH |
| Et | 3-Me | H | CN | Br | CH | Et | 3-Cl | H | CN | Br | CH |
| i-Pr | 3-Me | H | CN | Br | CH | i-Pr | 3-Cl | H | CN | Br | CH |
| t-Bu | 3-Me | H | CN | Br | CH | t-Bu | 3-Cl | H | CN | Br | CH |
| Me | 3-Me | H | OCHF₂ | CF₃ | CH | Me | 3-Cl | H | OCHF₂ | CF₃ | CH |
| Et | 3-Me | H | OCHF₂ | CF₃ | CH | Et | 3-Cl | H | OCHF₂ | CF₃ | CH |
| i-Pr | 3-Me | H | OCHF₂ | CF₃ | CH | i-Pr | 3-Cl | H | SCHF₂ | CF₃ | CH |
| t-Bu | 3-Me | H | OCHF₂ | CF₃ | CH | t-Bu | 3-Cl | H | OCHF₂ | CF₃ | CH |
| Me | 3-Me | H | SCHF₂ | CF₃ | CH | Me | 3-Cl | H | SCHF₂ | CF₃ | CH |
| Et | 3-Me | H | SCHF₂ | CF₃ | CH | Et | 3-Cl | H | SCHF₂ | CF₃ | CH |
| i-Pr | 3-Me | H | SCHF₂ | CF₃ | CH | i-Pr | 3-Cl | H | SCHF₂ | CF₃ | CH |
| t-Bu | 3-Me | H | SCHF₂ | CF₃ | CH | t-Bu | 3-Cl | H | SCHF₂ | CF₃ | CH |
| Me | 3-Me | H | OCF₃ | CF₃ | CH | Me | 3-Cl | H | OCF₃ | CF₃ | CH |
| Et | 3-Me | H | OCF₃ | CF₃ | CH | Et | 3-Cl | H | OCF₃ | CF₃ | CH |
| i-Pr | 3-Me | H | OCF₃ | CF₃ | CH | i-Pr | 3-Cl | H | OCF₃ | CF₃ | CH |
| t-Bu | 3-Me | H | OCF₃ | CF₃ | CH | t-Bu | 3-Cl | H | OCF₃ | CF₃ | CH |
| Me | 3-Me | H | SCF₃ | CF₃ | CH | Me | 3-Cl | H | SCF₃ | CF₃ | CH |
| Et | 3-Me | H | SCF₃ | CF₃ | CH | Et | 3-Cl | H | SCF₃ | CF₃ | CH |
| i-Pr | 3-Me | H | SCF₃ | CF₃ | CH | i-Pr | 3-Cl | H | SCF₃ | CF₃ | CH |
| t-Bu | 3-Me | H | SCF₃ | CF₃ | CH | t-Bu | 3-Cl | H | SCF₃ | CF₃ | CH |
| Me | 3-Me | H | C₂F₅ | CF₃ | CH | Me | 3-Cl | H | C₂F₅ | CF₃ | CH |
| Et | 3-Me | H | C₂F₅ | CF₃ | CH | Et | 3-Cl | H | C₂F₅ | CF₃ | CH |
| i-Pr | 3-Me | H | C₂F₅ | CF₃ | CH | i-Pr | 3-Cl | H | C₂F₅ | CF₃ | CH |
| t-Bu | 3-Me | H | C₂F₅ | CF₃ | CH | t-Bu | 3-Cl | H | C₂F₅ | CF₃ | CH |
| Me | 3-Me | H | n-C₃F₇ | CF₃ | CH | Me | 3-Cl | H | n-C₃F₇ | CF₃ | CH |
| Et | 3-Me | H | n-C₃F₇ | CF₃ | CH | Et | 3-Cl | H | n-C₃F₇ | CF₃ | CH |
| i-Pr | 3-Me | H | n-C₃F₇ | CF₃ | CH | i-Pr | 3-Cl | H | n-C₃F₇ | CF₃ | CH |
| t-Bu | 3-Me | H | n-C₃F₇ | CF₃ | CH | t-Bu | 3-Cl | H | n-C₃F₇ | CF₃ | CH |
| Me | 3-Me | H | i-C₃F₇ | CF₃ | CH | Me | 3-Cl | H | i-C₃F₇ | CF₃ | CH |
| Et | 3-Me | H | i-C₃F₇ | CF₃ | CH | Et | 3-Cl | H | i-C₃F₇ | CF₃ | CH |
| i-Pr | 3-Me | H | i-C₃F₇ | CF₃ | CH | i-Pr | 3-Cl | H | i-C₃F₇ | CF₃ | CH |
| t-Bu | 3-Me | H | i-C₃F₇ | CF₃ | CH | t-Bu | 3-Cl | H | i-C₃F₇ | CF₃ | CH |
| Me | 3-Me | H | CN | CF₃ | CH | Me | 3-Cl | H | CN | CF₃ | CH |
| Et | 3-Me | H | CN | CF₃ | CH | Et | 3-Cl | H | CN | CF₃ | CH |
| i-Pr | 3-Me | H | CN | CF₃ | CH | i-Pr | 3-Cl | H | CN | CF₃ | CH |
| t-Bu | 3-Me | H | CN | CF₃ | CH | t-Bu | 3-Cl | H | CN | CF₃ | CH |

TABLE 4

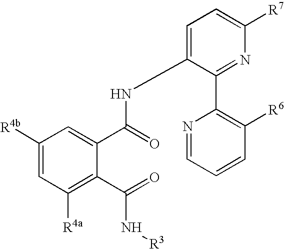

| R^{4a} | R^{4b} | R⁷ | R³ | R⁶ |
|---|---|---|---|---|
| CH₃ | F | CF₃ | Me | Cl |
| CH₃ | F | CF₃ | Et | Cl |
| CH₃ | F | CF₃ | i-Pr | Cl |
| CH₃ | F | CF₃ | t-Bu | Cl |
| CH₃ | F | CF₃ | Me | Br |
| CH₃ | F | CF₃ | Et | Br |
| CH₃ | F | CF₃ | i-Pr | Br |
| CH₃ | F | CF₃ | t-Bu | Br |
| CH₃ | F | Cl | Me | Cl |
| CH₃ | F | Cl | Et | Cl |
| CH₃ | F | Cl | i-Pr | Cl |
| CH₃ | F | Cl | t-Bu | Cl |
| CH₃ | F | Cl | Me | Br |
| CH₃ | F | Cl | Et | Br |
| CH₃ | F | Cl | i-Pr | Br |
| CH₃ | F | Cl | t-Bu | Br |
| CH₃ | F | Br | Me | Cl |
| CH₃ | F | Br | Et | Cl |
| CH₃ | F | Br | i-Pr | Cl |
| CH₃ | F | Br | t-Bu | Cl |
| CH₃ | F | Br | Me | Br |
| CH₃ | F | Br | Et | Br |
| CH₃ | F | Br | i-Pr | Br |
| CH₃ | F | Br | t-Bu | Br |
| CH₃ | Cl | CF₃ | Me | Cl |
| CH₃ | Cl | CF₃ | Et | Cl |
| CH₃ | Cl | CF₃ | i-Pr | Cl |
| CH₃ | Cl | CF₃ | t-Bu | Cl |
| CH₃ | Cl | CF₃ | Me | Br |
| CH₃ | Cl | CF₃ | Et | Br |
| CH₃ | Cl | CF₃ | i-Pr | Br |
| CH₃ | Cl | CF₃ | t-Bu | Br |
| CH₃ | Cl | Cl | Me | Cl |
| CH₃ | Cl | Cl | Et | Cl |
| CH₃ | Cl | Cl | i-Pr | Cl |
| CH₃ | Cl | Cl | t-Bu | Cl |
| CH₃ | Cl | Cl | Me | Br |
| CH₃ | Cl | Cl | Et | Br |
| CH₃ | Cl | Cl | i-Pr | Br |
| CH₃ | Cl | Cl | t-Bu | Br |
| CH₃ | Cl | Br | Me | Cl |
| CH₃ | Cl | Br | Et | Cl |
| CH₃ | Cl | Br | i-Pr | Cl |
| CH₃ | Cl | Br | t-Bu | Cl |
| CH₃ | Cl | Br | Me | Br |
| CH₃ | Cl | Br | Et | Br |
| CH₃ | Cl | Br | i-Pr | Br |
| CH₃ | Cl | Br | t-Bu | Br |
| CH₃ | Br | CF₃ | Me | Cl |
| CH₃ | Br | CF₃ | Et | Cl |
| CH₃ | Br | CF₃ | i-Pr | Cl |
| CH₃ | Br | CF₃ | t-Bu | Cl |
| CH₃ | Br | CF₃ | Me | Br |
| CH₃ | Br | CF₃ | Et | Br |
| CH₃ | Br | CF₃ | i-Pr | Br |
| CH₃ | Br | CF₃ | t-Bu | Br |
| CH₃ | Br | Cl | Me | Cl |
| CH₃ | Br | Cl | Et | Cl |
| CH₃ | Br | Cl | i-Pr | Cl |
| CH₃ | Br | Cl | t-Bu | Cl |
| CH₃ | Br | Cl | Me | Br |
| CH₃ | Br | Cl | Et | Br |
| CH₃ | Br | Cl | i-Pr | Br |
| CH₃ | Br | Cl | t-Bu | Br |
| CH₃ | Br | Br | Me | Cl |
| CH₃ | Br | Br | Et | Cl |
| CH₃ | Br | Br | i-Pr | Cl |
| CH₃ | Br | Br | t-Bu | Cl |
| CH₃ | Br | Br | Me | Br |
| CH₃ | Br | Br | Et | Br |
| CH₃ | Br | Br | i-Pr | Br |
| CH₃ | Br | Br | t-Bu | Br |
| CH₃ | I | CF₃ | Me | Cl |
| CH₃ | I | CF₃ | Et | Cl |
| CH₃ | I | CF₃ | i-Pr | Cl |
| CH₃ | I | CF₃ | t-Bu | Cl |
| CH₃ | I | CF₃ | Me | Br |
| CH₃ | I | CF₃ | Et | Br |
| CH₃ | I | CF₃ | i-Pr | Br |
| CH₃ | I | CF₃ | t-Bu | Br |
| CH₃ | I | Cl | Me | Cl |
| CH₃ | I | Cl | Et | Cl |
| CH₃ | I | Cl | i-Pr | Cl |
| CH₃ | I | Cl | t-Bu | Cl |
| CH₃ | I | Cl | Me | Br |
| CH₃ | I | Cl | Et | Br |
| CH₃ | I | Cl | i-Pr | Br |
| CH₃ | I | Cl | t-Bu | Br |
| CH₃ | I | Br | Me | Cl |
| CH₃ | I | Br | Et | Cl |
| CH₃ | I | Br | i-Pr | Cl |
| CH₃ | I | Br | t-Bu | Cl |
| CH₃ | I | Br | Me | Br |
| CH₃ | I | Br | Et | Br |
| CH₃ | I | Br | i-Pr | Br |
| CH₃ | I | Br | t-Bu | Br |
| CH₃ | CF₃ | CF₃ | Me | Cl |
| CH₃ | CF₃ | CF₃ | Et | Cl |
| CH₃ | CF₃ | CF₃ | i-Pr | Cl |
| CH₃ | CF₃ | CF₃ | t-Bu | Cl |
| CH₃ | CF₃ | CF₃ | Me | Br |
| CH₃ | CF₃ | CF₃ | Et | Br |
| CH₃ | CF₃ | CF₃ | i-Pr | Br |
| CH₃ | CF₃ | CF₃ | t-Bu | Br |
| CH₃ | CF₃ | Cl | Me | Cl |
| CH₃ | CF₃ | Cl | Et | Cl |
| CH₃ | CF₃ | Cl | i-Pr | Cl |
| CH₃ | CF₃ | Cl | t-Bu | Cl |
| CH₃ | CF₃ | Cl | Me | Br |
| CH₃ | CF₃ | Cl | Et | Br |
| CH₃ | CF₃ | Cl | i-Pr | Br |
| CH₃ | CF₃ | Cl | t-Bu | Br |
| CH₃ | CF₃ | Br | Me | Cl |
| CH₃ | CF₃ | Br | Et | Cl |
| CH₃ | CF₃ | Br | i-Pr | Cl |
| CH₃ | CF₃ | Br | t-Bu | Cl |
| CH₃ | CF₃ | Br | Me | Br |
| CH₃ | CF₃ | Br | Et | Br |
| CH₃ | CF₃ | Br | i-Pr | Br |
| CH₃ | CF₃ | Br | t-Bu | Br |
| CH₃ | Cl | Cl | n-Pr | Cl |
| CH₃ | Cl | Cl | n-Bu | Cl |
| CH₃ | Cl | Cl | s-Bu | Cl |
| CH₃ | Cl | Cl | i-Bu | Cl |
| CH₃ | H | CF₃ | Me | Cl |
| CH₃ | H | CF₃ | Et | Cl |
| CH₃ | H | CF₃ | i-Pr | Cl |
| CH₃ | H | CF₃ | t-Bu | Cl |
| CH₃ | H | CF₃ | Me | Br |
| CH₃ | H | CF₃ | Et | Br |
| CH₃ | H | CF₃ | i-Pr | Br |
| CH₃ | H | CF₃ | t-Bu | Br |
| CH₃ | H | Cl | Me | Cl |
| CH₃ | H | Cl | Et | Cl |
| CH₃ | H | Cl | i-Pr | Cl |
| CH₃ | H | Cl | t-Bu | Cl |
| CH₃ | H | Cl | Me | Br |
| CH₃ | H | Cl | Et | Br |
| CH₃ | H | Cl | i-Pr | Br |
| CH₃ | H | Cl | t-Bu | Br |
| CH₃ | H | Br | Me | Cl |
| CH₃ | H | Br | Et | Cl |
| CH₃ | H | Br | i-Pr | Cl |
| CH₃ | H | Br | t-Bu | Cl |
| CH₃ | H | Br | Me | Br |
| CH₃ | H | Br | Et | Br |
| CH₃ | H | Br | i-Pr | Br |
| CH₃ | H | Br | t-Bu | Br |
| Cl | F | CF₃ | Me | Cl |
| Cl | F | CF₃ | Et | Cl |
| Cl | F | CF₃ | i-Pr | Cl |
| Cl | F | CF₃ | t-Bu | Cl |
| Cl | F | CF₃ | Me | Br |
| Cl | F | CF₃ | Et | Br |
| Cl | F | CF₃ | i-Pr | Br |
| Cl | F | CF₃ | t-Bu | Br |
| Cl | F | Cl | Me | Cl |
| Cl | F | Cl | Et | Cl |
| Cl | F | Cl | i-Pr | Cl |
| Cl | F | Cl | t-Bu | Cl |
| Cl | F | Cl | Me | Br |
| Cl | F | Cl | Et | Br |
| Cl | F | Cl | i-Pr | Br |
| Cl | F | Cl | t-Bu | Br |
| Cl | F | Br | Me | Cl |
| Cl | F | Br | Et | Cl |
| Cl | F | Br | i-Pr | Cl |
| Cl | F | Br | t-Bu | Cl |
| Cl | F | Br | Me | Br |
| Cl | F | Br | Et | Br |
| Cl | F | Br | i-Pr | Br |
| Cl | F | Br | t-Bu | Br |
| Cl | Cl | CF₃ | Me | Cl |
| Cl | Cl | CF₃ | Et | Cl |
| Cl | Cl | CF₃ | i-Pr | Cl |
| Cl | Cl | CF₃ | t-Bu | Cl |
| Cl | Cl | CF₃ | Me | Br |
| Cl | Cl | CF₃ | Et | Br |
| Cl | Cl | CF₃ | i-Pr | Br |
| Cl | Cl | CF₃ | t-Bu | Br |
| Cl | Cl | Cl | Me | Cl |
| Cl | Cl | Cl | Et | Cl |
| Cl | Cl | Cl | i-Pr | Cl |
| Cl | Cl | Cl | t-Bu | Cl |
| Cl | Cl | Cl | Me | Br |
| Cl | Cl | Cl | Et | Br |
| Cl | Cl | Cl | i-Pr | Br |
| Cl | Cl | Cl | t-Bu | Br |
| Cl | Cl | Br | Me | Cl |
| Cl | Cl | Br | Et | Cl |
| Cl | Cl | Br | i-Pr | Cl |
| Cl | Cl | Br | t-Bu | Cl |
| Cl | Cl | Br | Me | Br |
| Cl | Cl | Br | Et | Br |
| Cl | Cl | Br | i-Pr | Br |
| Cl | Cl | Br | t-Bu | Br |
| Cl | Br | CF₃ | Me | Cl |
| Cl | Br | CF₃ | Et | Cl |
| Cl | Br | CF₃ | i-Pr | Cl |
| Cl | Br | CF₃ | t-Bu | Cl |
| Cl | Br | CF₃ | Me | Br |
| Cl | Br | CF₃ | Et | Br |
| Cl | Br | CF₃ | i-Pr | Br |
| Cl | Br | CF₃ | t-Bu | Br |
| Cl | Br | Cl | Me | Cl |
| Cl | Br | Cl | Et | Cl |
| Cl | Br | Cl | i-Pr | Cl |
| Cl | Br | Cl | t-Bu | Cl |
| Cl | H | CF₃ | Me | Cl |
| Cl | H | CF₃ | Et | Cl |
| Cl | H | CF₃ | i-Pr | Cl |
| Cl | H | CF₃ | t-Bu | Cl |
| Cl | H | CF₃ | Me | Br |
| Cl | H | CF₃ | Et | Br |
| Cl | H | CF₃ | i-Pr | Br |
| Cl | H | CF₃ | t-Bu | Br |
| Cl | H | Cl | Me | Cl |
| Cl | H | Cl | Et | Cl |
| Cl | H | Cl | i-Pr | Cl |
| Cl | H | Cl | t-Bu | Cl |
| Cl | H | Cl | Me | Br |
| Cl | H | Cl | Et | Br |
| Cl | H | Cl | i-Pr | Br |
| Cl | H | Cl | t-Bu | Br |
| Cl | H | Br | Me | Cl |
| Cl | H | Br | Et | Cl |
| Cl | H | Br | i-Pr | Cl |
| Cl | H | Br | t-Bu | Cl |
| Cl | H | Br | Me | Br |
| Cl | H | Br | Et | Br |
| Cl | H | Br | i-Pr | Br |
| Cl | H | Br | t-Bu | Br |
| Cl | Br | Cl | Me | Br |
| Cl | Br | Cl | Et | Br |
| Cl | Br | Cl | i-Pr | Br |
| Cl | Br | Cl | t-Bu | Br |
| Cl | Br | Br | Me | Cl |
| Cl | Br | Br | Et | Cl |
| Cl | Br | Br | i-Pr | Cl |
| Cl | Br | Br | t-Bu | Cl |
| Cl | Br | Br | Me | Br |
| Cl | Br | Br | Et | Br |
| Cl | Br | Br | i-Pr | Br |
| Cl | Br | Br | t-Bu | Br |
| Cl | I | CF₃ | Me | Cl |
| Cl | I | CF₃ | Et | Cl |
| Cl | I | CF₃ | i-Pr | Cl |
| Cl | I | CF₃ | t-Bu | Cl |
| Cl | I | CF₃ | Me | Br |
| Cl | I | CF₃ | Et | Br |
| Cl | I | CF₃ | i-Pr | Br |
| Cl | I | CF₃ | t-Bu | Br |
| Cl | I | Cl | Me | Cl |
| Cl | I | Cl | Et | Cl |
| Cl | I | Cl | i-Pr | Cl |
| Cl | I | Cl | t-Bu | Cl |
| Cl | I | Cl | Me | Br |
| Cl | I | Cl | Et | Br |
| Cl | I | Cl | i-Pr | Br |
| Cl | I | Cl | t-Bu | Br |
| Cl | I | Br | Me | Cl |
| Cl | I | Br | Et | Cl |
| Cl | I | Br | i-Pr | Cl |
| Cl | I | Br | t-Bu | Cl |
| Cl | I | Br | Me | Br |
| Cl | I | Br | Et | Br |
| Cl | I | Br | i-Pr | Br |
| Cl | I | Br | t-Bu | Br |
| Cl | CF₃ | CF₃ | Me | Cl |
| Cl | CF₃ | CF₃ | Et | Cl |
| Cl | CF₃ | CF₃ | i-Pr | Cl |
| Cl | CF₃ | CF₃ | t-Bu | Cl |
| Cl | CF₃ | CF₃ | Me | Br |
| Cl | CF₃ | CF₃ | Et | Br |
| Cl | CF₃ | CF₃ | i-Pr | Br |
| Cl | CF₃ | CF₃ | t-Bu | Br |
| Cl | CF₃ | Cl | Me | Cl |
| Cl | CF₃ | Cl | Et | Cl |
| Cl | CF₃ | Cl | i-Pr | Cl |
| Cl | CF₃ | Cl | t-Bu | Cl |
| Cl | CF₃ | Cl | Me | Br |
| Cl | CF₃ | Cl | Et | Br |
| Cl | CF₃ | Cl | i-Pr | Br |
| Cl | CF₃ | Cl | t-Bu | Br |
| Cl | CF₃ | Br | Me | Cl |
| Cl | CF₃ | Br | Et | Cl |
| Cl | CF₃ | Br | i-Pr | Cl |
| Cl | CF₃ | Br | t-Bu | Cl |
| Cl | CF₃ | Br | Me | Br |
| Cl | CF₃ | Br | Et | Br |
| Cl | CF₃ | Br | i-Pr | Br |
| Cl | CF₃ | Br | t-Bu | Br |
| Cl | Cl | Cl | n-Pr | Cl |
| Cl | Cl | Cl | n-Bu | Cl |
| Cl | Cl | Cl | s-Bu | Cl |
| Cl | Cl | Cl | i-Bu | Cl |
| Br | F | CF₃ | Me | Cl |
| Br | F | CF₃ | Et | Cl |
| Br | F | CF₃ | i-Pr | Cl |
| Br | F | CF₃ | t-Bu | Cl |
| Br | F | CF₃ | Me | Br |
| Br | F | CF₃ | Et | Br |
| Br | F | CF₃ | i-Pr | Br |
| Br | F | CF₃ | t-Bu | Br |
| Br | F | Cl | Me | Cl |
| Br | F | Cl | Et | Cl |
| Br | F | Cl | i-Pr | Cl |
| Br | F | Cl | t-Bu | Cl |
| Br | F | Cl | Me | Br |
| Br | F | Cl | Et | Br |
| Br | F | Cl | i-Pr | Br |
| Br | F | Cl | t-Bu | Br |
| Br | F | Br | Me | Cl |
| Br | F | Br | Et | Cl |
| Br | F | Br | i-Pr | Cl |
| Br | F | Br | t-Bu | Cl |
| Br | F | Br | Me | Br |
| Br | F | Br | Et | Br |
| Br | F | Br | i-Pr | Br |
| Br | F | Br | t-Bu | Br |
| Br | Cl | CF₃ | Me | Cl |
| Br | Cl | CF₃ | Et | Cl |
| Br | Cl | CF₃ | i-Pr | Cl |
| Br | Cl | CF₃ | t-Bu | Cl |
| Br | Cl | CF₃ | Me | Br |
| Br | Cl | CF₃ | Et | Br |
| Br | Cl | CF₃ | i-Pr | Br |
| Br | Cl | CF₃ | t-Bu | Br |
| Br | Cl | Cl | Me | Cl |
| Br | Cl | Cl | Et | Cl |
| Br | Cl | Cl | i-Pr | Cl |
| Br | Cl | Cl | t-Bu | Cl |
| Br | Cl | Cl | Me | Br |
| Br | Cl | Cl | Et | Br |
| Br | Cl | Cl | i-Pr | Br |
| Br | Cl | Cl | t-Bu | Br |
| Br | Cl | Br | Me | Cl |
| Br | Cl | Br | Et | Cl |
| Br | Cl | Br | i-Pr | Cl |
| Br | Cl | Br | t-Bu | Cl |
| Br | Cl | Br | Me | Br |
| Br | Cl | Br | Et | Br |
| Br | Cl | Br | i-Pr | Br |
| Br | Cl | Br | t-Bu | Br |
| Br | Br | CF₃ | Me | Cl |
| Br | Br | CF₃ | Et | Cl |
| Br | Br | CF₃ | i-Pr | Cl |
| Br | Br | CF₃ | t-Bu | Cl |
| Br | Br | CF₃ | Me | Br |
| Br | Br | CF₃ | Et | Br |
| Br | Br | CF₃ | i-Pr | Br |
| Br | Br | CF₃ | t-Bu | Br |
| Br | Br | Cl | Me | Cl |
| Br | Br | Cl | Et | Cl |
| Br | Br | Cl | i-Pr | Cl |
| Br | Br | Cl | t-Bu | Cl |
| Br | Br | Cl | Me | Br |
| Br | Br | Cl | Et | Br |
| Br | Br | Cl | i-Pr | Br |
| Br | Br | Cl | t-Bu | Br |
| Br | Br | Br | Me | Cl |
| Br | Br | Br | Et | Cl |
| Br | Br | Br | i-Pr | Cl |
| Br | Br | Br | t-Bu | Cl |
| Br | Br | Br | Me | Br |
| Br | Br | Br | Et | Br |
| Br | Br | Br | i-Pr | Br |
| Br | Br | Br | t-Bu | Br |
| Br | I | CF₃ | Me | Cl |
| Br | I | CF₃ | Et | Cl |
| Br | I | CF₃ | i-Pr | Cl |
| Br | I | CF₃ | t-Bu | Cl |
| Br | I | CF₃ | Me | Br |
| Br | I | CF₃ | Et | Br |
| Br | I | CF₃ | i-Pr | Br |
| Br | I | CF₃ | t-Bu | Br |
| Br | I | Cl | Me | Cl |
| Br | I | Cl | Et | Cl |
| Br | I | Cl | i-Pr | Cl |
| Br | I | Cl | t-Bu | Cl |
| Br | I | Cl | Me | Br |
| Br | I | Cl | Et | Br |
| Br | I | Cl | i-Pr | Br |
| Br | I | Cl | t-Bu | Br |
| Br | I | Br | Me | Cl |
| Br | I | Br | Et | Cl |
| Br | I | Br | i-Pr | Cl |
| Br | I | Br | t-Bu | Cl |
| Br | I | Br | Me | Br |
| Br | I | Br | Et | Br |
| Br | I | Br | i-Pr | Br |
| Br | I | Br | t-Bu | Br |
| Br | CF₃ | CF₃ | Me | Cl |
| Br | CF₃ | CF₃ | Et | Cl |
| Br | CF₃ | CF₃ | i-Pr | Cl |
| Br | CF₃ | CF₃ | t-Bu | Cl |
| Br | CF₃ | CF₃ | Me | Br |
| Br | CF₃ | CF₃ | Et | Br |
| Br | CF₃ | CF₃ | i-Pr | Br |
| Br | CF₃ | CF₃ | t-Bu | Br |
| Br | CF₃ | Cl | Me | Cl |
| Br | CF₃ | Cl | Et | Cl |
| Br | CF₃ | Cl | i-Pr | Cl |
| Br | CF₃ | Cl | t-Bu | Cl |
| Br | CF₃ | Cl | Me | Br |
| Br | CF₃ | Cl | Et | Br |
| Br | CF₃ | Cl | i-Pr | Br |
| Br | CF₃ | Cl | t-Bu | Br |
| Br | CF₃ | Br | Me | Cl |
| Br | CF₃ | Br | Et | Cl |
| Br | CF₃ | Br | i-Pr | Cl |
| Br | CF₃ | Br | t-Bu | Cl |
| Br | CF₃ | Br | Me | Br |
| Br | CF₃ | Br | Et | Br |
| Br | CF₃ | Br | i-Pr | Br |
| Br | CF₃ | Br | t-Bu | Br |
| I | Cl | CF₃ | Me | Cl |
| I | Cl | CF₃ | Et | Cl |
| I | Cl | CF₃ | i-Pr | Cl |
| I | Cl | CF₃ | t-Bu | Cl |
| I | Cl | CF₃ | Me | Br |
| I | Cl | CF₃ | Et | Br |
| I | Cl | CF₃ | i-Pr | Br |
| I | Cl | CF₃ | t-Bu | Br |
| I | Cl | Cl | Me | Cl |
| I | Cl | Cl | Et | Cl |
| I | Cl | Cl | i-Pr | Cl |
| I | Cl | Cl | t-Bu | Cl |
| I | Cl | Cl | Me | Br |
| I | Cl | Cl | Et | Br |
| I | Cl | Cl | i-Pr | Br |
| I | Cl | Cl | t-Bu | Br |
| I | Cl | Br | Me | Cl |
| I | Cl | Br | Et | Cl |
| I | Cl | Br | i-Pr | Cl |
| I | Cl | Br | t-Bu | Cl |
| I | Cl | Br | Me | Br |
| I | Cl | Br | Et | Br |
| I | Cl | Br | i-Pr | Br |
| I | Cl | Br | t-Bu | Br |
| I | H | CF₃ | Me | Cl |
| I | H | CF₃ | Et | Cl |
| I | H | CF₃ | i-Pr | Cl |
| I | H | CF₃ | t-Bu | Cl |

TABLE 5

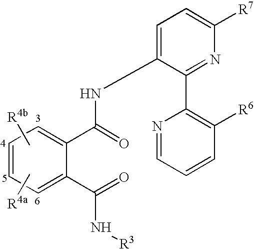

| R³ | R^{4a} | R^{4b} | R⁶ | R⁷ |
|---|---|---|---|---|
| Me | 3-Me | H | CF₃ | F |
| Et | 3-Me | 5-Me | OCF₃ | F |
| i-Pr | 3-Me | H | OCF₃ | F |
| t-Bu | 3-Me | 5-Cl | Br | F |
| Me | 3-Me | H | Br | F |
| Et | 3-Me | H | Cl | F |
| i-Pr | 3-Me | 5-Br | Cl | F |
| t-Bu | 3-Me | H | I | F |
| propargyl | 3-Me | H | CF₃ | F |
| c-propyl | 3-Me | H | OCF₃ | F |
| i-Pr | 3-Me | 5-Cl | CF₃ | F |
| t-Bu | 3-Me | H | SCF₃ | F |
| Me | 3-Me | 5-Cl | SCHF₂ | F |
| Et | 3-Me | H | OCHF₂ | F |
| i-Pr | 3-Me | H | CF₃ | F |
| t-Bu | 3-Me | H | C₂F₅ | F |
| propargyl | 3-Me | H | C₂F₅ | F |
| c-propyl | 3-Me | H | CF₃ | F |
| i-Pr | 3-Me | H | Me | F |
| t-Bu | 3-Me | 5-Br | CN | F |
| Me | 3-Me | H | CF₃ | Cl |
| Et | 3-Me | 5-Me | OCF₃ | Cl |
| i-Pr | 3-Me | H | OCF₃ | Cl |
| t-Bu | 3-Me | 5-Cl | Br | Cl |
| Me | 3-Me | H | Br | Cl |
| Et | 3-Me | H | Cl | Cl |
| i-Pr | 3-Me | 5-Br | Cl | Cl |
| t-Bu | 3-Me | H | I | Cl |
| propargyl | 3-Me | H | CF₃ | Cl |
| c-propyl | 3-Me | H | OCF₃ | Cl |
| i-Pr | 3-Me | 5-Cl | CF₃ | Cl |
| t-Bu | 3-Me | H | SCF₃ | Cl |
| Me | 3-Me | 5-Cl | SCHF₂ | Cl |
| Et | 3-Me | H | OCHF₂ | Cl |
| i-Pr | 3-Me | H | CF₃ | Cl |
| t-Bu | 3-Me | H | C₂F₅ | Cl |
| propargyl | 3-Me | H | C₂F₅ | Cl |
| c-propyl | 3-Me | H | CF₃ | Cl |
| i-Pr | 3-Me | H | Me | Cl |
| t-Bu | 3-Me | 5-Br | CN | Cl |
| Me | 3-Me | H | CF₃ | CF₃ |
| Et | 3-Me | 5-Me | OCF₃ | CF₃ |
| i-Pr | 3-Me | H | OCF₃ | CF₃ |
| t-Bu | 3-Me | 5-Cl | Br | CF₃ |
| Me | 3-Me | H | Br | CF₃ |
| Et | 3-Me | H | Cl | CF₃ |
| i-Pr | 3-Me | 5-Br | Cl | CF₃ |
| t-Bu | 3-Me | H | I | CF₃ |
| propargyl | 3-Me | H | CF₃ | CF₃ |
| c-propyl | 3-Me | H | OCF₃ | CF₃ |
| i-Pr | 3-Me | 5-Cl | CF₃ | CF₃ |
| t-Bu | 3-Me | H | SCF₃ | CF₃ |
| Me | 3-Me | 5-Cl | SCHF₂ | CF₃ |
| Et | 3-Me | H | OCHF₂ | CF₃ |
| i-Pr | 3-Me | H | CF₃ | CF₃ |
| t-Bu | 3-Me | H | C₂F₅ | CF₃ |
| propargyl | 3-Me | H | C₂F₅ | CF₃ |
| c-propyl | 3-Me | H | CF₃ | CF₃ |
| i-Pr | 3-Me | H | Me | CF₃ |
| t-Bu | 3-Me | 5-Br | CN | CF₃ |
| Me | 3-Me | H | CF₃ | Br |
| Et | 3-Me | 5-Me | OCF₃ | Br |
| i-Pr | 3-Me | H | OCF₃ | Br |
| t-Bu | 3-Me | 5-Cl | Br | Br |
| Me | 3-Me | H | Br | Br |
| Et | 3-Me | H | Cl | Br |
| i-Pr | 3-Me | 5-Br | Cl | Br |
| t-Bu | 3-Me | H | I | Br |
| propargyl | 3-Me | H | CF₃ | Br |
| c-propyl | 3-Me | H | OCF₃ | Br |
| i-Pr | 3-Me | 5-Cl | CF₃ | Br |
| t-Bu | 3-Me | H | SCF₃ | Br |
| Me | 3-Me | 5-Cl | SCHF₂ | Br |
| Et | 3-Me | H | OCHF₂ | Br |
| i-Pr | 3-Me | H | CF₃ | Br |
| t-Bu | 3-Me | H | C₂F₅ | |
| propargyl | 3-Me | H | C₂F₅ | Br |
| c-propyl | 3-Me | H | CF₃ | Br |
| i-Pr | 3-Me | H | Me | Br |
| t-Bu | 3-Me | 5-Br | CN | Br |
| Me | 6-Me | H | OCHF₂ | F |
| Et | 6-Me | H | OCHF₂ | F |
| i-Pr | 6-Me | H | OCHF₂ | F |
| t-Bu | 6-Me | H | OCHF₂ | F |
| Me | 6-Me | H | SCHF₂ | F |
| Et | 6-Me | H | SCHF₂ | F |
| i-Pr | 6-Me | H | SCHF₂ | F |
| t-Bu | 6-Me | H | SCHF₂ | F |
| Me | 6-Me | H | OCF₃ | F |
| Et | 6-Me | H | OCF₃ | F |
| i-Pr | 6-Me | H | OCF₃ | F |
| t-Bu | 6-Me | H | OCF₃ | F |
| Me | 6-Me | H | SCF₃ | F |
| Et | 6-Me | H | SCF₃ | F |
| i-Pr | 6-Me | H | SCF₃ | F |
| t-Bu | 6-Me | H | SCF₃ | F |
| Me | 6-Me | H | C₂F₅ | F |
| Et | 6-Me | H | C₂F₅ | F |
| i-Pr | 6-Me | H | C₂F₅ | F |
| t-Bu | 6-Me | H | C₂F₅ | F |
| Me | 6-Me | H | n-C₃F₇ | F |
| Et | 6-Me | H | n-C₃F₇ | F |
| i-Pr | 6-Me | H | n-C₃F₇ | F |
| t-Bu | 6-Me | H | n-C₃F₇ | F |
| Me | 6-Me | H | i-C₃F₇ | F |
| Et | 6-Me | H | i-C₃F₇ | F |
| i-Pr | 6-Me | H | i-C₃F₇ | F |
| t-Bu | 6-Me | H | i-C₃F₇ | F |
| Me | 6-Me | H | CN | F |
| Et | 6-Me | H | CN | F |
| i-Pr | 6-Me | H | CN | F |
| t-Bu | 6-Me | H | CN | F |
| Me | 6-Me | H | OCHF₂ | Cl |
| Et | 6-Me | H | OCHF₂ | Cl |
| i-Pr | 6-Me | H | OCHF₂ | Cl |
| t-Bu | 6-Me | H | OCHF₂ | Cl |
| Me | 6-Me | H | SCHF₂ | Cl |
| Et | 6-Me | H | SCHF₂ | Cl |
| i-Pr | 6-Me | H | SCHF₂ | Cl |
| t-Bu | 6-Me | H | SCHF₂ | Cl |
| Me | 6-Me | H | OCF₃ | Cl |
| Et | 6-Me | H | OCF₃ | Cl |
| i-Pr | 6-Me | H | OCF₃ | Cl |
| t-Bu | 6-Me | H | OCF₃ | Cl |
| Me | 6-Me | H | SCF₃ | Cl |
| Et | 6-Me | H | SCF₃ | Cl |
| i-Pr | 6-Me | H | SCF₃ | Cl |
| t-Bu | 6-Me | H | SCF₃ | Cl |
| Me | 6-Me | H | C₂F₅ | Cl |
| Et | 6-Me | H | C₂F₅ | Cl |
| i-Pr | 6-Me | H | C₂F₅ | Cl |
| t-Bu | 6-Me | H | C₂F₅ | Cl |
| Me | 6-Me | H | n-C₃F₇ | Cl |
| Et | 6-Me | H | n-C₃F₇ | Cl |
| i-Pr | 6-Me | H | n-C₃F₇ | Cl |
| t-Bu | 6-Me | H | n-C₃F₇ | Cl |
| Me | 6-Me | H | i-C₃F₇ | Cl |
| Et | 6-Me | H | i-C₃F₇ | Cl |
| i-Pr | 6-Me | H | i-C₃F₇ | Cl |
| t-Bu | 6-Me | H | i-C₃F₇ | Cl |
| Me | 6-Me | H | CN | Cl |
| Et | 6-Me | H | CN | Cl |
| i-Pr | 6-Me | H | CN | Cl |
| t-Bu | 6-Me | H | CN | Cl |
| Me | 6-Me | H | OCHF₂ | Br |
| Et | 6-Me | H | OCHF₂ | Br |
| i-Pr | 6-Me | H | OCHF₂ | Br |
| t-Bu | 6-Me | H | OCHF₂ | Br |
| Me | 6-Me | H | SCHF₂ | Br |
| Et | 6-Me | H | SCHF₂ | Br |
| i-Pr | 6-Me | H | SCHF₂ | Br |
| t-Bu | 6-Me | H | SCHF₂ | Br |
| Me | 6-Me | H | OCF₃ | Br |
| Et | 6-Me | H | OCF₃ | Br |
| i-Pr | 6-Me | H | OCF₃ | Br |
| t-Bu | 6-Me | H | OCF₃ | Br |
| Me | 6-Me | H | SCF₃ | Br |
| Et | 6-Me | H | SCF₃ | Br |
| i-Pr | 6-Me | H | SCF₃ | Br |
| t-Bu | 6-Me | H | SCF₃ | Br |
| Me | 6-Me | H | C₂F₅ | Br |
| Et | 6-Me | H | C₂F₅ | Br |
| i-Pr | 6-Me | H | C₂F₅ | Br |
| t-Bu | 6-Me | H | C₂F₅ | Br |
| Me | 6-Me | H | n-C₃F₇ | Br |
| Et | 6-Me | H | n-C₃F₇ | Br |
| i-Pr | 6-Me | H | n-C₃F₇ | Br |
| t-Bu | 6-Me | H | n-C₃F₇ | Br |
| Me | 6-Me | H | i-C₃F₇ | Br |
| Et | 6-Me | H | i-C₃F₇ | Br |
| i-Pr | 6-Me | H | i-C₃F₇ | Br |
| t-Bu | 6-Me | H | i-C₃F₇ | Br |
| Me | 6-Me | H | CN | Br |
| Et | 6-Me | H | CN | Br |
| i-Pr | 6-Me | H | CN | Br |
| t-Bu | 6-Me | H | CN | Br |
| Me | 6-Me | H | OCHF₂ | CF₃ |
| Et | 6-Me | H | OCHF₂ | CF₃ |
| i-Pr | 6-Me | H | OCHF₂ | CF₃ |
| t-Bu | 6-Me | H | OCHF₂ | CF₃ |
| Me | 6-Me | H | SCHF₂ | CF₃ |
| Et | 6-Me | H | SCHF₂ | CF₃ |
| i-Pr | 6-Me | H | SCHF₂ | CF₃ |
| t-Bu | 6-Me | H | SCHF₂ | CF₃ |
| Me | 6-Me | H | OCF₃ | CF₃ |
| Et | 6-Me | H | OCF₃ | CF₃ |
| i-Pr | 6-Me | H | OCF₃ | CF₃ |
| t-Bu | 6-Me | H | OCF₃ | CF₃ |
| Me | 6-Me | H | SCF₃ | CF₃ |
| Et | 6-Me | H | SCF₃ | CF₃ |
| i-Pr | 6-Me | H | SCF₃ | CF₃ |
| t-Bu | 6-Me | H | SCF₃ | CF₃ |
| Me | 6-Me | H | C₂F₅ | CF₃ |
| Et | 6-Me | H | C₂F₅ | CF₃ |
| i-Pr | 6-Me | H | C₂F₅ | CF₃ |
| t-Bu | 6-Me | H | C₂F₅ | CF₃ |
| Me | 6-Me | H | n-C₃F₇ | CF₃ |
| Et | 6-Me | H | n-C₃F₇ | CF₃ |
| i-Pr | 6-Me | H | n-C₃F₇ | CF₃ |
| t-Bu | 6-Me | H | n-C₃F₇ | CF₃ |
| Me | 6-Me | H | i-C₃F₇ | CF₃ |
| Et | 6-Me | H | i-C₃F₇ | CF₃ |
| i-Pr | 6-Me | H | i-C₃F₇ | CF₃ |
| t-Bu | 6-Me | H | i-C₃F₇ | CF₃ |
| Me | 6-Me | H | CN | CF₃ |
| Et | 6-Me | H | CN | CF₃ |
| i-Pr | 6-Me | H | CN | CF₃ |
| t-Bu | 6-Me | H | CN | CF₃ |
| Me | 6-Me | Cl | OCHF₂ | F |
| Et | 6-Me | Cl | OCHF₂ | F |
| i-Pr | 6-Me | Cl | OCHF₂ | F |
| t-Bu | 6-Me | Cl | OCHF₂ | F |
| Me | 6-Me | Cl | SCHF₂ | F |
| Et | 6-Me | Cl | SCHF₂ | F |
| i-Pr | 6-Me | Cl | SCHF₂ | F |
| t-Bu | 6-Me | Cl | SCHF₂ | F |
| Me | 6-Me | Cl | OCF₃ | F |
| Et | 6-Me | Cl | OCF₃ | F |
| i-Pr | 6-Me | Cl | OCF₃ | F |
| t-Bu | 6-Me | Cl | OCF₃ | F |
| Me | 6-Me | Cl | SCF₃ | F |
| Et | 6-Me | Cl | SCF₃ | F |
| i-Pr | 6-Me | Cl | SCF₃ | F |
| t-Bu | 6-Me | Cl | SCF₃ | F |
| Me | 6-Me | Cl | C₂F₅ | F |
| Et | 6-Me | Cl | C₂F₅ | F |
| i-Pr | 6-Me | Cl | C₂F₅ | F |
| t-Bu | 6-Me | Cl | C₂F₅ | F |
| Me | 6-Me | Cl | n-C₃F₇ | F |
| Et | 6-Me | Cl | n-C₃F₇ | F |
| i-Pr | 6-Me | Cl | n-C₃F₇ | F |
| t-Bu | 6-Me | Cl | n-C₃F₇ | F |
| Me | 6-Me | Cl | i-C₃F₇ | F |
| Et | 6-Me | Cl | i-C₃F₇ | F |
| i-Pr | 6-Me | Cl | i-C₃F₇ | F |
| t-Bu | 6-Me | Cl | i-C₃F₇ | F |
| Me | 6-Me | Cl | CN | F |
| Et | 6-Me | Cl | CN | F |
| i-Pr | 6-Me | Cl | CN | F |
| t-Bu | 6-Me | Cl | CN | F |
| Me | 6-Me | Cl | OCHF₂ | Cl |
| Et | 6-Me | Cl | OCHF₂ | Cl |
| i-Pr | 6-Me | Cl | OCHF₂ | Cl |
| t-Bu | 6-Me | Cl | OCHF₂ | Cl |
| Me | 6-Me | Cl | SCHF₂ | Cl |
| Et | 6-Me | Cl | SCHF₂ | Cl |
| i-Pr | 6-Me | Cl | SCHF₂ | Cl |
| t-Bu | 6-Me | Cl | SCHF₂ | Cl |
| Me | 6-Me | Cl | OCF₃ | Cl |
| Et | 6-Me | Cl | OCF₃ | Cl |
| i-Pr | 6-Me | Cl | OCF₃ | Cl |
| t-Bu | 6-Me | Cl | OCF₃ | Cl |
| Me | 6-Me | Cl | SCF₃ | Cl |
| Et | 6-Me | Cl | SCF₃ | Cl |
| i-Pr | 6-Me | Cl | SCF₃ | Cl |
| t-Bu | 6-Me | Cl | SCF₃ | Cl |
| Me | 6-Me | Cl | C₂F₅ | Cl |
| Et | 6-Me | Cl | C₂F₅ | Cl |
| i-Pr | 6-Me | Cl | C₂F₅ | Cl |
| t-Bu | 6-Me | Cl | C₂F₅ | Cl |
| Me | 6-Me | Cl | n-C₃F₇ | Cl |
| Et | 6-Me | Cl | n-C₃F₇ | Cl |
| i-Pr | 6-Me | Cl | n-C₃F₇ | Cl |
| t-Bu | 6-Me | Cl | n-C₃F₇ | Cl |
| Me | 6-Me | Cl | i-C₃F₇ | Cl |
| Et | 6-Me | Cl | i-C₃F₇ | Cl |
| i-Pr | 6-Me | Cl | i-C₃F₇ | Cl |
| t-Bu | 6-Me | Cl | i-C₃F₇ | Cl |
| Me | 6-Me | Cl | CN | Cl |
| Et | 6-Me | Cl | CN | Cl |
| i-Pr | 6-Me | Cl | CN | Cl |
| t-Bu | 6-Me | Cl | CN | Cl |
| Me | 6-Me | Cl | OCHF₂ | Br |
| Et | 6-Me | Cl | OCHF₂ | Br |
| i-Pr | 6-Me | Cl | OCHF₂ | Br |
| t-Bu | 6-Me | Cl | OCHF₂ | Br |
| Me | 6-Me | Cl | SCHF₂ | Br |
| Et | 6-Me | Cl | SCHF₂ | Br |
| i-Pr | 6-Me | Cl | SCHF₂ | Br |
| t-Bu | 6-Me | Cl | SCHF₂ | Br |
| Me | 6-Me | Cl | OCF₃ | Br |
| Et | 6-Me | Cl | OCF₃ | Br |
| i-Pr | 6-Me | Cl | OCF₃ | Br |
| t-Bu | 6-Me | Cl | OCF₃ | Br |
| Me | 6-Me | Cl | SCF₃ | Br |
| Et | 6-Me | Cl | SCF₃ | Br |
| i-Pr | 6-Me | Cl | SCF₃ | Br |
| t-Bu | 6-Me | Cl | SCF₃ | Br |
| Me | 6-Me | Cl | C₂F₅ | Br |
| Et | 6-Me | Cl | C₂F₅ | Br |
| i-Pr | 6-Me | Cl | C₂F₅ | Br |
| t-Bu | 6-Me | Cl | C₂F₅ | Br |
| Me | 6-Me | Cl | n-C₃F₇ | Br |
| Et | 6-Me | Cl | n-C₃F₇ | Br |
| i-Pr | 6-Me | Cl | n-C₃F₇ | Br |
| t-Bu | 6-Me | Cl | n-C₃F₇ | Br |
| Me | 6-Me | Cl | i-C₃F₇ | Br |
| Et | 6-Me | Cl | i-C₃F₇ | Br |
| i-Pr | 6-Me | Cl | i-C₃F₇ | Br |
| t-Bu | 6-Me | Cl | i-C₃F₇ | Br |
| Me | 6-Me | Cl | CN | Br |
| Et | 6-Me | Cl | CN | Br |
| i-Pr | 6-Me | Cl | CN | Br |
| t-Bu | 6-Me | Cl | CN | Br |
| Me | 6-Me | Cl | OCHF₂ | CF₃ |
| Et | 6-Me | Cl | OCHF₂ | CF₃ |
| i-Pr | 6-Me | Cl | OCHF₂ | CF₃ |
| t-Bu | 6-Me | Cl | OCHF₂ | CF₃ |
| Me | 6-Me | Cl | SCHF₂ | CF₃ |
| Et | 6-Me | Cl | SCHF₂ | CF₃ |
| i-Pr | 6-Me | Cl | SCHF₂ | CF₃ |
| t-Bu | 6-Me | Cl | SCHF₂ | CF₃ |
| Me | 6-Me | Cl | OCF₃ | CF₃ |
| Et | 6-Me | Cl | OCF₃ | CF₃ |
| i-Pr | 6-Me | Cl | OCF₃ | CF₃ |
| t-Bu | 6-Me | Cl | OCF₃ | CF₃ |
| Me | 6-Me | Cl | SCF₃ | CF₃ |
| Et | 6-Me | Cl | SCF₃ | CF₃ |
| i-Pr | 6-Me | Cl | SCF₃ | CF₃ |
| t-Bu | 6-Me | Cl | SCF₃ | CF₃ |
| Me | 6-Me | Cl | C₂F₅ | CF₃ |
| Et | 6-Me | Cl | C₂F₅ | CF₃ |
| i-Pr | 6-Me | Cl | C₂F₅ | CF₃ |
| t-Bu | 6-Me | Cl | C₂F₅ | CF₃ |
| Me | 6-Me | Cl | n-C₃F₇ | CF₃ |
| Et | 6-Me | Cl | n-C₃F₇ | CF₃ |
| i-Pr | 6-Me | Cl | n-C₃F₇ | CF₃ |
| t-Bu | 6-Me | Cl | n-C₃F₇ | CF₃ |
| Me | 6-Me | Cl | i-C₃F₇ | CF₃ |
| Et | 6-Me | Cl | i-C₃F₇ | CF₃ |
| i-Pr | 6-Me | Cl | i-C₃F₇ | CF₃ |
| t-Bu | 6-Me | Cl | i-C₃F₇ | CF₃ |
| Me | 6-Me | Cl | CN | CF₃ |
| Et | 6-Me | Cl | CN | CF₃ |
| i-Pr | 6-Me | Cl | CN | CF₃ |
| t-Bu | 6-Me | Cl | CN | CF₃ |
| Me | 3-Cl | H | CF₃ | F |
| Et | 3-Cl | 5-Me | OCF₃ | F |
| i-Pr | 3-Cl | H | OCF₃ | F |
| t-Bu | 3-Cl | 5-Cl | Br | F |
| Me | 3-Cl | H | Br | F |
| Et | 3-Cl | H | Cl | F |
| i-Pr | 3-Cl | 5-Br | Cl | F |
| t-Bu | 3-Cl | H | I | F |
| propargyl | 3-Cl | H | CF₃ | F |
| c-propyl | 3-Cl | H | OCF₃ | F |
| i-Pr | 3-Cl | 5-Cl | CF₃ | F |
| t-Bu | 3-Cl | H | SCF₃ | F |
| Me | 3-Cl | 5-Cl | SCHF₂ | F |
| Et | 3-Cl | H | OCHF₂ | F |
| i-Pr | 3-Cl | H | CF₃ | F |
| t-Bu | 3-Cl | H | C₂F₅ | F |
| propargyl | 3-Cl | H | C₂F₅ | F |
| c-propyl | 3-Cl | H | CF₃ | F |
| i-Pr | 3-Cl | H | Me | F |
| t-Bu | 3-Cl | 5-Br | CN | F |
| Me | 3-Cl | H | CF₃ | Cl |
| Et | 3-Cl | 5-Me | OCF₃ | Cl |
| i-Pr | 3-Cl | H | OCF₃ | Cl |
| t-Bu | 3-Cl | 5-Cl | Br | Cl |
| Me | 3-Cl | H | Br | Cl |
| Et | 3-Cl | H | Cl | Cl |
| i-Pr | 3-Cl | 5-Br | Cl | Cl |
| t-Bu | 3-Cl | H | I | Cl |
| propargyl | 3-Cl | H | CF₃ | Cl |
| c-propyl | 3-Cl | H | OCF₃ | Cl |
| i-Pr | 3-Cl | 5-Cl | CF₃ | Cl |
| t-Bu | 3-Cl | H | SCF₃ | Cl |
| Me | 3-Cl | 5-Cl | SCHF₂ | Cl |
| Et | 3-Cl | H | OCHF₂ | Cl |
| i-Pr | 3-Cl | H | CF₃ | Cl |
| t-Bu | 3-Cl | H | C₂F₅ | Cl |
| propargyl | 3-Cl | H | C₂F₅ | Cl |
| c-propyl | 3-Cl | H | CF₃ | Cl |
| i-Pr | 3-Cl | H | Me | Cl |
| t-Bu | 3-Cl | 5-Br | CN | Cl |
| Me | 3-Cl | H | CF₃ | CF₃ |
| Et | 3-Cl | 5-Me | OCF₃ | CF₃ |
| i-Pr | 3-Cl | H | OCF₃ | CF₃ |
| t-Bu | 3-Cl | 5-Cl | Br | CF₃ |
| Me | 3-Cl | H | Br | CF₃ |
| 3-Cl | H | Cl | CF₃ | |
| i-Pr | 3-Cl | 5-Br | Cl | CF₃ |
| t-Bu | 3-Cl | H | I | CF₃ |
| propargyl | 3-Cl | H | CF₃ | CF₃ |
| c-propyl | 3-Cl | H | OCF₃ | CF₃ |
| i-Pr | 3-Cl | 5-Cl | CF₃ | CF₃ |
| t-Bu | 3-Cl | H | SCF₃ | CF₃ |
| Me | 3-Cl | 5-Cl | SCHF₂ | CF₃ |
| Et | 3-Cl | H | OCHF₂ | CF₃ |
| i-Pr | 3-Cl | H | CF₃ | CF₃ |
| t-Bu | 3-Cl | H | C₂F₅ | CF₃ |
| propargyl | 3-Cl | H | C₂F₅ | CF₃ |
| c-propyl | 3-Cl | H | CF₃ | CF₃ |
| i-Pr | 3-Cl | H | Me | CF₃ |
| t-Bu | 3-Cl | 5-Br | CN | CF₃ |
| Me | 3-Cl | H | CF₃ | Br |
| Et | 3-Cl | 5-Me | OCF₃ | Br |
| i-Pr | 3-Cl | H | OCF₃ | Br |
| t-Bu | 3-Cl | 5-Cl | Br | Br |
| Me | 3-Cl | H | Br | Br |
| Et | 3-Cl | H | Cl | Br |
| i-Pr | 3-Cl | 5-Br | Cl | Br |
| t-Bu | 3-Cl | H | I | Br |
| propargyl | 3-Cl | H | CF₃ | Br |
| c-propyl | 3-Cl | H | OCF₃ | Br |
| i-Pr | 3-Cl | 5-Cl | CF₃ | Br |
| t-Bu | 3-Cl | H | SCF₃ | Br |
| Me | 3-Cl | 5-Cl | SCHF₂ | Br |
| Et | 3-Cl | H | OCHF₂ | Br |
| i-Pr | 3-Cl | H | CF₃ | Br |
| t-Bu | 3-Cl | H | C₂F₅ | Br |
| propargyl | 3-Cl | H | C₂F₅ | Br |
| c-propyl | 3-Cl | H | CF₃ | Br |
| i-Pr | 3-Cl | H | Me | Br |
| t-Bu | 3-Cl | 5-Br | CN | Br |
| Me | 6-Cl | H | OCHF₂ | F |
| Et | 6-Cl | H | OCHF₂ | F |
| i-Pr | 6-Cl | H | OCHF₂ | F |
| t-Bu | 6-Cl | H | OCHF₂ | F |
| Me | 6-Cl | H | SCHF₂ | F |
| Et | 6-Cl | H | SCHF₂ | F |
| i-Pr | 6-Cl | H | SCHF₂ | F |
| t-Bu | 6-Cl | H | SCHF₂ | F |
| Me | 6-Cl | H | OCF₃ | F |
| Et | 6-Cl | H | OCF₃ | F |
| i-Pr | 6-Cl | H | OCF₃ | F |
| t-Bu | 6-Cl | H | OCF₃ | F |
| Me | 6-Cl | H | SCF₃ | F |
| Et | 6-Cl | H | SCF₃ | F |
| i-Pr | 6-Cl | H | SCF₃ | F |
| t-Bu | 6-Cl | H | SCF₃ | F |
| Me | 6-Cl | H | C₂F₅ | F |
| Et | 6-Cl | H | C₂F₅ | F |
| i-Pr | 6-Cl | H | C₂F₅ | F |
| t-Bu | 6-Cl | H | C₂F₅ | F |
| Me | 6-Cl | H | n-C₃F₇ | F |
| Et | 6-Cl | H | n-C₃F₇ | F |
| i-Pr | 6-Cl | H | n-C₃F₇ | F |
| t-Bu | 6-Cl | H | n-C₃F₇ | F |
| Me | 6-Cl | H | i-C₃F₇ | F |
| Et | 6-Cl | H | i-C₃F₇ | F |
| i-Pr | 6-Cl | H | i-C₃F₇ | F |
| t-Bu | 6-Cl | H | i-C₃F₇ | F |
| Me | 6-Cl | H | CN | F |
| Et | 6-Cl | H | CN | F |
| i-Pr | 6-Cl | H | CN | F |
| t-Bu | 6-Cl | H | CN | F |
| Me | 6-Cl | H | OCHF₂ | Cl |
| Et | 6-Cl | H | OCHF₂ | Cl |
| i-Pr | 6-Cl | H | OCHF₂ | Cl |
| t-Bu | 6-Cl | H | OCHF₂ | Cl |
| Me | 6-Cl | H | SCHF₂ | Cl |
| Et | 6-Cl | H | SCHF₂ | Cl |
| i-Pr | 6-Cl | H | SCHF₂ | Cl |
| t-Bu | 6-Cl | H | SCHF₂ | Cl |
| Me | 6-Cl | H | OCF₃ | Cl |
| Et | 6-Cl | H | OCF₃ | Cl |
| i-Pr | 6-Cl | H | OCF₃ | Cl |
| t-Bu | 6-Cl | H | OCF₃ | Cl |
| Me | 6-Cl | H | SCF₃ | Cl |
| Et | 6-Cl | H | SCF₃ | Cl |
| i-Pr | 6-Cl | H | SCF₃ | Cl |
| t-Bu | 6-Cl | H | SCF₃ | Cl |
| Me | 6-Cl | H | C₂F₅ | Cl |
| Et | 6-Cl | H | C₂F₅ | Cl |
| i-Pr | 6-Cl | H | C₂F₅ | Cl |
| t-Bu | 6-Cl | H | C₂F₅ | Cl |
| Me | 6-Cl | H | n-C₃F₇ | Cl |
| Et | 6-Cl | H | n-C₃F₇ | Cl |
| i-Pr | 6-Cl | H | n-C₃F₇ | Cl |
| t-Bu | 6-Cl | H | n-C₃F₇ | Cl |
| Me | 6-Cl | H | i-C₃F₇ | Cl |
| Et | 6-Cl | H | i-C₃F₇ | Cl |
| i-Pr | 6-Cl | H | i-C₃F₇ | Cl |
| t-Bu | 6-Cl | H | i-C₃F₇ | Cl |
| Me | 6-Cl | H | CN | Cl |
| Et | 6-Cl | H | CN | Cl |
| i-Pr | 6-Cl | H | CN | Cl |
| t-Bu | 6-Cl | H | CN | Cl |
| Me | 6-Cl | H | OCHF₂ | Br |
| Et | 6-Cl | H | OCHF₂ | Br |
| i-Pr | 6-Cl | H | OCHF₂ | Br |
| t-Bu | 6-Cl | H | OCHF₂ | Br |
| Me | 6-Cl | H | SCHF₂ | Br |
| Et | 6-Cl | H | SCHF₂ | Br |
| i-Pr | 6-Cl | H | SCHF₂ | Br |
| t-Bu | 6-Cl | H | SCHF₂ | Br |
| Me | 6-Cl | H | OCF₃ | Br |
| Et | 6-Cl | H | OCF₃ | Br |
| i-Pr | 6-Cl | H | OCF₃ | Br |
| t-Bu | 6-Cl | H | OCF₃ | Br |
| Me | 6-Cl | H | SCF₃ | Br |
| Et | 6-Cl | H | SCF₃ | Br |
| i-Pr | 6-Cl | H | SCF₃ | Br |
| t-Bu | 6-Cl | H | SCF₃ | Br |
| Me | 6-Cl | H | C₂F₅ | Br |
| Et | 6-Cl | H | C₂F₅ | Br |
| i-Pr | 6-Cl | H | C₂F₅ | Br |
| t-Bu | 6-Cl | H | C₂F₅ | Br |
| Me | 6-Cl | H | n-C₃F₇ | Br |
| Et | 6-Cl | H | n-C₃F₇ | Br |
| i-Pr | 6-Cl | H | n-C₃F₇ | Br |
| t-Bu | 6-Cl | H | n-C₃F₇ | Br |
| Me | 6-Cl | H | i-C₃F₇ | Br |
| Et | 6-Cl | H | i-C₃F₇ | Br |
| i-Pr | 6-Cl | H | i-C₃F₇ | Br |
| t-Bu | 6-Cl | H | i-C₃F₇ | Br |
| Me | 6-Cl | H | CN | Br |
| Et | 6-Cl | H | CN | Br |
| i-Pr | 6-Cl | H | CN | Br |
| t-Bu | 6-Cl | H | CN | Br |
| Me | 6-Cl | H | OCHF₂ | CF₃ |
| Et | 6-Cl | H | OCHF₂ | CF₃ |
| i-Pr | 6-Cl | H | OCHF₂ | CF₃ |
| t-Bu | 6-Cl | H | OCHF₂ | CF₃ |
| Me | 6-Cl | H | SCHF₂ | CF₃ |
| Et | 6-Cl | H | SCHF₂ | CF₃ |
| i-Pr | 6-Cl | H | SCHF₂ | CF₃ |
| t-Bu | 6-Cl | H | SCHF₂ | CF₃ |
| Me | 6-Cl | H | OCF₃ | CF₃ |
| Et | 6-Cl | H | OCF₃ | CF₃ |
| i-Pr | 6-Cl | H | OCF₃ | CF₃ |
| t-Bu | 6-Cl | H | OCF₃ | CF₃ |
| Me | 6-Cl | H | SCF₃ | CF₃ |
| Et | 6-Cl | H | SCF₃ | CF₃ |
| i-Pr | 6-Cl | H | SCF₃ | CF₃ |
| t-Bu | 6-Cl | H | SCF₃ | CF₃ |
| Me | 6-Cl | H | C₂F₅ | CF₃ |
| Et | 6-Cl | H | C₂F₅ | CF₃ |
| i-Pr | 6-Cl | H | C₂F₅ | CF₃ |
| t-Bu | 6-Cl | H | C₂F₅ | CF₃ |
| Me | 6-Cl | H | n-C₃F₇ | CF₃ |
| Et | 6-Cl | H | n-C₃F₇ | CF₃ |
| i-Pr | 6-Cl | H | n-C₃F₇ | CF₃ |
| t-Bu | 6-Cl | H | n-C₃F₇ | CF₃ |
| Me | 6-Cl | H | i-C₃F₇ | CF₃ |
| Et | 6-Cl | H | i-C₃F₇ | CF₃ |
| i-Pr | 6-Cl | H | i-C₃F₇ | CF₃ |
| t-Bu | 6-Cl | H | i-C₃F₇ | CF₃ |
| Me | 6-Cl | H | CN | CF₃ |
| Et | 6-Cl | H | CN | CF₃ |
| i-Pr | 6-Cl | H | CN | CF₃ |
| t-Bu | 6-Cl | H | CN | CF₃ |
| Me | 6-Cl | Cl | OCHF₂ | F |
| Et | 6-Cl | Cl | OCHF₂ | F |
| i-Pr | 6-Cl | Cl | OCHF₂ | F |
| t-Bu | 6-Cl | Cl | OCHF₂ | F |
| Me | 6-Cl | Cl | SCHF₂ | F |
| Et | 6-Cl | Cl | SCHF₂ | F |
| i-Pr | 6-Cl | Cl | SCHF₂ | F |
| t-Bu | 6-Cl | Cl | SCHF₂ | F |
| Me | 6-Cl | Cl | OCF₃ | F |
| Et | 6-Cl | Cl | OCF₃ | F |
| i-Pr | 6-Cl | Cl | OCF₃ | F |
| t-Bu | 6-Cl | Cl | OCF₃ | F |
| Me | 6-Cl | Cl | SCF₃ | F |
| Et | 6-Cl | Cl | SCF₃ | F |
| i-Pr | 6-Cl | Cl | SCF₃ | F |
| t-Bu | 6-Cl | Cl | SCF₃ | F |
| Me | 6-Cl | Cl | C₂F₅ | F |
| Et | 6-Cl | Cl | C₂F₅ | F |
| i-Pr | 6-Cl | Cl | C₂F₅ | F |
| t-Bu | 6-Cl | Cl | C₂F₅ | F |
| Me | 6-Cl | Cl | n-C₃F₇ | F |
| Et | 6-Cl | Cl | n-C₃F₇ | F |
| i-Pr | 6-Cl | Cl | n-C₃F₇ | F |
| t-Bu | 6-Cl | Cl | n-C₃F₇ | F |
| Me | 6-Cl | Cl | i-C₃F₇ | F |
| Et | 6-Cl | Cl | i-C₃F₇ | F |
| i-Pr | 6-Cl | Cl | i-C₃F₇ | F |
| t-Bu | 6-Cl | Cl | i-C₃F₇ | F |
| Me | 6-Cl | Cl | CN | F |
| Et | 6-Cl | Cl | CN | F |
| i-Pr | 6-Cl | Cl | CN | F |
| t-Bu | 6-Cl | Cl | CN | F |
| Me | 6-Cl | Cl | OCHF₂ | Cl |
| Et | 6-Cl | Cl | OCHF₂ | Cl |
| i-Pr | 6-Cl | Cl | OCHF₂ | Cl |
| t-Bu | 6-Cl | Cl | OCHF₂ | Cl |
| Me | 6-Cl | Cl | SCHF₂ | Cl |
| Et | 6-Cl | Cl | SCHF₂ | Cl |
| i-Pr | 6-Cl | Cl | SCHF₂ | Cl |
| t-Bu | 6-Cl | Cl | SCHF₂ | Cl |
| Me | 6-Cl | Cl | OCF₃ | Cl |
| Et | 6-Cl | Cl | OCF₃ | Cl |
| i-Pr | 6-Cl | Cl | OCF₃ | Cl |
| t-Bu | 6-Cl | Cl | OCF₃ | Cl |
| Me | 6-Cl | Cl | SCF₃ | Cl |
| Et | 6-Cl | Cl | SCF₃ | Cl |
| i-Pr | 6-Cl | Cl | SCF₃ | Cl |
| t-Bu | 6-Cl | Cl | SCF₃ | Cl |
| Me | 6-Cl | Cl | C₂F₅ | Cl |
| Et | 6-Cl | Cl | C₂F₅ | Cl |
| i-Pr | 6-Cl | Cl | C₂F₅ | Cl |
| t-Bu | 6-Cl | Cl | C₂F₅ | Cl |
| Me | 6-Cl | Cl | n-C₃F₇ | Cl |
| Et | 6-Cl | Cl | n-C₃F₇ | Cl |
| i-Pr | 6-Cl | Cl | n-C₃F₇ | Cl |
| t-Bu | 6-Cl | Cl | n-C₃F₇ | Cl |
| Me | 6-Cl | Cl | i-C₃F₇ | Cl |
| Et | 6-Cl | Cl | i-C₃F₇ | Cl |
| i-Pr | 6-Cl | Cl | i-C₃F₇ | Cl |
| t-Bu | 6-Cl | Cl | i-C₃F₇ | Cl |
| Me | 6-Cl | Cl | CN | Cl |
| Et | 6-Cl | Cl | CN | Cl |
| i-Pr | 6-Cl | Cl | CN | Cl |
| t-Bu | 6-Cl | Cl | CN | Cl |
| Me | 6-Cl | Cl | OCHF₂ | Br |
| Et | 6-Cl | Cl | OCHF₂ | Br |
| i-Pr | 6-Cl | Cl | OCHF₂ | Br |
| t-Bu | 6-Cl | Cl | OCHF₂ | Br |
| Me | 6-Cl | Cl | SCHF₂ | Br |
| Et | 6-Cl | Cl | SCHF₂ | Br |
| i-Pr | 6-Cl | Cl | SCHF₂ | Br |
| t-Bu | 6-Cl | Cl | SCHF₂ | Br |
| Me | 6-Cl | Cl | OCF₃ | Br |
| Et | 6-Cl | Cl | OCF₃ | Br |
| i-Pr | 6-Cl | Cl | OCF₃ | Br |
| t-Bu | 6-Cl | Cl | OCF₃ | Br |
| Me | 6-Cl | Cl | SCF₃ | Br |
| Et | 6-Cl | Cl | SCF₃ | Br |
| i-Pr | 6-Cl | Cl | SCF₃ | Br |
| t-Bu | 6-Cl | Cl | SCF₃ | Br |
| Me | 6-Cl | Cl | C₂F₅ | Br |
| Et | 6-Cl | Cl | C₂F₅ | Br |
| i-Pr | 6-Cl | Cl | C₂F₅ | Br |
| t-Bu | 6-Cl | Cl | C₂F₅ | Br |
| Me | 6-Cl | Cl | n-C₃F₇ | Br |
| Et | 6-Cl | Cl | n-C₃F₇ | Br |
| i-Pr | 6-Cl | Cl | n-C₃F₇ | Br |
| t-Bu | 6-Cl | Cl | n-C₃F₇ | Br |
| Me | 6-Cl | Cl | i-C₃F₇ | Br |
| Et | 6-Cl | Cl | i-C₃F₇ | Br |
| i-Pr | 6-Cl | Cl | i-C₃F₇ | Br |
| t-Bu | 6-Cl | Cl | i-C₃F₇ | Br |
| Me | 6-Cl | Cl | CN | Br |
| Et | 6-Cl | Cl | CN | Br |
| i-Pr | 6-Cl | Cl | CN | Br |
| t-Bu | 6-Cl | Cl | CN | Br |
| Me | 6-Cl | Cl | OCHF₂ | CF₃ |
| Et | 6-Cl | Cl | OCHF₂ | CF₃ |
| i-Pr | 6-Cl | Cl | OCHF₂ | CF₃ |
| t-Bu | 6-Cl | Cl | OCHF₂ | CF₃ |
| Me | 6-Cl | Cl | SCHF₂ | CF₃ |
| Et | 6-Cl | Cl | SCHF₂ | CF₃ |
| i-Pr | 6-Cl | Cl | SCHF₂ | CF₃ |
| t-Bu | 6-Cl | Cl | SCHF₂ | CF₃ |
| Me | 6-Cl | Cl | OCF₃ | CF₃ |
| Et | 6-Cl | Cl | OCF₃ | CF₃ |
| i-Pr | 6-Cl | Cl | OCF₃ | CF₃ |
| t-Bu | 6-Cl | Cl | OCF₃ | CF₃ |
| Me | 6-Cl | Cl | SCF₃ | CF₃ |
| Et | 6-Cl | Cl | SCF₃ | CF₃ |
| i-Pr | 6-Cl | Cl | SCF₃ | CF₃ |
| t-Bu | 6-Cl | Cl | SCF₃ | CF₃ |
| Me | 6-Cl | Cl | C₂F₅ | CF₃ |
| Et | 6-Cl | Cl | C₂F₅ | CF₃ |
| i-Pr | 6-Cl | Cl | C₂F₅ | CF₃ |
| t-Bu | 6-Cl | Cl | C₂F₅ | CF₃ |
| Me | 6-Cl | Cl | n-C₃F₇ | CF₃ |
| Et | 6-Cl | Cl | n-C₃F₇ | CF₃ |
| i-Pr | 6-Cl | Cl | n-C₃F₇ | CF₃ |
| t-Bu | 6-Cl | Cl | n-C₃F₇ | CF₃ |
| Me | 6-Cl | Cl | i-C₃F₇ | CF₃ |
| Et | 6-Cl | Cl | i-C₃F₇ | CF₃ |
| i-Pr | 6-Cl | Cl | i-C₃F₇ | CF₃ |
| t-Bu | 6-Cl | Cl | i-C₃F₇ | CF₃ |
| Me | 6-Cl | Cl | CN | CF₃ |
| Et | 6-Cl | Cl | CN | CF₃ |
| i-Pr | 6-Cl | Cl | CN | CF₃ |
| t-Bu | 6-Cl | Cl | CN | CF₃ |

TABLE 6

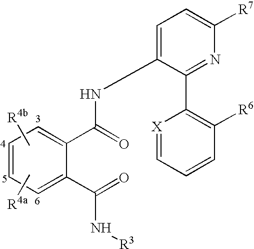

| R³ | R^{4a} | R^{4b} | R⁷ | R⁶ | X |
|---|---|---|---|---|---|
| Me | 6-Me | H | OCHF₂ | F | CH |
| Et | 6-Me | H | OCHF₂ | F | CH |
| i-Pr | 6-Me | H | OCHF₂ | F | CH |
| t-Bu | 6-Me | H | OCHF₂ | F | CH |
| Me | 6-Me | H | SCHF₂ | F | CH |
| Et | 6-Me | H | SCHF₂ | F | CH |
| i-Pr | 6-Me | H | SCHF₂ | F | CH |
| t-Bu | 6-Me | H | SCHF₂ | F | CH |
| Me | 6-Me | H | OCF₃ | F | CH |
| Et | 6-Me | H | OCF₃ | F | CH |
| i-Pr | 6-Me | H | OCF₃ | F | CH |
| t-Bu | 6-Me | H | OCF₃ | F | CH |
| Me | 6-Me | H | SCF₃ | F | CH |
| Et | 6-Me | H | SCF₃ | F | CH |
| i-Pr | 6-Me | H | SCF₃ | F | CH |
| t-Bu | 6-Me | H | SCF₃ | F | CH |
| Me | 6-Me | H | C₂F₅ | F | CH |
| Et | 6-Me | H | C₂F₅ | F | CH |
| i-Pr | 6-Me | H | C₂F₅ | F | CH |
| t-Bu | 6-Me | H | C₂F₅ | F | CH |
| Me | 6-Me | H | n-C₃F₇ | F | CH |
| Et | 6-Me | H | n-C₃F₇ | F | CH |
| i-Pr | 6-Me | H | n-C₃F₇ | F | CH |
| t-Bu | 6-Me | H | n-C₃F₇ | F | CH |
| Me | 6-Me | H | i-C₃F₇ | F | CH |
| Et | 6-Me | H | i-C₃F₇ | F | CH |
| i-Pr | 6-Me | H | i-C₃F₇ | F | CH |
| t-Bu | 6-Me | H | i-C₃F₇ | F | CH |
| Me | 6-Me | H | CN | F | CH |
| Et | 6-Me | H | CN | F | CH |
| i-Pr | 6-Me | H | CN | F | CH |
| t-Bu | 6-Me | H | CN | F | CH |
| Me | 6-Me | H | OCHF₂ | Cl | CH |
| Et | 6-Me | H | OCHF₂ | Cl | CH |
| i-Pr | 6-Me | H | OCHF₂ | Cl | CH |
| t-Bu | 6-Me | H | OCHF₂ | Cl | CH |
| Me | 6-Me | H | SCHF₂ | Cl | CH |
| Et | 6-Me | H | SCHF₂ | Cl | CH |
| i-Pr | 6-Me | H | SCHF₂ | Cl | CH |
| t-Bu | 6-Me | H | SCHF₂ | Cl | CH |
| Me | 6-Me | H | OCF₃ | Cl | CH |
| Et | 6-Me | H | OCF₃ | Cl | CH |
| i-Pr | 6-Me | H | OCF₃ | Cl | CH |
| t-Bu | 6-Me | H | OCF₃ | Cl | CH |
| Me | 6-Me | H | SCF₃ | Cl | CH |
| Et | 6-Me | H | SCF₃ | Cl | CH |
| i-Pr | 6-Me | H | SCF₃ | Cl | CH |
| t-Bu | 6-Me | H | SCF₃ | Cl | CH |
| Me | 6-Me | H | C₂F₅ | Cl | CH |
| Et | 6-Me | H | C₂F₅ | Cl | CH |
| i-Pr | 6-Me | H | C₂F₅ | Cl | CH |
| t-Bu | 6-Me | H | C₂F₅ | Cl | CH |
| Me | 6-Me | H | n-C₃F₇ | Cl | CH |
| Et | 6-Me | H | n-C₃F₇ | Cl | CH |
| i-Pr | 6-Me | H | n-C₃F₇ | Cl | CH |
| t-Bu | 6-Me | H | n-C₃F₇ | Cl | CH |
| Me | 6-Me | H | i-C₃F₇ | Cl | CH |
| Et | 6-Me | H | i-C₃F₇ | Cl | CH |
| i-Pr | 6-Me | H | i-C₃F₇ | Cl | CH |
| t-Bu | 6-Me | H | i-C₃F₇ | Cl | CH |
| Me | 6-Me | H | CN | Cl | CH |
| Et | 6-Me | H | CN | Cl | CH |
| i-Pr | 6-Me | H | CN | Cl | CH |
| t-Bu | 6-Me | H | CN | Cl | CH |
| Me | 6-Me | H | OCHF₂ | Br | CH |
| Et | 6-Me | H | OCHF₂ | Br | CH |
| i-Pr | 6-Me | H | OCHF₂ | Br | CH |
| t-Bu | 6-Me | H | OCHF₂ | Br | CH |
| Me | 6-Me | H | SCHF₂ | Br | CH |
| Et | 6-Me | H | SCHF₂ | Br | CH |
| i-Pr | 6-Me | H | SCHF₂ | Br | CH |
| t-Bu | 6-Me | H | SCHF₂ | Br | CH |
| Me | 6-Me | H | OCF₃ | Br | CH |
| Et | 6-Me | H | OCF₃ | Br | CH |
| i-Pr | 6-Me | H | OCF₃ | Br | CH |
| t-Bu | 6-Me | H | OCF₃ | Br | CH |
| Me | 6-Me | H | SCF₃ | Br | CH |
| Et | 6-Me | H | SCF₃ | Br | CH |
| i-Pr | 6-Me | H | SCF₃ | Br | CH |
| t-Bu | 6-Me | H | SCF₃ | Br | CH |
| Me | 6-Me | H | C₂F₅ | Br | CH |
| Et | 6-Me | H | C₂F₅ | Br | CH |
| i-Pr | 6-Me | H | C₂F₅ | Br | CH |
| t-Bu | 6-Me | H | C₂F₅ | Br | CH |
| Me | 6-Me | H | n-C₃F₇ | Br | CH |
| Et | 6-Me | H | n-C₃F₇ | Br | CH |
| i-Pr | 6-Me | H | n-C₃F₇ | Br | CH |
| t-Bu | 6-Me | H | n-C₃F₇ | Br | CH |
| Me | 6-Me | H | i-C₃F₇ | Br | CH |
| Et | 6-Me | H | i-C₃F₇ | Br | CH |
| i-Pr | 6-Me | H | i-C₃F₇ | Br | CH |
| t-Bu | 6-Me | H | i-C₃F₇ | Br | CH |
| Me | 6-Me | H | CN | Br | CH |
| Et | 6-Me | H | CN | Br | CH |
| i-Pr | 6-Me | H | CN | Br | CH |
| t-Bu | 6-Me | H | CN | Br | CH |
| Me | 6-Me | H | OCHF₂ | CF₃ | CH |
| Et | 6-Me | H | OCHF₂ | CF₃ | CH |
| i-Pr | 6-Me | H | OCHF₂ | CF₃ | CH |
| t-Bu | 6-Me | H | OCHF₂ | CF₃ | CH |
| Me | 6-Me | H | SCHF₂ | CF₃ | CH |
| Et | 6-Me | H | SCHF₂ | CF₃ | CH |
| i-Pr | 6-Me | H | SCHF₂ | CF₃ | CH |
| t-Bu | 6-Me | H | SCHF₂ | CF₃ | CH |
| Me | 6-Me | H | OCF₃ | CF₃ | CH |
| Et | 6-Me | H | OCF₃ | CF₃ | CH |
| i-Pr | 6-Me | H | OCF₃ | CF₃ | CH |
| t-Bu | 6-Me | H | OCF₃ | CF₃ | CH |
| Me | 6-Me | H | SCF₃ | CF₃ | CH |
| Et | 6-Me | H | SCF₃ | CF₃ | CH |
| i-Pr | 6-Me | H | SCF₃ | CF₃ | CH |
| t-Bu | 6-Me | H | SCF₃ | CF₃ | CH |
| Me | 6-Me | H | C₂F₅ | CF₃ | CH |
| Et | 6-Me | H | C₂F₅ | CF₃ | CH |
| i-Pr | 6-Me | H | C₂F₅ | CF₃ | CH |
| t-Bu | 6-Me | H | C₂F₅ | CF₃ | CH |
| Me | 6-Me | H | n-C₃F₇ | CF₃ | CH |
| Et | 6-Me | H | n-C₃F₇ | CF₃ | CH |
| i-Pr | 6-Me | H | n-C₃F₇ | CF₃ | CH |
| t-Bu | 6-Me | H | n-C₃F₇ | CF₃ | CH |
| Me | 6-Me | H | i-C₃F₇ | CF₃ | CH |
| Et | 6-Me | H | i-C₃F₇ | CF₃ | CH |
| i-Pr | 6-Me | H | i-C₃F₇ | CF₃ | CH |
| t-Bu | 6-Me | H | i-C₃F₇ | CF₃ | CH |
| Me | 6-Me | H | CN | CF₃ | CH |
| Et | 6-Me | H | CN | CF₃ | CH |
| i-Pr | 6-Me | H | CN | CF₃ | CH |
| t-Bu | 6-Me | H | CN | CF₃ | CH |
| Me | 6-Me | Cl | OCHF₂ | F | CH |
| Et | 6-Me | Cl | OCHF₂ | F | CH |
| i-Pr | 6-Me | Cl | OCHF₂ | F | CH |
| t-Bu | 6-Me | Cl | OCHF₂ | F | CH |
| Me | 6-Me | Cl | SCHF₂ | F | CH |
| Et | 6-Me | Cl | SCHF₂ | F | CH |
| i-Pr | 6-Me | Cl | SCHF₂ | F | CH |
| t-Bu | 6-Me | Cl | SCHF₂ | F | CH |
| Me | 6-Me | Cl | OCF₃ | F | CH |
| Et | 6-Me | Cl | OCF₃ | F | CH |
| i-Pr | 6-Me | Cl | OCF₃ | F | CH |
| t-Bu | 6-Me | Cl | OCF₃ | F | CH |
| Me | 6-Me | Cl | SCF₃ | F | CH |
| Et | 6-Me | Cl | SCF₃ | F | CH |
| i-Pr | 6-Me | Cl | SCF₃ | F | CH |
| t-Bu | 6-Me | Cl | SCF₃ | F | CH |
| Me | 6-Me | Cl | C₂F₅ | F | CH |
| Et | 6-Me | Cl | C₂F₅ | F | CH |
| i-Pr | 6-Me | Cl | C₂F₅ | F | CH |
| t-Bu | 6-Me | Cl | C₂F₅ | F | CH |
| Me | 6-Me | Cl | n-C₃F₇ | F | CH |
| Et | 6-Me | Cl | n-C₃F₇ | F | CH |
| i-Pr | 6-Me | Cl | n-C₃F₇ | F | CH |
| t-Bu | 6-Me | Cl | n-C₃F₇ | F | CH |
| Me | 6-Me | Cl | i-C₃F₇ | F | CH |
| Et | 6-Me | Cl | i-C₃F₇ | F | CH |
| i-Pr | 6-Me | Cl | i-C₃F₇ | F | CH |
| t-Bu | 6-Me | Cl | i-C₃F₇ | F | CH |
| Me | 6-Me | Cl | CN | F | CH |
| Et | 6-Me | Cl | CN | F | CH |
| i-Pr | 6-Me | Cl | CN | F | CH |
| t-Bu | 6-Me | Cl | CN | F | CH |
| Me | 6-Me | Cl | OCHF₂ | Cl | CH |
| Et | 6-Me | Cl | OCHF₂ | Cl | CH |
| i-Pr | 6-Me | Cl | OCHF₂ | Cl | CH |
| t-Bu | 6-Me | Cl | OCHF₂ | Cl | CH |
| Me | 6-Me | Cl | SCHF₂ | Cl | Cl |
| Et | 6-Me | Cl | SCHF₂ | Cl | CH |
| i-Pr | 6-Me | Cl | SCHF₂ | Cl | CH |
| t-Bu | 6-Me | Cl | SCHF₂ | Cl | CH |
| Me | 6-Me | Cl | OCF₃ | Cl | CH |
| Et | 6-Me | Cl | OCF₃ | Cl | CH |
| i-Pr | 6-Me | Cl | OCF₃ | Cl | CH |
| t-Bu | 6-Me | Cl | OCF₃ | Cl | CH |
| Me | 6-Me | Cl | SCF₃ | Cl | CH |
| Et | 6-Me | Cl | SCF₃ | Cl | CH |
| i-Pr | 6-Me | Cl | SCF₃ | Cl | CH |
| t-Bu | 6-Me | Cl | SCF₃ | Cl | CH |
| Me | 6-Me | Cl | C₂F₅ | Cl | CH |
| Et | 6-Me | Cl | C₂F₅ | Cl | CH |
| i-Pr | 6-Me | Cl | C₂F₅ | Cl | CH |
| t-Bu | 6-Me | Cl | C₂F₅ | Cl | CH |
| Me | 6-Me | Cl | n-C₃F₇ | Cl | CH |
| Et | 6-Me | Cl | n-C₃F₇ | Cl | CH |
| i-Pr | 6-Me | Cl | n-C₃F₇ | Cl | CH |
| t-Bu | 6-Me | Cl | n-C₃F₇ | Cl | CH |
| Me | 6-Me | Cl | i-C₃F₇ | Cl | CH |
| Et | 6-Me | Cl | i-C₃F₇ | Cl | CH |
| i-Pr | 6-Me | Cl | i-C₃F₇ | Cl | CH |
| t-Bu | 6-Me | Cl | i-C₃F₇ | Cl | CH |
| Me | 6-Me | Cl | CN | Cl | CH |
| Et | 6-Me | Cl | CN | Cl | CH |
| i-Pr | 6-Me | Cl | CN | Cl | CH |
| t-Bu | 6-Me | Cl | CN | Cl | CH |
| Me | 6-Me | Cl | OCHF₂ | Br | CH |
| Et | 6-Me | Cl | OCHF₂ | Br | CH |
| i-Pr | 6-Me | Cl | OCHF₂ | Br | CH |
| t-Bu | 6-Me | Cl | OCHF₂ | Br | CH |
| Me | 6-Me | Cl | SCHF₂ | Br | CH |
| Et | 6-Me | Cl | SCHF₂ | Br | CH |
| i-Pr | 6-Me | Cl | SCHF₂ | Br | CH |
| t-Bu | 6-Me | Cl | SCHF₂ | Br | CH |
| Me | 6-Me | Cl | OCF₃ | Br | CH |
| Et | 6-Me | Cl | OCF₃ | Br | CH |
| i-Pr | 6-Me | Cl | OCF₃ | Br | CH |
| t-Bu | 6-Me | Cl | OCF₃ | Br | CH |
| Me | 6-Me | Cl | SCF₃ | Br | CH |
| Et | 6-Me | Cl | SCF₃ | Br | CH |
| i-Pr | 6-Me | Cl | SCF₃ | Br | CH |
| t-Bu | 6-Me | Cl | SCF₃ | Br | CH |
| Me | 6-Me | Cl | C₂F₅ | Br | CH |
| Et | 6-Me | Cl | C₂F₅ | Br | CH |
| i-Pr | 6-Me | Cl | C₂F₅ | Br | CH |
| t-Bu | 6-Me | Cl | C₂F₅ | Br | CH |
| Me | 6-Me | Cl | n-C₃F₇ | Br | CH |
| Et | 6-Me | Cl | n-C₃F₇ | Br | CH |
| i-Pr | 6-Me | Cl | n-C₃F₇ | Br | CH |
| t-Bu | 6-Me | Cl | n-C₃F₇ | Br | CH |
| Me | 6-Me | Cl | i-C₃F₇ | Br | CH |
| Et | 6-Me | Cl | i-C₃F₇ | Br | CH |
| i-Pr | 6-Me | Cl | i-C₃F₇ | Br | CH |
| t-Bu | 6-Me | Cl | i-C₃F₇ | Br | CH |
| Me | 6-Me | Cl | CN | Br | CH |
| Et | 6-Me | Cl | CN | Br | CH |
| i-Pr | 6-Me | Cl | CN | Br | CH |
| t-Bu | 6-Me | Cl | CN | Br | CH |
| Me | 6-Me | Cl | OCHF₂ | CF₃ | CH |
| Et | 6-Me | Cl | OCHF₂ | CF₃ | CH |
| i-Pr | 6-Me | Cl | OCHF₂ | CF₃ | CH |
| t-Bu | 6-Me | Cl | OCHF₂ | CF₃ | CH |
| Me | 6-Me | Cl | SCHF₂ | CF₃ | CH |
| Et | 6-Me | Cl | SCHF₂ | CF₃ | CH |
| i-Pr | 6-Me | Cl | SCHF₂ | CF₃ | CH |
| t-Bu | 6-Me | Cl | SCHF₂ | CF₃ | CH |
| Me | 6-Me | Cl | OCF₃ | CF₃ | CH |
| Et | 6-Me | Cl | OCF₃ | CF₃ | CH |
| i-Pr | 6-Me | Cl | OCF₃ | CF₃ | CH |
| t-Bu | 6-Me | Cl | OCF₃ | CF₃ | CH |
| Me | 6-Me | Cl | SCF₃ | CF₃ | CH |
| Et | 6-Me | Cl | SCF₃ | CF₃ | CH |
| i-Pr | 6-Me | Cl | SCF₃ | CF₃ | CH |
| t-Bu | 6-Me | Cl | SCF₃ | CF₃ | CH |
| Me | 6-Me | Cl | C₂F₅ | CF₃ | CH |
| Et | 6-Me | Cl | C₂F₅ | CF₃ | CH |
| i-Pr | 6-Me | Cl | C₂F₅ | CF₃ | CH |
| t-Bu | 6-Me | Cl | C₂F₅ | CF₃ | CH |
| Me | 6-Me | Cl | n-C₃F₇ | CF₃ | CH |
| Et | 6-Me | Cl | n-C₃F₇ | CF₃ | CH |
| i-Pr | 6-Me | Cl | n-C₃F₇ | CF₃ | CH |
| t-Bu | 6-Me | Cl | n-C₃F₇ | CF₃ | CH |
| Me | 6-Me | Cl | i-C₃F₇ | CF₃ | CH |
| Et | 6-Me | Cl | i-C₃F₇ | CF₃ | CH |
| i-Pr | 6-Me | Cl | i-C₃F₇ | CF₃ | CH |
| t-Bu | 6-Me | Cl | i-C₃F₇ | CF₃ | CH |
| Me | 6-Me | Cl | CN | CF₃ | CH |
| Et | 6-Me | Cl | CN | CF₃ | CH |
| i-Pr | 6-Me | Cl | CN | CF₃ | CH |
| t-Bu | 6-Me | Cl | CN | CF₃ | CH |
| Me | 6-Me | H | OCHF₂ | F | CF |
| Et | 6-Me | H | OCHF₂ | F | CF |
| i-Pr | 6-Me | H | OCHF₂ | F | CF |
| t-Bu | 6-Me | H | OCHF₂ | F | CF |
| Me | 6-Me | H | SCHF₂ | F | CF |
| Et | 6-Me | H | SCHF₂ | F | CF |
| i-Pr | 6-Me | H | SCHF₂ | F | CF |
| t-Bu | 6-Me | H | SCHF₂ | F | CF |
| Me | 6-Me | H | OCF₃ | F | CF |
| Et | 6-Me | H | OCF₃ | F | CF |
| i-Pr | 6-Me | H | OCF₃ | F | CF |
| t-Bu | 6-Me | H | OCF₃ | F | CF |
| Me | 6-Me | H | SCF₃ | F | CF |
| Et | 6-Me | H | SCF₃ | F | CF |
| i-Pr | 6-Me | H | SCF₃ | F | CF |
| t-Bu | 6-Me | H | SCF₃ | F | CF |
| Me | 6-Me | H | C₂F₅ | F | CF |
| Et | 6-Me | H | C₂F₅ | F | CF |
| i-Pr | 6-Me | H | C₂F₅ | F | CF |
| t-Bu | 6-Me | H | C₂F₅ | F | CF |
| Me | 6-Me | H | n-C₃F₇ | F | CF |
| Et | 6-Me | H | n-C₃F₇ | F | CF |
| i-Pr | 6-Me | H | n-C₃F₇ | F | CF |
| t-Bu | 6-Me | H | n-C₃F₇ | F | CF |
| Me | 6-Me | H | i-C₃F₇ | F | CF |
| Et | 6-Me | H | i-C₃F₇ | F | CF |
| i-Pr | 6-Me | H | i-C₃F₇ | F | CF |
| t-Bu | 6-Me | H | i-C₃F₇ | F | CF |
| Me | 6-Me | H | CN | F | CF |
| Et | 6-Me | H | CN | F | CF |
| i-Pr | 6-Me | H | CN | F | CF |
| t-Bu | 6-Me | H | CN | F | CF |
| Me | 6-Me | H | OCHF₂ | Cl | CCl |
| Et | 6-Me | H | OCHF₂ | Cl | CCl |
| i-Pr | 6-Me | H | OCHF₂ | Cl | CCl |
| t-Bu | 6-Me | H | OCHF₂ | Cl | CCl |
| Me | 6-Me | H | SCHF₂ | Cl | CCl |
| Et | 6-Me | H | SCHF₂ | Cl | CCl |
| i-Pr | 6-Me | H | SCHF₂ | Cl | CCl |
| t-Bu | 6-Me | H | SCHF₂ | Cl | CCl |
| Me | 6-Me | H | OCF₃ | Cl | CCl |
| Et | 6-Me | H | OCF₃ | Cl | CCl |
| i-Pr | 6-Me | H | OCF₃ | Cl | CCl |
| t-Bu | 6-Me | H | OCF₃ | Cl | CCl |
| Me | 6-Me | H | SCF₃ | Cl | CCl |
| Et | 6-Me | H | SCF₃ | Cl | CCl |
| i-Pr | 6-Me | H | SCF₃ | Cl | CCl |
| t-Bu | 6-Me | H | SCF₃ | Cl | CCl |
| Me | 6-Me | H | C₂F₅ | Cl | CCl |
| Et | 6-Me | H | C₂F₅ | Cl | CCl |
| i-Pr | 6-Me | H | C₂F₅ | Cl | CCl |
| t-Bu | 6-Me | H | C₂F₅ | Cl | CCl |
| Me | 6-Me | H | n-C₃F₇ | Cl | CCl |
| Et | 6-Me | H | n-C₃F₇ | Cl | CCl |
| i-Pr | 6-Me | H | n-C₃F₇ | Cl | CCl |
| t-Bu | 6-Me | H | n-C₃F₇ | Cl | CCl |
| Me | 6-Me | H | i-C₃F₇ | Cl | CCl |
| Et | 6-Me | H | i-C₃F₇ | Cl | CCl |
| i-Pr | 6-Me | H | i-C₃F₇ | Cl | CCl |
| t-Bu | 6-Me | H | i-C₃F₇ | Cl | CCl |
| Me | 6-Me | H | CN | Cl | CCl |
| Et | 6-Me | H | CN | Cl | CCl |
| i-Pr | 6-Me | H | CN | Cl | CCl |
| t-Bu | 6-Me | H | CN | Cl | CCl |
| Me | 3-Me | H | OCHF₂ | F | CH |
| Et | 3-Me | H | OCHF₂ | F | CH |
| i-Pr | 3-Me | H | OCHF₂ | F | CH |
| t-Bu | 3-Me | H | OCHF₂ | F | CH |
| Me | 3-Me | H | SCHF₂ | F | CH |
| Et | 3-Me | H | SCHF₂ | F | CH |
| i-Pr | 3-Me | H | SCHF₂ | F | CH |
| t-Bu | 3-Me | H | SCHF₂ | F | CH |
| Me | 3-Me | H | OCF₃ | F | CH |
| Et | 3-Me | H | OCF₃ | F | CH |
| i-Pr | 3-Me | H | OCF₃ | F | CH |
| t-Bu | 3-Me | H | OCF₃ | F | CH |
| Me | 3-Me | H | SCF₃ | F | CH |
| Et | 3-Me | H | SCF₃ | F | CH |
| i-Pr | 3-Me | H | SCF₃ | F | CH |
| t-Bu | 3-Me | H | SCF₃ | F | CH |
| Me | 3-Me | H | C₂F₅ | F | CH |
| Et | 3-Me | H | C₂F₅ | F | CH |
| i-Pr | 3-Me | H | C₂F₅ | F | CH |
| t-Bu | 3-Me | H | C₂F₅ | F | CH |
| Me | 3-Me | H | n-C₃F₇ | F | CH |
| Et | 3-Me | H | n-C₃F₇ | F | CH |
| i-Pr | 3-Me | H | n-C₃F₇ | F | CH |
| t-Bu | 3-Me | H | n-C₃F₇ | F | CH |
| Me | 3-Me | H | i-C₃F₇ | F | CH |
| Et | 3-Me | H | i-C₃F₇ | F | CH |
| i-Pr | 3-Me | H | i-C₃F₇ | F | CH |
| t-Bu | 3-Me | H | i-C₃F₇ | F | CH |
| Me | 3-Me | H | CN | F | CH |
| Et | 3-Me | H | CN | F | CH |
| i-Pr | 3-Me | H | CN | F | CH |
| t-Bu | 3-Me | H | CN | F | CH |
| Me | 3-Me | H | OCHF₂ | Cl | CH |
| Et | 3-Me | H | OCHF₂ | Cl | CH |
| i-Pr | 3-Me | H | OCHF₂ | Cl | CH |
| t-Bu | 3-Me | H | OCHF₂ | Cl | CH |
| Me | 3-Me | H | SCHF₂ | Cl | CH |
| Et | 3-Me | H | SCHF₂ | Cl | CH |
| i-Pr | 3-Me | H | SCHF₂ | Cl | CH |
| t-Bu | 3-Me | H | SCHF₂ | Cl | CH |
| Me | 3-Me | H | OCF₃ | Cl | CH |
| Et | 3-Me | H | OCF₃ | Cl | CH |
| i-Pr | 3-Me | H | OCF₃ | Cl | CH |
| t-Bu | 3-Me | H | OCF₃ | Cl | CH |
| Me | 3-Me | H | SCF₃ | Cl | CH |
| Et | 3-Me | H | SCF₃ | Cl | CH |
| i-Pr | 3-Me | H | SCF₃ | Cl | CH |
| t-Bu | 3-Me | H | SCF₃ | Cl | CH |
| Me | 3-Me | H | C₂F₅ | Cl | CH |
| Et | 3-Me | H | C₂F₅ | Cl | CH |
| i-Pr | 3-Me | H | C₂F₅ | Cl | CH |
| t-Bu | 3-Me | H | C₂F₅ | Cl | CH |
| Me | 3-Me | H | n-C₃F₇ | Cl | CH |
| Et | 3-Me | H | n-C₃F₇ | Cl | CH |
| i-Pr | 3-Me | H | n-C₃F₇ | Cl | CH |
| t-Bu | 3-Me | H | n-C₃F₇ | Cl | CH |
| Me | 3-Me | H | i-C₃F₇ | Cl | CH |
| Et | 3-Me | H | i-C₃F₇ | Cl | CH |
| i-Pr | 3-Me | H | i-C₃F₇ | Cl | CH |
| t-Bu | 3-Me | H | i-C₃F₇ | Cl | CH |
| Me | 3-Me | H | CN | Cl | CH |
| Et | 3-Me | H | CN | Cl | CH |
| i-Pr | 3-Me | H | CN | Cl | CH |
| t-Bu | 3-Me | H | CN | Cl | CH |
| Me | 3-Me | H | OCHF₂ | Br | CH |
| Et | 3-Me | H | OCHF₂ | Br | CH |
| i-Pr | 3-Me | H | OCHF₂ | Br | CH |
| t-Bu | 3-Me | H | OCHF₂ | Br | CH |
| Me | 3-Me | H | SCHF₂ | Br | CH |
| Et | 3-Me | H | SCHF₂ | Br | CH |
| i-Pr | 3-Me | H | SCHF₂ | Br | CH |
| t-Bu | 3-Me | H | SCHF₂ | Br | CH |
| Me | 3-Me | H | OCF₃ | Br | CH |
| Et | 3-Me | H | OCF₃ | Br | CH |
| i-Pr | 3-Me | H | OCF₃ | Br | CH |
| t-Bu | 3-Me | H | OCF₃ | Br | CH |
| Me | 3-Me | H | SCF₃ | Br | CH |
| Et | 3-Me | H | SCF₃ | Br | CH |
| i-Pr | 3-Me | H | SCF₃ | Br | CH |
| t-Bu | 3-Me | H | SCF₃ | Br | CH |
| Me | 3-Me | H | C₂F₅ | Br | CH |
| Et | 3-Me | H | C₂F₅ | Br | CH |
| i-Pr | 3-Me | H | C₂F₅ | Br | CH |
| t-Bu | 3-Me | H | C₂F₅ | Br | CH |
| Me | 3-Me | H | n-C₃F₇ | Br | CH |
| Et | 3-Me | H | n-C₃F₇ | Br | CH |
| i-Pr | 3-Me | H | n-C₃F₇ | Br | CH |
| t-Bu | 3-Me | H | n-C₃F₇ | Br | CH |
| Me | 3-Me | H | i-C₃F₇ | Br | CH |
| Et | 3-Me | H | i-C₃F₇ | Br | CH |
| i-Pr | 3-Me | H | i-C₃F₇ | Br | CH |
| t-Bu | 3-Me | H | i-C₃F₇ | Br | CH |
| Me | 3-Me | H | CN | Br | CH |
| Et | 3-Me | H | CN | Br | CH |
| i-Pr | 3-Me | H | CN | Br | CH |
| t-Bu | 3-Me | H | CN | Br | CH |
| Me | 3-Me | H | OCHF₂ | CF₃ | CH |
| Et | 3-Me | H | OCHF₂ | CF₃ | CH |
| i-Pr | 3-Me | H | OCHF₂ | CF₃ | CH |
| t-Bu | 3-Me | H | OCHF₂ | CF₃ | CH |
| Me | 3-Me | H | SCHF₂ | CF₃ | CH |
| Et | 3-Me | H | SCHF₂ | CF₃ | CH |
| i-Pr | 3-Me | H | SCHF₂ | CF₃ | CH |
| t-Bu | 3-Me | H | SCHF₂ | CF₃ | CH |
| Me | 3-Me | H | OCF₃ | CF₃ | Cl |
| Et | 3-Me | H | OCF₃ | CF₃ | Cl |
| i-Pr | 3-Me | H | OCF₃ | CF₃ | CH |
| t-Bu | 3-Me | H | OCF₃ | CF₃ | CH |
| Me | 3-Me | H | SCF₃ | CF₃ | Cl |
| Et | 3-Me | H | SCF₃ | CF₃ | CH |
| i-Pr | 3-Me | H | SCF₃ | CF₃ | CH |
| t-Bu | 3-Me | H | SCF₃ | CF₃ | CH |
| Me | 3-Me | H | C₂F₅ | CF₃ | Cl |
| Et | 3-Me | H | C₂F₅ | CF₃ | Cl |
| i-Pr | 3-Me | H | C₂F₅ | CF₃ | CH |
| t-Bu | 3-Me | H | C₂F₅ | CF₃ | CH |
| Me | 3-Me | H | n-C₃F₇ | CF₃ | CH |
| Et | 3-Me | H | n-C₃F₇ | CF₃ | CH |
| i-Pr | 3-Me | H | n-C₃F₇ | CF₃ | CH |
| t-Bu | 3-Me | H | n-C₃F₇ | CF₃ | CH |
| Me | 3-Me | H | i-C₃F₇ | CF₃ | CH |
| Et | 3-Me | H | i-C₃F₇ | CF₃ | Cl |
| i-Pr | 3-Me | H | i-C₃F₇ | CF₃ | CH |
| t-Bu | 3-Me | H | i-C₃F₇ | CF₃ | CH |
| Me | 3-Me | H | CN | CF₃ | Cl |
| Et | 3-Me | H | CN | CF₃ | Cl |
| i-Pr | 3-Me | H | CN | CF₃ | CH |
| t-Bu | 3-Me | H | CN | CF₃ | CH |
| Me | 6-Cl | H | OCHF₂ | F | CH |
| Et | 6-Cl | H | OCHF₂ | F | CH |
| i-Pr | 6-Cl | H | OCHF₂ | F | CH |
| t-Bu | 6-Cl | H | OCHF₂ | F | CH |
| Me | 6-Cl | H | SCHF₂ | F | CH |
| Et | 6-Cl | H | SCHF₂ | F | CH |
| i-Pr | 6-Cl | H | SCHF₂ | F | CH |
| t-Bu | 6-Cl | H | SCHF₂ | F | CH |
| Me | 6-Cl | H | OCF₃ | F | CH |
| Et | 6-Cl | H | OCF₃ | F | CH |
| i-Pr | 6-Cl | H | OCF₃ | F | CH |
| t-Bu | 6-Cl | H | OCF₃ | F | CH |
| Me | 6-Cl | H | SCF₃ | F | CH |
| Et | 6-Cl | H | SCF₃ | F | CH |
| i-Pr | 6-Cl | H | SCF₃ | F | CH |
| t-Bu | 6-Cl | H | SCF₃ | F | CH |
| Me | 6-Cl | H | C₂F₅ | F | CH |
| Et | 6-Cl | H | C₂F₅ | F | CH |
| i-Pr | 6-Cl | H | C₂F₅ | F | CH |
| t-Bu | 6-Cl | H | C₂F₅ | F | CH |
| Me | 6-Cl | H | n-C₃F₇ | F | CH |
| Et | 6-Cl | H | n-C₃F₇ | F | CH |
| i-Pr | 6-Cl | H | n-C₃F₇ | F | CH |
| t-Bu | 6-Cl | H | n-C₃F₇ | F | CH |
| Me | 6-Cl | H | i-C₃F₇ | F | CH |
| Et | 6-Cl | H | i-C₃F₇ | F | CH |
| i-Pr | 6-Cl | H | i-C₃F₇ | F | CH |
| t-Bu | 6-Cl | H | i-C₃F₇ | F | CH |
| Me | 6-Cl | H | CN | F | CH |
| Et | 6-Cl | H | CN | F | CH |
| i-Pr | 6-Cl | H | CN | F | CH |
| t-Bu | 6-Cl | H | CN | F | CH |
| Me | 6-Cl | H | OCHF₂ | Cl | CH |
| Et | 6-Cl | H | OCHF₂ | Cl | CH |
| i-Pr | 6-Cl | H | OCHF₂ | Cl | CH |
| t-Bu | 6-Cl | H | OCHF₂ | Cl | CH |
| Me | 6-Cl | H | SCHF₂ | Cl | CH |
| Et | 6-Cl | H | SCHF₂ | Cl | CH |
| i-Pr | 6-Cl | H | SCHF₂ | Cl | CH |
| t-Bu | 6-Cl | H | SCHF₂ | Cl | CH |
| Me | 6-Cl | H | OCF₃ | Cl | CH |
| Et | 6-Cl | H | OCF₃ | Cl | CH |
| i-Pr | 6-Cl | H | OCF₃ | Cl | CH |
| t-Bu | 6-Cl | H | OCF₃ | Cl | CH |
| Me | 6-Cl | H | SCF₃ | Cl | CH |
| Et | 6-Cl | H | SCF₃ | Cl | CH |
| i-Pr | 6-Cl | H | SCF₃ | Cl | CH |
| t-Bu | 6-Cl | H | SCF₃ | Cl | CH |
| Me | 6-Cl | H | C₂F₅ | Cl | CH |
| Et | 6-Cl | H | C₂F₅ | Cl | CH |
| i-Pr | 6-Cl | H | C₂F₅ | Cl | CH |
| t-Bu | 6-Cl | H | C₂F₅ | Cl | CH |
| Me | 6-Cl | H | n-C₃F₇ | Cl | CH |
| Et | 6-Cl | H | n-C₃F₇ | Cl | CH |
| i-Pr | 6-Cl | H | n-C₃F₇ | Cl | CH |
| t-Bu | 6-Cl | H | n-C₃F₇ | Cl | CH |
| Me | 6-Cl | H | i-C₃F₇ | Cl | CH |
| Et | 6-Cl | H | i-C₃F₇ | Cl | CH |
| i-Pr | 6-Cl | H | i-C₃F₇ | Cl | CH |
| t-Bu | 6-Cl | H | i-C₃F₇ | Cl | CH |
| Me | 6-Cl | H | CN | Cl | CH |
| Et | 6-Cl | H | CN | Cl | CH |
| i-Pr | 6-Cl | H | CN | Cl | CH |
| t-Bu | 6-CL | H | CN | Cl | CH |
| Me | 6-Cl | H | OCHF₂ | Br | CH |
| Et | 6-Cl | H | OCHF₂ | Br | CH |
| i-Pr | 6-Cl | H | OCHF₂ | Br | CH |
| t-Bu | 6-Cl | H | OCHF₂ | Br | CH |
| Me | 6-Cl | H | SCHF₂ | Br | CH |
| Et | 6-Cl | H | SCHF₂ | Br | CH |
| i-Pr | 6-Cl | H | SCHF₂ | Br | CH |
| t-Bu | 6-Cl | H | SCHF₂ | Br | CH |
| Me | 6-Cl | H | OCF₃ | Br | CH |
| Et | 6-Cl | H | OCF₃ | Br | CH |
| i-Pr | 6-Cl | H | OCF₃ | Br | CH |
| t-Bu | 6-Cl | H | OCF₃ | Br | CH |
| Me | 6-Cl | H | SCF₃ | Br | CH |
| Et | 6-Cl | H | SCF₃ | Br | CH |
| i-Pr | 6-Cl | H | SCF₃ | Br | CH |
| t-Bu | 6-Cl | H | SCF₃ | Br | CH |
| Me | 6-Cl | H | C₂F₅ | Br | CH |
| Et | 6-Cl | H | C₂F₅ | Br | CH |
| i-Pr | 6-Cl | H | C₂F₅ | Br | CH |
| t-Bu | 6-Cl | H | C₂F₅ | Br | CH |
| Me | 6-Cl | H | n-C₃F₇ | Br | CH |
| Et | 6-Cl | H | n-C₃F₇ | Br | CH |
| i-Pr | 6-Cl | H | n-C₃F₇ | Br | CH |
| t-Bu | 6-Cl | H | n-C₃F₇ | Br | CH |
| Me | 6-Cl | H | i-C₃F₇ | Br | CH |
| Et | 6-Cl | H | i-C₃F₇ | Br | CH |
| i-Pr | 6-Cl | H | i-C₃F₇ | Br | CH |
| t-Bu | 6-Cl | H | i-C₃F₇ | Br | CH |
| Me | 6-Cl | H | CN | Br | CH |
| Et | 6-Cl | H | CN | Br | CH |
| i-Pr | 6-Cl | H | CN | Br | CH |
| t-Bu | 6-Cl | H | CN | Br | CH |
| Me | 6-Cl | H | OCHF₂ | CF₃ | CH |
| Et | 6-Cl | H | OCHF₂ | CF₃ | CH |
| i-Pr | 6-Cl | H | OCHF₂ | CF₃ | CH |
| t-Bu | 6-Cl | H | OCHF₂ | CF₃ | CH |
| Me | 6-Cl | H | SCHF₂ | CF₃ | CH |
| Et | 6-Cl | H | SCHF₂ | CF₃ | CH |
| i-Pr | 6-Cl | H | SCHF₂ | CF₃ | CH |
| t-Bu | 6-Cl | H | SCHF₂ | CF₃ | CH |
| Me | 6-Cl | H | OCF₃ | CF₃ | CH |
| Et | 6-Cl | H | OCF₃ | CF₃ | CH |
| i-Pr | 6-Cl | H | OCF₃ | CF₃ | CH |
| t-Bu | 6-Cl | H | OCF₃ | CF₃ | CH |
| Me | 6-Cl | H | SCF₃ | CF₃ | CH |
| Et | 6-Cl | H | SCF₃ | CF₃ | CH |
| i-Pr | 6-Cl | H | SCF₃ | CF₃ | CH |
| t-Bu | 6-Cl | H | SCF₃ | CF₃ | CH |
| Me | 6-Cl | H | C₂F₅ | CF₃ | CH |
| Et | 6-Cl | H | C₂F₅ | CF₃ | CH |
| i-Pr | 6-Cl | H | C₂F₅ | CF₃ | CH |
| t-Bu | 6-Cl | H | C₂F₅ | CF₃ | CH |
| Me | 6-Cl | H | n-C₃F₇ | CF₃ | CH |
| Et | 6-Cl | H | n-C₃F₇ | CF₃ | CH |
| i-Pr | 6-Cl | H | n-C₃F₇ | CF₃ | CH |
| t-Bu | 6-Cl | H | n-C₃F₇ | CF₃ | CH |
| Me | 6-Cl | H | i-C₃F₇ | CF₃ | CH |
| Et | 6-Cl | H | i-C₃F₇ | CF₃ | CH |
| i-Pr | 6-Cl | H | i-C₃F₇ | CF₃ | CH |
| t-Bu | 6-Cl | H | i-C₃F₇ | CF₃ | CH |
| Me | 6-Cl | H | CN | CF₃ | CH |
| Et | 6-Cl | H | CN | CF₃ | CH |
| i-Pr | 6-Cl | H | CN | CF₃ | CH |
| t-Bu | 6-Cl | H | CN | CF₃ | CH |
| Me | 6-Cl | Cl | OCHF₂ | F | CH |
| Et | 6-Cl | Cl | OCHF₂ | F | CH |
| i-Pr | 6-Cl | Cl | OCHF₂ | F | CH |
| t-Bu | 6-Cl | Cl | OCHF₂ | F | CH |
| Me | 6-Cl | Cl | SCHF₂ | F | CH |
| Et | 6-Cl | Cl | SCHF₂ | F | CH |
| i-Pr | 6-Cl | Cl | SCHF₂ | F | CH |
| t-Bu | 6-Cl | Cl | SCHF₂ | F | CH |
| Me | 6-Cl | Cl | OCF₃ | F | CH |
| Et | 6-Cl | Cl | OCF₃ | F | CH |
| i-Pr | 6-Cl | Cl | OCF₃ | F | CH |
| t-Bu | 6-Cl | Cl | OCF₃ | F | CH |
| Me | 6-Cl | Cl | SCF₃ | F | CH |
| Et | 6-Cl | Cl | SCF₃ | F | CH |
| i-Pr | 6-Cl | Cl | SCF₃ | F | CH |
| t-Bu | 6-Cl | Cl | SCF₃ | F | CH |
| Me | 6-Cl | Cl | C₂F₅ | F | CH |
| Et | 6-Cl | Cl | C₂F₅ | F | CH |
| i-Pr | 6-Cl | Cl | C₂F₅ | F | CH |
| t-Bu | 6-Cl | Cl | C₂F₅ | F | CH |
| Me | 6-Cl | Cl | n-C₃F₇ | F | CH |
| Et | 6-Cl | Cl | n-C₃F₇ | F | CH |
| i-Pr | 6-Cl | Cl | n-C₃F₇ | F | CH |
| t-Bu | 6-Cl | Cl | n-C₃F₇ | F | CH |
| Me | 6-Cl | Cl | i-C₃F₇ | F | CH |
| Et | 6-Cl | Cl | i-C₃F₇ | F | CH |
| i-Pr | 6-Cl | Cl | i-C₃F₇ | F | CH |
| t-Bu | 6-Cl | Cl | i-C₃F₇ | F | CH |
| Me | 6-Cl | Cl | CN | F | CH |
| Et | 6-Cl | Cl | CN | F | CH |
| i-Pr | 6-Cl | Cl | CN | F | CH |
| t-Bu | 6-Cl | Cl | CN | F | CH |
| Me | 6-Cl | Cl | OCHF₂ | Cl | CH |
| Et | 6-Cl | Cl | OCHF₂ | Cl | CH |
| i-Pr | 6-Cl | Cl | OCHF₂ | Cl | CH |
| t-Bu | 6-Cl | Cl | OCHF₂ | Cl | CH |
| Me | 6-Cl | Cl | SCHF₂ | Cl | CH |
| Et | 6-Cl | Cl | SCHF₂ | Cl | CH |
| i-Pr | 6-Cl | Cl | SCHF₂ | Cl | CH |
| t-Bu | 6-Cl | Cl | SCHF₂ | Cl | CH |
| Me | 6-Cl | Cl | OCF₃ | Cl | CH |
| Et | 6-Cl | Cl | OCF₃ | Cl | CH |
| i-Pr | 6-Cl | Cl | OCF₃ | Cl | CH |
| t-Bu | 6-Cl | Cl | OCF₃ | Cl | CH |
| Me | 6-Cl | Cl | SCF₃ | Cl | CH |
| Et | 6-Cl | Cl | SCF₃ | Cl | CH |
| i-Pr | 6-Cl | Cl | SCF₃ | Cl | CH |
| t-Bu | 6-Cl | Cl | SCF₃ | Cl | CH |
| Me | 6-Cl | Cl | C₂F₅ | Cl | CH |
| Et | 6-Cl | Cl | C₂F₅ | Cl | CH |
| i-Pr | 6-Cl | Cl | C₂F₅ | Cl | CH |
| t-Bu | 6-Cl | Cl | C₂F₅ | Cl | CH |
| Me | 6-Cl | Cl | n-C₃F₇ | Cl | CH |
| Et | 6-Cl | Cl | n-C₃F₇ | Cl | CH |
| i-Pr | 6-Cl | Cl | n-C₃F₇ | Cl | CH |
| t-Bu | 6-Cl | Cl | n-C₃F₇ | Cl | CH |
| Me | 6-Cl | Cl | i-C₃F₇ | Cl | CH |
| Et | 6-Cl | Cl | i-C₃F₇ | Cl | CH |
| i-Pr | 6-Cl | Cl | i-C₃F₇ | Cl | CH |
| t-Bu | 6-Cl | Cl | i-C₃F₇ | Cl | CH |
| Me | 6-Cl | Cl | CN | Cl | CH |
| Et | 6-Cl | Cl | CN | Cl | CH |
| i-Pr | 6-Cl | Cl | CN | Cl | CH |
| t-Bu | 6-Cl | Cl | CN | Cl | CH |
| Me | 6-Cl | Cl | OCHF₂ | Br | CH |
| Et | 6-Cl | Cl | OCHF₂ | Br | CH |
| i-Pr | 6-Cl | Cl | OCHF₂ | Br | CH |
| t-Bu | 6-Cl | Cl | OCHF₂ | Br | CH |
| Me | 6-Cl | Cl | SCHF₂ | Br | CH |
| Et | 6-Cl | Cl | SCHF₂ | Br | CH |
| i-Pr | 6-Cl | Cl | SCHF₂ | Br | CH |
| t-Bu | 6-Cl | Cl | SCHF₂ | Br | CH |
| Me | 6-Cl | Cl | OCF₃ | Br | CH |
| Et | 6-Cl | Cl | OCF₃ | Br | CH |
| i-Pr | 6-Cl | Cl | OCF₃ | Br | CH |
| t-Bu | 6-Cl | Cl | OCF₃ | Br | CH |
| Me | 6-Cl | Cl | SCF₃ | Br | CH |
| Et | 6-Cl | Cl | SCF₃ | Br | CH |
| i-Pr | 6-Cl | Cl | SCF₃ | Br | CH |
| t-Bu | 6-Cl | Cl | SCF₃ | Br | CH |
| Me | 6-Cl | Cl | C₂F₅ | Br | CH |
| Et | 6-Cl | Cl | C₂F₅ | Br | CH |
| i-Pr | 6-Cl | Cl | C₂F₅ | Br | CH |
| t-Bu | 6-Cl | Cl | C₂F₅ | Br | CH |
| Me | 6-Cl | Cl | n-C₃F₇ | Br | CH |
| Et | 6-Cl | Cl | n-C₃F₇ | Br | CH |
| i-Pr | 6-Cl | Cl | n-C₃F₇ | Br | CH |
| t-Bu | 6-Cl | Cl | n-C₃F₇ | Br | CH |
| Me | 6-Cl | Cl | i-C₃F₇ | Br | CH |
| Et | 6-Cl | Cl | i-C₃F₇ | Br | CH |
| i-Pr | 6-Cl | Cl | i-C₃F₇ | Br | CH |
| t-Bu | 6-Cl | Cl | i-C₃F₇ | Br | CH |
| Me | 6-Cl | Cl | CN | Br | CH |
| Et | 6-Cl | Cl | CN | Br | CH |
| i-Pr | 6-Cl | Cl | CN | Br | CH |
| t-Bu | 6-Cl | Cl | CN | Br | CH |
| Me | 6-Cl | Cl | OCHF₂ | CF₃ | CH |
| Et | 6-Cl | Cl | OCHF₂ | CF₃ | CH |
| i-Pr | 6-Cl | Cl | OCHF₂ | CF₃ | CH |
| t-Bu | 6-Cl | Cl | OCHF₂ | CF₃ | CH |
| Me | 6-Cl | Cl | SCHF₂ | CF₃ | CH |
| Et | 6-Cl | Cl | SCHF₂ | CF₃ | CH |
| i-Pr | 6-Cl | Cl | SCHF₂ | CF₃ | CH |
| t-Bu | 6-Cl | Cl | SCHF₂ | CF₃ | CH |
| Me | 6-Cl | Cl | OCF₃ | CF₃ | CH |
| Et | 6-Cl | Cl | OCF₃ | CF₃ | CH |
| i-Pr | 6-Cl | Cl | OCF₃ | CF₃ | CH |
| t-Bu | 6-Cl | Cl | OCF₃ | CF₃ | CH |
| Me | 6-Cl | Cl | SCF₃ | CF₃ | CH |
| Et | 6-Cl | Cl | SCF₃ | CF₃ | CH |
| i-Pr | 6-Cl | Cl | SCF₃ | CF₃ | CH |
| t-Bu | 6-Cl | Cl | SCF₃ | CF₃ | CH |
| Me | 6-Cl | Cl | C₂F₅ | CF₃ | CH |
| Et | 6-Cl | Cl | C₂F₅ | CF₃ | CH |
| i-Pr | 6-Cl | Cl | C₂F₅ | CF₃ | CH |
| t-Bu | 6-Cl | Cl | C₂F₅ | CF₃ | CH |
| Me | 6-Cl | Cl | n-C₃F₇ | CF₃ | CH |
| Et | 6-Cl | Cl | n-C₃F₇ | CF₃ | CH |
| i-Pr | 6-Cl | Cl | n-C₃F₇ | CF₃ | CH |
| t-Bu | 6-Cl | Cl | n-C₃F₇ | CF₃ | CH |
| Me | 6-Cl | Cl | i-C₃F₇ | CF₃ | CH |
| Et | 6-Cl | Cl | i-C₃F₇ | CF₃ | CH |
| i-Pr | 6-Cl | Cl | i-C₃F₇ | CF₃ | CH |
| t-Bu | 6-Cl | Cl | i-C₃F₇ | CF₃ | CH |
| Me | 6-Cl | Cl | CN | CF₃ | CH |
| Et | 6-Cl | Cl | CN | CF₃ | CH |
| i-Pr | 6-Cl | Cl | CH | CF₃ | CH |
| t-Bu | 6-Cl | Cl | CN | CF₃ | CH |
| Me | 6-Cl | H | OCHF₂ | F | CF |
| Et | 6-Cl | H | OCHF₂ | F | CF |
| i-Pr | 6-Cl | H | OCHF₂ | F | CF |
| t-Bu | 6-Cl | H | OCHF₂ | F | CF |
| Me | 6-Cl | H | SCHF₂ | F | CF |
| Et | 6-Cl | H | SCHF₂ | F | CF |
| i-Pr | 6-Cl | H | SCHF₂ | F | CF |
| t-Bu | 6-Cl | H | SCHF₂ | F | CF |
| Me | 6-Cl | H | OCF₃ | F | CF |
| Et | 6-Cl | H | OCF₃ | F | CF |
| i-Pr | 6-Cl | H | OCF₃ | F | CF |
| t-Bu | 6-Cl | H | OCF₃ | F | CF |
| Me | 6-Cl | H | SCF₃ | F | CF |
| Et | 6-Cl | H | SCF₃ | F | CF |
| i-Pr | 6-Cl | H | SCF₃ | F | CF |
| t-Bu | 6-Cl | H | SCF₃ | F | CF |
| Me | 6-Cl | H | C₂F₅ | F | CF |
| Et | 6-Cl | H | C₂F₅ | F | CF |
| i-Pr | 6-Cl | H | C₂F₅ | F | CF |
| t-Bu | 6-Cl | H | C₂F₅ | F | CF |
| Me | 6-Cl | H | n-C₃F₇ | F | CF |
| Et | 6-Cl | H | n-C₃F₇ | F | CF |
| i-Pr | 6-Cl | H | n-C₃F₇ | F | CF |
| t-Bu | 6-Cl | H | n-C₃F₇ | F | CF |
| Me | 6-Cl | H | i-C₃F₇ | F | CF |
| Et | 6-Cl | H | i-C₃F₇ | F | CF |
| i-Pr | 6-Cl | H | i-C₃F₇ | F | CF |
| t-Bu | 6-Cl | H | i-C₃F₇ | F | CF |
| Me | 6-Cl | H | CN | F | CF |
| Et | 6-Cl | H | CN | F | CF |
| i-Pr | 6-Cl | H | CN | F | CF |
| t-Bu | 6-Cl | H | CN | F | CF |
| Me | 6-Cl | H | OCHF₂ | Cl | CCl |
| Et | 6-Cl | H | OCHF₂ | Cl | CCl |
| i-Pr | 6-Cl | H | OCHF₂ | Cl | CCl |
| t-Bu | 6-Cl | H | OCHF₂ | Cl | CCl |
| Me | 6-Cl | H | SCHF₂ | Cl | CCl |
| Et | 6-Cl | H | SCHF₂ | Cl | CCl |
| i-Pr | 6-Cl | H | SCHF₂ | Cl | CCl |
| t-Bu | 6-Cl | H | SCHF₂ | Cl | CCl |
| Me | 6-Cl | H | OCF₃ | Cl | CCl |
| Et | 6-Cl | H | OCF₃ | Cl | CCl |
| i-Pr | 6-Cl | H | OCF₃ | Cl | CCl |
| t-Bu | 6-Cl | H | OCF₃ | Cl | CCl |
| Me | 6-Cl | H | SCF₃ | Cl | CCl |
| Et | 6-Cl | H | SCF₃ | Cl | CCl |
| i-Pr | 6-Cl | H | SCF₃ | Cl | CCl |
| t-Bu | 6-Cl | H | SCF₃ | Cl | CQ |
| Me | 6-Cl | H | C₂F₅ | Cl | CCl |
| Et | 6-Cl | H | C₂F₅ | Cl | CCl |
| i-Pr | 6-Cl | H | C₂F₅ | Cl | CCl |
| t-Bu | 6-Cl | H | C₂F₅ | Cl | CCl |
| Me | 6-Cl | H | n-C₃F₇ | Cl | CCl |
| Et | 6-Cl | H | n-C₃F₇ | Cl | CCl |
| i-Pr | 6-Cl | H | n-C₃F₇ | Cl | CCl |
| t-Bu | 6-Cl | H | n-C₃F₇ | Cl | CCl |
| Me | 6-Cl | H | i-C₃F₇ | Cl | CCl |
| Et | 6-Cl | H | i-C₃F₇ | Cl | CCl |
| i-Pr | 6-Cl | H | i-C₃F₇ | Cl | CCl |
| t-Bu | 6-Cl | H | i-C₃F₇ | Cl | CCl |
| Me | 6-Cl | H | CN | Cl | CCl |
| Et | 6-Cl | H | CN | Cl | CCl |
| i-Pr | 6-Cl | H | CN | Cl | CCl |
| t-Bu | 6-Cl | H | CN | Cl | CCl |
| Me | 3-Cl | H | OCHF₂ | F | CH |
| Et | 3-Cl | H | OCHF₂ | F | CH |
| i-Pr | 3-Cl | H | OCHF₂ | F | CH |
| t-Bu | 3-Cl | H | OCHF₂ | F | CH |
| Me | 3-Cl | H | SCHF₂ | F | CH |
| Et | 3-Cl | H | SCHF₂ | F | CH |
| i-Pr | 3-Cl | H | SCHF₂ | F | CH |
| t-Bu | 3-Cl | H | SCHF₂ | F | CH |
| Me | 3-Cl | H | OCF₃ | F | CH |
| Et | 3-Cl | H | OCF₃ | F | CH |
| i-Pr | 3-Cl | H | OCF₃ | F | CH |
| t-Bu | 3-Cl | H | OCF₃ | F | CH |
| Me | 3-Cl | H | SCF₃ | F | CH |
| Et | 3-Cl | H | SCF₃ | F | CH |
| i-Pr | 3-Cl | H | SCF₃ | F | CH |
| t-Bu | 3-Cl | H | SCF₃ | F | CH |
| Me | 3-Cl | H | C₂F₅ | F | CH |
| Et | 3-Cl | H | C₂F₅ | F | CH |
| i-Pr | 3-Cl | H | C₂F₅ | F | CH |
| t-Bu | 3-Cl | H | C₂F₅ | F | CH |
| Me | 3-Cl | H | n-C₃F₇ | F | CH |
| Et | 3-Cl | H | n-C₃F₇ | F | CH |
| i-Pr | 3-Cl | H | n-C₃F₇ | F | CH |
| t-Bu | 3-Cl | H | n-C₃F₇ | F | CH |
| Me | 3-Cl | H | i-C₃F₇ | F | CH |
| Et | 3-Cl | H | i-C₃F₇ | F | CH |
| i-Pr | 3-Cl | H | i-C₃F₇ | F | CH |
| t-Bu | 3-Cl | H | i-C₃F₇ | F | CH |
| Me | 3-Cl | H | CN | F | CH |
| Et | 3-Cl | H | CN | F | CH |
| i-Pr | 3-Cl | H | CN | F | CH |
| t-Bu | 3-Cl | H | CN | F | CH |
| Me | 3-Cl | H | OCHF₂ | Cl | CH |
| Et | 3-Cl | H | OCHF₂ | Cl | CH |
| i-Pr | 3-Cl | H | OCHF₂ | Cl | CH |
| t-Bu | 3-Cl | H | OCHF₂ | Cl | CH |
| Me | 3-Cl | H | SCHF₂ | Cl | CH |
| Et | 3-Cl | H | SCHF₂ | Cl | CH |
| i-Pr | 3-Cl | H | SCHF₂ | Cl | CH |
| t-Bu | 3-Cl | H | SCHF₂ | Cl | CH |
| Me | 3-Cl | H | OCF₃ | Cl | CH |
| Et | 3-Cl | H | OCF₃ | Cl | CH |
| i-Pr | 3-Cl | H | OCF₃ | Cl | CH |
| t-Bu | 3-Cl | H | OCF₃ | Cl | CH |
| Me | 3-Cl | H | SCF₃ | Cl | CH |
| Et | 3-Cl | H | SCF₃ | Cl | CH |
| i-Pr | 3-Cl | H | SCF₃ | Cl | CH |
| t-Bu | 3-Cl | H | SCF₃ | Cl | CH |
| Me | 3-Cl | H | C₂F₅ | Cl | CH |
| Et | 3-Cl | H | C₂F₅ | Cl | CH |
| i-Pr | 3-Cl | H | C₂F₅ | Cl | CH |
| t-Bu | 3-Cl | H | C₂F₅ | Cl | CH |
| Me | 3-Cl | H | n-C₃F₇ | Cl | CH |
| Et | 3-Cl | H | n-C₃F₇ | Cl | CH |
| i-Pr | 3-Cl | H | n-C₃F₇ | Cl | CH |
| t-Bu | 3-Cl | H | n-C₃F₇ | Cl | CH |
| Me | 3-Cl | H | i-C₃F₇ | Cl | CH |
| Et | 3-Cl | H | i-C₃F₇ | Cl | CH |
| i-Pr | 3-Cl | H | i-C₃F₇ | Cl | CH |
| t-Bu | 3-Cl | H | i-C₃F₇ | Cl | CH |
| Me | 3-Cl | H | CN | Cl | CH |
| Et | 3-Cl | H | CN | Cl | CH |
| i-Pr | 3-Cl | H | CN | Cl | CH |
| t-Bu | 3-Cl | H | CN | Cl | CH |
| Me | 3-Cl | H | OCHF₂ | Br | CH |
| Et | 3-Cl | H | OCHF₂ | Br | CH |
| i-Pr | 3-Cl | H | OCHF₂ | Br | CH |
| t-Bu | 3-Cl | H | OCHF₂ | Br | CH |
| Me | 3-Cl | H | SCHF₂ | Br | CH |
| Et | 3-Cl | H | SCHF₂ | Br | CH |
| i-Pr | 3-Cl | H | SCHF₂ | Br | CH |
| t-Bu | 3-Cl | H | SCHF₂ | Br | CH |
| Me | 3-Cl | H | OCF₃ | Br | CH |
| Et | 3-Cl | H | OCF₃ | Br | CH |
| i-Pr | 3-Cl | H | OCF₃ | Br | CH |
| t-Bu | 3-Cl | H | OCF₃ | Br | CH |
| Me | 3-Cl | H | SCF₃ | Br | CH |
| Et | 3-Cl | H | SCF₃ | Br | CH |
| i-Pr | 3-Cl | H | SCF₃ | Br | CH |
| t-Bu | 3-Cl | H | SCF₃ | Br | CH |
| Me | 3-Cl | H | C₂F₅ | Br | CH |
| Et | 3-Cl | H | C₂F₅ | Br | CH |
| i-Pr | 3-Cl | H | C₂F₅ | Br | CH |
| t-Bu | 3-Cl | H | C₂F₅ | Br | CH |
| Me | 3-Cl | H | n-C₃F₇ | Br | CH |
| Et | 3-Cl | H | n-C₃F₇ | Br | CH |
| i-Pr | 3-Cl | H | n-C₃F₇ | Br | CH |
| t-Bu | 3-Cl | H | n-C₃F₇ | Br | CH |
| Me | 3-Cl | H | i-C₃F₇ | Br | CH |
| Et | 3-Cl | H | i-C₃F₇ | Br | CH |
| i-Pr | 3-Cl | H | i-C₃F₇ | Br | CH |
| t-Bu | 3-Cl | H | i-C₃F₇ | Br | CH |
| Me | 3-Cl | H | CN | Br | CH |
| Et | 3-Cl | H | CN | Br | CH |
| i-Pr | 3-Cl | H | CN | Br | CH |
| t-Bu | 3-Cl | H | CN | Br | CH |
| Me | 3-Cl | H | OCHF₂ | CF₃ | CH |
| Et | 3-Cl | H | OCHF₂ | CF₃ | CH |
| i-Pr | 3-Cl | H | OCHF₂ | CF₃ | CH |
| t-Bu | 3-Cl | H | OCHF₂ | CF₃ | CH |
| Me | 3-Cl | H | SCHF₂ | CF₃ | CH |
| Et | 3-Cl | H | SCHF₂ | CF₃ | CH |
| i-Pr | 3-Cl | H | SCHF₂ | CF₃ | CH |
| t-Bu | 3-Cl | H | SCHF₂ | CF₃ | CH |
| Me | 3-Cl | H | OCF₃ | CF₃ | CH |
| Et | 3-Cl | H | OCF₃ | CF₃ | CH |
| i-Pr | 3-Cl | H | OCF₃ | CF₃ | CH |
| t-Bu | 3-Cl | H | OCF₃ | CF₃ | CH |
| Me | 3-Cl | H | SCF₃ | CF₃ | CH |
| Et | 3-Cl | H | SCF₃ | CF₃ | CH |
| i-Pr | 3-Cl | H | SCF₃ | CF₃ | CH |
| t-Bu | 3-Cl | H | SCF₃ | CF₃ | CH |
| Me | 3-Cl | H | C₂F₅ | CF₃ | CH |
| Et | 3-Cl | H | C₂F₅ | CF₃ | CH |
| i-Pr | 3-Cl | H | C₂F₅ | CF₃ | CH |
| t-Bu | 3-Cl | H | C₂F₅ | CF₃ | CH |
| Me | 3-Cl | H | n-C₃F₇ | CF₃ | CH |
| Et | 3-Cl | H | n-C₃F₇ | CF₃ | CH |
| i-Pr | 3-Cl | H | n-C₃F₇ | CF₃ | CH |
| t-Bu | 3-Cl | H | n-C₃F₇ | CF₃ | CH |
| Me | 3-Cl | H | i-C₃F₇ | CF₃ | CH |
| Et | 3-Cl | H | i-C₃F₇ | CF₃ | CH |
| i-Pr | 3-Cl | H | i-C₃F₇ | CF₃ | CH |
| t-Bu | 3-Cl | H | i-C₃F₇ | CF₃ | CH |
| Me | 3-Cl | H | CN | CF₃ | CH |
| Et | 3-Cl | H | CN | CF₃ | CH |
| i-Pr | 3-Cl | H | CN | CF₃ | CH |
| t-Bu | 3-Cl | H | CN | CF₃ | CH |

TABLE 7

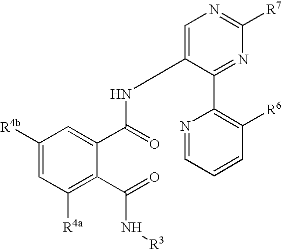

| R^{4a} | R^{4b} | R⁷ | R³ | R⁶ |
|---|---|---|---|---|
| CH₃ | F | CF₃ | Me | Cl |
| CH₃ | F | CF₃ | Et | Cl |
| CH₃ | F | CF₃ | i-Pr | Cl |
| CH₃ | F | CF₃ | t-Bu | Cl |
| CH₃ | F | CF₃ | Me | Br |
| CH₃ | F | CF₃ | Et | Br |
| CH₃ | F | CF₃ | i-Pr | Br |
| CH₃ | F | CF₃ | t-Bu | Br |
| CH₃ | F | Cl | Me | Cl |
| CH₃ | F | Cl | Et | Cl |
| CH₃ | F | Cl | i-Pr | Cl |
| CH₃ | F | Cl | t-Bu | Cl |
| CH₃ | F | Cl | Me | Br |
| CH₃ | F | Cl | Et | Br |
| CH₃ | F | Cl | i-Pr | Br |
| CH₃ | F | Cl | t-Bu | Br |
| CH₃ | F | Br | Me | Cl |
| CH₃ | F | Br | Et | Cl |
| CH₃ | F | Br | i-Pr | Cl |
| CH₃ | F | Br | t-Bu | Cl |
| CH₃ | F | Br | Me | Br |
| CH₃ | F | Br | Et | Br |
| CH₃ | F | Br | i-Pr | Br |
| CH₃ | F | Br | t-Bu | Br |
| CH₃ | Cl | CF₃ | Me | Cl |
| CH₃ | Cl | CF₃ | Et | Cl |
| CH₃ | Cl | CF₃ | i-Pr | Cl |
| CH₃ | Cl | CF₃ | t-Bu | Cl |
| CH₃ | Cl | CF₃ | Me | Br |
| CH₃ | Cl | CF₃ | Et | Br |
| CH₃ | Cl | CF₃ | i-Pr | Br |
| CH₃ | Cl | CF₃ | t-Bu | Br |
| CH₃ | Cl | Cl | Me | Cl |
| CH₃ | Cl | Cl | Et | Cl |
| CH₃ | Cl | Cl | i-Pr | Cl |
| CH₃ | Cl | Cl | t-Bu | Cl |
| CH₃ | Cl | Cl | Me | Br |
| CH₃ | Cl | Cl | Et | Br |
| CH₃ | Cl | Cl | i-Pr | Br |
| CH₃ | Cl | Cl | t-Bu | Br |
| CH₃ | Cl | Br | Me | Cl |
| CH₃ | Cl | Br | Et | Cl |
| CH₃ | Cl | Br | i-Pr | Cl |
| CH₃ | Cl | Br | t-Bu | Cl |
| CH₃ | Cl | Br | Me | Br |
| CH₃ | Cl | Br | Et | Br |
| CH₃ | Cl | Br | i-Pr | Br |
| CH₃ | Cl | Br | t-Bu | Br |
| CH₃ | Br | CF₃ | Me | Cl |
| CH₃ | Br | CF₃ | Et | Cl |
| CH₃ | Br | CF₃ | i-Pr | Cl |
| CH₃ | Br | CF₃ | t-Bu | Cl |
| CH₃ | Br | CF₃ | Me | Br |
| CH₃ | Br | CF₃ | Et | Br |
| CH₃ | Br | CF₃ | i-Pr | Br |
| CH₃ | Br | CF₃ | t-Bu | Br |
| CH₃ | Br | Cl | Me | Cl |
| CH₃ | Br | Cl | Et | Cl |
| CH₃ | Br | Cl | i-Pr | Cl |
| CH₃ | Br | Cl | t-Bu | Cl |
| CH₃ | Br | Cl | Me | Br |
| CH₃ | Br | Cl | Et | Br |
| CH₃ | Br | Cl | i-Pr | Br |
| CH₃ | Br | Cl | t-Bu | Br |
| CH₃ | Br | Br | Me | Cl |
| CH₃ | Br | Br | Et | Cl |
| CH₃ | Br | Br | i-Pr | Cl |
| CH₃ | Br | Br | t-Bu | Cl |
| CH₃ | Br | Br | Me | Br |
| CH₃ | Br | Br | Et | Br |
| CH₃ | Br | Br | i-Pr | Br |
| CH₃ | Br | Br | t-Bu | Br |
| CH₃ | I | CF₃ | Me | Cl |
| CH₃ | I | CF₃ | Et | Cl |
| CH₃ | I | CF₃ | i-Pr | Cl |
| CH₃ | I | CF₃ | t-Bu | Cl |
| CH₃ | I | CF₃ | Me | Br |
| CH₃ | I | CF₃ | Et | Br |
| CH₃ | I | CF₃ | i-Pr | Br |
| CH₃ | I | CF₃ | t-Bu | Br |
| CH₃ | I | Cl | Me | Cl |
| CH₃ | I | Cl | Et | Cl |
| CH₃ | I | Cl | i-Pr | Cl |
| CH₃ | I | Cl | t-Bu | Cl |
| CH₃ | I | Cl | Me | Br |
| CH₃ | I | Cl | Et | Br |
| CH₃ | I | Cl | i-Pr | Br |
| CH₃ | I | Cl | t-Bu | Br |
| CH₃ | I | Br | Me | Cl |
| CH₃ | I | Br | Et | Cl |
| CH₃ | I | Br | i-Pr | Cl |
| CH₃ | I | Br | t-Bu | Cl |
| CH₃ | I | Br | Me | Br |
| CH₃ | I | Br | Et | Br |
| CH₃ | I | Br | i-Pr | Br |
| CH₃ | I | Br | t-Bu | Br |
| CH₃ | CF₃ | CF₃ | Me | Cl |
| CH₃ | CF₃ | CF₃ | Et | Cl |
| CH₃ | CF₃ | CF₃ | i-Pr | Cl |
| CH₃ | CF₃ | CF₃ | t-Bu | Cl |
| CH₃ | CF₃ | CF₃ | Me | Br |
| CH₃ | CF₃ | CF₃ | Et | Br |
| CH₃ | CF₃ | CF₃ | i-Pr | Br |
| CH₃ | CF₃ | CF₃ | t-Bu | Br |
| CH₃ | CF₃ | Cl | Me | Cl |
| CH₃ | CF₃ | Cl | Et | Cl |
| CH₃ | CF₃ | Cl | i-Pr | Cl |
| CH₃ | CF₃ | Cl | t-Bu | Cl |
| CH₃ | CF₃ | Cl | Me | Br |
| CH₃ | CF₃ | Cl | Et | Br |
| CH₃ | CF₃ | Cl | i-Pr | Br |
| CH₃ | CF₃ | Cl | t-Bu | Br |
| CH₃ | CF₃ | Br | Me | Cl |
| CH₃ | CF₃ | Br | Et | Cl |
| CH₃ | CF₃ | Br | i-Pr | Cl |
| CH₃ | CF₃ | Br | t-Bu | Cl |
| CH₃ | CF₃ | Br | Me | Br |
| CH₃ | CF₃ | Br | Et | Br |
| CH₃ | CF₃ | Br | i-Pr | Br |
| CH₃ | CF₃ | Br | t-Bu | Br |
| CH₃ | Cl | Cl | n-Pr | Cl |
| CH₃ | Cl | Cl | n-Bu | Cl |
| CH₃ | Cl | Cl | s-Bu | Cl |
| CH₃ | Cl | Cl | i-Bu | Cl |
| CH₃ | H | CF₃ | Me | Cl |
| CH₃ | H | CF₃ | Et | Cl |
| CH₃ | H | CF₃ | i-Pr | Cl |
| CH₃ | H | CF₃ | t-Bu | Cl |
| CH₃ | H | CF₃ | Me | Br |
| CH₃ | H | CF₃ | Et | Br |
| CH₃ | H | CF₃ | i-Pr | Br |
| CH₃ | H | CF₃ | t-Bu | Br |
| CH₃ | H | Cl | Me | Cl |
| CH₃ | H | Cl | Et | Cl |
| CH₃ | H | Cl | i-Pr | Cl |
| CH₃ | H | Cl | t-Bu | Cl |
| CH₃ | H | Cl | Me | Br |
| CH₃ | H | Cl | Et | Br |
| CH₃ | H | Cl | i-Pr | Br |
| CH₃ | H | Cl | t-Bu | Br |
| CH₃ | H | Br | Me | Cl |
| CH₃ | H | Br | Et | Cl |
| CH₃ | H | Br | i-Pr | Cl |
| CH₃ | H | Br | t-Bu | Cl |
| CH₃ | H | Br | Me | Br |
| CH₃ | H | Br | Et | Br |
| CH₃ | H | Br | i-Pr | Br |
| CH₃ | H | Br | t-Bu | Br |
| Cl | F | CF₃ | Me | Cl |
| Cl | F | CF₃ | Et | Cl |
| Cl | F | CF₃ | i-Pr | Cl |
| Cl | F | CF₃ | t-Bu | Cl |
| Cl | F | CF₃ | Me | Br |
| Cl | F | CF₃ | Et | Br |
| Cl | F | CF₃ | i-Pr | Br |
| Cl | F | CF₃ | t-Bu | Br |
| Cl | F | Cl | Me | Cl |
| Cl | F | Cl | Et | Cl |
| Cl | F | Cl | i-Pr | Cl |
| Cl | F | Cl | t-Bu | Cl |
| Cl | F | Cl | Me | Br |
| Cl | F | Cl | Et | Br |
| Cl | F | Cl | i-Pr | Br |
| Cl | F | Cl | t-Bu | Br |
| Cl | F | Br | Me | Cl |
| Cl | F | Br | Et | Cl |
| Cl | F | Br | i-Pr | Cl |
| Cl | F | Br | t-Bu | Cl |
| Cl | F | Br | Me | Br |
| Cl | F | Br | Et | Br |
| Cl | F | Br | i-Pr | Br |
| Cl | F | Br | t-Bu | Br |
| Cl | Cl | CF₃ | Me | Cl |
| Cl | Cl | CF₃ | Et | Cl |
| Cl | Cl | CF₃ | i-Pr | Cl |
| Cl | Cl | CF₃ | t-Bu | Cl |
| Cl | Cl | CF₃ | Me | Br |
| Cl | Cl | CF₃ | Et | Br |
| Cl | Cl | CF₃ | i-Pr | Br |
| Cl | Cl | CF₃ | t-Bu | Br |
| Cl | Cl | Cl | Me | Cl |
| Cl | Cl | Cl | Et | Cl |
| Cl | Cl | Cl | i-Pr | Cl |
| Cl | Cl | Cl | t-Bu | Cl |
| Cl | Cl | Cl | Me | Br |
| Cl | Cl | Cl | Et | Br |
| Cl | Cl | Cl | i-Pr | Br |
| Cl | Cl | Cl | t-Bu | Br |
| Cl | Cl | Br | Me | Cl |
| Cl | Cl | Br | Et | Cl |
| Cl | Cl | Br | i-Pr | Cl |
| Cl | Cl | Br | t-Bu | Cl |
| Cl | Cl | Br | Me | Br |
| Cl | Cl | Br | Et | Br |
| Cl | Cl | Br | i-Pr | Br |
| Cl | Cl | Br | t-Bu | Br |
| Cl | Br | CF₃ | Me | Cl |
| Cl | Br | CF₃ | Et | Cl |
| Cl | Br | CF₃ | i-Pr | Cl |
| Cl | Br | CF₃ | t-Bu | Cl |
| Cl | Br | CF₃ | Me | Br |
| Cl | Br | CF₃ | Et | Br |
| Cl | Br | CF₃ | i-Pr | Br |
| Cl | Br | CF₃ | t-Bu | Br |
| Cl | Br | Cl | Me | Cl |
| Cl | Br | Cl | Et | Cl |
| Cl | Br | Cl | i-Pr | Cl |
| Cl | Br | Cl | t-Bu | Cl |
| Cl | H | CF₃ | Me | Cl |
| Cl | H | CF₃ | Et | Cl |
| Cl | H | CF₃ | i-Pr | Cl |
| Cl | H | CF₃ | t-Bu | Cl |
| Cl | H | CF₃ | Me | Br |
| Cl | H | CF₃ | Et | Br |
| Cl | H | CF₃ | i-Pr | Br |
| Cl | H | CF₃ | t-Bu | Br |
| Cl | H | Cl | Me | Cl |
| Cl | H | Cl | Et | Cl |
| Cl | H | Cl | i-Pr | Cl |
| Cl | H | Cl | t-Bu | Cl |
| Cl | H | Cl | Me | Br |
| Cl | H | Cl | Et | Br |
| Cl | H | Cl | i-Pr | Br |
| Cl | H | Cl | t-Bu | Br |
| Cl | H | Br | Me | Cl |
| Cl | H | Br | Et | Cl |
| Cl | H | Br | i-Pr | Cl |
| Cl | H | Br | t-Bu | Cl |
| Cl | H | Br | Me | Br |
| Cl | H | Br | Et | Br |
| Cl | H | Br | i-Pr | Br |
| Cl | H | Br | t-Bu | Br |
| Cl | Br | Cl | Me | Br |
| Cl | Br | Cl | Et | Br |
| Cl | Br | Cl | i-Pr | Br |
| Cl | Br | Cl | t-Bu | Br |
| Cl | Br | Br | Me | Cl |
| Cl | Br | Br | Et | Cl |
| Cl | Br | Br | i-Pr | Cl |
| Cl | Br | Br | t-Bu | Cl |
| Cl | Br | Br | Me | Br |
| Cl | Br | Br | Et | Br |
| Cl | Br | Br | i-Pr | Br |
| Cl | Br | Br | t-Bu | Br |
| Cl | I | CF₃ | Me | Cl |
| Cl | I | CF₃ | Et | Cl |
| Cl | I | CF₃ | i-Pr | Cl |
| Cl | I | CF₃ | t-Bu | Cl |
| Cl | I | CF₃ | Me | Br |
| Cl | I | CF₃ | Et | Br |
| Cl | I | CF₃ | i-Pr | Br |
| Cl | I | CF₃ | t-Bu | Br |
| Cl | I | Cl | Me | Cl |
| Cl | I | Cl | Et | Cl |
| Cl | I | Cl | i-Pr | Cl |
| Cl | I | Cl | t-Bu | Cl |
| Cl | I | Cl | Me | Br |
| Cl | I | Cl | Et | Br |
| Cl | I | Cl | i-Pr | Br |
| Cl | I | Cl | t-Bu | Br |
| Cl | I | Br | Me | Cl |
| Cl | I | Br | Et | Cl |
| Cl | I | Br | i-Pr | Cl |
| Cl | I | Br | t-Bu | Cl |
| Cl | I | Br | Me | Br |
| Cl | I | Br | Et | Br |
| Cl | I | Br | i-Pr | Br |
| Cl | I | Br | t-Bu | Br |
| Cl | CF₃ | CF₃ | Me | Cl |
| Cl | CF₃ | CF₃ | Et | Cl |
| Cl | CF₃ | CF₃ | i-Pr | Cl |
| Cl | CF₃ | CF₃ | t-Bu | Cl |
| Cl | CF₃ | CF₃ | Me | Br |
| Cl | CF₃ | CF₃ | Et | Br |
| Cl | CF₃ | CF₃ | i-Pr | Br |
| Cl | CF₃ | CF₃ | t-Bu | Br |
| Cl | CF₃ | Cl | Me | Cl |
| Cl | CF₃ | Cl | Et | Cl |
| Cl | CF₃ | Cl | i-Pr | Cl |
| Cl | CF₃ | Cl | t-Bu | Cl |
| Cl | CF₃ | Cl | Me | Br |
| Cl | CF₃ | Cl | Et | Br |
| Cl | CF₃ | Cl | i-Pr | Br |
| Cl | CF₃ | Cl | t-Bu | Br |
| Cl | CF₃ | Br | Me | Cl |
| Cl | CF₃ | Br | Et | Cl |
| Cl | CF₃ | Br | i-Pr | Cl |
| Cl | CF₃ | Br | t-Bu | Cl |
| Cl | CF₃ | Br | Me | Br |
| Cl | CF₃ | Br | Et | Br |
| Cl | CF₃ | Br | i-Pr | Br |
| Cl | CF₃ | Br | t-Bu | Br |
| Cl | Cl | Cl | n-Pr | Cl |
| Cl | Cl | Cl | n-Bu | Cl |
| Cl | Cl | Cl | s-Bu | Cl |
| Cl | Cl | Cl | i-Bu | Cl |
| Br | F | CF₃ | Me | Cl |
| Br | F | CF₃ | Et | Cl |
| Br | F | CF₃ | i-Pr | Cl |
| Br | F | CF₃ | t-Bu | Cl |
| Br | F | CF₃ | Me | Br |
| Br | F | CF₃ | Et | Br |
| Br | F | CF₃ | i-Pr | Br |
| Br | F | CF₃ | t-Bu | Br |
| Br | F | Cl | Me | Cl |
| Br | F | Cl | Et | Cl |
| Br | F | Cl | i-Pr | Cl |
| Br | F | Cl | t-Bu | Cl |
| Br | F | Cl | Me | Br |
| Br | F | Cl | Et | Br |
| Br | F | Cl | i-Pr | Br |
| Br | F | Cl | t-Bu | Br |
| Br | F | Br | Me | Cl |
| Br | F | Br | Et | Cl |
| Br | F | Br | i-Pr | Cl |
| Br | F | Br | t-Bu | Cl |
| Br | F | Br | Me | Br |
| Br | F | Br | Et | Br |
| Br | F | Br | i-Pr | Br |
| Br | F | Br | t-Bu | Br |
| Br | Cl | CF₃ | Me | Cl |
| Br | Cl | CF₃ | Et | Cl |
| Br | Cl | CF₃ | i-Pr | Cl |
| Br | Cl | CF₃ | t-Bu | Cl |
| Br | Cl | CF₃ | Me | Br |
| Br | Cl | CF₃ | Et | Br |
| Br | Cl | CF₃ | i-Pr | Br |
| Br | Cl | CF₃ | t-Bu | Br |
| Br | Cl | Cl | Me | Cl |
| Br | Cl | Cl | Et | Cl |
| Br | Cl | Cl | i-Pr | Cl |
| Br | Cl | Cl | t-Bu | Cl |
| Br | Cl | Cl | Me | Br |
| Br | Cl | Cl | Et | Br |
| Br | Cl | Cl | i-Pr | Br |
| Br | Cl | Cl | t-Bu | Br |
| Br | Cl | Br | Me | Cl |
| Br | Cl | Br | Et | Cl |
| Br | Cl | Br | i-Pr | Cl |
| Br | Cl | Br | t-Bu | Cl |
| Br | Cl | Br | Me | Br |
| Br | Cl | Br | Et | Br |
| Br | Cl | Br | i-Pr | Br |
| Br | Cl | Br | t-Bu | Br |
| Br | Br | CF₃ | Me | Cl |
| Br | Br | CF₃ | Et | Cl |
| Br | Br | CF₃ | i-Pr | Cl |
| Br | Br | CF₃ | t-Bu | Cl |
| Br | Br | CF₃ | Me | Br |
| Br | Br | CF₃ | Et | Br |
| Br | Br | CF₃ | i-Pr | Br |
| Br | Br | CF₃ | t-Bu | Br |
| Br | Br | Cl | Me | Cl |
| Br | Br | Cl | Et | Cl |
| Br | Br | Cl | i-Pr | Cl |
| Br | Br | Cl | t-Bu | Cl |
| Br | Br | Cl | Me | Br |
| Br | Br | Cl | Et | Br |
| Br | Br | Cl | i-Pr | Br |
| Br | Br | Cl | t-Bu | Br |
| Br | Br | Br | Me | Cl |
| Br | Br | Br | Et | Cl |
| Br | Br | Br | i-Pr | Cl |
| Br | Br | Br | t-Bu | Cl |
| Br | Br | Br | Me | Br |
| Br | Br | Br | Et | Br |
| Br | Br | Br | i-Pr | Br |
| Br | Br | Br | t-Bu | Br |
| Br | I | CF₃ | Me | Cl |
| Br | I | CF₃ | Et | Cl |
| Br | I | CF₃ | i-Pr | Cl |
| Br | I | CF₃ | t-Bu | Cl |
| Br | I | CF₃ | Me | Br |
| Br | I | CF₃ | Et | Br |
| Br | I | CF₃ | i-Pr | Br |
| Br | I | CF₃ | t-Bu | Br |
| Br | I | Cl | Me | Cl |
| Br | I | Cl | Et | Cl |
| Br | I | Cl | i-Pr | Cl |
| Br | I | Cl | t-Bu | Cl |
| Br | I | Cl | Me | Br |
| Br | I | Cl | Et | Br |
| Br | I | Cl | i-Pr | Br |
| Br | I | Cl | t-Bu | Br |
| Br | I | Br | Me | Cl |
| Br | I | Br | Et | Cl |
| Br | I | Br | i-Pr | Cl |
| Br | I | Br | t-Bu | Cl |
| Br | I | Br | Me | Br |
| Br | I | Br | Et | Br |
| Br | I | Br | i-Pr | Br |
| Br | I | Br | t-Bu | Br |
| Br | CF₃ | CF₃ | Me | Cl |
| Br | CF₃ | CF₃ | Et | Cl |
| Br | CF₃ | CF₃ | i-Pr | Cl |
| Br | CF₃ | CF₃ | t-Bu | Cl |
| Br | CF₃ | CF₃ | Me | Br |
| Br | CF₃ | CF₃ | Et | Br |
| Br | CF₃ | CF₃ | i-Pr | Br |
| Br | CF₃ | CF₃ | t-Bu | Br |
| Br | CF₃ | Cl | Me | Cl |
| Br | CF₃ | Cl | Et | Cl |
| Br | CF₃ | Cl | i-Pr | Cl |
| Br | CF₃ | Cl | t-Bu | Cl |
| Br | CF₃ | Cl | Me | Br |
| Br | CF₃ | Cl | Et | Br |
| Br | CF₃ | Cl | i-Pr | Br |
| Br | CF₃ | Cl | t-Bu | Br |
| Br | CF₃ | Br | Me | Cl |
| Br | CF₃ | Br | Et | Cl |
| Br | CF₃ | Br | i-Pr | Cl |
| Br | CF₃ | Br | t-Bu | Cl |
| Br | CF₃ | Br | Me | Br |
| Br | CF₃ | Br | Et | Br |
| Br | CF₃ | Br | i-Pr | Br |
| Br | CF₃ | Br | t-Bu | Br |
| I | Cl | CF₃ | Me | Cl |
| I | Cl | CF₃ | Et | Cl |
| I | Cl | CF₃ | i-Pr | Cl |
| I | Cl | CF₃ | t-Bu | Cl |
| I | Cl | CF₃ | Me | Br |
| I | Cl | CF₃ | Et | Br |
| I | Cl | CF₃ | i-Pr | Br |
| I | Cl | CF₃ | t-Bu | Br |
| I | Cl | Cl | Me | Cl |
| I | Cl | Cl | Et | Cl |
| I | Cl | Cl | i-Pr | Cl |
| I | Cl | Cl | t-Bu | Cl |
| I | Cl | Cl | Me | Br |
| I | Cl | Cl | Et | Br |
| I | Cl | Cl | i-Pr | Br |
| I | Cl | Cl | t-Bu | Br |
| I | Cl | Br | Me | Cl |
| I | Cl | Br | Et | Cl |
| I | Cl | Br | i-Pr | Cl |
| I | Cl | Br | t-Bu | Cl |
| I | Cl | Br | Me | Br |
| I | Cl | Br | Et | Br |
| I | Cl | Br | i-Pr | Br |
| I | Cl | Br | t-Bu | Br |
| I | H | CF₃ | Me | Cl |
| I | H | CF₃ | Et | Cl |
| I | H | CF₃ | i-Pr | Cl |
| I | H | CF₃ | t-Bu | Cl |

TABLE 8

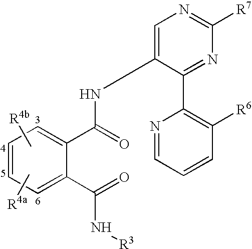

| R³ | R^{4a} | R^{4b} | R⁷ | R⁶ |
|---|---|---|---|---|
| Me | 3-Me | H | CF₃ | F |
| Et | 3-Me | 5-Me | OCF₃ | F |
| i-Pr | 3-Me | H | OCF₃ | F |
| t-Bu | 3-Me | 5-Cl | Br | F |
| Me | 3-Me | H | Br | F |
| Et | 3-Me | H | Cl | F |
| i-Pr | 3-Me | 5-Br | Cl | F |
| t-Bu | 3-Me | H | I | F |
| propargyl | 3-Me | H | CF₃ | F |
| c-propyl | 3-Me | H | OCF₃ | F |
| i-Pr | 3-Me | 5-Cl | CF₃ | F |
| t-Bu | 3-Me | H | SCF₃ | F |
| Me | 3-Me | 5-Cl | SCHF₂ | F |
| Et | 3-Me | H | OCHF₂ | F |
| i-Pr | 3-Me | H | CF₃ | F |
| t-Bu | 3-Me | H | C₂F₅ | F |
| propargyl | 3-Me | H | C₂F₅ | F |
| c-propyl | 3-Me | H | CF₃ | F |
| i-Pr | 3-Me | H | Me | F |
| t-Bu | 3-Me | 5-Br | CN | F |
| Me | 3-Me | H | CF₃ | Cl |
| Et | 3-Me | 5-Me | OCF₃ | Cl |
| i-Pr | 3-Me | H | OCF₃ | Cl |
| t-Bu | 3-Me | 5-Cl | Br | Cl |
| Me | 3-Me | H | Br | Cl |
| Et | 3-Me | H | Cl | Cl |
| i-Pr | 3-Me | 5-Br | Cl | Cl |
| t-Bu | 3-Me | H | I | Cl |
| propargyl | 3-Me | H | CF₃ | Cl |
| c-propyl | 3-Me | H | OCF₃ | Cl |
| i-Pr | 3-Me | 5-Cl | CF₃ | Cl |
| t-Bu | 3-Me | H | SCF₃ | Cl |
| Me | 3-Me | 5-Cl | SCHF₂ | Cl |
| Et | 3-Me | H | OCHF₂ | Cl |
| i-Pr | 3-Me | H | CF₃ | Cl |
| t-Bu | 3-Me | H | C₂F₅ | Cl |
| propargyl | 3-Me | H | C₂F₅ | Cl |
| c-propyl | 3-Me | H | CF₃ | Cl |
| i-Pr | 3-Me | H | Me | Cl |
| t-Bu | 3-Me | 5-Br | CN | Cl |
| Me | 3-Me | H | CF₃ | CF₃ |
| Et | 3-Me | 5-Me | OCF₃ | CF₃ |
| i-Pr | 3-Me | H | OCF₃ | CF₃ |
| t-Bu | 3-Me | 5-Cl | Br | CF₃ |
| Me | 3-Me | H | Br | CF₃ |
| Et | 3-Me | H | Cl | CF₃ |
| i-Pr | 3-Me | 5-Br | Cl | CF₃ |
| t-Bu | 3-Me | H | I | CF₃ |
| propargyl | 3-Me | H | CF₃ | CF₃ |
| c-propyl | 3-Me | H | OCF₃ | CF₃ |
| i-Pr | 3-Me | 5-Cl | CF₃ | CF₃ |
| t-Bu | 3-Me | H | SCF₃ | CF₃ |
| Me | 3-Me | 5-Cl | SCHF₂ | CF₃ |
| Et | 3-Me | H | OCHF₂ | CF₃ |
| i-Pr | 3-Me | H | CF₃ | CF₃ |
| t-Bu | 3-Me | H | C₂F₅ | CF₃ |
| propargyl | 3-Me | H | C₂F₅ | CF₃ |
| c-propyl | 3-Me | H | CF₃ | CF₃ |
| i-Pr | 3-Me | H | Me | CF₃ |
| t-Bu | 3-Me | 5-Br | CN | CF₃ |
| Me | 3-Me | H | CF₃ | Br |
| Et | 3-Me | 5-Me | OCF₃ | Br |
| i-Pr | 3-Me | H | OCF₃ | Br |
| t-Bu | 3-Me | 5-Cl | Br | Br |
| Me | 3-Me | H | Br | Br |
| Et | 3-Me | H | Cl | Br |
| i-Pr | 3-Me | 5-Br | Cl | Br |
| t-Bu | 3-Me | H | I | Br |
| propargyl | 3-Me | H | CF₃ | Br |
| c-propyl | 3-Me | H | OCF₃ | Br |
| i-Pr | 3-Me | 5-Cl | CF₃ | Br |
| t-Bu | 3-Me | H | SCF₃ | Br |
| Me | 3-Me | 5-Cl | SCHF₂ | Br |
| Et | 3-Me | H | OCHF₂ | Br |
| i-Pr 3-Me | H | CF₃ | Br | |
| t-Bu | 3-Me | H | C₂F₅ | Br |
| propargyl | 3-Me | H | C₂F₅ | Br |
| c-propyl | 3-Me | H | CF₃ | Br |
| i-Pr | 3-Me | H | Me | Br |
| t-Bu | 3-Me | 5-Br | CN | Br |
| Me | 6-Me | H | OCHF₂ | F |
| Et | 6-Me | H | OCHF₂ | F |
| i-Pr | 6-Me | H | OCHF₂ | F |
| t-Bu | 6-Me | H | OCHF₂ | F |
| Me | 6-Me | H | SCHF₂ | F |
| Et | 6-Me | H | SCHF₂ | F |
| i-Pr | 6-Me | H | SCHF₂ | F |
| t-Bu | 6-Me | H | SCHF₂ | F |
| Me | 6-Me | H | OCF₃ | F |
| Et | 6-Me | H | OCF₃ | F |
| i-Pr | 6-Me | H | OCF₃ | F |
| t-Bu | 6-Me | H | OCF₃ | F |
| Me | 6-Me | H | SCF₃ | F |
| Et | 6-Me | H | SCF₃ | F |
| i-Pr | 6-Me | H | SCF₃ | F |
| t-Bu | 6-Me | H | SCF₃ | F |
| Me | 6-Me | H | C₂F₅ | F |
| Et | 6-Me | H | C₂F₅ | F |
| i-Pr | 6-Me | H | C₂F₅ | F |
| t-Bu | 6-Me | H | C₂F₅ | F |
| Me | 6-Me | H | n-C₃F₇ | F |
| Et | 6-Me | H | n-C₃F₇ | F |
| i-Pr | 6-Me | H | n-C₃F₇ | F |
| t-Bu | 6-Me | H | n-C₃F₇ | F |
| Me | 6-Me | H | i-C₃F₇ | F |
| Et | 6-Me | H | i-C₃F₇ | F |
| i-Pr | 6-Me | H | i-C₃F₇ | F |
| t-Bu | 6-Me | H | i-C₃F₇ | F |
| Me | 6-Me | H | CN | F |
| Et | 6-Me | H | CN | F |
| i-Pr | 6-Me | H | CN | F |
| t-Bu | 6-Me | H | CN | F |
| Me | 6-Me | H | OCHF₂ | Cl |
| Et | 6-Me | H | OCHF₂ | Cl |
| i-Pr | 6-Me | H | OCHF₂ | Cl |
| t-Bu | 6-Me | H | OCHF₂ | Cl |
| Me | 6-Me | H | SCHF₂ | Cl |
| Et | 6-Me | H | SCHF₂ | Cl |
| i-Pr | 6-Me | H | SCHF₂ | Cl |
| t-Bu | 6-Me | H | SCHF₂ | Cl |
| Me | 6-Me | H | OCF₃ | Cl |
| Et | 6-Me | H | OCF₃ | Cl |
| i-Pr | 6-Me | H | OCF₃ | Cl |
| t-Bu | 6-Me | H | OCF₃ | Cl |
| Me | 6-Me | H | SCF₃ | Cl |
| Et | 6-Me | H | SCF₃ | Cl |
| i-Pr | 6-Me | H | SCF₃ | Cl |
| t-Bu | 6-Me | H | SCF₃ | Cl |
| Me | 6-Me | H | C₂F₅ | Cl |
| Et | 6-Me | H | C₂F₅ | Cl |
| i-Pr | 6-Me | H | C₂F₅ | Cl |
| t-Bu | 6-Me | H | C₂F₅ | Cl |
| Me | 6-Me | H | n-C₃F₇ | Cl |
| Et | 6-Me | H | n-C₃F₇ | Cl |
| i-Pr | 6-Me | H | n-C₃F₇ | Cl |
| t-Bu | 6-Me | H | n-C₃F₇ | Cl |
| Me | 6-Me | H | i-C₃F₇ | Cl |
| Et | 6-Me | H | i-C₃F₇ | Cl |
| i-Pr | 6-Me | H | i-C₃F₇ | Cl |
| t-Bu | 6-Me | H | i-C₃F₇ | Cl |
| Me | 6-Me | H | CN | Cl |
| Et | 6-Me | H | CN | Cl |
| i-Pr | 6-Me | H | CN | Cl |
| t-Bu | 6-Me | H | CN | Cl |
| Me | 6-Me | H | OCHF₂ | Br |
| Et | 6-Me | H | OCHF₂ | Br |
| i-Pr | 6-Me | H | OCHF₂ | Br |
| t-Bu | 6-Me | H | OCHF₂ | Br |
| Me | 6-Me | H | SCHF₂ | Br |
| Et | 6-Me | H | SCHF₂ | Br |
| i-Pr | 6-Me | H | SCHF₂ | Br |
| t-Bu | 6-Me | H | SCHF₂ | Br |
| Me | 6-Me | H | OCF₃ | Br |
| Et | 6-Me | H | OCF₃ | Br |
| i-Pr | 6-Me | H | OCF₃ | Br |
| t-Bu | 6-Me | H | OCF₃ | Br |
| Me | 6-Me | H | SCF₃ | Br |
| Et | 6-Me | H | SCF₃ | Br |
| i-Pr | 6-Me | H | SCF₃ | Br |
| t-Bu | 6-Me | H | SCF₃ | Br |
| Me | 6-Me | H | C₂F₅ | Br |
| Et | 6-Me | H | C₂F₅ | Br |
| i-Pr | 6-Me | H | C₂F₅ | Br |
| t-Bu | 6-Me | H | C₂F₅ | Br |
| Me | 6-Me | H | n-C₃F₇ | Br |
| Et | 6-Me | H | n-C₃F₇ | Br |
| i-Pr | 6-Me | H | n-C₃F₇ | Br |
| t-Bu | 6-Me | H | n-C₃F₇ | Br |
| Me | 6-Me | H | i-C₃F₇ | Br |
| Et | 6-Me | H | i-C₃F₇ | Br |
| i-Pr | 6-Me | H | i-C₃F₇ | Br |
| t-Bu | 6-Me | H | i-C₃F₇ | Br |
| Me | 6-Me | H | CN | Br |
| Et | 6-Me | H | CN | Br |
| i-Pr | 6-Me | H | CN | Br |
| t-Bu | 6-Me | H | CN | Br |
| Me | 6-Me | H | OCHF₂ | CF₃ |
| Et | 6-Me | H | OCHF₂ | CF₃ |
| i-Pr | 6-Me | H | OCHF₂ | CF₃ |
| t-Bu | 6-Me | H | OCHF₂ | CF₃ |
| Me | 6-Me | H | SCHF₂ | CF₃ |
| Et | 6-Me | H | SCHF₂ | CF₃ |
| i-Pr | 6-Me | H | SCHF₂ | CF₃ |
| t-Bu | 6-Me | H | SCHF₂ | CF₃ |
| Me | 6-Me | H | OCF₃ | CF₃ |
| Et | 6-Me | H | OCF₃ | CF₃ |
| i-Pr | 6-Me | H | OCF₃ | CF₃ |
| t-Bu | 6-Me | H | OCF₃ | CF₃ |
| Me | 6-Me | H | SCF₃ | CF₃ |
| Et | 6-Me | H | SCF₃ | CF₃ |
| i-Pr | 6-Me | H | SCF₃ | CF₃ |
| t-Bu | 6-Me | H | SCF₃ | CF₃ |
| Me | 6-Me | H | C₂F₅ | CF₃ |
| Et | 6-Me | H | C₂F₅ | CF₃ |
| i-Pr | 6-Me | H | C₂F₅ | CF₃ |
| t-Bu | 6-Me | H | C₂F₅ | CF₃ |
| Me | 6-Me | H | n-C₃F₇ | CF₃ |
| Et | 6-Me | H | n-C₃F₇ | CF₃ |
| i-Pr | 6-Me | H | n-C₃F₇ | CF₃ |
| t-Bu | 6-Me | H | n-C₃F₇ | CF₃ |
| Me | 6-Me | H | i-C₃F₇ | CF₃ |
| Et | 6-Me | H | i-C₃F₇ | CF₃ |
| i-Pr | 6-Me | H | i-C₃F₇ | CF₃ |
| t-Bu | 6-Me | H | i-C₃F₇ | CF₃ |
| Me | 6-Me | H | CN | CF₃ |
| Et | 6-Me | H | CN | CF₃ |
| i-Pr | 6-Me | H | CN | CF₃ |
| t-Bu | 6-Me | H | CN | CF₃ |
| Me | 6-Me | Cl | OCHF₂ | F |
| Et | 6-Me | Cl | OCHF₂ | F |
| i-Pr | 6-Me | Cl | OCHF₂ | F |
| t-Bu | 6-Me | Cl | OCHF₂ | F |
| Me | 6-Me | Cl | SCHF₂ | F |
| Et | 6-Me | Cl | SCHF₂ | F |
| i-Pr | 6-Me | Cl | SCHF₂ | F |
| t-Bu | 6-Me | Cl | SCHF₂ | F |
| Me | 6-Me | Cl | OCF₃ | F |
| Et | 6-Me | Cl | OCF₃ | F |
| i-Pr | 6-Me | Cl | OCF₃ | F |
| t-Bu | 6-Me | Cl | OCF₃ | F |
| Me | 6-Me | Cl | SCF₃ | F |
| Et | 6-Me | Cl | SCF₃ | F |
| i-Pr | 6-Me | Cl | SCF₃ | F |
| t-Bu | 6-Me | Cl | SCF₃ | F |
| Me | 6-Me | Cl | C₂F₅ | F |
| Et | 6-Me | Cl | C₂F₅ | F |
| i-Pr | 6-Me | Cl | C₂F₅ | F |
| t-Bu | 6-Me | Cl | C₂F₅ | F |
| Me | 6-Me | Cl | n-C₃F₇ | F |
| Et | 6-Me | Cl | n-C₃F₇ | F |
| i-Pr | 6-Me | Cl | n-C₃F₇ | F |
| t-Bu | 6-Me | Cl | n-C₃F₇ | F |
| Me | 6-Me | Cl | i-C₃F₇ | F |
| Et | 6-Me | Cl | i-C₃F₇ | F |
| i-Pr | 6-Me | Cl | i-C₃F₇ | F |
| t-Bu | 6-Me | Cl | i-C₃F₇ | F |
| Me | 6-Me | Cl | CN | F |
| Et | 6-Me | Cl | CN | F |
| i-Pr | 6-Me | Cl | CN | F |
| t-Bu | 6-Me | Cl | CN | F |
| Me | 6-Me | Cl | OCHF₂ | Cl |
| Et | 6-Me | Cl | OCHF₂ | Cl |
| i-Pr | 6-Me | Cl | OCHF₂ | Cl |
| t-Bu | 6-Me | Cl | OCHF₂ | Cl |
| Me | 6-Me | Cl | SCHF₂ | Cl |
| Et | 6-Me | Cl | SCHF₂ | Cl |
| i-Pr | 6-Me | Cl | SCHF₂ | Cl |
| t-Bu | 6-Me | Cl | SCHF₂ | Cl |
| Me | 6-Me | Cl | OCF₃ | Cl |
| Et | 6-Me | Cl | OCF₃ | Cl |
| i-Pr | 6-Me | Cl | OCF₃ | Cl |
| t-Bu | 6-Me | Cl | OCF₃ | Cl |
| Me | 6-Me | Cl | SCF₃ | Cl |
| Et | 6-Me | Cl | SCF₃ | Cl |
| i-Pr | 6-Me | Cl | SCF₃ | Cl |
| t-Bu | 6-Me | Cl | SCF₃ | Cl |
| Me | 6-Me | Cl | C₂F₅ | Cl |
| Et | 6-Me | Cl | C₂F₅ | Cl |
| i-Pr | 6-Me | Cl | C₂F₅ | Cl |
| t-Bu | 6-Me | Cl | C₂F₅ | Cl |
| Me | 6-Me | Cl | n-C₃F₇ | Cl |
| Et | 6-Me | Cl | n-C₃F₇ | Cl |
| i-Pr | 6-Me | Cl | n-C₃F₇ | Cl |
| t-Bu | 6-Me | Cl | n-C₃F₇ | Cl |
| Me | 6-Me | Cl | i-C₃F₇ | Cl |
| Et | 6-Me | Cl | i-C₃F₇ | Cl |
| i-Pr | 6-Me | Cl | i-C₃F₇ | Cl |
| t-Bu | 6-Me | Cl | i-C₃F₇ | Cl |
| Me | 6-Me | Cl | CN | Cl |
| Et | 6-Me | Cl | CN | Cl |
| i-Pr | 6-Me | Cl | CN | Cl |
| t-Bu | 6-Me | Cl | CN | Cl |
| Me | 6-Me | Cl | OCHF₂ | Br |
| Et | 6-Me | Cl | OCHF₂ | Br |
| i-Pr | 6-Me | Cl | OCHF₂ | Br |
| t-Bu | 6-Me | Cl | OCHF₂ | Br |
| Me | 6-Me | Cl | SCHF₂ | Br |
| Et | 6-Me | Cl | SCHF₂ | Br |
| i-Pr | 6-Me | Cl | SCHF₂ | Br |
| t-Bu | 6-Me | Cl | SCHF₂ | Br |
| Me | 6-Me | Cl | OCF₃ | Br |
| Et | 6-Me | Cl | OCF₃ | Br |
| i-Pr | 6-Me | Cl | OCF₃ | Br |
| t-Bu | 6-Me | Cl | OCF₃ | Br |
| Me | 6-Me | Cl | SCF₃ | Br |
| Et | 6-Me | Cl | SCF₃ | Br |
| i-Pr | 6-Me | Cl | SCF₃ | Br |
| t-Bu | 6-Me | Cl | SCF₃ | Br |
| Me | 6-Me | Cl | C₂F₅ | Br |
| Et | 6-Me | Cl | C₂F₅ | Br |
| i-Pr | 6-Me | Cl | C₂F₅ | Br |
| t-Bu | 6-Me | Cl | C₂F₅ | Br |
| Me | 6-Me | Cl | n-C₃F₇ | Br |
| Et | 6-Me | Cl | n-C₃F₇ | Br |
| i-Pr | 6-Me | Cl | n-C₃F₇ | Br |
| t-Bu | 6-Me | Cl | n-C₃F₇ | Br |
| Me | 6-Me | Cl | i-C₃F₇ | Br |
| Et | 6-Me | Cl | i-C₃F₇ | Br |
| i-Pr | 6-Me | Cl | i-C₃F₇ | Br |
| t-Bu | 6-Me | Cl | i-C₃F₇ | Br |
| Me | 6-Me | Cl | CN | Br |
| Et | 6-Me | Cl | CN | Br |
| i-Pr | 6-Me | Cl | CN | Br |
| t-Bu | 6-Me | Cl | CN | Br |
| Me | 6-Me | Cl | OCHF₂ | CF₃ |
| Et | 6-Me | Cl | OCHF₂ | CF₃ |
| i-Pr | 6-Me | Cl | OCHF₂ | CF₃ |
| t-Bu | 6-Me | Cl | OCHF₂ | CF₃ |
| Me | 6-Me | Cl | SCHF₂ | CF₃ |
| Et | 6-Me | Cl | SCHF₂ | CF₃ |
| i-Pr | 6-Me | Cl | SCHF₂ | CF₃ |
| t-Bu | 6-Me | Cl | SCHF₂ | CF₃ |
| Me | 6-Me | Cl | OCF₃ | CF₃ |
| Et | 6-Me | Cl | OCF₃ | CF₃ |
| i-Pr | 6-Me | Cl | OCF₃ | CF₃ |
| t-Bu | 6-Me | Cl | OCF₃ | CF₃ |
| Me | 6-Me | Cl | SCF₃ | CF₃ |
| Et | 6-Me | Cl | SCF₃ | CF₃ |
| i-Pr | 6-Me | Cl | SCF₃ | CF₃ |
| t-Bu | 6-Me | Cl | SCF₃ | CF₃ |
| Me | 6-Me | Cl | C₂F₅ | CF₃ |
| Et | 6-Me | Cl | C₂F₅ | CF₃ |
| i-Pr | 6-Me | Cl | C₂F₅ | CF₃ |
| t-Bu | 6-Me | Cl | C₂F₅ | CF₃ |
| Me | 6-Me | Cl | n-C₃F₇ | CF₃ |
| Et | 6-Me | Cl | n-C₃F₇ | CF₃ |
| i-Pr | 6-Me | Cl | n-C₃F₇ | CF₃ |
| t-Bu | 6-Me | Cl | n-C₃F₇ | CF₃ |
| Me | 6-Me | Cl | i-C₃F₇ | CF₃ |
| Et | 6-Me | Cl | i-C₃F₇ | CF₃ |
| i-Pr | 6-Me | Cl | i-C₃F₇ | CF₃ |
| t-Bu | 6-Me | Cl | i-C₃F₇ | CF₃ |
| Me | 6-Me | Cl | CN | CF₃ |
| Et | 6-Me | Cl | CN | CF₃ |
| i-Pr | 6-Me | Cl | CN | CF₃ |
| t-Bu | 6-Me | Cl | CN | CF₃ |
| Me | 3-Cl | H | CF₃ | F |
| Et | 3-Cl | 5-Me | OCF₃ | F |
| i-Pr | 3-Cl | H | OCF₃ | F |
| t-Bu | 3-Cl | 5-Cl | Br | F |
| Me | 3-Cl | H | Br | F |
| Et | 3-Cl | H | Cl | F |
| i-Pr | 3-Cl | 5-Br | Cl | F |
| t-Bu | 3-Cl | H | I | F |
| propargyl | 3-Cl | H | CF₃ | F |
| c-propyl | 3-Cl | H | OCF₃ | F |
| i-Pr | 3-Cl | 5-Cl | CF₃ | F |
| t-Bu | 3-Cl | H | SCF₃ | F |
| Me | 3-Cl | 5-Cl | SCHF₂ | F |
| Et | 3-Cl | H | OCHF₂ | F |
| i-Pr | 3-Cl | H | CF₃ | F |
| t-Bu | 3-Cl | H | C₂F₅ | F |
| propargyl | 3-Cl | H | C₂F₅ | F |
| c-propyl | 3-Cl | H | CF₃ | F |
| i-Pr | 3-Cl | H | Me | F |
| t-Bu | 3-Cl | 5-Br | CN | F |
| Me | 3-Cl | H | CF₃ | Cl |
| Et | 3-Cl | 5-Me | OCF₃ | Cl |
| i-Pr | 3-Cl | H | OCF₃ | Cl |
| t-Bu | 3-Cl | 5-Cl | Br | Cl |
| Me | 3-Cl | H | Br | Cl |
| Et | 3-Cl | H | Cl | Cl |
| i-Pr | 3-Cl | 5-Br | Cl | Cl |
| t-Bu | 3-Cl | H | I | Cl |
| propargyl | 3-Cl | H | CF₃ | Cl |
| c-propyl | 3-Cl | H | OCF₃ | Cl |
| i-Pr | 3-Cl | 5-Cl | CF₃ | Cl |
| t-Bu | 3-Cl | H | SCF₃ | Cl |
| Me | 3-Cl | 5-Cl | SCHF₂ | Cl |
| Et | 3-Cl | H | OCHF₂ | Cl |
| i-Pr | 3-Cl | H | CF₃ | Cl |
| t-Bu | 3-Cl | H | C₂F₅ | Cl |
| propargyl | 3-Cl | H | C₂F₅ | Cl |
| c-propyl | 3-Cl | H | CF₃ | Cl |
| i-Pr | 3-Cl | H | Me | Cl |
| t-Bu | 3-Cl | 5-Br | CN | Cl |
| Me | 3-Cl | H | CF₃ | CF₃ |
| Et | 3-Cl | 5-Me | OCF₃ | CF₃ |
| i-Pr | 3-Cl | H | OCF₃ | CF₃ |
| t-Bu | 3-Cl | 5-Cl | Br | CF₃ |
| Me | 3-Cl | H | Br | CF₃ |
| Et | 3-Cl | H | Cl | CF₃ |
| i-Pr | 3-Cl | 5-Br | Cl | CF₃ |
| t-Bu | 3-Cl | H | I | CF₃ |
| propargyl | 3-Cl | H | CF₃ | CF₃ |
| c-propyl | 3-Cl | H | OCF₃ | CF₃ |
| i-Pr | 3-Cl | 5-Cl | CF₃ | CF₃ |
| t-Bu | 3-Cl | H | SCF₃ | CF₃ |
| Me | 3-Cl | 5-Cl | SCHF₂ | CF₃ |
| Et | 3-Cl | H | OCHF₂ | CF₃ |
| i-Pr | 3-Cl | H | CF₃ | CF₃ |
| t-Bu | 3-Cl | H | C₂F₅ | CF₃ |
| propargyl | 3-Cl | H | C₂F₅ | CF₃ |
| c-propyl | 3-Cl | H | CF₃ | CF₃ |
| i-Pr | 3-Cl | H | Me | CF₃ |
| t-Bu | 3-Cl | 5-Br | CN | CF₃ |
| Me | 3-Cl | H | CF₃ | Br |
| Et | 3-Cl | 5-Me | OCF₃ | Br |
| i-Pr | 3-Cl | H | OCF₃ | Br |
| t-Bu | 3-Cl | 5-Cl | Br | Br |
| Me | 3-Cl | H | Br | Br |
| Et | 3-Cl | H | Cl | Br |
| i-Pr | 3-Cl | 5-Br | Cl | Br |
| t-Bu | 3-Cl | H | I | Br |
| propargyl | 3-Cl | H | CF₃ | Br |
| c-propyl | 3-Cl | H | OCF₃ | Br |
| i-Pr | 3-Cl | 5-Cl | CF₃ | Br |
| t-Bu | 3-Cl | H | SCF₃ | Br |
| Me | 3-Cl | 5-Cl | SCHF₂ | Br |
| Et | 3-Cl | H | OCHF₂ | Br |
| i-Pr | 3-Cl | H | CF₃ | Br |
| t-Bu | 3-Cl | H | C₂F₅ | Br |
| propargyl | 3-Cl | H | C₂F₅ | Br |
| c-propyl | 3-Cl | H | CF₃ | Br |
| i-Pr | 3-Cl | H | Me | Br |
| t-Bu | 3-Cl | 5-Br | CN | Br |
| Me | 6-Cl | H | OCHF₂ | F |
| Et | 6-Cl | H | OCHF₂ | F |
| i-Pr | 6-Cl | H | OCHF₂ | F |
| t-Bu | 6-Cl | H | OCHF₂ | F |
| Me | 6-Cl | H | SCHF₂ | F |
| Et | 6-Cl | H | SCHF₂ | F |
| i-Pr | 6-Cl | H | SCHF₂ | F |
| t-Bu | 6-Cl | H | SCHF₂ | F |
| Me | 6-Cl | H | OCF₃ | F |
| Et | 6-Cl | H | OCF₃ | F |
| i-Pr | 6-Cl | H | OCF₃ | F |
| t-Bu | 6-Cl | H | OCF₃ | F |
| Me | 6-Cl | H | SCF₃ | F |
| Et | 6-Cl | H | SCF₃ | F |
| i-Pr | 6-Cl | H | SCF₃ | F |
| t-Bu | 6-Cl | H | SCF₃ | F |
| Me | 6-Cl | H | C₂F₅ | F |
| Et | 6-Cl | H | C₂F₅ | F |
| i-Pr | 6-Cl | H | C₂F₅ | F |
| t-Bu | 6-Cl | H | C₂F₅ | F |
| Me | 6-Cl | H | n-C₃F₇ | F |
| Et | 6-Cl | H | n-C₃F₇ | F |
| i-Pr | 6-Cl | H | n-C₃F₇ | F |
| t-Bu | 6-Cl | H | n-C₃F₇ | F |
| Me | 6-Cl | H | i-C₃F₇ | F |
| Et | 6-Cl | H | i-C₃F₇ | F |
| i-Pr | 6-Cl | H | i-C₃F₇ | F |
| t-Bu | 6-Cl | H | i-C₃F₇ | F |
| Me | 6-Cl | H | CN | F |
| Et | 6-Cl | H | CN | F |
| i-Pr | 6-Cl | H | CN | F |
| t-Bu | 6-Cl | H | CN | F |
| Me | 6-Cl | H | OCHF₂ | Cl |
| Et | 6-Cl | H | OCHF₂ | Cl |
| i-Pr | 6-Cl | H | OCHF₂ | Cl |
| t-Bu | 6-Cl | H | OCHF₂ | Cl |
| Me | 6-Cl | H | SCHF₂ | Cl |
| Et | 6-Cl | H | SCHF₂ | Cl |
| i-Pr | 6-Cl | H | SCHF₂ | Cl |
| t-Bu | 6-Cl | H | SCHF₂ | Cl |
| Me | 6-Cl | H | OCF₃ | Cl |
| Et | 6-Cl | H | OCF₃ | Cl |
| i-Pr | 6-Cl | H | OCF₃ | Cl |
| t-Bu | 6-Cl | H | OCF₃ | Cl |
| Me | 6-Cl | H | SCF₃ | Cl |
| Et | 6-Cl | H | SCF₃ | Cl |
| i-Pr | 6-Cl | H | SCF₃ | Cl |
| t-Bu | 6-Cl | H | SCF₃ | Cl |
| Me | 6-Cl | H | C₂F₅ | Cl |
| Et | 6-Cl | H | C₂F₅ | Cl |
| i-Pr | 6-Cl | H | C₂F₅ | Cl |
| t-Bu | 6-Cl | H | C₂F₅ | Cl |
| Me | 6-Cl | H | n-C₃F₇ | Cl |
| Et | 6-Cl | H | n-C₃F₇ | Cl |
| i-Pr | 6-Cl | H | n-C₃F₇ | Cl |
| t-Bu | 6-Cl | H | n-C₃F₇ | Cl |
| Me | 6-Cl | H | i-C₃F₇ | Cl |
| Et | 6-Cl | H | i-C₃F₇ | Cl |
| i-Pr | 6-Cl | H | i-C₃F₇ | Cl |
| t-Bu | 6-Cl | H | i-C₃F₇ | Cl |
| Me | 6-Cl | H | CN | Cl |
| Et | 6-Cl | H | CN | Cl |
| i-Pr | 6-Cl | H | CN | Cl |
| t-Bu | 6-Cl | H | CN | Cl |
| Me | 6-Cl | H | OCHF₂ | Br |
| Et | 6-Cl | H | OCHF₂ | Br |
| i-Pr | 6-Cl | H | OCHF₂ | Br |
| t-Bu | 6-Cl | H | OCHF₂ | Br |
| Me | 6-Cl | H | SCHF₂ | Br |
| Et | 6-Cl | H | SCHF₂ | Br |
| i-Pr | 6-Cl | H | SCHF₂ | Br |
| t-Bu | 6-Cl | H | SCHF₂ | Br |
| Me | 6-Cl | H | OCF₃ | Br |
| Et | 6-Cl | H | OCF₃ | Br |
| i-Pr | 6-Cl | H | OCF₃ | Br |
| t-Bu | 6-Cl | H | OCF₃ | Br |
| Me | 6-Cl | H | SCF₃ | Br |
| Et | 6-Cl | H | SCF₃ | Br |
| i-Pr | 6-Cl | H | SCF₃ | Br |
| t-Bu | 6-Cl | H | SCF₃ | Br |
| Me | 6-Cl | H | C₂F₅ | Br |
| Et | 6-Cl | H | C₂F₅ | Br |
| i-Pr | 6-Cl | H | C₂F₅ | Br |
| t-Bu | 6-Cl | H | C₂F₅ | Br |
| Me | 6-Cl | H | n-C₃F₇ | Br |
| Et | 6-Cl | H | n-C₃F₇ | Br |
| i-Pr | 6-Cl | H | n-C₃F₇ | Br |
| t-Bu | 6-Cl | H | n-C₃F₇ | Br |
| Me | 6-Cl | H | i-C₃F₇ | Br |
| Et | 6-Cl | H | i-C₃F₇ | Br |
| i-Pr | 6-Cl | H | i-C₃F₇ | Br |
| t-Bu | 6-Cl | H | i-C₃F₇ | Br |
| Me | 6-Cl | H | CN | Br |
| Et | 6-Cl | H | CN | Br |
| i-Pr | 6-Cl | H | CN | Br |
| t-Bu | 6-Cl | H | CN | Br |
| Me | 6-Cl | H | OCHF₂ | CF₃ |
| Et | 6-Cl | H | OCHF₂ | CF₃ |
| i-Pr | 6-Cl | H | OCHF₂ | CF₃ |
| t-Bu | 6-Cl | H | OCHF₂ | CF₃ |
| Me | 6-Cl | H | SCHF₂ | CF₃ |
| Et | 6-Cl | H | SCHF₂ | CF₃ |
| i-Pr | 6-Cl | H | SCHF₂ | CF₃ |
| t-Bu | 6-Cl | H | SCHF₂ | CF₃ |
| Me | 6-Cl | H | OCF₃ | CF₃ |
| Et | 6-Cl | H | OCF₃ | CF₃ |
| i-Pr | 6-Cl | H | OCF₃ | CF₃ |
| t-Bu | 6-Cl | H | OCF₃ | CF₃ |
| Me | 6-Cl | H | SCF₃ | CF₃ |
| Et | 6-Cl | H | SCF₃ | CF₃ |
| i-Pr | 6-Cl | H | SCF₃ | CF₃ |
| t-Bu | 6-Cl | H | SCF₃ | CF₃ |
| Me | 6-Cl | H | C₂F₅ | CF₃ |
| Et | 6-Cl | H | C₂F₅ | CF₃ |
| i-Pr | 6-Cl | H | C₂F₅ | CF₃ |
| t-Bu | 6-Cl | H | C₂F₅ | CF₃ |
| Me | 6-Cl | H | n-C₃F₇ | CF₃ |
| Et | 6-Cl | H | n-C₃F₇ | CF₃ |
| i-Pr | 6-Cl | H | n-C₃F₇ | CF₃ |
| t-Bu | 6-Cl | H | n-C₃F₇ | CF₃ |
| Me | 6-Cl | H | i-C₃F₇ | CF₃ |
| Et | 6-Cl | H | i-C₃F₇ | CF₃ |
| i-Pr | 6-Cl | H | i-C₃F₇ | CF₃ |
| t-Bu | 6-Cl | H | i-C₃F₇ | CF₃ |
| Me | 6-Cl | H | CN | CF₃ |
| Et | 6-Cl | H | CN | CF₃ |
| i-Pr | 6-Cl | H | CN | CF₃ |
| t-Bu | 6-Cl | H | CN | CF₃ |
| Me | 6-Cl | Cl | OCHF₂ | F |
| Et | 6-Cl | Cl | OCHF₂ | F |
| i-Pr | 6-Cl | Cl | OCHF₂ | F |
| t-Bu | 6-Cl | Cl | OCHF₂ | F |
| Me | 6-Cl | Cl | SCHF₂ | F |
| Et | 6-Cl | Cl | SCHF₂ | F |
| i-Pr | 6-Cl | Cl | SCHF₂ | F |
| t-Bu | 6-Cl | Cl | SCHF₂ | F |
| Me | 6-Cl | Cl | OCF₃ | F |
| Et | 6-Cl | Cl | OCF₃ | F |
| i-Pr | 6-Cl | Cl | OCF₃ | F |
| t-Bu | 6-Cl | Cl | OCF₃ | F |
| Me | 6-Cl | Cl | SCF₃ | F |
| Et | 6-Cl | Cl | SCF₃ | F |
| i-Pr | 6-Cl | Cl | SCF₃ | F |
| t-Bu | 6-Cl | Cl | SCF₃ | F |
| Me | 6-Cl | Cl | C₂F₅ | F |
| Et | 6-Cl | Cl | C₂F₅ | F |
| i-Pr | 6-Cl | Cl | C₂F₅ | F |
| t-Bu | 6-Cl | Cl | C₂F₅ | F |
| Me | 6-Cl | Cl | n-C₃F₇ | F |
| Et | 6-Cl | Cl | n-C₃F₇ | F |
| i-Pr | 6-Cl | Cl | n-C₃F₇ | F |
| t-Bu | 6-Cl | Cl | n-C₃F₇ | F |
| Me | 6-Cl | Cl | i-C₃F₇ | F |
| Et | 6-Cl | Cl | i-C₃F₇ | F |
| i-Pr | 6-Cl | Cl | i-C₃F₇ | F |
| t-Bu | 6-Cl | Cl | i-C₃F₇ | F |
| Me | 6-Cl | Cl | CN | F |
| Et | 6-Cl | Cl | CN | F |
| i-Pr | 6-Cl | Cl | CN | F |
| t-Bu | 6-Cl | Cl | CN | F |
| Me | 6-Cl | Cl | OCHF₂ | Cl |
| Et | 6-Cl | Cl | OCHF₂ | Cl |
| i-Pr | 6-Cl | Cl | OCHF₂ | Cl |
| t-Bu | 6-Cl | Cl | OCHF₂ | Cl |
| Me | 6-Cl | Cl | SCHF₂ | Cl |
| Et | 6-Cl | Cl | SCHF₂ | Cl |
| i-Pr | 6-Cl | Cl | SCHF₂ | Cl |
| t-Bu | 6-Cl | Cl | SCHF₂ | Cl |
| Me | 6-Cl | Cl | OCF₃ | Cl |
| Et | 6-Cl | Cl | OCF₃ | Cl |
| i-Pr | 6-Cl | Cl | OCF₃ | Cl |
| t-Bu | 6-Cl | Cl | OCF₃ | Cl |
| Me | 6-Cl | Cl | SCF₃ | Cl |
| Et | 6-Cl | Cl | SCF₃ | Cl |
| i-Pr | 6-Cl | Cl | SCF₃ | Cl |
| t-Bu | 6-Cl | Cl | SCF₃ | Cl |
| Me | 6-Cl | Cl | C₂F₅ | Cl |
| Et | 6-Cl | Cl | C₂F₅ | Cl |
| i-Pr | 6-Cl | Cl | C₂F₅ | Cl |
| t-Bu | 6-Cl | Cl | C₂F₅ | Cl |
| Me | 6-Cl | Cl | n-C₃F₇ | Cl |
| Et | 6-Cl | Cl | n-C₃F₇ | Cl |
| i-Pr | 6-Cl | Cl | n-C₃F₇ | Cl |
| t-Bu | 6-Cl | Cl | n-C₃F₇ | Cl |
| Me | 6-Cl | Cl | i-C₃F₇ | Cl |
| Et | 6-Cl | Cl | i-C₃F₇ | Cl |
| i-Pr | 6-Cl | Cl | i-C₃F₇ | Cl |
| t-Bu | 6-Cl | Cl | i-C₃F₇ | Cl |
| Me | 6-Cl | Cl | CN | Cl |
| Et | 6-Cl | Cl | CN | Cl |
| i-Pr | 6-Cl | Cl | CN | Cl |
| t-Bu | 6-Cl | Cl | CN | Cl |
| Me | 6-Cl | Cl | OCHF₂ | Br |
| Et | 6-Cl | Cl | OCHF₂ | Br |
| i-Pr | 6-Cl | Cl | OCHF₂ | Br |
| t-Bu | 6-Cl | Cl | OCHF₂ | Br |
| Me | 6-Cl | Cl | SCHF₂ | Br |
| Et | 6-Cl | Cl | SCHF₂ | Br |
| i-Pr | 6-Cl | Cl | SCHF₂ | Br |
| t-Bu | 6-Cl | Cl | SCHF₂ | Br |
| Me | 6-Cl | Cl | OCF₃ | Br |
| Et | 6-Cl | Cl | OCF₃ | Br |
| i-Pr | 6-Cl | Cl | OCF₃ | Br |
| t-Bu | 6-Cl | Cl | OCF₃ | Br |
| Me | 6-Cl | Cl | SCF₃ | Br |
| Et | 6-Cl | Cl | SCF₃ | Br |
| i-Pr | 6-Cl | Cl | SCF₃ | Br |
| t-Bu | 6-Cl | Cl | SCF₃ | Br |
| Me | 6-Cl | Cl | C₂F₅ | Br |
| Et | 6-Cl | Cl | C₂F₅ | Br |
| i-Pr | 6-Cl | Cl | C₂F₅ | Br |
| t-Bu | 6-Cl | Cl | C₂F₅ | Br |
| Me | 6-Cl | Cl | n-C₃F₇ | Br |
| Et | 6-Cl | Cl | n-C₃F₇ | Br |
| i-Pr | 6-Cl | Cl | n-C₃F₇ | Br |
| t-Bu | 6-Cl | Cl | n-C₃F₇ | Br |
| Me | 6-Cl | Cl | i-C₃F₇ | Br |
| Et | 6-Cl | Cl | i-C₃F₇ | Br |
| i-Pr | 6-Cl | Cl | i-C₃F₇ | Br |
| t-Bu | 6-Cl | Cl | i-C₃F₇ | Br |
| Me | 6-Cl | Cl | CN | Br |
| Et | 6-Cl | Cl | CN | Br |
| i-Pr | 6-Cl | Cl | CN | Br |
| t-Bu | 6-Cl | Cl | CN | Br |
| Me | 6-Cl | Cl | OCHF₂ | CF₃ |
| Et | 6-Cl | Cl | OCHF₂ | CF₃ |
| i-Pr | 6-Cl | Cl | OCHF₂ | CF₃ |
| t-Bu | 6-Cl | Cl | OCHF₂ | CF₃ |
| Me | 6-Cl | Cl | SCHF₂ | CF₃ |
| Et | 6-Cl | Cl | SCHF₂ | CF₃ |
| i-Pr | 6-Cl | Cl | SCHF₂ | CF₃ |
| t-Bu | 6-Cl | Cl | SCHF₂ | CF₃ |
| Me | 6-Cl | Cl | OCF₃ | CF₃ |
| Et | 6-Cl | Cl | OCF₃ | CF₃ |
| i-Pr | 6-Cl | Cl | OCF₃ | CF₃ |
| t-Bu | 6-Cl | Cl | OCF₃ | CF₃ |
| Me | 6-Cl | Cl | SCF₃ | CF₃ |
| Et | 6-Cl | Cl | SCF₃ | CF₃ |
| i-Pr | 6-Cl | Cl | SCF₃ | CF₃ |
| t-Bu | 6-Cl | Cl | SCF₃ | CF₃ |
| Me | 6-Cl | Cl | C₂F₅ | CF₃ |
| Et | 6-Cl | Cl | C₂F₅ | CF₃ |
| i-Pr | 6-Cl | Cl | C₂F₅ | CF₃ |
| t-Bu | 6-Cl | Cl | C₂F₅ | CF₃ |
| Me | 6-Cl | Cl | n-C₃F₇ | CF₃ |
| Et | 6-Cl | Cl | n-C₃F₇ | CF₃ |
| i-Pr | 6-Cl | Cl | n-C₃F₇ | CF₃ |
| t-Bu | 6-Cl | Cl | n-C₃F₇ | CF₃ |
| Me | 6-Cl | Cl | i-C₃F₇ | CF₃ |
| Et | 6-Cl | Cl | i-C₃F₇ | CF₃ |
| i-Pr | 6-Cl | Cl | i-C₃F₇ | CF₃ |
| t-Bu | 6-Cl | Cl | i-C₃F₇ | CF₃ |
| Me | 6-Cl | Cl | CN | CF₃ |
| Et | 6-Cl | Cl | CN | CF₃ |
| i-Pr | 6-Cl | Cl | CN | CF₃ |
| t-Bu | 6-Cl | Cl | CN | CF₃ |

TABLE 9

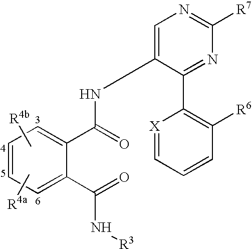

| R³ | R^{4a} | R^{4b} | R⁷ | R⁶ | X |
|---|---|---|---|---|---|
| Me | 6-Me | H | OCHF₂ | F | CH |
| Et | 6-Me | H | OCHF₂ | F | CH |
| i-Pr | 6-Me | H | OCHF₂ | F | CH |
| t-Bu | 6-Me | H | OCHF₂ | F | CH |
| Me | 6-Me | H | SCHF₂ | F | CH |
| Et | 6-Me | H | SCHF₂ | F | CH |
| i-Pr | 6-Me | H | SCHF₂ | F | CH |
| t-Bu | 6-Me | H | SCHF₂ | F | CH |
| Me | 6-Me | H | OCF₃ | F | CH |
| Et | 6-Me | H | OCF₃ | F | CH |
| i-Pr | 6-Me | H | OCF₃ | F | CH |
| t-Bu | 6-Me | H | OCF₃ | F | CH |
| Me | 6-Me | H | SCF₃ | F | CH |
| Et | 6-Me | H | SCF₃ | F | CH |
| i-Pr | 6-Me | H | SCF₃ | F | CH |
| t-Bu | 6-Me | H | SCF₃ | F | CH |
| Me | 6-Me | H | C₂F₅ | F | CH |
| Et | 6-Me | H | C₂F₅ | F | CH |
| i-Pr | 6-Me | H | C₂F₅ | F | CH |
| t-Bu | 6-Me | H | C₂F₅ | F | CH |
| Me | 6-Me | H | n-C₃F1 | F | CH |
| Et | 6-Me | H | n-C₃F₇ | F | CH |
| i-Pr | 6-Me | H | n-C₃F₇ | F | CH |
| t-Bu | 6-Me | H | n-C₃F₇ | F | CH |
| Me | 6-Me | H | i-C₃F₇ | F | CH |
| Et | 6-Me | H | i-C₃F₇ | F | CH |
| i-Pr | 6-Me | H | i-C₃F₇ | F | CH |
| t-Bu | 6-Me | H | i-C₃F₇ | F | CH |
| Me | 6-Me | H | CN | F | CH |
| Et | 6-Me | H | CN | F | CH |
| i-Pr | 6-Me | H | CN | F | CH |
| t-Bu | 6-Me | H | CN | F | CH |
| Me | 6-Me | H | OCHF₂ | Cl | CH |
| Et | 6-Me | H | OCHF₂ | Cl | CH |
| i-Pr | 6-Me | H | OCHF₂ | Cl | CH |
| t-Bu | 6-Me | H | OCHF₂ | Cl | CH |
| Me | 6-Me | H | SCHF₂ | Cl | CH |
| Et | 6-Me | H | SCHF₂ | Cl | CH |
| i-Pr | 6-Me | H | SCHF₂ | Cl | CH |
| t-Bu | 6-Me | H | SCHF₂ | Cl | CH |
| Me | 6-Me | H | OCF₃ | Cl | CH |
| Et | 6-Me | H | OCF₃ | Cl | CH |
| i-Pr | 6-Me | H | OCF₃ | Cl | CH |
| t-Bu | 6-Me | H | OCF₃ | Cl | CH |
| Me | 6-Me | H | SCF₃ | Cl | CH |
| Et | 6-Me | H | SCF₃ | Cl | CH |
| i-Pr | 6-Me | H | SCF₃ | Cl | CH |
| t-Bu | 6-Me | H | SCF₃ | Cl | CH |
| Me | 6-Me | H | C₂F₅ | Cl | CH |
| Et | 6-Me | H | C₂F₅ | Cl | CH |
| i-Pr | 6-Me | H | C₂F₅ | Cl | CH |
| t-Bu | 6-Me | H | C₂F₅ | Cl | CH |
| Me | 6-Me | H | n-C₃F₇ | Cl | CH |
| Et | 6-Me | H | n-C₃F₇ | Cl | CH |
| i-Pr | 6-Me | H | n-C₃F₇ | Cl | CH |
| t-Bu | 6-Me | H | n-C₃F₇ | Cl | CH |
| Me | 6-Me | H | i-C₃F₇ | Cl | CH |
| Et | 6-Me | H | i-C₃F₇ | Cl | CH |
| i-Pr | 6-Me | H | i-C₃F₇ | Cl | CH |
| t-Bu | 6-Me | H | i-C₃F₇ | Cl | CH |
| Me | 6-Me | H | CN | Cl | CH |
| Et | 6-Me | H | CN | Cl | CH |
| i-Pr | 6-Me | H | CN | Cl | CH |
| t-Bu | 6-Me | H | CN | Cl | CH |
| Me | 6-Me | H | OCHF₂ | Br | CH |
| Et | 6-Me | H | OCHF₂ | Br | CH |
| i-Pr | 6-Me | H | OCHF₂ | Br | CH |
| t-Bu | 6-Me | H | OCHF₂ | Br | CH |
| Me | 6-Me | H | SCHF₂ | Br | CH |
| Et | 6-Me | H | SCHF₂ | Br | CH |
| i-Pr | 6-Me | H | SCHF₂ | Br | CH |
| t-Bu | 6-Me | H | SCHF₂ | Br | CH |
| Me | 6-Me | H | OCF₃ | Br | CH |
| Et | 6-Me | H | OCF₃ | Br | CH |
| i-Pr | 6-Me | H | OCF₃ | Br | CH |
| t-Bu | 6-Me | H | OCF₃ | Br | CH |
| Me | 6-Me | H | SCF₃ | Br | CH |
| Et | 6-Me | H | SCF₃ | Br | CH |
| i-Pr | 6-Me | H | SCF₃ | Br | CH |
| t-Bu | 6-Me | H | SCF₃ | Br | CH |
| Me | 6-Me | H | C₂F₅ | Br | CH |
| Et | 6-Me | H | C₂F₅ | Br | CH |
| i-Pr | 6-Me | H | C₂F₅ | Br | CH |
| t-Bu | 6-Me | H | C₂F₅ | Br | CH |
| Me | 6-Me | H | n-C₃F₇ | Br | CH |
| Et | 6-Me | H | n-C₃F₇ | Br | CH |
| i-Pr | 6-Me | H | n-C₃F₇ | Br | CH |
| t-Bu | 6-Me | H | n-C₃F₇ | Br | CH |
| Me | 6-Me | H | i-C₃F₇ | Br | CH |
| Et | 6-Me | H | i-C₃F₇ | Br | CH |
| i-Pr | 6-Me | H | i-C₃F₇ | Br | CH |
| t-Bu | 6-Me | H | i-C₃F₇ | Br | CH |
| Me | 6-Me | H | CN | Br | CH |
| Et | 6-Me | H | CN | Br | CH |
| i-Pr | 6-Me | H | CN | Br | CH |
| t-Bu | 6-Me | H | CN | Br | CH |
| Me | 6-Me | H | OCHF₂ | CF₃ | CH |
| Et | 6-Me | H | OCHF₂ | CF₃ | CH |
| i-Pr | 6-Me | H | OCHF₂ | CF₃ | CH |
| t-Bu | 6-Me | H | OCHF₂ | CF₃ | CH |
| Me | 6-Me | H | SCHF₂ | CF₃ | CH |
| Et | 6-Me | H | SCHF₂ | CF₃ | CH |
| i-Pr | 6-Me | H | SCHF₂ | CF₃ | CH |
| t-Bu | 6-Me | H | SCHF₂ | CF₃ | CH |
| Me | 6-Me | H | OCF₃ | CF₃ | CH |
| Et | 6-Me | H | OCF₃ | CF₃ | CH |
| i-Pr | 6-Me | H | OCF₃ | CF₃ | CH |
| t-Bu | 6-Me | H | OCF₃ | CF₃ | CH |
| Me | 6-Me | H | SCF₃ | CF₃ | CH |
| Et | 6-Me | H | SCF₃ | CF₃ | CH |
| i-Pr | 6-Me | H | SCF₃ | CF₃ | CH |
| t-Bu | 6-Me | H | SCF₃ | CF₃ | CH |
| Me | 6-Me | H | C₂F₅ | CF₃ | CH |
| Et | 6-Me | H | C₂F₅ | CF₃ | CH |
| i-Pr | 6-Me | H | C₂F₅ | CF₃ | CH |
| t-Bu | 6-Me | H | C₂F₅ | CF₃ | CH |
| Me | 6-Me | H | n-C₃F₇ | CF₃ | CH |
| Et | 6-Me | H | n-C₃F₇ | CF₃ | CH |
| i-Pr | 6-Me | H | n-C₃F₇ | CF₃ | CH |
| t-Bu | 6-Me | H | n-C₃F₇ | CF₃ | CH |
| Me | 6-Me | H | i-C₃F₇ | CF₃ | CH |
| Et | 6-Me | H | i-C₃F₇ | CF₃ | CH |
| i-Pr | 6-Me | H | i-C₃F₇ | CF₃ | CH |
| t-Bu | 6-Me | H | i-C₃F₇ | CF₃ | CH |
| Me | 6-Me | H | CN | CF₃ | CH |
| Et | 6-Me | H | CN | CF₃ | CH |
| i-Pr | 6-Me | H | CN | CF₃ | CH |
| t-Bu | 6-Me | H | CN | CF₃ | CH |
| Me | 6-Me | Cl | OCHF₂ | F | CH |
| Et | 6-Me | Cl | OCHF₂ | F | CH |
| i-Pr | 6-Me | Cl | OCHF₂ | F | CH |
| t-Bu | 6-Me | Cl | OCHF₂ | F | CH |
| Me | 6-Me | Cl | SCHF₂ | F | CH |
| Et | 6-Me | Cl | SCHF₂ | F | CH |
| i-Pr | 6-Me | Cl | SCHF₂ | F | CH |
| t-Bu | 6-Me | Cl | SCHF₂ | F | CH |
| Me | 6-Me | Cl | OCF₃ | F | CH |
| Et | 6-Me | Cl | OCF₃ | F | CH |
| i-Pr | 6-Me | Cl | OCF₃ | F | CH |
| t-Bu | 6-Me | Cl | OCF₃ | F | CH |
| Me | 6-Me | Cl | SCF₃ | F | CH |
| Et | 6-Me | Cl | SCF₃ | F | CH |
| i-Pr | 6-Me | Cl | SCF₃ | F | CH |
| t-Bu | 6-Me | Cl | SCF₃ | F | CH |
| Me | 6-Me | Cl | C₂F₅ | F | CH |
| Et | 6-Me | Cl | C₂F₅ | F | CH |
| i-Pr | 6-Me | Cl | C₂F₅ | F | CH |
| t-Bu | 6-Me | Cl | C₂F₅ | F | CH |
| Me | 6-Me | Cl | n-C₃F₇ | F | CH |
| Et | 6-Me | Cl | n-C₃F₇ | F | CH |
| i-Pr | 6-Me | Cl | n-C₃F₇ | F | CH |
| t-Bu | 6-Me | Cl | n-C₃F₇ | F | CH |
| Me | 6-Me | Cl | i-C₃F₇ | F | CH |
| Et | 6-Me | Cl | i-C₃F₇ | F | CH |
| i-Pr | 6-Me | Cl | i-C₃F₇ | F | CH |
| t-Bu | 6-Me | Cl | i-C₃F₇ | F | CH |
| Me | 6-Me | Cl | CN | F | CH |
| Et | 6-Me | Cl | CN | F | CH |
| i-Pr | 6-Me | Cl | CN | F | CH |
| t-Bu | 6-Me | Cl | CN | F | CH |
| Me | 6-Me | Cl | OCHF₂ | Cl | CH |
| Et | 6-Me | Cl | OCHF₂ | Cl | CH |
| i-Pr | 6-Me | Cl | OCHF₂ | Cl | CH |
| t-Bu | 6-Me | Cl | OCHF₂ | Cl | CH |
| Me | 6-Me | Cl | SCHF₂ | Cl | CH |
| Et | 6-Me | Cl | SCHF₂ | Cl | CH |
| i-Pr | 6-Me | Cl | SCHF₂ | Cl | CH |
| t-Bu | 6-Me | Cl | SCHF₂ | Cl | CH |
| Me | 6-Me | Cl | OCF₃ | Cl | CH |
| Et | 6-Me | Cl | OCF₃ | Cl | CH |
| i-Pr | 6-Me | Cl | OCF₃ | Cl | CH |
| t-Bu | 6-Me | Cl | OCF₃ | Cl | CH |
| Me | 6-Me | Cl | SCF₃ | Cl | CH |
| Et | 6-Me | Cl | SCF₃ | Cl | CH |
| i-Pr | 6-Me | Cl | SCF₃ | Cl | CH |
| t-Bu | 6-Me | Cl | SCF₃ | Cl | CH |
| Me | 6-Me | Cl | C₂F₅ | Cl | CH |
| Et | 6-Me | Cl | C₂F₅ | Cl | CH |
| i-Pr | 6-Me | Cl | C₂F₅ | Cl | CH |
| t-Bu | 6-Me | Cl | C₂F₅ | Cl | CH |
| Me | 6-Me | Cl | n-C₃F₇ | Cl | CH |
| Et | 6-Me | Cl | n-C₃F₇ | Cl | CH |
| i-Pr | 6-Me | Cl | n-C₃F₇ | Cl | CH |
| t-Bu | 6-Me | Cl | n-C₃F₇ | Cl | CH |
| Me | 6-Me | Cl | i-C₃F₇ | Cl | CH |
| Et | 6-Me | Cl | i-C₃F₇ | Cl | CH |
| i-Pr | 6-Me | Cl | i-C₃F₇ | Cl | CH |
| t-Bu | 6-Me | Cl | i-C₃F₇ | Cl | CH |
| Me | 6-Me | Cl | CN | Cl | CH |
| Et | 6-Me | Cl | CN | Cl | CH |
| i-Pr | 6-Me | Cl | CN | Cl | CH |
| t-Bu | 6-Me | Cl | CN | Cl | CH |
| Me | 6-Me | Cl | OCHF₂ | Br | CH |
| Et | 6-Me | Cl | OCHF₂ | Br | CH |
| i-Pr | 6-Me | Cl | OCHF₂ | Br | CH |
| t-Bu | 6-Me | Cl | OCHF₂ | Br | CH |
| Me | 6-Me | Cl | SCHF₂ | Br | CH |
| Et | 6-Me | Cl | SCHF₂ | Br | CH |
| i-Pr | 6-Me | Cl | SCHF₂ | Br | CH |
| t-Bu | 6-Me | Cl | SCHF₂ | Br | CH |
| Me | 6-Me | Cl | OCF₃ | Br | CH |
| Et | 6-Me | Cl | OCF₃ | Br | CH |
| i-Pr | 6-Me | Cl | OCF₃ | Br | CH |
| t-Bu | 6-Me | Cl | OCF₃ | Br | CH |
| Me | 6-Me | Cl | SCF₃ | Br | CH |
| Et | 6-Me | Cl | SCF₃ | Br | CH |
| i-Pr | 6-Me | Cl | SCF₃ | Br | CH |
| t-Bu | 6-Me | Cl | SCF₃ | Br | CH |
| Me | 6-Me | Cl | C₂F₅ | Br | CH |
| Et | 6-Me | Cl | C₂F₅ | Br | CH |
| i-Pr | 6-Me | Cl | C₂F₅ | Br | CH |
| t-Bu | 6-Me | Cl | C₂F₅ | Br | CH |
| Me | 6-Me | Cl | n-C₃F₇ | Br | CH |
| Et | 6-Me | Cl | n-C₃F₇ | Br | CH |
| i-Pr | 6-Me | Cl | n-C₃F₇ | Br | CH |
| t-Bu | 6-Me | Cl | n-C₃F₇ | Br | CH |
| Me | 6-Me | Cl | i-C₃F₇ | Br | CH |
| Et | 6-Me | Cl | i-C₃F₇ | Br | CH |
| i-Pr | 6-Me | Cl | i-C₃F₇ | Br | CH |
| t-Bu | 6-Me | Cl | i-C₃F₇ | Br | CH |
| Me | 6-Me | Cl | CN | Br | CH |
| Et | 6-Me | Cl | CN | Br | CH |
| i-Pr | 6-Me | Cl | CN | Br | CH |
| t-Bu | 6-Me | Cl | CN | Br | CH |
| Me | 6-Me | Cl | OCHF₂ | CF₃ | CH |
| Et | 6-Me | Cl | OCHF₂ | CF₃ | CH |
| i-Pr | 6-Me | Cl | OCHF₂ | CF₃ | CH |
| t-Bu | 6-Me | Cl | OCHF₂ | CF₃ | CH |
| Me | 6-Me | Cl | SCHF₂ | CF₃ | CH |
| Et | 6-Me | Cl | SCHF₂ | CF₃ | CH |
| i-Pr | 6-Me | Cl | SCHF₂ | CF₃ | CH |
| t-Bu | 6-Me | Cl | SCHF₂ | CF₃ | CH |
| Me | 6-Me | Cl | OCF₃ | CF₃ | CH |
| Et | 6-Me | Cl | OCF₃ | CF₃ | CH |
| i-Pr | 6-Me | Cl | OCF₃ | CF₃ | CH |
| t-Bu | 6-Me | Cl | OCF₃ | CF₃ | CH |
| Me | 6-Me | Cl | SCF₃ | CF₃ | CH |
| Et | 6-Me | Cl | SCF₃ | CF₃ | CH |
| i-Pr | 6-Me | Cl | SCF₃ | CF₃ | CH |
| t-Bu | 6-Me | Cl | SCF₃ | CF₃ | CH |
| Me | 6-Me | Cl | C₂F₅ | CF₃ | CH |
| Et | 6-Me | Cl | C₂F₅ | CF₃ | CH |
| i-Pr | 6-Me | Cl | C₂F₅ | CF₃ | CH |
| t-Bu | 6-Me | Cl | C₂F₅ | CF₃ | CH |
| Me | 6-Me | Cl | n-C₃F₇ | CF₃ | CH |
| Et | 6-Me | Cl | n-C₃F₇ | CF₃ | CH |
| i-Pr | 6-Me | Cl | n-C₃F₇ | CF₃ | CH |
| t-Bu | 6-Me | Cl | n-C₃F₇ | CF₃ | CH |
| Me | 6-Me | Cl | i-C₃F₇ | CF₃ | CH |
| Et | 6-Me | Cl | i-C₃F₇ | CF₃ | CH |
| i-Pr | 6-Me | Cl | i-C₃F₇ | CF₃ | CH |
| t-Bu | 6-Me | Cl | i-C₃F₇ | CF₃ | CH |
| Me | 6-Me | Cl | CN | CF₃ | CH |
| Et | 6-Me | Cl | CN | CF₃ | CH |
| i-Pr | 6-Me | Cl | CN | CF₃ | CH |
| t-Bu | 6-Me | Cl | CN | CF₃ | CH |
| Me | 6-Me | H | OCHF₂ | F | CF |
| Et | 6-Me | H | OCHF₂ | F | CF |
| i-Pr | 6-Me | H | OCHF₂ | F | CF |
| t-Bu | 6-Me | H | OCHF₂ | F | CF |
| Me | 6-Me | H | SCHF₂ | F | CF |
| Et | 6-Me | H | SCHF₂ | F | CF |
| i-Pr | 6-Me | H | SCHF₂ | F | CF |
| t-Bu | 6-Me | H | SCHF₂ | F | CF |
| Me | 6-Me | H | OCF₃ | F | CF |
| Et | 6-Me | H | OCF₃ | F | CF |
| i-Pr | 6-Me | H | OCF₃ | F | CF |
| t-Bu | 6-Me | H | OCF₃ | F | CF |
| Me | 6-Me | H | SCF₃ | F | CF |
| Et | 6-Me | H | SCF₃ | F | CF |
| i-Pr | 6-Me | H | SCF₃ | F | CF |
| t-Bu | 6-Me | H | SCF₃ | F | CF |
| Me | 6-Me | H | C₂F₅ | F | CF |
| Et | 6-Me | H | C₂F₅ | F | CF |
| i-Pr | 6-Me | H | C₂F₅ | F | CF |
| t-Bu | 6-Me | H | C₂F₅ | F | CF |
| Me | 6-Me | H | n-C₃F₇ | F | CF |
| Et | 6-Me | H | n-C₃F₇ | F | CF |
| i-Pr | 6-Me | H | n-C₃F₇ | F | CF |
| t-Bu | 6-Me | H | n-C₃F₇ | F | CF |
| Me | 6-Me | H | i-C₃F₇ | F | CF |
| Et | 6-Me | H | i-C₃F₇ | F | CF |
| i-Pr | 6-Me | H | i-C₃F₇ | F | CF |
| t-Bu | 6-Me | H | i-C₃F₇ | F | CF |
| Me | 6-Me | H | CN | F | CF |
| Et | 6-Me | H | CN | F | CF |
| i-Pr | 6-Me | H | CN | F | CF |
| t-Bu | 6-Me | H | CN | F | CF |
| Me | 6-Me | H | OCHF₂ | Cl | CCl |
| Et | 6-Me | H | OCHF₂ | Cl | CCl |
| i-Pr | 6-Me | H | OCHF₂ | Cl | CCl |
| t-Bu | 6-Me | H | OCHF₂ | Cl | CCl |
| Me | 6-Me | H | SCHF₂ | Cl | CCl |
| Et | 6-Me | H | SCHF₂ | Cl | CCl |
| i-Pr | 6-Me | H | SCHF₂ | Cl | CCH |
| t-Bu | 6-Me | H | SCHF₂ | Cl | CCl |
| Me | 6-Me | H | OCF₃ | Cl | CCl |
| Et | 6-Me | H | OCF₃ | Cl | CCl |
| i-Pr | 6-Me | H | OCF₃ | Cl | CCl |
| t-Bu | 6-Me | H | OCF₃ | Cl | CCl |
| Me | 6-Me | H | SCF₃ | Cl | CCl |
| Et | 6-Me | H | SCF₃ | Cl | CCl |
| i-Pr | 6-Me | H | SCF₃ | Cl | CCl |
| t-Bu | 6-Me | H | SCF₃ | Cl | CCl |
| Me | 6-Me | H | C₂F₅ | Cl | CCl |
| Et | 6-Me | H | C₂F₅ | Cl | CCl |
| i-Pr | 6-Me | H | C₂F₅ | Cl | CCl |
| t-Bu | 6-Me | H | C₂F₅ | Cl | CCl |
| Me | 6-Me | H | n-C₃F₇ | Cl | CCl |
| Et | 6-Me | H | n-C₃F₇ | Cl | CCl |
| i-Pr | 6-Me | H | n-C₃F₇ | Cl | CCl |
| t-Bu | 6-Me | H | n-C₃F₇ | Cl | CCl |
| Me | 6-Me | H | i-C₃F₇ | Cl | CCl |
| Et | 6-Me | H | i-C₃F₇ | Cl | CCl |
| i-Pr | 6-Me | H | i-C₃F₇ | Cl | CCl |
| t-Bu | 6-Me | H | i-C₃F₇ | Cl | CCl |
| Me | 6-Me | H | CN | Cl | CCl |
| Et | 6-Me | H | CN | Cl | CCl |
| i-Pr | 6-Me | H | CN | Cl | CCl |
| t-Bu | 6-Me | H | CN | Cl | CCl |
| Me | 6-Cl | H | OCHF₂ | F | CH |
| Et | 6-Cl | H | OCHF₂ | F | CH |
| i-Pr | 6-Cl | H | OCHF₂ | F | CH |
| t-Bu | 6-Cl | H | OCHF₂ | F | CH |
| Me | 6-Cl | H | SCHF₂ | F | CH |
| Et | 6-Cl | H | SCHF₂ | F | CH |
| i-Pr | 6-Cl | H | SCHF₂ | F | CH |
| t-Bu | 6-Cl | H | SCHF₂ | F | CH |
| Me | 6-Cl | H | OCF₃ | F | CH |
| Et | 6-Cl | H | OCF₃ | F | CH |
| i-Pr | 6-Cl | H | OCF₃ | F | CH |
| t-Bu | 6-Cl | H | OCF₃ | F | CH |
| Me | 6-Cl | H | SCF₃ | F | CH |
| Et | 6-Cl | H | SCF₃ | F | CH |
| i-Pr | 6-Cl | H | SCF₃ | F | CH |
| t-Bu | 6-Cl | H | SCF₃ | F | CH |
| Me | 6-Cl | H | C₂F₅ | F | CH |
| Et | 6-Cl | H | C₂F₅ | F | CH |
| i-Pr | 6-Cl | H | C₂F₅ | F | CH |
| t-Bu | 6-Cl | H | C₂F₅ | F | CH |
| Me | 6-Cl | H | n-C₃F₇ | F | CH |
| Et | 6-Cl | H | n-C₃F₇ | F | CH |
| i-Pr | 6-Cl | H | n-C₃F₇ | F | CH |
| t-Bu | 6-Cl | H | n-C₃F₇ | F | CH |
| Me | 6-Cl | H | i-C₃F₇ | F | CH |
| Et | 6-Cl | H | i-C₃F₇ | F | CH |
| i-Pr | 6-Cl | H | i-C₃F₇ | F | CH |
| t-Bu | 6-Cl | H | i-C₃F₇ | F | CH |
| Me | 6-Cl | H | CN | F | CH |
| Et | 6-Cl | H | CN | F | CH |
| i-Pr | 6-Cl | H | CN | F | CH |
| t-Bu | 6-Cl | H | CN | F | CH |
| Me | 6-Cl | H | OCHF₂ | Cl | CH |
| Et | 6-Cl | H | OCHF₂ | Cl | CH |
| i-Pr | 6-Cl | H | OCHF₂ | Cl | CH |
| t-Bu | 6-Cl | H | OCHF₂ | Cl | CH |
| Me | 6-Cl | H | SCHF₂ | Cl | CH |
| Et | 6-Cl | H | SCHF₂ | Cl | CH |
| i-Pr | 6-Cl | H | SCHF₂ | Cl | CH |
| t-Bu | 6-Cl | H | SCHF₂ | Cl | CH |
| Me | 6-Cl | H | OCF₃ | Cl | CH |
| Et | 6-Cl | H | OCF₃ | Cl | CH |
| i-Pr | 6-Cl | H | OCF₃ | Cl | CH |
| t-Bu | 6-Cl | H | OCF₃ | Cl | CH |
| Me | 6-Cl | H | SCF₃ | Cl | CH |
| Et | 6-Cl | H | SCF₃ | Cl | CH |
| i-Pr | 6-Cl | H | SCF₃ | Cl | CH |
| t-Bu | 6-Cl | H | SCF₃ | Cl | CH |
| Me | 6-Cl | H | C₂F₅ | Cl | CH |
| Et | 6-Cl | H | C₂F₅ | Cl | CH |
| i-Pr | 6-Cl | H | C₂F₅ | Cl | CH |
| t-Bu | 6-Cl | H | C₂F₅ | Cl | CH |
| Me | 6-Cl | H | n-C₃F₇ | Cl | CH |
| Et | 6-Cl | H | n-C₃F₇ | Cl | CH |
| i-Pr | 6-Cl | H | n-C₃F₇ | Cl | CH |
| t-Bu | 6-Cl | H | n-C₃F₇ | Cl | CH |
| Me | 6-Cl | H | i-C₃F₇ | Cl | CH |
| Et | 6-Cl | H | i-C₃F₇ | Cl | CH |
| i-Pr | 6-Cl | H | i-C₃F₇ | Cl | CH |
| t-Bu | 6-Cl | H | i-C₃F₇ | Cl | CH |
| Me | 6-Cl | H | CN | Cl | CH |
| Et | 6-Cl | H | CN | Cl | CH |
| i-Pr | 6-Cl | H | CN | Cl | CH |
| t-Bu | 6-Cl | H | CN | Cl | CH |
| Me | 6-Cl | H | OCHF₂ | Br | CH |
| Et | 6-Cl | H | OCHF₂ | Br | CH |
| i-Pr | 6-Cl | H | OCHF₂ | Br | CH |
| t-Bu | 6-Cl | H | OCHF₂ | Br | CH |
| Me | 6-Cl | H | SCHF₂ | Br | CH |
| Et | 6-Cl | H | SCHF₂ | Br | CH |
| i-Pr | 6-Cl | H | SCHF₂ | Br | CH |
| t-Bu | 6-Cl | H | SCHF₂ | Br | CH |
| Me | 6-Cl | H | OCF₃ | Br | CH |
| Et | 6-Cl | H | OCF₃ | Br | CH |
| i-Pr | 6-Cl | H | OCF₃ | Br | CH |
| t-Bu | 6-Cl | H | OCF₃ | Br | CH |
| Me | 6-Cl | H | SCF₃ | Br | CH |
| Et | 6-Cl | H | SCF₃ | Br | CH |
| i-Pr | 6-Cl | H | SCF₃ | Br | CH |
| t-Bu | 6-Cl | H | SCF₃ | Br | CH |
| Me | 6-Cl | H | C₂F₅ | Br | CH |
| Et | 6-Cl | H | C₂F₅ | Br | CH |
| i-Pr | 6-Cl | H | C₂F₅ | Br | CH |
| t-Bu | 6-Cl | H | C₂F₅ | Br | CH |
| Me | 6-Cl | H | n-C₃F₇ | Br | CH |
| Et | 6-Cl | H | n-C₃F₇ | Br | CH |
| i-Pr | 6-Cl | H | n-C₃F₇ | Br | CH |
| t-Bu | 6-Cl | H | n-C₃F₇ | Br | CH |
| Me | 6-Cl | H | i-C₃F₇ | Br | CH |
| Et | 6-Cl | H | i-C₃F₇ | Br | CH |
| i-Pr | 6-Cl | H | i-C₃F₇ | Br | CH |
| t-Bu | 6-Cl | H | i-C₃F₇ | Br | CH |
| Me | 6-Cl | H | CN | Br | CH |
| Et | 6-Cl | H | CN | Br | CH |
| i-Pr | 6-Cl | H | CN | Br | CH |
| t-Bu | 6-Cl | H | CN | Br | CH |
| Me | 6-Cl | H | OCHF₂ | CF₃ | CH |
| Et | 6-Cl | H | OCHF₂ | CF₃ | CH |
| i-Pr | 6-Cl | H | OCHF₂ | CF₃ | CH |
| t-Bu | 6-Cl | H | OCHF₂ | CF₃ | CH |
| Me | 6-Cl | H | SCHF₂ | CF₃ | CH |
| Et | 6-Cl | H | SCHF₂ | CF₃ | CH |
| i-Pr | 6-Cl | H | SCHF₂ | CF₃ | CH |
| t-Bu | 6-Cl | H | SCHF₂ | CF₃ | CH |
| Me | 6-Cl | H | OCF₃ | CF₃ | CH |
| Et | 6-Cl | H | OCF₃ | CF₃ | CH |
| i-Pr | 6-Cl | H | OCF₃ | CF₃ | CH |
| t-Bu | 6-Cl | H | OCF₃ | CF₃ | CH |
| Me | 6-Cl | H | SCF₃ | CF₃ | CH |
| Et | 6-Cl | H | SCF₃ | CF₃ | CH |
| i-Pr | 6-Cl | H | SCF₃ | CF₃ | CH |
| t-Bu | 6-Cl | H | SCF₃ | CF₃ | CH |
| Me | 6-Cl | H | C₂F₅ | CF₃ | CH |
| Et | 6-Cl | H | C₂F₅ | CF₃ | CH |
| i-Pr | 6-Cl | H | C₂F₅ | CF₃ | CH |
| t-Bu | 6-Cl | H | C₂F₅ | CF₃ | CH |
| Me | 6-Cl | H | n-C₃F₇ | CF₃ | CH |
| Et | 6-Cl | H | n-C₃F₇ | CF₃ | CH |
| i-Pr | 6-Cl | H | n-C₃F₇ | CF₃ | CH |
| t-Bu | 6-Cl | H | n-C₃F₇ | CF₃ | CH |
| Me | 6-Cl | H | i-C₃F₇ | CF₃ | CH |
| Et | 6-Cl | H | i-C₃F₇ | CF₃ | CH |
| i-Pr | 6-Cl | H | i-C₃F₇ | CF₃ | CH |
| t-Bu | 6-Cl | H | i-C₃F₇ | CF₃ | CH |
| Me | 6-Cl | H | CH | CF₃ | CH |
| Et | 6-Cl | H | CH | CF₃ | CH |
| i-Pr | 6-Cl | H | CH | CF₃ | CH |
| t-Bu | 6-Cl | H | CH | CF₃ | CH |
| Me | 6-Cl | Cl | OCHF₂ | F | CH |
| Et | 6-Cl | Cl | OCHF₂ | F | CH |
| i-Pr | 6-Cl | Cl | OCHF₂ | F | CH |
| t-Bu | 6-Cl | Cl | OCHF₂ | F | CH |
| Me | 6-Cl | Cl | SCHF₂ | F | CH |
| Et | 6-Cl | Cl | SCHF₂ | F | CH |
| i-Pr | 6-Cl | Cl | SCHF₂ | F | CH |
| t-Bu 6-Cl | Cl | SCHF₂ | F | CH | |
| Me | 6-Cl | Cl | OCF₃ | F | CH |
| Et | 6-Cl | Cl | OCF₃ | F | CH |
| i-Pr | 6-Cl | Cl | OCF₃ | F | CH |
| t-Bu | 6-Cl | Cl | OCF₃ | F | CH |
| Me | 6-Cl | Cl | SCF₃ | F | CH |
| Et | 6-Cl | Cl | SCF₃ | F | CH |
| i-Pr | 6-Cl | Cl | SCF₃ | F | CH |
| t-Bu | 6-Cl | Cl | SCF₃ | F | CH |
| Me | 6-Cl | Cl | C₂F₅ | F | CH |
| Et | 6-Cl | Cl | C₂F₅ | F | CH |
| i-Pr | 6-Cl | Cl | C₂F₅ | F | CH |
| t-Bu | 6-Cl | Cl | C₂F₅ | F | CH |
| Me | 6-Cl | Cl | n-C₃F₇ | F | CH |
| Et | 6-Cl | Cl | n-C₃F₇ | F | CH |
| i-Pr | 6-Cl | Cl | n-C₃F₇ | F | CH |
| t-Bu | 6-Cl | Cl | n-C₃F₇ | F | CH |
| Me | 6-Cl | Cl | i-C₃F₇ | F | CH |
| Et | 6-Cl | Cl | i-C₃F₇ | F | CH |
| i-Pr | 6-Cl | Cl | i-C₃F₇ | F | CH |
| t-Bu | 6-Cl | Cl | i-C₃F₇ | F | CH |
| Me | 6-Cl | Cl | CN | F | CH |
| Et | 6-Cl | Cl | CN | F | CH |
| i-Pr | 6-Cl | Cl | CN | F | CH |
| t-Bu | 6-Cl | Cl | CN | F | CH |
| Me | 6-Cl | Cl | OCHF₂ | Cl | CH |
| Et | 6-Cl | Cl | OCHF₂ | Cl | CH |
| i-Pr | 6-Cl | Cl | OCHF₂ | Cl | CH |
| t-Bu | 6-Cl | Cl | OCHF₂ | Cl | CH |
| Me | 6-Cl | Cl | SCHF₂ | Cl | CH |
| Et | 6-Cl | Cl | SCHF₂ | Cl | CH |
| i-Pr | 6-Cl | Cl | SCHF₂ | Cl | CH |
| t-Bu | 6-Cl | Cl | SCHF₂ | Cl | CH |
| Me | 6-Cl | Cl | OCF₃ | Cl | CH |
| Et | 6-Cl | Cl | OCF₃ | Cl | CH |
| i-Pr | 6-Cl | Cl | OCF₃ | Cl | CH |
| t-Bu | 6-Cl | Cl | OCF₃ | Cl | CH |
| Me | 6-Cl | Cl | SCF₃ | Cl | CH |
| Et | 6-Cl | Cl | SCF₃ | Cl | CH |
| i-Pr | 6-Cl | Cl | SCF₃ | Cl | CH |
| t-Bu | 6-Cl | Cl | SCF₃ | Cl | CH |
| Me | 6-Cl | Cl | C₂F₅ | Cl | CH |
| Et | 6-Cl | Cl | C₂F₅ | Cl | CH |
| i-Pr | 6-Cl | Cl | C₂F₅ | Cl | CH |
| t-Bu | 6-Cl | Cl | C₂F₅ | Cl | CH |
| Me | 6-Cl | Cl | n-C₃F₇ | Cl | CH |
| Et | 6-Cl | Cl | n-C₃F₇ | Cl | CH |
| i-Pr | 6-Cl | Cl | n-C₃F₇ | Cl | CH |
| t-Bu | 6-Cl | Cl | n-C₃F₇ | Cl | CH |
| Me | 6-Cl | Cl | i-C₃F₇ | Cl | CH |
| Et | 6-Cl | Cl | i-C₃F₇ | Cl | CH |
| i-Pr | 6-Cl | Cl | i-C₃F₇ | Cl | CH |
| t-Bu | 6-Cl | Cl | i-C₃F₇ | Cl | CH |
| Me | 6-Cl | Cl | CN | Cl | CH |
| Et | 6-Cl | Cl | CN | Cl | CH |
| i-Pr | 6-Cl | Cl | CN | Cl | CH |
| t-Bu | 6-Cl | Cl | CN | Cl | CH |
| Me | 6-Cl | Cl | OCHF₂ | Br | CH |
| Et | 6-Cl | Cl | OCHF₂ | Br | CH |
| i-Pr | 6-Cl | Cl | OCHF₂ | Br | CH |
| t-Bu | 6-Cl | Cl | OCHF₂ | Br | CH |
| Me | 6-Cl | Cl | SCHF₂ | Br | CH |
| Et | 6-Cl | Cl | SCHF₂ | Br | CH |
| i-Pr | 6-Cl | Cl | SCHF₂ | Br | CH |
| t-Bu | 6-Cl | Cl | SCHF₂ | Br | CH |
| Me | 6-Cl | Cl | OCF₃ | Br | CH |
| Et | 6-Cl | Cl | OCF₃ | Br | CH |
| i-Pr | 6-Cl | Cl | OCF₃ | Br | CH |
| t-Bu | 6-Cl | Cl | OCF₃ | Br | CH |
| Me | 6-Cl | Cl | SCF₃ | Br | CH |
| Et | 6-Cl | Cl | SCF₃ | Br | CH |
| i-Pr | 6-Cl | Cl | SCF₃ | Br | CH |
| t-Bu | 6-Cl | Cl | SCF₃ | Br | CH |
| Me | 6-Cl | Cl | C₂F₅ | Br | CH |
| Et | 6-Cl | Cl | C₂F₅ | Br | CH |
| i-Pr | 6-Cl | Cl | C₂F₅ | Br | CH |
| t-Bu | 6-Cl | Cl | C₂F₅ | Br | CH |
| Me | 6-Cl | Cl | n-C₃F₇ | Br | CH |
| Et | 6-Cl | Cl | n-C₃F₇ | Br | CH |
| i-Pr | 6-Cl | Cl | n-C₃F₇ | Br | CH |
| t-Bu | 6-Cl | Cl | n-C₃F₇ | Br | CH |
| Me | 6-Cl | Cl | i-C₃F₇ | Br | CH |
| Et | 6-Cl | Cl | i-C₃F₇ | Br | CH |
| i-Pr | 6-Cl | Cl | i-C₃F₇ | Br | CH |
| t-Bu | 6-Cl | Cl | i-C₃F₇ | Br | CH |
| Me | 6-Cl | Cl | CN | Br | CH |
| Et | 6-Cl | Cl | CN | Br | CH |
| i-Pr | 6-Cl | Cl | CN | Br | CH |
| t-Bu | 6-Cl | Cl | CN | Br | CH |
| Me | 6-Cl | Cl | OCHF₂ | CF₃ | CH |
| Et | 6-Cl | Cl | OCHF₂ | CF₃ | CH |
| i-Pr | 6-Cl | Cl | OCHF₂ | CF₃ | CH |
| t-Bu | 6-Cl | Cl | OCHF₂ | CF₃ | CH |
| Me | 6-Cl | Cl | SCHF₂ | CF₃ | CH |
| Et | 6-Cl | Cl | SCHF₂ | CF₃ | CH |
| i-Pr | 6-Cl | Cl | SCHF₂ | CF₃ | CH |
| t-Bu | 6-Cl | Cl | SCHF₂ | CF₃ | CH |
| Me | 6-Cl | Cl | OCF₃ | CF₃ | CH |
| Et | 6-Cl | Cl | OCF₃ | CF₃ | CH |
| i-Pr | 6-Cl | Cl | OCF₃ | CF₃ | CH |
| t-Bu | 6-Cl | Cl | OCF₃ | CF₃ | CH |
| Me | 6-Cl | Cl | SCF₃ | CF₃ | CH |
| Et | 6-Cl | Cl | SCF₃ | CF₃ | CH |
| i-Pr | 6-Cl | Cl | SCF₃ | CF₃ | CH |
| t-Bu | 6-Cl | Cl | SCF₃ | CF₃ | CH |
| Me | 6-Cl | Cl | C₂F₅ | CF₃ | CH |
| Et | 6-Cl | Cl | C₂F₅ | CF₃ | CH |
| i-Pr | 6-Cl | Cl | C₂F₅ | CF₃ | CH |
| t-Bu | 6-Cl | Cl | C₂F₅ | CF₃ | CH |
| Me | 6-Cl | Cl | n-C₃F₇ | CF₃ | CH |
| Et | 6-Cl | Cl | n-C₃F₇ | CF₃ | CH |
| i-Pr | 6-Cl | Cl | n-C₃F₇ | CF₃ | CH |
| t-Bu | 6-Cl | Cl | n-C₃F₇ | CF₃ | CH |
| Me | 6-Cl | Cl | i-C₃F₇ | CF₃ | CH |
| Et | 6-Cl | Cl | i-C₃F₇ | CF₃ | CH |
| i-Pr | 6-Cl | Cl | i-C₃F₇ | CF₃ | CH |
| t-Bu | 6-Cl | Cl | i-C₃F₇ | CF₃ | CH |
| Me | 6-Cl | Cl | CN | CF₃ | CH |
| Et | 6-Cl | Cl | CN | CF₃ | CH |
| i-Pr | 6-Cl | Cl | CN | CF₃ | CH |
| t-Bu | 6-Cl | Cl | CN | CF₃ | CH |
| Me | 6-Cl | H | OCHF₂ | F | CF |
| Et | 6-Cl | H | OCHF₂ | F | CF |
| i-Pr | 6-Cl | H | OCHF₂ | F | CF |
| t-Bu | 6-Cl | H | OCHF₂ | F | CF |
| Me | 6-Cl | H | SCHF₂ | F | CF |
| Et | 6-Cl | H | SCHF₂ | F | CF |
| i-Pr | 6-Cl | H | SCHF₂ | F | CF |
| t-Bu | 6-Cl | H | SCHF₂ | F | CF |
| Me | 6-Cl | H | OCF₃ | F | CF |
| Et | 6-Cl | H | OCF₃ | F | CF |
| i-Pr | 6-Cl | H | OCF₃ | F | CF |
| t-Bu | 6-Cl | H | OCF₃ | F | CF |
| Me | 6-Cl | H | SCF₃ | F | CF |
| Et | 6-Cl | H | SCF₃ | F | CF |
| i-Pr | 6-Cl | H | SCF₃ | F | CF |
| t-Bu | 6-Cl | H | SCF₃ | F | CF |
| Me | 6-Cl | H | C₂F₅ | F | CF |
| Et | 6-Cl | H | C₂F₅ | F | CF |
| i-Pr | 6-Cl | H | C₂F₅ | F | CF |
| t-Bu | 6-Cl | H | C₂F₅ | F | CF |
| Me | 6-Cl | H | n-C₃F₇ | F | CF |
| Et | 6-Cl | H | n-C₃F₇ | F | CF |
| i-Pr | 6-Cl | H | n-C₃F₇ | F | CF |
| t-Bu | 6-Cl | H | n-C₃F₇ | F | CF |
| Me | 6-Cl | H | i-C₃F₇ | F | CF |
| Et | 6-Cl | H | i-C₃F₇ | F | CF |
| i-Pr | 6-Cl | H | i-C₃F₇ | F | CF |
| t-Bu | 6-Cl | H | i-C₃F₇ | F | CF |
| Me | 6-Cl | H | CN | F | CF |
| Et | 6-Cl | H | CN | F | CF |
| i-Pr | 6-Cl | H | CN | F | CF |
| t-Bu | 6-Cl | H | CN | F | CF |
| Me | 6-Cl | H | OCHF₂ | Cl | CCl |
| Et | 6-Cl | H | OCHF₂ | Cl | CCl |
| i-Pr | 6-Cl | H | OCHF₂ | Cl | CCl |
| t-Bu | 6-Cl | H | OCHF₂ | Cl | CCl |
| Me | 6-Cl | H | SCHF₂ | Cl | CCl |
| Et | 6-Cl | H | SCHF₂ | Cl | CCl |
| i-Pr | 6-Cl | H | SCHF₂ | Cl | CCl |
| t-Bu | 6-Cl | H | SCHF₂ | Cl | CCl |
| Me | 6-Cl | H | OCF₃ | Cl | CCl |
| Et | 6-Cl | H | OCF₃ | Cl | CCl |
| i-Pr | 6-Cl | H | OCF₃ | Cl | CCl |
| t-Bu | 6-Cl | H | OCF₃ | Cl | CCl |
| Me | 6-Cl | H | SCF₃ | Cl | CCl |
| Et | 6-Cl | H | SCF₃ | Cl | CCl |
| i-Pr | 6-Cl | H | SCF₃ | Cl | CCl |
| t-Bu | 6-Cl | H | SCF₃ | Cl | CCl |
| Me | 6-Cl | H | C₂F₅ | Cl | CCl |
| Et | 6-Cl | H | C₂F₅ | Cl | CCl |
| i-Pr | 6-Cl | H | C₂F₅ | Cl | CCl |
| t-Bu | 6-Cl | H | C₂F₅ | Cl | CCl |
| Me | 6-Cl | H | n-C₃F₇ | Cl | CCl |
| Et | 6-Cl | H | n-C₃F₇ | Cl | CCl |
| i-Pr | 6-Cl | H | n-C₃F₇ | Cl | CCl |
| t-Bu | 6-Cl | H | n-C₃F₇ | Cl | CCl |
| Me | 6-Cl | H | i-C₃F₇ | Cl | CCl |
| Et | 6-Cl | H | i-C₃F₇ | Cl | CCl |
| i-Pr | 6-Cl | H | i-C₃F₇ | Cl | CCl |
| t-Bu | 6-Cl | H | i-C₃F₇ | Cl | CCl |
| Me | 6-Cl | H | CN | Cl | CCl |
| Et | 6-Cl | H | CN | Cl | CCl |
| i-Pr | 6-Cl | H | CN | Cl | CCl |
| t-Bu | 6-Cl | H | CN | Cl | CCl |

TABLE 10

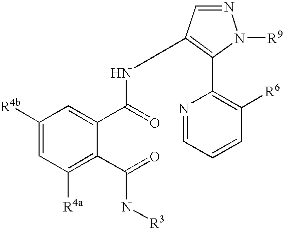

| R^{4a} | R^{4b} | R⁹ | R³ | R⁶ |
|---|---|---|---|---|
| CH₃ | F | CF₃ | Me | Cl |
| CH₃ | F | CF₃ | Et | Cl |
| CH₃ | F | CF₃ | i-Pr | Cl |
| CH₃ | F | CF₃ | t-Bu | Cl |
| CH₃ | F | CF₃ | Me | Br |
| CH₃ | F | CF₃ | Et | Br |
| CH₃ | F | CF₃ | i-Pr | Br |
| CH₃ | F | CF₃ | t-Bu | Br |
| CH₃ | F | CH₂CF₃ | Me | Cl |
| CH₃ | F | CH₂CF₃ | Et | Cl |
| CH₃ | F | CH₂CF₃ | i-Pr | Cl |
| CH₃ | F | CH₂CF₃ | t-Bu | Cl |
| CH₃ | F | CH₂CF₃ | Me | Br |
| CH₃ | F | CH₂CF₃ | Et | Br |
| CH₃ | F | CH₂CF₃ | i-Pr | Br |
| CH₃ | F | CH₂CF₃ | t-Bu | Br |
| CH₃ | F | CF₂CHF₂ | Me | Cl |
| CH₃ | F | CF₂CHF₂ | Et | Cl |
| CH₃ | F | CF₂CHF₂ | i-Pr | Cl |
| CH₃ | F | CF₂CHF₂ | t-Bu | Cl |
| CH₃ | F | CF₂CHF₂ | Me | Br |
| CH₃ | F | CF₂CHF₂ | Et | Br |
| CH₃ | F | CF₂CHF₂ | i-Pr | Br |
| CH₃ | F | CF₂CHF₂ | t-Bu | Br |
| CH₃ | Cl | CF₃ | Me | Cl |
| CH₃ | Cl | CF₃ | Et | Cl |
| CH₃ | Cl | CF₃ | i-Pr | Cl |
| CH₃ | Cl | CF₃ | t-Bu | Cl |
| CH₃ | Cl | CF₃ | Me | Br |
| CH₃ | Cl | CF₃ | Et | Br |
| CH₃ | Cl | CF₃ | i-Pr | Br |
| CH₃ | Cl | CF₃ | t-Bu | Br |
| CH₃ | Cl | CH₂CF₃ | Me | Cl |
| CH₃ | Cl | CH₂CF₃ | Et | Cl |
| CH₃ | Cl | CH₂CF₃ | i-Pr | Cl |
| CH₃ | Cl | CH₂CF₃ | t-Bu | Cl |
| CH₃ | Cl | CH₂CF₃ | Me | Br |
| CH₃ | Cl | CH₂CF₃ | Et | Br |
| CH₃ | Cl | CH₂CF₃ | i-Pr | Br |
| CH₃ | Cl | CH₂CF₃ | t-Bu | Br |
| CH₃ | Cl | CF₂CHF₂ | Me | Cl |
| CH₃ | Cl | CF₂CHF₂ | Et | Cl |
| CH₃ | Cl | CF₂CHF₂ | i-Pr | Cl |
| CH₃ | Cl | CF₂CHF₂ | t-Bu | Cl |
| CH₃ | Cl | CF₂CHF₂ | Me | Br |
| CH₃ | Cl | CF₂CHF₂ | Et | Br |
| CH₃ | Cl | CF₂CHF₂ | i-Pr | Br |
| CH₃ | Cl | CF₂CHF₂ | t-Bu | Br |
| CH₃ | Br | CF₃ | Me | Cl |
| CH₃ | Br | CF₃ | Et | Cl |
| CH₃ | Br | CF₃ | i-Pr | Cl |
| CH₃ | Br | CF₃ | t-Bu | Cl |
| CH₃ | Br | CF₃ | Me | Br |
| CH₃ | Br | CF₃ | Et | Br |
| CH₃ | Br | CF₃ | i-Pr | Br |
| CH₃ | Br | CF₃ | t-Bu | Br |
| CH₃ | Br | CH₂CF₃ | Me | Cl |
| CH₃ | Br | CH₂CF₃ | Et | Cl |
| CH₃ | Br | CH₂CF₃ | i-Pr | Cl |
| CH₃ | Br | CH₂CF₃ | t-Bu | Cl |
| CH₃ | Br | CH₂CF₃ | Me | Br |
| CH₃ | Br | CH₂CF₃ | Et | Br |
| CH₃ | Br | CH₂CF₃ | i-Pr | Br |
| CH₃ | Br | CH₂CF₃ | t-Bu | Br |
| CH₃ | Br | CF₂CHF₂ | Me | Cl |
| CH₃ | Br | CF₂CHF₂ | Et | Cl |
| CH₃ | Br | CF₂CHF₂ | i-Pr | Cl |
| CH₃ | Br | CF₂CHF₂ | t-Bu | Cl |
| CH₃ | Br | CF₂CHF₂ | Me | Br |
| CH₃ | Br | CF₂CHF₂ | Et | Br |
| CH₃ | Br | CF₂CHF₂ | i-Pr | Br |
| CH₃ | Br | CF₂CHF₂ | t-Bu | Br |
| CH₃ | I | CF₃ | Me | Cl |
| CH₃ | I | CF₃ | Et | Cl |
| CH₃ | I | CF₃ | i-Pr | Cl |
| CH₃ | I | CF₃ | t-Bu | Cl |
| CH₃ | I | CF₃ | Me | Br |
| CH₃ | I | CF₃ | Et | Br |
| CH₃ | I | CF₃ | i-Pr | Br |
| CH₃ | I | CF₃ | t-Bu | Br |
| CH₃ | I | CH₂CF₃ | Me | Cl |
| CH₃ | I | CH₂CF₃ | Et | Cl |
| CH₃ | I | CH₂CF₃ | i-Pr | Cl |
| CH₃ | I | CH₂CF₃ | t-Bu | Cl |
| CH₃ | I | CH₂CF₃ | Me | Br |
| CH₃ | I | CH₂CF₃ | Et | Br |
| CH₃ | I | CH₂CF₃ | i-Pr | Br |
| CH₃ | I | CH₂CF₃ | t-Bu | Br |
| CH₃ | I | CF₂CHF₂ | Me | Cl |
| CH₃ | I | CF₂CHF₂ | Et | Cl |
| CH₃ | I | CF₂CHF₂ | i-Pr | Cl |
| CH₃ | I | CF₂CHF₂ | t-Bu | Cl |
| CH₃ | I | CF₂CHF₂ | Me | Br |
| CH₃ | I | CF₂CHF₂ | Et | Br |
| CH₃ | I | CF₂CHF₂ | i-Pr | Br |
| CH₃ | I | CF₂CHF₂ | t-Bu | Br |
| CH₃ | CF₃ | CF₃ | Me | Cl |
| CH₃ | CF₃ | CF₃ | Et | Cl |
| CH₃ | CF₃ | CF₃ | i-Pr | Cl |
| CH₃ | CF₃ | CF₃ | t-Bu | Cl |
| CH₃ | CF₃ | CF₃ | Me | Br |
| CH₃ | CF₃ | CF₃ | Et | Br |
| CH₃ | CF₃ | CF₃ | i-Pr | Br |
| CH₃ | CF₃ | CF₃ | t-Bu | Br |
| CH₃ | CF₃ | CH₂CF₃ | Me | Cl |
| CH₃ | CF₃ | CH₂CF₃ | Et | Cl |
| CH₂ | CF₃ | CH₂CF₃ | i-Pr | Cl |
| CH₃ | CF₃ | CH₂CF₃ | t-Bu | Cl |
| CH₃ | CF₃ | CH₂CF₃ | Me | Br |
| CH₃ | CF₃ | CH₂CF₃ | Et | Br |
| CH₃ | CF₃ | CH₂CF₃ | i-Pr | Br |
| CH₃ | CF₃ | CH₂CF₃ | t-Bu | Br |
| CH₃ | CF₃ | CF₂CHF₂ | Me | Cl |
| CH₃ | CF₃ | CF₂CHF₂ | Et | Cl |
| CH₃ | CF₃ | CF₂CHF₂ | i-Pr | Cl |
| CH₃ | CF₃ | CF₂CHF₂ | t-Bu | Cl |
| CH₃ | CF₃ | CF₂CHF₂ | Me | Br |
| CH₃ | CF₃ | CF₂CHF₂ | Et | Br |
| CH₃ | CF₃ | CF₂CHF₂ | i-Pr | Br |
| CH₃ | CF₃ | CF₂CHF₂ | t-Bu | Br |
| CH₃ | Cl | CH₂CF₃ | n-Pr | Cl |
| CH₃ | Cl | CH₂CF₃ | n-Bu | Cl |
| CH₃ | Cl | CH₂CF₃ | s-Bu | Cl |
| CH₃ | Cl | CH₂CF₃ | i-Bu | Cl |
| Cl | F | CF₃ | Me | Cl |
| Cl | F | CF₃ | Et | Cl |
| Cl | F | CF₃ | i-Pr | Cl |
| Cl | F | CF₃ | t-Bu | Cl |
| Cl | F | CF₃ | Me | Br |
| Cl | F | CF₃ | Et | Br |
| Cl | F | CF₃ | i-Pr | Br |
| Cl | F | CF₃ | t-Bu | Br |
| Cl | F | CH₂CF₃ | Me | Cl |
| Cl | F | CH₂CF₃ | Et | Cl |
| Cl | F | CH₂CF₃ | i-Pr | Cl |
| Cl | F | CH₂CF₃ | t-Bu | Cl |
| Cl | F | CH₂CF₃ | Me | Br |
| Cl | F | CH₂CF₃ | Et | Br |
| Cl | F | CH₂CF₃ | i-Pr | Br |
| Cl | F | CH₂CF₃ | t-Bu | Br |
| Cl | F | CF₂CHF₂ | Me | Cl |
| Cl | F | CF₂CHF₂ | Et | Cl |
| Cl | F | CF₂CHF₂ | i-Pr | Cl |
| Cl | F | CF₂CHF₂ | t-Bu | Cl |
| Cl | F | CF₂CHF₂ | Me | Br |
| Cl | F | CF₂CHF₂ | Et | Br |
| Cl | F | CF₂CHF₂ | i-Pr | Br |
| Cl | F | CF₂CHF₂ | t-Bu | Br |
| Cl | Cl | CF₃ | Me | Cl |
| Cl | Cl | CF₃ | Et | Cl |
| Cl | Cl | CF₃ | i-Pr | Cl |
| CL | Cl | CF₃ | t-Bu | Cl |
| Cl | Cl | CF₃ | Me | Br |
| Cl | Cl | CF₃ | Et | Br |
| Cl | Cl | CF₃ | i-Pr | Br |
| Cl | Cl | CF₃ | t-Bu | Br |
| Cl | Cl | CH₂CF₃ | Me | Cl |
| Cl | Cl | CH₂CF₃ | Et | Cl |
| Cl | Cl | CH₂CF₃ | i-Pr | Cl |
| Cl | Cl | CH₂CF₃ | t-Bu | Cl |
| Cl | Cl | CH₂CF₃ | Me | Br |
| Cl | Cl | CH₂CF₃ | Et | Br |
| Cl | Cl | CH₂CF₃ | i-Pr | Br |
| Cl | Cl | CH₂CF₃ | t-Bu | Br |
| Cl | Cl | CF₂CHF₂ | Me | Cl |
| Cl | Cl | CF₂CHF₂ | Et | Cl |
| Cl | Cl | CF₂CHF₂ | i-Pr | Cl |
| Cl | Cl | CF₂CHF₂ | t-Bu | Cl |
| Cl | Cl | CF₂CHF₂ | Me | Br |
| Cl | Cl | CF₂CHF₂ | Et | Br |
| Cl | Cl | CF₂CHF₂ | i-Pr | Br |
| Cl | Cl | CF₂CHF₂ | t-Bu | Br |
| Cl | Br | CF₃ | Me | Cl |
| Cl | Br | CF₃ | Et | Cl |
| Cl | Br | CF₃ | i-Pr | Cl |
| Cl | Br | CF₃ | t-Bu | Cl |
| Cl | Br | CF₃ | Me | Br |
| Cl | Br | CF₃ | Et | Br |
| Cl | Br | CF₃ | i-Pr | Br |
| Cl | Br | CF₃ | t-Bu | Br |
| Cl | Br | CH₂CF₃ | Me | Cl |
| Cl | Br | CH₂CF₃ | Et | Cl |
| Cl | Br | CH₂CF₃ | i-Pr | Cl |
| Cl | Br | CH₂CF₃ | t-Bu | Cl |
| CH₃ | H | CF₃ | Me | Cl |
| CH₃ | H | CF₃ | Et | Cl |
| CH₃ | H | CF₃ | i-Pr | Cl |
| CH₃ | H | CF₃ | t-Bu | Cl |
| CH₃ | H | CF₃ | Me | Br |
| CH₃ | H | CF₃ | Et | Br |
| CH₃ | H | CF₃ | i-Pr | Br |
| CH₃ | H | CF₃ | t-Bu | Br |
| CH₃ | H | CH₂CF₃ | Me | Cl |
| CH₃ | H | CH₂CF₃ | Et | Cl |
| CH₃ | H | CH₂CF₃ | i-Pr | Cl |
| CH₃ | H | CH₂CF₃ | t-Bu | Cl |
| CH₃ | H | CH₂CF₃ | Me | Br |
| CH₃ | H | CH₂CF₃ | Et | Br |
| CH₃ | H | CH₂CF₃ | i-Pr | Br |
| CH₃ | H | CH₂CF₃ | t-Bu | Br |
| CH₃ | H | CF₂CHF₂ | Me | Cl |
| CH₃ | H | CF₂CHF₂ | Et | Cl |
| CH₃ | H | CF₂CHF₂ | i-Pr | Cl |
| CH₃ | H | CF₂CHF₂ | t-Bu | Cl |
| CH₃ | H | CF₂CHF₂ | Me | Br |
| CH₃ | H | CF₂CHF₂ | Et | Br |
| CH₃ | H | CF₂CHF₂ | i-Pr | Br |
| CH₃ | H | CF₂CHF₂ | t-Bu | Br |
| CH₃ | F | CHF₂ | Me | Cl |
| CH₃ | F | CHF₂ | Et | Cl |
| CH₃ | F | CHF₂ | i-Pr | Cl |
| CH₃ | F | CHF₂ | t-Bu | Cl |
| CH₃ | F | CHF₂ | Me | Br |
| CH₃ | F | CHF₂ | Et | Br |
| CH₃ | F | CHF₂ | i-Pr | Br |
| CH₃ | F | CHF₂ | t-Bu | Br |
| Cl | F | CHF₂ | Me | Cl |
| Cl | F | CHF₂ | Et | Cl |
| Cl | F | CHF₂ | i-Pr | Cl |
| Cl | F | CHF₂ | t-Bu | Cl |
| Cl | F | CHF₂ | Me | Br |
| Cl | F | CHF₂ | Et | Br |
| Cl | F | CHF₂ | i-Pr | Br |
| Cl | F | CHF₂ | t-Bu | Br |
| CH₃ | Br | CHF₂ | Me | Cl |
| CH₃ | Br | CHF₂ | Et | Cl |
| CH₃ | Br | CHF₂ | i-Pr | Cl |
| CH₃ | Br | CHF₂ | t-Bu | Cl |
| CH₃ | Br | CHF₂ | Me | Br |
| CH₃ | Br | CHF₂ | Et | Br |
| CH₃ | Br | CHF₂ | i-Pr | Br |
| CH₃ | Br | CHF₂ | t-Bu | Br |
| Cl | Br | CHF₂ | Me | Cl |
| Cl | Br | CHF₂ | Et | Cl |
| Cl | Br | CHF₂ | i-Pr | Cl |
| Cl | Br | CHF₂ | t-Bu | Cl |
| Cl | Br | CHF₂ | Me | Br |
| Cl | Br | CHF₂ | Et | Br |
| Cl | Br | CHF₂ | i-Pr | Br |
| Cl | Br | CHF₂ | t-Bu | Br |
| CH₃ | H | CHF₂ | Me | Br |
| CH₃ | H | CHF₂ | Et | Br |
| CH₃ | H | CHF₂ | i-Pr | Br |
| CH₃ | H | CHF₂ | t-Bu | Br |
| Cl | Br | CH₂CF₃ | Me | Br |
| Cl | Br | CH₂CF₃ | Et | Br |
| Cl | Br | CH₂CF₃ | i-Pr | Br |
| Cl | Br | CH₂CF₃ | t-Bu | Br |
| Cl | Br | CF₂CHF₂ | Me | Cl |
| Cl | Br | CF₂CHF₂ | Et | Cl |
| Cl | Br | CF₂CHF₂ | i-Pr | Cl |
| Cl | Br | CF₂CHF₂ | t-Bu | Cl |
| Cl | Br | CF₂CHF₂ | Me | Br |
| Cl | Br | CF₂CHF₂ | Et | Br |
| Cl | Br | CF₂CHF₂ | i-Pr | Br |
| Cl | Br | CF₂CHF₂ | t-Bu | Br |
| Cl | I | CF₃ | Me | Cl |
| Cl | I | CF₃ | Et | Cl |
| Cl | I | CF₃ | i-Pr | Cl |
| Cl | I | CF₃ | t-Bu | Cl |
| Cl | I | CF₃ | Me | Br |
| Cl | I | CF₃ | Et | Br |
| Cl | I | CF₃ | i-Pr | Br |
| Cl | I | CF₃ | t-Bu | Br |
| Cl | I | CH₂CF₃ | Me | Cl |
| Cl | I | CH₂CF₃ | Et | Cl |
| Cl | I | CH₂CF₃ | i-Pr | Cl |
| Cl | I | CH₂CF₃ | t-Bu | Cl |
| Cl | I | CH₂CF₃ | Me | Br |
| Cl | I | CH₂CF₃ | Et | Br |
| Cl | I | CH₂CF₃ | i-Pr | Br |
| Cl | I | CH₂CF₃ | t-Bu | Br |
| Cl | I | CF₂CHF₂ | Me | Cl |
| Cl | I | CF₂CHF₂ | Et | Cl |
| Cl | I | CF₂CHF₂ | i-Pr | Cl |
| Cl | I | CF₂CHF₂ | t-Bu | Cl |
| Cl | I | CF₂CHF₂ | Me | Br |
| Cl | I | CF₂CHF₂ | Et | Br |
| Cl | I | CF₂CHF₂ | i-Pr | Br |
| Cl | I | CF₂CHF₂ | t-Bu | Br |
| Cl | CF₃ | CF₃ | Me | Cl |
| Cl | CF₃ | CF₃ | Et | Cl |
| Cl | CF₃ | CF₃ | i-Pr | Cl |
| Cl | CF₃ | CF₃ | t-Bu | Cl |
| Cl | CF₃ | CF₃ | Me | Br |
| Cl | CF₃ | CF₃ | Et | Br |
| Cl | CF₃ | CF₃ | i-Pr | Br |
| Cl | CF₃ | CF₃ | t-Bu | Br |
| Cl | CF₃ | CH₂CF₃ | Me | Cl |
| Cl | CF₃ | CH₂CF₃ | Et | Cl |
| Cl | CF₃ | CH₂CF₃ | i-Pr | Cl |
| Cl | CF₃ | CH₂CF₃ | t-Bu | Cl |
| Cl | CF₃ | CH₂CF₃ | Me | Br |
| Cl | CF₃ | CH₂CF₃ | Et | Br |
| Cl | CF₃ | CH₂CF₃ | i-Pr | Br |
| Cl | CF₃ | CH₂CF₃ | t-Bu | Br |
| Cl | CF₃ | CF₂CHF₂ | Me | Cl |
| Cl | CF₃ | CF₂CHF₂ | Et | Cl |
| Cl | CF₃ | CF₂CHF₂ | i-Pr | Cl |
| Cl | CF₃ | CF₂CHF₂ | t-Bu | Cl |
| Cl | CF₃ | CF₂CHF₂ | Me | Br |
| Cl | CF₃ | CF₂CHF₂ | Et | Br |
| Cl | CF₃ | CF₂CHF₂ | i-Pr | Br |
| Cl | CF₃ | CF₂CHF₂ | t-Bu | Br |
| Cl | Cl | CH₂CF₃ | n-Pr | Cl |
| Cl | Cl | CH₂CF₃ | n-Bu | Cl |
| Cl | Cl | CH₂CF₃ | s-Bu | Cl |
| Cl | Cl | CH₂CF₃ | i-Bu | Cl |
| Br | F | CF₃ | Me | Cl |
| Br | F | CF₃ | Et | Cl |
| Br | F | CF₃ | i-Pr | Cl |
| Br | F | CF₃ | t-Bu | Cl |
| Br | F | CF₃ | Me | Br |
| Br | F | CF₃ | Et | Br |
| Br | F | CF₃ | i-Pr | Br |
| Br | F | CF₃ | t-Bu | Br |
| Br | F | CH₂CF₃ | Me | Cl |
| Br | F | CH₂CF₃ | Et | Cl |
| Br | F | CH₂CF₃ | i-Pr | Cl |
| Br | F | CH₂CF₃ | t-Bu | Cl |
| Br | F | CH₂CF₃ | Me | Br |
| Br | F | CH₂CF₃ | Et | Br |
| Br | F | CH₂CF₃ | i-Pr | Br |
| Br | F | CH₂CF₃ | t-Bu | Br |
| Br | F | CF₂CHF₂ | Me | Cl |
| Br | F | CF₂CHF₂ | Et | Cl |
| Br | F | CF₂CHF₂ | i-Pr | Cl |
| Br | F | CF₂CHF₂ | t-Bu | Cl |
| Br | F | CF₂CHF₂ | Me | Br |
| Br | F | CF₂CHF₂ | Et | Br |
| Br | F | CF₂CHF₂ | i-Pr | Br |
| Br | F | CF₂CHF₂ | t-Bu | Br |
| Br | Cl | CF₃ | Me | Cl |
| Br | Cl | CF₃ | Et | Cl |
| Br | Cl | CF₃ | i-Pr | Cl |
| Br | Cl | CF₃ | t-Bu | Cl |
| Br | Cl | CF₃ | Me | Br |
| Br | Cl | CF₃ | Et | Br |
| Br | Cl | CF₃ | i-Pr | Br |
| Br | Cl | CF₃ | t-Bu | Br |
| Br | Cl | CH₂CF₃ | Me | Cl |
| Br | Cl | CH₂CF₃ | Et | Cl |
| Br | Cl | CH₂CF₃ | i-Pr | Cl |
| Br | Cl | CH₂CF₃ | t-Bu | Cl |
| Br | Cl | CH₂CF₃ | Me | Br |
| Br | Cl | CH₂CF₃ | Et | Br |
| Br | Cl | CH₂CF₃ | i-Pr | Br |
| Br | Cl | CH₂CF₃ | t-Bu | Br |
| Br | Cl | CF₂CHF₂ | Me | Cl |
| Br | Cl | CF₂CHF₂ | Et | Cl |
| Br | Cl | CF₂CHF₂ | i-Pr | Cl |
| Br | Cl | CF₂CHF₂ | t-Bu | Cl |
| Br | Cl | CF₂CHF₂ | Me | Br |
| Br | Cl | CF₂CHF₂ | Et | Br |
| Br | Cl | CF₂CHF₂ | i-Pr | Br |
| Br | Cl | CF₂CHF₂ | t-Bu | Br |
| Br | Br | CF₃ | Me | Cl |
| Br | Br | CF₃ | Et | Cl |
| Br | Br | CF₃ | i-Pr | Cl |
| Br | Br | CF₃ | t-Bu | Cl |
| Br | Br | CF₃ | Me | Br |
| Br | Br | CF₃ | Et | Br |
| Br | Br | CF₃ | i-Pr | Br |
| Br | Br | CF₃ | t-Bu | Br |
| Br | Br | CH₂CF₃ | Me | Cl |
| Br | Br | CH₂CF₃ | Et | Cl |
| Br | Br | CH₂CF₃ | i-Pr | Cl |
| Br | Br | CH₂CF₃ | t-Bu | Cl |
| Br | Br | CH₂CF₃ | Me | Br |
| Br | Br | CH₂CF₃ | Et | Br |
| Br | Br | CH₂CF₃ | i-Pr | Br |
| Br | Br | CH₂CF₃ | t-Bu | Br |
| Br | Br | CF₂CHF₂ | Me | Cl |
| Br | Br | CF₂CHF₂ | Et | Cl |
| Br | Br | CF₂CHF₂ | i-Pr | Cl |
| Br | Br | CF₂CHF₂ | t-Bu | Cl |
| Br | Br | CF₂CHF₂ | Me | Br |
| Br | Br | CF₂CHF₂ | Et | Br |
| Br | Br | CF₂CHF₂ | i-Pr | Br |
| Br | Br | CF₂CHF₂ | t-Bu | Br |
| Br | I | CF₃ | Me | Cl |
| Br | I | CF₃ | Et | Cl |
| Br | I | CF₃ | i-Pr | Cl |
| Br | I | CF₃ | t-Bu | Cl |
| Br | I | CF₃ | Me | Br |
| Br | I | CF₃ | Et | Br |
| Br | I | CF₃ | i-Pr | Br |
| Br | I | CF₃ | t-Bu | Br |
| Br | I | CH₂CF₃ | Me | Cl |
| Br | I | CH₂CF₃ | Et | Cl |
| Br | I | CH₂CF₃ | i-Pr | Cl |
| Br | I | CH₂CF₃ | t-Bu | Cl |
| Br | I | CH₂CF₃ | Me | Br |
| Br | I | CH₂CF₃ | Et | Br |
| Br | I | CH₂CF₃ | i-Pr | Br |
| Br | I | CH₂CF₃ | t-Bu | Br |
| Br | I | CF₂CHF₂ | Me | Cl |
| Br | I | CF₂CHF₂ | Et | Cl |
| Br | I | CF₂CHF₂ | i-Pr | Cl |
| Br | I | CF₂CHF₂ | t-Bu | Cl |
| Br | I | CF₂CHF₂ | Me | Br |
| Br | I | CF₂CHF₂ | Et | Br |
| Br | I | CF₂CHF₂ | i-Pr | Br |
| Br | I | CF₂CHF₂ | t-Bu | Br |
| Br | CF₃ | CF₃ | Me | Cl |
| Br | CF₃ | CF₃ | Et | Cl |
| Br | CF₃ | CF₃ | i-Pr | Cl |
| Br | CF₃ | CF₃ | t-Bu | Cl |
| Br | CF₃ | CF₃ | Me | Br |
| Br | CF₃ | CF₃ | Et | Br |
| Br | CF₃ | CF₃ | i-Pr | Br |
| Br | CF₃ | CF₃ | t-Bu | Br |
| Br | CF₃ | CH₂CF₃ | Me | Cl |
| Br | CF₃ | CH₂CF₃ | Et | Cl |
| Br | CF₃ | CH₂CF₃ | i-Pr | Cl |
| Br | CF₃ | CH₂CF₃ | t-Bu | Cl |
| Br | CF₃ | CH₂CF₃ | Me | Br |
| Br | CF₃ | CH₂CF₃ | Et | Br |
| Br | CF₃ | CH₂CF₃ | i-Pr | Br |
| Br | CF₃ | CH₂CF₃ | t-Bu | Br |
| Br | CF₃ | CF₂CHF₂ | Me | Cl |
| Br | CF₃ | CF₂CHF₂ | Et | Cl |
| Br | CF₃ | CF₂CHF₂ | i-Pr | Cl |
| Br | CF₃ | CF₂CHF₂ | t-Bu | Cl |
| Br | CF₃ | CF₂CHF₂ | Me | Br |
| Br | CF₃ | CF₂CHF₂ | Et | Br |
| Br | CF₃ | CF₂CHF₂ | i-Pr | Br |
| Br | CF₃ | CF₂CHF₂ | t-Bu | Br |
| Cl | H | CF₃ | Me | Cl |
| Cl | H | CF₃ | Et | Cl |
| Cl | H | CF₃ | i-Pr | Cl |
| Cl | H | CF₃ | t-Bu | Cl |
| Cl | H | CF₃ | Me | Br |
| Cl | H | CF₃ | Et | Br |
| Cl | H | CF₃ | i-Pr | Br |
| Cl | H | CF₃ | t-Bu | Br |
| Cl | H | CH₂CF₃ | Me | Cl |
| Cl | H | CH₂CF₃ | Et | Cl |
| Cl | H | CH₂CF₃ | i-Pr | Cl |
| Cl | H | CH₂CF₃ | t-Bu | Cl |
| Cl | H | CH₂CF₃ | Me | Br |
| Cl | H | CH₂CF₃ | Et | Br |
| Cl | H | CH₂CF₃ | i-Pr | Br |
| Cl | H | CH₂CF₃ | t-Bu | Br |
| Cl | H | CF₂CHF₂ | Me | Cl |
| Cl | H | CF₂CHF₂ | Et | Cl |
| Cl | H | CF₂CHF₂ | i-Pr | Cl |
| Cl | H | CF₂CHF₂ | t-Bu | Cl |
| Cl | H | CF₂CHF₂ | Me | Br |
| Cl | H | CF₂CHF₂ | Et | Br |
| Cl | H | CF₂CHF₂ | i-Pr | Br |
| Cl | H | CF₂CHF₂ | t-Bu | Br |
| CH₃ | Cl | CHF₂ | Me | Cl |
| CH₃ | Cl | CHF₂ | Et | Cl |
| CH₃ | Cl | CHF₂ | i-Pr | Cl |
| CH₃ | Cl | CHF₂ | t-Bu | Cl |
| CH₃ | Cl | CHF₂ | Me | Br |
| CH₃ | Cl | CHF₂ | Et | Br |
| CH₃ | Cl | CHF₂ | i-Pr | Br |
| CH₃ | Cl | CHF₂ | t-Bu | Br |
| Cl | F | CHF₂ | Me | Cl |
| Cl | F | CHF₂ | Et | Cl |
| Cl | F | CHF₂ | i-Pr | Cl |
| Cl | F | CHF₂ | t-Bu | Cl |
| Cl | F | CHF₂ | Me | Br |
| Cl | F | CHF₂ | Et | Br |
| Cl | F | CHF₂ | i-Pr | Br |
| Cl | F | CHF₂ | t-Bu | Br |
| CH₃ | I | CHF₂ | Me | Cl |
| CH₃ | I | CHF₂ | Et | Cl |
| CH₃ | I | CHF₂ | i-Pr | Cl |
| CH₃ | I | CHF₂ | t-Bu | Cl |
| CH₃ | I | CHF₂ | Me | Br |
| CH₃ | I | CHF₂ | Et | Br |
| CH₃ | I | CHF₂ | i-Pr | Br |
| CH₃ | I | CHF₂ | t-Bu | Br |
| Cl | I | CHF₂ | Me | Cl |
| Cl | I | CHF₂ | Et | Cl |
| Cl | I | CHF₂ | i-Pr | Cl |
| Cl | I | CHF₂ | t-Bu | Cl |
| Cl | I | CHF₂ | Me | Br |
| Cl | I | CHF₂ | Et | Br |
| Cl | I | CHF₂ | i-Pr | Br |
| Cl | I | CHF₂ | t-Bu | Br |
| Cl | H | CHF₂ | Me | Br |
| Cl | H | CHF₂ | Et | Br |
| Cl | H | CHF₂ | i-Pr | Br |
| Cl | H | CHF₂ | t-Bu | Br |

TABLE 11

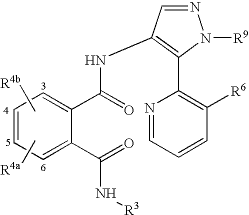

| R³ | R^{4a} | R^{4b} | R⁹ | R⁶ | R³ | R^{4a} | R^{4b} | R⁹ | R⁶ |
|---|---|---|---|---|---|---|---|---|---|
| Me | 3-Me | H | CF₃ | F | Me | 3-Cl | H | CF³ | F |
| Et | 3-Me | 5-Me | CHF₂ | F | Et | 3-Cl | 5-Me | CHF₂ | F |
| i-Pr | 3-Me | H | CHF₂ | F | i-Pr | 3-Cl | H | CHF₂ | F |
| t-Bu | 3-Me | 5-Cl | CH₂CF₃ | F | t-Bu | 3-Cl | 5-Cl | CH₂CF₃ | F |
| Me | 3-Me | H | CH₂CF₃ | F | Me | 3-Cl | H | CH₂CF₃ | F |
| Et | 3-Me | H | CF₂CHF₂ | F | Et | 3-Cl | H | CF₂CHF₂ | F |
| i-Pr | 3-Me | 5-Br | CF₂CHF₂ | F | i-Pr | 3-Cl | 5-Br | CF₂CHF₂ | F |
| t-Bu | 3-Me | H | Et | F | t-Bu | 3-Cl | H | Et | F |
| propargyl | 3-Me | H | CF₃ | F | propargyl | 3-Cl | H | CF₃ | F |
| c-propyl | 3-Me | H | CHF₂ | F | c-propyl | 3-Cl | H | CHF₂ | F |
| i-Pr | 3-Me | 5-Cl | CF₃ | F | i-Pr | 3-Cl | 5-Cl | CF₃ | F |
| t-Bu | 3-Me | H | n-C₃F₇ | F | t-Bu | 3-Cl | H | n-C₃F₇ | F |
| Me | 3-Me | S-Cl | i-C₃F₇ | F | Me | 3-Cl | 5-Cl | i-C₃F₇ | F |
| Et | 3-Me | H | i-Pr | F | Et | 3-Cl | H | i-Pr | F |
| i-Pr | 3-Me | H | CF₃ | F | i-Pr | 3-Cl | H | CF₃ | F |
| t-Bu | 3-Me | H | C₂F₅ | F | t-Bu | 3-Cl | H | C₂F₅ | F |
| propargyl | 3-Me | H | C₂F₅ | F | propargyl | 3-Cl | H | C₂F₅ | F |
| c-propyl | 3-Me | H | CF₃ | F | c-propyl | 3-Cl | H | CF₃ | F |
| i-Pr | 3-Me | H | n-Pr | F | i-Pr | 3-Cl | H | n-Pr | F |
| t-Bu | 3-Me | 5-Br | CH₂CH₂Cl | F | t-Bu | 3-Cl | 5-Br | CH₂CH₂Cl | F |
| Me | 3-Me | H | CF₃ | Cl | Me | 3-Cl | H | CF₃ | Cl |
| Et | 3-Me | 5-Me | CHF₂ | Cl | Et | 3-Cl | 5-Me | CHF₂ | Cl |
| i-Pr | 3-Me | H | CHF₂ | Cl | i-Pr | 3-Cl | H | CHF₂ | Cl |
| t-Bu | 3-Me | 5-Cl | CH₂CF₃ | Cl | t-Bu | 3-Cl | 5-Cl | CH₂CF₃ | Cl |
| Me | 3-Me | H | CH₂CF₃ | Cl | Me | 3-Cl | H | CH₂CF₃ | Cl |
| Et | 3-Me | H | CF₂CHF₂ | Cl | Et | 3-Cl | H | CF₂CHF₂ | Cl |
| i-Pr | 3-Me | 5-Br | CF₂CHF₂ | Cl | i-Pr | 3-Cl | 5-Br | CF₂CHF₂ | Cl |
| t-Bu | 3-Me | H | Et | Cl | t-Bu | 3-Cl | H | Et | Cl |
| propargyl | 3-Me | H | CF₃ | Cl | propargyl | 3-Cl | H | CF₃Cl | |
| c-propyl | 3-Me | H | CHF₂ | Cl | c-propyl | 3-Cl | H | CHF₂ | Cl |
| i-Pr | 3-Me | 5-Cl | CF₃ | Cl | i-Pr | 3-Cl | 5-Cl | CF₃ | Cl |
| t-Bu | 3-Me | H | n-C₃F₇ | Cl | t-Bu | 3-Cl | H | n-C₃F₇ | Cl |
| Me | 3-Me | 5-Cl | i-C₃F₇ | Cl | Me | 3-Cl | 5-Cl | i-C₃F₇ | Cl |
| Et | 3-Me | H | i-Pr | Cl | Et | 3-Cl | H | i-Pr | Cl |
| i-Pr | 3-Me | H | CF₃ | Cl | i-Pr | 3-Cl | H | CF₃ | Cl |
| t-Bu | 3-Me | H | C₂F₅ | Cl | t-Bu | 3-Cl | H | C₂F₅ | Cl |
| propargyl | 3-Me | H | C₂F₅ | Cl | propargyl | 3-Cl | H | C₂F₅ | Cl |
| c-propyl | 3-Me | H | CF₃ | Cl | c-propyl | 3-Cl | H | CF₃ | Cl |
| i-Pr | 3-Me | H | n-Pr | Cl | i-Pr | 3-Cl | H | n-Pr | Cl |
| t-Bu | 3-Me | 5-Br | CH₂CH₂Cl | Cl | t-Bu | 3-Cl | 5-Br | CH₂CH₂Cl | Cl |
| Me | 3-Me | H | CF₃ | CF₃ | Me | 3-Cl | H | CF₃ | CF₃ |
| Et | 3-Me | 5-Me | CHF₂ | CF₃ | Et | 3-Cl | S-Me | CHF₂ | CF₃ |
| i-Pr | 3-Me | H | CHF₂ | CF₃ | i-Pr | 3-Cl | H | CHF₂ | CF₃ |
| t-Bu | 3-Me | 5-Cl | CH₂CF₃ | CF₃ | t-Bu | 3-Cl | 5-Cl | CH₂CF₃ | CF₃ |
| Me | 3-Me | H | CH₂CF₃ | CF₃ | Me | 3-Cl | H | CH₂CF₃ | CF₃ |
| Et | 3-Me | H | CF₂CHF₂ | CF₃ | Et | 3-Cl | H | CF₂CHF₂ | CF₃ |
| i-Pr | 3-Me | 5-Br | CF₂CHF₂ | CF₃ | i-Pr | 3-Cl | 5-Br | CF₂CHF₂ | CF₃ |
| t-Bu | 3-Me | H | Et | CF₃ | t-Bu | 3-Cl | H | Et | CF₃ |
| propargyl | 3-Me | H | CF₃ | CF₃ | propargyl | 3-Cl | H | CF₃ | CF₃ |
| c-propyl | 3-Me | H | CHF₂ | CF₃ | c-propyl | 3-Cl | H | CHF₂ | CF₃ |
| i-Pr | 3-Me | 5-Cl | CF₃ | CF₃ | i-Pr | 3-Cl | 5-Cl | CF₃ | CF₃ |
| t-Bu | 3-Me | H | n-C₃F₇ | CF₃ | t-Bu | 3-Cl | H | n-C₃F₇ | CF₃ |
| Me | 3-Me | 5-Cl | i-C₃F₇ | CF₃ | Me | 3-Cl | 5-Cl | i-C₃F₇ | CF₃ |
| Et | 3-Me | H | i-Pr | CF₃ | Et | 3-Cl | H | i-Pr | CF₃ |
| i-Pr | 3-Me | H | CF₃ | CF₃ | i-Pr | 3-Cl | H | CF₃ | CF₃ |
| t-Bu | 3-Me | H | C₂F₅ | CF₃ | t-Bu | 3-Cl | H | C₂F₅ | CF₃ |
| propargyl | 3-Me | H | C₂F₅ | CF₃ | propargyl | 3-Cl | H | C₂F₅ | CF₃ |
| c-propyl | 3-Me | H | CF₃ | CF₃ | c-propyl | 3-Cl | H | CF₃ | CF₃ |
| i-Pr 3-Me | H | n-Pr | CF₃ | i-Pr | 3-Cl | H | n-Pr | CF₃ | |
| t-Bu | 3-Me | 5-Br | CH₂CH₂Cl | CF₃ | t-Bu | 3-Cl | 5-Br | CH₂CH₂Cl | CF₃ |
| Me | 3-Me | H | CF₃ | Br | Me | 3-Cl | H | CF₃ | Br |
| Et | 3-Me | 5-Me | CHF₂ | Br | Et | 3-Cl | 5-Me | CHF₂ | Br |
| i-Pr | 3-Me | H | CHF₂ | Br | i-Pr | 3-Cl | H | CHF₂ | Br |
| t-Bu | 3-Me | 5-Cl | CH₂CF₃ | Br | t-Bu | 3-Cl | 5-Cl | CH₂CF₃ | Br |
| Me | 3-Me | H | CH₂CF₃ | Br | Me | 3-Cl | H | CH₂CF₃ | Br |
| Et | 3-Me | H | CF₂CHF₂ | Br | Et | 3-Cl | H | CF₂CHF₂ | Br |
| i-Pr | 3-Me | 5-Br | CF₂CHF₂ | Br | i-Pr | 3-Cl | 5-Br | CF₂CHF₂ | Br |
| t-Bu | 3-Me | H | Et | Br | t-Bu | 3-Cl | H | Et | Br |
| propargyl | 3-Me | H | CF₃ | Br | propargyl | 3-Cl | H | CF₃Br | |
| c-propyl | 3-Me | H | CHF₂ | Br | c-propyl | 3-Cl | H | CHF₂ | Br |
| i-Pr | 3-Me | 5-Cl | CF₃ | Br | i-Pr | 3-Cl | 5-Cl | CF₃ | Br |
| t-Bu | 3-Me | H | n-C₃F₇ | Br | t-Bu | 3-Cl | H | n-C₃F₇ | Br |
| Me | 3-Me | 5-Cl | i-C₃F₇ | Br | Me | 3-Cl | 5-Cl | i-C₃F₇ | Br |
| Et | 3-Me | H | i-Pr | Br | Et | 3-Cl | H | i-Pr | Br |
| i-Pr | 3-Me | H | CF₃ | Br | i-Pr | 3-Cl | H | CF₃ | Br |
| t-Bu | 3-Me | H | C₂F₅ | Br | t-Bu | 3-Cl | H | C₂F₅ | Br |
| propargyl | 3-Me | H | C₂F₅ | Br | propargyl | 3-Cl | H | C₂F₅ | Br |
| c-propyl | 3-Me | H | CF₃ | Br | c-propyl | 3-Cl | H | CF₃ | Br |
| i-Pr | 3-Me | H | n-Pr | Br | i-Pr | 3-Cl | H | n-Pr | Br |
| t-Bu | 3-Me | 5-Br | CH₂CH₂Cl | Br | t-Bu | 3-Cl | 5-Br | CH₂CH₂Cl | Br |
| Me | 6-Me | H | CHF₂ | F | Me | 6-Cl | H | CHF₂ | F |
| Et | 6-Me | H | CHF₂ | F | Et | 6-Cl | H | CHF₂ | F |
| i-Pr | 6-Me | H | CHF₂ | F | i-Pr | 6-Cl | H | CHF₂ | F |
| t-Bu | 6-Me | H | CHF₂ | F | t-Bu | 6-Cl | H | CHF₂ | F |
| Me | 6-Me | H | n-Pr | F | Me | 6-Cl | H | n-Pr | F |
| Et | 6-Me | H | n-Pr | F | Et | 6-Cl | H | n-Pr | F |
| i-Pr | 6-Me | H | n-Pr | F | i-Pr | 6-Cl | H | n-Pr | F |
| t-Bu | 6-Me | H | n-Pr | F | t-Bu | 6-Cl | H | n-Pr | F |
| Me | 6-Me | H | CF₃ | F | Me | 6-Cl | H | CF₃ | F |
| Et | 6-Me | H | CF₃ | F | Et | 6-Cl | H | CF₃ | F |
| i-Pr | 6-Me | H | CF₃ | F | i-Pr | 6-Cl | H | CF₃ | F |
| t-Bu | 6-Me | H | CF₃ | F | t-Bu | 6-Cl | H | CF₃ | F |
| Me | 6-Me | H | i-Pr | F | Me | 6-Cl | H | i-Pr | F |
| Et | 6-Me | H | i-Pr | F | Et | 6-Cl | H | i-Pr | F |
| i-Pr | 6-Me | H | i-Pr | F | i-Pr | 6-Cl | H | i-Pr | F |
| t-Bu | 6-Me | H | i-Pr | F | t-Bu | 6-Cl | H | i-Pr | F |
| Me | 6-Me | H | C₂F₅ | F | Me | 6-Cl | H | C₂F₅ | F |
| Et | 6-Me | H | C₂F₅ | F | Et | 6-Cl | H | C₂F₅ | F |
| i-Pr 6-Me | H | C₂F₅ | F | i-Pr | 6-Cl | H | C₂F₅ | F | |
| t-Bu | 6-Me | H | C₂F₅ | F | t-Bu | 6-Cl | H | C₂F₅ | F |
| Me | 6-Me | H | n-C₃F₇ | F | Me | 6-Cl | H | n-C₃F₇ | F |
| Et | 6-Me | H | n-C₃F₇ | F | Et | 6-Cl | H | n-C₃F₇ | F |
| i-Pr | 6-Me | H | n-C₃F₇ | F | i-Pr | 6-Cl | H | n-C₃F₇ | F |
| t-Bu | 6-Me | H | n-C₃F₇ | F | t-Bu | 6-Cl | H | n-C₃F₇ | F |
| Me | 6-Me | H | i-C₃F₇ | F | Me | 6-Cl | H | i-C₃F₇ | F |
| Et | 6-Me | H | i-C₃F₇ | F | Et | 6-Cl | H | i-C₃F₇ | F |
| i-Pr | 6-Me | H | i-C₃F₇ | F | i-Pr | 6-Cl | H | i-C₃F₇ | F |
| t-Bu | 6-Me | H | i-C₃F₇ | F | t-Bu | 6-Cl | H | i-C₃F₇ | F |
| Me | 6-Me | H | Et | F | Me | 6-Cl | H | Et | F |
| Et | 6-Me | H | Et | F | Et | 6-Cl | H | Et | F |
| i-Pr | 6-Me | H | Et | F | i-Pr | 6-Cl | H | Et | F |
| t-Bu | 6-Me | H | Et | F | t-Bu | 6-Cl | H | Et | F |
| Me | 6-Me | H | CHF₂ | Cl | Me | 6-Cl | H | CHF₂ | Cl |
| Et | 6-Me | H | CHF₂ | Cl | Et | 6-Cl | H | CHF₂ | Cl |
| i-Pr | 6-Me | H | CHF₂ | Cl | i-Pr | 6-Cl | H | CHF₂ | Cl |
| t-Bu | 6-Me | H | CHF₂ | Cl | t-Bu | 6-Cl | H | CHF₂ | Cl |
| Me | 6-Me | H | n-Pr | Cl | Me | 6-Cl | H | n-Pr | Cl |
| Et | 6-Me | H | n-Pr | Cl | Et | 6-Cl | H | n-Pr | Cl |
| i-Pr | 6-Me | H | n-Pr | Cl | i-Pr | 6-Cl | H | n-Pr | Cl |
| t-Bu | 6-Me | H | n-Pr | Cl | t-Bu | 6-Cl | H | n-Pr | Cl |
| Me | 6-Me | H | CF₃ | Cl | Me | 6-Cl | H | CF₃ | Cl |
| Et | 6-Me | H | CF₃ | Cl | Et | 6-Cl | H | CF₃ | Cl |
| i-Pr | 6-Me | H | CF₃ | Cl | i-Pr | 6-Cl | H | CF₃ | Cl |
| t-Bu | 6-Me | H | CF₃ | Cl | t-Bu | 6-Cl | H | CF₃ | Cl |
| Me | 6-Me | H | i-Pr | Cl | Me | 6-Cl | H | i-Pr | Cl |
| Et | 6-Me | H | i-Pr | Cl | Et | 6-Cl | H | i-Pr | Cl |
| i-Pr | 6-Me | H | i-Pr | Cl | i-Pr | 6-Cl | H | i-Pr | Cl |
| t-Bu | 6-Me | H | i-Pr | Cl | t-Bu | 6-Cl | H | i-Pr | Cl |
| Me | 6-Me | H | C₂F₅ | Cl | Me | 6-Cl | H | C₂F₅ | Cl |
| Et | 6-Me | H | C₂F₅ | Cl | Et | 6-Cl | H | C₂F₅ | Cl |
| i-Pr | 6-Me | H | C₂F₅ | Cl | i-Pr | 6-Cl | H | C₂F₅ | Cl |
| t-Bu | 6-Me | H | C₂F₅ | Cl | t-Bu | 6-Cl | H | C₂F₅ | Cl |
| Me | 6-Me | H | n-C₃F₇ | Cl | Me | 6-Cl | H | n-C₃F₇ | Cl |
| Et | 6-Me | H | n-C₃F₇ | Cl | Et | 6-Cl | H | n-C₃F₇ | Cl |
| i-Pr | 6-Me | H | n-C₃F₇ | Cl | i-Pr | 6-Cl | H | n-C₃F₇ | Cl |
| t-Bu | 6-Me | H | n-C₃F₇ | Cl | t-Bu | 6-Cl | H | n-C₃F₇ | Cl |
| Me | 6-Me | H | i-C₃F₇ | Cl | Me | 6-Cl | H | i-C₃F₇ | Cl |
| Et | 6-Me | H | i-C₃F₇ | Cl | Et | 6-Cl | H | i-C₃F₇ | Cl |
| i-Pr | 6-Me | H | i-C₃F₇ | Cl | i-Pr | 6-Cl | H | i-C₃F₇ | Cl |
| t-Bu | 6-Me | H | i-C₃F₇ | Cl | t-Bu | 6-Cl | H | i-C₃F₇ | Cl |
| Me | 6-Me | H | Et | Cl | Me | 6-Cl | H | Et | Cl |
| Et | 6-Me | H | Et | Cl | Et | 6-Cl | H | Et | Cl |
| i-Pr | 6-Me | H | Et | Cl | i-Pr | 6-Cl | H | Et | Cl |
| t-Bu | 6-Me | H | Et | Cl | t-Bu | 6-Cl | H | Et | Cl |
| Me | 6-Me | H | CHF₂ | Br | Me | 6-Cl | H | CHF₂ | Br |
| Et | 6-Me | H | CHF₂ | Br | Et | 6-Cl | H | CHF₂ | Br |
| i-Pr | 6-Me | H | CHF₂ | Br | i-Pr | 6-Cl | H | CHF₂ | Br |
| t-Bu | 6-Me | H | CHF₂ | Br | t-Bu | 6-Cl | H | CHF₂ | Br |
| Me | 6-Me | H | n-Pr | Br | Me | 6-CL | H | n-Pr | Br |
| Et | 6-Me | H | n-Pr | Br | Et | 6-Cl | H | n-Pr | Br |
| i-Pr | 6-Me | H | n-Pr | Br | i-Pr | 6-Cl | H | n-Pr | Br |
| f-Eu | 6-Me | H | n-Pr | Br | t-Bu | 6-Cl | H | n-Pr | Br |
| Me | 6-Me | H | CF₃ | Er | Me | 6-Cl | H | CF₃ | Br |
| Et | 6-Me | H | CF₃ | Br | Et | 6-Cl | H | CF₃ | Br |
| i-Pr | 6-Me | H | CF₃ | Br | i-Pr | 6-Cl | H | CF₃ | Br |
| f-Eu | 6-Me | H | CF₃ | Br | t-Bu | 6-Cl | H | CF₃ | Br |
| Me | 6-Me | H | i-Pr | Br | Me | 6-Cl | H | i-Pr | Br |
| Et | 6-Me | H | i-Pr | Br | Et | 6-Cl | H | i-Pr | Br |
| i-Pr | 6-Me | H | i-Pr | Br | i-Pr | 6-Cl | H | i-Pr | Br |
| f-Eu | 6-Me | H | i-Pr | Br | t-Bu | 6-Cl | H | i-Pr | Br |
| Me | 6-Me | H | C₂F₅ | Br | Me | 6-Cl | H | C₂F₅ | Er |
| Et | 6-Me | H | C₂F₅ | Br | Et | 6-Cl | H | C₂F₅ | Br |
| i-Pr | 6-Me | H | C₂F₅ | Br | i-Pr | 6-Cl | H | C₂F₅ | Br |
| t-Bu | 6-Me | H | C₂F₅ | Br | f-Eu | 6-Cl | H | C₂F₅ | Br |
| Me | 6-Me | H | n-C₃F₇ | Br | Me | 6-Cl | H | n-C₃F₇ | Br |
| Et | 6-Me | H | n-C₃F₇ | Br | Et | 6-Cl | H | n-C₃F₇ | Br |
| i-Pr | 6-Me | H | n-C₃F₇ | Br | i-Pr | 6-Cl | H | n-C₃F₇ | Br |
| f-Eu | 6-Me | H | n-C₃F₇ | Br | t-Eu | 6-Cl | H | n-C₃F₇ | Br |
| Me | 6-Me | H | i-C₃F₇ | Br | Me | 6-Cl | H | i-C₃F₇ | Br |
| Et | 6-Me | H | i-C₃F₇ | Br | Et | 6-Cl | H | i-C₃F₇ | Br |
| i-Pr | 6-Me | H | i-C₃F₇ | Br | i-Pr | 6-Cl | H | i-C₃F₇ | Br |
| t-Bu | 6-Me | H | i-C₃F₇ | Br | 1-Eu | 6-Cl | H | i-C₃F₇ | Br |
| Me | 6-Me | H | Et | Er | Me | 6-Cl | H | Et | Br |
| Et | 6-Me | H | Et | Er | Et | 6-Cl | H | Et | Br |
| i-Pr | 6-Me | H | Et | Br | i-Pr | 6-Cl | H | Et | Br |
| f-Eu | 6-Me | H | Et | Br | f-Eu | 6-Cl | H | Et | Br |
| Me | 6-Me | H | CHF₂ | CF₃ | Me | 6-Cl | H | CHF₂ | CF₃ |
| Et | 6-Me | H | CHF₂ | CF₃ | Et | 6-CL | H | CHF₂ | CF₃ |
| i-Pr | 6-Me | H | CHF₂ | CF₃ | i-Pr | 6-Cl | H | CHF₂ | CF₃ |
| t-Bu | 6-Me | H | CHF₂ | CF₃ | t-Bu | 6-Cl | H | CHF₂ | CF₃ |
| Me | 6-Me | H | n-Pr | CF₃ | Me | 6-Cl | H | n-Pr | CF₃ |
| Et | 6-Me | H | n-Pr | CF₃ | Et | 6-Cl | H | n-Pr | CF₃ |
| i-Pr | 6-Me | H | n-Pr | CF₃ | i-Pr | 6-Cl | H | n-Pr | CF₃ |
| t-Bu | 6-Me | H | n-Pr | CF₃ | t-Bu | 6-Cl | H | n-Pr | CF₃ |
| Me | 6-Me | H | CF₃ | CF₃ | Me | 6-Cl | H | CF₃ | CF₃ |
| Et | 6-Me | H | CF₃ | CF₃ | Et | 6-Cl | H | CF₃ | CF₃ |
| i-Pr | 6-Me | H | CF₃ | CF₃ | i-Pr | 6-Cl | H | CF₃ | CF₃ |
| t-Bu | 6-Me | H | CF₃ | CF₃ | t-Bu | 6-Cl | H | CF₃ | CF₃ |
| Me | 6-Me | H | i-Pr | CF₃ | Me | 6-Cl | H | i-Pr | CF₃ |
| Et | 6-Me | H | i-Pr | CF₃ | Et | 6-Cl | H | i-Pr | CF₃ |
| i-Pr | 6-Me | H | i-Pr | CF₃ | i-Pr | 6-Cl | H | i-Pr | CF₃ |
| t-Bu | 6-Me | H | i-Pr | CF₃ | t-Bu | 6-Cl | H | i-Pr | CF₃ |
| Me | 6-Me | H | C₂F₅ | CF₃ | Me | 6-Cl | H | C₂F₅ | CF₃ |
| Et | 6-Me | H | C₂F₅ | CF₃ | Et | 6-Cl | H | C₂F₅ | CF₃ |
| i-Pr | 6-Me | H | C₂F₅ | CF₃ | i-Pr | 6-Cl | H | C₂F₅ | CF₃ |
| t-Bu | 6-Me | H | C₂F₅ | CF₃ | t-Bu | 6-Cl | H | CH₂F₅ | CF₃ |
| Me | 6-Me | H | n-C₃F₇ | CF₃ | Me | 6-Cl | H | n-C₃F₇ | CF₃ |
| Et | 6-Me | H | n-C₃F₇ | CF₃ | Et | 6-Cl | H | n-C₃F₇ | CF₃ |
| i-Pr | 6-Me | H | n-C₃F₇ | CF₃ | i-Pr | 6-Cl | H | n-C₃F₇ | CF₃ |
| t-Bu | 6-Me | H | n-C₃F₇ | CF₃ | t-Bu | 6-Cl | H | n-C₃F₇ | CF₃ |
| Me | 6-Me | H | i-C₃F₇ | CF₃ | Me | 6-Cl | H | i-C₃F₇ | CF₃ |
| Et | 6-Me | H | i-C₃F₇ | CF₃ | Et | 6-Cl | H | i-C₃F₇ | CF₃ |
| i-Pr | 6-Me | H | i-C₃F₇ | CF₃ | i-Pr | 6-Cl | H | i-C₃F₇ | CF₃ |
| t-Bu | 6-Me | H | i-C₃F₇ | CF₃ | t-Bu | 6-Cl | H | i-C₃F₇ | CF₃ |
| Me | 6-Me | H | Et | CF₃ | Me | 6-Cl | H | Et | CF₃ |
| Et | 6-Me | H | Et | CF₃ | Et | 6-Cl | H | Et | CF₃ |
| i-Pr | 6-Me | H | Et | CF₃ | i-Pr | 6-Cl | H | Et | CF₃ |
| t-Bu | 6-Me | H | Et | CF₃ | t-Bu | 6-Cl | H | Et | CF₃ |
| Me | 6-Me | Cl | CHF₂ | F | Me | 6-Cl | Cl | CHF₂ | F |
| Et | 6-Me | Cl | CHF₂ | F | Et | 6-Cl | Cl | CHF₂ | F |
| i-Pr | 6-Me | Cl | CHF₂ | F | i-Pr | 6-Cl | Cl | CHF₂ | F |
| t-Bu | 6-Me | Cl | CHF₂ | F | t-Bu | 6-Cl | Cl | CHF₂ | F |
| Me | 6-Me | Cl | n-Pr | F | Me | 6-Cl | Cl | n-Pr | F |
| Et | 6-Me | Cl | n-Pr | F | Et | 6-Cl | Cl | n-Pr | F |
| i-Pr | 6-Me | Cl | n-Pr | F | i-Pr | 6-Cl | Cl | n-Pr | F |
| t-Bu | 6-Me | Cl | n-Pr | F | t-Bu | 6-Cl | Cl | n-Pr | F |
| Me | 6-Me | Cl | CF₃ | F | Me | 6-Cl | Cl | CF₃ | F |
| Et | 6-Me | Cl | CF₃ | F | Et | 6-Cl | Cl | CF₃ | F |
| i-Pr | 6-Me | Cl | CF₃ | F | i-Pr | 6-Cl | Cl | CF₃ | F |
| t-Bu | 6-Me | Cl | CF₃ | F | t-Bu | 6-Cl | Cl | CF₃ | F |
| Me | 6-Me | Cl | i-Pr | F | Me | 6-Cl | Cl | i-Pr | F |
| Et | 6-Me | Cl | i-Pr | F | Et | 6-Cl | Cl | i-Pr | F |
| i-Pr | 6-Me | Cl | i-Pr | F | i-Pr | 6-Cl | Cl | i-Pr | F |
| t-Bu | 6-Me | Cl | i-Pr | F | t-Bu | 6-Cl | Cl | i-Pr | F |
| Me | 6-Me | Cl | C₂F₅ | F | Me | 6-Cl | Cl | C₂F₅ | F |
| Et | 6-Me | Cl | C₂F₅ | F | Et | 6-Cl | Cl | C₂F₅ | F |
| i-Pr | 6-Me | Cl | C₂F₅ | F | i-Pr | 6-Cl | Cl | C₂F₅ | F |
| t-Bu | 6-Me | Cl | C₂F₅ | F | t-Bu | 6-Cl | Cl | C₂F₅ | F |
| Me | 6-Me | Cl | n-C₃F₇ | F | Me | 6-Cl | Cl | n-C₃F₇ | F |
| Et | 6-Me | Cl | n-C₃F₇ | F | Et | 6-Cl | Cl | n-C₃F₇ | F |
| i-Pr | 6-Me | Cl | n-C₃F₇ | F | i-Pr | 6-Cl | Cl | n-C₃F₇ | F |
| t-Bu | 6-Me | Cl | n-C₃F₇ | F | t-Bu | 6-Cl | Cl | n-C₃F₇ | F |
| Me | 6-Me | Cl | i-C₃F₇ | F | Me | 6-Cl | Cl | i-C₃F₇ | F |
| Et | 6-Me | Cl | i-C₃F₇ | F | Et | 6-Cl | Cl | i-C₃F₇ | F |
| i-Pr | 6-Me | Cl | i-C₃F₇ | F | i-Pr | 6-Cl | Cl | i-C₃F₇ | F |
| t-Bu | 6-Me | Cl | i-C₃F₇ | F | t-Bu | 6-Cl | Cl | i-C₃F₇ | F |
| Me | 6-Me | Cl | Et | F | Me | 6-Cl | Cl | Et | F |
| Et | 6-Me | Cl | Et | F | Et | 6-Cl | Cl | Et | F |
| i-Pr | 6-Me | Cl | Et | F | i-Pr | 6-Cl | Cl | Et | F |
| t-Bu | 6-Me | Cl | Et | F | t-Bu | 6-Cl | Cl | Et | F |
| Me | 6-Me | Cl | CHF₂ | Cl | Me | 6-Cl | Cl | CHF₂ | Cl |
| Et | 6-Me | Cl | CHF₂ | Cl | Et | 6-Cl | Cl | CHF₂ | Cl |
| i-Pr | 6-Me | Cl | CHF₂ | Cl | i-Pr | 6-Cl | Cl | CHF₂ | Cl |
| t-Bu | 6-Me | Cl | CHF₂ | Cl | t-Bu | 6-Cl | Cl | CHF₂ | Cl |
| Me | 6-Me | Cl | n-Pr | Cl | Me | 6-Cl | Cl | n-Pr | Cl |
| Et | 6-Me | Cl | n-Pr | Cl | Et | 6-Cl | Cl | n-Pr | Cl |
| i-Pr | 6-Me | Cl | n-Pr | Cl | i-Pr | 6-Cl | Cl | n-Pr | Cl |
| t-Bu | 6-Me | Cl | n-Pr | Cl | t-Bu | 6-Cl | Cl | n-Pr | Cl |
| Me | 6-Me | Cl | CF₃ | Cl | Me | 6-Cl | Cl | CF₃ | Cl |
| Et | 6-Me | Cl | CF₃ | Cl | Et | 6-Cl | Cl | CF₃ | Cl |
| i-Pr | 6-Me | Cl | CF₃ | Cl | i-Pr | 6-Cl | Cl | CF₃ | Cl |
| t-Bu | 6-Me | Cl | CF₃ | Cl | t-Bu | 6-Cl | Cl | CF₃ | Cl |
| Me | 6-Me | Cl | i-Pr | Cl | Me | 6-Cl | Cl | i-Pr | Cl |
| Et | 6-Me | Cl | i-Pr | Cl | Et | 6-Cl | Cl | i-Pr | Cl |
| i-Pr | 6-Me | Cl | i-Pr | Cl | i-Pr | 6-Cl | Cl | i-Pr | Cl |
| t-Bu | 6-Me | Cl | i-Pr | Cl | t-Bu | 6-Cl | Cl | i-Pr | Cl |
| Me | 6-Me | Cl | C₂F₅ | Cl | Me | 6-Cl | Cl | C₂F₅ | Cl |
| Et | 6-Me | Cl | C₂F₅ | Cl | Et | 6-Cl | Cl | C₂F₅ | Cl |
| i-Pr | 6-Me | Cl | C₂F₅ | Cl | i-Pr | 6-Cl | Cl | C₂F₅ | Cl |
| t-Bu | 6-Me | Cl | C₂F₅ | Cl | t-Bu | 6-Cl | Cl | C₂F₅ | Cl |
| Me | 6-Me | Cl | n-C₃F₇ | Cl | Me | 6-Cl | Cl | n-C₃F₇ | Cl |
| Et | 6-Me | Cl | n-C₃F₇ | Cl | Et | 6-Cl | Cl | n-C₃F₇ | Cl |
| i-Pr | 6-Me | Cl | n-C₃F₇ | Cl | i-Pr | 6-Cl | Cl | n-C₃F₇ | Cl |
| t-Bu | 6-Me | Cl | n-C₃F₇ | Cl | t-Bu | 6-Cl | Cl | n-C₃F₇ | Cl |
| Me | 6-Me | Cl | i-C₃F₇ | Cl | Me | 6-Cl | Cl | i-C₃F₇ | Cl |
| Et | 6-Me | Cl | i-C₃F₇ | Cl | Et | 6-Cl | Cl | i-C₃F₇ | Cl |
| i-Pr | 6-Me | Cl | i-C₃F₇ | Cl | i-Pr | 6-Cl | Cl | i-C₃F₇ | Cl |
| t-Bu | 6-Me | Cl | i-C₃F₇ | Cl | t-Bu | 6-Cl | Cl | i-C₃F₇ | Cl |
| Me | 6-Me | Cl | Et | Cl | Me | 6-Cl | Cl | Et | Cl |
| Et | 6-Me | Cl | Et | Cl | Et | 6-Cl | Cl | Et | Cl |
| i-Pr | 6-Me | Cl | Et | Cl | i-Pr | 6-Cl | Cl | Et | Cl |
| t-Bu | 6-Me | Cl | Et | Cl | t-Bu | 6-Cl | Cl | Et | Cl |
| Me | 6-Me | Cl | CHF₂ | Br | Me | 6-Cl | Cl | CHF₂ | Br |
| Et | 6-Me | Cl | CHF₂ | Br | Et | 6-Cl | Cl | CHF₂ | Br |
| i-Pr | 6-Me | Cl | CHF₂ | Br | i-Pr | 6-Cl | Cl | CHF₂ | Br |
| t-Bu | 6-Me | Cl | CHF₂ | Br | t-Bu | 6-Cl | Cl | CHF₂ | Br |
| Me | 6-Me | Cl | n-Pr | Br | Me | 6-Cl | Cl | n-Pr | Br |
| Et | 6-Me | Cl | n-Pr | Br | Et | 6-Cl | Cl | n-Pr | Br |
| i-Pr | 6-Me | Cl | n-Pr | Br | i-Pr | 6-Cl | Cl | n-Pr | Br |
| t-Bu | 6-Me | Cl | n-Pr | Br | t-Bu | 6-Cl | Cl | n-Pr | Br |
| Me | 6-Me | Cl | CF₃ | Br | Me | 6-Cl | Cl | CF₃ | Br |
| Et | 6-Me | Cl | CF₃ | Br | Et | 6-Cl | Cl | CF₃ | Br |
| i-Pr | 6-Me | Cl | CF₃ | Br | i-Pr | 6-Cl | Cl | CF₃ | Br |
| t-Bu | 6-Me | Cl | CF₃ | Br | t-Bu | 6-Cl | Cl | CF₃ | Br |
| Me | 6-Me | Cl | i-Pr | Br | Me | 6-Cl | Cl | i-Pr | Br |
| Et | 6-Me | Cl | i-Pr | Br | Et | 6-Cl | Cl | i-Pr | Br |
| i-Pr | 6-Me | Cl | i-Pr | Br | i-Pr | 6-Cl | Cl | i-Pr | Br |
| t-Bu | 6-Me | Cl | i-Pr | Br | t-Bu | 6-Cl | Cl | i-Pr | Br |
| Me | 6-Me | Cl | C₂F₅ | Br | Me | 6-Cl | Cl | C₂F₅ | Br |
| Et | 6-Me | Cl | C₂F₅ | Br | Et | 6-Cl | Cl | C₂F₅ | Br |
| i-Pr | 6-Me | Cl | C₂F₅ | Br | i-Pr | 6-Cl | Cl | C₂F₅ | Br |
| t-Bu | 6-Me | Cl | C₂F₅ | Br | t-Bu | 6-Cl | Cl | C₂F₅ | Br |
| Me | 6-Me | Cl | n-C₃F₇ | Br | Me | 6-Cl | Cl | n-C₃F₇ | Br |
| Et | 6-Me | Cl | n-C₃F₇ | Br | Et | 6-Cl | Cl | n-C₃F₇ | Br |
| i-Pr | 6-Me | Cl | n-C₃F₇ | Br | i-Pr | 6-Cl | Cl | n-C₃F₇ | Br |
| t-Bu | 6-Me | Cl | n-C₃F₇ | Br | t-Bu | 6-Cl | Cl | n-C₃F₇ | Br |
| Me | 6-Me | Cl | i-C₃F₇ | Br | Me | 6-Cl | Cl | i-C₃F₇ | Br |
| Et | 6-Me | Cl | i-C₃F₇ | Br | Et | 6-Cl | Cl | i-C₃F₇ | Br |
| i-Pr | 6-Me | Cl | i-C₃F₇ | Br | i-Pr | 6-Cl | Cl | i-C₃F₇ | Br |
| t-Bu | 6-Me | Cl | i-C₃F₇ | Br | t-Bu | 6-Cl | Cl | i-C₃F₇ | Br |
| Me | 6-Me | Cl | Et | Br | Me | 6-Cl | Cl | Et | Br |
| Et | 6-Me | Cl | Et | Br | Et | 6-Cl | Cl | Et | Br |
| i-Pr | 6-Me | Cl | Et | Br | i-Pr | 6-Cl | Cl | Et | Br |
| t-Bu | 6-Me | Cl | Et | Br | t-Bu | 6-Cl | Cl | Et | Br |
| Me | 6-Me | Cl | CHF₂ | CF₃ | Me | 6-Cl | Cl | CHF₂ | CF₃ |
| Et | 6-Me | Cl | CHF₂ | CF₃ | Et | 6-Cl | Cl | CHF₂ | CF₃ |
| i-Pr | 6-Me | Cl | CHF₂ | CF₃ | i-Pr | 6-Cl | Cl | CHF₂ | CF₃ |
| t-Bu | 6-Me | Cl | CHF₂ | CF₃ | t-Bu | 6-Cl | Cl | CHF₂ | CF₃ |
| Me | 6-Me | Cl | n-Pr | CF₃ | Me | 6-Cl | Cl | n-Pr | CF₃ |
| Et | 6-Me | Cl | n-Pr | CF₃ | Et | 6-Cl | Cl | n-Pr | CF₃ |
| i-Pr | 6-Me | Cl | n-Pr | CF₃ | i-Pr | 6-Cl | Cl | n-Pr | CF₃ |
| t-Bu | 6-Me | Cl | n-Pr | CF₃ | t-Bu | 6-Cl | Cl | n-Pr | CF₃ |
| Me | 6-Me | Cl | CF₃ | CF₃ | Me | 6-Cl | Cl | CF₃ | CF₃ |
| Et | 6-Me | Cl | CF₃ | CF₃ | Et | 6-Cl | Cl | CF₃ | CF₃ |
| i-Pr | 6-Me | Cl | CF₃ | CF₃ | i-Pr | 6-Cl | Cl | CF₃ | CF₃ |
| t-Bu | 6-Me | Cl | CF₃ | CF₃ | t-Bu | 6-Cl | Cl | CF₃ | CF₃ |
| Me | 6-Me | Cl | i-Pr | CF₃ | Me | 6-Cl | Cl | i-Pr | CF₃ |
| Et | 6-Me | Cl | i-Pr | CF₃ | Et | 6-Cl | Cl | i-Pr | CF₃ |
| i-Pr | 6-Me | Cl | i-Pr | CF₃ | i-Pr | 6-Cl | Cl | i-Pr | CF₃ |
| t-Bu | 6-Me | Cl | i-Pr | CF₃ | t-Bu | 6-Cl | Cl | i-Pr | CF₃ |
| Me | 6-Me | Cl | C₂F₅ | CF₃ | Me | 6-Cl | Cl | C₂F₅ | CF₃ |
| Et | 6-Me | Cl | C₂F₅ | CF₃ | Et | 6-Cl | Cl | C₂F₅ | CF₃ |
| i-Pr | 6-Me | Cl | C₂F₅ | CF₃ | i-Pr | 6-Cl | Cl | C₂F₅ | CF₃ |
| t-Bu | 6-Me | Cl | C₂F₅ | CF₃ | t-Bu | 6-Cl | Cl | C₂F₅ | CF₃ |
| Me | 6-Me | Cl | n-C₃F₇ | CF₃ | Me | 6-Cl | Cl | n-C₃F₇ | CF₃ |
| Et | 6-Me | Cl | n-C₃F₇ | CF₃ | Et | 6-Cl | Cl | n-C₃F₇ | CF₃ |
| i-Pr | 6-Me | Cl | n-C₃F₇ | CF₃ | i-Pr | 6-Cl | Cl | n-C₃F₇ | CF₃ |
| t-Bu | 6-Me | Cl | n-C₃F₇ | CF₃ | t-Bu | 6-Cl | Cl | n-C₃F₇ | CF₃ |
| Me | 6-Me | Cl | i-C₃F₇ | CF₃ | Me | 6-Cl | Cl | i-C₃F₇ | CF₃ |
| Et | 6-Me | Cl | i-C₃F₇ | CF₃ | Et | 6-Cl | Cl | i-C₃F₇ | CF₃ |
| i-Pr | 6-Me | Cl | i-C₃F₇ | CF₃ | i-Pr | 6-Cl | Cl | i-C₃F₇ | CF₃ |
| t-Bu | 6-Me | Cl | i-C₃F₇ | CF₃ | t-Bu | 6-Cl | Cl | i-C₃F₇ | CF₃ |
| Me | 6-Me | Cl | Et | CF₃ | Me | 6-Cl | Cl | Et | CF₃ |
| Et | 6-Me | Cl | Et | CF₃ | Et | 6-Cl | Cl | Et | CF₃ |
| i-Pr | 6-Me | Cl | Et | CF₃ | i-Pr | 6-Cl | Cl | Et | CF₃ |
| t-Bu | 6-Me | Cl | Et | CF₃ | t-Bu | 6-Cl | Cl | Et | CF₃ |

TABLE 12

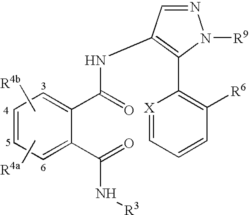

| R³ | R^{4a} | R^{4b} | R⁹ | R⁶ | X | R³ | R^{4a} | R^{4b} | R⁹ | R⁶ | X |
|---|---|---|---|---|---|---|---|---|---|---|---|
| Me | 6-Me | H | CHF₂ | F | CH | Me | 6-Cl | H | CHF₂ | F | CH |
| Et | 6-Me | H | CHF₂ | F | CH | Et | 6-Cl | H | CHF₂ | F | CH |
| i-Pr | 6-Me | H | CHF₂ | F | CH | i-Pr | 6-Cl | H | CHF₂ | F | CH |
| t-Bu | 6-Me | H | CHF₂ | F | CH | t-Bu | 6-Cl | H | CHF₂ | F | CH |
| Me | 6-Me | H | n-Pr | F | CH | Me | 6-Cl | H | n-Pr | F | CH |
| Et | 6-Me | H | n-Pr | F | CH | Et | 6-Cl | H | n-Pr | F | CH |
| i-Pr | 6-Me | H | n-Pr | F | CH | i-Pr | 6-Cl | H | n-Pr | F | CH |
| t-Bu | 6-Me | H | n-Pr | F | CH | t-Bu | 6-Cl | H | n-Pr | F | CH |
| Me | 6-Me | H | CF₃ | F | CH | Me | 6-Cl | H | CF₃ | F | CH |
| Et | 6-Me | H | CF₃ | F | CH | Et | 6-Cl | H | CF₃ | F | CH |
| i-Pr | 6-Me | H | CF₃F | CH | i-Pr | 6-Cl | H | CF₃ | F | CH | |
| t-Bu | 6-Me | H | CF₃F | CH | t-Bu | 6-Cl | H | CF₃ | F | CH | |
| Me | 6-Me | H | i-Pr | F | CH | Me | 6-Cl | H | i-Pr | F | CH |
| Et | 6-Me | H | i-Pr | F | CH | Et | 6-Cl | H | i-Pr | F | CH |
| i-Pr | 6-Me | H | i-Pr | F | CH | i-Pr | 6-Cl | H | i-Pr | F | CH |
| t-Bu | 6-Me | H | i-Pr | F | CH | t-Bu | 6-Cl | H | i-Pr | F | CH |
| Me | 6-Me | H | C₂F₅ | F | CH | Me | 6-Cl | H | C₂F₅ | F | CH |
| Et | 6-Me | H | C₂F₅ | F | CH | Et | 6-Cl | H | C₂F₅ | F | CH |
| i-Pr | 6-Me | H | C₂F₅ | F | CH | i-Pr | 6-Cl | H | C₂F₅ | F | CH |
| t-Bu | 6-Me | H | C₂F₅ | F | CH | t-Bu | 6-Cl | H | C₂F₅ | F | CH |
| Me | 6-Me | H | n-C₃F₇ | F | CH | Me | 6-Cl | H | n-C₃F₇ | F | CH |
| Et | 6-Me | H | n-C₃F₇ | F | CH | Et | 6-Cl | H | n-C₃F₇ | F | CH |
| i-Pr | 6-Me | H | n-C₃F₇ | F | CH | i-Pr | 6-Cl | H | n-C₃F₇ | F | CH |
| t-Bu | 6-Me | H | n-C₃F₇ | F | CH | t-Bu | 6-Cl | H | n-C₃F₇ | F | CH |
| Me | 6-Me | H | i-C₃F₇ | F | CH | Me | 6-Cl | H | i-C₃F₇ | F | CH |
| Et | 6-Me | H | i-C₃F₇ | F | CH | Et | 6-Cl | H | i-C₃F₇ | F | CH |
| i-Pr | 6-Me | H | i-C₃F₇ | F | CH | i-Pr | 6-Cl | H | i-C₃F₇ | F | CH |
| t-Bu | 6-Me | H | i-C₃F₇ | F | CH | t-Bu | 6-Cl | H | i-C₃F₇ | F | CH |
| Me | 6-Me | H | Et | F | CH | Me | 6-Cl | H | Et | F | CH |
| Et | 6-Me | H | Et | F | CH | Et | 6-Cl | H | Et | F | CH |
| i-Pr | 6-Me | H | Et | F | CH | i-Pr | 6-Cl | H | Et | F | CH |
| t-Bu | 6-Me | H | Et | F | CH | t-Bu | 6-Cl | H | Et | F | CH |
| Me | 6-Me | H | CHF₂ | Cl | CH | Me | 6-Cl | H | CHF₂ | Cl | CH |
| Et | 6-Me | H | CHF₂ | Cl | CH | Et | 6-Cl | H | CHF₂ | Cl | CH |
| i-Pr | 6-Me | CHF₂ | Cl | CH | i-Pr | 6-Cl | H | CHF₂ | Cl | CH | |
| t-Bu | 6-Me | H | CHF₂ | Cl | CH | t-Bu | 6-Cl | H | CHF₂ | Cl | CH |
| Me | 6-Me | H | n-Pr | Cl | CH | Me | 6-Cl | H | n-Pr | Cl | CH |
| Et | 6-Me | H | n-Pr | Cl | CH | Et | 6-Cl | H | n-Pr | Cl | CH |
| i-Pr | 6-Me | H | n-Pr | Cl | CH | i-Pr | 6-Cl | H | n-Pr | Cl | CH |
| t-Bu | 6-Me | H | n-Pr | Cl | CH | t-Bu | 6-Cl | H | n-Pr | Cl | CH |
| Me | 6-Me | H | CF₃Cl | CH | Me | 6-Cl | H | CF₃ | Cl | CH | |
| Et | 6-Me | H | CF₃Cl | CH | Et | 6-Cl | H | CF₃ | Cl | CH | |
| i-Pr | 6-Me | H | CF₃ | Cl | CH | i-Pr | 6-Cl | H | CF₃ | Cl | CH |
| t-Bu | 6-Me | H | CF₃ | Cl | CH | t-Bu | 6-Cl | H | CF₃ | Cl | CH |
| Me | 6-Me | H | i-Pr | Cl | CH | Me | 6-Cl | H | i-Pr | Cl | CH |
| Et | 6-Me | H | i-Pr | Cl | CH | Et | 6-Cl | H | i-Pr | Cl | CH |
| i-Pr | 6-Me | H | i-Pr | Cl | CH | i-Pr | 6-Cl | H | i-Pr | Cl | CH |
| t-Bu | 6-Me | H | i-Pr | Cl | CH | t-Bu | 6-Cl | H | i-Pr | Cl | CH |
| Me | 6-Me | H | C₂F₅Cl | CH | Me | 6-Cl | H | C₂F₅ | Cl | CH | |
| Et | 6-Me | H | C₂F₅ | Cl | CH | Et | 6-Cl | H | C₂F₅ | Cl | CH |
| i-Pr | 6-Me | H | C₂F₅ | Cl | CH | i-Pr | 6-Cl | H | C₂F₅ | Cl | CH |
| t-Bu | 6-Me | H | C₂F₅ | Cl | CH | t-Bu | 6-Cl | H | C₂F₅ | Cl | CH |
| Me | 6-Me | H | n-C₃F₇ | Cl | CH | Me | 6-Cl | H | n-C₃F₇ | Cl | CH |
| Et | 6-Me | H | n-C₃F₇ | Cl | CH | Et | 6-Cl | H | n-C₃F₇ | Cl | CH |
| i-Pr | 6-Me | H | n-C₃F₇ | Cl | CH | i-Pr | 6-Cl | H | n-C₃F₇ | Cl | CH |
| t-Bu | 6-Me | H | n-C₃F₇ | Cl | CH | t-Bu | 6-Cl | H | n-C₃F₇ | Cl | CH |
| Me | 6-Me | H | i-C₃F₇ | Cl | CH | Me | 6-Cl | H | i-C₃F₇ | Cl | CH |
| Et | 6-Me | H | i-C₃F₇ | Cl | CH | Et | 6-Cl | H | i-C₃F₇ | Cl | CH |
| i-Pr | 6-Me | H | i-C₃F₇ | Cl | CH | i-Pr | 6-Cl | H | i-C₃F₇ | Cl | CH |
| t-Bu | 6-Me | H | i-C₃F₇ | Cl | CH | t-Bu | 6-Cl | H | i-C₃F₇ | Cl | CH |
| Me | 6-Me | H | Et | Cl | CH | Me | 6-Cl | H | Et | Cl | CH |
| Et | 6-Me | H | Et | Cl | CH | Et | 6-Cl | H | Et | Cl | CH |
| i-Pr | 6-Me | H | Et | Cl | CH | i-Pr | 6-Cl | H | Et | Cl | CH |
| t-Bu | 6-Me | H | Et | Cl | CH | t-Bu | 6-Cl | H | Et | Cl | CH |
| Me | 6-Me | H | CHF₂ | Br | CH | Me | 6-Cl | H | CHF₂ | Br | CH |
| Et | 6-Me | H | CHF₂ | Br | CH | Et | 6-Cl | H | CHF₂ | Br | CH |
| i-Pr | 6-Me | H | CHF₂ | Br | CH | i-Pr | 6-Cl | H | CHF₂ | Br | CH |
| t-Bu | 6-Me | H | CHF₂ | Br | CH | t-Bu | 6-Cl | H | CHF₂ | Br | CH |
| Me | 6-Me | H | n-Pr | Br | CH | Me | 6-Cl | H | n-Pr | Br | CH |
| Et | 6-Me | H | n-Pr | Br | CH | Et | 6-Cl | H | n-Pr | Br | CH |
| i-Pr | 6-Me | H | n-Pr Br | CH | i-Pr | 6-Cl | H | n-Pr | Br | CH | |
| t-Bu | 6-Me | H | n-Pr Br | CH | t-Bu | 6-Cl | H | n-Pr | Br | CH | |
| Me | 6-Me | H | CF₃ | Br | CH | Me | 6-Cl | H | CF₃ | Br | CH |
| Et | 6-Me | H | CF₃ | Br | CH | Et | 6-Cl | H | CF₃ | Br | CH |
| i-Pr | 6-Me | H | CF₃ | Br | CH | i-Pr | 6-Cl | H | CF₃ | Br | CH |
| t-Bu | 6-Me | H | CF₃ | Br | CH | t-Bu | 6-Cl | H | CF₃ | Br | CH |
| Me | 6-Me | H | i-Pr | Br | CH | Me | 6-Cl | H | i-Pr | Br | CH |
| Et | 6-Me | H | i-Pr | Br | CH | Et | 6-Cl | H | i-Pr | Br | CH |
| i-Pr | 6-Me | H | i-Pr | Br | CH | i-Pr | 6-Cl | H | i-Pr | Br | CH |
| t-Bu | 6-Me | H | i-Pr | Br | CH | t-Bu | 6-Cl | H | i-Pr | Br | CH |
| Me | 6-Me | H | C₂F₅ | Br | CH | Me | 6-Cl | H | C₂F₅ | Br | CH |
| Et | 6-Me | H | C₂F₅ | Br | CH | Et | 6-Cl | H | C₂F₅ | Br | CH |
| i-Pr | 6-Me | H | C₂F₅ | Br | CH | i-Pr | 6-Cl | H | C₂F₅ | Br | CH |
| t-Bu | 6-Me | H | C₂F₅ | Br | CH | t-Bu | 6-Cl | H | C₂F₅ | Br | CH |
| Me | 6-Me | H | n-C₃F₇ | Br | CH | Me | 6-Cl | H | n-C₃F₇ | Br | CH |
| Et | 6-Me | H | n-C₃F₇ | Br | CH | Et | 6-Cl | H | n-C₃F₇ | Br | CH |
| i-Pr | 6-Me | H | n-C₃F₇ | Br | CH | i-Pr | 6-Cl | H | n-C₃F₇ | Br | CH |
| t-Bu | 6-Me | H | n-C₃F₇ | Br | CH | t-Bu | 6-Cl | H | n-C₃F₇ | Br | CH |
| Me | 6-Me | H | i-C₃F₇ | Br | CH | Me | 6-Cl | H | i-C₃F₇ | Br | CH |
| Et | 6-Me | H | i-C₃F₇ | Br | CH | Et | 6-Cl | H | i-C₃F₇ | Br | CH |
| i-Pr | 6-Me | H | i-C₃F₇ | Br | CH | i-Pr | 6-Cl | H | i-C₃F₇ | Br | CH |
| t-Bu | 6-Me | H | i-C₃F₇ | Br | CH | t-Bu | 6-Cl | H | i-C₃F₇ | Br | CH |
| Me | 6-Me | H | Et | Br | CH | Me | 6-Cl | H | Et | Br | CH |
| Et | 6-Me | H | Et | Br | CH | Et | 6-Cl | H | Et | Br | CH |
| i-Pr | 6-Me | H | Et | Br | CH | i-Pr | 6-Cl | H | Et | Br | CH |
| t-Bu | 6-Me | H | Et | Br | CH | t-Bu | 6-Cl | H | Et | Br | CH |
| Me | 6-Me | H | CHF₂ | CF₃ | CH | Me | 6-Cl | H | CHF₂ | CF₃ | CH |
| Et | 6-Me | H | CHF₂ | CF₃ | CH | Et | 6-Cl | H | CHF₂ | CF₃ | CH |
| i-Pr | 6-Me | H | CHF₂ | CF₃ | CH | i-Pr | 6-Cl | H | CHF₂ | CF₃ | CH |
| t-Bu | 6-Me | H | CHF₂ | CF₃ | CH | t-Bu | 6-Cl | H | CHF₂ | CF₃ | CH |
| Me | 6-Me | H | n-Pr | CF₃ | CH | Me | 6-Cl | H | n-Pr | CF₃ | CH |
| Et | 6-Me | H | n-Pr | CF₃ | CH | Et | 6-Cl | H | n-Pr | CF₃ | CH |
| i-Pr | 6-Me | H | n-Pr | CF₃ | CH | i-Pr | 6-Cl | H | n-Pr | CF₃ | CH |
| t-Bu | 6-Me | H | n-Pr | CF₃ | CH | t-Bu | 6-Cl | H | n-Pr | CF₃ | CH |
| Me | 6-Me | H | CF₃ | CF₃ | CH | Me | 6-Cl | H | CF₃ | CF₃ | CH |
| Et | 6-Me | H | CF₃ | CF₃ | CH | Et | 6-Cl | H | CF₃ | CF₃ | CH |
| i-Pr | 6-Me | H | CF₃ | CF₃ | CH | i-Pr | 6-Cl | H | CF₃ | CF₃ | CH |
| t-Bu | 6-Me | H | CF₃ | CF₃ | CH | t-Bu | 6-Cl | H | CF₃ | CF₃ | CH |
| Me | 6-Me | H | i-Pr | CF₃ | CH | Me | 6-Cl | H | i-Pr | CF₃ | CH |
| Et | 6-Me | H | i-Pr | CF₃ | CH | Et | 6-Cl | H | i-Pr | CF₃ | CH |
| i-Pr | 6-Me | H | i-Pr | CF₃ | CH | i-Pr | 6-Cl | H | i-Pr | CF₃ | CH |
| t-Bu | 6-Me | H | i-Pr | CF₃ | CH | t-Bu | 6-Cl | H | i-Pr | CF₃ | CH |
| Me | 6-Me | H | C₂F₅ | CF₃ | CH | Me | 6-Cl | H | C₂F₅ | CF₃ | CH |
| Et | 6-Me | H | C₂F₅ | CF₃ | CH | Et | 6-Cl | H | C₂F₅ | CF₃ | CH |
| i-Pr | 6-Me | H | C₂F₅ | CF₃ | CH | i-Pr | 6-Cl | H | C₂F₅ | CF₃ | CH |
| t-Bu | 6-Me | H | C₂F₅ | CF₃ | CH | t-Bu | 6-Cl | H | C₂F₅ | CF₃ | CH |
| Me | 6-Me | H | n-C₃F₇ | CF₃ | CH | Me | 6-Cl | H | n-C₃F₇ | CF₃ | CH |
| Et | 6-Me | H | n-C₃F₇ | CF₃ | CH | Et | 6-Cl | H | n-C₃F₇ | CF₃ | CH |
| i-Pr | 6-Me | H | n-C₃F₇ | CF₃ | CH | i-Pr | 6-Cl | H | n-C₃F₇ | CF₃ | CH |
| t-Bu | 6-Me | H | n-C₃F₇ | CF₃ | CH | t-Bu | 6-Cl | H | n-C₃F₇ | CF₃ | CH |
| Me | 6-Me | H | i-C₃F₇ | CF₃ | CH | Me | 6-Cl | H | i-C₃F₇ | CF₃ | CH |
| Et | 6-Me | H | i-C₃F₇ | CF₃ | CH | Et | 6-Cl | H | i-C₃F₇ | CF₃ | CH |
| i-Pr | 6-Me | H | i-C₃F₇ | CF₃ | CH | i-Pr | 6-Cl | H | i-C₃F₇ | CF₃ | CH |
| t-Bu | 6-Me | H | i-C₃F₇ | CF₃ | CH | t-Bu | 6-Cl | H | i-C₃F₇ | CF₃ | CH |
| Me | 6-Me | H | Et | CF₃ | CH | Me | 6-Cl | H | Et | CF₃ | CH |
| Et | 6-Me | H | Et | CF₃ | CH | Et | 6-Cl | H | Et | CF₃ | CH |
| i-Pr | 6-Me | H | Et | CF₃ | CH | i-Pr | 6-Cl | H | Et | CF₃ | CH |
| t-Bu | 6-Me | H | Et | CF₃ | CH | t-Bu | 6-Cl | H | Et | CF₃ | CH |
| Me | 6-Me | Cl | CHF₂ | F | CH | Me | 6-Cl | Cl | CHF₂ | F | CH |
| Et | 6-Me | Cl | CHF₂ | F | CH | Et | 6-Cl | Cl | CHF₂ | F | CH |
| i-Pr | 6-Me | Cl | CHF₂ | F | CH | i-Pr | 6-Cl | Cl | CHF₂ | F | CH |
| t-Bu | 6-Me | Cl | CHF₂ | F | CH | t-Bu | 6-Cl | Cl | CHF₂ | F | CH |
| Me | 6-Me | Cl | n-Pr | F | CH | Me | 6-Cl | Cl | n-Pr | F | CH |
| Et | 6-Me | Cl | n-Pr | F | CH | Et | 6-Cl | Cl | n-Pr | F | CH |
| i-Pr | 6-Me | Cl | n-Pr | F | CH | i-Pr | 6-Cl | Cl | n-Pr | F | CH |
| t-Bu | 6-Me | Cl | n-Pr | F | CH | t-Bu | 6-Cl | Cl | n-Pr | F | CH |
| Me | 6-Me | Cl | CF₃ | F | CH | Me | 6-Cl | Cl | CF₃ | F | CH |
| Et | 6-Me | Cl | CF₃ | F | CH | Et | 6-Cl | Cl | CF₃ | F | CH |
| i-Pr | 6-Me | Cl | CF₃F | CH | i-Pr | 6-Cl | Cl | CF₃ | F | CH | |
| t-Bu | 6-Me | Cl | CF₃F | CH | t-Bu | 6-Cl | Cl | CF₃ | F | CH | |
| Me | 6-Me | Cl | i-Pr | F | CH | Me | 6-Cl | Cl | i-Pr | F | CH |
| Et | 6-Me | Cl | i-Pr | F | CH | Et | 6-Cl | Cl | i-Pr | F | CH |
| i-Pr | 6-Me | Cl | i-Pr | F | CH | i-Pr | 6-Cl | Cl | i-Pr | F | CH |
| t-Bu | 6-Me | Cl | i-Pr | F | CH | t-Bu | 6-Cl | Cl | i-Pr | F | CH |
| Me | 6-Me | Cl | C₂F₅ | F | CH | Me | 6-Cl | Cl | C₂F₅ | F | CH |
| Et | 6-Me | Cl | C₂F₅ | F | CH | Et | 6-Cl | Cl | C₂F₅ | F | CH |
| i-Pr | 6-Me | Cl | C₂F₅ | F | CH | i-Pr | 6-Cl | Cl | C₂F₅ | F | CH |
| t-Bu | 6-Me | Cl | C₂F₅ | F | CH | t-Bu | 6-Cl | Cl | C₂F₅ | F | CH |
| Me | 6-Me | Cl | n-C₃F₇ | F | CH | Me | 6-Cl | Cl | n-C₃F₇ | F | CH |
| Et | 6-Me | Cl | n-C₃F₇ | F | CH | Et | 6-Cl | Cl | n-C₃F₇ | F | CH |
| i-Pr | 6-Me | Cl | n-C₃F₇ | F | CH | i-Pr | 6-Cl | Cl | n-C₃F₇ | F | CH |
| t-Bu | 6-Me | Cl | n-C₃F₇ | F | CH | t-Bu | 6-Cl | Cl | n-C₃F₇ | F | CH |
| Me | 6-Me | Cl | i-C₃F₇ | F | CH | Me | 6-Cl | Cl | i-C₃F₇ | F | CH |
| Et | 6-Me | Cl | i-C₃F₇ | F | CH | Et | 6-Cl | Cl | i-C₃F₇ | F | CH |
| i-Pr | 6-Me | Cl | i-C₃F₇ | F | CH | i-Pr | 6-Cl | Cl | i-C₃F₇ | F | CH |
| t-Bu | 6-Me | Cl | i-C₃F₇ | F | CH | t-Bu | 6-Cl | Cl | i-C₃F₇ | F | CH |
| Me | 6-Me | Cl | Et | F | CH | Me | 6-Cl | Cl | Et | F | CH |
| Et | 6-Me | Cl | Et | FCH | Et | 6-Cl | Cl | Et | F | CH | |
| i-Pr | 6-Me | Cl | Et | F | CH | i-Pr | 6-Cl | Cl | Et | F | CH |
| t-Bu | 6-Me | Cl | Et | F | CH | t-Bu | 6-Cl | Cl | Et | F | CH |
| Me | 6-Me | Cl | CHF₂ | Cl | CH | Me | 6-Cl | Cl | CHF₂ | Cl | CH |
| Et | 6-Me | Cl | CHF₂ | Cl | CH | Et | 6-Cl | Cl | CHF₂ | Cl | CH |
| i-Pr | 6-Me | Cl | CHF₂ | Cl | CH | i-Pr | 6-Cl | Cl | CHF₂ | Cl | CH |
| t-Bu | 6-Me | Cl | CHF₂ | Cl | CH | t-Bu | 6-Cl | Cl | CHF₂ | Cl | CH |
| Me | 6-Me | Cl | n-Pr | Cl | CH | Me | 6-Cl | Cl | n-Pr | Cl | CH |
| Et | 6-Me | Cl | n-Pr | Cl | CH | Et | 6-Cl | Cl | n-Pr | Cl | CH |
| i-Pr | 6-Me | Cl | n-Pr | Cl | CH | i-Pr | 6-Cl | Cl | n-Pr | Cl | CH |
| t-Bu | 6-Me | Cl | n-Pr | Cl | CH | t-Bu | 6-Cl | Cl | n-Pr | Cl | CH |
| Me | 6-Me | Cl | CF₃ | Cl | CH | Me | 6-Cl | Cl | CF₃ | Cl | CH |
| Et | 6-Me | Cl | CF₃ | C1 | CH | Et | 6-Cl | Cl | CF₃ | Cl | CH |
| i-Pr | 6-Me | Cl | CF₃ | Cl | CH | i-Pr | 6-Cl | Cl | CF₃ | Cl | CH |
| t-Bu | 6-Me | Cl | CF₃ | Cl | CH | t-Bu | 6-Cl | Cl | CF₃ | Cl | CH |
| Me | 6-Me | Cl | i-Pr | Cl | CH | Me | 6-Cl | Cl | i-Pr | Cl | CH |
| Et | 6-Me | Cl | i-Pr | Cl | CH | Et | 6-Cl | Cl | i-Pr | Cl | CH |
| i-Pr | 6-Me | Cl | i-Pr | Cl | CH | i-Pr | 6-Cl | Cl | i-Pr | Cl | CH |
| t-Bu | 6-Me | Cl | i-Pr | Cl | CH | t-Bu | 6-Cl | Cl | i-Pr | Cl | CH |
| Me | 6-Me | Cl | C₂F₅ | Cl | CH | Me | 6-Cl | Cl | C₂F₅ | Cl | CH |
| Et | 6-Me | Cl | C₂F₅ | Cl | CH | Et | 6-Cl | Cl | C₂F₅ | Cl | CH |
| i-Pr | 6-Me | Cl | C₂F₅ | Cl | CH | i-Pr | 6-Cl | Cl | C₂F₅Cl | CH | |
| t-Bu | 6-Me | Cl | C₂F₅ | Cl | CH | t-Bu | 6-Cl | Cl | C₂F₅Cl | CH | |
| Me | 6-Me | Cl | n-C₃F₇ | Cl | CH | Me | 6-Cl | Cl | n-C₃F₇ | Cl | CH |
| Et | 6-Me | Cl | n-C₃F₇ | Cl | CH | Et | 6-Cl | Cl | n-C₃F₇ | Cl | CH |
| i-Pr | 6-Me | Cl | n-C₃F₇ | Cl | CH | i-Pr | 6-Cl | Cl | n-CF₃F₇ | Cl | CH |
| t-Bu | 6-Me | Cl | n-C₃F₇ | Cl | CH | t-Bu | 6-Cl | Cl | n-C₃F₇ | Cl | CH |
| Me | 6-Me | Cl | i-C₃F₇ | Cl | CH | Me | 6-Cl | C₃F₇ | Cl | CH | |
| Et | 6-Me | Cl | i-C₃F₇ | Cl | CH | Et | 6-Cl | C₃F₇ | Cl | CH | |
| i-Pr | 6-Me | Cl | i-C₃F₇ | Cl | CH | i-Pr | 6-Cl | Cl | i-C₃F₇ | Cl | CH |
| t-Bu | 6-Me | Cl | i-C₃F₇ | Cl | CH | t-Bu | 6-Cl | Cl | i-C₃F₇ | Cl | CH |
| Me | 6-Me | Cl | Et | Cl | CH | Me | 6-Cl | Cl | Et | Cl | CH |
| Et | 6-Me | Cl | Et | Cl | CH | Et | 6-Cl | Cl | Et | Cl | CH |
| i-Pr | 6-Me | Cl | Et | Cl | CH | i-Pr | 6-Cl | Cl | Et | Cl | CH |
| t-Bu | 6-Me | Cl | Et | Cl | CH | t-Bu | 6-Cl | Cl | Et | Cl | CH |
| Me | 6-Me | Cl | CHF₂ | Br | CH | Me | 6-Cl | Cl | CHF₂ | Br | CH |
| Et | 6-Me | Cl | CHF₂ | Br | CH | Et | 6-Cl | Cl | CHF₂ | Br | CH |
| i-Pr | 6-Me | Cl | CHF₂ | Br | CH | i-Pr | 6-Cl | Cl | CHF₂ | Br | CH |
| t-Bu | 6-Me | Cl | CHF₂ | Br | CH | t-Bu | 6-Cl | Cl | CHF₂ | Br | CH |
| Me | 6-Me | Cl | n-Pr | Br | CH | Me | 6-Cl | Cl | n-Pr | Br | CH |
| Et | 6-Me | Cl | n-Pr | Br | CH | Et | 6-Cl | Cl | n-Pr | Br | CH |
| i-Pr | 6-Me | Cl | n-Pr | Br | CH | i-Pr | 6-Cl | Cl | n-Pr | Br | CH |
| t-Bu | 6-Me | Cl | n-Pr | Br | CH | t-Bu | 6-Cl | Cl | n-Pr | Br | CH |
| Me | 6-Me | Cl | CH₃ | Br | CH | Me | 6-Cl | Cl | CF₃ | Br | CH |
| Et | 6-Me | Cl | CH₃ | Br | CH | Et | 6-Cl | Cl | CF₃ | Br | CH |
| i-Pr | 6-Me | Cl | CF₃Br | CH | i-Pr | 6-Cl | Cl | CF₃ | Br | CH | |
| t-Bu | 6-Me | Cl | CF₃Br | CH | t-Bu | 6-Cl | Cl | CF₃ | Br | CH | |
| Me | 6-Me | Cl | i-Pr | Br | CH | Me | 6-Cl | Cl | i-Pr | Br | CH |
| Et | 6-Me | Cl | i-Pr | Br | CH | Et | 6-Cl | Cl | i-Pr | Br | CH |
| i-Pr | 6-Me | Cl | i-Pr | Br | CH | i-Pr | 6-Cl | Cl | i-Pr | Br | CH |
| t-Bu | 6-Me | Cl | i-Pr | Br | CH | t-Bu | 6-Cl | Cl | i-Pr | Br | CH |
| Me | 6-Me | Cl | C₂F₅ | Br | CH | Me | 6-Cl | Cl | C₂F₅ | Br | CH |
| Et | 6-Me | Cl | C₂F₅ | Br | CH | Et | 6-Cl | Cl | C₂F₅ | Br | CH |
| i-Pr | 6-Me | Cl | C₂F₅ | Br | CH | i-Pr | 6-Cl | Cl | C₂F₅ | Br | CH |
| t-Bu | 6-Me | Cl | C₂F₅ | Br | CH | t-Bu | 6-Cl | Cl | C₂F₅ | Br | CH |
| Me | 6-Me | Cl | n-C₃F₇ | Br | CH | Me | 6-Cl | Cl | n-C₃F₇ | Br | CH |
| Et | 6-Me | Cl | n-C₃F₇ | Br | CH | Et | 6-Cl | Cl | n-C₃F₇ | Br | CH |
| i-Pr | 6-Me | Cl | n-C₃F₇ | Br | CH | i-Pr | 6-Cl | Cl | n-C₃F₇ | Br | CH |
| t-Bu | 6-Me | Cl | n-C₃F₇ | Br | CH | t-Bu | 6-Cl | Cl | n-C₃F₇ | Br | CH |
| Me | 6-Me | Cl | i-C₃F₇ | Br | CH | Me | 6-Cl | Cl | i-C₃F₇ | Br | CH |
| Et | 6-Me | Cl | i-C₃F₇ | Br | CH | Et | 6-Cl | Cl | i-C₃F₇ | Br | CH |
| i-Pr | 6-Me | Cl | i-C₃F₇ | Br | CH | i-Pr | 6-Cl | Cl | i-C₃F₇ | Br | CH |
| t-Bu | 6-Me | Cl | i-C₃F₇ | Br | CH | t-Bu | 6-Cl | Cl | i-C₃F₇ | Br | CH |
| Me | 6-Me | Cl | Et | Br | CH | Me | 6-Cl | Cl | Et | Br | CH |
| Et | 6-Me | Cl | Et | Br | CH | Et | 6-Cl | Cl | Et | Br | CH |
| i-Pr | 6-Me | Cl | Et | Br | CH | i-Pr | 6-Cl | Cl | Et | Br | CH |
| t-Bu | 6-Me | Cl | Et | Br | CH | t-Bu | 6-Cl | Cl | Et | Br | CH |
| Me | 6-Me | Cl | CHF₂ | CF₃ | CH | Me | 6-Cl | Cl | CHF₂ | CF₃ | CH |
| Et | 6-Me | Cl | CHF₂ | CF₃ | CH | Et | 6-Cl | Cl | CHF₂ | CF₃ | CH |
| i-Pr | 6-Me | Cl | CHF₂ | CF₃ | CH | i-Pr | 6-Cl | Cl | CHF₂ | CH₃ | CH |
| t-Bu | 6-Me | Cl | CHF₂ | CF₃ | CH | t-Bu | 6-Cl | Cl | CHF₂ | CF₃ | CH |
| Me | 6-Me | Cl | n-Pr | CF₃ | CH | Me | 6-Cl | Cl | n-Pr | CH₃ | CH |
| Et | 6-Me | Cl | n-Pr | CF₃ | CH | Et | 6-Cl | Cl | n-Pr | CF₃ | CH |
| i-Pr | 6-Me | Cl | n-Pr | CF₃ | CH | i-Pr | 6-Cl | Cl | n-Pr | CF₃ | CH |
| t-Bu | 6-Me | Cl | n-Pr | CF₃ | CH | t-Bu | 6-Cl | Cl | n-Pr | CF₃ | CH |
| Me | 6-Me | Cl | CF₃ | CF₃ | CH | Me | 6-Cl | Cl | CF₃ | CF₃ | CH |
| Et | 6-Me | Cl | CH₃ | CF₃ | CH | Et | 6-Cl | Cl | CF₃ | CF₃ | CH |
| i-Pr | 6-Me | Cl | CH₃ | CF₃ | CH | i-Pr | 6-Cl | Cl | CF₃ | CF₃ | CH |
| t-Bu | 6-Me | Cl | CH₃ | CF₃ | CH | t-Bu | 6-Cl | Cl | CF₃ | CF₃ | CH |
| Me | 6-Me | Cl | i-Pr | CF₃ | CH | Me | 6-Cl | Cl | i-Pr | CF₃ | CH |
| Et | 6-Me | Cl | i-Pr | CF₃ | CH | Et | 6-Cl | Cl | i-Pr | CF₃ | CH |
| i-Pr | 6-Me | Cl | i-Pr | CF₃ | CH | i-Pr | 6-Cl | Cl | i-Pr | CF₃ | CH |
| t-Bu | 6-Me | Cl | i-Pr | CF₃ | CH | t-Bu | 6-Cl | Cl | i-Pr | CF₃ | CH |
| Me | 6-Me | Cl | C₂F₅ | CF₃ | CH | Me | 6-Cl | Cl | C₂F₅ | CF₃ | CH |
| Et | 6-Me | Cl | C₂F₅ | CF₃ | CH | Et | 6-Cl | Cl | C₂F₅ | CF₃ | CH |
| i-Pr | 6-Me | Cl | C₂F₅ | CF₃ | CH | i-Pr | 6-Cl | Cl | C₂F₅ | CF₃ | CH |
| t-Bu | 6-Me | Cl | C₂F₅ | CF₃ | CH | t-Bu | 6-Cl | Cl | C₂F₅ | CF₃ | CH |
| Me | 6-Me | Cl | n-C₃F₇ | CF₃ | CH | Me | 6-Cl | Cl | n-C₃F₇ | CF₃ | CH |
| Et | 6-Me | Cl | n-C₃F₇ | CF₃ | CH | Et | 6-Cl | Cl | n-C₃F₇ | CF₃ | CH |
| i-Pr | 6-Me | Cl | n-C₃F₇ | CF₃ | CH | i-Pr | 6-Cl | Cl | n-C₃F₇ | CF₃ | CH |
| t-Bu | 6-Me | Cl | n-C₃F₇ | CF₃ | CH | t-Bu | 6-Cl | Cl | n-C₃F₇ | CF₃ | CH |
| Me | 6-Me | Cl | i-C₃F₇ | CF₃ | CH | Me | 6-Cl | Cl | i-C₃F₇ | CF₃ | CH |
| Et | 6-Me | Cl | i-C₃F₇ | CF₃ | CH | Et | 6-Cl | Cl | i-C₃F₇ | CF₃ | CH |
| i-Pr | 6-Me | Cl | i-C₃F₇ | CF₃ | CH | i-Pr | 6-Cl | Cl | i-C₃F₇ | CF₃ | CH |
| t-Bu | 6-Me | Cl | i-C₃F₇ | CF₃ | CH | t-Bu | 6-Cl | Cl | i-C₃F₇ | CF₃ | CH |
| Me | 6-Me | Cl | Et | CF₃ | CH | Me | 6-Cl | Cl | Et | CF₃ | CH |
| Et | 6-Me | Cl | Et | CF₃ | CH | Et | 6-Cl | Cl | Et | CF₃ | CH |
| i-Pr | 6-Me | Cl | Et | CF₃ | CH | i-Pr | 6-Cl | Cl | Et | CF₃ | CH |
| t-Bu | 6-Me | Cl | Et | CF₃ | CH | t-Bu | 6-Cl | Cl | Et | CF₃ | CH |
| Me | 6-Me | H | CHF₂ | F | CF | Me | 6-Cl | H | CHF₂ | F | CF |
| Et | 6-Me | H | CHF₂ | F | CF | Et | 6-Cl | H | CHF₂ | F | CF |
| i-Pr | 6-Me | H | CHF₂ | F | CF | i-Pr | 6-Cl | H | CHF₂ | F | CF |
| t-Bu | 6-Me | H | CHF₂ | F | CF | t-Bu | 6-Cl | H | CHF₂ | F | CF |
| Me | 6-Me | H | n-Pr | F | CF | Me | 6-Cl | H | n-Pr | F | CF |
| Et | 6-Me | H | n-Pr | F | CF | Et | 6-Cl | H | n-Pr | F | CF |
| i-Pr | 6-Me | H | n-Pr | F | CF | i-Pr | 6-Cl | H | n-Pr | F | CF |
| t-Bu | 6-Me | H | n-Pr | F | CF | t-Bu | 6-Cl | H | n-Pr | F | CF |
| Me | 6-Me | H | CF₃ | F | CF | Me | 6-Cl | H | CF₃ | F | CF |
| Et | 6-Me | H | CF₃ | F | CF | Et | 6-Cl | H | CF₃ | F | CF |
| i-Pr | 6-Me | H | CF₃ | F | CF | i-Pr | 6-Cl | H | CF₃ | F | CF |
| t-Bu | 6-Me | H | CF₃ | F | CF | t-Bu | 6-Cl | H | CF₃ | F | CF |
| Me | 6-Me | H | i-Pr | F | CF | Me | 6-Cl | H | i-Pr | F | CF |
| Et | 6-Me | H | i-Pr | F | CF | Et | 6-Cl | H | i-Pr | F | CF |
| i-Pr | 6-Me | H | i-Pr | F | CF | i-Pr | 6-Cl | H | i-Pr | F | CF |
| t-Bu | 6-Me | H | i-Pr | F | CF | t-Bu | 6-Cl | H | i-Pr | F | CF |
| Me | 6-Me | H | C₂F₅ | F | CF | Me | 6-Cl | H | C₂F₅ | F | CF |
| Et | 6-Me | H | C₂F₅ | F | CF | Et | 6-Cl | H | C₂F₅ | F | CF |
| i-Pr | 6-Me | H | C₂F₅ | F | CF | i-Pr | 6-Cl | H | C₂F₅ | F | CF |
| t-Bu | 6-Me | H | C₂F₅ | F | CF | t-Bu | 6-Cl | H | C₂F₅ | F | CF |
| Me | 6-Me | H | n-C₃F₇ | F | CF | Me | 6-Cl | H | n-C₃F₇ | F | CF |
| Et | 6-Me | H | n-C₃F₇ | F | CF | Et | 6-Cl | H | n-C₃F₇ | F | CF |
| i-Pr | 6-Me | H | n-C₃F₇ | F | CF | i-Pr | 6-Cl | H | n-C₃F₇ | F | CF |
| t-Bu | 6-Me | H | n-C₃F₇ | F | CF | t-Bu | 6-Cl | H | n-C₃F₇ | F | CF |
| Me | 6-Me | H | i-C₃F₇ | F | CF | Me | 6-Cl | H | i-C₃F₇ | F | CF |
| Et | 6-Me | H | i-C₃F₇ | F | CF | Et | 6-Cl | H | i-C₃F₇ | F | CF |
| i-Pr | 6-Me | H | i-C₃F₇ | F | CF | i-Pr | 6-Cl | H | i-C₃F₇ | F | CF |
| t-Bu | 6-Me | H | i-C₃F₇ | F | CF | t-Bu | 6-Cl | H | i-C₃F₇ | F | CF |
| Me | 6-Me | H | Et | F | CF | Me | 6-Cl | H | Et | F | CF |
| Et | 6-Me | H | Et | F | CF | Et | 6-Cl | H | Et | F | CF |
| i-Pr | 6-Me | H | Et | F | CF | i-Pr | 6-Cl | H | Et | F | CF |
| t-Bu | 6-Me | H | Et | F | CF | t-Bu | 6-Cl | H | Et | F | CF |
| Me | 6-Me | H | CHF₂ | Cl | CCl | Me | 6-Cl | H | CHF₂ | Cl | CCl |
| Et | 6-Me | H | CHF₂ | Cl | CCl | Et | 6-Cl | H | CHF₂ | Cl | CCl |
| i-Pr | 6-Me | H | CHF₂ | Cl | CCl | i-Pr | 6-Cl | H | CHF₂ | Cl | CCl |
| t-Bu | 6-Me | H | CHF₂ | Cl | CCl | t-Bu | 6-Cl | H | CHF₂ | Cl | CCl |
| Me | 6-Me | H | n-Pr | Cl | CCl | Me | 6-Cl | H | n-Pr | Cl | CCl |
| Et | 6-Me | H | n-Pr | Cl | CCl | Et | 6-Cl | H | n-Pr | Cl | CCl |
| i-Pr | 6-Me | H | n-Pr | Cl | CCl | i-Pr | 6-Cl | H | n-Pr | Cl | CCl |
| t-Bu | 6-Me | H | n-Pr | Cl | CCl | t-Bu | 6-Cl | H | n-Pr | Cl | CCl |
| Me | 6-Me | H | CF₃ | Cl | CCl | Me | 6-Cl | H | CF₃ | Cl | CCl |
| Et | 6-Me | H | CF₃ | Cl | CCl | Et | 6-Cl | H | CF₃ | Cl | CCl |
| i-Pr | 6-Me | H | CF₃Cl | CCl | i-Pr | 6-Cl | H | CF₃ | Cl | CCl | |
| t-Bu | 6-Me | H | CF₃Cl | CCl | t-Bu | 6-Cl | H | CF₃ | Cl | CCl | |
| Me | 6-Me | H | i-Pr | Cl | CCl | Me | 6-Cl | H | i-Pr | Cl | CCl |
| Et | 6-Me | H | i-Pr | Cl | CCl | Et | 6-Cl | H | i-Pr | Cl | CCl |
| i-Pr | 6-Me | H | i-Pr | Cl | CCl | i-Pr | 6-Cl | H | i-Pr | Cl | CCl |
| t-Bu | 6-Me | H | i-Pr | Cl | CCl | t-Bu | 6-Cl | H | i-Pr | Cl | CCl |
| Me | 6-Me | H | C₂F₅ | Cl | CCl | Me | 6-Cl | H | C₂F₅ | Cl | CCl |
| Et | 6-Me | H | C₂F₅ | Cl | CCl | Et | 6-Cl | H | C₂F₅ | Cl | CCl |
| i-Pr | 6-Me | H | C₂F₅ | Cl | CCl | i-Pr | 6-Cl | H | C₂F₅ | Cl | CCl |
| t-Bu | 6-Me | H | C₂F₅ | Cl | CCl | t-Bu | 6-Cl | H | C₂F₅ | Cl | CCl |
| Me | 6-Me | H | n-C₃F₇ | Cl | CCl | Me | 6-Cl | H | n-C₃F₇ | Cl | CCl |
| Et | 6-Me | H | n-C₃F₇ | Cl | CCl | Et | 6-Cl | H | n-C₃F₇ | Cl | CCl |
| i-Pr | 6-Me | H | n-C₃F₇ | Cl | CCl | i-Pr | 6-Cl | H | n-C₃F₇ | Cl | CCl |
| t-Bu | 6-Me | H | n-C₃F₇ | Cl | CCl | t-Bu | 6-Cl | H | n-C₃F₇ | Cl | CCl |
| Me | 6-Me | H | i-C₃F₇ | Cl | CCl | Me | 6-Cl | H | i-C₃F₇ | Cl | CCl |
| Et | 6-Me | H | i-C₃F₇ | Cl | CCl | Et | 6-Cl | H | i-C₃F₇ | Cl | CCl |
| i-Pr | 6-Me | H | i-C₃F₇ | Cl | CCl | i-Pr | 6-Cl | H | i-C₃F₇ | Cl | CCl |
| t-Bu | 6-Me | H | i-C₃F₇ | Cl | CCl | t-Bu | 6-Cl | H | i-C₃F₇ | Cl | CCl |
| Me | 6-Me | H | Et | Cl | CCl | Me | 6-Cl | H | Et | Cl | CCl |
| Et | 6-Me | H | Et | Cl | CCl | Et | 6-Cl | H | Et | Cl | CCl |
| i-Pr | 6-Me | H | Et | Cl | CCl | i-Pr | 6-Cl | H | Et | Cl | CCl |
| t-Bu | 6-Me | H | Et | Cl | CCl | t-Bu | 6-Cl | H | Et | Cl | CCl |

TABLE 13

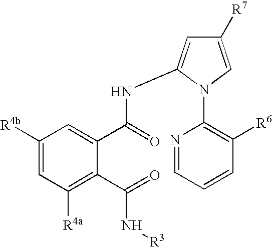

| R^{4a} | R^{4b} | R⁷ | R³ | R⁶ | R^{4a} | R^{4b} | R⁷ | R³ | R⁶ | R^{4a} | R^{4b} | R⁷ | R³ | R⁶ |
|---|---|---|---|---|---|---|---|---|---|---|---|---|---|---|
| CH₃ | F | CF₃ | Me | Cl | Cl | F | CF₃ | Me | Cl | Br | F | CF₃ | Me | Cl |
| CH₃ | F | CF₃ | Et | Cl | Cl | F | CF₃ | Et | Cl | Br | F | CF₃ | Et | Cl |
| CH₃ | F | CF₃ | i-Pr | Cl | Cl | F | CF₃ | i-Pr | Cl | Br | F | CF₃ | i-Pr | Cl |
| CH₃ | F | CF₃ | t-Bu | Cl | Cl | F | CF₃ | t-Bu | Cl | Br | F | CF₃ | t-Bu | Cl |
| CH₃ | F | CF₃ | Me | Br | Cl | F | CF₃ | Me | Br | Br | F | CF₃ | Me | Br |
| CH₃ | F | CF₃ | Et | Br | Cl | F | CF₃ | Et | Br | Br | F | CF₃ | Et | Br |
| CH₃ | F | CF₃ | i-Pr | Br | Cl | F | CF₃ | i-Pr | Br | Br | F | CF₃ | i-Pr | Br |
| CH₃ | F | CF₃ | t-Bu | Br | Cl | F | CF₃ | t-Bu | Br | Br | F | CF₃ | t-Bu | Br |
| CH₃ | F | Cl | Me | Cl | Cl | F | Cl | Me | Cl | Br | F | Cl | Me | Cl |
| CH₃ | F | Cl | Et | Cl | Cl | F | Cl | Et | Cl | Br | F | Cl | Et | Cl |
| CH₃ | F | Cl | i-Pr | Cl | Cl | F | Cl | i-Pr | Cl | Br | F | Cl | i-Pr | Cl |
| CH₃ | F | Cl | t-Bu | Cl | Cl | F | Cl | t-Bu | Cl | Br | F | Cl | t-Bu | Cl |
| CH₃ | F | Cl | Me | Br | Cl | F | Cl | Me | Br | Br | F | Cl | Me | Br |
| CH₃ | F | Cl | Et | Br | Cl | F | Cl | Et | Br | Br | F | Cl | Et | Br |
| CH₃ | F | Cl | i-Pr | Br | Cl | F | Cl | i-Pr | Br | Br | F | Cl | i-Pr | Br |
| CH₃ | F | Cl | t-Bu | Br | Cl | F | Cl | t-Bu | Br | Br | F | Cl | t-Bu | Br |
| CH₃ | F | Br | Me | Cl | Cl | F | Br | Me | Cl | Br | F | Br | Me | Cl |
| CH₃ | F | Br | Et | Cl | Cl | F | Br | Et | Cl | Br | F | Br | Et | Cl |
| CH₃ | F | Br | i-Pr | Cl | Cl | F | Br | i-Pr | Cl | Br | F | Br | i-Pr | Cl |
| CH₃ | F | Br | t-Bu | Cl | Cl | F | Br | t-Bu | Cl | Br | F | Br | t-Bu | Cl |
| CH₃ | F | Br | Me | Br | Cl | F | Br | Me | Br | Br | F | Br | Me | Br |
| CH₃ | F | Br | Et | Br | Cl | F | Br | Et | Br | Br | F | Br | Et | Br |
| CH₃ | F | Br | i-Pr | Br | Cl | F | Br | i-Pr | Br | Br | F | Br | i-Pr | Br |
| CH₃ | F | Br | t-Bu | Br | Cl | F | Br | t-Bu | Br | Br | F | Br | t-Bu | Br |
| CH₃ | Cl | CF₃ | Me | Cl | Cl | Cl | CF₃ | Me | Cl | Br | Cl | CF₃ | Me | Cl |
| CH₃ | Cl | CF₃ | Et | Cl | Cl | Cl | CF₃ | Et | Cl | Br | Cl | CF₃ | Et | Cl |
| CH₃ | Cl | CF₃ | i-Pr | Cl | Cl | Cl | CF₃ | i-Pr | Cl | Br | Cl | CF₃ | i-Pr | Cl |
| CH₃ | Cl | CF₃ | t-Bu | Cl | Cl | Cl | CF₃ | t-Bu | Cl | Br | Cl | CF₃ | t-Bu | Cl |
| CH₃ | Cl | CF₃ | Me | Br | Cl | Cl | CF₃ | Me | Br | Br | Cl | CF₃ | Me | Br |
| CH₃ | Cl | CF₃ | Et | Br | Cl | Cl | CF₃ | Et | Br | Br | Cl | CF₃ | Et | Br |
| CH₃ | Cl | CF₃ | i-Pr | Br | Cl | Cl | CF₃ | i-Pr | Br | Br | Cl | CF₃ | i-Pr | Br |
| CH₃ | Cl | CF₃ | t-Bu | Br | Cl | Cl | CF₃ | t-Bu | Br | Br | Cl | CF₃ | t-Bu | Br |
| CH₃ | Cl | Cl | Me | Cl | Cl | Cl | Cl | Me | Cl | Br | Cl | Cl | Me | Cl |
| CH₃ | Cl | Cl | Et | Cl | Cl | Cl | Cl | Et | Cl | Br | Cl | Cl | Et | Cl |
| CH₃ | Cl | Cl | i-Pr | Cl | Cl | Cl | Cl | i-Pr | Cl | Br | Cl | Cl | i-Pr | Cl |
| CH₃ | Cl | Cl | t-Bu | Cl | Cl | Cl | Cl | t-Bu | Cl | Br | Cl | Cl | t-Bu | Cl |
| CH₃ | Cl | Cl | Me | Br | Cl | Cl | Cl | Me | Br | Br | Cl | Cl | Me | Br |
| CH₃ | Cl | Cl | Et | Br | Cl | Cl | Cl | Et | Br | Br | Cl | Cl | Et | Br |
| CH₃ | Cl | Cl | i-Pr | Br | Cl | Cl | Cl | i-Pr | Br | Br | Cl | Cl | i-Pr | Br |
| CH₃ | Cl | Cl | t-Bu | Br | Cl | Cl | Cl | t-Bu | Br | Br | Cl | Cl | t-Bu | Br |
| CH₃ | Cl | Br | Me | Cl | Cl | Cl | Br | Me | Cl | Br | Cl | Br | Me | Cl |
| CH₃ | Cl | Br | Et | Cl | Cl | Cl | Br | Et | Cl | Br | Cl | Br | Et | Cl |
| CH₃ | Cl | Br | i-Pr | Cl | Cl | Cl | Br | i-Pr | Cl | Br | Cl | Br | i-Pr | Cl |
| CH₃ | Cl | Br | t-Bu | Cl | Cl | Cl | Br | t-Bu | Cl | Br | Cl | Br | t-Bu | Cl |
| CH₃ | Cl | Br | Me | Br | Cl | Cl | Br | Me | Br | Br | Cl | Br | Me | Br |
| CH₃ | Cl | Br | Et | Br | Cl | Cl | Br | Et | Br | Br | Cl | Br | Et | Br |
| CH₃ | Cl | Br | i-Pr | Br | Cl | Cl | Br | i-Pr | Br | Br | Cl | Br | i-Pr | Br |
| CH₃ | Cl | Br | t-Bu | Br | Cl | Cl | Br | t-Bu | Br | Br | Cl | Br | t-Bu | Br |
| CH₃ | Br | CF₃ | Me | Cl | Cl | Br | CF₃ | Me | Cl | Br | Br | CF₃ | Me | Cl |
| CH₃ | Br | CF₃ | Et | Cl | Cl | Br | CF₃ | Et | Cl | Br | Br | CF₃ | Et | Cl |
| CH₃ | Br | CF₃ | i-Pr | Cl | Cl | Br | CF₃ | i-Pr | Cl | Br | Br | CF₃ | i-Pr | Cl |
| CH₃ | Br | CF₃ | t-Bu | Cl | Cl | Br | CF₃ | t-Bu | Cl | Br | Br | CF₃ | t-Bu | Cl |
| CH₃ | Br | CF₃ | Me | Br | Cl | Br | CF₃ | Me | Br | Br | Br | CF₃ | Me | Br |
| CH₃ | Br | CF₃ | Et | Br | Cl | Br | CF₃ | Et | Br | Br | Br | CF₃ | Et | Br |
| CH₃ | Br | CF₃ | i-Pr | Br | Cl | Br | CF₃ | i-Pr | Br | Br | Br | CF₃ | i-Pr | Br |
| CH₃ | Br | CF₃ | t-Bu | Br | Cl | Br | CF₃ | t-Bu | Br | Br | Br | CF₃ | t-Bu | Br |
| CH₃ | Br | Cl | Me | Cl | Cl | Br | Cl | Me | Cl | Br | Br | Cl | Me | Cl |
| CH₃ | Br | Cl | Et | Cl | Cl | Br | Cl | Et | Cl | Br | Br | Cl | Et | Cl |
| CH₃ | Br | Cl | i-Pr | Cl | Cl | Br | Cl | i-Pr | Cl | Br | Br | Cl | i-Pr | Cl |
| CH₃ | Br | Cl | t-Bu | Cl | Cl | Br | Cl | t-Bu | Cl | Br | Br | Cl | t-Bu | Cl |
| CH₃ | Br | Cl | Me | Br | Cl | H | CF₃ | Me | Cl | Br | Br | Cl | Me | Br |
| CH₃ | Br | Cl | Et | Br | Cl | H | CF₃ | Et | Cl | Br | Br | Cl | Et | Br |
| CH₃ | Br | Cl | i-Pr | Br | Cl | H | CF₃ | i-Pr | Cl | Br | Br | Cl | i-Pr | Br |
| CH₃ | Br | Cl | t-Bu | Br | Cl | H | CF₃ | t-Bu | Cl | Br | Br | Cl | t-Bu | Br |
| CH₃ | Br | Br | Me | Cl | Cl | H | CF₃ | Me | Br | Br | Br | Br | Me | Cl |
| CH₃ | Br | Br | Et | Cl | Cl | H | CF₃ | Et | Br | Br | Br | Br | Et | Cl |
| CH₃ | Br | Br | i-Pr | Cl | Cl | H | CF₃ | i-Pr | Br | Br | Br | Br | i-Pr | Cl |
| CH₃ | Br | Br | t-Bu | Cl | Cl | H | CF₃ | t-Bu | Br | Br | Br | Br | t-Bu | Cl |
| CH₃ | Br | Br | Me | Br | Cl | H | Cl | Me | Cl | Br | Br | Br | Me | Br |
| CH₃ | Br | Br | Et | Br | Cl | H | Cl | Et | Cl | Br | Br | Br | Et | Br |
| CH₃ | Br | Br | i-Pr | Br | Cl | H | Cl | i-Pr | Cl | Br | Br | Br | i-Pr | Br |
| CH₃ | Br | Br | t-Bu | Br | Cl | H | Cl | t-Bu | Cl | Br | Br | Br | t-Bu | Br |
| CH₃ | I | CF₃ | Me | Cl | Cl | H | Cl | Me | Br | Br | I | CF₃ | Me | Cl |
| CH₃ | I | CF₃ | Et | Cl | Cl | H | Cl | Et | Br | Br | I | CF₃ | Et | Cl |
| CH₃ | I | CF₃ | i-Pr | Cl | Cl | H | Cl | i-Pr | Br | Br | I | CF₃ | i-Pr | Cl |
| CH₃ | I | CF₃ | t-Bu | Cl | Cl | H | Cl | t-Bu | Br | Br | I | CF₃ | t-Bu | Cl |
| CH₃ | I | CF₃ | Me | Br | Cl | H | Br | Me | Cl | Br | I | CF₃ | Me | Br |
| CH₃ | I | CF₃ | Et | Br | Cl | H | Br | Et | Cl Br | I | CF₃ | Et | Br | |
| CH₃ | I | CF₃ | i-Pr | Br | Cl | H | Br | i-Pr | Cl | Br | I | CF₃ | i-Pr | Br |
| CH₃ | I | CF₃ | t-Bu | Br | Cl | H | Br | t-Bu | Cl | Br | I | CF₃ | t-Bu | Br |
| CH₃ | I | Cl | Me | Cl | Cl | H | Br | Me | Br | Br | I | Cl | Me | Cl |
| CH₃ | I | Cl | Et | Cl | Cl | H | Br | Et | Br | Br | I | Cl | Et | Cl |
| CH₃ | I | Cl | i-Pr | Cl | Cl | H | Br | i-Pr | Br | Br | I | Cl | i-Pr | Cl |
| CH₃ | I | Cl | t-Bu | Cl | Cl | H | Br | t-Bu | Br | Br | I | Cl | t-Bu | Cl |
| CH₃ | I | Cl | Me | Br | Cl | Br | Cl | Me | Br | Br | I | Cl | Me | Br |
| CH₃ | I | Cl | Et | Br | Cl | Br | Cl | Et | Br | Br | I | Cl | Et | Br |
| CH₃ | I | Cl | i-Pr | Br | Cl | Br | Cl | i-Pr | Br | Br | I | Cl | i-Pr | Br |
| CH₃ | I | Cl | t-Bu | Br | Cl | Br | Cl | t-Bu | Br | Br | I | Cl | t-Bu | Br |
| CH₃ | I | Br | Me | Cl | Cl | Br | Br | Me | Cl | Br | I | Br | Me | Cl |
| CH₃ | I | Br | Et | Cl | Cl | Br | Br | Et | Cl | Br | I | Br | Et | Cl |
| CH₃ | I | Br | i-Pr | Cl | Cl | Br | Br | i-Pr | Cl | Br | I | Br | i-Pr | Cl |
| CH₃ | I | Br | t-Bu | Cl | Cl | Br | Br | t-Bu | Cl | Br | I | Br | t-Bu | Cl |
| CH₃ | I | Br | Me | Br | Cl | Br | Br | Me | Br | Br | I | Br | Me | Br |
| CH₃ | I | Br | Et | Br | Cl | Br | Br | Et | Br | Br | I | Br | Et | Br |
| CH₃ | I | Br | i-Pr | Br | Cl | Br | Br | i-Pr | Br | Br | I | Br | i-Pr | Br |
| CH₃ | I | Br | t-Bu | Br | Cl | Br | Br | t-Bu | Br | Br | I | Br | t-Bu | Br |
| CH₃ | CF₃ | CF₃ | Me | Cl | Cl | I | CF₃ | Me | Cl | Br | CF₃ | CF₃ | Me | Cl |
| CH₃ | CF₃ | CF₃ | Et | Cl | Cl | I | CF₃ | Et | Cl | Br | CF₃ | CF₃ | Et | Cl |
| CH₃ | CF₃ | CF₃ | i-Pr | Cl | Cl | I | CF₃ | i-Pr | Cl | Br | CF₃ | CF₃ | i-Pr | Cl |
| CH₃ | CF₃ | CF₃ | t-Bu | Cl | Cl | I | CF₃ | t-Bu | Cl | Br | CF₃ | CF₃ | t-Bu | Cl |
| CH₃ | CF₃ | CF₃ | Me | Br | Cl | I | CF₃ | Me | Br | Br | CF₃ | CF₃ | Me | Br |
| CH₃ | CF₃ | CF₃ | Et | Br | Cl | I | CF₃ | Et | Br | Br | CF₃ | CF₃ | Et | Br |
| CH₃ | CF₃ | CF₃ | i-Pr | Br | Cl | I | CF₃ | i-Pr | Br | Br | CF₃ | CF₃ | i-Pr | Br |
| CH₃ | CF₃ | CF₃ | t-Bu | Br | Cl | I | CF₃ | t-Bu | Br | Br | CF₃ | CF₃ | t-Bu | Br |
| CH₃ | CF₃ | Cl | Me | Cl | Cl | I | Cl | Me | Cl | Br | CF₃ | Cl | Me | Cl |
| CH₃ | CF₃ | Cl | Et | Cl | Cl | I | Cl | Et | Cl | Br | CF₃ | Cl | Et | Cl |
| CH₃ | CF₃ | Cl | i-Pr | Cl | Cl | I | Cl | i-Pr | Cl | Br | CF₃ | Cl | i-Pr | Cl |
| CH₃ | CF₃ | Cl | t-Bu | Cl | Cl | I | Cl | t-Bu | Cl | Br | CF₃ | Cl | t-Bu | Cl |
| CH₃ | CF₃ | Cl | Me | Br | Cl | I | Cl | Me | Br | Br | CF₃ | Cl | Me | Br |
| CH₃ | CF₃ | Cl | Et | Br | Cl | I | Cl | Et | Br | Br | CF₃ | Cl | Et | Br |
| CH₃ | CF₃ | Cl | i-Pr | Br | Cl | I | Cl | i-Pr | Br | Br | CF₃ | Cl | i-Pr | Br |
| CH₃ | CF₃ | Cl | t-Bu | Br | Cl | I | Cl | t-Bu | Br | Br | CF₃ | Cl | t-Bu | Br |
| CH₃ | CF₃ | Br | Me | Cl | Cl | I | Br | Me | Cl | Br | CF₃ | Br | Me | Cl |
| CH₃ | CF₃ | Br | Et | Cl | Cl | I | Br | Et | Cl | Br | CF₃ | Br | Et | Cl |
| CH₃ | CF₃ | Br | i-Pr | Cl | Cl | I | Br | i-Pr | Cl | Br | CF₃ | Br | i-Pr | Cl |
| CH₃ | CF₃ | Br | t-Bu | Cl | Cl | I | Br | t-Bu | Cl | Br | CF₃ | Br | t-Bu | Cl |
| CH₃ | CF₃ | Br | Me | Br | Cl | I | Br | Me | Br | Br | CF₃ | Br | Me | Br |
| CH₃ | CF₃ | Br | Et | Br | Cl | I | Br | Et | Br | Br | CF₃ | Br | Et | Br |
| CH₃ | CF₃ | Br | i-Pr | Br | Cl | I | Br | i-Pr | Br | Br | CF₃ | Br | i-Pr | Br |
| CH₃ | CF₃ | Br | t-Bu | Br | Cl | I | Br | t-Bu | Br | Br | CF₃ | Br | t-Bu | Br |
| CH₃ | Cl | Cl | n-Pr | Cl | Cl | CF₃ | CF₃ | Me | Cl | I | Cl | CF₃ | Me | Cl |
| CH₃ | Cl | Cl | n-Bu | Cl | Cl | CF₃ | CF₃ | Et | Cl | I | Cl | CF₃ | Et | Cl |
| CH₃ | Cl | Cl | s-Bu | Cl | Cl | CF₃ | CF₃ | i-Pr | Cl | I | Cl | CF₃ | i-Pr | Cl |
| CH₃ | Cl | Cl | i-Bu | Cl | Cl | CF₃ | CF₃ | t-Bu | Cl | I | Cl | CF₃ | t-Bu | Cl |
| CH₃ | H | CF₃ | Me | Cl | Cl | CF₃ | CF₃ | Me | Br | I | Cl | CF₃ | Me | Br |
| CH₃ | H | CF₃ | Et | Cl | Cl | CF₃ | CF₃ | Et | Br | I | Cl | CF₃ | Et | Br |
| CH₃ | H | CF₃ | i-Pr | Cl | Cl | CF₃ | CF₃ | i-Pr | Br | I | Cl | CF₃ | i-Pr | Br |
| CH₃ | H | CF₃ | t-Bu | Cl | Cl | CF₃ | CF₃ | t-Bu | Br | I | Cl | CF₃ | t-Bu | Br |
| CH₃ | H | CF₃ | Me | Br | Cl | CF₃ | Cl | Me | Cl | I | Cl | Cl | Me | Cl |
| CH₃ | H | CF₃ | Et | Br | Cl | CF₃ | Cl | Et | Cl | I | Cl | Cl | Et | Cl |
| CH₃ | H | CF₃ | i-Pr | Br | Cl | CF₃ | Cl | i-Pr | Cl | I | Cl | Cl | i-Pr | Cl |
| CH₃ | H | CF₃ | t-Bu | Br | Cl | CF₃ | Cl | t-Bu | Cl | I | Cl | Cl | t-Bu | Cl |
| CH₃ | H | Cl | Me | Cl | Cl | CF₃ | Cl | Me | Br | I | Cl | Cl | Me | Br |
| CH₃ | H | Cl | Et | Cl | Cl | CF₃ | Cl | Et | Br | I | Cl | Cl | Et | Br |
| CH₃ | H | Cl | i-Pr | Cl | Cl | CF₃ | Cl | i-Pr | Br | I | Cl | Cl | i-Pr | Br |
| CH₃ | H | Cl | t-Bu | Cl | Cl | CF₃ | Cl | t-Bu | Br | I | Cl | Cl | t-Bu | Br |
| CH₃ | H | Cl | Me | Br | Cl | CF₃ | Br | Me | Cl | I | Cl | Br | Me | Cl |
| CH₃ | H | Cl | Et | Br | Cl | CF₃ | Br | Et | Cl | I | Cl | Br | Et | Cl |
| CH₃ | H | Cl | i-Pr | Br | Cl | CF₃ | Br | i-Pr | Cl | I | Cl | Br | i-Pr | Cl |
| CH₃ | H | Cl | t-Bu | Br | Cl | CF₃ | Br | t-Bu | Cl | I | Cl | Br | t-Bu | Cl |
| CH₃ | H | Br | Me | Cl | Cl | CF₃ | Br | Me | Br | I | Cl | Br | Me | Br |
| CH₃ | H | Br | Et | Cl | Cl | CF₃ | Br | Et | Br | I | Cl | Br | Et | Br |
| CH₃ | H | Br | i-Pr | Cl | Cl | CF₃ | Br | i-Pr | Br | I | Cl | Br | i-Pr | Br |
| CH₃ | H | Br | t-Bu | Cl | Cl | CF₃ | Br | t-Bu | Br | I | Cl | Br | t-Bu | Br |
| CH₃ | H | Br | Me | Br | Cl | Cl | Cl | n-Pr | Cl | I | H | CF₃ | Me | Cl |
| CH₃ | H | Br | Et | Br | Cl | Cl | Cl | n-Bu | Cl | I | H | CF₃ | Et | Cl |
| CH₃ | H | Br | i-Pr | Br | Cl | Cl | Cl | s-Bu | Cl | I | H | CF₃ | i-Pr | Cl |
| CH₃ | H | Br | t-Bu | Br | Cl | Cl | Cl | i-Bu | Cl | I | H | CF₃ | t-Bu | Cl |

TABLE 14

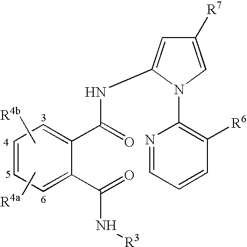

| R³ | R^{4a} | R^{4b} | R⁷ | R⁶ | R³ | R^{4a} | R^{4b} | R⁷ | R⁶ |
|---|---|---|---|---|---|---|---|---|---|
| Me | 3-Me | H | CF₃ | F | Me | 3-Cl | H | CF3 | F |
| Et | 3-Me | 5-Me | OCF₃ | F | Et | 3-Cl | 5-Me | OCF3 | F |
| i-Pr | 3-Me | H | OCF₃ | F | i-Pr | 3-Cl | H | OCF3 | F |
| t-Bu | 3-Me | 5-Cl | Br | F | t-Bu | 3-Cl | 5-Cl | Br | F |
| Me | 3-Me | H | Br | F | Me | 3-Cl | H | Br | F |
| Et | 3-Me | H | Cl | F | Et | 3-Cl | H | Cl | F |
| i-Pr | 3-Me | 5-Br | Cl | F | i-Pr | 3-Cl | 5-Br | Cl | F |
| t-Bu | 3-Me | H | I | F | t-Bu | 3-Cl | H | I | F |
| propargyl | 3-Me | H | CF₃ | F | propargyl | 3-Cl | H | CF₃ | F |
| c-propyl | 3-Me | H | OCF₃ | F | c-propyl | 3-Cl | H | OCF₃ | F |
| i-Pr | 3-Me | 5-Cl | CF₃ | F | i-Pr | 3-Cl | 5-Cl | CF₃ | F |
| t-Bu | 3-Me | H | SCF₃ | F | t-Bu | 3-Cl | H | SCF₃ | F |
| Me | 3-Me | 5-Cl | SCHF₂ | F | Me | 3-Cl | 5-Cl | SCHF₂ | F |
| Et | 3-Me | H | OCHF₂ | F | Et | 3-Cl | H | OCHF₂ | F |
| i-Pr | 3-Me | H | CF₃ | F | i-Pr | 3-Cl | H | CF₃ | F |
| t-Bu | 3-Me | H | C₂F₅ | F | t-Bu | 3-Cl | H | C₂F₅ | F |
| propargyl | 3-Me | H | C₂F₅ | F | propargyl | 3-Cl | H | C₂F₅F | |
| c-propyl | 3-Me | H | CF₃ | F | c-propyl | 3-Cl | H | CF₃ | F |
| i-Pr | 3-Me | H | Me | F | i-Pr | 3-Cl | H | Me | F |
| t-Bu | 3-Me | 5-Br | CN | F | t-Bu | 3-Cl | 5-Br | CN | F |
| Me | 3-Me | H | CF₃ | Cl | Me | 3-Cl | H | CF₃ | Cl |
| Et | 3-Me | 5-Me | 0CF₃ | Cl | Et | 3-Cl | 5-Me | OCF₃ | Cl |
| i-Pr | 3-Me | H | OCF₃ | Cl | i-Pr | 3-Cl | H | 0CF₃ | Cl |
| t-Bu | 3-Me | 5-Cl | Br | Cl | t-Bu | 3-Cl | 5-Cl | Br | Cl |
| Me | 3-Me | H | Br | Cl | Me | 3-Cl | H | Br | Cl |
| Et | 3-Me | H | Cl | Cl | Et | 3-Cl | H | Cl | Cl |
| i-Pr | 3-Me | 5-Br | Cl | Cl | i-Pr | 3-Cl | 5-Br | Cl | Cl |
| t-Bu | 3-Me | H | I | Cl | t-Bu | 3-Cl | H | I | Cl |
| propargyl | 3-Me | H | CF₃ | Cl | propargyl | 3-Cl | H | CF₃ | Cl |
| c-propyl | 3-Me | H | 0CF₃ | Cl | e-propyl | 3-Cl | H | 0CF₃ | Cl |
| i-Pr | 3-Me | 5-Cl | CF₃ | Cl | i-Pr | 3-Cl | 5-Cl | CF₃ | Cl |
| t-Bu | 3-Me | H | SCF₃ | Cl | t-Bu | 3-Cl | H | SCF₃ | Cl |
| Me | 3-Me | 5-Cl | SCHF₂ | Cl | Me | 3-Cl | 5-Cl | SCHF₂ | Cl |
| Et | 3-Me | H | OCHF₂ | Cl | Et | 3-Cl | H | OCHF₂ | Cl |
| i-Pr | 3-Me | H | CF₃ | Cl | i-Pr | 3-Cl | H | CF₃ | Cl |
| t-Bu | 3-Me | H | C₂F₅ | Cl | t-Bu | 3-Cl | H | C₂F₅ | Cl |
| propargyl | 3-Me | H | C₂F₅ | Cl | propargyl | 3-Cl | H | C₂F₅ | Cl |
| c-propyl | 3-Me | H | CF₃ | Cl | c-propyl | 3-Cl | H | CF₃ | Cl |
| i-Pr | 3-Me | H | Me | Cl | i-Pr | 3-Cl | H | Me | Cl |
| t-Bu 3-Me | 5-Br | CN | Cl | t-Bu | 3-Cl | S-Br | CN | Cl | |
| Me | 3-Me | H | CF₃ | CF₃ | Me | 3-Cl | H | CF₃ | CF₃ |
| Et | 3-Me | 5-Me | OCF₃ | CF₃ | Et | 3-Cl | 5-Me | OCF₃ | CF₃ |
| i-Pr | 3-Me | H | OCF₃ | CF₃ | i-Pr | 3-Cl | H | OCF₃ | CF₃ |
| t-Bu | 3-Me | 5-Cl | Br | CF₃ | t-Bu | 3-Cl | S-Cl | Br | CF₃ |
| Me | 3-Me | H | Br | CF₃ | Me | 3-Cl | H | Br | CF₃ |
| Et | 3-Me | H | Cl | CF₃ | Et | 3-Cl | H | Cl | CF₃ |
| i-Pr | 3-Me | 5-Br | Cl | CF₃ | i-Pr | 3-Cl | 5-Br | Cl | CF₃ |
| t-Bu | 3-Me | H | I | CF₃ | t-Bu | 3-Cl | H | I | CF₃ |
| propargyl | 3-Me | H | CF₃ | CF₃ | propargyl | 3-Cl | H | CF₃ | CF₃ |
| c-propyl | 3-Me | H | OCF₃ | CF₃ | c-propyl | 3-Cl | H | 0CF₃ | CF₃ |
| i-Pr | 3-Me | 5-Cl | CF₃ | CF₃ | i-Pr | 3-Cl | 5-Cl | CF₃ | CF₃ |
| t-Bu | 3-Me | H | SCF₃ | CF₃ | t-Bu | 3-Cl | H | SCF₃ | CF₃ |
| Me | 3-Me | 5-Cl | SCHF₂ | CF₃ | Me | 3-Cl | 5-Cl | SCHF₂ | CF₃ |
| Et | 3-Me | H | OCHF₂ | CF₃ | Et | 3-Cl | H | OCHF₂ | CF₃ |
| i-Pr | 3-Me | H | CF₃ | CF₃ | i-Pr | 3-Cl | H | CF₃ | CF₃ |
| t-Bu | 3-Me | H | C₂F₅ | CF₃ | t-Bu | 3-Cl | H | C₂F₅ | CF₃ |
| propargyl | 3-Me | H | C₂F₅ | CF₃ | propargyl | 3-Cl | H | C₂F₅ | CF₃ |
| c-propyl | 3-Me | H | CF₃ | CF₃ | c-propyl | 3-Cl | H | CF₃ | CF₃ |
| i-Pr | 3-Me | H | Me | CF₃ | i-Pr | 3-Cl | H | Me | CF₃ |
| t-Bu | 3-Me | 5-Br | CN | CF₃ | t-Bu | 3-Cl | 5-Br | CN | CF₃ |
| Me | 3-Me | H | CF₃ | Br | Me | 3-Cl | H | CF₃ | Br |
| Et | 3-Me | 5-Me | OCF₃ | Br | Et | 3-Cl | 5-Me | 0CF₃ | Br |
| i-Pr | 3-Me | H | 0CF₃ | Br | i-Pr | 3-Cl | H | OCF₃ | Br |
| t-Bu | 3-Me | 5-Cl | Br | Br | t-Bu | 3-Cl | 5-Cl | Br | Br |
| Me | 3-Me | H | Br | Br | Me | 3-Cl | H | Br | Br |
| Et | 3-Me | H | Cl | Br | Et | 3-Cl | H | Cl | Br |
| i-Pr | 3-Me | 5-Br | Cl | Br | i-Pr | 3-Cl | 5-Br | Cl | Br |
| t-Bu | 3-Me | H | I | Br | t-Bu | 3-Cl | H | I | Br |
| propargyl | 3-Me | H | CF₃ | Br | propargyl | 3-Cl | H | CF₃ | Br |
| c-propyl | 3-Me | H | OCF₃ | Br | c-propyl | 3-Cl | H | OCF₃ | Br |
| i-Pr | 3-Me | S-Cl | CF₃ | Br | i-Pr | 3-Cl | S-Cl | CF₃ | Br |
| t-Bu | 3-Me | H | SCF₃ | Br | t-Bu | 3-Cl | H | SCF₃ | Br |
| Me | 3-Me | S-Cl | SCHF₂ | Br | Me | 3-Cl | S-Cl | SCHF₂ | Br |
| Et | 3-Me | H | OCHF₂ | Br | Et | 3-Cl | H | OCHF₂ | Br |
| i-Pr | 3-Me | H | CF₃ | Br | i-Pr | 3-Cl | H | CF₃ | Br |
| t-Bu | 3-Me | H | C₂F₅ | Br | t-Bu | 3-Cl | H | C₂F₅ | Br |
| propargyl | 3-Me | H | C₂F₅ | Br | propargyl | 3-Cl | H | C₂F₅ | Br |
| c-propyl | 3-Me | H | CF₃ | Br | c-propyl | 3-Cl | H | CF₃ | Br |
| i-Pr | 3-Me | H | Me | Br | i-Pr | 3-Cl | H | Me | Br |
| t-Bu | 3-Me | 5-Br | CN | Br | t-Bu | 3-Cl | 5-Br | CN | Br |
| Me | 6-Me | H | OCHF₂ | F | Me | 6-Cl | H | OCHF₂ | F |
| Et | 6-Me | H | OCHF₂ | F | Et | 6-Cl | H | OCHF₂ | F |
| i-Pr | 6-Me | H | OCHF₂ | F | i-Pr | 6-Cl | H | OCHF₂ | F |
| t-Bu | 6-Me | H | OCHF₂ | F | t-Bu | 6-Cl | H | OCHF₂ | F |
| Me | 6-Me | H | SCHF₂ | F | Me | 6-Cl | H | SCHF₂ | F |
| Et | 6-Me | H | SCHF₂ | F | Et | 6-Cl | H | SCHF₂ | F |
| i-Pr | 6-Me | H | SCHF₂ | F | i-Pr | 6-Cl | H | SCHF₂ | F |
| t-Bu | 6-Me | H | SCHF₂ | F | t-Bu | 6-Cl | H | SCHF₂ | F |
| Me | 6-Me | H | OCF₃ | F | Me | 6-Cl | H | OCF₃ | F |
| Et | 6-Me | H | OCF₃ | F | Et | 6-Cl | H | OCF₃ | F |
| i-Pr | 6-Me | H | OCF₃ | F | i-Pr | 6-Cl | H | OCF₃ | F |
| t-Bu | 6-Me | H | OCF₃ | F | t-Bu | 6-Cl | H | OCF₃ | F |
| Me | 6-Me | H | SCF₃ | F | Me | 6-Cl | H | SCF₃ | F |
| Et | 6-Me | H | SCF₃ | F | Et | 6-Cl | H | SCF₃ | F |
| i-Pr | 6-Me | H | SCF₃ | F | i-Pr | 6-Cl | H | SCF₃ | F |
| t-Bu | 6-Me | H | SCF₃ | F | t-Bu | 6-Cl | H | SCF₃ | F |
| Me | 6-Me | H | C₂F₅ | F | Me | 6-Cl | H | C₂F₅ | F |
| Et | 6-Me | H | C₂F₅ | F | Et | 6-Cl | H | C₂F₅ | F |
| i-Pr | 6-Me | H | C₂F₅ | F | i-Pr | 6-Cl | H | C₂F₅ | F |
| t-Bu | 6-Me | H | C₂F₅ | F | t-Bu | 6-Cl | H | C₂F₅ | F |
| Me | 6-Me | H | n-C₃F₇ | F | Me | 6-Cl | H | n-C₃F₇ | F |
| Et | 6-Me | H | n-C₃F₇ | F | Et | 6-Cl | H | n-C₃F₇ | F |
| i-Pr | 6-Me | H | n-C₃F₇ | F | i-Pr | 6-Cl | H | n-C₃F₇ | F |
| t-Bu | 6-Me | H | n-C₃F₇ | F | t-Bu | 6-Cl | H | n-C₃F₇ | F |
| Me | 6-Me | H | i-C₃F₇ | F | Me | 6-Cl | H | i-C₃F₇ | F |
| Et | 6-Me | H | i-C₃F₇ | F | Et | 6-Cl | H | i-C₃F₇ | F |
| i-Pr | 6-Me | H | i-C₃F₇ | F | i-Pr | 6-Cl | H | i-C₃F₇ | F |
| t-Bu | 6-Me | H | i-C₃F₇ | F | t-Bu | 6-Cl | H | i-C₃F₇ | F |
| Me | 6-Me | H | CN | F | Me | 6-Cl | H | CN | F |
| Et | 6-Me | H | CN | F | Et | 6-Cl | H | CN | F |
| i-Pr6-Me | H | CN | F | i-Pr | 6-Cl | H | CN | F | |
| t-Bu 6-Me | H | CM | F | t-Bu | 6-Cl | H | CN | F | |
| Me | 6-Me | H | OCHF₂ | Cl | Me | 6-Cl | H | OCHF₂ | Cl |
| Et | 6-Me | H | OCHF₂ | Cl | Et | 6-Cl | H | OCHF₂ | Cl |
| i-Pr | 6-Me | H | OCHF₂ | Cl | i-Pr | 6-Cl | H | OCHF₂ | Cl |
| t-Bu | 6-Me | H | OCHF₂ | Cl | t-Bu | 6-Cl | H | OCHF₂ | Cl |
| Me | 6-Me | H | SCHF₂ | Cl | Me | 6-Cl | H | SCHF₂ | Cl |
| Et | 6-Me | H | SCHF₂ | Cl | Et | 6-Cl | H | SCHF₂ | Cl |
| i-Pr | 6-Me | H | SCHF₂ | Cl | i-Pr | 6-Cl | H | SCHF₂ | Cl |
| t-Bu | 6-Me | H | SCHF₂ | Cl | t-Bu | 6-Cl | H | SCHF₂ | Cl |
| Me | 6-Me | H | OCF₃ | Cl | Me | 6-Cl | H | OCF₃ | Cl |
| Et | 6-Me | H | OCF₃ | Cl | Et | 6-Cl | H | OCF₃ | Cl |
| i-Pr | 6-Me | H | OCF₃ | Cl | i-Pr | 6-Cl | H | OCF₃ | Cl |
| t-Bu | 6-Me | H | OCF₃ | Cl | t-Bu | 6-Cl | H | OCF₃ | Cl |
| Me | 6-Me | H | SCF₃ | Cl | Me | 6-Cl | H | SCF₃ | Cl |
| Et | 6-Me | H | SCF₃ | Cl | Et | 6-Cl | H | SCF₃ | Cl |
| i-Pr | 6-Me | H | SCF₃ | Cl | i-Pr | 6-Cl | H | SCF₃ | Cl |
| t-Bu6-Me | H | SCF₃ | Cl | t-Bu | 6-Cl | H | SCF₃ | Cl | |
| Me | 6-Me | H | C₂F₅ | Cl | Me | 6-Cl | H | C₂F₅ | Cl |
| Et | 6-Me | H | C₂F₅ | Cl | Et | 6-Cl | H | C₂F₅ | Cl |
| i-Pr | 6-Me | H | C₂F₅ | Cl | i-Pr | 6-Cl | H | C₂F₅ | Cl |
| t-Bu | 6-Me | H | C₂F₅ | Cl | t-Bu | 6-Cl | H | C₂F₅ | Cl |
| Me | 6-Me | H | n-C₃F₇ | Cl | Me | 6-Cl | H | n-C₃F₇ | Cl |
| Et | 6-Me | H | n-C₃F₇ | Cl | Et | 6-Cl | H | n-C₃F₇ | Cl |
| i-Pr | 6-Me | H | n-C₃F₇ | Cl | i-Pr | 6-Cl | H | n-C₃F₇ | Cl |
| t-Bu | 6-Me | H | n-C₃F₇ | Cl | t-Bu | 6-Cl | H | n-C₃F₇ | Cl |
| Me | 6-Me | H | i-C₃F₇ | Cl | Me | 6-Cl | H | i-C₃F₇ | Cl |
| Et | 6-Me | H | i-C₃F₇ | Cl | Et | 6-Cl | H | i-C₃F₇ | Cl |
| i-Pr | 6-Me | H | i-C₃F₇ | Cl | i-Pr | 6-Cl | H | i-C₃F₇ | Cl |
| t-Bu | 6-Me | H | i-C₃F₇ | Cl | t-Bu | 6-Cl | H | i-C₃F₇ | Cl |
| Me | 6-Me | H | CN | Cl | Me | 6-Cl | H | CN | Cl |
| Et | 6-Me | H | CN | Cl | Et | 6-Cl | H | CN | Cl |
| i-Pr | 6-Me | H | CN | Cl | i-Pr | 6-Cl | H | CN | Cl |
| t-Bu | 6-Me | H | CN | Cl | t-Bu | 6-Cl | H | CN | Cl |
| Me | 6-Me | H | OCHF₂ | Br | Me | 6-Cl | H | OCHF₂ | Br |
| Et | 6-Me | H | OCHF₂ | Br | Et | 6-Cl | H | OCHF₂ | Br |
| i-Pr | 6-Me | H | OCHF₂ | Br | i-Pr | 6-Cl | H | OCHF₂ | Br |
| t-Bu | 6-Me | H | OCHF₂ | Br | t-Bu | 6-Cl | H | OCHF₂ | Br |
| Me | 6-Me | H | SCHF₂ | Br | Me | 6-Cl | H | SCHF₂ | Br |
| Et | 6-Me | H | SCHF₂ | Br | Et | 6-Cl | H | SCHF₂ | Br |
| i-Pr | 6-Me | H | SCHF₂ | Br | i-Pr | 6-Cl | H | SCHF₂ | Br |
| t-Bu | 6-Me | H | SCHF₂ | Br | t-Bu | 6-Cl | H | SCHF₂ | Br |
| Me | 6-Me | H | OCF₃ | Br | Me | 6-Cl | H | OCF₃ | Br |
| Et | 6-Me | H | OCF₃ | Br | Et | 6-Cl | H | OCF₃ | Br |
| i-Pr | 6-Me | H | OCF₃ | Br | i-Pr | 6-Cl | H | OCF₃ | Br |
| t-Bu | 6-Me | H | OCF₃ | Br | t-Bu | 6-Cl | H | OCF₃ | Br |
| Me | 6-Me | H | SCF₃ | Br | Me | 6-Cl | H | SCF₃ | Br |
| Et | 6-Me | H | SCF₃ | Br | Et | 6-Cl | H | SCF₃ | Br |
| i-Pr | 6-Me | H | SCF₃ | Br | i-Pr | 6-Cl | H | SCF₃ | Br |
| t-Bu | 6-Me | H | SCF₃ | Br | t-Bu | 6-Cl | H | SCF₃ | Br |
| Me | 6-Me | H | C₂F₅ | Br | Me | 6-Cl | H | C₂F₅ | Br |
| Et | 6-Me | H | C₂F₅ | Br | Et | 6-Cl | H | C₂F₅ | Br |
| i-Pr | 6-Me | H | C₂F₅ | Br | i-Pr | 6-Cl | H | C₂F₅ | Br |
| t-Bu | 6-Me | H | C₂F₅ | Br | t-Bu | 6-Cl | H | C₂F₅ | Br |
| Me | 6-Me | H | n-C₃F₇ | Br | Me | 6-Cl | H | n-C₃F₇ | Br |
| Et | 6-Me | H | n-C₃F₇ | Br | Et | 6-Cl | H | n-C₃F₇ | Br |
| i-Pr | 6-Me | H | n-C₃F₇ | Br | i-Pr | 6-Cl | H | n-C₃F₇ | Br |
| t-Bu | 6-Me | H | n-C₃F₇ | Br | t-Bu | 6-Cl | H | n-C₃F₇ | Br |
| Me | 6-Me | H | i-C₃F₇ | Br | Me | 6-Cl | H | i-C₃F₇ | Br |
| Et | 6-Me | H | i-C₃F₇ | Br | Et | 6-Cl | H | i-C₃F₇ | Br |
| i-Pr | 6-Me | H | i-C₃F₇ | Br | i-Pr | 6-Cl | H | i-C₃F₇ | Br |
| t-Bu | 6-Me | H | i-C₃F₇ | Br | t-Bu | 6-Cl | H | i-C₃F₇ | Br |
| Me | 6-Me | H | CN | Br | Me | 6-Cl | H | CN | Br |
| Et | 6-Me | H | CN | Br | Et | 6-Cl | H | CN | Br |
| i-Pr | 6-Me | H | CN | Br | i-Pr | 6-Cl | H | CN | Br |
| t-Bu | 6-Me | H | CN | Br | t-Bu | 6-Cl | H | CN | Br |
| Me | 6-Me | H | OCHF₂ | CF₃ | Me | 6-Cl | H | OCHF₂ | CF₃ |
| Et | 6-Me | H | OCHF₂ | CF₃ | Et | 6-Cl | H | OCHF₂ | CF₃ |
| i-Pr | 6-Me | H | OCHF₂ | CF₃ | i-Pr | 6-Cl | H | OCHF₂ | CF₃ |
| t-Bu | 6-Me | H | OCHF₂ | CF₃ | t-Bu | 6-Cl | H | OCHF₂ | CF₃ |
| Me | 6-Me | H | SCHF₂ | CF₃ | Me | 6-Cl | H | SCHF₂ | CF₃ |
| Et | 6-Me | H | SCHF₂ | CF₃ | Et | 6-Cl | H | SCHF₂ | CF₃ |
| i-Pr | 6-Me | H | SCHF₂ | CF₃ | i-Pr | 6-Cl | H | SCHF₂ | CF₃ |
| t-Bu | 6-Me | H | SCHF₂ | CF₃ | t-Bu | 6-Cl | H | SCHF₂ | CF₃ |
| Me | 6-Me | H | 0CF₃ | CF₃ | Me | 6-Cl | H | 0CF₃ | CF₃ |
| Et | 6-Me | H | 0CF₃ | CF₃ | Et | 6-Cl | H | OCF₃ | CF₃ |
| i-Pr | 6-Me | H | 0CF₃ | CF₃ | i-Pr | 6-Cl | H | 0CF₃ | CF₃ |
| t-Bu | 6-Me | H | OCF₃ | CF₃ | t-Bu | 6-Cl | H | OCF₃ | CF₃ |
| Me | 6-Me | H | SCF₃ | CF₃ | Me | 6-Cl | H | SCF₃ | CF₃ |
| Et | 6-Me | H | SCF₃ | CF₃ | Et | 6-Cl | H | SCF₃ | CF₃ |
| i-Pr | 6-Me | H | SCF₃ | CF₃ | i-Pr | 6-Cl | H | SCF₃ | CF₃ |
| t-Bu | 6-Me | H | SCF₃ | CF₃ | t-Bu | 6-Cl | H | SCF₃ | CF₃ |
| Me | 6-Me | H | C₂F₅ | CF₃ | Me | 6-Cl | H | C₂F₅ | CF₃ |
| Et | 6-Me | H | C₂F₅ | CF₃ | Et | 6-Cl | H | C₂F₅ | CF₃ |
| i-Pr | 6-Me | H | C₂F₅ | CF₃ | i-Pr | 6-Cl | H | C₂F₅ | CF₃ |
| t-Bu | 6-Me | H | C₂F₅ | CF₃ | t-Bu | 6-Cl | H | C₂F₅ | CF₃ |
| Me | 6-Me | H | n-C₃F₇ | CF₃ | Me | 6-Cl | H | n-C₃F₇ | CF₃ |
| Et | 6-Me | H | n-C₃F₇ | CF₃ | Et | 6-Cl | H | n-C₃F₇ | CF₃ |
| i-Pr | 6-Me | H | n-C₃F₇ | CF₃ | i-Pr | 6-Cl | H | n-C₃F₇ | CF₃ |
| t-Bu | 6-Me | H | n-C₃F₇ | CF₃ | t-Bu | 6-Cl | H | n-C₃F₇ | CF₃ |
| Me | 6-Me | H | i-C₃F₇ | CF₃ | Me | 6-Cl | H | i-C₃F₇ | CF₃ |
| Et | 6-Me | H | i-C₃F₇ | CF₃ | Et | 6-Cl | H | i-C₃F₇ | CF₃ |
| i-Pr | 6-Me | H | i-C₃F₇ | CF₃ | i-Pr | 6-Cl | H | i-C₃F₇ | CF₃ |
| t-Bu | 6-Me | H | i-C₃F₇ | CF₃ | t-Bu | 6-Cl | H | i-C₃F₇ | CF₃ |
| Me | 6-Me | H | CN | CF₃ | Me | 6-Cl | H | CN | CF₃ |
| Et | 6-Me | H | CN | CF₃ | Et | 6-Cl | H | CN | CF₃ |
| i-Pr | 6-Me | H | CN | CF₃ | i-Pr | 6-Cl | H | CN | CF₃ |
| t-Bu | 6-Me | H | CN | CF₃ | t-Bu | 6-Cl | H | CN | CF₃ |
| Me | 6-Me | Cl | OCHF₂ | F | Me | 6-Cl | Cl | OCHF₂ | F |
| Et | 6-Me | Cl | OCHF₂ | F | Et | 6-Cl | Cl | OCHF₂ | F |
| i-Pr | 6-Me | Cl | OCHF₂ | F | i-Pr | 6-Cl | Cl | OCHF₂ | F |
| t-Bu | 6-Me | Cl | OCHF₂ | F | t-Bu | 6-Cl | Cl | OCHF₂ | F |
| Me | 6-Me | Cl | SCHF₂ | F | Me | 6-Cl | Cl | SCHF₂ | F |
| Et | 6-Me | Cl | SCHF₂ | F | Et | 6-Cl | Cl | SCHF₂ | F |
| i-Pr | 6-Me | Cl | SCHF₂ | F | i-Pr | 6-Cl | Cl | SCHF₂ | F |
| t-Bu | 6-Me | Cl | SCHF₂ | F | t-Bu | 6-Cl | Cl | SCHF₂ | F |
| Me | 6-Me | Cl | OCF₃ | F | Me | 6-Cl | Cl | 0CF₃ | F |
| Et | 6-Me | Cl | OCF₃ | F | Et | 6-Cl | Cl | 0CF₃ | F |
| i-Pr | 6-Me | Cl | OCF₃ | F | i-Pr | 6-Cl | Cl | 0CF₃ | F |
| t-Bu | 6-Me | Cl | OCF₃ | F | t-Bu | 6-Cl | Cl | OCF₃ | F |
| Me | 6-Me | Cl | SCF₃ | F | Me | 6-Cl | Cl | SCF₃ | F |
| Et | 6-Me | Cl | SCF₃ | F | Et | 6-Cl | Cl | SCF₃ | F |
| i-Pr | 6-Me | Cl | SCF₃ | F | i-Pr | 6-Cl | Cl | SCF₃ | F |
| t-Bu | 6-Me | Cl | SCF₃ | F | t-Bu | 6-Cl | Cl | SCF₃ | F |
| Me | 6-Me | Cl | C₂F₅ | F | Me | 6-Cl | Cl | C₂F₅ | F |
| Et | 6-Me | Cl | C₂F₅ | F | Et | 6-Cl | Cl | C₂F₅ | F |
| i-Pr | 6-Me | Cl | C₂F₅ | F | i-Pr | 6-Cl | Cl | C₂F₅ | F |
| t-Bu | 6-Me | Cl | C₂F₅ | F | t-Bu | 6-Cl | Cl | C₂F₅ | F |
| Me | 6-Me | Cl | n-C₃F₇ | F | Me | 6-Cl | Cl | n-C₃F₇ | F |
| Et | 6-Me | Cl | n-C₃F₇ | F | Et | 6-Cl | Cl | n-C₃F₇ | F |
| i-Pr | 6-Me | Cl | n-C₃F₇ | F | i-Pr | 6-Cl | Cl | n-C₃F₇ | F |
| t-Bu | 6-Me | Cl | n-C₃F₇ | F | t-Bu | 6-Cl | Cl | n-C₃F₇ | F |
| Me | 6-Me | Cl | i-C₃F₇ | F | Me | 6-Cl | Cl | i-C₃F₇ | F |
| Et | 6-Me | Cl | i-C₃F₇ | F | Et | 6-Cl | Cl | i-C₃F₇ | F |
| i-Pr | 6-Me | Cl | i-C₃F₇ | F | i-Pr | 6-Cl | Cl | i-C₃F₇ | F |
| t-Bu | 6-Me | Cl | i-C₃F₇ | F | t-Bu | 6-Cl | Cl | i-C₃F₇ | F |
| Me | 6-Me | Cl | CN | F | Me | 6-Cl | Cl | CN | F |
| Et | 6-Me | Cl | CN | F | Et | 6-Cl | Cl | CN | F |
| i-Pr | 6-Me | Cl | CN | F | i-Pr | 6-Cl | Cl | CN | F |
| t-Bu | 6-Me | Cl | CN | F | t-Bu | 6-Cl | Cl | CN | F |
| Me | 6-Me | Cl | OCHF₂ | Cl | Me | 6-Cl | Cl | OCHF₂ | Cl |
| Et | 6-Me | Cl | OCHF₂ | Cl | Et | 6-Cl | Cl | OCHF₂ | Cl |
| i-Pr | 6-Me | Cl | OCHF₂ | Cl | i-Pr | 6-Cl | Cl | OCHF₂ | Cl |
| t-Bu | 6-Me | Cl | OCHF₂ | Cl | t-Bu | 6-Cl | Cl | OCHF₂ | Cl |
| Me | 6-Me | Cl | SCHF₂ | Cl | Me | 6-Cl | Cl | SCHF₂ | Cl |
| Et | 6-Me | Cl | SCHF₂ | Cl | Et | 6-Cl | Cl | SCHF₂ | Cl |
| i-Pr | 6-Me | Cl | SCHF₂ | Cl | i-Pr | 6-Cl | Cl | SCHF₂ | Cl |
| t-Bu | 6-Me | Cl | SCHF₂ | Cl | t-Bu | 6-Cl | Cl | SCHF₂ | Cl |
| Me | 6-Me | Cl | OCF₃ | Cl | Me | 6-Cl | Cl | OCF₃ | Cl |
| Et | 6-Me | Cl | OCF₃ | Cl | Et | 6-Cl | Cl | OCF₃ | Cl |
| i-Pr | 6-Me | Cl | OCF₃ | Cl | i-Pr | 6-Cl | Cl | OCF₃ | Cl |
| t-Bu | 6-Me | Cl | OCF₃ | Cl | t-Bu | 6-Cl | Cl | OCF₃ | Cl |
| Me | 6-Me | Cl | SCF₃ | Cl | Me | 6-Cl | Cl | SCF₃ | Cl |
| Et | 6-Me | Cl | SCF₃ | Cl | Et | 6-Cl | Cl | SCF₃ | Cl |
| i-Pr | 6-Me | Cl | SCF₃ | Cl | i-Pr | 6-Cl | Cl | SCF₃ | Cl |
| t-Bu | 6-Me | Cl | SCF₃ | Cl | t-Bu | 6-Cl | Cl | SCF₃ | Cl |
| Me | 6-Me | Cl | C₂F₅ | Cl | Me | 6-Cl | Cl | C₂F₅ | Cl |
| Et | 6-Me | Cl | C₂F₅ | Cl | Et | 6-Cl | Cl | C₂F₅ | Cl |
| i-Pr | 6-Me | Cl | C₂F₅ | Cl | i-Pr | 6-Cl | Cl | C₂F₅ | Cl |
| t-Bu | 6-Me | Cl | C₂F₅ | Cl | t-Bu | 6-Cl | Cl | C₂F₅ | Cl |
| Me | 6-Me | Cl | n-C₃F₇ | Cl | Me | 6-Cl | Cl | n-C₃F₇ | Cl |
| Et | 6-Me | Cl | n-C₃F₇ | Cl | Et | 6-Cl | Cl | n-C₃F₇ | Cl |
| i-Pr | 6-Me | Cl | n-C₃F₇ | Cl | i-Pr | 6-Cl | Cl | n-C₃F₇ | Cl |
| t-Bu | 6-Me | Cl | n-C₃F₇ | Cl | t-Bu | 6-Cl | Cl | n-C₃F₇ | Cl |
| Me | 6-Me | Cl | i-C₃F₇ | Cl | Me | 6-Cl | Cl | i-C₃F₇ | Cl |
| Et | 6-Me | Cl | i-C₃F₇ | Cl | Et | 6-Cl | Cl | i-C₃F₇ | Cl |
| i-Pr | 6-Me | Cl | i-C₃F₇ | Cl | i-Pr | 6-Cl | Cl | i-C₃F₇ | Cl |
| t-Bu | 6-Me | Cl | i-C₃F₇ | Cl | t-Bu | 6-Cl | Cl | i-C₃F₇ | Cl |
| Me | 6-Me | Cl | CN | Cl | Me | 6-Cl | Cl | CN | Cl |
| Et | 6-Me | Cl | CN | Cl | Et | 6-Cl | Cl | CN | Cl |
| i-Pr | 6-Me | Cl | CN | Cl | i-Pr | 6-Cl | Cl | CN | Cl |
| t-Bu | 6-Me | Cl | CN | Cl | t-Bu | 6-Cl | Cl | CN | Cl |
| Me | 6-Me | Cl | OCHF₂ | Br | Me | 6-Cl | Cl | OCHF₂ | Br |
| Et | 6-Me | Cl | OCHF₂ | Br | Et | 6-Cl | Cl | OCHF₂ | Br |
| i-Pr | 6-Me | Cl | OCHF₂ | Br | i-Pr | 6-Cl | Cl | OCHF₂ | Br |
| t-Bu | 6-Me | Cl | OCHF₂ | Br | t-Bu | 6-Cl | Cl | OCHF₂ | Br |
| Me | 6-Me | Cl | SCHF₂ | Br | Me | 6-Cl | Cl | SCHF₂ | Br |
| Et | 6-Me | Cl | SCHF₂ | Br | Et | 6-Cl | Cl | SCHF₂ | Br |
| i-Pr | 6-Me | Cl | SCHF₂ | Br | i-Pr | 6-Cl | Cl | SCHF₂ | Br |
| t-Bu | 6-Me | Cl | SCHF₂ | Br | t-Bu | 6-Cl | Cl | SCHF₂ | Br |
| Me | 6-Me | Cl | OCF₃ | Br | Me | 6-Cl | Cl | OCF₃ | Br |
| Et | 6-Me | Cl | OCF₃ | Br | Et | 6-Cl | Cl | OCF₃ | Br |
| i-Pr | 6-Me | Cl | OCF₃ | Br | i-Pr | 6-Cl | Cl | OCF₃ | Br |
| t-Bu | 6-Me | Cl | OCF₃ | Br | t-Bu | 6-Cl | Cl | OCF₃ | Br |
| Me | 6-Me | Cl | SCF₃ | Br | Me | 6-Cl | Cl | SCF₃ | Br |
| Et | 6-Me | Cl | SCF₃ | Br | Et | 6-Cl | Cl | SCF₃ | Br |
| i-Pr | 6-Me | Cl | SCF₃ | Br | i-Pr | 6-Cl | Cl | SCF₃ | Br |
| t-Bu | 6-Me | Cl | SCF₃ | Br | t-Bu | 6-Cl | Cl | SCF₃ | Br |
| Me | 6-Me | Cl | C₂F₅ | Br | Me | 6-Cl | Cl | C₂F₅ | Br |
| Et | 6-Me | Cl | C₂F₅ | Br | Et | 6-Cl | Cl | C₂F₅ | Br |
| i-Pr | 6-Me | Cl | C₂F₅ | Br | i-Pr | 6-Cl | Cl | C₂F₅ | Br |
| t-Bu | 6-Me | Cl | C₂F₅ | Br | t-Bu | 6-Cl | Cl | C₂F₅ | Br |
| Me | 6-Me | Cl | n-C₃F₇ | Br | Me | 6-Cl | Cl | n-C₃F₇ | Br |
| Et | 6-Me | Cl | n-C₃F₇ | Br | Et | 6-Cl | Cl | n-C₃F₇ | Br |
| i-Pr | 6-Me | Cl | n-C₃F₇ | Br | i-Pr | 6-Cl | Cl | n-C₃F₇ | Br |
| t-Bu | 6-Me | Cl | n-C₃F₇ | Br | t-Bu | 6-Cl | Cl | n-C₃F₇ | Br |
| Me | 6-Me | Cl | i-C₃F₇ | Br | Me | 6-Cl | Cl | i-C₃F₇ | Br |
| Et | 6-Me | Cl | i-C₃F₇ | Br | Et | 6-Cl | Cl | i-C₃F₇ | Br |
| i-Pr | 6-Me | Cl | i-C₃F₇ | Br | i-Pr | 6-Cl | Cl | i-C₃F₇ | Br |
| t-Bu | 6-Me | Cl | i-C₃F₇ | Br | t-Bu | 6-Cl | Cl | i-C₃F₇ | Br |
| Me | 6-Me | Cl | CN | Br | Me | 6-Cl | Cl | CN | Br |
| Et | 6-Me | Cl | CN | Br | Et | 6-Cl | Cl | CN | Br |
| i-Pr | 6-Me | Cl | CN | Br | i-Pr | 6-Cl | Cl | CN | Br |
| t-Bu | 6-Me | Cl | CN | Br | t-Bu | 6-Cl | Cl | CN | Br |
| Me | 6-Me | Cl | OCHF₂ | CF₃ | Me | 6-Cl | Cl | OCHF₂ | CF₃ |
| Et | 6-Me | Cl | OCHF₂ | CF₃ | Et | 6-Cl | Cl | OCHF₂ | CF₃ |
| i-Pr | 6-Me | Cl | OCHF₂ | CF₃ | i-Pr | 6-Cl | Cl | OCHF₂ | CF₃ |
| t-Bu | 6-Me | Cl | OCHF₂ | CF₃ | t-Bu | 6-Cl | Cl | OCHF₂ | CF₃ |
| Me | 6-Me | Cl | SCHF₂ | CF₃ | Me | 6-Cl | Cl | SCHF₂ | CF₃ |
| Et | 6-Me | Cl | SCHF₂ | CF₃ | Et | 6-Cl | Cl | SCHF₂ | CF₃ |
| i-Pr | 6-Me | Cl | SCHF₂ | CF₃ | i-Pr | 6-Cl | Cl | SCHF₂ | CF₃ |
| t-Bu | 6-Me | Cl | SCHF₂ | CF₃ | t-Bu | 6-Cl | Cl | SCHF₂ | CF₃ |
| Me | 6-Me | Cl | OCF₃ | CF₃ | Me | 6-Cl | Cl | OCF₃ | CF₃ |
| Et | 6-Me | Cl | OCF₃ | CF₃ | Et | 6-Cl | Cl | OCF₃ | CF₃ |
| i-Pr | 6-Me | Cl | OCF₃ | CF₃ | i-Pr | 6-Cl | Cl | 0CF₃ | CF₃ |
| t-Bu | 6-Me | Cl | OCF₃ | CF₃ | t-Bu | 6-Cl | Cl | OCF₃ | CF₃ |
| Me | 6-Me | Cl | SCF₃ | CF₃ | Me | 6-Cl | Cl | SCF₃ | CF₃ |
| Et | 6-Me | Cl | SCF₃ | CF₃ | Et | 6-Cl | Cl | SCF₃ | CF₃ |
| i-Pr | 6-Me | Cl | SCF₃ | CF₃ | i-Pr | 6-Cl | Cl | SCF₃ | CF₃ |
| t-Bu | 6-Me | Cl | SCF₃ | CF₃ | t-Bu | 6-Cl | Cl | SCF₃ | CF₃ |
| Me | 6-Me | Cl | C₂F₅ | CF₃ | Me | 6-Cl | Cl | C₂F₅ | CF₃ |
| Et | 6-Me | Cl | C₂F₅ | CF₃ | Et | 6-Cl | Cl | C₂F₅ | CF₃ |
| i-Pr | 6-Me | Cl | C₂F₅ | CF₃ | i-Pr | 6-Cl | Cl | C₂F₅ | CF₃ |
| t-Bu | 6-Me | Cl | C₂F₅ | CF₃ | t-Bu | 6-Cl | Cl | C₂F₅ | CF₃ |
| Me | 6-Me | Cl | n-C₃F₇ | CF₃ | Me | 6-Cl | Cl | n-C₃F₇ | CF₃ |
| Et | 6-Me | Cl | n-C₃F₇ | CF₃ | Et | 6-Cl | Cl | n-C₃F₇ | CF₃ |
| i-Pr | 6-Me | Cl | n-C₃F₇ | CF₃ | i-Pr | 6-Cl | Cl | n-C₃F₇ | CF₃ |
| t-Bu | 6-Me | Cl | n-C₃F₇ | CF₃ | t-Bu | 6-Cl | Cl | n-C₃F₇ | CF₃ |
| Me | 6-Me | Cl | i-C₃F₇ | CF₃ | Me | 6-Cl | Cl | i-C₃F₇ | CF₃ |
| Et | 6-Me | Cl | i-C₃F₇ | CF₃ | Et | 6-Cl | Cl | i-C₃F₇ | CF₃ |
| i-Pr | 6-Me | Cl | i-C₃F₇ | CF₃ | i-Pr | 6-Cl | Cl | i-C₃F₇ | CF₃ |
| t-Bu | 6-Me | Cl | i-C₃F₇ | CF₃ | t-Bu | 6-Cl | Cl | i-C₃F₇ | CF₃ |
| Me | 6-Me | Cl | CN | CF₃ | Me | 6-Cl | Cl | CN | CF₃ |
| Et | 6-Me | Cl | CN | CF₃ | Et | 6-Cl | Cl | CN | CF₃ |
| i-Pr | 6-Me | Cl | CN | CF₃ | i-Pr | 6-Cl | Cl | CN | CF₃ |
| t-Bu | 6-Me | Cl | CN | CF₃ | t-Bu | 6-Cl | Cl | CN | CF₃ |

TABLE 15

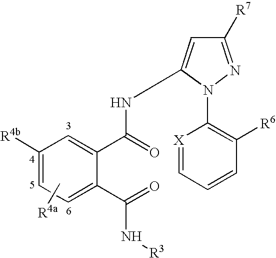

| R³ | R^{4a} | R^{4b} | R⁷ | R⁶ | X | R³ | R^{4a} | R^{4b} | R⁷ | R⁶ | X |
|---|---|---|---|---|---|---|---|---|---|---|---|
| Me | 6-Me | H | OCHF₂ | F | CH | Me | 6-Cl | H | OCHF₂ | F | CH |
| Et | 6-Me | H | OCHF₂ | F | CH | Et | 6-Cl | H | OCHF₂ | F | CH |
| i-Pr | 6-Me | H | OCHF₂ | F | CH | i-Pr | 6-Cl | H | OCHF₂ | F | CH |
| t-Bu | 6-Me | H | OCHF₂ | F | CH | t-Bu | 6-Cl | H | OCHF₂ | F | CH |
| Me | 6-Me | H | SCHF₂ | F | CH | Me | 6-Cl | H | SCHF₂ | F | CH |
| Et | 6-Me | H | SCHF₂ | F | CH | Et | 6-Cl | H | SCHF₂ | F | CH |
| i-Pr | 6-Me | H | SCHF₂ | F | CH | i-Pr | 6-Cl | H | SCHF₂ | F | CH |
| t-13u | 6-Me | H | SCHF₂ | F | CH | t-Bu | 6-Cl | H | SCHF₂ | F | CH |
| Me | 6-Me | H | OCF₃ | F | CH | Me | 6-Cl | H | OCF₃ | F | CH |
| Et | 6-Me | H | OCF₃ | F | CH | Et | 6-Cl | H | OCF₃ | F | CH |
| i-Pr | 6-Me | H | OCF₃ | F | CH | i-Pr | 6-Cl | H | OCF₃ | F | CH |
| t-Bu | 6-Me | H | OCF₃ | F | CH | t-Bu | 6-Cl | H | OCF₃ | F | CH |
| Me | 6-Me | H | SCF₃ | F | CH | Me | 6-Cl | H | SCF₃ | F | CH |
| Et | 6-Me | H | SCF₃ | F | CH | Et | 6-Cl | H | SCF₃ | F | CH |
| i-Pr | 6-Me | H | SCF₃ | F | CH | i-Pr | 6-Cl | H | SCF₃ | F | CH |
| t-Bu | 6-Me | H | SCF₃ | F | CH | t-Bu | 6-Cl | H | SCF₃ | F | CH |
| Me | 6-Me | H | C₂F₅ | F | CH | Me | 6-Cl | H | C₂F₅ | F | CH |
| Et | 6-Me | H | C₂F₅ | F | CH | Et | 6-Cl | H | C₂F₅ | F | CH |
| i-Pr | 6-Me | H | C₂F₅ | F | CH | i-Pr | 6-Cl | H | C₂F₅ | F | CH |
| t-Bu | 6-Me | H | C₂F₅ | F | CH | t-Bu | 6-Cl | H | C₂F₅ | F | CH |
| Me | 6-Me | H | n-C₃F₇ | F | CH | Me | 6-Cl | H | n-C₃F₇ | F | CH |
| Et | 6-Me | H | n-C₃F₇ | F | CH | Et | 6-Cl | H | n-C₃F₇ | F | CH |
| i-Pr | 6-Me | H | n-C₃F₇ | F | CH | i-Pr | 6-Cl | H | n-C₃F₇ | F | CH |
| t-Bu | 6-Me | H | n-C₃F₇ | F | CH | t-Bu | 6-Cl | H | n-C₃F₇ | F | CH |
| Me | 6-Me | H | i-C₃F₇ | F | CH | Me | 6-Cl | H | i-C₃F₇ | F | CH |
| Et | 6-Me | H | i-C₃F₇ | F | OH | Et | 6-Cl | H | i-C₃F₇ | F | CH |
| i-Pr | 6-Me | H | i-C₃F₇ | F | CH | i-Pr | 6-Cl | H | i-C₃F₇ | F | CH |
| t-Bu | 6-Me | H | i-C₃F₇ | F | CH | t-Bu | 6-Cl | H | i-C₃F₇ | F | CH |
| Me | 6-Me | H | CN | F | CH | Me | 6-Cl | H | CN | F | CH |
| Et | 6-Me | H | CN | F | CH | Et | 6-Cl | H | CN | F | CH |
| i-Pr | 6-Me | H | CH | F | CH | i-Pr | 6-Cl | H | CN | F | CH |
| t-Bu | 6-Me | H | CH | F | OH | t-Bu | 6-Cl | H | CN | F | CH |
| Me | 6-Me | H | OCHF₂ | Cl | CH | Me | 6-Cl | H | OCHF₂ | Cl | CH |
| Et | 6-Me | H | OCHF₂ | Cl | CH | Et | 6-Cl | H | OCHF₂ | Cl | CH |
| i-Pr | 6-Me | H | OCHF₂ | Cl | CH | i-Pr | 6-Cl | H | OCHF₂ | Cl | CH |
| t-Bu | 6-Me | H | OCHF₂ | Cl | CH | t-Bu | 6-Cl | H | OCHF₂ | Cl | CH |
| Me | 6-Me | H | SCHF₂ | Cl | CH | Me | 6-Cl | H | SCHF₂ | Cl | CH |
| Et | 6-Me | H | SCHF₂ | Cl | CH | Et | 6-Cl | H | SCHF₂ | Cl | CH |
| i-Pr | 6-Me | H | SOHF₂ | Cl | CH | i-Pr | 6-Cl | H | SCHF₂ | Cl | CH |
| t-Bu | 6-Me | H | SCHF₂ | Cl | CH | t-Bu | 6-Cl | H | SCHF₂ | Cl | CH |
| Me | 6-Me | H | OCF₃ | Cl | CH | Me | 6-Cl | H | OCF₃ | Cl | CH |
| Et | 6-Me | H | OCF₃ | Cl | CH | Et | 6-Cl | H | OCF₃ | Cl | CH |
| i-Pr | 6-Me | H | OCF₃ | Cl | CH | i-Pr | 6-Cl | H | OCF₃ | Cl | CH |
| t-Bu | 6-Me | H | OCF₃ | Cl | CH | t-Bu | 6-Cl | H | OCF₃ | Cl | CH |
| Me | 6-Me | H | SCF₃ | Cl | CH | Me | 6-Cl | H | SCF₃ | Cl | CH |
| Et | 6-Me | H | SCF₃ | Cl | CH | Et | 6-Cl | H | SCF₃ | Cl | CH |
| i-Pr | 6-Me | H | SCF₃ | Cl | CH | i-Pr | 6-Cl | H | SCF₃ | Cl | CH |
| t-Bu | 6-Me | H | SOF₃ | Cl | CH | t-Bu | 6-Cl | H | SOF₃ | Cl | CH |
| Me | 6-Me | H | C₂F₅ | Cl | CH | Me | 6-Cl | H | C₂F₅ | Cl | CH |
| Et | 6-Me | H | C₂F₅ | Cl | CH | Et | 6-Cl | H | C₂F₅ | Cl | CH |
| i-Pr | 6-Me | H | C₂F₅ | Cl | CH | i-Pr | 6-Cl | H | C₂F₅ | Cl | CH |
| t-Bu | 6-Me | H | C₂F₅ | Cl | CH | t-Bu | 6-Cl | H | C₂F₅ | Cl | CH |
| Me | 6-Me | H | n-C₃F₇ | Cl | CH | Me | 6-Cl | H | n-C₃F₇ | Cl | CH |
| Et | 6-Me | H | n-C₃F₇ | Cl | CH | Et | 6-Cl | H | n-C₃F₇ | Cl | CH |
| i-Pr | 6-Me | H | n-C₃F₇ | Cl | CH | i-Pr | 6-Cl | H | n-C₃F₇ | Cl | CH |
| t-Bu | 6-Me | H | n-C₃F₇ | Cl | CH | t-Bu | 6-Cl | H | n-C₃F₇ | Cl | CH |
| Me | 6-Me | H | i-C₃F₇ | Cl | CH | Me | 6-Cl | H | i-C₃F₇ | Cl | CH |
| Et | 6-Me | H | i-C₃F₇ | Cl | CH | Et | 6-Cl | H | i-C₃F₇ | Cl | CH |
| i-Pr | 6-Me | H | i-C₃F₇ | Cl | CH | i-Pr | 6-Cl | H | i-C₃F₇ | Cl | CH |
| t-Bu | 6-Me | H | i-C₃F₇ | Cl | CH | t-Bu | 6-Cl | H | i-C₃F₇ | Cl | CH |
| Me | 6-Me | H | CN | Cl | CH | Me | 6-Cl | H | CN | Cl | CH |
| Et | 6-Me | H | CN | Cl | CH | Et | 6-Cl | H | CN | Cl | CH |
| i-Pr | 6-Me | H | CN | Cl | CH | i-Pr | 6-Cl | H | CN | Cl | CH |
| t-Bu | 6-Me | H | CN | Cl | CH | t-Bu | 6-Cl | H | CN | Cl | CH |
| Me | 6-Me | H | OCHF₂ | Br | CH | Me | 6-Cl | H | OCHF₂ | Br | CH |
| Et | 6-Me | H | OCHF₂ | Br | CH | Et | 6-Cl | H | OCHF₂ | Br | CH |
| i-Pr | 6-Me | H | OCHF₂ | Br | CH | i-Pr | 6-Cl | H | OCHF₂ | Br | CH |
| t-Bu | 6-Me | H | OCHF₂ | Br | CH | t-Bu | 6-Cl | H | OCHF₂ | Br | CH |
| Me | 6-Me | H | SCHF₂ | Br | CH | Me | 6-Cl | H | SCHF₂ | Br | CH |
| Et | 6-Me | H | SCHF₂ | Br | CH | Et | 6-Cl | H | SCHF₂ | Br | CH |
| i-Pr | 6-Me | H | SCHF₂ | Br | CH | i-Pr | 6-Cl | H | SCHF₂ | Br | CH |
| t-Bu | 6-Me | H | SCHF₂ | Br | CH | t-Bu | 6-Cl | H | SCHF₂ | Br | CH |
| Me | 6-Me | H | OCF₃ | Br | CH | Me | 6-Cl | H | OCF₃ | Br | CH |
| Et | 6-Me | H | OCF₃ | Br | CH | Et | 6-Cl | H | OCF₃ | Br | CH |
| i-Pr | 6-Me | H | OCF₃ | Br | CH | i-Pr | 6-Cl | H | OCF₃ | Br | CH |
| t-Bu | 6-Me | H | OCF₃ | Br | CH | t-Bu | 6-Cl | H | OCF₃ | Br | CH |
| Me | 6-Me | H | SCF₃ | Br | CH | Me | 6-Cl | H | SCF₃ | Br | CH |
| Et | 6-Me | H | SCF₃ | Br | CH | Et | 6-Cl | H | SCF₃ | Br | CH |
| i-Pr | 6-Me | H | SCF₃ | Br | CH | i-Pr | 6-Cl | H | SCF₃ | Br | CH |
| t-Bu | 6-Me | H | SCF₃ | Br | CH | t-Bu | 6-Cl | H | SCF₃ | Br | CH |
| Me | 6-Me | H | C₂F₅ | Br | CH | Me | 6-Cl | H | C₂F₅ | Br | CH |
| Et | 6-Me | H | C₂F₅ | Br | CH | Et | 6-Cl | H | C₂F₅ | Br | CH |
| i-Pr | 6-Me | H | C₂F₅ | Br | CH | i-Pr | 6-Cl | H | C₂F₅ | Br | CH |
| t-Bu | 6-Me | H | C₂F₅ | Br | CH | t-Bu | 6-Cl | H | C₂F₅ | Br | CH |
| Me | 6-Me | H | n-C₃F₇ | Br | CH | Me | 6-Cl | H | n-C₃F₇ | Br | CH |
| Et | 6-Me | H | n-C₃F₇ | Br | CH | Et | 6-Cl | H | n-C₃F₇ | Br | CH |
| i-Pr | 6-Me | H | n-C₃F₇ | Br | CH | i-Pr | 6-Cl | H | n-C₃F₇ | Br | CH |
| t-Bu | 6-Me | H | n-C₃F₇ | Br | CH | t-Bu | 6-Cl | H | n-C₃F₇ | Br | CH |
| Me | 6-Me | H | i-C₃F₇ | Br | CH | Me | 6-Cl | H | i-C₃F₇ | Br | CH |
| Et | 6-Me | H | i-C₃F₇ | Br | CH | Et | 6-Cl | H | i-C₃F₇ | Br | CH |
| i-Pr | 6-Me | H | i-C₃F₇ | Br | CH | i-Pr | 6-Cl | H | i-C₃F₇ | Br | CH |
| t-Bu | 6-Me | H | i-C₃F₇ | Br | CH | t-Bu | 6-Cl | H | i-C₃F₇ | Br | CH |
| Me | 6-Me | H | CN | Br | CH | Me | 6-Cl | H | CN | Br | CH |
| Et | 6-Me | H | CN | Br | CH | Et | 6-Cl | H | CN | Br | CH |
| i-Pr | 6-Me | H | CN | Br | CH | i-Pr | 6-Cl | H | CN | Br | CH |
| t-Bu | 6-Me | H | CN | Br | CH | t-Bu | 6-Cl | H | CN | Br | CH |
| Me | 6-Me | H | OCHF₂ | CF₃ | CH | Me | 6-Cl | H | OCHF₂ | CF₃ | CH |
| Et | 6-Me | H | OCHF₂ | CF₃ | CH | Et | 6-Cl | H | OCHF₂ | CF₃ | CH |
| i-Pr | 6-Me | H | OCHF₂ | CF₃ | CH | i-Pr | 6-Cl | H | OCHF₂ | CF₃ | CH |
| t-Bu | 6-Me | H | OCHF₂ | CF₃ | CH | t-Bu | 6-Cl | H | OCHF₂ | CF₃ | CH |
| Me | 6-Me | H | SCHF₂ | CF₃ | CH | Me | 6-Cl | H | SCHF₂ | CF₃ | CH |
| Et | 6-Me | H | SCHF₂ | CF₃ | CH | Et | 6-Cl | H | SCHF₂ | CF₃ | CH |
| i-Pr | 6-Me | H | SCHF₂ | CF₃ | CH | i-Pr | 6-Cl | H | SCHF₂ | CF₃ | CH |
| t-Bu | 6-Me | H | SCHF₂ | CF₃ | CH | t-Bu | 6-Cl | H | SCHF₂ | CF₃ | CH |
| Me | 6-Me | H | OCF₃ | CF₃ | CH | Me | 6-Cl | H | OCF₃ | CF₃ | CH |
| Et | 6-Me | H | OCF₃ | CF₃ | CH | Et | 6-Cl | H | OCF₃ | CF₃ | CH |
| i-Pr | 6-Me | H | OCF₃ | CF₃ | CH | i-Pr | 6-Cl | H | OCF₃ | CF₃ | CH |
| t-Bu | 6-Me | H | OCF₃ | CF₃ | CH | t-Bu | 6-Cl | H | OCF₃ | CF₃ | CH |
| Me | 6-Me | H | SCF₃ | CF₃ | CH | Me | 6-Cl | H | SCF₃ | CF₃ | CH |
| Et | 6-Me | H | SCF₃ | CF₃ | CH | Et | 6-Cl | H | SCF₃ | CF₃ | CH |
| i-Pr | 6-Me | H | SCF₃ | CF₃ | CH | i-Pr | 6-Cl | H | SCF₃ | CF₃ | CH |
| t-Bu | 6-Me | H | SCF₃ | CF₃ | CH | t-Bu | 6-Cl | H | SCF₃ | CF₃ | CH |
| Me | 6-Me | H | C₂F₅ | CF₃ | CH | Me | 6-Cl | H | C₂F₅ | CF₃ | CH |
| Et | 6-Me | H | C₂F₅ | CF₃ | CH | Et | 6-Cl | H | C₂F₅ | CF₃ | CH |
| i-Pr | 6-Me | H | C₂F₅ | CF₃ | CH | i-Pr | 6-Cl | H | C₂F₅ | CF₃ | CH |
| t-Bu | 6-Me | H | C₂F₅ | CF₃ | CH | t-Bu | 6-Cl | H | C₂F₅ | CF₃ | CH |
| Me | 6-Me | H | n-C₃F₇ | CF₃ | CH | Me | 6-Cl | H | n-C₃F₇ | CF₃ | CH |
| Et | 6-Me | H | n-C₃F₇ | CF₃ | CH | Et | 6-Cl | H | n-C₃F₇ | CF₃ | CH |
| i-Pr | 6-Me | H | n-C₃F₇ | CF₃ | CH | i-Pr | 6-Cl | H | n-C₃F₇ | CF₃ | CH |
| t-Bu | 6-Me | H | n-C₃F₇ | CF₃ | CH | t-Bu | 6-Cl | H | n-C₃F₇ | CF₃ | CH |
| Me | 6-Me | H | i-C₃F₇ | CF₃ | CH | Me | 6-Cl | H | i-C₃F₇ | CF₃ | CH |
| Et | 6-Me | H | i-C₃F₇ | CF₃ | CH | Et | 6-Cl | H | i-C₃F₇ | CF₃ | CH |
| i-Pr | 6-Me | H | i-C₃F₇ | CF₃ | CH | i-Pr | 6-Cl | H | i-C₃F₇ | CF₃ | CH |
| t-Bu | 6-Me | H | i-C₃F₇ | CF₃ | CH | t-Bu | 6-Cl | H | i-C₃F₇ | CF₃ | CH |
| Me | 6-Me | H | CN | CF₃ | CH | Me | 6-Cl | H | CN | CF₃ | CH |
| Et | 6-Me | H | CN | CF₃ | CH | Et | 6-Cl | H | CN | CF₃ | CH |
| i-Pr | 6-Me | H | CN | CF₃ | CH | i-Pr | 6-Cl | H | CN | CF₃ | CH |
| t-Bu | 6-Me | H | CN | CF₃ | CH | t-Bu | 6-Cl | H | CN | CF₃ | CH |
| Me | 6-Me | Cl | OCHF₂ | F | CH | Me | 6-Cl | Cl | OCHF₂ | F | CH |
| Et | 6-Me | Cl | OCHF₂ | F | CH | Et | 6-Cl | Cl | OCHF₂ | F | CH |
| i-Pr | 6-Me | Cl | OCHF₂ | F | CH | i-Pr | 6-Cl | Cl | OCHF₂ | F | CH |
| t-Bu | 6-Me | Cl | OCHF₂ | F | CH | t-Bu | 6-Cl | Cl | OCHF₂ | F | CH |
| Me | 6-Me | Cl | SCHF₂ | F | CH | Me | 6-Cl | Cl | SCHF₂ | F | CH |
| Et | 6-Me | Cl | SCHF₂ | F | CH | Et | 6-Cl | Cl | SCHF₂ | F | CH |
| i-Pr | 6-Me | Cl | SCHF₂ | F | CH | i-Pr | 6-Cl | Cl | SCHF₂ | F | CH |
| t-Bu | 6-Me | Cl | SCHF₂ | F | CH | t-Bu | 6-Cl | Cl | SCHF₂ | F | CH |
| Me | 6-Me | Cl | OCF₃ | F | Ch | Me | 6-Cl | Cl | OCF₃ | F | CH |
| Et | 6-Me | Cl | OCF₃ | F | CH | Et | 6-Cl | Cl | OCF₃ | F | CH |
| i-Pr | 6-Me | Cl | OCF₃ | F | CH | i-Pr | 6-Cl | Cl | OCF₃ | F | CH |
| t-Bu | 6-Me | Cl | OCF₃ | F | CH | t-Bu | 6-Cl | Cl | OCF₃ | F | CH |
| Me | 6-Me | Cl | SCF₃ | F | Ch | Me | 6-Cl | Cl | SCF₃ | F | CH |
| Et | 6-Me | Cl | SCF₃ | F | CH | Et | 6-Cl | Cl | SCF₃ | F | CH |
| i-Pr | 6-Me | Cl | SCF₃ | F | CH | i-Pr | 6-Cl | Cl | SCF₃ | F | CH |
| t-Bu | 6-Me | Cl | SCF₃ | F | CH | t-Bu | 6-Cl | Cl | SCF₃ | F | CH |
| Me | 6-Me | Cl | C₂F₅ | F | Ch | Me | 6-Cl | Cl | C₂F₅ | F | CH |
| Et | 6-Me | Cl | C₂F₅ | F | CH | Et | 6-Cl | Cl | C₂F₅ | F | CH |
| i-Pr | 6-Me | Cl | C₂F₅ | F | CH | i-Pr | 6-Cl | Cl | C₂F₅ | F | CH |
| t-Bu | 6-Me | Cl | C₂F₅ | F | CH | t-Bu | 6-Cl | Cl | C₂F₅ | F | CH |
| Me | 6-Me | Cl | n-C₃F₇ | F | CH | Me | 6-Cl | Cl | n-C₃F₇ | F | CH |
| Et | 6-Me | Cl | n-C₃F₇ | F | CH | Et | 6-Cl | Cl | n-C₃F₇ | F | CH |
| i-Pr | 6-Me | Cl | n-C₃F₇ | F | CH | i-Pr | 6-Cl | Cl | n-C₃F₇ | F | CH |
| t-Bu | 6-Me | Cl | n-C₃F₇ | F | CH | t-Bu | 6-Cl | Cl | n-C₃F₇ | F | CH |
| Me | 6-Me | Cl | i-C₃F₇ | F | CH | Me | 6-Cl | H | n-C₃F₇ | F | CH |
| Et | 6-Me | Cl | i-C₃F₇ | F | CH | Et | 6-Cl | H | n-C₃F₇ | F | CH |
| i-Pr | 6-Me | Cl | i-C₃F₇ | F | CH | i-Pr | 6-Cl | Cl | i-C₃F₇ | F | CH |
| t-Bu | 6-Me | Cl | i-C₃F₇ | F | CH | t-Bu | 6-Cl | Cl | i-C₃F₇ | F | CH |
| Me | 6-Me | Cl | CN | F | CH | Me | 6-Cl | Cl | CN | F | CH |
| Et | 6-Me | Cl | CN | F | CH | Et | 6-Cl | Cl | CN | F | CH |
| i-Pr | 6-Me | Cl | CN | F | CH | i-Pr | 6-Cl | Cl | CN | F | CH |
| t-Bu | 6-Me | Cl | CN | F | CH | t-Bu | 6-Cl | Cl | CN | F | CH |
| Me | 6-Me | Cl | OCHF₂ | Cl | CH | Me | 6-Cl | Cl | OCHF₂ | Cl | CH |
| Et | 6-Me | Cl | OCHF₂ | Cl | CH | Et | 6-Cl | Cl | OCHF₂ | Cl | CH |
| i-Pr | 6-Me | Cl | OCHF₂ | Cl | CH | i-Pr | 6-Cl | Cl | OCHF₂ | Cl | CH |
| t-Bu | 6-Me | Cl | OCHF₂ | Cl | CH | t-Bu | 6-Cl | Cl | OCHF₂ | Cl | CH |
| Me | 6-Me | Cl | SCHF₂ | Cl | CH | Me | 6-Cl | Cl | SCHF₂ | Cl | CH |
| Et | 6-Me | Cl | SCHF₂ | Cl | CH | Et | 6-Cl | Cl | SCHF₂ | Cl | CH |
| i-Pr | 6-Me | Cl | SCHF₂ | Cl | CH | i-Pr | 6-Cl | Cl | SCIHF₂ | Cl | CH |
| t-Bu | 6-Me | Cl | SCUF₂ | Cl | CH | t-Bu | 6-Cl | Cl | SCHF₂ | Cl | CH |
| Me | 6-Me | Cl | OCF₃ | Cl | CH | Me | 6-Cl | Cl | OCF₃ | Cl | CH |
| Et | 6-Me | Cl | OCF₃ | Cl | CH | Et | 6-Cl | Cl | OCF₃ | Cl | CH |
| i-Pr | 6-Me | Cl | OCF₃ | Cl | CH | i-Pr | 6-Cl | Cl | OCF₃ | Cl | CU |
| t-Bu | 6-Me | Cl | OCF₃ | Cl | CH | t-Bu | 6-Cl | Cl | OCF₃ | Cl | CH |
| Me | 6-Me | Cl | SCF₃ | Cl | CH | Me | 6-Cl | Cl | SCF₃ | Cl | CH |
| Et | 6-Me | Cl | SCF₃ | Cl | CH | Et | 6-Cl | Cl | SCF₃ | Cl | CH |
| i-Pr | 6-Me | Cl | SCF₃ | Cl | CH | i-Pr | 6-Cl | Cl | SCF₃ | Cl | CH |
| t-Bu | 6-Me | Cl | SCF₃ | Cl | CH | t-Bu | 6-Cl | Cl | SCF₃ | Cl | CH |
| Me | 6-Me | Cl | C₂F₅ | Cl | CH | Me | 6-Cl | Cl | C₂F₅ | Cl | CH |
| Et | 6-Me | Cl | C₂F₅ | Cl | CH | Et | 6-Cl | Cl | C₂F₅ | Cl | CH |
| i-Pr | 6-Me | Cl | C₂F₅ | Cl | CH | i-Pr | 6-Cl | Cl | C₂F₅ | Cl | CH |
| t-Bu | 6-Me | Cl | C₂F₅ | Cl | CH | t-Bu | 6-Cl | Cl | C₂F₅ | Cl | CH |
| Me | 6-Me | Cl | n-C₃F₇ | Cl | CH | Me | 6-Cl | Cl | n-C₃F₇ | Cl | CH |
| Et | 6-Me | Cl | n-C₃F₇ | Cl | CH | Et | 6-Cl | Cl | n-C₃F₇ | Cl | CH |
| i-Pr | 6-Me | Cl | n-C₃F₇ | Cl | Cl | i-Pr | 6-Cl | Cl | n-C₃F₇ | Cl | CH |
| t-Bu | 6-Me | Cl | n-C₃F₇ | Cl | CH | t-Bu | 6-Cl | Cl | n-C₃F₇ | Cl | CH |
| Me | 6-Me | Cl | i-C₃F₇ | Cl | CH | Me | 6-Cl | Cl | i-C₃F₇ | Cl | CH |
| Et | 6-Me | Cl | i-C₃F₇ | Cl | CH | Et | 6-Cl | Cl | i-C₃F₇ | Cl | CH |
| i-Pr | 6-Me | Cl | i-C₃F₇ | Cl | CH | i-Pr | 6-Cl | Cl | i-C₃F_{7Cl} | CH | |
| t-Bu | 6-Me | Cl | i-C₃F₇ | Cl | CH | t-Bu | 6-Cl | Cl | i-C₃F_{7Cl} | ~li | |
| Me | 6-Me | Cl | CN | Cl | CH | Me | 6-Cl | Cl | CN | Cl | CH |
| Et | 6-Me | Cl | CN | Cl | CH | Et | 6-Cl | Cl | CN | Cl | CH |
| i-Pr | 6-Me | Cl | CN | Cl | CH | i-Pr | 6-Cl | Cl | CN | Cl | CH |
| t-Bu | 6-Me | Cl | CN | Cl | CH | t-Bu | 6-Cl | Cl | CN | Cl | CH |
| Me | 6-Me | Cl | OCHF₂ | Br | CH | Me | 6-Cl | Cl | OCHF₂ | Br | CH |
| Et | 6-Me | Cl | OCHF₂ | Br | CH | Et | 6-Cl | Cl | OCHF₂ | Br | CH |
| i-Pr | 6-Me | Cl | OCHF₂ | Br | CH | i-Pr | 6-Cl | Cl | OCHF₂ | Br | CH |
| t-Bu | 6-Me | Cl | OCHF₂ | Br | CH | t-Bu | 6-Cl | Cl | OCHF₂ | Br | CH |
| Me | 6-Me | Cl | SCHF₂ | Br | CH | Me | 6-Cl | Cl | SCHF₂ | Br | CH |
| Et | 6-Me | Cl | SCHF₂ | Br | CH | Et | 6-Cl | Cl | SCHF₂ | Br | CH |
| i-Pr | 6-Me | Cl | SCHF₂ | Br | CH | i-Pr | 6-Cl | Cl | SCHF₂ | Br | CH |
| t-Bu | 6-Me | Cl | SCHF₂ | Br | CH | t-Bu | 6-Cl | Cl | SCHF₂ | Br | CH |
| Me | 6-Me | Cl | OCF₃ | Br | CH | Me | 6-Cl | Cl | OCF₃ | Br | CH |
| Et | 6-Me | Cl | OCF₃ | Br | CH | Et | 6-Cl | Cl | OCF₃ | Br | CH |
| i-Pr | 6-Me | Cl | OCF₃ | Br | CH | i-Pr | 6-Cl | Cl | OCF₃ | Br | CH |
| t-Bu | 6-Me | Cl | OCF₃ | Br | CH | t-Bu | 6-Cl | Cl | OCF₃ | Br | CH |
| Me | 6-Me | Cl | SCF₃ | Br | CH | Me | 6-Cl | Cl | SCF₃ | Br | CH |
| Et | 6-Me | Cl | SCF₃ | Br | CH | Et | 6-Cl | Cl | SCF₃ | Br | CH |
| i-Pr | 6-Me | Cl | SCF₃ | Br | CH | i-Pr | 6-Cl | Cl | SCF₃ | Br | CH |
| t-Bu | 6-Me | Cl | SCF₃ | Br | CH | t-Bu | 6-Cl | Cl | SCF₃ | Br | CH |
| Me | 6-Me | Cl | C₂F₅ | Br | CH | Me | 6-Cl | Cl | C₂F₅ | Br | CH |
| Et | 6-Me | Cl | C₂F₅ | Br | CH | Et | 6-Cl | Cl | C₂F₅ | Br | CH |
| i-Pr | 6-Me | Cl | C₂F₅ | Br | CH | i-Pr | 6-Cl | Cl | C₂F₅ | Br | CH |
| t-Bu | 6-Me | Cl | C₂F₅ | Br | CH | t-Bu | 6-Cl | Cl | C₂F₅ | Br | CH |
| Me | 6-Me | Cl | n-C₃F₇ | Br | CH | Me | 6-Cl | Cl | n-C₃F₇ | Br | CH |
| Et | 6-Me | Cl | n-C₃F₇ | Br | CH | Et | 6-Cl | Cl | n-C₃F₇ | Br | CH |
| i-Pr | 6-Me | Cl | n-C₃F₇ | Br | CH | i-Pr | 6-Cl | Cl | n-C₃F₇ | Br | CH |
| t-Bu | 6-Me | Cl | n-C₃F₇ | Br | CH | t-Bu | 6-Cl | Cl | n-C₃F₇ | Br | CH |
| Me | 6-Me | Cl | i-C₃F₇ | Br | CH | Me | 6-Cl | Cl | i-C₃F₇ | Br | CH |
| Et | 6-Me | Cl | i-C₃F₇ | Br | CH | Et | 6-Cl | Cl | i-C₃F₇ | Br | CH |
| i-Pr | 6-Me | Cl | i-C₃F₇ | Br | CH | i-Pr | 6-Cl | Cl | i-C₃F₇ | Br | CH |
| t-Bu | 6-Me | Cl | i-C₃F₇ | Br | CH | t-Bu | 6-Cl | Cl | i-C₃F₇ | Br | CH |
| Me | 6-Me | Cl | CN | Br | CH | Me | 6-Cl | Cl | CN | Br | CH |
| Et | 6-Me | Cl | CN | Br | CH | Et | 6-Cl | Cl | CN | Br | CH |
| i-Pr | 6-Me | Cl | CN | Br | CH | i-Pr | 6-Cl | Cl | CN | Br | CH |
| t-Bu | 6-Me | Cl | CN | Br | CH | t-Bu | 6-Cl | Cl | CN | Br | CH |
| Me | 6-Me | Cl | OCHF₂ | CF₃ | CH | Me | 6-Cl | Cl | OCHF₂ | CF₃ | CH |
| Et | 6-Me | Cl | OCHF₂ | CF₃ | CH | Et | 6-Cl | Cl | OCHF₂ | CF₃ | CH |
| i-Pr | 6-Me | Cl | OCHF₂ | CF₃ | CH | i-Pr | 6-Cl | Cl | OCHF₂ | CF₃ | CH |
| t-Bu | 6-Me | Cl | OCHF₂ | CF₃ | CH | t-Bu | 6-Cl | Cl | OCHF₂ | CF₃ | CH |
| Me | 6-Me | Cl | SCHF₂ | CF₃ | CH | Me | 6-Cl | Cl | SCHF₂ | CF₃ | CH |
| Et | 6-Me | Cl | SCHF₂ | CF₃ | CH | Et | 6-Cl | Cl | SCHF₂ | CF₃ | CH |
| i-Pr | 6-Me | Cl | SCHF₂ | CF₃ | CH | i-Pr | 6-Cl | Cl | SCHF₂ | CF₃ | CH |
| t-Bu | 6-Me | Cl | SCHF₂ | CF₃ | CH | t-Bu | 6-Cl | Cl | SCHF₂ | CF₃ | CH |
| Me | 6-Me | Cl | OCF₃ | CF₃ | CH | Me | 6-Cl | Cl | OCF₃ | CF₃ | CH |
| Et | 6-Me | Cl | OCF₃ | CF₃ | CH | Et | 6-Cl | Cl | OCF₃ | CF₃ | CH |
| i-Pr | 6-Me | Cl | OCF3 | CF₃ | CH | i-Pr | 6-Cl | Cl | OCF3 | CF₃ | CH |
| t-Bu | 6-Me | Cl | OCF3 | CF₃ | CH | t-Bu | 6-Cl | Cl | OCF3 | CF₃ | CH |
| Me | 6-Me | Cl | SCF₃ | CF₃ | CH | Me | 6-Cl | Cl | SCF₃ | CF₃ | CH |
| Et | 6-Me | Cl | SCF₃ | CF₃ | CH | Et | 6-Cl | Cl | SCF₃ | CF₃ | CH |
| i-Pr | 6-Me | Cl | SCF3 | CF₃ | CH | i-Pr | 6-Cl | Cl | SCF3 | CF₃ | CH |
| t-Bu | 6-Me | Cl | SCF3 | CF₃ | CH | t-Bu | 6-Cl | Cl | SCF3 | CF₃ | CH |
| Me | 6-Me | Cl | C₂F₅ | CF₃ | CH | Me | 6-Cl | Cl | C₂F₅ | CF₃ | CH |
| Et | 6-Me | Cl | C₂F₅ | CF₃ | CH | Et | 6-Cl | Cl | C₂F₅ | CF₃ | CH |
| i-Pr | 6-Me | Cl | C₂F₅ | CF₃ | CH | i-Pr | 6-Cl | Cl | C₂F_{5CF}₃ | CH | |
| t-Bu | 6-Me | Cl | C₂F₅ | CF₃ | CH | t-Bu | 6-Cl | Cl | C₂F_{5CF}₃ | CH | |
| Me | 6-Me | Cl | n-C₃F₇ | CF₃ | CH | Me | 6-Cl | Cl | n-C₃F₇ | CF₃ | CH |
| Et | 6-Me | Cl | n-C₃F₇ | CF₃ | CH | Et | 6-Cl | Cl | n-C₃F₇ | CF₃ | CH |
| i-Pr | 6-Me | Cl | n-C₃F₇ | CF₃ | CH | i-Pr | 6-Cl | Cl | n-C₃F₇ | CF₃ | CH |
| t-Bu | 6-Me | Cl | n-C₃F₇ | CF₃ | CH | t-Bu | 6-Cl | Cl | n-C₃F₇ | CF₃ | CH |
| Me | 6-Me | Cl | i-C₃F₇ | CF₃ | CH | Me | 6-Cl | Cl | i-C₃F₇ | CF₃ | CH |
| Et | 6-Me | Cl | i-C₃F₇ | CF₃ | CH | Et | 6-Cl | Cl | i-C₃F₇ | CF₃ | CH |
| i-Pr | 6-Me | Cl | i-C₃F₇ | CF₃ | CH | i-Pr | 6-Cl | Cl | i-C₃F₇ | CF₃ | CH |
| t-Bu | 6-Me | Cl | i-C₃F₇ | CF₃ | CH | t-Bu | 6-Cl | Cl | i-C₃F₇ | CF₃ | CH |
| Me | 6-Me | Cl | CN | CF₃ | CH | Me | 6-Cl | Cl | CN | CF₃ | CH |
| Et | 6-Me | Cl | CN | CF₃ | CH | Et | 6-Cl | Cl | CN | CF₃ | CH |
| i-Pr | 6-Me | Cl | CN | CF₃ | CH | i-Pr | 6-Cl | Cl | CN | CF₃ | CH |
| t-Bu | 6-Me | Cl | CN | CF₃ | CH | t-Bu | 6-Cl | Cl | CN | CF₃ | CH |
| Me | 6-Me | H | OCHF₂ | F | CF | Me | 6-Cl | H | OCHF₂ | F | CF |
| Et | 6-Me | H | OCHF₂ | F | CF | Et | 6-Cl | H | OCHF₂ | F | CF |
| i-Pr | 6-Me | H | OCHF₂ | F | CF | i-Pr | 6-Cl | H | OCHF₂ | F | CF |
| t-Bu | 6-Me | H | OCHF₂ | F | CF | t-Bu | 6-Cl | H | OCHF₂ | F | CF |
| Me | 6-Me | H | SCHF₂ | F | CF | Me | 6-Cl | H | SCHF₂ | F | CF |
| Et | 6-Me | H | SCHF₂ | F | CF | Et | 6-Cl | H | SCHF₂ | F | CF |
| i-Pr | 6-Me | H | SCHF₂ | F | CF | i-Pr | 6-Cl | H | SCHF₂ | F | CF |
| t-Bu | 6-Me | H | SCHF₂ | F | CF | t-Bu | 6-Cl | H | SCHF₂ | F | CF |
| Me | 6-Me | H | OCF₃ | F | CF | Me | 6-Cl | H | OCF₃ | F | CF |
| Et | 6-Me | H | OCF₃ | F | CF | Et | 6-Cl | H | OCF₃ | F | CF |
| i-Pr | 6-Me | H | OCF₃ | F | CF | i-Pr | 6-Cl | H | OCF₃ | F | CF |
| t-Bu | 6-Me | H | OCF₃ | F | CF | t-Bu | 6-Cl | H | OCF₃ | F | CF |
| Me | 6-Me | H | SCF₃ | F | CF | Me | 6-Cl | H | SCF₃ | F | CF |
| Et | 6-Me | H | SCF₃ | F | CF | Et | 6-Cl | H | SCF₃ | F | CF |
| i-Pr | 6-Me | H | SCF₃ | F | CF | i-Pr | 6-Cl | H | SCF3 F | CF | |
| t-Bu | 6-Me | H | SCF₃ | F | CF | t-Bu | 6-Cl | H | SCF3 F | CF | |
| Me | 6-Me | H | C₂F₅ | F | CF | Me | 6-Cl | H | C₂F₅ | F | CF |
| Et | 6-Me | H | C₂F₅ | F | CF | Et | 6-Cl | H | C₂F₅ | F | CF |
| i-Pr | 6-Me | H | C₂F_{5 F} | CF | i-Pr | 6-Cl | H | C₂F₅ | F | CF | |
| t-Bu | 6-Me | H | C₂F_{5 F} | CF | t-Bu | 6-Cl | H | C₂F₅ | F | CF | |
| Me | 6-Me | H | n-C₃F₇ | F | CF | Me | 6-Cl | H | n-C₃F₇ | F | CF |
| Et | 6-Me | H | n-C₃F₇ | F | CF | Et | 6-Cl | H | n-C₃F₇ | F | CF |
| i-Pr | 6-Me | H | n-C₃F₇ | F | CF | i-Pr | 6-Cl | H | n-C₃F₇ | F | CF |
| t-Bu | 6-Me | H | n-C₃F₇ | F | CF | t-Bu | 6-Cl | H | n-C₃F₇ | F | CF |
| Me | 6-Me | H | i-C₃F₇ | F | CF | Me | 6-Cl | H | i-C₃F₇ | F | CF |
| Et | 6-Me | H | i-C₃F₇ | F | CF | Et | 6-Cl | H | iC₃F₇ | F | CF |
| i-Pr | 6-Me | H | i-C₃F₇ | F | CF | i-Pr | 6-Cl | H | i-C₃F₇ | F | CF |
| t-Bu | 6-Me | H | i-C₃F₇ | F | CF | t-Bu | 6-Cl | H | i-C₃F₇ | F | CF |
| Me | 6-Me | H | CN | F | CF | Me | 6-Cl | H | CN | F | CF |
| Et | 6-Me | H | CN | F | CF | Et | 6-Cl | H | CN | F | CF |
| i-Pr | 6-Me | H | CN | F | CF | i-Pr | 6-Cl | H | CN | F | CF |
| t-Bu | 6-Me | H | CN | F | CF | t-Bu | 6-Cl | H | CN | F | CF |
| Me | 6-Me | H | OCHF₂ | Cl | CCl | Me | 6-Cl | H | OCHF₂ | Cl | CCl |
| Et | 6-Me | H | OCHF₂ | Cl | CCl | Et | 6-Cl | H | OCHF₂ | Cl | CCl |
| i-Pr | 6-Me | H | OCHF₂ | Cl | CCl | i-Pr | 6-Cl | H | OCHF₂ | Cl | CCl |
| t-Bu | 6-Me | H | OCHF₂ | Cl | CCl | t-Bu | 6-Cl | H | OCHF₂ | Cl | CCl |
| Me | 6-Me | H | SCHF₂ | Cl | CCl | Me | 6-Cl | H | SCHF₂ | Cl | CCl |
| Et | 6-Me | H | SCHF₂ | Cl | CCl | Et | 6-Cl | H | SCHF₂ | Cl | CCl |
| i-Pr | 6-Me | H | SCHF₂ | Cl | CCl | i-Pr | 6-Cl | H | SCHF₂ | Cl | CCl |
| t-Bu | 6-Me | H | SCHF₂ | Cl | CCl | t-Bu | 6-Cl | H | SCHF₂ | Cl | CCl |
| Me | 6-Me | H | OCF₃ | Cl | CCl | Me | 6-Cl | H | OCF₃ | Cl | CCl |
| Et | 6-Me | H | 0CF₃ | Cl | CCl | Et | 6-Cl | H | OCF₃ | Cl | CCl |
| i-Pr | 6-Me | H | OCF₃ | Cl | CCl | i-Pr | 6-Cl | H | OCF₃ | Cl | CCl |
| t-Bu | 6-Me | H | OCF₃ | Cl | CCl | t-Bu | 6-Cl | H | OCF₃ | Cl | CCl |
| Me | 6-Me | H | SCF₃ | Cl | CCl | Me | 6-Cl | H | SCF₃ | Cl | CCl |
| Et | 6-Me | H | SCF₃ | Cl | CCl | Et | 6-Cl | H | SCF₃ | Cl | CCl |
| i-Pr | 6-Me | H | SCF₃ | Cl | CCl | i-Pr | 6-Cl | H | SCF₃ | Cl | CCl |
| t-Bu | 6-Me | H | SCF₃ | Cl | CCl | t-Bu | 6-Cl | H | SCF₃ | Cl | CCl |
| Me | 6-Me | H | C₂F₅ | Cl | CCl | Me | 6-Cl | H | C₂F₅ | Cl | CCl |
| Et | 6-Me | H | C₂F₅ | Cl | CCl | Et | 6-Cl | H | C₂F₅ | Cl | CCl |
| i-Pr | 6-Me | H | C₂F₅ | Cl | CCl | i-Pr | 6-Cl | H | C₂F₅ | Cl | CCl |
| t-Bu | 6-Me | H | C₂F₅ | Cl | CCl | t-Bu | 6-Cl | H | C₂F₅ | Cl | CCl |
| Me | 6-Me | H | n-C₃F₇ | Cl | CCl | Me | 6-Cl | H | n-C₃F₇ | Cl | CCl |
| Et | 6-Me | H | n-C₃F₇ | Cl | CCl | Et | 6-Cl | H | n-C₃F₇ | Cl | CCl |
| i-Pr | 6-Me | H | n-C₃F₇ | Cl | CCl | i-Pr | 6-Cl | H | n-C₃F₇ | Cl | CCl |
| t-Bu | 6-Me | H | n-C₃F₇ | Cl | CCl | t-Bu | 6-Cl | H | n-C₃F₇ | Cl | CCl |
| Me | 6-Me | H | i-C₃F₇ | Cl | CCl | Me | 6-Cl | H | i-C₃F₇ | Cl | CCl |
| Et | 6-Me | H | i-C₃F₇ | Cl | CCl | Et | 6-Cl | H | i-C₃F₇ | Cl | CCl |
| i-Pr | 6-Me | H | i-C₃F₇ | Cl | CCl | i-Pr | 6-Cl | H | i-C₃F₇ | Cl | CCl |
| t-Bu | 6-Me | H | i-C₃F₇ | Cl | CCl | t-Bu | 6-Cl | H | i-C₃F₇ | Cl | CCl |
| Me | 6-Me | H | CN | Cl | CCl | Me | 6-Cl | H | CN | Cl | CCl |
| Et | 6-Me | H | CN | Cl | CCl | Et | 6-Cl | H | CN | Cl | CCl |
| i-Pr | 6-Me | H | CN | Cl | CCl | i-Pr | 6-Cl | H | CN | Cl | CCl |
| t-Bu | 6-Me | H | CN | Cl | CCl | t-Bu | 6-Cl | H | CN | Cl | CCl |
| Me | 3-Me | H | OCHF₂ | F | CH | Me | 3-Cl | H | OCHF₂ | F | CH |
| Et | 3-Me | H | OCHF₂ | F | CH | Et | 3-Cl | H | OCHF₂ | F | CH |
| i-Pr | 3-Me | H | OCHF₂ | F | CH | i-Pr | 3-Cl | H | OCHF₂ | F | CH |
| t-Bu | 3-Me | H | OCHF9 | F | CH | t-Bu | 3-Cl | H | OCHF₂ | F | CH |
| Me | 3-Me | H | SCHF₂ | F | CH | Me | 3-Cl | H | SCHF₂ | F | CH |
| Et | 3-Me | H | SCHF₂ | F | CH | Et | 3-Cl | H | SCHF₂ | F | CH |
| i-Pr | 3-Me | H | SCHF₂ | F | CH | i-Pr | 3-Cl | H | SCHF₂ | F | CH |
| t-Bu | 3-Me | H | SCHF₂ | F | CH | t-Bu | 3-Cl | H | SCHF₂ | F | CH |
| Me | 3-Me | H | OCF₃ | F | CH | Me | 3-Cl | H | OCF₃ | F | CH |
| Et | 3-Me | H | OCF₃ | F | CH | Et | 3-Cl | H | OCF₃ | F | CH |
| i-Pr | 3-Me | H | OCF₃ | F | CH | i-Pr | 3-Cl | H | OCF₃ | F | CH |
| t-Bu | 3-Me | H | OCF₃ | F | CH | t-Bu | 3-Cl | H | OCF₃ | F | CH |
| Me | 3-Me | H | SCF₃ | F | CH | Me | 3-Cl | H | SCF₃ | F | CH |
| Et | 3-Me | H | SCF₃ | F | CH | Et | 3-Cl | H | SCF₃ | F | CH |
| i-Pr | 3-Me | H | SCF₃ | F | CH | i-Pr | 3-Cl | H | SCF₃ | F | CH |
| t-Bu | 3-Me | H | SCF₃ | F | CH | t-Bu | 3-Cl | H | SCF₃ | F | CH |
| Me | 3-Me | H | C₂F₅ | F | CH | Me | 3-Cl | H | C₂F₅ | F | CH |
| Et | 3-Me | H | C₂F₅ | F | CH | Et | 3-Cl | H | C₂F₅ | F | CH |
| i-Pr | 3-Me | H | C₂F₅ | F | CH | i-Pr | 3-Cl | H | C₂F₅ | F | CH |
| t-Bu | 3-Me | H | C₂F₅ | F | CH | t-Bu | 3-Cl | H | C₂F₅ | F | CH |
| Me | 3-Me | H | n-C₃F₇ | F | CH | Me | 3-Cl | H | n-C₃F₇ | F | CH |
| Et | 3-Me | H | n-C₃F₇ | F | CH | Et | 3-Cl | H | n-C₃F₇ | F | CH |
| i-Pr | 3-Me | H | n-C₃F₇ | F | CH | i-Pr | 3-Cl | H | n-C₃F₇ | F | CH |
| t-Bu | 3-Me | H | n-C₃F₇ | F | CH | t-Bu | 3-Cl | H | n-C₃F₇ | F | CH |
| Me | 3-Me | H | i-C₃F₇ | F | CH | Me | 3-Cl | H | i-C₃F₇ | F | CH |
| Et | 3-Me | H | i-C₃F₇ | F | CH | Et | 3-Cl | H | i-C₃F₇ | F | CH |
| i-Pr | 3-Me | H | i-C₃F₇ | F | CH | i-Pr | 3-Cl | H | i-C₃F₇ | F | CH |
| t-Bu | 3-Me | H | i-C₃F₇ | F | CH | t-Bu | 3-Cl | H | i-C₃F₇ | F | CH |
| Me | 3-Me | H | CN | F | CH | Me | 3-Cl | H | CN | F | CH |
| Et | 3-Me | H | CN | F | CH | Et | 3-Cl | H | CN | F | CH |
| i-Pr | 3-Me | H | CN | F | CH | i-Pr | 3-Cl | H | CN | F | CH |
| t-Bu | 3-Me | H | CN | F | CH | t-Bu | 3-Cl | H | CN | F | CH |
| Me | 3-Me | H | OCHF₂ | Cl | CH | Me | 3-Cl | H | OOHF₂ | Cl | CH |
| Et | 3-Me | H | OCHF₂ | Cl | CH | Et | 3-Cl | H | OCHF₂ | Cl | CH |
| i-Pr | 3-Me | H | OCHF₂ | Cl | CH | i-Pr | 3-Cl | H | OCHF₂ | Cl | CH |
| t-Bu | 3-Me | H | OCHF₂ | Cl | CH | t-Bu | 3-Cl | H | OCHF₂ | Cl | CH |
| Me | 3-Me | H | SCHF₂ | Cl | CH | Me | 3-Cl | H | SCHF₂ | Cl | CH |
| Et | 3-Me | H | SCHF₂ | Cl | CH | Et | 3-Cl | H | SCHF₂ | Cl | CH |
| i-Pr | 3-Me | H | SCHF₂ | Cl | CH | i-Pr | 3-Cl | H | SCHF₂ | Cl | CH |
| t-Bu | 3-Me | H | SCHF₂ | Cl | CH | t-Bu | 3-Cl | H | SCHF₂ | Cl | CH |
| Me | 3-Me | H | OCF₃ | Cl | CH | Me | 3-Cl | H | OCF₃ | Cl | CH |
| Et | 3-Me | H | OCF₃ | Cl | CH | Et | 3-Cl | H | OCF₃ | Cl | CH |
| i-Pr | 3-Me | H | OCF₃ | Cl | CH | i-Pr | 3-Cl | H | OCF₃ | Cl | CH |
| t-Bu | 3-Me | H | OCF₃ | Cl | CH | t-Bu | 3-Cl | H | OCF₃ | Cl | CH |
| Me | 3-Me | H | SCF₃ | Cl | CH | Me | 3-Cl | H | SCF₃ | Cl | CH |
| Et | 3-Me | H | SCF₃ | Cl | CH | Et | 3-Cl | H | SCF₃ | Cl | CH |
| i-Pr | 3-Me | H | SCF₃ | Cl | CH | i-Pr | 3-Cl | H | SCF₃ | Cl | CH |
| t-Bu | 3-Me | H | SCF₃ | Cl | CH | t-Bu | 3-Cl | H | SCF₃ | Cl | CH |
| Me | 3-Me | H | C₂F₅ | Cl | CH | Me | 3-Cl | H | C₂F₅ | Cl | CH |
| Et | 3-Me | H | C₂F₅ | Cl | CH | Et | 3-Cl | H | C₂F₅ | Cl | CH |
| i-Pr | 3-Me | H | C₂F₅ | Cl | CH | i-Pr | 3-Cl | H | C₂F₅ | Cl | CH |
| t-Bu | 3-Me | H | C₂F₅ | Cl | CH | t-Bu | 3-Cl | H | C₂F₅ | Cl | CH |
| Me | 3-Me | H | n-C₃F₇ | Cl | CH | Me | 3-Cl | H | n-C₃F₇ | Cl | CH |
| Et | 3-Me | H | n-C₃F₇ | Cl | CH | Et | 3-Cl | H | n-C₃F₇ | Cl | CH |
| i-Pr | 3-Me | H | n-C₃F₇ | Cl | CH | i-Pr | 3-Cl | H | n-C₃F₇ | Cl | CH |
| t-Bu | 3-Me | H | n-C₃F₇ | Cl | CH | t-Bu | 3-Cl | H | n-C₃F₇ | Cl | CH |
| Me | 3-Me | H | i-C₃F₇ | Cl | CH | Me | 3-Cl | H | i-C₃F₇ | Cl | CH |
| Et | 3-Me | H | i-C₃F₇ | Cl | CH | Et | 3-Cl | H | i-C₃F₇ | Cl | CH |
| i-Pr | 3-Me | H | i-C₃F₇ | Cl | CH | i-Pr | 3-Cl | H | i-C₃F₇ | Cl | CH |
| t-Bu | 3-Me | H | i-C₃F₇ | Cl | CH | t-Bu | 3-Cl | H | i-C₃F₇ | Cl | CH |
| Me | 3-Me | H | CH | Cl | CH | Me | 3-Cl | H | CN | Cl | CH |
| Et | 3-Me | H | CN | Cl | CH | Et | 3-Cl | H | CN | Cl | CH |
| i-Pr | 3-Me | H | CN | Cl | CH | i-Pr | 3-Cl | H | CN | Cl | CH |
| t-Bu | 3-Me | H | CN | Cl | CH | t-Bu | 3-Cl | H | CN | Cl | CH |
| Me | 3-Me | H | OCHF₂ | Br | CH | Me | 3-Cl | H | OCHF₂ | Br | CH |
| Et | 3-Me | H | OCHF₂ | Br | CH | Et | 3-Cl | H | OCHF₂ | Br | CH |
| i-Pr | 3-Me | H | OCHF₂ | Br | CH | i-Pr | 3-Cl | H | OCHF₂ | Br | CH |
| t-Bu | 3-Me | H | OCHF₂ | Br | CH | t-Bu | 3-Cl | H | OCHF₂ | Br | CH |
| Me | 3-Me | H | SCHF₂ | Br | CH | Me | 3-Cl | H | SCHF₂ | Br | CH |
| Et | 3-Me | H | SCHF₂ | Br | CH | Et | 3-Cl | H | SCHF₂ | Br | CH |
| i-Pr | 3-Me | H | SCHF₂ | Br | CH | i-Pr | 3-Cl | H | SCHF₂ | Br | CH |
| t-Bu | 3-Me | H | SCHF₂ | Br | CH | t-Bu | 3-Cl | H | SCHF₂ | Br | CH |
| Me | 3-Me | H | OCF₃ | Br | CH | Me | 3-Cl | H | OCF₃ | Br | CH |
| Et | 3-Me | H | OCF₃ | Br | CH | Et | 3-Cl | H | OCF₃ | Br | CH |
| i-Pr | 3-Me | H | OCF₃ | Br | CH | i-Pr | 3-Cl | H | OCF₃ | Br | CH |
| t-Bu | 3-Me | H | OCF₃ | Br | CH | t-Bu | 3-Cl | H | OCF₃ | Br | CH |
| Me | 3-Me | H | SCF₃ | Br | CH | Me | 3-Cl | H | SCF₃ | Br | CH |
| Et | 3-Me | H | SCF₃ | Br | CH | Et | 3-Cl | H | SCF₃ | Br | CH |
| i-Pr | 3-Me | H | SCF₃ | Br | CH | i-Pr | 3-Cl | H | SCF₃ | Br | CH |
| t-Bu | 3-Me | H | SCF₃ | Br | CH | t-Bu | 3-Cl | H | SCF₃ | Br | CH |
| Me | 3-Me | H | C₂F₅ | Br | CH | Me | 3-Cl | H | C₂F₅ | Br | CH |
| Et | 3-Me | H | C₂F₅ | Br | CH | Et | 3-Cl | H | C₂F₅ | Br | ~2H |
| i-Pr | 3-Me | H | C₂F₅ | Br | CH | i-Pr | 3-Cl | H | C₂F₅ | Br | CH |
| t-Bu | 3-Me | H | C₂F₅ | Br | CH | t-Bu | 3-Cl | H | C₂F₅ | Br | CH |
| Me | 3-Me | H | n-C₃F₇ | Br | CH | Me | 3-Cl | H | n-C₃F₇ | Br | CH |
| Et | 3-Me | H | n-C₃F₇ | Br | CH | Et | 3-Cl | H | n-C₃F₇ | Br | CH |
| i-Pr | 3-Me | H | n-C₃F₇ | Br | CH | i-Pr | 3-Cl | H | n-C₃F₇ | Br | CH |
| t-Bu | 3-Me | H | n-C₃F₇ | Br | CH | t-Bu | 3-Cl | H | n-C₃F₇ | Br | CH |
| Me | 3-Me | H | i-C₃F₇ | Br | CH | Me | 3-Cl | H | i-C₃F₇ | Br | CH |
| Et | 3-Me | H | i-C₃F₇ | Br | CH | Et | 3-Cl | H | i-C₃F₇ | Br | CH |
| i-Pr | 3-Me | H | i-C₃F₇ | Br | CH | i-Pr | 3-Cl | H | i-C₃F₇ | Br | CH |
| t-Bu | 3-Me | H | i-C₃F₇ | Br | CH | t-Bu | 3-Cl | H | i-C₃F₇ | Br | CH |
| Me | 3-Me | H | CN | Br | CH | Me | 3-Cl | H | CN | Br | CH |
| Et | 3-Me | H | CN | Br | CH | Et | 3-Cl | H | CN | Br | CH |
| i-Pr | 3-Me | H | CN | Br | CH | i-Pr | 3-Cl | H | CN | Br | CH |
| t-Bu | 3-Me | H | CN | Br | CH | t-Bu | 3-Cl | H | CN | Br | CH |
| Me | 3-Me | H | OCHF₂ | CF₃ | CH | Me | 3-Cl | H | OCHF₂ | CF₃ | CH |
| Et | 3-Me | H | OCHF₂ | CF₃ | CH | Et | 3-Cl | H | OCHF₂ | CF₃ | CH |
| i-Pr | 3-Me | H | OCHF₂ | CF₃ | CH | i-Pr | 3-Cl | H | OCHF₂ | CF₃ | CH |
| t-Bu | 3-Me | H | OCHF₂ | CF₃ | CH | t-Bu | 3-Cl | H | OCHF₂ | CF₃ | CH |
| Me | 3-Me | H | SCHF₂ | CF₃ | CH | Me | 3-Cl | H | SCHF₂ | CF₃ | CH |
| Et | 3-Me | H | SCHF₂ | CF₃ | CH | Et | 3-Cl | H | SCHF₂ | CF₃ | CH |
| i-Pr | 3-Me | H | SCHF₂ | CF₃ | CH | i-Pr | 3-Cl | H | SCHF₂ | CF₃ | CH |
| t-Bu | 3-Me | H | SCHF₂ | CF₃ | CH | t-Bu | 3-Cl | H | SCHF₂ | CF₃ | CH |
| Me | 3-Me | H | OCF₃ | CF₃ | CH | Me | 3-Cl | H | OCF₃ | CF₃ | CH |
| Et | 3-Me | H | OCF₃ | CF₃ | CH | Et | 3-Cl | H | OCF₃ | CF₃ | CH |
| i-Pr | 3-Me | H | OCF₃ | CF₃ | CH | i-Pr | 3-Cl | H | OCF₃ | CF₃ | CH |
| t-Bu | 3-Me | H | OCF₃ | CF₃ | CH | t-Bu | 3-Cl | H | OCF₃ | CF₃ | CH |
| Me | 3-Me | H | SCF₃ | CF₃ | CH | Me | 3-Cl | H | SCF₃ | CF₃ | CH |
| Et | 3-Me | H | SCF₃ | CF₃ | CH | Et | 3-Cl | H | SCF₃ | CF₃ | CH |
| i-Pr | 3-Me | H | SCF₃ | CF₃ | CH | i-Pr | 3-Cl | H | SCF₃ | CF₃ | CH |
| t-Bu | 3-Me | H | SCF₃ | CF₃ | CH | t-Bu | 3-Cl | H | SCF₃ | CF₃ | Cl |
| Me | 3-Me | H | C₂F₅ | CF₃ | CH | Me | 3-Cl | H | C₂F₅ | CF₃ | CH |
| Et | 3-Me | H | C₂F₅ | CF₃ | CH | Et | 3-Cl | H | C₂F₅ | CF₃ | CH |
| i-Pr | 3-Me | H | C₂F₅ | CF₃ | CH | i-Pr | 3-Cl | H | C₂F₅ | CF₃ | CH |
| t-Bu | 3-Me | H | C₂F₅ | CF₃ | CH | t-Bu | 3-Cl | H | C₂F₅ | CF₃ | CH |
| Me | 3-Me | H | n-C₃F₇ | CF₃ | CH | Me | 3-Cl | H | n-C₃F₇ | CF₃ | CH |
| Et | 3-Me | H | n-C₃F₇ | CF₃ | CH | Et | 3-Cl | H | n-C₃F₇ | CF₃ | CH |
| i-Pr | 3-Me | H | n-C₃F₇ | CF₃ | CH | i-Pr | 3-Cl | H | n-C₃F₇ | CF₃ | CH |
| t-Bu | 3-Me | H | n-C₃F₇ | CF₃ | CH | t-Bu | 3-Cl | H | n-C₃F₇ | CF₃ | CH |
| Me | 3-Me | H | i-C₃F₇ | CF₃ | CH | Me | 3-Cl | H | i-C₃F₇ | CF₃ | CH |
| Et | 3-Me | H | i-C₃F₇ | CF₃ | CH | Et | 3-Cl | H | i-C₃F₇ | CF₃ | CH |
| i-Pr | 3-Me | H | i-C₃F₇ | CF₃ | CH | i-Pr | 3-Cl | H | i-C₃F₇ | CF₃ | CH |
| t-Bu | 3-Me | H | i-C₃F₇ | CF₃ | CH | t-Bu | 3-Cl | H | i-C₃F₇ | CF₃ | CH |
| Me | 3-Me | H | CN | CF₃ | CH | Me | 3-Cl | H | CN | CF₃ | CH |
| Et | 3-Me | H | CN | CF₃ | CH | Et | 3-Cl | H | CN | CF₃ | CH |
| i-Pr | 3-Me | H | CN | CF₃ | CH | i-Pr | 3-Cl | H | CN | CF₃ | CH |
| t-Bu | 3-Me | H | CN | CF₃ | CH | t-Bu | 3-Cl | H | CN | CF₃ | CH |

TABLE 16

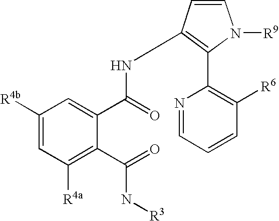

| R^{4a} | R^{4b} | R⁹ | R³ | R⁶ | R^{4a} | R^{4b} | R⁹ | R³ | R⁶ |
|---|---|---|---|---|---|---|---|---|---|
| CH₃ | F | CF₃ | Me | Cl | Cl | Br | CH₂CF₃ | Me | Br |
| CH₃ | F | CF₃ | Et | Cl | Cl | Br | CH₂CF₃ | Et | Br |
| CH₃ | F | CF₃ | i-Fr | Cl | Cl | Br | CH₂CF₃ | i-Pr | Br |
| CH₃ | F | CF₃ | t-Bu | Cl | Cl | Br | CH₂CF₃ | t-Bu | Br |
| CH₃ | F | CF₃ | Me | Br | Cl | Br | CF₂CHF₂ | Me | Cl |
| CH₃ | F | CF₃ | Et | Br | Cl | Br | CF₂CHF₂ | Et | Cl |
| CH₃ | F | CF₃ | i-Pr | Br | Cl | Br | CF₂CHF₂ | i-Pr | Cl |
| CH₃ | F | CF₃ | t-Bu | Br | Cl | Br | CF₂CHF₂ | t-Bu | Cl |
| CH₃ | F | CH₂CF₃ | Me | Cl | Cl | Br | CF₂CHF₂ | Me | Br |
| CH₃ | F | CH₂CF₃ | Et | Cl | Cl | Br | CF₂CHF₂ | Et | Br |
| CH₃ | F | CH₂CF₃ | i-Pr | Cl | Cl | Br | CF₂CHF₂ | i-Pr | Br |
| CH₃ | F | CH₂CF₃ | t-Bu | Cl | Cl | Br | CF₂CHF₂ | t-Bu | Br |
| CH₃ | F | CH₂CF₃ | Me | Br | Cl | I | CF₃ | Me | Cl |
| CH₃ | F | CH₂CF₃ | Et | Br | Cl | I | CF₃ | Et | Cl |
| CH₃ | F | CH₂CF₃ | i-Pr | Br | Cl | I | CF₃ | i-Pr | Cl |
| CH₃ | F | CH₂CF₃ | t-Bu | Br | Cl | I | CF₃ | t-Bu | Cl |
| CH₃ | F | CF₂CHF₂ | Me | Cl | Cl | I | CF₃ | Me | Br |
| CH₃ | F | CF₂CHF₂ | Et | Cl | Cl | I | CF₃ | Et | Br |
| CH₃ | F | CF₂CHF₂ | i-Pr | Cl | Cl | I | CF₃ | i-Pr | Br |
| CH₃ | F | CF₂CHF₂ | t-Bu | Cl | Cl | I | CF₃ | t-Bu | Br |
| CH₃ | F | CF₂CHF₂ | Me | Br | Cl | I | CH₂CF₃ | Me | Cl |
| CH₃ | F | CF₂CHF₂ | Et | Br | Cl | I | CH₂CF₃ | Et | Cl |
| CH₃ | F | CF₂CHF₂ | i-Pr | Br | Cl | I | CH₂CF₃ | i-Pr | Cl |
| CH₃ | F | CF₂CHF₂ | t-Bu | Br | Cl | I | CH₂CF₃ | t-Bu | Cl |
| CH₃ | Cl | CF₃ | Me | Cl | Cl | I | CH₂CF₃ | Me | Br |
| CH₃ | Cl | CF₃ | Et | Cl | Cl | I | CH₂CF₃ | Et | Br |
| CH₃ | Cl | CF₃ | i-Pr | Cl | Cl | I | CH₂CF₃ | i-Pr | Br |
| CH₃ | Cl | CF₃ | t-Bu | Cl | Cl | I | CH₂CF₃ | t-Bu | Br |
| CH₃ | Cl | CF₃ | Me | Br | Cl | I | CF₂CHF₂ | Me | Cl |
| CH₃ | Cl | CF₃ | Et | Br | Cl | I | CF₂CHF₂ | Et | Cl |
| CH₃ | Cl | CF₃ | i-Pr | Br | Cl | I | CF₂CHF₂ | i-Pr | Cl |
| CH₃ | Cl | CF₃ | t-Bu | Br | Cl | I | CF₂CHF₂ | t-Bu | Cl |
| CH₃ | Cl | CH₂CF₃ | Me | Cl | Cl | I | CF₂CHF₂ | Me | Br |
| CH₃ | Cl | CH₂CF₃ | Et | Cl | Cl | I | CF₂CHF₂ | Et | Br |
| CH₃ | Cl | CH₂CF₃ | i-Pr | Cl | Cl | I | CF₂CHF₂ | i-Pr | Br |
| CH₃ | Cl | CH₂CF₃ | t-Bu | Cl | Cl | I | CF₂CHF₂ | t-Bu | Br |
| CH₃ | Cl | CH₂CF₃ | Me | Br | Cl | CF₃ | CF₃ | Me | Cl |
| CH₃ | Cl | CH₂CF₃ | Et | Br | Cl | CF₃ | CF₃ | Et | Cl |
| CH₃ | Cl | CH₂CF₃ | i-Pr | Br | Cl | CF₃ | CF₃ | i-Pr | Cl |
| CH₃ | Cl | CH₂CF₃ | t-Bu | Br | Cl | CF₃ | CF₃ | t-Bu | Cl |
| CH₃ | Cl | CF₂CHF₂ | Me | Cl | Cl | CF₃ | CF₃ | Me | Br |
| CH₃ | Cl | CF₂CHF₂ | Et | Cl | Cl | CF₃ | CF₃ | Et | Br |
| CH₃ | Cl | CF₂CHF₂ | i-Pr | Cl | Cl | CF₃ | CF₃ | i-Pr | Br |
| CH₃ | Cl | CF₂CHF₂ | t-Bu | Cl | Cl | CF₃ | CF₃ | t-Bu | Br |
| CH₃ | Cl | CF₂CHF₂ | Me | Br | Cl | CF₃ | CH₂CF₃ | Me | Cl |
| CH₃ | Cl | CF₂CHF₂ | Et | Br | CI | CF₃ | CH₂CF₃ | Et | Cl |
| CH₃ | Cl | CF₂CHF₂ | i-Pr | Br | Cl | CF₃ | CH₂CF₃ | i-Pr | Cl |
| CH₃ | Cl | CF₂CHF₂ | t-Bu | Br | Cl | CF₃ | CH₂CF₃ | t-Bu | Cl |
| CH₃ | Br | CF₃ | Me | Cl | Cl | CF₃ | CH₂CF₃ | Me | Br |
| CH₃ | Br | CF₃ | Et | Cl | Cl | CF₃ | CH₂CF₃ | Et | Br |
| CH₃ | Br | CF₃ | i-Pr | Cl | Cl | CF₃ | CH₂CF₃ | i-Pr | Br |
| CH₃ | Br | CF₃ | t-Bu | Cl | Cl | CF₃ | CH₂CF₃ | t-Bu | Br |
| CH₃ | Br | CF₃ | Me | Br | Cl | CF₃ | CF₂CHF₂ | Me | Cl |
| CH₃ | Br | CF₃ | Et | Br | Cl | CF₃ | CF₂CHF₂ | Et | CI |
| CH₃ | Br | CF₃ | i-Pr | Br | Cl | CF₃ | CF₂CHF₂ | i-Pr | Cl |
| CH₃ | Br | CF₃ | t-Bu | Br | Cl | CF₃ | CF₂CHF₂ | t-Bu | Cl |
| CH₃ | Br | CH₂CF₃ | Me | Cl | Cl | CF₃ | CF₂CHF₂ | Me | Br |
| CH₃ | Br | CH₂CF₃ | Et | Cl | Cl | CF₃ | CF₂CHF₂ | Et | Br |
| CH₃ | Br | CH₂CF₃ | i-Pr | Cl | Cl | CF₃ | CF₂CHF₂ | i-Pr | Br |
| CH₃ | Br | CH₂CF₃ | t-Bu | Cl | Cl | CF₃ | CF₂CHF₂ | t-Bu | Br |
| CH₃ | Br | CH₂CF₃ | Me | Br | Cl | Cl | CH₂CF₃ | n-Pr | Cl |
| CH₃ | Br | CH₂CF₃ | Et | Br | Cl | Cl | CH₂CF₃ | n-Bu | Cl |
| CH₃ | Br | CH₂CF₃ | i-Pr | Br | Cl | Cl | CH₂CF₃ | s-Bu | Cl |
| CH₃ | Br | CH₂CF₃ | t-Bu | Br | Cl | Cl | CH₂CF₃ | i-Bu | Cl |
| CH₃ | Br | CF₂CHF₂ | Me | Cl | Br | F | CF₃ | Me | Cl |
| CH₃ | Br | CF₂CHP2 | Et | Cl | Br | F | CF₃ | Et | Cl |
| CH₃ | Br | CF₂CHF₂ | i-Pr | Cl | Br | F | CF₃ | i-Pr | Cl |
| CH₃ | Br | CF₂CHF₂ | t-Bu | Cl | Br | F | CF₃ | t-Bu | Cl |
| CH₃ | Br | CF₂CHF₂ | Me | Br | Br | F | CF₃ | Me | Br |
| CH₃ | Br | CF₂CHF₂ | Et | Br | Br | F | CF₃ | Et | Br |
| CH₃ | Br | CF₂CHF₂ | i-Pr | Br | Br | F | CF₃ | i-Pr | Br |
| CH₃ | Br | CF₂CHF₂ | t-Bu | Br | Br | F | CF₃ | t-Bu | Br |
| CH₃ | I | CF₃ | Me | Cl | Br | F | CH₂CF₃ | Me | Cl |
| CH₃ | I | CF₃ | Et | Cl | Br | F | CH₂CF₃ | Et | Cl |
| CH₃ | I | CF₃ | i-Pr | Cl | Br | F | CH₂CF₃ | i-Pr | Cl |
| CH₃ | I | CF₃ | t-Bu | Cl | Br | F | CH₂CF₃ | t-Bu | CI |
| CH₃ | I | CF₃ | Me | Br | Br | F | CH₂CF₃ | Me | Br |
| CH₃ | I | CF₃ | Et | Br | Br | F | CH₂CF₃ | Et | Br |
| CH₃ | I | CF₃ | i-Pr | Br | Br | F | CH₂CF₃ | i-Pr | Br |
| CH₃ | I | CF₃ | t-Bu | Br | Br | F | CFI2CF_{3 t-Bu} | Br | |
| CH₃ | I | CH₂CF₃ | Me | Cl | Br | F | CF₂CHF₂ | Me | Cl |
| CH₃ | I | CH₂CF₃ | Et | Cl | Br | F | CF₂CHF₂ | Et | Cl |
| CH₃ | I | CH₂CF₃ | i-Pr | CL | Br | F | CF₂CHF₂ | i-Pr | Cl |
| CH₃ | I | CH₂CF₃ | t-Bu | Cl | Br | F | CF₂CHF₂ | t-Bu | Cl |
| CH₃ | I | CH₂CF₃ | Me | Br | Br | F | CF₂CHF₂ | Me | Br |
| CH₃ | I | CH₂CF₃ | Et | Br | Br | F | CF₂CHF₂ | Et | Br |
| CH₃ | I | CH₂CF₃ | i-Pr | Br | Br | F | CF₂CHF₂ | i-Pr | Br |
| CH₃ | I | CH₂CF₃ | t-Bu | Br | Br | F | CF₂CHF₂ | t-Bu | Br |
| CH₃ | I | CF₂CHF₂ | Me | Cl | Br | Cl | CF₃ | Me | Cl |
| CH₃ | I | CF₂CHF₂ | Et | Cl | Br | CI | CF₃ | Et | Cl |
| CH₃ | I | CF₂CHF₂ | i-Pr | Cl | Br | Cl | CF₃ | i-Pr | Cl |
| CH₃ | I | CF₂CHF₂ | t-Bu | Cl | Br | Cl | CF₃ | t-Bu | Cl |
| CH₃ | I | CF₂CHF₂ | Me | Br | Br | Cl | CF₃ | Me | Br |
| CH₃ | I | CF₂CHF₂ | Et | Br | Br | Cl | CF₃ | Et | Br |
| CH₃ | I | CF₂CHF₂ | i-Pr | Br | Br | Cl | CF₃ | i-Pr | Br |
| CH₃ | I | CF₂CHF₂ | t-Bu | Br | Br | Cl | CF₃ | t-Bu | Br |
| CH₃ | CF₃ | CF₃ | Me | Cl | Br | Cl | CH₂CF₃ | Me | Cl |
| CH₃ | CF₃ | CF₃ | Et | Cl | Br | Cl | CH₂CF₃ | Et | Cl |
| CH₃ | CF₃ | CF₃ | i-Pr | Cl | Br | Cl | CH₂CF₃ | i-Pr | Cl |
| CH₃ | CF₃ | CF₃ | t-Bu | Cl | Br | Cl | CH₂CF₃ | t-Bu | Cl |
| CH₃ | CF₃ | CF₃ | Me | Br | Br | Cl | CH₂CF₃ | Me | Br |
| CH₃ | CF₃ | CF₃ | Et | Br | Br | Cl | CH₂CF₃ | Et | Br |
| CH₃ | CF₃ | CF₃ | i-Pr | Br | Br | Cl | CH₂CF₃ | i-Pr | Br |
| CH₃ | CF₃ | CF₃ | t-Bu | Br | Br | Cl | CH₂CF₃ | t-Bu | Br |
| CH₃ | CF₃ | CH₂CF₃ | Me | Cl | Br | Cl | CF₂CHF₂ | Me | Cl |
| CH₃ | CF₃ | CH₂CF₃ | Et | Cl | Br | Cl | CF₂CHF₂ | Et | Cl |
| CH₃ | CF₃ | CH₂CF₃ | i-Pr | Cl | Br | Cl | CF₂CHF₂ | i-Pr | Cl |
| CH₃ | CF₃ | CH₂CF₃ | t-Bu | Cl | Br | Cl | CF₂CHF₂ | t-Bu | Cl |
| CH₃ | CF₃ | CH₂CF₃ | Me | Br | Br | Cl | CF₂CHF₂ | Me | Br |
| CH₃ | CF₃ | CH₂CF₃ | Et | Br | Br | Cl | CF₂CHF2 | Et | Br |
| CH₃ | CF₃ | CH₂CF₃ | i-Pr | Br | Br | Cl | CF₂CHF₂ | i-Pr | Br |
| CH₃ | CF₃ | CH₂CF₃ | t-Bu | Br | Br | Cl | CF₂CHF₂ | t-Bu | Br |
| CH₃ | CF₃ | CF₂CHF₂ | Me | Cl | Br | Br | CF₃ | Me | Cl |
| CH₃ | CF₃ | CF₂CHF₂ | Et | Cl | Br | Br | CF₃ | Et | Cl |
| CH₃ | CF₃ | CF₂CHF₂ | i-Pr | Cl | Br | Br | CF₃ | i-Pr | Cl |
| CH₃ | CF₃ | CF₂CHF₂ | t-Bu | Cl | Br | Br | CF₃ | t-Bu | Cl |
| CH₃ | CF₃ | CF₂CHF₂ | Me | Br | Br | Br | CF₃ | Me | Br |
| CH₃ | CF₃ | CF₂CHF₂ | Et | Br | Br | Br | CF₃ | Et | Br |
| CH₃ | CF₃ | CF₂CHF₂ | i-Pr | Br | Br | Br | CF₃ | i-Pr | Br |
| CH₃ | CF₃ | CF₂CHF₂ | t-Bu | Br | Br | Br | CF₃ | t-Bu | Br |
| CH₃ | Cl | CH₂CF₃ | n-Pr | Cl | Br | Br | CH₂CF₃ | Me | Cl |
| CH₃ | Cl | CH₂CF₃ | n-Bu | Cl | Br | Br | CH₂CF₃ | Et | Cl |
| CH₃ | Cl | CH₂CF₃ | s-Bu | Cl | Br | Br | C2CF₃ | i-Pr | Cl |
| CH₃ | Cl | CC2CF₃ | i-Bu | Cl | Br | Br | CH₂CF₃ | t-Bu | Cl |
| Cl | F | CF₃ | Me | Cl | Br | Br | CH₂CF₃ | Me | Br |
| Cl | F | CF₃ | Et | Cl | Br | Br | CH₂CF₃ | Et | Br |
| Cl | F | CF₃ | i-Pr | Cl | Br | Br | CH₂CF₃ | i-Pr | Br |
| Cl | F | CF₃ | t-Bu | Cl | Br | Br | CH₂CF₃ | t-Bu | Br |
| Cl | F | CF₃ | Me | Br | Br | Br | CF₂CHF₂ | Me | Cl |
| Cl | F | CF₃ | Et | Br | Br | Br | CF₂CHF₂ | Et | Cl |
| Cl | F | CF₃ | i-Pr | Br | Br | Br | CF₂CHF₂ | i-Pr | Cl |
| Cl | F | CF₃ | t-Bu | Br | Br | Br | CF₂CHF₂ | t-Bu | Cl |
| Cl | F | CH₂CF₃ | Me | Cl | Br | Br | CF₂CHF₂ | Me | Br |
| Cl | F | CH₂CF₃ | Et | Cl | Br | Br | CF₂CHF₂ | Et | Br |
| Cl | F | CH₂CF₃ | i-Pr | Cl | Br | Br | CF₂CHF₂ | i-Pr | Br |
| Cl | F | CH₂CF₃ | t-Bu | Cl | Br | Br | CF₂CHF₂ | t-Bu | Br |
| Cl | F | CH₂CF₃ | Me | Br | Br | I | CF₃ | Me | Cl |
| Cl | F | CH₂CF₃ | Et | Br | Br | I | CF₃ | Et | Cl |
| Cl | F | CH₂CF₃ | i-Pr | Br | Br | I | CF₃ | i-Pr | Cl |
| Cl | F | CH₂CF₃ | t-Bu | Br | Br | I | CF₃ | t-Bu | Cl |
| Cl | F | CF₂CHF₂ | Me | Cl | Br | I | CF₃ | Me | Br |
| Cl | F | CF₂CHF₂ | Et | Cl | Br | I | CF₃ | Et | Br |
| Cl | F | CF₂CHF₂ | i-Pr | Cl | Br | I | CF₃ | i-Pr | Br |
| Cl | F | CF₂CHF₂ | t-Bu | Cl | Br | I | CF₃ | t-Bu | Br |
| Cl | F | CF₂CHF₂ | Me | Br | Br | I | CH₂CF₃ | Me | Cl |
| Cl | F | CF₂CHF₂ | Et | Br | Br | I | CH₂CF₃ | Et | Cl |
| CI | F | CF₂CHF₂ | i-Pr | Br | Br | I | CH₂CF₃ | i-Pr | Cl |
| Cl | F | CF₂CHF₂ | t-Bu | Br | Br | I | CH₂CF₃ | t-Bu | Cl |
| Cl | Cl | CF₃ | Me | Cl | Br | I | CH₂CF₃ | Me | Br |
| Cl | Cl | CF₃ | Et | Cl | Br | I | CH₂CF₃ | Et | Br |
| Cl | Cl | CF₃ | i-Pr | Cl | Br | I | Cll2CF_{3 i-Pr} | Br | |
| CI | Cl | CF₃ | t-Bu | Cl | Br | I | Cll2CF_{3 t-Bu} | Br | |
| Cl | Cl | CF₃ | Me | Br | Br | I | CF₂CHF₂ | Me | Cl |
| Cl | Cl | CF₃ | Et | Br | Br | I | CF₂CHF₂ | Et | Cl |
| Cl | Cl | CF₃ | i-Pr | Br | Br | I | CF₂CHF₂ | i-Pr | Cl |
| Cl | Cl | CF₃ | g-Bu | Br | Br | I | CF₂CHF₂ | t-Bu | Cl |
| Cl | Cl | CH₂CF₃ | Me | Cl | Br | I | CF₂CHF₂ | Me | Br |
| Cl | Cl | CH₂CF₃ | Et | Cl | Br | I | CF₂CHF₂ | Et | Br |
| Cl | Cl | CH₂CF₃ | i-Pr | Cl | Br | I | CF₂CHF₂ | i-Pr | Br |
| Cl | Cl | CH₂CF₃ | t-Bu | Cl | Br | I | CF₂CHF₂ | t-Bu | Br |
| Cl | Cl | CH₂CF₃ | Me | Br | Br | CF₃ | CF₃ | Me | Cl |
| Cl | Cl | CH₂CF₃ | Et | Br | Br | CF₃ | CF₃ | Et | Cl |
| Cl | Cl | CH₂CF₃ | i-Pr | Br | Br | CF₃ | CF₃ | i-Pr | Cl |
| Cl | Cl | CH₂CF₃ | t-Bu | Br | Br | CF₃ | CF₃ | t-Bu | Cl |
| Cl | Cl | CF₂CHF₂ | Me | Cl | Br | CF₃ | CF₃ | Me | Br |
| Cl | Cl | CF₂CHF₂ | EL | Cl | Br | CF₃ | CF₃ | EL | Br |
| Cl | Cl | CF₂CHF₂ | i-Pr | Cl | Br | CF₃ | CF₃ | i-Pr | Br |
| Cl | Cl | CF₂CHF₂ | t-Bu | Cl | Br | CF₃ | CF₃ | t-Bu | Br |
| Cl | Cl | CF₂CHF₂ | Me | Br | Br | CF₃ | CH₂CF₃ | Me | Cl |
| Cl | Cl | CF₂CHF₂ | Et | Br | Br | CF₃ | CH₂CF₃ | Et | Cl |
| Cl | Cl | CF₂CHF₂ | i-Pr | Br | Br | CF₃ | CH₂CF₃ | i-Pr | Cl |
| Cl | Cl | CF₂CHF₂ | t-Bu | Br | Br | CF₃ | CH₂CF₃ | t-Bu | Cl |
| Cl | Br | CF₃ | Me | Cl | Br | CF₃ | CH₂CF₃ | Me | Br |
| Cl | Br | CF₃ | Et | Cl | Br | CF₃ | CH₂CF₃ | Et | Br |
| Cl | Br | CF₃ | i-Pr | Cl | Br | CF₃ | CH₂CF₃ | i-Pr | Br |
| Cl | Br | CF₃ | t-Bu | Cl | Br | CF₃ | CH₂CF₃ | t-Bu | Br |
| Cl | Br | CF₃ | Me | Br | Br | CF₃ | CF₂CHF₂ | Me | Cl |
| Cl | Br | CF₃ | Et | Br | Br | CF₃ | CF₂CHF₂ | Et | Cl |
| Cl | Br | CF₃ | i-Pr | Br | Br | CF₃ | CF₂CHF₂ | i-Pr | Cl |
| Cl | Br | CF₃ | t-Bu | Br | Br | CF₃ | CF₂CHF₂ | t-Bu | Cl |
| Cl | Br | CH₂CF₃ | Me | CI | Br | CF₃ | CF₂CHF₂ | Me | Br |
| Cl | Br | CH₂CF₃ | Et | Cl | Br | CF₃ | CF₂CHF₂ | Et | Br |
| Cl | Br | CH₂CF₃ | i-Pr | Cl | Br | CF₃ | CF₂CHF₂ | i-Pr | Br |
| Cl | Br | CH₂CF₃ | t-Bu | Cl | Br | CF₃ | CF₂CHF₂ | t-Bu | Br |
| CH₃ | H | CF₃ | Me | Cl | Cl | H | CF₃ | Me | Cl |
| CH₃ | H | CF₃ | Et | Cl | Cl | H | CF₃ | Et | Cl |
| CH₃ | H | CF₃ | i-Pr | Cl | Cl | H | CF₃ | i-Pr | Cl |
| CH₃ | H | CF₃ | t-Bu | Cl | Cl | H | CF₃ | t-Bu | Cl |
| CH₃ | H | CF₃ | Me | Br | Cl | H | CF₃ | Me | Br |
| CH₃ | H | CF₃ | Et | Br | Cl | H | CF₃ | Et | Br |
| CH₃ | H | CF₃ | i-Pr | Br | Cl | H | CF₃ | i-Pr | Br |
| CH₃ | H | CF₃ | t-Bu | Br | Cl | H | CF₃ | t-Bu | Br |
| CH₃ | H | CH₂CF₃ | Me | Cl | Cl | H | CH₂CF₃ | Me | Cl |
| CH₃ | H | CH₂CF₃ | Et | Cl | Cl | H | CH₂CF₃ | EL | Cl |
| CH₃ | H | CH₂CF₃ | i-Fr | Cl | Cl | H | CH₂CF₃ | i-Pr | Cl |
| CH₃ | H | CH₂CF₃ | t-Bu | Cl | Cl | H | CH₂CF₃ | t-Bu | Cl |
| CH₃ | H | CH₂CF₃ | Me | Br | Cl | H | CH₂CF₃ | Me | Br |
| CH₃ | H | CH₂CF₃ | Et | Br | Cl | H | CH₂CF₃ | Et | Br |
| CH₃ | H | CH₂CF₃ | i-Pr | Br | Cl | H | CH₂CF₃ | i-Pr | Br |
| CH₃ | H | CH₂CF₃ | t-Bu | Br | Cl | H | CH₂CF₃ | t-Bu | Br |
| CH₃ | H | CF₂CHF₂ | Me | Cl | Cl | H | CF₂CHF₂ | Me | Cl |
| CH₃ | H | CF₂CHF₂ | Et | Cl | Cl | H | CF₂CHF₂ | Et | Cl |
| CH₃ | H | CF₂CHF₂ | i-Pr | Cl | Cl | H | CF₂CHF₂ | i-Pr | Cl |
| CH₃ | H | CF₂CHF₂ | t-Bu | Cl | Cl | H | CF₂CHF₂ | t-Bu | Cl |
| CH₃ | H | CF₂CHF₂ | Me | Br | Cl | H | CF₂CHF₂ | Me | Br |
| CH₃ | H | CF₂CHF₂ | Et | Br | Cl | H | CF₂CHF₂ | Et | Br |
| CH₃ | H | CF₂CHF₂ | i-Pr | Br | Cl | H | CF₂CHF₂ | i-Pr | Br |
| CH₃ | H | CF₂CHF₂ | t-Bu | Br | Cl | H | CF₂CHF₂ | t-Bu | Br |
| CH₃ | F | CHF₂ | Me | Cl | CH₃ | Cl | CHF₂ | Me | Cl |
| CH₃ | F | CHF₂ | EL | Cl | CH₃ | Cl | CHF₂ | Et | Cl |
| CH₃ | F | CHF₂ | i-Pr | Cl | CH₃ | Cl | CHF₂ | i-Pr | Cl |
| CH₃ | F | CHF₂ | t-Bu | Cl | CH₃ | Cl | CHF₂ | t-Bu | Cl |
| CH₃ | F | CHF₂ | Me | Br | CH₃ | Cl | CHF₂ | Me | Br |
| CH₃ | F | CHF₂ | Et | Br | CH₃ | Cl | CHF₂ | Et | Br |
| CH₃ | F | CHF₂ | i-Fr | Br | CH₃ | Cl | CHF₂ | i-Pr | Br |
| CH₃ | F | CHF₂ | t-Bu | Br | CH₃ | Cl | CHF₂ | t-Bu | Br |
| Cl | F | CHF₂ | Me | Cl | Cl | F | CHF₂ | Me | Cl |
| Cl | F | CHF₂ | EL | Cl | Cl | F | CHF₂ | Et | Cl |
| Cl | F | CHF₂ | i-Pr | Cl | Cl | F | CHF₂ | i-Pr | Cl |
| Cl | F | CHF₂ | t-Bu | Cl | Cl | F | CHF₂ | t-Bu | Cl |
| Cl | F | CHF₂ | Me | Br | Cl | F | CHF₂ | Me | Br |
| Cl | F | CHF₂ | Et | Br | Cl | F | CHF₂ | Et | Br |
| Cl | F | CHF₂ | i-Fr | Br | Cl | F | CHF₂ | i-Pr | Br |
| Cl | F | CHF₂ | t-Bu | Br | Cl | F | CHF₂ | t-Bu | Br |
| CH₃ | Br | CHF₂ | Me | Cl | CH₃ | I | CHF₂ | Me | Cl |
| CH₃ | Br | CHF₂ | Et | Cl | CH₃ | I | CHF₂ | Et | Cl |
| CH₃ | Br | CHF₂ | i-Fr | Cl | CH₃ | I | CHF₂ | i-Pr | Cl |
| CH₃ | Br | CHF₂ | t-Bu | Cl | CH₃ | I | CHF₂ | tBu | Cl |
| CH₃ | Br | CHF₂ | Me | Br | CH₃ | I | CHF₂ | Me | Br |
| CH₃ | Br | CHF₂ | Et | Br | CH₃ | I | CHF₂ | Et | Br |
| CH₃ | Br | CHF₂ | i-Pr | Br | CH₃ | I | CHF₂ | i-Pr | Br |
| CH₃ | Br | CHF₂ | t-Bu | Br | CH₃ | I | CHF₂ | t-Bu | Br |
| Cl | Br | CHF₂ | Me | Cl | Cl | I | CHF₂ | Me | Cl |
| Cl | Br | CHF₂ | Et | Cl | CI | I | ClIP2 | Et | CI |
| Cl | Br | CHF₂ | i-Pr | Cl | Cl | I | CHF₂ | i-Pr | Cl |
| Cl | Br | CHF₂ | t-Bu | Cl | Cl | I | CHF₂ | t-Bu | CI |
| CI | Br | CHF₂ | Me | Br | Cl | I | CHF₂ | Me | Br |
| Cl | Br | CHF₂ | Et | Br | Cl | I | CHF₂ | Et | Br |
| Cl | Br | CHF₂ | i-Pr | Br | Cl | I | CHF₂ | i-Pr | Br |
| Cl | Br | CHF₂ | t-Bu | Br | Cl | I | CHF₂ | t-Bu | Br |
| CH₃ | H | CHF₂ | Me | Br | Cl | H | CHF₂ | Me | Br |
| CH₃ | H | CHF₂ | Et | Br | Cl | H | CHF₂ | Et | Br |
| CH₃ | H | CHF₂ | i-Pr | Br | Cl | H | CHF₂ | i-Pr | Br |
| CH₃ | H | CHF₂ | t-Bu | Br | Cl | H | CHF₂ | t-Bu | Br |

TABLE 16

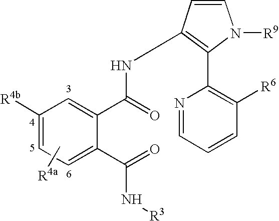

| R³ | R^{4a} | R^{4b} | R⁹ | R⁶ | R³ | R^{4a} | R^{4b} | R⁹ | R⁶ |
|---|---|---|---|---|---|---|---|---|---|
| Me | 3-Me | H | CF₃ | F | Me | 3-Cl | H | CF₃ | F |
| Et | 3-Me | 5-Me | CHF₂ | F | Et | 3-Cl | 5-Me | CHF₂ | F |
| i-Pr | 3-Me | H | CHF₂ | F | i-Pr | 3-Cl | H | CHF₂ | F |
| t-Bu | 3-Me | 5-Cl | CH₂CF₃ | F | t-Bu | 3-Cl | 5-Cl | CH₂CF₃ | F |
| Me | 3-Me | H | CH₂CF₃ | F | Me | 3-Cl | H | CH₂CF₃ | F |
| Et | 3-Me | H | CF₂CHF₂ | F | Et | 3-Cl | H | CF₂CHF₂ | F |
| i-Pr | 3-Me | 5-Br | CF₂CHF₂ | F | i-Pr | 3-Cl | 5-Br | CF₂CHF₂ | F |
| t-Bu | 3-Me | H | Et | F | t-Bu | 3-Cl | H | Et | F |
| propargyl | 3-Me | H | CF₃ | F | propargyl | 3-Cl | H | CF_{3 F} | |
| c-propyl | 3-Me | H | CHF₂ | F | c-propyl | 3-Cl | H | CHF₂ | F |
| i-Pr | 3-Me | 5-Cl | CF₃ | F | i-Pr | 3-Cl | 5-Cl | CF₃ | F |
| t-Bu | 3-Me | H | n-C₃F₇ | F | t-Bu | 3-Cl | H | n-C₃F₇ | F |
| Me | 3-Me | 5-Cl | i-C₃F₇ | F | Me | 3-Cl | 5-Cl | i-C₃F₇ | F |
| Et | 3-Me | H | i-Pr | F | Et | 3-Cl | H | i-Pr | F |
| i-Pr | 3-Me | H | CF₃ | F | i-Pr | 3-Cl | H | CF₃ | F |
| t-Bu | 3-Me | H | C₂F₅ | F | t-Bu | 3-Cl | H | C₂F₅ | F |
| propargyl | 3-Me | H | C₂F₅ | F | propargyl | 3-Cl | H | C₂F₅ | F |
| c-propyl | 3-Me | H | CF₃ | F | c-propyl | 3-Cl | H | CF₃ | F |
| i-Pr | 3-Me | H | n-Pr | F | i-Pr | 3-Cl | H | n-Pr | F |
| t-Bu | 3-Me | 5-Br | CH₂CH₂Cl | F | t-Bu | 3-Cl | 5-Br | CH₂CH₂Cl | F |
| Me | 3-Me | H | CF₃ | Cl | Me | 3-Cl | H | CF₃ | Cl |
| Et | 3-Me | 5-Me | CHF₂ | Cl | Et | 3-Cl | 5-Me | CHF₂ | Cl |
| i-Pr | 3-Me | H | CHF₂ | Cl | i-Pr | 3-Cl | H | CHF₂ | Cl |
| t-Bu | 3-Me | 5-Cl | CH₂CF₃ | Cl | t-Bu | 3-Cl | 5-Br | CH₂CH₂Cl | Cl |
| Me | 3-Me | H | CH₂CF₃ | Cl | Me | 3-Cl | H | CH₂CF₃ | Cl |
| Et | 3-Me | H | CF₂CHF₂ | Cl | Et | 3-Cl | H | CF₂CHF₂ | Cl |
| i-Pr | 3-Me | 5-Br | CF₂CHF₂ | Cl | i-Pr | 3-Cl | 5-Br | CF₂CHF₂ | Cl |
| t-Bu | 3-Me | H | Et | Cl | t-Bu | 3-Cl | H | Et | Cl |
| propargyl | 3-Me | H | CF₃ | Cl | propargyl | 3-Cl | H | CF₃ | Cl |
| c-propyl | 3-Me | H | CHF₂ | Cl | c-propyl | 3-Cl | H | CHF₂ | Cl |
| i-Pr | 3-Me | 5-Cl | CF₃ | Cl | i-Pr | 3-Cl | 5-Cl | CF₃ | Cl |
| t-Bu | 3-Me | H | n-C₃F₇ | Cl | t-Bu | 3-Cl | H | n-C₃F₇ | Cl |
| Me | 3-Me | 5-Cl | i-C₃F₇ | Cl | Me | 3-Cl | 5-Cl | i-C₃F₇ | Cl |
| Et | 3-Me | H | i-Pr | Cl | Et | 3-Cl | H | i-Pr | Cl |
| i-Pr | 3-Me | H | CF₃ | Cl | i-Pr | 3-Cl | H | CF₃ | Cl |
| t-Bu | 3-Me | H | C₂F₅ | Cl | t-Bu | 3-Cl | H | C₂F₅ | Cl |
| propargyl | 3-Me | H | C₂F₅ | Cl | propargyl | 3-Cl | H | C₂F₅ | Cl |
| c-propyl | 3-Me | H | CF₃ | Cl | c-propyl | 3-Cl | H | CF₃ | Cl |
| i-Pr | 3-Me | H | n-Pr | Cl | i-Pr | 3-Cl | H | n-Pr | Cl |
| t-Bu | 3-Me | 5-Br | CH₂CH₂Cl | Cl | t-Bu | 3-Cl | 5-Br | CH₂CH₂Cl | Cl |
| Me | 3-Me | H | CF₃ | CF₃ | Me | 3-Cl | H | CF₃ | CF₃ |
| Et | 3-Me | 5-Me | CHF₂ | CF₃ | Et | 3-Cl | 5-Me | CHF₂ | CF₃ |
| i-Pr3-Me | H | CHF₂ | CF₃ | i-Pr | 3-Cl | H | CHF₂ | CF₃ | |
| t-Bu | 3-Me | 5-Cl | CH₂CF₃ | CF₃ | t-Bu | 3-Cl | 5-Cl | CH₂CF₃ | CF₃ |
| Me | 3-Me | H | CH₂CF₃ | CF₃ | Me | 3-Cl | H | CH₂CF₃ | CF₃ |
| Et | 3-Me | H | CF₂CHF₂ | CF₃ | Et | 3-Cl | H | CF₂CHF₂ | CF₃ |
| i-Pr | 3-Me | 5-Br | CF₂CHF₂ | CF₃ | i-Pr | 3-Cl | 5-Br | CF₂CHF₂ | CF₃ |
| t-Bu | 3-Me | H | Et | CF₃ | t-Bu | 3-Cl | H | Et | CF₃ |
| propargyl | 3-Me | H | CF₃ | CF₃ | propargyl | 3-Cl | H | CF₃ | CF₃ |
| c-propyl | 3-Me | H | CHF₂ | CF₃ | c-propyl | 3-Cl | H | CHF₂ | CF₃ |
| i-Pr | 3-Me | 5-Cl | CF₃ | CF₃ | i-Pr | 3-Cl | 5-Cl | CF₃ | CF₃ |
| t-Bu | 3-Me | H | n-C₃F₇ | CF₃ | t-Bu | 3-Cl | H | n-C₃F₇ | CF₃ |
| Me | 3-Me | 5-Cl | i-C₃F₇ | CF₃ | Me | 3-Cl | 5-Cl | i-C₃F₇ | CF₃ |
| Et | 3-Me | H | i-Pr | CF₃ | Et | 3-Cl | H | i-Pr | CF₃ |
| i-Pr | 3-Me | H | CF₃ | CF₃ | i-Pr | 3-Cl | H | CF₃ | CF₃ |
| t-Bu | 3-Me | H | C₂F₅ | CF₃ | t-Bu | 3-Cl | H | C₂F₅ | CF₃ |
| propargyl | 3-Me | H | C₂F₅ | CF₃ | propargyl | 3-Cl | H | C₂F₅ | CF₃ |
| c-propyl | 3-Me | H | CF₃ | F | c-propyl | 3-Cl | H | CF₃ | CF₃ |
| i-Pr | 3-Me | H | n-Pr | CF₃ | i-Pr | 3-Cl | H | n-Pr | CF₃ |
| t-Bu | 3-Me | 5-Br | CH₂CH₂Cl | CF₃ | t-Bu | 3-Cl | 5-Br | CH₂CH₂Cl | CF₃ |
| Me | 3-Me | H | CF₃ | Br | Me | 3-Cl | H | CF₃ | Br |
| Et | 3-Me | 5-Me | CHF₂ | Br | Et | 3-Cl | 5-Me | CHF₂ | Br |
| i-Pr | 3-Me | H | CHF₂ | Br | i-Pr | 3-Cl | H | CHF₂ | Br |
| t-Bu | 3-Me | 5-Cl | CH₂CF₃ | Br | t-Bu | 3-Cl | 5-Cl | CH₂CF₃ | Br |
| Me | 3-Me | H | CH₂CF₃ | Br | Me | 3-Cl | H | CH₂CF₃ | Br |
| Et | 3-Me | H | CF₂CHF₂ | Br | Et | 3-Cl | H | CF₂CHF₂ | Br |
| i-Pr | 3-Me | 5-Br | CF₂CHF₂ | Br | i-Pr | 3-Cl | 5-Br | CF₂CHF₂ | Br |
| t-Bu | 3-Me | H | Et | Br | t-Bu | 3-Cl | H | Et | Br |
| propargyl | 3-Me | H | CF₃ | Br | propargyl | 3-Cl | H | CF₃ | Br |
| c-propyl | 3-Me | H | CHF₂ | Br | c-propyl | 3-Cl | H | CHF₂ | Br |
| i-Pr | 3-Me | 5-Cl | CF₃ | Br | i-Pr | 3-Cl | 5-Cl | CF₃ | Br |
| t-Bu | 3-Me | H | n-C₃F₇ | Br | t-Bu | 3-Cl | H | n-C₃F₇ | Br |
| Me | 3-Me | 5-Cl | i-C₃F₇ | Br | Me | 3-Cl | 5-Cl | i-C₃F₇ | Br |
| Et | 3-Me | H | i-Pr | Br | Et | 3-Cl | H | i-Pr | Br |
| i-Pr | 3-Me | H | CF₃ | Br | i-Pr | 3-Cl | H | CF₃ | Br |
| t-Bu | 3-Me | H | C₂F₅ | Br | t-Bu | 3-Cl | H | C₂F₅ | Br |
| propargyl | 3-Me | H | C₂F₅ | Br | propargyl | 3-Cl | H | C₂F₅ | Br |
| c-propyl | 3-Me | H | CF₃ | Br | c-propyl | 3-Cl | H | CF₃ | Br |
| i-Pr | 3-Me | H | n-Pr | Br | i-Pr | 3-Cl | H | n-Pr | Br |
| t-Bu | 3-Me | 5-Br | CH₂CH₂Cl | Br | t-Bu | 3-Cl | 5-Br | CH₂Cl | Br |
| Me | 6-Me | H | CHF₂ | F | Me | 6-Cl | H | CHF₂ | F |
| Et | 6-Me | H | CHF₂ | F | Et | 6-Cl | H | CHF₂ | F |
| i-Pr | 6-Me | H | CHF₂ | F | i-Pr | 6-Cl | H | CHF₂ | F |
| t-Bu | 6-Me | H | CHF₂ | F | t-Bu | 6-Cl | H | CHF₂ | F |
| Me | 6-Me | H | n-Pr | F | Me | 6-Cl | H | fl-Pr | F |
| Et | 6-Me | H | n-Pr | F | Et | 6-Cl | H | fl-Pr | F |
| i-Pr | 6-Me | H | n-Pr | F | i-Pr | 6-Cl | H | n-Pr | F |
| t-Bu | 6-Me | H | n-Pr | F | t-Bu | 6-Cl | H | n-Pr | F |
| Me | 6-Me | H | CF₃ | F | Me | 6-Cl | H | CF₃ | F |
| Et | 6-Me | H | CF₃ | F | Et | 6-Cl | H | CF₃ | F |
| i-Pr | 6-Me | H | CF₃ | F | i-Pr | 6-Cl | H | CF₃ | F |
| t-Bu | 6-Me | H | CF₃ | F | t-Bu | 6-Cl | H | CF₃ | F |
| Me | 6-Me | H | i-Pr | F | Me | 6-Cl | H | i-Pr | F |
| Et | 6-Me | H | i-Pr | F | Et | 6-Cl | H | i-Pr | F |
| i-Pr | 6-Me | H | i-Pr | F | i-Pr | 6-Cl | H | i-Pr | F |
| t-Bu | 6-Me | H | i-Pr | F | t-Bu | 6-Cl | H | i-Pr | F |
| Me | 6-Me | H | C₂F₅ | F | Me | 6-Cl | H | C₂F₅ | F |
| Et | 6-Me | H | C₂F₅ | F | El | 6-Cl | H | C₂F₅ | F |
| i-Pr | 6-Me | H | C₂F₅ | F | i-Pr | 6-Cl | H | C₂F₅ | F |
| t-Bu | 6-Me | H | C₂F₅ | F | t-Bu | 6-Cl | H | C₂F₅ | F |
| Me | 6-Me | H | n-C₃F₇ | F | Me | 6-Cl | H | n-C₃F₇ | F |
| El | 6-Me | H | n-C₃F₇ | F | El | 6-Cl | H | n-C₃F₇ | F |
| i-Pr | 6-Me | H | n-C₃F₇ | F | i-Pr | 6-Cl | H | n-C₃F₇ | F |
| t-Bu | 6-Me | H | n-C₃F₇ | F | t-Bu | 6-Cl | H | n-C₃F₇ | F |
| Me | 6-Me | H | i-C₃F₇ | F | Me | 6-Cl | H | i-C₃F₇ | F |
| El | 6-Me | H | i-C₃F₇ | F | Et | 6-Cl | H | i-C₃F₇ | F |
| i-Pr | 6-Me | H | i-C₃F₇ | F | i-Pr | 6-Cl | H | i-C₃F₇ | F |
| t-Bu | 6-Me | H | i-C₃F₇ | F | t-Bu | 6-Cl | H | i-C₃F₇ | F |
| Me | 6-Me | H | Et | F | Me | 6-Cl | H | Et | F |
| Et | 6-Me | H | El | F | Et | 6-Cl | H | Et | F |
| i-Pr | 6-Me | H | Et | F | i-Pr | 6-Cl | H | Et | F |
| t-Bu | 6-Me | H | Et | F | t-Bu | 6-Cl | H | El | F |
| Me | 6-Me | H | CHF₂ | Cl | Me | 6-Cl | H | CHF₂ | Cl |
| Et | 6-Me | H | CHF₂ | Cl | Et | 6-Cl | H | CHF₂ | Cl |
| i-Pr | 6-Me | H | CHF₂ | Cl | i-Pr | 6-Cl | H | CHF₂ | Cl |
| t-Bu | 6-Me | H | CHF₂ | Cl | t-Bu | 6-Cl | H | CHF₂ | Cl |
| Me | 6-Me | H | n-Pr | Cl | Me | 6-Cl | H | n-Pr | Cl |
| Et | 6-Me | H | n-Pr | Cl | Et | 6-Cl | H | n-Pr | Cl |
| i-Pr | 6-Me | H | n-Pr | Cl | i-Pr | 6-Cl | H | n-Pr | Cl |
| t-Bu | 6-Me | H | n-Pr | Cl | t-Bu | 6-Cl | H | n-Pr | Cl |
| Me | 6-Me | H | CF₃ | Cl | Me | 6-Cl | H | CF₃ | Cl |
| Et | 6-Me | H | CF₃ | Cl | El | 6-Cl | H | CF₃ | Cl |
| i-Pr | 6-Me | H | CF₃ | Cl | i-Pr | 6-Cl | H | CF₃ | Cl |
| t-Bu | 6-Me | H | CF₃ | Cl | t-Bu | 6-Cl | H | CF₃ | Cl |
| Me | 6-Me | H | i-Pr | Cl | Me | 6-Cl | H | i-Pr | Cl |
| Et | 6-Me | H | i-Pr | Cl | Et | 6-Cl | H | i-Pr | Cl |
| i-Pr | 6-Me | H | i-Pr | Cl | i-Pr | 6-Cl | H | i-Pr | Cl |
| t-Bu | 6-Me | H | i-Pr | Cl | t-Bu | 6-Cl | H | i-Pr | Cl |
| Me | 6-Me | H | C₂F₅ | Cl | Me | 6-Cl | H | C₂F₅ | Cl |
| Et | 6-Me | H | C₂F₅ | Cl | Et | 6-Cl | H | C₂F₅ | Cl |
| i-Pr | 6-Me | H | C₂F₅ | Cl | i-Pr | 6-Cl | H | C₂F₅ | Cl |
| t-Bu | 6-Me | H | C₂F₅ | Cl | t-Bu | 6-Cl | H | C₂F₅ | Cl |
| Me | 6-Me | H | n-C₃F₇ | Cl | Me | 6-Cl | H | n-C₃F₇ | Cl |
| Et | 6-Me | H | n-C₃F₇ | Cl | Et | 6-Cl | H | n-C₃F₇ | Cl |
| i-Pr | 6-Me | H | n-C₃F₇ | Cl | i-Pr | 6-Cl | H | n-C₃F₇ | Cl |
| t-Bu | 6-Me | H | n-C₃F₇ | Cl | t-Bu | 6-Cl | H | n-C₃F₇ | Cl |
| Me | 6-Me | H | i-C₃F₇ | Cl | Me | 6-Cl | H | i-C₃F₇ | Cl |
| Et | 6-Me | H | i-C₃F₇ | Cl | Et | 6-Cl | H | i-C₃F₇ | Cl |
| i-Pr | 6-Me | H | i-C₃F₇ | Cl | i-Pr | 6-Cl | H | i-C₃F₇ | Cl |
| t-Bu | 6-Me | H | i-C₃F₇ | Cl | t-Bu | 6-Cl | H | i-C₃F₇ | Cl |
| Me | 6-Me | H | Et | Cl | Me | 6-Cl | H | Et | Cl |
| Et | 6-Me | H | Et | Cl | Et | 6-Cl | H | Et | Cl |
| i-Pr | 6-Me | H | Et | Cl | i-Pr | 6-Cl | H | Et | Cl |
| t-Bu | 6-Me | H | Et | Cl | t-Bu | 6-Cl | H | Et | Cl |
| Me | 6-Me | H | CHF₂ | Br | Me | 6-Cl | H | CHF₂ | Br |
| Et | 6-Me | H | CHF₂ | Br | Et | 6-Cl | H | CHF₂ | Br |
| i-Pr | 6-Me | H | CHF₂ | Br | i-Pr | 6-Cl | H | CHF₂ | Br |
| t-Bu | 6-Me | H | CHF₂ | Br | t-Bu | 6-Cl | H | CHF₂ | Br |
| Me | 6-Me | H | n-Pr | Br | Me | 6-Cl | H | n-Pr | Br |
| Et | 6-Me | H | n-Pr | Br | Et | 6-Cl | H | n-Pr | Br |
| i-Pr | 6-Me | H | n-Pr | Br | i-Pr | 6-Cl | H | n-Pr | Br |
| t-Bu | 6-Me | H | n-Pr | Br | t-Bu | 6-Cl | H | n-Pr | Br |
| Me | 6-Me | H | CF₃ | Br | Me | 6-Cl | H | CF₃ | Br |
| Et | 6-Me | H | CF₃ | Br | Et | 6-Cl | H | CF₃ | Br |
| i-Pr | 6-Me | H | CF₃ | Br | i-Pr | 6-Cl | H | CF₃ | Br |
| t-Bu | 6-Me | H | CF₃ | Br | t-Bu | 6-Cl | H | CF₃ | Br |
| Me | 6-Me | H | i-Pr | Br | Me | 6-Cl | H | i-Pr | Br |
| Et | 6-Me | H | i-Pr | Br | El | 6-Cl | H | i-Pr | Br |
| i-Pr | 6-Me | H | i-Pr | Br | i-Pr | 6-Cl | H | i-Pr | Br |
| t-Bu | 6-Me | H | i-Pr | Br | t-Bu | 6-Cl | H | i-Pr | Br |
| Me | 6-Me | H | C₂F₅ | Br | Me | 6-Cl | H | C₂F₅ | Br |
| Et | 6-Me | H | C₂F₅ | Br | El | 6-Cl | H | C₂F₅ | Br |
| i-Pr | 6-Me | H | C₂F₅ | Br | i-Pr | 6-CL | H | C₂F₅ | Br |
| t-Bu | 6-Me | H | C₂F₅ | Br | t-Bu | 6-Cl | H | C₂F₅ | Br |
| Me | 6-Me | H | n-C₃F₇ | Br | Me | 6-Cl | H | n-C₃F₇ | Br |
| Et | 6-Me | H | n-C₃F₇ | Br | Et | 6-Cl | H | n-C₃F₇ | Br |
| i-Pr | 6-Me | H | n-C₃F₇ | Br | i-Pr | 6-Cl | H | n-C₃F₇ | Br |
| t-Bu | 6-Me | H | n-C₃F₇ | Br | t-Bu | 6-Cl | H | n-C₃F₇ | Br |
| Me | 6-Me | H | i-C₃F₇ | Br | Me | 6-Cl | H | i-C₃F₇ | Br |
| Et | 6-Me | H | i-C₃F₇ | Br | El | 6-Cl | H | i-C₃F₇ | Br |
| i-Pr | 6-Me | H | i-C₃F₇ | Br | i-Pr | 6-Cl | H | i-C₃F₇ | Br |
| t-Bu | 6-Me | H | i-C₃F₇ | Br | t-Bu | 6-Cl | H | i-C₃F₇ | Br |
| Me | 6-Me | H | Et | Br | Me | 6-Cl | H | Et | Br |
| El | 6-Me | H | lEt | Br | El | 6-Cl | H | Et | Br |
| i-Pr | 6-Me | H | Et | Br | i-Pr | 6-Cl | H | Et | Br |
| t-Bu | 6-Me | H | Et | Br | t-Bu | 6-Cl | H | Et | Br |
| Me | 6-Me | H | CHF₂ | CF₃ | Me | 6-Cl | H | CHF₂ | CF₃ |
| Et | 6-Me | H | CHF₂ | CF₃ | El | 6-Cl | H | CHF₂ | CF₃ |
| i-Pr | 6-Me | H | CHF₂ | CF₃ | i-Pr | 6-Cl | H | CHF₂ | CF₃ |
| t-Bu | 6-Me | H | CHF₂ | CF₃ | t-Bu | 6-Cl | H | CHF₂ | CF₃ |
| Me | 6-Me | H | n-Pr | CF₃ | Me | 6-Cl | H | n-Pr | CF₃ |
| Et | 6-Me | H | n-Pr | CF₃ | Et | 6-Cl | H | n-Pr | CF₃ |
| i-Pr | 6-Me | H | n-Pr | CF₃ | i-Pr | 6-Cl | H | n-Pr | CF₃ |
| t-Bu | 6-Me | H | n-Pr | CF₃ | t-Bu | 6-Cl | H | n-Pr | CF₃ |
| Me | 6-Me | H | CF₃ | CF₃ | Me | 6-Cl | H | CF₃ | CF₃ |
| El | 6-Me | H | CF₃ | CF₃ | Et | 6-Cl | H | CF₃ | CF₃ |
| i-Pr | 6-Me | H | CF₃ | CF₃ | i-Pr | 6-Cl | H | CF₃ | CF₃ |
| t-Bu | 6-Me | H | CF₃ | CF₃ | f-Bu | 6-Cl | H | CF₃ | CF₃ |
| Me | 6-Me | H | i-Pr | CF₃ | Me | 6-Cl | H | i-Pr | CF₃ |
| Et | 6-Me | H | i-Pr | CF₃ | Et | 6-Cl | H | i-Pr | CF₃ |
| i-Pr | 6-Me | H | i-Pr | CF₃ | i-Pr | 6-Cl | H | i-Pr | CF₃ |
| t-Bu | 6-Me | H | i-Pr | CF₃ | t-Bu | 6-Cl | H | i-Pr | CF₃ |
| Me | 6-Me | H | C₂F₅ | CF₃ | Me | 6-Cl | H | C₂F₅ | CF₃ |
| El | 6-Me | H | C₂F₅ | CF₃ | Et | 6-Cl | H | C₂F₅ | CF₃ |
| i-Pr | 6-Me | H | C₂F₅ | CF₃ | i-Pr | 6-Cl | H | C₂F₅ | CF₃ |
| t-Bu | 6-Me | H | C₂F₅ | CF₃ | (-BU | 6-Cl | H | C₂F₅ | CF₃ |
| Me | 6-Me | H | n-C₃F₇ | CF₃ | Me | 6-Cl | H | n-C₃F₇ | CF₃ |
| Et | 6-Me | H | n-C₃F₇ | CF₃ | Et | 6-Cl | H | n-C₃F₇ | CF₃ |
| i-Pr | 6-Me | H | n-C₃F₇ | CF₃ | i-Pr | 6-Cl | H | n-C₃F₇ | CF₃ |
| t-Bu | 6-Me | H | n-C₃F₇ | CF₃ | t-Bu | 6-Cl | H | n-C₃F₇ | CF₃ |
| Me | 6-Me | H | i-C₃F₇ | CF₃ | Me | 6-Cl | H | i-C₃F₇ | CF₃ |
| Et | 6-Me | H | i-C₃F₇ | CF₃ | Et | 6-Cl | H | i-C₃F₇ | CF₃ |
| i-Pr | 6-Me | H | i-C₃F₇ | CF₃ | i-Pr | 6-Cl | H | i-C₃F₇ | CF₃ |
| t-Bu | 6-Me | H | i-C₃F₇ | CF₃ | t-Bu | 6-Cl | H | i-C₃F₇ | CF₃ |
| Me | 6-Me | H | Et | CF₃ | Me | 6-Cl | H | Et | CF₃ |
| Et | 6-Me | H | Et | CF₃ | Et | 6-Cl | H | Et | CF₃ |
| i-Pr | 6-Me | H | Et | CF₃ | i-Pr | 6-Cl | H | Et | CF₃ |
| t-Bu | 6-Me | H | Et | CF₃ | t-Bu | 6-Cl | H | Et | CF₃ |
| Me | 6-Me | Cl | CHF₂ | F | Me | 6-Cl | Cl | CHF₂ | F |
| Et | 6-Me | Cl | CHF₂ | F | Et | 6-Cl | Cl | CHF₂ | F |
| i-Pr | 6-Me | Cl | CHF₂ | F | i-Pr | 6-Cl | Cl | CHF₂ | F |
| t-Bu | 6-Me | Cl | CHF₂ | F | t-Bu | 6-Cl | Cl | CLIP2 | F |
| Me | 6-Me | Cl | n-Pr | F | Me | 6-Cl | Cl | n-Pr | F |
| Et | 6-Me | Cl | n-Pr | F | Et | 6-Cl | Cl | n-Pr | F |
| i-Pr | 6-Me | Cl | n-Pr | F | i-Pr | 6-Cl | Cl | n-Pr | F |
| t-Bu | 6-Me | Cl | n-Pr | F | t-Bu | 6-Cl | Cl | n-Pr | F |
| Me | 6-Me | Cl | CF₃ | F | Me | 6-Cl | Cl | CF₃ | F |
| Et | 6-Me | Cl | CF₃ | F | Et | 6-Cl | Cl | CF₃ | F |
| i-Pr | 6-Me | Cl | CF₃ | F | i-Pr | 6-Cl | Cl | CF₃ | F |
| t-Bu | 6-Me | Cl | CF₃ | F | t-Bu | 6-Cl | Cl | CF₃ | F |
| Me | 6-Me | Cl | i-Pr | F | Me | 6-Cl | Cl | i-Pr | F |
| Et | 6-Me | Cl | i-Pr | F | Et | 6-Cl | Cl | i-Pr | F |
| i-Pr | 6-Me | Cl | i-Pr | F | i-Pr | 6-Cl | Cl | i-Pr | F |
| t-Bu | 6-Me | Cl | i-Pr | F | t-Bu | 6-Cl | Cl | i-Pr | F |
| Me | 6-Me | Cl | C₂F₅ | F | Me | 6-Cl | Cl | C₂F₅ | F |
| Et | 6-Me | Cl | C₂F₅ | F | Et | 6-Cl | Cl | C₂F₅ | F |
| i-Pr | 6-Me | Cl | C₂F₅ | F | i-Pr | 6-Cl | Cl | C₂F₅ | F |
| t-Bu | 6-Me | Cl | C₂F₅ | F | t-Bu | 6-Cl | Cl | C₂F₅ | F |
| Me | 6-Me | Cl | n-C₃F₇ | F | Me | 6-Cl | Cl | n-C₃F₇ | F |
| Et | 6-Me | Cl | n-C₃F₇ | F | Et | 6-Cl | Cl | n-C₃F₇ | F |
| i-Pr | 6-Me | Cl | n-C₃F₇ | F | i-Pr | 6-Cl | Cl | n-C₃F₇ | F |
| t-Bu | 6-Me | Cl | n-C₃F₇ | F | t-Bu | 6-Cl | Cl | n-C₃F₇ | F |
| Me | 6-Me | Cl | i-C₃F₇ | F | Me | 6-Cl | Cl | i-C₃F₇ | F |
| Et | 6-Me | Cl | i-C₃F₇ | F | Et | 6-Cl | Cl | i-C₃F₇ | F |
| i-Pr | 6-Me | Cl | i-C₃F₇ | F | i-Pr | 6-Cl | Cl | i-C₃F₇ | F |
| t-Bu | 6-Me | Cl | i-C₃F₇ | F | t-Bu | 6-Cl | Cl | i-C₃F₇ | F |
| Me | 6-Me | Cl | Et | F | Me | 6-Cl | Cl | Et | F |
| Et | 6-Me | Cl | Et | F | Et | 6-Cl | Cl | Et | F |
| i-Pr | 6-Me | Cl | Et | F | i-Pr | 6-Cl | Cl | Et | F |
| t-Bu | 6-Me | Cl | Et | F | t-Bu | 6-Cl | Cl | Et | F |
| Me | 6-Me | Cl | CHF₂ | Cl | Me | 6-Cl | Cl | CHF₂ | Cl |
| Et | 6-Me | Cl | CHF₂ | Cl | Et | 6-Cl | Cl | CHF₂ | Cl |
| i-Pr | 6-Me | Cl | CHF₂ | Cl | i-Pr | 6-Cl | Cl | CHF₂ | Cl |
| t-Bu | 6-Me | Cl | CHF₂ | Cl | t-Bu | 6-Cl | Cl | CHF₂ | Cl |
| Me | 6-Me | Cl | n-Pr | CI | Me | 6-Cl | Cl | n-Pr | Cl |
| Et | 6-Me | Cl | n-Pr | Cl | Et | 6-Cl | Cl | n-Pr | Cl |
| i-Pr | 6-Me | Cl | n-Pr | Cl | i-Pr | 6-Cl | Cl | n-Pr | Cl |
| t-Bu | 6-Me | Cl | n-Pr | Cl | t-Bu | 6-Cl | Cl | n-Pr | Cl |
| Me | 6-Me | Cl | CF₃ | Cl | Me | 6-Cl | Cl | CF₃ | Cl |
| Et | 6-Me | Cl | CF₃ | Cl | Et | 6-Cl | Cl | CF₃ | Cl |
| i-Pr | 6-Me | Cl | CF₃ | Cl | i-Pr | 6-Cl | Cl | CF₃ | Cl |
| t-Bu | 6-Me | Cl | CF₃ | Cl | t-Bu | 6-Cl | Cl | CF₃ | Cl |
| Me | 6-Me | Cl | i-Pr | Cl | Me | 6-Cl | Cl | i-Pr | Cl |
| Et | 6-Me | Cl | i-Pr | Cl | Et | 6-Cl | Cl | i-Pr | Cl |
| i-Pr | 6-Me | Cl | i-Pr | Cl | i-Pr | 6-Cl | Cl | i-Pr | Cl |
| t-Bu | 6-Me | Cl | i-Pr | Cl | t-Bu | 6-Cl | Cl | i-Pr | Cl |
| Me | 6-Me | Cl | C₂F₅ | Cl | Me | 6-Cl | Cl | C₂F₅ | Cl |
| Et | 6-Me | Cl | C₂F₅ | Cl | Et | 6-Cl | Cl | C₂F₅ | Cl |
| i-Pr | 6-Me | Cl | C₂F₅ | Cl | i-Pr | 6-Cl | Cl | C₂F₅ | Cl |
| t-Bu | 6-Me | Cl | C₂F₅ | Cl | t-Bu | 6-Cl | Cl | C₂F₅ | Cl |
| Me | 6-Me | Cl | n-C₃F₇ | Cl | Me | 6-Cl | Cl | n-C₃F₇ | Cl |
| Et | 6-Me | Cl | n-C₃F₇ | Cl | Et | 6-Cl | Cl | n-C₃F₇ | Cl |
| i-Pr | 6-Me | Cl | n-C₃F₇ | Cl | i-Pr | 6-Cl | Cl | n-C₃F₇ | Cl |
| t-Bu | 6-Me | Cl | n-C₃F₇ | Cl | t-Bu | 6-Cl | Cl | n-C₃F₇ | Cl |
| Me | 6-Me | Cl | i-C₃F₇ | Cl | Me | 6-Cl | Cl | i-C₃F₇ | Cl |
| Et | 6-Me | Cl | i-C₃F₇ | Cl | Et | 6-Cl | Cl | i-C3Fy | Cl |
| i-Pr | 6-Me | Cl | i-C₃F₇ | Cl | i-Pr | 6-Cl | Cl | i-C₃F₇ | Cl |
| t-Bu | 6-Me | Cl | i-C₃F₇ | Cl | g-Bu | 6-Cl | Cl | i-C₃F₇ | Cl |
| Me | 6-Me | Cl | Et | Cl | Me | 6-Cl | Cl | Et | Cl |
| Et | 6-Me | Cl | Et | Cl | Et | 6-Cl | Cl | Et | Cl |
| i-Pr | 6-Me | Cl | Et | Cl | i-Pr | 6-Cl | Cl | Et | Cl |
| t-Bu | 6-Me | Cl | Et | Cl | t-Bu | 6-Cl | Cl | Et | Cl |
| Me | 6-Me | Cl | CHF₂ | Br | Me | 6-Cl | Cl | CHF₂ | Br |
| Et | 6-Me | Cl | CHF₂ | Br | Et | 6-Cl | Cl | CHF₂ | Br |
| i-Pr | 6-Me | Cl | CHF₂ | Br | i-Pr | 6-Cl | Cl | CHF₂ | Br |
| t-Bu | 6-Me | Cl | CHF₂ | Br | t-Bu | 6-Cl | Cl | CHF₂ | Br |
| Me | 6-Me | Cl | n-Pr | Br | Me | 6-Cl | Cl | n-Pr | Br |
| Et | 6-Me | Cl | n-Pr | Br | Et | 6-Cl | Cl | n-Pr | Br |
| i-Pr | 6-Me | Cl | n-Pr | Br | i-Pr | 6-Cl | Cl | n-Pr | Br |
| t-Bu | 6-Me | Cl | n-Pr | Br | t-Bu | 6-Cl | Cl | n-Pr | Br |
| Me | 6-Me | Cl | CF₃ | Br | Me | 6-Cl | Cl | CF₃ | Br |
| Et | 6-Me | Cl | CF₃ | Br | Et | 6-Cl | Cl | CF₃ | Br |
| i-Pr | 6-Me | Cl | CF₃ | Br | i-Pr | 6-Cl | Cl | CF₃ | Br |
| t-Bu | 6-Me | Cl | CF₃ | Br | t-Bu | 6-Cl | Cl | CF₃ | Br |
| Me | 6-Me | Cl | i-Pr | Br | Me | 6-Cl | Cl | i-Pr | Br |
| Et | 6-Me | Cl | i-Pr | Br | Et | 6-Cl | Cl | i-Pr | Br |
| i-Pr | 6-Me | Cl | i-Pr | Br | i-Pr | 6-Cl | Cl | i-Pr | Br |
| t-Bu | 6-Me | Cl | i-Pr | Br | t-Bu | 6-Cl | Cl | i-Pr | Br |
| Me | 6-Me | Cl | C₂F₅ | Br | Me | 6-Cl | Cl | C₂F₅ | Br |
| Et | 6-Me | Cl | C₂F₅ | Br | Et | 6-Cl | Cl | C₂F₅ | Br |
| i-Pr | 6-Me | Cl | C₂F₅ | Br | i-Pr | 6-Cl | Cl | C₂F₅ | Br |
| t-Bu | 6-Me | Cl | C₂F₅ | Br | t-Bu | 6-Cl | Cl | C₂F₅ | Br |
| Me | 6-Me | Cl | n-C₃F₇ | Br | Me | 6-Cl | Cl | n-C₃F₇ | Br |
| Et | 6-Me | Cl | n-C₃F₇ | Br | Et | 6-Cl | Cl | n-C₃F₇ | Br |
| i-Pr | 6-Me | Cl | n-C₃F₇ | Br | i-Pr | 6-Cl | Cl | n-C₃F₇ | Br |
| t-Bu | 6-Me | Cl | n-C₃F₇ | Br | t-Bu | 6-Cl | Cl | n-C₃F₇ | Br |
| Me | 6-Me | Cl | i-C₃F₇ | Br | Me | 6-Cl | Cl | i-C₃F₇ | Br |
| Et | 6-Me | Cl | i-C₃F₇ | Br | Et | 6-Cl | Cl | i-C₃F₇ | Br |
| i-Pr | 6-Me | Cl | i-C₃F₇ | Br | i-Pr | 6-Cl | Cl | i-C₃F₇ | Br |
| t-Bu | 6-Me | Cl | i-C₃F₇ | Br | t-Bu | 6-Cl | Cl | i-C₃F₇ | Br |
| Me | 6-Me | Cl | Et | Br | Me | 6-Cl | Cl | Et | Br |
| Et | 6-Me | Cl | Et | Br | Et | 6-Cl | Cl | Et | Br |
| i-Pr | 6-Me | Cl | Et | Br | i-Pr | 6-Cl | Cl | Et | Br |
| t-Bu | 6-Me | Cl | Et | Br | t-Bu | 6-Cl | Cl | Et | Br |
| Me | 6-Me | Cl | CHF₂ | CF₃ | Me | 6-Cl | Cl | CHF₂ | CF₃ |
| Et | 6-Me | Cl | CHF₂ | CF₃ | Et | 6-Cl | Cl | CHF₂ | CF₃ |
| i-Pr | 6-Me | Cl | CHF₂ | CF₃ | i-Pr | 6-Cl | Cl | CHF₂ | CF₃ |
| t-Bu | 6-Me | Cl | CHF₂ | CF₃ | t-Bu | 6-Cl | Cl | CHF₂ | CF₃ |
| Me | 6-Me | Cl | n-Pr | CF₃ | Me | 6-Cl | Cl | n-Pr | CF₃ |
| Et | 6-Me | Cl | n-Pr | CF₃ | Et | 6-Cl | Cl | n-Pr | CF₃ |
| i-Pr | 6-Me | Cl | n-Pr | CF₃ | i-Pr | 6-Cl | Cl | n-Pr | CF₃ |
| t-Bu | 6-Me | Cl | n-Pr | CF₃ | t-Bu | 6-Cl | Cl | n-Pr | CF₃ |
| Me | 6-Me | Cl | CF₃ | CF₃ | Me | 6-Cl | Cl | CF₃ | CF₃ |
| Et | 6-Me | Cl | CF₃ | CF₃ | Et | 6-Cl | Cl | CF₃ | CF₃ |
| i-Pr | 6-Me | Cl | CF₃ | CF₃ | i-Pr | 6-Cl | Cl | CF₃ | CF₃ |
| t-Bu | 6-Me | Cl | CF₃ | CF₃ | t-Bu | 6-Cl | Cl | CF₃ | CF₃ |
| Me | 6-Me | Cl | i-Pr | CF₃ | Me | 6-Cl | Cl | i-Pr | CF₃ |
| Et | 6-Me | Cl | i-Pr | CF₃ | Et | 6-Cl | Cl | i-Pr | CF₃ |
| i-Pr | 6-Me | Cl | i-Pr | CF₃ | i-Pr | 6-Cl | Cl | i-Pr | CF₃ |
| t-Bu | 6-Me | Cl | i-Pr | CF₃ | t-Bu | 6-Cl | Cl | i-Pr | CF₃ |
| Me | 6-Me | Cl | C₂F₅ | CF₃ | Me | 6-Cl | Cl | C₂F₅ | CF₃ |
| Et | 6-Me | Cl | C₂F₅ | CF₃ | Et | 6-Cl | Cl | C₂F₅ | CF₃ |
| i-Pr | 6-Me | Cl | C₂F₅ | CF₃ | i-Pr | 6-Cl | Cl | C₂F₅ | CF₃ |
| t-Bu | 6-Me | Cl | C₂F₅ | CF₃ | t-Bu | 6-Cl | Cl | C₂F₅ | CF₃ |
| Me | 6-Me | Cl | n-C₃F₇ | CF₃ | Me | 6-Cl | Cl | n-C₃F₇ | CF₃ |
| Et | 6-Me | Cl | n-C₃F₇ | CF₃ | Et | 6-Cl | Cl | n-C₃F₇ | CF₃ |
| i-Pr | 6-Me | Cl | n-C₃F₇ | CF₃ | i-Pr | 6-Cl | Cl | n-C₃F₇ | CF₃ |
| t-Bu | 6-Me | Cl | n-C₃F₇ | CF₃ | t-Bu | 6-Cl | Cl | n-C₃F₇ | CF₃ |
| Me | 6-Me | Cl | i-C₃F₇ | CF₃ | Me | 6-Cl | Cl | i-C₃F₇ | CF₃ |
| Et | 6-Me | Cl | i-C₃F₇ | CF₃ | Et | 6-Cl | Cl | i-C₃F₇ | CF₃ |
| i-Pr | 6-Me | Cl | i-C₃F₇ | CF₃ | i-Pr | 6-Cl | Cl | i-C₃F₇ | CF₃ |
| t-Bu | 6-Me | Cl | i-C₃F₇ | CF₃ | t-Bu | 6-Cl | Cl | i-C₃F₇ | CF₃ |
| Me | 6-Me | Cl | Et | CF₃ | Me | 6-Cl | Cl | Et | CF₃ |
| Et | 6-Me | Cl | Et | CF₃ | Et | 6-Cl | Cl | Et | CF₃ |
| i-Pr | 6-Me | Cl | Et | CF₃ | i-Pr | 6-Cl | Cl | Et | CF₃ |
| t-Bu | 6-Me | Cl | Et | CF₃ | t-Bu | 6-Cl | Cl | Et | CF₃ |

TABLE 17

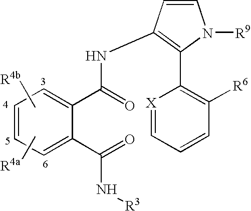

| R³ | R^{4a} | R^{4b} | R⁹ | R⁶ | X | R³ | R^{4a} | R^{4b} | R⁹ | R⁶ | X |
|---|---|---|---|---|---|---|---|---|---|---|---|
| Me | 6-Me | H | CHF₂ | F | CH | Me | 6-Cl | H | CHF₂ | F | CH |
| Et | 6-Me | H | CHF₂ | F | CH | Et | 6-Cl | H | CHF₂ | F | CH |
| i-Pr | 6-Me | H | CHF₂ | F | CH | i-Pr | 6-Cl | H | CHF₂ | F | CH |
| t-Bu | 6-Me | H | CHF₂ | F | CH | t-Bu | 6-Cl | H | CHF₂ | F | CH |
| Me | 6-Me | H | n-Pr | F | CH | Me | 6-Cl | H | n-Pr | F | CH |
| Et | 6-Me | H | n-Pr | F | CH | Et | 6-Cl | H | n-Pr | F | CH |
| i-Pr | 6-Me | H | n-Pr | F | CH | i-Pr | 6-Cl | H | n-Pr | F | CH |
| t-Bu | 6-Me | H | n-Pr | F | CH | t-Bu | 6-Cl | H | n-Pr | F | CH |
| Me | 6-Me | H | CF₃ | F | CH | Me | 6-Cl | H | CF₃ | F | CH |
| Et | 6-Me | H | CF₃ | F | CH | Et | 6-Cl | H | CF₃ | F | CH |
| i-Pr | 6-Me | H | CF₃ | F | CH | i-Pr | 6-Cl | H | CF₃ | F | CH |
| t-Bu | 6-Me | H | CF₃ | F | CH | t-Bu | 6-Cl | H | CF₃ | F | CH |
| Me | 6-Me | H | i-Pr | F | CH | Me | 6-Cl | H | i-Pr | F | CH |
| Et | 6-Me | H | i-Pr | F | CH | Et | 6-Cl | H | i-Pr | F | CH |
| i-Pr | 6-Me | H | i-Pr | F | CH | i-Pr | 6-Cl | H | i-Pr | F | CH |
| t-Bu | 6-Me | H | i-Pr | F | CH | t-Bu | 6-Cl | H | i-Pr | F | CH |
| Me | 6-Me | H | C₂F₅ | F | CH | Me | 6-Cl | H | C₂F₅ | F | CH |
| Et | 6-Me | H | C₂F₅ | F | CH | Et | 6-Cl | H | C₂F₅ | F | CH |
| i-Pr | 6-Me | H | C₂F₅ | F | CH | i-Pr | 6-Cl | H | C₂F₅ | F | CH |
| t-Bu | 6-Me | H | C₂F₅ | F | CH | t-Bu | 6-Cl | H | C₂F₅ | F | CH |
| Me | 6-Me | H | n-C₃F₇ | F | CH | Me | 6-Cl | H | n-C₃F₇ | F | CH |
| Et | 6-Me | H | n-C₃F₇ | F | CH | Et | 6-Cl | H | n-C₃F₇ | F | CH |
| i-Pr | 6-Me | H | n-C₃F₇ | F | CH | i-Pr | 6-Cl | H | n-C₃F₇ | F | CH |
| t-Bu | 6-Me | H | n-C₃F₇ | F | CH | t-Bu | 6-Cl | H | n-C₃F₇ | F | CH |
| Me | 6-Me | H | i-C₃F₇ | F | CH | Me | 6-Cl | H | i-C₃F₇ | F | CH |
| Et | 6-Me | H | i-C₃F₇ | F | CH | Et | 6-Cl | H | i-C₃F₇ | F | CH |
| i-Pr | 6-Me | H | i-C₃F₇ | F | CH | i-Pr | 6-Cl | H | i-C₃F₇ | F | CH |
| t-Bu | 6-Me | H | i-C₃F₇ | F | CH | t-Bu | 6-Cl | H | i-C₃F₇ | F | CH |
| Me | 6-Me | H | Et | F | CH | Me | 6-Cl | H | Et | F | CH |
| Et | 6-Me | H | Et | F | CH | Et | 6-Cl | H | Et | F | CH |
| i-Pr | 6-Me | H | Et | F | CH | i-Pr | 6-Cl | H | Et | F | CH |
| t-Bu | 6-Me | H | Et | F | CH | t-Bu | 6-Cl | H | Et | F | CH |
| Me | 6-Me | H | CHF₂ | Cl | CH | Me | 6-Cl | H | CHF₂ | Cl | CH |
| Et | 6-Me | H | CHF₂ | Cl | CH | Et | 6-Cl | H | CHF₂ | Cl | CH |
| i-Pr | 6-Me | H | CHF₂ | Cl | CH | i-Pr | 6-Cl | H | CHF₂ | Cl | CH |
| t-Bu | 6-Me | H | CHF₂ | Cl | CH | t-Bu | 6-Cl | H | CHF₂ | Cl | CH |
| Me | 6-Me | H | n-Pr | Cl | CH | Me | 6-Cl | H | n-Pr | Cl | CH |
| Et | 6-Me | H | n-Pr | Cl | CH | Et | 6-Cl | H | n-Pr | Cl | CH |
| i-Pr | 6-Me | H | n-Pr | Cl | CH | i-Pr | 6-Cl | H | n-Pr | Cl | CH |
| t-Bu | 6-Me | H | n-Pr | Cl | CH | t-Bu | 6-Cl | H | n-Pr | Cl | CH |
| Me | 6-Me | H | CF₃ | Cl | CH | Me | 6-Cl | H | CF₃ | Cl | CH |
| Et | 6-Me | H | CF₃ | Cl | CH | Et | 6-Cl | H | CF₃ | Cl | CH |
| i-Pr | 6-Me | H | CF₃ | Cl | CH | i-Pr | 6-Cl | H | CF₃ | Cl | CH |
| t-Bu | 6-Me | H | CF₃ | Cl | CH | t-Bu | 6-Cl | H | CF₃ | Cl | CH |
| Me | 6-Me | H | i-Pr | Cl | CH | Me | 6-Cl | H | i-Pr | Cl | CH |
| Et | 6-Me | H | i-Pr | Cl | CH | Et | 6-Cl | H | i-Pr | Cl | CH |
| i-Pr | 6-Me | H | i-Pr | Cl | CH | i-Pr | 6-Cl | H | i-Pr | Cl | CH |
| t-Bu | 6-Me | H | i-Pr | Cl | CH | t-Bu | 6-Cl | H | i-Pr | Cl | CH |
| Me | 6-Me | H | C₂F₅ | Cl | CH | Me | 6-Cl | H | C₂F₅ | Cl | CH |
| Et | 6-Me | H | C₂F₅ | Cl | CH | Et | 6-Cl | H | C₂F₅ | Cl | CH |
| i-Pr | 6-Me | H | C₂F₅ | Cl | CH | i-Pr | 6-Cl | H | C₂F₅ | Cl | CH |
| t-Bu | 6-Me | H | C₂F₅ | Cl | CH | t-Bu | 6-Cl | H | C₂F₅ | Cl | CH |
| Me | 6-Me | H | n-C₃F₇ | Cl | CH | Me | 6-Cl | H | n-C₃F₇ | Cl | CH |
| Et | 6-Me | H | n-C₃F₇ | Cl | CH | Et | 6-Cl | H | n-C₃F₇ | Cl | CH |
| i-Pr | 6-Me | H | n-C₃F₇ | Cl | CH | i-Pr | 6-Cl | H | n-C₃F₇ | Cl | CH |
| t-Bu | 6-Me | H | n-C₃F₇ | Cl | CH | t-Bu | 6-Cl | H | n-C₃F₇ | Cl | CH |
| Me | 6-Me | H | i-C₃F₇ | Cl | CH | Me | 6-Cl | H | i-C₃F₇ | Cl | CH |
| Et | 6-Me | H | i-C₃F₇ | Cl | CH | Et | 6-Cl | H | i-C₃F₇ | Cl | CH |
| i-Pr | 6-Me | H | i-C₃F₇ | Cl | CH | i-Pr | 6-Cl | H | i-C₃F₇ | Cl | CH |
| t-Bu | 6-Me | H | i-C₃F₇ | Cl | CH | t-Bu | 6-Cl | H | i-C₃F₇ | Cl | CH |
| Me | 6-Me | H | Et | Cl | CH | Me | 6-Cl | H | Et | Cl | CH |
| Et | 6-Me | H | Et | Cl | CH | Et | 6-Cl | H | Et | Cl | CH |
| i-Pr | 6-Me | H | Et | Cl | CH | i-Pr | 6-Cl | H | Et | Cl | CH |
| t-Bu | 6-Me | H | Et | Cl | CH | t-Bu | 6-Cl | H | Et | Cl | CH |
| Me | 6-Me | H | CHF₂ | Br | CH | Me | 6-Cl | H | CHF₂ | Br | CH |
| Et | 6-Me | H | CHF₂ | Br | CH | Et | 6-Cl | H | CHF₂ | Br | CH |
| i-Pr | 6-Me | H | CHF₂ | Br | CH | i-Pr | 6-Cl | H | CHF₂ | Br | CH |
| t-Bu | 6-Me | H | CHF₂ | Br | CH | t-Bu | 6-Cl | H | CHF₂ | Br | CH |
| Me | 6-Me | H | n-Pr | Br | CH | Me | 6-Cl | H | n-Pr | Br | CH |
| Et | 6-Me | H | n-Pr | Br | CH | Et | 6-Cl | H | n-Pr | Br | CH |
| i-Pr | 6-Me | H | n-Pr | Br | CH | i-Pr | 6-Cl | H | n-Pr | Br | CH |
| t-Bu | 6-Me | H | n-Pr | Br | CH | t-Bu | 6-Cl | H | n-Pr | Br | CH |
| Me | 6-Me | H | CF₃ | Br | CH | Me | 6-Cl | H | CF₃ | Br | CH |
| Et | 6-Me | H | CF₃ | Br | CR | Et | 6-Cl | H | CF₃ | Br | CR |
| i-Pr | 6-Me | H | CF₃ | Br | CH | i-Pr | 6-Cl | H | CF₃ | Br | CR |
| t-Bu | 6-Me | H | CF₃ | Br | CH | t-Bu | 6-Cl | H | CF₃ | Br | CR |
| Me | 6-Me | H | i-Pr | Br | CH | Me | 6-Cl | H | i-Pr | Br | CH |
| Et | 6-Me | H | i-Pr | Br | CH | Et | 6-Cl | H | i-Pr | Br | CH |
| i-Pr | 6-Me | H | i-Pr | Br | CH | i-Pr | 6-Cl | H | i-Pr | Br | CH |
| t-Bu | 6-Me | H | i-Pr | Br | CH | t-Bu | 6-Cl | H | i-Pr | Br | CH |
| Me | 6-Me | H | C₂F₅ | Br | CH | Me | 6-Cl | H | C₂F₅ | Br | CH |
| Et | 6-Me | H | C₂F₅ | Br | CH | Et | 6-Cl | H | C₂F₅ | Br | CH |
| i-Pr | 6-Me | H | C₂F₅ | Br | CH | i-Pr | 6-Cl | H | C₂F₅ | Br | CH |
| t-Bu | 6-Me | H | C₂F₅ | Br | CH | t-Bu | 6-Cl | H | C₂F₅ | Br | CH |
| Me | 6-Me | H | n-C₃F₇ | Br | CH | Me | 6-Cl | H | n-C₃F₇ | Br | CH |
| Et | 6-Me | H | n-C₃F₇ | Br | CH | Et | 6-Cl | H | n-C₃F₇ | Br | CH |
| i-Pr | 6-Me | H | n-C₃F₇ | Br | CH | i-Pr | 6-Cl | H | n-C₃F₇ | Br | CH |
| t-Bu | 6-Me | H | n-C₃F₇ | Br | CH | t-Bu | 6-Cl | H | n-C₃F₇ | Br | CH |
| Me | 6-Me | H | i-C₃F₇ | Br | CH | Me | 6-Cl | H | i-C₃F₇ | Br | CH |
| Et | 6-Me | H | i-C₃F₇ | Br | CH | Et | 6-Cl | H | i-C₃F₇ | Br | CH |
| i-Pr | 6-Me | H | i-C₃F₇ | Br | CH | i-Pr | 6-Cl | H | i-C₃F₇ | Br | CH |
| t-Bu | 6-Me | H | i-C₃F₇ | Br | CH | t-Bu | 6-Cl | H | i-C₃F₇ | Br | CH |
| Me | 6-Me | H | Et | Br | CH | Me | 6-Cl | H | Et | Br | CH |
| Et | 6-Me | H | Et | Br | CH | Et | 6-Cl | H | Et | Br | CH |
| i-Pr | 6-Me | H | Et | Br | CH | i-Pr | 6-Cl | H | Et | Br | CH |
| t-Bu | 6-Me | H | Et | Br | CH | t-Bu | 6-Cl | H | Et | Br | CH |
| Me | 6-Me | H | CHF₂ | CF₃ | CH | Me | 6-Cl | H | CHF₂ | CF₃ | CH |
| Et | 6-Me | H | CHF₂ | CF₃ | CH | Et | 6-Cl | H | CHF₂ | CF₃ | CH |
| i-Pr | 6-Me | H | CHF₂ | CF₃ | CH | i-Pr | 6-Cl | H | CHF₂ | CF₃ | CH |
| t-Bu | 6-Me | H | CHF₂ | CF₃ | CH | t-Bu | 6-Cl | H | CHF₂ | CF₃ | CH |
| Me | 6-Me | H | n-Pr | CF₃ | CH | Me | 6-Cl | H | n-Pr | CF₃ | CH |
| Et | 6-Me | H | n-Pr | CF₃ | CH | Et | 6-Cl | H | n-Pr | CF₃ | CH |
| i-Pr | 6-Me | H | n-Pr | CF₃ | CH | i-Pr | 6-Cl | H | n-Pr | CF₃ | CH |
| t-Bu | 6-Me | H | n-Pr | CF₃ | CH | t-Bu | 6-Cl | H | n-Pr | CF₃ | CH |
| Me | 6-Me | H | CF₃ | CF₃ | CH | Me | 6-Cl | H | CF₃ | CF₃ | CH |
| Et | 6-Me | H | CF₃ | CF₃ | CH | Et | 6-Cl | H | CF₃ | CF₃ | CH |
| i-Pr | 6-Me | H | CF₃ | CF₃ | CH | i-Pr | 6-Cl | H | CF₃ | CF₃ | CH |
| t-Bu | 6-Me | H | CF₃ | CF₃ | CH | t-Bu | 6-Cl | H | CF₃ | CF₃ | CH |
| Me | 6-Me | H | i-Pr | CF₃ | CH | Me | 6-Cl | H | i-Pr | CF₃ | CH |
| Et | 6-Me | H | i-Pr | CF₃ | CH | Et | 6-Cl | H | i-Pr | CF₃ | CH |
| i-Pr | 6-Me | H | i-Pr | CF₃ | CH | i-Pr | 6-Cl | H | i-Pr | CF₃ | CH |
| t-Bu | 6-Me | H | i-Pr | CF₃ | CH | t-Bu | 6-Cl | H | i-Pr | CF₃ | CH |
| Me | 6-Me | H | C₂F₅ | CF₃ | CH | Me | 6-Cl | H | C₂F₅ | CF₃ | CH |
| Et | 6-Me | H | C₂F₅ | CF₃ | CH | Et | 6-Cl | H | C₂F₅ | CF₃ | CH |
| i-Pr | 6-Me | H | C₂F₅ | CF₃ | CH | i-Pr | 6-Cl | H | C₂F₅ | CF₃ | CH |
| t-Bu | 6-Me | H | C₂F₅ | CF₃ | CH | t-Bu | 6-Cl | H | C₂F₅ | CF₃ | CH |
| Me | 6-Me | H | n-C₃F₇ | CF₃ | CH | Me | 6-Cl | H | n-C₃F₇ | CF₃ | CH |
| Et | 6-Me | H | n-C₃F₇ | CF₃ | CH | Et | 6-Cl | H | n-C₃F₇ | CF₃ | CH |
| i-Pr | 6-Me | H | n-C₃F₇ | CF₃ | CH | i-Pr | 6-Cl | H | n-C₃F₇ | CF₃ | CH |
| t-Bu | 6-Me | H | n-C₃F₇ | CF₃ | CH | t-Bu | 6-Cl | H | n-C₃F₇ | CF₃ | CH |
| Me | 6-Me | H | i-C₃F₇ | CF₃ | CH | Me | 6-Cl | H | i-C₃F₇ | CF₃ | CH |
| Et | 6-Me | H | i-C₃F₇ | CF₃ | CH | Et | 6-Cl | H | i-C₃F₇ | CF₃ | CH |
| i-Pr | 6-Me | H | i-C₃F₇ | CF₃ | CH | i-Pr | 6-Cl | H | i-C₃F₇ | CF₃ | CH |
| t-Bu | 6-Me | H | i-C₃F₇ | CF₃ | CH | t-Bu | 6-Cl | H | i-C₃F₇ | CF₃ | CH |
| Me | 6-Me | H | Et | CF₃ | CH | Me | 6-Cl | H | Et | CF₃ | CH |
| Et | 6-Me | H | Et | CF₃ | CH | Et | 6-Cl | H | Et | CF₃ | CH |
| i-Pr | 6-Me | H | Et | CF₃ | CH | i-Pr | 6-Cl | H | Et | CF₃ | CH |
| t-Bu | 6-Me | H | Et | CF₃ | CH | t-Bu | 6-Cl | H | Et | CF₃ | CH |
| Me | 6-Me | Cl | CHF₂ | F | CH | Me | 6-Cl | Cl | CHF₂ | F | CH |
| Et | 6-Me | Cl | CHF₂ | F | CH | Et | 6-Cl | Cl | CHF₂ | F | CH |
| i-Pr | 6-Me | Cl | CHF₂ | F | CH | i-Pr | 6-Cl | Cl | CHF₂ | F | CH |
| t-Bu | 6-Me | Cl | CHF₂ | F | CH | t-Bu | 6-Cl | Cl | CHF₂ | F | CH |
| Me | 6-Me | Cl | n-Pr | F | CH | Me | 6-Cl | Cl | n-Pr | F | CH |
| Et | 6-Me | Cl | n-Pr | F | CH | Et | 6-Cl | Cl | n-Pr | F | CH |
| i-Pr | 6-Me | Cl | n-Pr | F | CH | i-Pr | 6-Cl | Cl | n-Pr | F | CH |
| t-Bu | 6-Me | Cl | n-Pr | F | CH | t-Bu | 6-Cl | Cl | n-Pr | F | CH |
| Me | 6-Me | Cl | CF₃ | F | CH | Me | 6-Cl | Cl | CF₃ | F | CH |
| Et | 6-Me | Cl | CF₃ | F | CH | Et | 6-Cl | Cl | CF₃ | F | CH |
| i-Pr | 6-Me | Cl | CF₃ | F | CH | i-Pr | 6-Cl | Cl | CF₃ | F | CH |
| t-Bu | 6-Me | Cl | CF₃ | F | CH | t-Bu | 6-Cl | Cl | CF₃ | F | CH |
| Me | 6-Me | Cl | i-Pr | F | CH | Me | 6-Cl | Cl | i-Pr | F | CH |
| Et | 6-Me | Cl | i-Pr | F | CH | Et | 6-Cl | Cl | i-Pr | F | CH |
| i-Pr | 6-Me | Cl | i-Pr | F | CH | i-Pr | 6-Cl | Cl | i-Pr | F | CH |
| t-Bu | 6-Me | Cl | i-Pr | F | CH | t-Bu | 6-Cl | Cl | i-Pr | F | CH |
| Me | 6-Me | Cl | C₂F₅ | F | CH | Me | 6-Cl | Cl | C₂F₅ | F | CH |
| Et | 6-Me | Cl | C₂F₅ | F | CH | Et | 6-Cl | Cl | C₂F₅ | F | CH |
| i-Pr | 6-Me | Cl | C₂F₅ | F | CH | i-Pr | 6-Cl | Cl | C₂F₅ | F | CH |
| t-Bu | 6-Me | Cl | C₂F₅ | F | CH | t-Bu | 6-Cl | Cl | C₂F₅ | F | CH |
| Me | 6-Me | Cl | n-C₃F₇ | F | CH | Me | 6-Cl | Cl | n-C₃F₇ | F | CH |
| Et | 6-Me | Cl | n-C₃F₇ | F | CH | Et | 6-Cl | Cl | n-C₃F₇ | F | CH |
| i-Pr | 6-Me | Cl | n-C₃F₇ | F | CH | i-Pr | 6-Cl | Cl | n-C₃F₇ | F | CH |
| t-Bu | 6-Me | Cl | n-C₃F₇ | F | CH | t-Bu | 6-Cl | Cl | n-C₃F₇ | F | CH |
| Me | 6-Me | Cl | i-C₃F₇ | F | CH | Me | 6-Cl | Cl | i-C₃F₇ | F | CH |
| Et | 6-Me | Cl | i-C₃F₇ | F | CH | Et | 6-Cl | Cl | i-C₃F₇ | F | CH |
| i-Pr | 6-Me | Cl | i-C₃F₇ | F | CH | i-Pr | 6-Cl | Cl | i-C₃F₇ | F | CH |
| t-Bu | 6-Me | Cl | i-C₃F₇ | F | CH | t-Bu | 6-Cl | Cl | i-C₃F₇ | F | CH |
| Me | 6-Me | Cl | Et | F | CH | Me | 6-Cl | Cl | Et | F | CH |
| Et | 6-Me | Cl | Et | F | CH | Et | 6-Cl | Cl | Et | F | CH |
| i-Pr | 6-Me | Cl | Et | F | CH | i-Pr | 6-Cl | Cl | Et | F | CH |
| t-Bu | 6-Me | Cl | Et | F | CH | t-Bu | 6-Cl | Cl | Et | F | CH |
| Me | 6-Me | Cl | CHF₂ | Cl | CH | Me | 6-Cl | Cl | CHF₂ | Cl | CH |
| Et | 6-Me | Cl | CHF₂ | Cl | CH | Et | 6-Cl | Cl | CHF₂ | Cl | CH |
| i-Pr | 6-Me | Cl | CHF₂ | Cl | CH | i-Pr | 6-Cl | Cl | CHF₂ | Cl | CH |
| t-Bu | 6-Me | Cl | CHF₂ | Cl | CH | t-Bu | 6-Cl | Cl | CHF₂ | Cl | CH |
| Me | 6-Me | Cl | n-Pr | Cl | CH | Me | 6-Cl | Cl | n-Pr | Cl | CH |
| Et | 6-Me | Cl | n-Pr | Cl | CH | Et | 6-Cl | Cl | n-Pr | Cl | CH |
| i-Pr | 6-Me | Cl | n-Pr | Cl | CH | i-Pr | 6-Cl | Cl | n-Pr | Cl | CH |
| t-Bu | 6-Me | Cl | n-Pr | Cl | CH | t-Bu | 6-Cl | Cl | n-Pr | Cl | CH |
| Me | 6-Me | Cl | CF₃ | Cl | CH | Me | 6-Cl | Cl | CF₃ | Cl | CH |
| Et | 6-Me | Cl | CF₃ | Cl | CH | Et | 6-Cl | Cl | CF₃ | Cl | CH |
| i-Pr | 6-Me | Cl | CF₃ | Cl | CH | i-Pr | 6-Cl | Cl | CF₃ | Cl | CH |
| t-Bu | 6-Me | Cl | CF₃ | Cl | CH | t-Bu | 6-Cl | Cl | CF₃ | Cl | CH |
| Me | 6-Me | Cl | i-Pr | Cl | CH | Me | 6-Cl | Cl | i-Pr | Cl | CH |
| Et | 6-Me | Cl | i-Pr | Cl | CH | Et | 6-Cl | Cl | i-Pr | Cl | CH |
| i-Pr | 6-Me | Cl | i-Pr | Cl | CH | i-Pr | 6-Cl | Cl | i-Pr | Cl | CH |
| t-Bu | 6-Me | Cl | i-Pr | Cl | CH | t-Bu | 6-Cl | Cl | i-Pr | Cl | CH |
| Me | 6-Me | Cl | C₂F₅ | Cl | CH | Me | 6-Cl | Cl | C₂F₅ | Cl | CH |
| Et | 6-Me | Cl | C₂F₅ | Cl | CH | Et | 6-Cl | Cl | C₂F₅ | Cl | CH |
| i-Pr | 6-Me | Cl | C₂F₅ | Cl | CH | i-Pr | 6-Cl | Cl | C₂F₅ | Cl | CH |
| t-Bu | 6-Me | Cl | C₂F₅ | Cl | CH | t-Bu | 6-Cl | Cl | C₂F₅ | Cl | CH |
| Me | 6-Me | Cl | n-C₃F₇ | Cl | CH | Me | 6-Cl | Cl | n-C₃F₇ | Cl | CH |
| Et | 6-Me | Cl | n-C₃F₇ | Cl | CH | Et | 6-Cl | Cl | n-C₃F₇ | Cl | CH |
| i-Pr | 6-Me | Cl | n-C₃F₇ | Cl | CH | i-Pr | 6-Cl | Cl | n-C₃F₇ | Cl | CH |
| t-Bu | 6-Me | Cl | n-C₃F₇ | Cl | CH | t-Bu | 6-Cl | Cl | n-C₃F₇ | Cl | CH |
| Me | 6-Me | Cl | i-C₃F₇ | Cl | CH | Me | 6-Cl | Cl | i-C₃F₇ | Cl | CH |
| Et | 6-Me | Cl | i-C₃F₇ | Cl | CH | Et | 6-Cl | Cl | i-C₃F₇ | Cl | CH |
| i-Pr | 6-Me | Cl | i-C₃F₇ | Cl | CH | i-Pr | 6-Cl | Cl | i-C₃F₇ | Cl | CH |
| t-Bu | 6-Me | Cl | i-C₃F₇ | Cl | CH | t-Bu | 6-Cl | Cl | i-C₃F₇ | Cl | CH |
| Me | 6-Me | Cl | Et | Cl | CH | Me | 6-Cl | Cl | Et | Cl | CH |
| Et | 6-Me | Cl | Et | Cl | CH | Et | 6-Cl | Cl | Et | Cl | CH |
| i-Pr | 6-Me | Cl | Et | Cl | CH | i-Pr | 6-Cl | Cl | Et | Cl | CH |
| t-Bu | 6-Me | Cl | Et | Cl | CH | t-Bu | 6-Cl | Cl | Et | Cl | CH |
| Me | 6-Me | Cl | CHF₂ | Br | CH | Me | 6-Cl | Cl | CHF₂ | Br | CH |
| Et | 6-Me | Cl | CHF₂ | Br | CH | Et | 6-Cl | Cl | CHF₂ | Br | CH |
| i-Pr | 6-Me | Cl | CHF₂ | Br | CH | i-Pr | 6-Cl | Cl | CHF₂ | Br | CH |
| t-Bu | 6-Me | Cl | CHF₂ | Br | CH | t-Bu | 6-Cl | Cl | CHF₂ | Br | CH |
| Me | 6-Me | Cl | n-Pr | Br | CH | Me | 6-Cl | Cl | n-Pr | Br | CH |
| Et | 6-Me | Cl | n-Pr | Br | CH | Et | 6-Cl | Cl | n-Fr | Br | CH |
| i-Pr | 6-Me | Cl | n-Pr | Br | CH | i-Pr | 6-Cl | Cl | n-Pr | Br | CH |
| t-Bu | 6-Me | Cl | n-Pr | Br | CH | t-Bu | 6-Cl | Cl | n-Pr | Br | CH |
| Me | 6-Me | Cl | CF₃ | Br | CH | Me | 6-Cl | Cl | CF₃ | Br | CH |
| Et | 6-Me | Cl | CF₃ | Br | CH | Et | 6-Cl | Cl | CF₃ | Br | CH |
| i-Pr | 6-Me | Cl | CF₃ | Br | CH | i-Pr | 6-Cl | Cl | CF₃ | Br | CH |
| t-Bu | 6-Me | Cl | CF₃ | Br | CH | t-Bu | 6-Cl | Cl | CF₃ | Br | CH |
| Me | 6-Me | Cl | i-Pr | Br | CH | Me | 6-Cl | Cl | i-Pr | Br | CH |
| Et | 6-Me | Cl | i-Pr | Br | CH | Et | 6-Cl | Cl | i-Pr | Br | CH |
| i-Pr | 6-Me | Cl | i-Pr | Br | CH | i-Pr | 6-Cl | Cl | i-Pr | Br | CH |
| t-Bu | 6-Me | Cl | i-Pr | Br | CH | t-Bu | 6-Cl | Cl | i-Pr | Br | CH |
| Me | 6-Me | Cl | C₂F₅ | Br | CH | Me | 6-Cl | Cl | C₂F₅ | Br | CH |
| Et | 6-Me | Cl | C₂F₅ | Br | CH | Et | 6-Cl | Cl | C₂F₅ | Br | CH |
| i-Pr | 6-Me | Cl | C₂F₅ | Br | CH | i-Pr | 6-Cl | Cl | C₂F₅ | Br | CH |
| t-Bu | 6-Me | Cl | C₂F₅ | Br | CH | t-Bu | 6-Cl | Cl | C₂F₅ | Br | CH |
| Me | 6-Me | Cl | n-C₃F₇ | Br | CH | Me | 6-Cl | Cl | n-C₃F₇ | Br | CH |
| Et | 6-Me | Cl | n-C₃F₇ | Br | CH | Et | 6-Cl | Cl | n-C₃F₇ | Br | CH |
| i-Pr | 6-Me | Cl | n-C₃F₇ | Br | CH | i-Pr | 6-Cl | Cl | n-C₃F₇ | Br | CH |
| t-Bu | 6-Me | Cl | n-C₃F₇ | Br | CH | t-Bu | 6-Cl | Cl | n-C₃F₇ | Br | CH |
| Me | 6-Me | Cl | i-C₃F₇ | Br | CH | Me | 6-Cl | Cl | i-C₃F₇ | Br | CH |
| Et | 6-Me | Cl | i-C₃F₇ | Br | CH | Et | 6-Cl | Cl | i-C₃F₇ | Br | CH |
| i-Pr | 6-Me | Cl | i-C₃F₇ | Br | CH | i-Pr | 6-Cl | Cl | i-C₃F₇ | Br | CH |
| t-Bu | 6-Me | Cl | i-C₃F₇ | Br | CH | t-Bu | 6-Cl | Cl | i-C₃F₇ | Br | CH |
| Me | 6-Me | Cl | Et | Br | CH | Me | 6-Cl | Cl | Et | Br | CH |
| Et | 6-Me | Cl | Et | Br | CH | Et | 6-Cl | Cl | Et | Br | CH |
| i-Pr | 6-Me | Cl | Et | Br | CH | i-Pr | 6-Cl | Cl | Et | Br | CH |
| t-Bu | 6-Me | Cl | Et | Br | CH | t-Bu | 6-Cl | Cl | Et | Br | CH |
| Me | 6-Me | Cl | CHF₂ | CF₃ | CH | Me | 6-Cl | Cl | CHF₂ | CF₃ | CH |
| Et | 6-Me | Cl | CHF₂ | CF₃ | CH | Et | 6-Cl | Cl | CHF₂ | CF₃ | CH |
| i-Pr | 6-Me | Cl | CHF₂ | CF₃ | CH | i-Pr | 6-Cl | Cl | CHF₂ | CF₃ | CH |
| t-Bu | 6-Me | Cl | CHF₂ | CF₃ | CH | t-Bu | 6-Cl | Cl | CHF₂ | CF₃ | CH |
| Me | 6-Me | Cl | n-Pr | CF₃ | CH | Me | 6-Cl | Cl | n-Pr | CF₃ | CH |
| Et | 6-Me | Cl | n-Pr | CF₃ | CH | Et | 6-Cl | Cl | n-Pr | CF₃ | CH |
| i-Pr | 6-Me | Cl | n-Pr | CF₃ | CH | i-Pr | 6-Cl | Cl | n-Pr | CF₃ | CH |
| t-Bu | 6-Me | Cl | n-Pr | CF₃ | CH | t-Bu | 6-Cl | Cl | n-Pr | CF₃ | CH |
| Me | 6-Me | Cl | CF₃ | CF₃ | CH | Me | 6-Cl | Cl | CF₃ | CF₃ | CH |
| Et | 6-Me | Cl | CF₃ | CF₃ | CH | Et | 6-Cl | Cl | CF₃ | CF₃ | CH |
| i-Pr | 6-Me | Cl | CF₃ | CF₃ | CH | i-Pr | 6-Cl | Cl | CF₃ | CF₃ | CH |
| t-Bu | 6-Me | Cl | CF₃ | CF₃ | CH | t-Bu | 6-Cl | Cl | CF₃ | CF₃ | CH |
| Me | 6-Me | Cl | i-Pr | CF₃ | CH | Me | 6-Cl | Cl | i-Pr | CF₃ | CH |
| Et | 6-Me | Cl | i-Pr | CF₃ | CH | Et | 6-Cl | Cl | i-Pr | CF₃ | CH |
| i-Pr | 6-Me | Cl | i-Pr | CF₃ | CH | i-Pr | 6-Cl | Cl | i-Pr | CF₃ | CH |
| t-Bu | 6-Me | Cl | i-Pr | CF₃ | CH | t-Bu | 6-Cl | Cl | i-Pr | CF₃ | CH |
| Me | 6-Me | Cl | C₂F₅ | CF₃ | CH | Me | 6-Cl | Cl | C₂F₅ | CF₃ | CH |
| Et | 6-Me | Cl | C₂F₅ | CF₃ | CH | Et | 6-Cl | Cl | C₂F₅ | CF₃ | CH |
| i-Pr | 6-Me | Cl | C₂F₅ | CF₃ | CH | i-Pr | 6-Cl | Cl | C₂F₅ | CF₃ | CH |
| t-Bu | 6-Me | Cl | C₂F₅ | CF₃ | CH | t-Bu | 6-Cl | Cl | C₂F₅ | CF₃ | CH |
| Me | 6-Me | Cl | n-C₃F₇ | CF₃ | CH | Me | 6-Cl | Cl | n-C₃F₇ | CF₃ | CH |
| Et | 6-Me | Cl | n-C₃F₇ | CF₃ | CH | Et | 6-Cl | Cl | n-C₃F₇ | CF₃ | CH |
| i-Pr | 6-Me | Cl | n-C₃F₇ | CF₃ | CH | i-Pr | 6-Cl | Cl | n-C₃F₇ | CF₃ | CH |
| t-Bu | 6-Me | Cl | n-C₃F₇ | CF₃ | CH | t-Bu | 6-Cl | Cl | n-C₃F₇ | CF₃ | CH |
| Me | 6-Me | Cl | i-C₃F₇ | CF₃ | CH | Me | 6-Cl | Cl | i-C₃F₇ | CF₃ | CH |
| Et | 6-Me | Cl | i-C₃F₇ | CF₃ | CH | Et | 6-Cl | Cl | i-C₃F₇ | CF₃ | CH |
| i-Pr | 6-Me | Cl | i-C₃F₇ | CF₃ | CH | i-Pr | 6-Cl | Cl | i-C₃F₇ | CF₃ | CH |
| t-Bu | 6-Me | Cl | i-C₃F₇ | CF₃ | CH | t-Bu | 6-Cl | Cl | i-C₃F₇ | CF₃ | CH |
| Me | 6-Me | Cl | Et | CF₃ | CH | Me | 6-Cl | Cl | Et | CF₃ | CH |
| Et | 6-Me | Cl | Et | CF₃ | CH | Et | 6-Cl | Cl | Et | CF₃ | CH |
| i-Pr | 6-Me | Cl | Et | CF₃ | CH | i-Pr | 6-Cl | Cl | Et | CF₃ | CH |
| t-Bu | 6-Me | Cl | Et | CF₃ | CH | t-Bu | 6-Cl | Cl | Et | CF₃ | CH |
| Me | 6-Me | H | CHF₂ | F | CF | Me | 6-Cl | H | CHF₂ | F | CF |
| Et | 6-Me | H | CHF₂ | F | CF | Et | 6-Cl | H | CHF₂ | F | CF |
| i-Pr | 6-Me | H | CHF₂ | F | CF | i-Pr | 6-Cl | H | CHF₂ | F | CF |
| t-Bu | 6-Me | H | CHF₂ | F | CF | t-Bu | 6-Cl | H | CHF₂ | F | CF |
| Me | 6-Me | H | n-Pr | F | CF | Me | 6-Cl | H | n-Pr | F | CF |
| Et | 6-Me | H | n-Pr | F | CF | Et | 6-Cl | H | n-Pr | F | CF |
| i-Pr | 6-Me | H | n-Pr | F | CF | i-Pr | 6-Cl | H | n-Pr | F | CF |
| t-Bu | 6-Me | H | n-Pr | F | CF | t-Bu | 6-Cl | H | n-Pr | F | CF |
| Me | 6-Me | H | CF₃ | F | CF | Me | 6-Cl | H | CF₃ | F | CF |
| Et | 6-Me | H | CF₃ | F | CF | Et | 6-Cl | H | CF₃ | F | CF |
| i-Pr | 6-Me | H | CF₃ | F | CF | i-Pr | 6-Cl | H | CF₃ | F | CF |
| t-Bu | 6-Me | H | CF₃ | F | CF | t-Bu | 6-Cl | H | CF₃ | F | CF |
| Me | 6-Me | H | i-Pr | F | CF | Me | 6-Cl | H | i-Pr | F | CF |
| Et | 6-Me | H | i-Pr | F | CF | Et | 6-Cl | H | i-Pr | F | CF |
| i-Pr | 6-Me | H | i-Pr | F | CF | i-Pr | 6-Cl | H | i-Pr | F | CF |
| t-Bu | 6-Me | H | i-Pr | F | CF | t-Bu | 6-Cl | H | i-Pr | F | CF |
| Me | 6-Me | H | C₂F₅ | F | CF | Me | 6-Cl | H | C₂F₅ | F | CF |
| Et | 6-Me | H | C₂F₅ | F | CF | Et | 6-Cl | H | C₂F₅ | F | CF |
| i-Pr | 6-Me | H | C₂F₅ | F | CF | i-Pr | 6-Cl | H | C₂F₅ | F | CF |
| t-Bu | 6-Me | H | C₂F₅ | F | CF | t-Bu | 6-Cl | H | C₂F₅ | F | CF |
| Me | 6-Me | H | n-C₃F₇ | F | CF | Me | 6-Cl | H | n-C₃F₇ | F | CF |
| Et | 6-Me | H | n-C₃F₇ | F | CF | Et | 6-Cl | H | n-C₃F₇ | F | CF |
| i-Pr | 6-Me | H | n-C₃F₇ | F | CF | i-Pr | 6-Cl | H | n-C₃F₇ | F | CF |
| t-Bu | 6-Me | H | n-C₃F₇ | F | CF | t-Bu | 6-Cl | H | n-C₃F₇ | F | CF |
| Me | 6-Me | H | i-C₃F₇ | F | CF | Me | 6-Cl | H | i-C₃F₇ | F | CF |
| Et | 6-Me | H | i-C₃F₇ | F | CF | Et | 6-Cl | H | i-C₃F₇ | F | CF |
| i-Pr | 6-Me | H | i-C₃F₇ | F | CF | i-Pr | 6-Cl | H | i-C₃F₇ | F | CF |
| t-Bu | 6-Me | H | i-C₃F₇ | F | CF | t-Bu | 6-Cl | H | i-C₃F₇ | F | CF |
| Me | 6-Me | H | Et | F | CF | Me | 6-Cl | H | Et | F | CF |
| Et | 6-Me | H | Et | F | CF | Et | 6-Cl | H | Et | F | CF |
| i-Pr | 6-Me | H | Et | F | CF | i-Pr | 6-Cl | H | Et | F | CF |
| t-Bu | 6-Me | H | Et | F | CF | t-Bu | 6-Cl | H | Et | F | CF |
| Me | 6-Me | H | CHF₂ | Cl | CCl | Me | 6-Cl | H | CHF₂ | Cl | CCl |
| Et | 6-Me | H | CHF₂ | Cl | CCl | Et | 6-Cl | H | CHF₂ | Cl | CCl |
| i-Pr | 6-Me | H | CHF₂ | Cl | CCl | i-Pr | 6-Cl | H | CHF₂ | Cl | CCl |
| t-Bu | 6-Me | H | CHF₂ | Cl | CCl | t-Bu | 6-Cl | H | CHF₂ | Cl | CCl |
| Me | 6-Me | H | n-Pr | Cl | CCl | Me | 6-Cl | H | n-Pr | Cl | CCl |
| Et | 6-Me | H | n-Pr | Cl | CCl | Et | 6-Cl | H | n-Pr | Cl | CCl |
| i-Pr | 6-Me | H | n-Pr | Cl | CCl | i-Pr | 6-Cl | H | n-Pr | Cl | CCl |
| t-Bu | 6-Me | H | n-Pr | Cl | CCl | t-Bu | 6-Cl | H | n-Pr | Cl | CCl |
| Me | 6-Me | H | CF₃ | Cl | CCl | Me | 6-Cl | H | CF₃ | Cl | CCl |
| Et | 6-Me | H | CF₃ | Cl | CCl | Et | 6-Cl | H | CF₃ | Cl | CCl |
| i-Pr | 6-Me | H | CF₃ | Cl | CCl | i-Pr | 6-Cl | H | CF₃ | Cl | CCl |
| t-Bu | 6-Me | H | CF₃ | Cl | CCl | t-Bu | 6-Cl | H | CF₃ | Cl | CCl |
| Me | 6-Me | H | i-Pr | Cl | CCl | Me | 6-Cl | H | i-Pr | Cl | CCl |
| Et | 6-Me | H | i-Pr | Cl | CCl | Et | 6-Cl | H | i-Pr | Cl | CCl |
| i-Pr | 6-Me | H | i-Pr | Cl | CCl | i-Pr | 6-Cl | H | i-Pr | Cl | CCl |
| t-Bu | 6-Me | H | i-Pr | Cl | CCl | t-Bu | 6-Cl | H | i-Pr | Cl | CCl |
| Me | 6-Me | H | C₂F₅ | Cl | CCl | Me | 6-Cl | H | C₂F₅ | Cl | CCl |
| Et | 6-Me | H | C₂F₅ | Cl | CCl | Et | 6-Cl | H | C₂F₅ | Cl | CCl |
| i-Pr | 6-Me | H | C₂F₅ | Cl | CCl | i-Pr | 6-Cl | H | C₂F₅ | Cl | CCl |
| t-Bu | 6-Me | H | C₂F₅ | Cl | CCl | t-Bu | 6-Cl | H | C₂F₅ | Cl | CCl |
| Me | 6-Me | H | n-C₃F₇ | Cl | CCl | Me | 6-Cl | H | n-C₃F₇ | Cl | CCl |
| Et | 6-Me | H | n-C₃F₇ | Cl | CCl | Et | 6-Cl | H | n-C₃F₇ | Cl | CCl |
| i-Pr | 6-Me | H | n-C₃F₇ | Cl | CCl | i-Pr | 6-Cl | H | n-C₃F₇ | Cl | CCl |
| t-Bu | 6-Me | H | n-C₃F₇ | Cl | CCl | t-Bu | 6-Cl | H | n-C₃F₇ | Cl | CCl |
| Me | 6-Me | H | i-C₃F₇ | Cl | CCl | Me | 6-Cl | H | i-C₃F₇ | Cl | CCl |
| Et | 6-Me | H | i-C₃F₇ | Cl | CCl | Et | 6-Cl | H | i-C₃F₇ | Cl | CCl |
| i-Pr | 6-Me | H | i-C₃F₇ | Cl | CCl | i-Pr | 6-Cl | H | i-C₃F₇ | Cl | CCl |
| t-Bu | 6-Me | H | i-C₃F₇ | Cl | CCl | t-Bu | 6-Cl | H | i-C₃F₇ | Cl | CCl |
| Me | 6-Me | H | Et | Cl | CCl | Me | 6-Cl | H | Et | Cl | CCl |
| Et | 6-Me | H | Et | Cl | CCl | Et | 6-Cl | H | Et | Cl | CCl |
| i-Pr | 6-Me | H | Et | Cl | CCl | i-Pr | 6-Cl | H | Et | Cl | CCl |
| t-Bu | 6-Me | H | Et | Cl | CCl | t-Bu | 6-Cl | H | Et | Cl | CCl |

TABLE 18

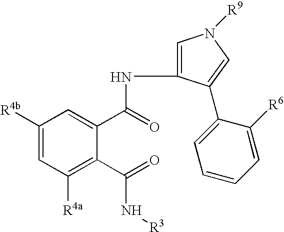

| R⁹ is CHF₂ | | | | R⁹ is CH₂CF₃ | | | | R⁹ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | H | Cl |
| Et | CH₃ | H | Cl | Et | CH₃ | H | Cl | Et | CH₃ | H | Cl |
| i-Pr | CH₃ | H | Cl | i-Pr | CH₃ | H | Cl | i-Pr | CH₃ | H | Cl |
| t-Bu | CH₃ | H | Cl | t-Bu | CH₃ | H | Cl | t-Bu | CH₃ | H | Cl |
| Me | CH₃ | H | Br | Me | CH₃ | H | Br | Me | CH₃ | H | Br |
| Et | CH₃ | H | Br | Et | CH₃ | H | Br | Et | CH₃ | H | Br |
| i-Pr | CH₃ | H | Br | i-Pr | CH₃ | H | Br | i-Pr | CH₃ | H | Br |
| t-Bu | CH₃ | H | Br | t-Bu | CH₃ | H | Br | t-Bu | CH₃ | H | Br |
| Me | CH₃ | F | Cl | Me | CH₃ | F | Cl | Me | CH₃ | F | Cl |
| Et | CH₃ | F | Cl | Et | CH₃ | F | Cl | Et | CH₃ | F | Cl |
| i-Pr | CH₃ | F | Cl | i-Pr | CH₃ | F | Cl | i-Pr | CH₃ | F | Cl |
| t-Bu | CH₃ | F | Cl | t-Bu | CH₃ | F | Cl | t-Bu | CH₃ | F | Cl |
| Me | CH₃ | F | Br | Me | CH₃F | Br | Me | CH₃F | Br | | |
| Et | CH₃ | F | Br | Et | CH₃F | Br | Et | CH₃F | Br | | |
| i-Pr | CH₃ | F | Br | i-Pr | CH₃ | F | Br | i-Pr | CH₃ | F | Br |
| t-Bu | CH₃ | F | Br | t-Bu | CH₃ | F | Br | t-Bu | CH₃ | F | Br |
| Me | CH₃ | Cl | Cl | Me | CH₃Cl | Cl | Me | CH₃Cl | Cl | | |
| Et | CH₃ | Cl | Cl | Et | CH₃Cl | Cl | Et | CH₃Cl | Cl | | |
| i-Pr | CH₃ | Cl | Cl | i-Pr | CH₃ | Cl | Cl | i-Pr | CH₃ | Cl | Cl |
| t-Bu | CH₃ | Cl | Cl | t-Bu | CH₃ | Cl | Cl | t-Bu | CH₃ | Cl | Cl |
| Me | CH₃ | Cl | Br | Me | CH₃ | Cl | Br | Me | CH₃ | Cl | Br |
| Et | CH₃ | Cl | Br | Et | CH₃ | Cl | Br | Et | CH₃ | Cl | Br |
| i-Pr | CH₃ | Cl | Br | i-Pr | CH₃ | Cl | Br | i-Pr | CH₃ | Cl | Br |
| t-Bu | CH₃ | Cl | Br | t-Bu | CH₃ | Cl | Br | 1-Bu | CH₃ | Cl | Br |
| Me | CH₃ | Br | Cl | Me | CH₃Br | Cl | Me | CH₃ | Br | Cl | |
| Et | CH₃ | Br | Cl | Et | CH₃Br | Cl | Et | CH₃ | Br | Cl | |
| i-Pr | CH₃ | Br | Cl | i-Pr | CH₃ | Br | Cl | i-Pr | CH₃ | Br | Cl |
| t-Bu | CH₃ | Br | Cl | t-Bu | CH₃ | Br | Cl | t-Bu | CH₃ | Br | Cl |
| Me | CH₃ | Br | Br | Me | CH₃ | Br | Br | Me | CH₃ | Br | Br |
| Et | CH₃ | Br | Br | Et | CH₃ | Br | Br | Et | CH₃ | Br | Br |
| i-Pr | CH₃ | Br | Br | i-Pr | CH₃ | Br | Br | i-Pr | CH₃ | Br | Br |
| t-Bu | CH₃ | Br | Br | t-Bu | CH₃ | Br | Br | t-Bu | CH₃ | Br | Br |
| Me | CH₃ | I | Cl | Me | CH₃ | I | Cl | Me CH₃ | I | Cl | |
| Et | CH₃ | I | Cl | Et | CH₃ | I | Cl | Et CH₃ | I | Cl | |
| i-Pr | CH₃ | I | Cl | i-Pr | CH₃ | I | Cl | i-Pr | CH₃ | I | Cl |
| t-Bu | CH₃ | I | Cl | t-Bu | CH₃ | I | Cl | t-Bu | CH₃ | I | Cl |
| Me | CH₃ | I | Br | Me | CH₃ | I | Br | Me | CH₃ | I | Br |
| Et | CH₃ | I | Br | Et | CH₃ | I | Br | Et | CH₃ | I | Br |
| i-Pr | CH₃ | I | Br | i-Pr | CH₃ | I | Br | i-Pr | CH₃ | I | Br |
| t-Bu | CH₃ | I | Br | t-Bu | CH₃ | I | Br | t-Bu | CH₃ | I | Br |
| Me | CH₃ | CF₃ | Cl | Me | CH₃ | CF₃ | Cl | Me | CH₃ | CF₃ | Cl |
| Et | CH₃ | CF₃ | Cl | Et | CH₃ | CF₃ | Cl | Et | CH₃ | CF₃ | Cl |
| i-Pr | CH₃ | CF₃ | Cl | i-Pr | CH₃ | CF₃ | Cl | i-Pr | CH₃ | CF₃ | Cl |
| t-Bu | CH₃ | CF₃ | Cl | t-Bu | CH₃ | CF₃ | Cl | t-Bu | CH₃ | CF₃ | Cl |
| Me | CH₃ | CF₃ | Br | Me | CH₃ | CF₃ | Br | Me | CH₃ | CF₃ | Br |
| Et | CH₃ | CF₃ | Br | Et | CH₃ | CF₃ | Br | Et | CH₃ | CF₃ | Br |
| i-Pr | CH₃ | CF₃ | Br | i-Pr | CH₃ | CF₃ | Br | i-Pr | CH₃ | CF₃ | Br |
| t-Bu | CH₃ | CF₃ | Br | t-Bu | CH₃ | CF₃ | Br | t-Bu | CH₃ | CF₃ | Br |
| n-Pr | CH₃ | Cl | Cl | Me | Cl | F | Br | Me | Cl | H | Br |
| n-Bu | CH₃ | Cl | Cl | Et | Cl | F | Br | Et | Cl | H | Br |
| s-Bu | CH₃ | Cl | Cl | i-Pr | Cl | F | Br | i-Pr | Cl | H | Br |
| i-Bu | CH₃ | Cl | Cl | t-Bu | Cl | F | Br | t-Bu | Cl | H | Br |
| Me | Cl | F | Cl | Me | Cl | F | Cl | Me | Cl | H | Cl |
| Et | Cl | F | Cl | Et | Cl | F | Cl | Et | Cl | H | Cl |
| i-Pr | Cl | F | Cl | i-Pr | Cl | F | Cl | i-Pr | Cl | H | Cl |
| t-Bu | Cl | F | Cl | t-Bu | Cl | F | Cl | i-Pr | Cl | H | Cl |
| Me | Cl | F | Br | Me | Cl | Cl | Br | Me | Cl | I | Br |
| Et | Cl | F | Br | Et | Cl | Cl | Br | Et | Cl | I | Br |
| i-Pr | Cl | F | Br | i-Pr | Cl | Cl | Br | i-Pr | Cl | I | Br |
| t-Bu | Cl | F | Br | t-Bu | Cl | Cl | Br | t-Bu | Cl | I | Br |
| Me | Cl | Cl | Cl | Me | Cl | Cl | Cl | Me | Cl | I | Cl |
| Et | Cl | Cl | Cl | Et | Cl | Cl | Cl | Et | Cl | I | Cl |
| i-Pr | Cl | Cl | Cl | i-Pr | Cl | Cl | Cl | i-Pr | Cl | I | Cl |
| t-Bu | Cl | Cl | Cl | t-Bu | Cl | Cl | Cl | t-Bu | Cl | I | Cl |
| Me | Cl | H | Br | Me | Cl | H | Br | Me | Cl | F | Br |
| Et | Cl | H | Br | Et | Cl | H | Br | Et | Cl | F | Br |
| i-Pr | Cl | H | Br | i-Pr | Cl | H | Br | i-Pr | Cl | F | Br |
| t-Bu | Cl | H | Br | t-Bu | Cl | H | Br | t-Bu | Cl | F | Br |
| Me | Cl | H | Cl | Me | Cl | H | Cl | Me | Cl | F | Cl |
| Et | Cl | H | Cl | Et | Cl | H | Cl | Et | Cl | F | Cl |
| i-Pr | Cl | H | Cl | i-Pr | Cl | H | Cl | i-Pr | Cl | F | Cl |
| t-Bu | Cl | H | Cl | t-Bu | Cl | H | Cl | t-Bu | Cl | F | Cl |
| Me | Cl | Br | Br | Me | Cl | Br | Br | Me | Cl | CF₃ | Br |
| Et | Cl | Br | Br | Et | Cl | Br | Br | Et | Cl | CF₃ | Br |
| i-Pr | Cl | Br | Br | i-Pr | Cl | Br | Br | i-Pr | Cl | CF₃ | Br |
| t-Bu | Cl | Br | Br | t-Bu | Cl | Br | Br | t-Bu | Cl | CF₃ | Br |
| Me | Cl | Br | Cl | Me | Cl | I | Cl | Me | Cl | CF₃ | Cl |
| Et | Cl | Br | Cl | Et | Cl | I | Cl | Et | Cl | CF₃ | Cl |
| i-Pr | Cl | Br | Cl | i-Pr | Cl | I | Cl | i-Pr | Cl | CF₃ | Cl |
| t-Bu | Cl | Br | Cl | t-Bu | Cl | I | Cl | t-Bu | Cl | CF₃ | Cl |
| Me | Cl | I | Br | Me | Cl | I | Br | Me | Br | F | Cl |
| Et | Cl | I | Br | Et | Cl | I | Br | Et | Br | F | Cl |
| i-Pr | Cl | I | Br | i-Pr | Cl | I | Br | i-Pr | Br | F | Cl |
| t-Bu | Cl | I | Br | t-Bu | Cl | I | Br | t-Bu | Br | F | Cl |
| Me | Cl | I | Cl | Me | Cl | CF₃ | Cl | Me | Br | F | Br |
| Et | Cl | I | Cl | Et | Cl | CF₃ | Cl | Et | Br | F | Br |
| i-Pr | Cl | I | Cl | i-Pr | Cl | CF₃ | Cl | i-Pr | Br | F | Br |
| t-Bu | Cl | I | Cl | t-Bu | Cl | CF₃ | Cl | t-Bu | Br | F | Br |
| Me | Cl | CF₃ | Br | Me | Cl | CF₃ | Br | Me | BrCl | Cl | |
| Et | Cl | CF₃ | Br | Et | Cl | CF₃ | Br | Et | BrCl | Cl | |
| i-Pr | Cl | CF₃ | Br | i-Pr | Cl | CF₃ | Br | i-Pr | Br | Cl | Cl |
| t-Bu | Cl | CF₃ | Br | t-Bu | Cl | CF₃ | Br | t-Bu | Br | Cl | Cl |
| Me | Cl | CF₃ | Cl | n-Pr | Cl | Cl | Cl | Me | Br | Cl | Br |
| Et | Cl | CF₃ | Cl | n-Bu | Cl | Cl | Cl | Et | Br | Cl | Br |
| i-Pr | Cl | CF₃ | Cl | s-Bu | Cl | Cl | Cl | i-Pr | Br | Cl | Br |
| t-Bu | Cl | CF₃ | Cl | i-Bu | Cl | Cl | Cl | t-Bu | Br | Cl | Br |
| Me | Br | F | Cl | Me | Br | F | Cl | Me | Br | Br | Cl |
| Et | Br | F | Cl | Et | Br | F | Cl | Et | Br | Br | Cl |
| i-Pr | Br | F | Cl | i-Pr | Br | F | Cl | i-Pr | Br | Br | Cl |
| t-Bu | Br | F | Cl | t-Bu | Br | F | Cl | t-Bu | Br | Br | Cl |
| Me | Br | F | Br | Me | Br | F | Br | Me | Br | Br | Br |
| Et | Br | F | Br | Et | Br | F | Br | Et | Br | Br | Br |
| i-Pr | Br | F | Br | i-Pr | Br | F | Br | i-Pr | Br | Br | Br |
| t-Bu | Br | F | Br | t-Bu | Br | F | Br | t-Bu | Br | Br | Br |
| Me | Br | Cl | Cl | Me | Br | Cl | Cl | Me | Br | I | Cl |
| Et | Br | Cl | Cl | Et | Br | Cl | Cl | Et | Br | I | Cl |
| i-Pr | Br | Cl | Cl | i-Pr | Br | Cl | Cl | i-Pr | Br | I | Cl |
| t-Bu | Br | Cl | Cl | t-Bu | Br | Cl | Cl | t-Bu | Br | I | Cl |
| Me | Br | Cl | Br | Me | Br | Cl | Br | Me | Br | I | Br |
| Et | Br | Cl | Br | Et | Br | Cl | Br | Et | Br | I | Br |
| i-Pr | Br | Cl | Br | i-Pr | Br | Cl | Br | i-Pr | Br | I | Br |
| t-Bu | Br | Cl | Br | t-Bu | Br | Cl | Br | t-Bu | Br | I | Br |
| Me | Br | Br | Cl | Me | Br | Br | Cl | Me | Br | CF₃ | Cl |
| Et | Br | Br | Cl | Et | Br | Br | Cl | Et | Br | CF₃ | Cl |
| i-Pr | Br | Br | Cl | i-Pr | Br | Br | Cl | i-Pr | Br | CF₃ | Cl |
| t-Bu | Br | Br | Cl | t-Bu | Br | Br | Cl | t-Bu | Br | CF₃ | Cl |
| Me | Br | Br | Br | Me | Br | Br | Br | Me | Br | CF₃ | Br |
| Et | Br | Br | Br | Et | Br | Br | Br | Et | Br | CF₃ | Br |
| i-Pr | Br | Br | Br | i-Pr | Br | Br | Br | i-Pr | Br | CF₃ | Br |
| t-Bu | Br | Br | Br | t-Bu | Br | Br | Br | t-Bu | Br | CF₃ | Br |
| Me | Br | I | Cl | Me | Br | I | Cl | Me | Cl | Cl | Br |
| Et | Br | I | Cl | Et | Br | I | Cl | Et | Cl | Cl | Br |
| i-Pr | Br | I | Cl | i-Pr | Br | I | Cl | i-Pr | Cl | Cl | Br |
| t-Bu | Br | I | Cl | t-Bu | Br | I | Cl | t-Bu | Cl | Cl | Br |
| Me | Br | I | Br | Me | Br | I | Br | Me | Cl | Cl | Cl |
| Et | Br | I | Br | Et | Br | I | Br | Et | Cl | Cl | Cl |
| i-Pr | Br | I | Br | i-Pr | Br | I | Br | i-Pr | Cl | Cl | Cl |
| t-Bu | Br | I | Br | t-Bu | Br | I | Br | t-Bu | Cl | Cl | Cl |

TABLE 19

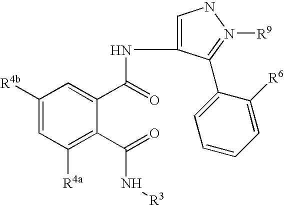

| R⁹ is CHF₂ | | | | R⁹ is CH₂CF₃ | | | | R₉ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | b H | Cl |
| Et | CH₃ | H | Cl | Et | CH₃ | H | Cl | El | CH₃ | H | Cl |
| i-Pr | CH₃ | H | Cl | i-Pr | CH₃ | H | Cl | i-Pr | CH₃ | H | Cl |
| t-Bu | CH₃ | H | Cl | t-Bu | CH₃ | H | Cl | t-Bu | CH₃ | H | Cl |
| Me | CH₃ | H | Br | Me | CH₃ | H | Br | Me | CH₃ | H | Br |
| Et | CH₃ | H | Br | Et | CH₃ | H | Br | Et | CH₃ | H | Br |
| i-Pr | CH₃ | H | Br | i-Pr | CH₃ | H | Br | i-Pr | CH₃ | H | Br |
| t-Bu | CH₃ | H | Br | t-Bu | CH₃ | H | Br | t-Bu | CH₃ | H | Br |
| Me | CH₃ | F | Cl | Me | CH₃ | F | Cl | Me | CH₃ | F | Cl |
| Et | CH₃ | F | Cl | Et | CH₃ | F | Cl | Et | CH₃ | F | Cl |
| i-Pr | CH₃ | F | Cl | i-Pr | CH₃ | F | Cl | i-Pr | CH₃ | F | Cl |
| t-Bu | CH₃ | F | Cl | t-Bu | CH₃ | F | Cl | t-Bu | CH₃ | F | Cl |
| Me | CH₃ | F | Br | Me | CH₃ | F | Br | Me | CH₃ | F | Br |
| Et | CH₃ | F | Br | Et | CH₃ | F | Br | El | CH₃ | F | Br |
| i-Pr | CH₃ | F | Br | i-Pr | CH₃ | F | Br | i-Pr | CH₃ | F | Br |
| t-Bu | CH₃ | F | Br | t-Bu | CH₃ | F | Br | t-Bu | CH₃ | F | Br |
| Me | CH₃ | Cl | Cl | Me | CH₃ | Cl | Cl | Me | CH₃ | Cl | Cl |
| Et | CH₃ | Cl | Cl | Et | CH₃ | Cl | Cl | Et | CH₃ | Cl | Cl |
| i-Pr | CH₃ | Cl | Cl | i-Pr | CH₃ | Cl | Cl | i-Pr | CH₃ | Cl | Cl |
| t-Bu | CH₃ | Cl | Cl | t-Bu | CH₃ | Cl | Cl | t-Bu | CH₃ | Cl | Cl |
| Me | CH₃ | Cl | Br | Me | CH₃ | Cl | Br | Me | CH₃ | Cl | Br |
| Et | CH₃ | Cl | Br | El | CH₃ | Cl | Br | Et | CH₃ | Cl | Br |
| i-Pr | CH₃ | Cl | Br | i-Pr | CH₃ | Cl | Br | i-Pr | CH₃ | Cl | Br |
| t-Bu | CH₃ | Cl | Br | t-Bu | CH₃ | Cl | Br | t-Bu | CH₃ | Cl | Br |
| Me | CH₃ | Br | Cl | Me | CH₃ | Br | Cl | Me | CH₃ | Br | Cl |
| Et | CH₃ | Br | Cl | Et | CH₃ | Br | Cl | Et | CH₃ | Br | Cl |
| i-Pr | CH₃ | Br | Cl | i-Pr | CH₃ | Br | Cl | i-Pr | CH₃ | Br | Cl |
| t-Bu | CH₃ | Br | Cl | t-Bu | CH₃ | Br | Cl | t-Bu | CH₃ | Br | Cl |
| Me | CH₃ | Br | Br | Me | CH₃ | Br | Br | Me | CH₃ | Br | Br |
| Et | CH₃ | Br | Br | Et | CH₃ | Br | Br | Et | CH₃ | Br | Br |
| i-Pr | CH₃ | Br | Br | i-Pr | CH₃ | Br | Br | i-Pr | CH₃ | Br | Br |
| t-Bu | CH₃ | Br | Br | t-Bu | CH₃ | Br | Br | t-Bu | CH₃ | Br | Br |
| Me | CH₃ | I | Cl | Me | CH₃ | I | Cl | Me | CH₃ | I | Cl |
| Et | CH₃ | I | Cl | Et | CH₃ | I | Cl | Et | CH₃ | I | Cl |
| i-Pr | CH₃ | I | Cl | i-Pr | CH₃ | I | Cl | i-Pr | CH₃ | I | Cl |
| t-Bu | CH₃ | I | Cl | t-Bu | CH₃ | I | Cl | t-Bu | CH₃ | I | Cl |
| Me | CH₃ | I | Br | Me | CH₃ | I | Br | Me | CH₃ | I | Br |
| Et | CH₃ | I | Br | Et | CH₃ | I | Br | Et | CH₃ | I | Br |
| i-Pr | CH₃ | I | Br | i-Pr | CH₃ | I | Br | i-Pr | CH₃ | I | Br |
| t-Bu | CH₃ | I | Br | t-Bu | CH₃ | I | Br | t-Bu | CH₃ | I | Br |
| Me | CH₃ | CF₃ | Cl | Me | CH₃ | CF₃ | Cl | Me | CH₃ | CF₃ | Cl |
| Et | CH₃ | CF₃ | Cl | Et | CH₃ | CF₃ | Cl | Et | CH₃ | CF₃ | Cl |
| i-Pr | CH₃ | CF₃ | Cl | i-Pr | CH₃ | CF₃ | Cl | i-Pr | CH₃ | CF₃ | Cl |
| t-Bu | CH₃ | CF₃ | Cl | t-Bu | CH₃ | CF₃ | Cl | t-Bu | CH₃ | CF₃ | Cl |
| Me | CH₃ | CF₃ | Br | Me | CH₃ | CF₃ | Br | Me | CH₃ | CF₃ | Br |
| Et | CH₃ | CF₃ | Br | Et | CH₃ | CF₃ | Br | Et | CH₃ | CF₃ | Br |
| i-Pr | CH₃ | CF₃ | Br | i-Pr | CH₃ | CF₃ | Br | i-Pr | CH₃ | CF₃ | Br |
| t-Bu | CH₃ | CF₃ | Br | t-Bu | CH₃ | CF₃ | Br | t-Bu | CH₃ | CF₃ | Br |
| n-Pr | CH₃ | Cl | Cl | Me | Cl | F | Br | Me | Cl | H | Br |
| n-Bu | CH₃ | Cl | Cl | Et | Cl | F | Br | Et | Cl | H | Br |
| s-Bu | CH₃ | Cl | Cl | i-Pr | Cl | F | Br | i-Pr | Cl | H | Br |
| i-Bu | CH₃ | CI | Cl | t-Bu | Cl | F | Br | t-Bu | Cl | H | Br |
| Me | Cl | F | Cl | Me | Cl | F | Cl | Me | Cl | H | Cl |
| Et | Cl | F | Cl | Et | Cl | F | Cl | Et | Cl | H | Cl |
| i-Pr | Cl | F | Cl | i-Pr | Cl | F | Cl | i-Pr | Cl | H | Cl |
| t-Bu | Cl | F | Cl | t-Bu | Cl | F | Cl | i-Pr | Cl | H | Cl |
| Me | Cl | F | Br | Me | Cl | Cl | Br | Me | Cl | I | Br |
| Et | Cl | F | Br | Et | Cl | Cl | Br | Et | Cl | I | Br |
| i-Pr | Cl | F | Br | i-Pr | Cl | Cl | Br | i-Pr | Cl | I | Br |
| t-Bu | Cl | F | Br | t-Bu | Cl | Cl | Br | t-Bu | Cl | I | Br |
| Me | Cl | Cl | Cl | Me | Cl | Cl | Cl | Me | Cl | I | Cl |
| Et | Cl | Cl | Cl | Et | Cl | Cl | Cl | Et | Cl | I | Cl |
| i-Pr | Cl | Cl | Cl | i-Pr | Cl | Cl | Cl | i-Pr | Cl | I | Cl |
| t-Bu | Cl | Cl | Cl | t-Bu | Cl | Cl | Cl | t-Bu | Cl | I | Cl |
| Me | Cl | H | Br | Me | Cl | H | Br | Me | Cl | F | Br |
| Et | Cl | H | Br | Et | Cl | H | Br | Et | Cl | F | Br |
| i-Pr | Cl | H | Br | i-Pr | Cl | H | Br | i-Pr | Cl | F | Br |
| t-Bu | Cl | H | Br | t-Bu | Cl | H | Br | t-Bu | Cl | F | Br |
| Me | Cl | H | Cl | Me | Cl | H | Cl | Me | Cl | F | Cl |
| Et | Cl | H | Cl | Et | Cl | H | Cl | Et | Cl | F | Cl |
| i-Pr | Cl | H | Cl | i-Pr | Cl | H | Cl | i-Pr | Cl | F | Cl |
| t-Bu | Cl | H | Cl | t-Bu | Cl | H | Cl | t-Bu | Cl | F | Cl |
| Me | Cl | Br | Br | Me | Cl | Br | Br | Me | Cl | CF₃ | Br |
| Et | Cl | Br | Br | Et | Cl | Br | Br | Et | Cl | CF₃ | Br |
| i-Pr | Cl | Br | Br | i-Pr | Cl | Br | Br | i-Pr | Cl | CF₃ | Br |
| t-Bu | Cl | Br | Br | t-Bu | Cl | Br | Br | t-Bu | Cl | CF₃ | Br |
| Me | Cl | Br | Cl | Me | Cl | I | Cl | Me | Cl | CF₃ | Cl |
| Et | Cl | Br | Cl | Et | Cl | I | Cl | Et | Cl | CF₃ | Cl |
| i-Pr | Cl | Br | Cl | i-Pr | Cl | I | Cl | i-Pr | Cl | CF₃ | Cl |
| t-Bu | Cl | Br | Cl | t-Bu | Cl | I | Cl | t-Bu | Cl | CF₃ | Cl |
| Me | Cl | I | Br | Me | Cl | I | Br | Me | Br | F | Cl |
| Et | Cl | I | Br | Et | Cl | I | Br | Et | Br | F | Cl |
| i-Pr | Cl | I | Br | i-Pr | Cl | I | Br | i-Pr | Br | F | Cl |
| t-Bu | Cl | I | Br | t-Bu | Cl | I | Br | t-Bu | Br | F | Cl |
| Me | Cl | I | Cl | Me | Cl | CF₃ | Cl | Me | Br | F | Br |
| Et | Cl | I | Cl | Et | Cl | CF₃ | Cl | Et | Br | F | Br |
| i-Pr | Cl | I | Cl | i-Pr | Cl | CF₃ | Cl | i-Pr | Br | F | Br |
| t-Bu | Cl | I | Cl | t-Bu | Cl | CF₃ | Cl | t-Bu | Br | F | Br |
| Me | Cl | CF₃ | Br | Me | Cl | CF₃ | Br | Me | Br | Cl | Cl |
| Et | Cl | CF₃ | Br | Et | Cl | CF₃ | Br | Et | Br | Cl | Cl |
| i-Pr | Cl | CF₃ | Br | i-Pr | Cl | CF₃ | Br | i-Pr | Br | Cl | Cl |
| t-Bu | Cl | CF₃ | Br | t-Bu | Cl | CF₃ | Br | t-Bu | Br | Cl | Cl |
| Me | Cl | CF₃ | Cl | n-Pr | Cl | Cl | Cl | Me | Br | Cl | Br |
| Et | Cl | CF₃ | Cl | n-Bu | Cl | Cl | Cl | Et | Br | Cl | Br |
| i-Pr | Cl | CF₃ | Cl | s-Bu | Cl | Cl | Cl | i-Pr | Br | Cl | Br |
| t-Bu | Cl | CF₃ | Cl | i-Bu | Cl | Cl | Cl | t-Bu | Br | Cl | Br |
| Me | Br | F | Cl | Me | Br | F | Cl | Me | Br | Br | Cl |
| Et | Br | F | Cl | Et | Br | F | Cl | Et | Br | Br | Cl |
| i-Pr | Br | F | Cl | i-Pr | Br | F | Cl | i-Pr | Br | Br | Cl |
| t-Bu | Br | F | Cl | t-Bu | Br | F | Cl | t-Bu | Br | Br | Cl |
| Me | Br | F | Br | Me | Br | F | Br | Me | Br | Br | Br |
| Et | Br | F | Br | Et | Br | F | Br | Et | Br | Br | Br |
| i-Pr | Br | F | Br | i-Pr | Br | F | Br | i-Pr | Br | Br | Br |
| t-Bu | Br | F | Br | t-Bu | Br | F | Br | t-Bu | Br | Br | Br |
| Me | Br | Cl | Cl | Me | Br | Cl | Cl | Me | Br | I | Cl |
| Et | Br | Cl | Cl | Et | Br | Cl | Cl | Et | Br | I | Cl |
| i-Pr | Br | Cl | Cl | i-Pr | Br | Cl | Cl | i-Pr | Br | I | Cl |
| t-Bu | Br | Cl | Cl | t-Bu | Br | Cl | Cl | t-Bu | Br | I | Cl |
| Me | Br | Cl | Br | Me | Br | Cl | Br | Me | Br | I | Br |
| Et | Br | Cl | Br | Et | Br | Cl | Br | Et | Br | I | Br |
| i-Pr | Br | Cl | Br | i-Pr | Br | Cl | Br | i-Pr | Br | I | Br |
| t-Bu | Br | Cl | Br | t-Bu | Br | Cl | Br | t-Bu | Br | I | Br |
| Me | Br | Br | Cl | Me | Br | Br | Cl | Me | Br | CF₃ | Cl |
| Et | Br | Br | Cl | Et | Br | Br | Cl | Et | Br | CF₃ | Cl |
| i-Pr | Br | Br | Cl | i-Pr | Br | Br | Cl | i-Pr | Br | CF₃ | Cl |
| t-Bu | Br | Br | Cl | t-Bu | Br | Br | Cl | t-Bu | Br | CF₃ | Cl |
| Me | Br | Br | Br | Me | Br | Br | Br | Me | Br | CF₃ | Br |
| Et | Br | Br | Br | Et | Br | Br | Br | Et | Br | CF₃ | Br |
| i-Pr | Br | Br | Br | i-Pr | Br | Br | Br | i-Pr | Br | CF₃ | Br |
| t-Bu | Br | Br | Br | t-Bu | Br | Br | Br | t-Bu | Br | CF₃ | Br |
| Me | Br | I | Cl | Me | Br | I | Cl | Me | Cl | Cl | Br |
| Et | Br | I | Cl | Et | Br | I | Cl | Et | Cl | Cl | Br |
| i-Pr | Br | I | Cl | i-Pr | Br | I | Cl | i-Pr | Cl | Cl | Br |
| t-Bu | Br | I | Cl | t-Bu | Br | I | Cl | t-Bu | Cl | Cl | Br |
| Me | Br | I | Br | Me | Br | I | Br | Me | Cl | Cl | Cl |
| Et | Br | I | Br | Et | Br | I | Br | Et | Cl | Cl | Cl |
| i-Pr | Br | I | Br | i-Pr | Br | I | Br | i-Pr | Cl | Cl | Cl |
| t-Bu | Br | I | Br | t-Bu | Br | I | Br | t-Bu | Cl | Cl | Cl |

TABLE 20

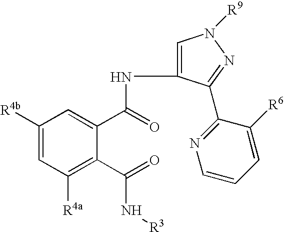

| R⁹ is CHF₂ | | | | R⁹ is CH₂F₃ | | | | R⁹ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | Br | Cl |
| Et | CH₃ | H | Cl | Et | CH₃ | H | Cl | Et | CH₃ | Br | Cl |
| i-Pr | CH₃ | H | Cl | i-Pr | CH₃ | H | Cl | i-Pr | CH₃ | Br | Cl |
| t-Bu | CH₃ | H | Cl | t-Bu | CH₃ | H | Cl | t-Bu | CH₃ | Br | Cl |
| Me | CH₃ | H | Br | Me | CH₃ | H | Br | Me | CH₃ | Br | Br |
| Et | CH₃ | H | Br | Et | CH₃ | H | Br | Et | CH₃ | Br | Br |
| i-Pr | CH₃ | H | Br | i-Pr | CH₃ | H | Br | i-Pr | CH₃ | Br | Br |
| t-Bu | CH₃ | H | Br | t-Bu | CH₃ | H | Br | t-Bu | CH₃ | Br | Br |
| Me | CH₃ | F | Cl | Me | CH₃ | Br | Cl | Me | CH₃ | I | Cl |
| Et | CH₃ | F | Cl | Et | CH₃ | Br | Cl | Et | CH₃ | I | Cl |
| i-Pr | CH₃ | F | Cl | i-Pr | CH₃ | Br | Cl | i-Pr | CH₃ | I | Cl |
| t-Bu | CH₃ | F | Cl | t-Bu | CH₃ | Br | Cl | t-Bu | CH₃ | I | Cl |
| Me | CH₃ | F | Br | Me | CH₃ | Br | Br | Me | CH₃ | I | Br |
| Et | CH₃ | F | Br | Et | CH₃ | Br | Br | Et | CH₃ | I | Br |
| i-Pr | CH₃ | F | Br | i-Pr | CH₃ | Br | Br | i-Pr | CH₃ | I | Br |
| t-Bu | CH₃ | F | Br | t-Bu | CH₃ | Br | Br | t-Bu | CH₃ | I | Br |
| Me | CH₃ | Cl | Cl | Me | CH₃ | F | Cl | Me | CH₃ | CF₃ | Cl |
| Et | CH₃ | Cl | Cl | Et | CH₃ | F | Cl | Et | CH₃ | CF₃ | Cl |
| i-Pr | CH₃ | Cl | Cl | i-Pr | CH₃ | F | Cl | i-Pr | CH₃ | CF₃ | Cl |
| t-Bu | CH₃ | Cl | Cl | t-Bu | CH₃ | F | Cl | t-Bu | CH₃ | CF₃ | Cl |
| Me | CH₃ | Cl | Br | Me | CH₃ | F | Br | Me | CH₃ | CF₃ | Br |
| Et | CH₃ | Cl | Br | Et | CH₃ | F | Br | Et | CH₃ | CF₃ | Br |
| i-Pr | CH₃ | Cl | Br | i-Pr | CH₃ | F | Br | i-Pr | CH₃ | CF₃ | Br |
| t-Bu | CH₃ | Cl | Br | t-Bu | CH₃ | F | Br | t-Bu | CH₃ | CF₃ | Br |
| Me | CH₃ | Br | Cl | Me | CH₃ | Cl | Cl | Me | CH₃ | Cl | Cl |
| Et | CH₃ | Br | Cl | Et | CH₃ | Cl | Cl | Et | CH₃ | Cl | Cl |
| i-Pr | CH₃ | Br | Cl | i-Pr | CH₃ | Cl | Cl | i-Pr | CH₃ | Cl | Cl |
| t-Bu | CH₃ | Br | Cl | t-Bu | CH₃ | Cl | Cl | t-Bu | CH₃ | Cl | Cl |
| Me | CH₃ | Br | Br | Me | CH₃ | Cl | Br | Me | CH₃ | Cl | Br |
| Et | CH₃ | Br | Br | Et | CH₃ | Cl | Br | Et | CH₃ | Cl | Br |
| i-Pr | CH₃ | Br | Br | i-Pr | CH₃ | Cl | Br | i-Pr | CH₃ | Cl | Br |
| t-Bu | CH₃ | Br | Br | t-Bu | CH₃ | Cl | Br | t-Bu | CH₃ | Cl | Br |
| Me | CH₃ | I | Cl | Me | CH₃ | I | Cl | Me | CH₃ | H | Cl |
| Et | CH₃ | I | Cl | Et | CH₃ | I | Cl | Et | CH₃ | H | Cl |
| i-Pr | CH₃ | I | Cl | i-Pr | CH₃ | I | Cl | i-Pr | CH₃ | H | Cl |
| t-Bu | CH₃ | I | Cl | t-Bu | CH₃ | I | Cl | t-Bu | CH₃ | H | Cl |
| Me | CH₃ | I | Br | Me | CH₃ | I | Br | Me | CH₃ | H | Br |
| Et | CH₃ | I | Br | Et | CH₃ | I | Br | Et | CH₃ | H | Br |
| i-Pr | CH₃ | I | Br | i-Pr | CH₃ | I | Br | i-Pr | CH₃ | H | Br |
| t-Bu | CH₃ | I | Br | t-Bu | CH₃ | I | Br | t-Bu | CH₃ | H | Br |
| Me | CH₃ | CF₃ | Cl | Me | CH₃ | CF₃ | Cl | Me | CH₃ | F | Cl |
| Et | CH₃ | CF₃ | Cl | Et | CH₃ | CF₃ | Cl | Et | CH₃ | F | Cl |
| i-Pr | CH₃ | CF₃ | Cl | i-Pr | CH₃ | CF₃ | Cl | i-Pr | CH₃ | F | Cl |
| t-Bu | CH₃ | CF₃ | Cl | t-Bu | CH₃ | CF₃ | Cl | t-Bu | CH₃ | F | Cl |
| Me | CH₃ | CF₃ | Br | Me | CH₃ | CF₃ | Br | Me | CH₃ | F | Br |
| Et | CH₃ | CF₃ | Br | Et | CH₃ | CF₃ | Br | Et | CH₃ | F | Br |
| i-Pr | CH₃ | CF₃ | Br | i-Pr | CH₃ | CF₃ | Br | i-Pr | CH₃ | F | Br |
| t-Bu | CH₃ | CF₃ | Br | t-Bu | CH₃ | CF₃ | Br | t-Bu | CH₃ | F | Br |
| n-Pr | CH₃ | Cl | Cl | Me | Cl | H | Br | Me | Cl | Cl | Br |
| n-Bu | CH₃ | Cl | Cl | Et | Cl | H | Br | Et | Cl | Cl | Br |
| s-Bu | CH₃ | Cl | Cl | i-Pr | Cl | H | Br | i-Pr | Cl | Cl | Br |
| i-Bu | CH₃ | Cl | Cl | t-Bu | Cl | H | Br | t-Bu | Cl | Cl | Br |
| Me | Cl | I | Br | Me | Cl | H | Cl | Me | Cl | Cl | Cl |
| Et | Cl | I | Br | Et | Cl | H | Cl | Et | Cl | Cl | Cl |
| i-Pr | Cl | I | Br | i-Pr | Cl | H | Cl | i-Pr | Cl | Cl | Cl |
| t-Bu | Cl | I | Br | t-Bu | Cl | H | Cl | t-Bu | Cl | Cl | Cl |
| Me | Cl | I | Cl | Me | Cl | Cl | Br | Me | Cl | I | Br |
| Et | Cl | I | Cl | Et | Cl | Cl | Br | Et | Cl | I | Br |
| i-Pr | Cl | I | Cl | i-Pr | Cl | Cl | Br | i-Pr | Cl | I | Br |
| t-Bu | Cl | I | Cl | t-Bu | Cl | Cl | Br | t-Bu | Cl | I | Br |
| Me | Cl | H | Br | Me | Cl | Cl | Cl | Me | Cl | I | Cl |
| Et | Cl | H | Br | Et | Cl | Cl | Cl | Et | Cl | I | Cl |
| i-Pr | Cl | H | Br | i-Pr | Cl | Cl | Cl | i-Pr | Cl | I | Cl |
| t-Bu | Cl | H | Br | t-Bu | Cl | Cl | Cl | t-Bu | Cl | I | Cl |
| Me | Cl | H | Cl | Me | Cl | F | Br | Me | Cl | F | Br |
| Et | Cl | H | Cl | Et | Cl | F | Br | Et | Cl | F | Br |
| i-Pr | Cl | H | Cl | i-Pr | Cl | F | Br | i-Pr | Cl | F | Br |
| t-Bu | Cl | H | Cl | t-Bu | Cl | F | Br | t-Bu | Cl | F | Br |
| Me | Cl | CF₃ | Br | Me | Cl | F | Cl | Me | Cl | F | Cl |
| Et | Cl | CF₃ | Br | Et | Cl | F | Cl | Et | Cl | F | Cl |
| i-Pr | Cl | CF₃ | Br | i-Pr | Cl | F | Cl | i-Pr | Cl | F | Cl |
| t-Bu | Cl | CF₃ | Br | t-Bu | Cl | F | Cl | t-Bu | Cl | F | Cl |
| Me | Cl | CF₃ | Cl | Me | Cl | Br | Br | Me | Cl | H | Br |
| Et | Cl | CF₃ | Cl | Et | Cl | Br | Br | Et | Cl | H | Br |
| i-Pr | Cl | CF₃ | Cl | i-Pr | Cl | Br | Br | i-Pr | Cl | H | Br |
| t-Bu | Cl | CF₃ | Cl | t-Bu | Cl | Br | Br | t-Bu | Cl | H | Br |
| Me | Cl | Br | Br | Me | Cl | I | Cl | Me | Cl | H | Cl |
| Et | Cl | Br | Br | Et | Cl | I | Cl | Et | Cl | H | Cl |
| i-Pr | Cl | Br | Br | i-Pr | Cl | I | Cl | i-Pr | Cl | H | Cl |
| t-Bu | Cl | Br | Br | t-Bu | Cl | I | Cl | i-Pr | Cl | H | Cl |
| Me | Cl | Br | Cl | Me | Cl | I | Br | Me | Cl | CF₃ | Br |
| Et | Cl | Br | Cl | Et | Cl | I | Br | Et | Cl | CF₃ | Br |
| i-Pr | Cl | Br | Cl | i-Pr | Cl | I | Br | i-Pr | Cl | CF₃ | Br |
| t-Bu | Cl | Br | Cl | t-Bu | Cl | I | Br | t-Bu | Cl | CF₃ | Br |
| Me | Cl | F | Br | Me | Cl | CF₃ | Cl | Me | Cl | CF₃ | Cl |
| Et | Cl | F | Br | Et | Cl | CF₃ | Cl | Et | Cl | CF₃ | Cl |
| i-Pr | Cl | F | Br | i-Pr | Cl | CF₃ | Cl | i-Pr | Cl | CF₃ | Cl |
| t-Bu | Cl | F | Br | t-Bu | Cl | CF₃ | Cl | t-Bu | Cl | CF₃ | Cl |
| Me | Cl | Cl | Cl | Me | Cl | CF₃ | Br | Me | Br | F | Cl |
| Et | Cl | Cl | Cl | Et | Cl | CF₃ | Br | Et | Br | F | Cl |
| i-Pr | Cl | Cl | Cl | i-Pr | Cl | CF₃ | Br | i-Pr | Br | F | Cl |
| t-Bu | Cl | Cl | Cl | t-Bu | Cl | CF₃ | Br | t-Bu | Br | F | Cl |
| Me | Cl | F | Cl | n-Pr | Cl | Cl | Cl | Me | Br | F | Br |
| Et | Cl | F | Cl | n-Bu | Cl | Cl | Cl | Et | Br | F | Br |
| i-Pr | Cl | F | Cl | s-Bu | Cl | Cl | Cl | i-Pr | Br | F | Br |
| t-Bu | Cl | F | Cl | i-Bu | Cl | Cl | Cl | t-Bu | Br | F | Br |
| Me | Br | Br | Cl | Me | Br | F | Cl | Me | Br | Cl | Cl |
| Et | Br | Br | Cl | Et | Br | F | Cl | Et | Br | Cl | Cl |
| i-Pr | Br | Br | Cl | i-Pr | Br | F | Cl | i-Pr | Br | Cl | Cl |
| t-Bu | Br | Br | Cl | t-Bu | Br | F | Cl | t-Bu | Br | Cl | Cl |
| Me | Br | Br | Br | Me | Br | F | Br | Me | Br | Cl | Br |
| Et | Br | Br | Br | Et | Br | F | Br | Et | Br | Cl | Br |
| i-Pr | Br | Br | Br | i-Pr | Br | F | Br | i-Pr | Br | Cl | Br |
| t-Bu | Br | Br | Br | t-Bu | Br | F | Br | t-Bu | Br | Cl | Br |
| Me | Br | I | Cl | Me | Br | Cl | Cl | Me | Br | Br | Cl |
| Et | Br | I | Cl | Et | Br | Cl | Cl | Et | Br | Br | Cl |
| i-Pr | Br | I | Cl | i-Pr | Br | Cl | Cl | i-Pr | Br | Br | Cl |
| t-Bu | Br | I | Cl | t-Bu | Br | Cl | Cl | t-Bu | Br | Br | Cl |
| Me | Br | I | Br | Me | Br | Cl | Br | Me | Br | Br | Br |
| Et | Br | I | Br | Et | Br | Cl | Br | Et | Br | Br | Br |
| i-Pr | Br | I | Br | i-Pr | Br | Cl | Br | i-Pr | Br | Br | Br |
| t-Bu | Br | I | Br | t-Bu | Br | Cl | Br | t-Bu | Br | Br | Br |
| Me | Br | F | Cl | Me | Br | I | Cl | Me | Br | CF₃ | Cl |
| Et | Br | F | Cl | Et | Br | I | Cl | Et | Br | CF₃ | Cl |
| i-Pr | Br | F | Cl | i-Pr | Br | I | Cl | i-Pr | Br | CF₃ | Cl |
| t-Bu | Br | F | Cl | t-Bu | Br | I | Cl | t-Bu | Br | CF₃ | Cl |
| Me | Br | F | Br | Me | Br | I | Br | Me | Br | CF₃ | Br |
| Et | Br | F | Br | Et | Br | I | Br | Et | Br | CF₃ | Br |
| i-Pr | Br | F | Br | i-Pr | Br | I | Br | i-Pr | Br | CF₃ | Br |
| t-Bu | Br | F | Br | t-Bu | Br | I | Br | t-Bu | Br | CF₃ | Br |
| Me | Br | Cl | Cl | Me | Br | Br | Cl | Me | Br | I | Cl |
| Et | Br | Cl | Cl | Et | Br | Br | Cl | Et | Br | I | Cl |
| i-Pr | Br | Cl | Cl | i-Pr | Br | Br | Cl | i-Pr | Br | I | Cl |
| t-Bu | Br | Cl | Cl | t-Bu | Br | Br | Cl | t-Bu | Br | I | Cl |
| Me | Br | Cl | Br | Me | Br | Br | Br | Me | Br | I | Br |
| Et | Br | Cl | Br | Et | Br | Br | Br | Et | Br | I | Br |
| i-Pr | Br | Cl | Br | i-Pr | Br | Br | Br | i-Pr | Br | I | Br |
| t-Bu | Br | Cl | Br | t-Bu | Br | Br | Br | t-Bu | Br | I | Br |

TABLE 21

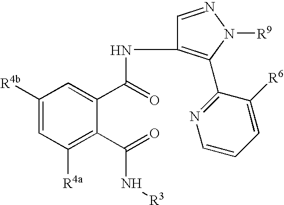

| R⁹ is CHF₂ | | | | R⁹ is CH₂F₃ | | | | R⁹ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | Br | Cl |
| Et | CH₃ | H | Cl | Et | CH₃ | H | Cl | Et | CH₃ | Br | Cl |
| i-Pr | CH₃ | H | Cl | i-Pr | CH₃ | H | Cl | i-Pr | CH₃ | Br | Cl |
| t-Bu | CH₃ | H | Cl | t-Bu | CH₃ | H | Cl | t-Bu | CH₃ | Br | Cl |
| Me | CH₃ | H | Br | Me | CH₃ | H | Br | Me | CH₃ | Br | Br |
| Et | CH₃ | H | Br | Et | CH₃ | H | Br | Et | CH₃ | Br | Br |
| i-Pr | CH₃ | H | Br | i-Pr | CH₃ | H | Br | i-Pr | CH₃ | Br | Br |
| t-Bu | CH₃ | H | Br | t-Bu | CH₃ | H | Br | t-Bu | CH₃ | Br | Br |
| Me | CH₃ | F | Cl | Me | CH₃ | Br | Cl | Me | CH₃ | I | Cl |
| Et | CH₃ | F | Cl | Et | CH₃ | Br | Cl | Et | CH₃ | I | Cl |
| i-Pr | CH₃ | F | Cl | i-Pr | CH₃ | Br | Cl | i-Pr | CF₃ | I | Cl |
| t-Bu | CH₃ | F | Cl | t-Bu | CH₃ | Br | Cl | t-Bu | CF₃ | I | Cl |
| Me | CH₃ | F | Br | Me | CH₃ | Br | Br | Me | CH₃ | I | Br |
| Et | CH₃ | F | Br | Et | CH₃ | Br | Br | Et | CH₃ | I | Br |
| i-Pr | CH₃ | F | Br | i-Pr | CH₃ | Br | Br | i-Pr | CH₃ | I | Br |
| t-Bu | CH₃ | F | Br | t-Bu | CH₃ | Br | Br | t-Bu | CH₃ | I | Br |
| Me | CH₃ | Cl | Cl | Me | CH₃ | F | Cl | Me | CH₃ | CF₃ | Cl |
| Et | CH₃ | Cl | Cl | Et | CH₃ | F | Cl | Et | CH₃ | CF₃ | Cl |
| i-Pr | CH₃ | Cl | Cl | i-Pr | CH₃ | F | Cl | i-Pr | CH₃ | CF₃ | Cl |
| t-Bu | CH₃ | Cl | Cl | t-Bu | CH₃ | F | Cl | t-Bu | CH₃ | CF₃ | Cl |
| Me | CH₃ | Cl | Br | Me | CH₃ | F | Br | Me | CH₃ | CF₃ | Br |
| Et | CH₃ | Cl | Br | Et | CH₃ | F | Br | Et | CH₃ | CF₃ | Br |
| i-Pr | CH₃ | Cl | Br | i-Pr | CH₃ | F | Br | i-Pr | CH₃ | CF₃ | Br |
| t-Bu | CH₃ | Cl | Br | t-Bu | CH₃ | F | Br | t-Bu | CH₃ | CF₃ | Br |
| Me | CH₃ | Br | Cl | Me | CH₃ | Cl | Cl | Me | CH₃ | Cl | Cl |
| Et | CH₃ | Br | Cl | Et | CH₃ | Cl | Cl | Et | CH₃ | Cl | Cl |
| i-Pr | CH₃ | Br | Cl | i-Pr | CH₃ | Cl | Cl | i-Pr | CH₃ | Cl | Cl |
| t-Bu | CH₃ | Br | Cl | t-Bu | CH₃ | Cl | Cl | t-Bu | CH₃ | Cl | Cl |
| Me | CH₃ | Br | Br | Me | CH₃ | Cl | Br | Me | CH₃ | Cl | Br |
| Et | CH₃ | Br | Br | Et | CH₃ | Cl | Br | Et | CH₃ | Cl | Br |
| i-Pr | CH₃ | Br | Br | i-Pr | CH₃ | Cl | Br | i-Pr | CH₃ | Cl | Br |
| t-Bu | CH₃ | Br | Br | t-Bu | CH₃ | Cl | Br | t-Bu | CH₃ | Cl | Br |
| Me | CH₃ | I | Cl | Me | CH₃ | I | Cl | Me | CH₃ | H | Cl |
| Et | CH₃ | I | Cl | Et | CH₃ | I | Cl | Et | CH₃ | H | Cl |
| i-Pr | CH₃ | I | Cl | i-Pr | CH₃ | I | Cl | i-Pr | CH₃ | H | Cl |
| t-Bu | CH₃ | I | Cl | t-Bu | CH₃ | I | Cl | t-Bu | CH₃ | H | Cl |
| Me | CH₃ | I | Br | Me | CH₃ | I | Br | Me | CH₃ | H | Br |
| Et | CH₃ | I | Br | Et | CH₃ | I | Br | Et | CH₃ | H | Br |
| i-Pr | CH₃ | I | Br | i-Pr | CH₃ | I | Br | i-Pr | CH₃ | B | Br |
| t-Bu | CH₃ | I | Br | t-Bu | CH₃ | I | Br | t-Bu | CH₃ | H | Br |
| Me | CH₃ | CH₃ | Cl | Me | CH₃ | CH₃ | Cl | Me | CH₃ | F | Cl |
| Et | CH₃ | CH₃ | Cl | Et | CH₃ | CH₃ | Cl | Et | CH₃ | F | Cl |
| i-Pr | CH₃ | CH₃ | Cl | i-Pr | CH₃ | CH₃ | Cl | i-Pr | CH₃ | F | Cl |
| t-Bu | CH₃ | CH₃ | Cl | t-Bu | CH₃ | CH₃ | Cl | t-Bu | CH₃ | F | Cl |
| Me | CH₃ | CH₃ | Br | Me | CH₃ | CH₃ | Br | Me | CH₃ | F | Br |
| Et | CH₃ | CH₃ | Br | Et | CH₃ | CH₃ | Br | Et | CH₃ | F | Br |
| i-Pr | CH₃ | GH₃ | Br | i-Pr | CH₃ | CH₃ | Br | i-Pr | CH₃ | F | Br |
| t-Bu | CH₃ | CH₃ | Br | t-Bu | CH₃ | CH₃ | Br | t-Bu | CH₃ | F | Br |
| n-Pr | CH₃ | Cl | Cl | Me | Cl | H | Br | Me | Cl | Cl | Br |
| n-Bu | CH₃ | Cl | Cl | Et | Cl | B | Br | Et | Cl | Cl | Br |
| s-Bu | CH₃ | Cl | Cl | i-Pr | Cl | H | Br | i-Pr | Cl | Cl | Br |
| i-Bu | CH₃ | Cl | Cl | t-Bu | Cl | B | Br | t-Bu | Cl | Cl | Br |
| Me | Cl | I | Br | Me | Cl | H | Cl | Me | Cl | Cl | Cl |
| Et | Cl | I | Br | Et | Cl | H | Cl | Et | Cl | Cl | Cl |
| i-Pr | Cl | I | Br | i-Pr | Cl | H | Cl | i-Pr | Cl | Cl | Cl |
| t-Bu | Cl | I | Br | t-Bu | Cl | H | Cl | t-Bu | Cl | Cl | Cl |
| Me | Cl | I | Cl | Me | Cl | Cl | Br | Me | Cl | I | Br |
| Et | Cl | I | Cl | Et | Cl | Cl | Br | Et | Cl | I | Br |
| i-Pr | Cl | I | Cl | i-Pr | Cl | Cl | Br | i-Pr | Cl | I | Br |
| t-Bu | Cl | I | Cl | t-Bu | Cl | Cl | Br | t-Bu | Cl | I | Br |
| Me | Cl | H | Br | Me | Cl | Cl | Cl | Me | Cl | I | Cl |
| Et | Cl | H | Br | Et | Cl | Cl | Cl | Et Cl | I | Cl | |
| i-Pr | Cl | H | Br | i-Pr | Cl | Cl | Cl | i-Pr | Cl | I | Cl |
| t-Bu | Cl | H | Br | t-Bu | Cl | Cl | Cl | t-Bu | Cl | I | Cl |
| Me | Cl | H | Cl | Me | Cl | F | Br | Me | Cl | F | Br |
| Et | Cl | H | Cl | Et | Cl | F | Br | Et | Cl | F | Br |
| i-Pr | Cl | H | Cl | i-Pr | Cl | F | Br | i-Pr | Cl | F | Br |
| t-Bu | Cl | H | Cl | t-Bu | Cl | F | Br | t-Bu | Cl | F | Br |
| Me | Cl | CH₃ | Br | Me | Cl | F | Cl | Me | Cl | F | Cl |
| Et | Cl | CH₃ | Br | Et | Cl | F | Cl | Et Cl | F | Cl | |
| i-Pr | Cl | CH₃ | Br | i-Pr | Cl | F | Cl | i-Pr | Cl | F | Cl |
| t-Bu | Cl | CH₃ | Br | t-Bu | Cl | F | Cl | t-Bu | Cl | F | Cl |
| Me | Cl | CH₃ | Cl | Me | Cl | Br | Br | Me | Cl | H | Br |
| Et | Cl | CH₃ | Cl | Et | Cl | Br | Br | Et | Cl | H | Br |
| i-Pr | Cl | CH₃ | Cl | i-Pr | Cl | Br | Br | i-Pr | Cl | H | Br |
| t-Bu | Cl | CH₃ | Cl | t-Bu | Cl | Br | Br | t-Bu | Cl | H | Br |
| Me | Cl | Br | Br | Me | Cl | I | Cl | Me | Cl | H | Cl |
| Et | Cl | Br | Br | Et | Cl | I | Cl | Et | Cl | H | Cl |
| i-Pr | Cl | Br | Br | i-Pr | Cl | I | Cl | i-Pr | Cl | H | Cl |
| t-Bu | Cl | Br | Br | t-Bu | Cl | I | Cl | i-Pr | Cl | H | Cl |
| Me | Cl | Br | Cl | Me | Cl | I | Br | Me | Cl | CH₃ | Br |
| Et | Cl | Br | Cl | Et | Cl | I | Br | Et Cl | CH₃ | Br | |
| i-Pr | Cl | Br | Cl | i-Pr | Cl | I | Br | i-Pr | Cl | CH₃ | Br |
| t-Bu | Cl | Br | Cl | t-Bu | Cl | I | Br | t-Bu | Cl | CH₃ | Br |
| Me | Cl | F | Br | Me | Cl | CH₃ | Cl | Me | Cl | CH₃ | Cl |
| Et | Cl | F | Br | Et | Cl | CH₃ | Cl | Et Cl | CH₃ | Cl | |
| i-Pr | Cl | F | Br | i-Pr | Cl | CH₃ | Cl | i-Pr | Cl | CH₃ | Cl |
| t-Bu | Cl | F | Br | t-Bu | Cl | CH₃ | Cl | t-Bu | Cl | CH₃ | Cl |
| Me | Cl | Cl | Cl | Me | Cl | CH₃ | Br | Me | Br | F | Cl |
| Et | Cl | Cl | Cl | Et | Cl | CH₃ | Br | Et Br | F | Cl | |
| i-Pr | Cl | Cl | Cl | i-Pr | Cl | CH₃ | Br | i-Pr | Br | F | Cl |
| t-Bu | Cl | Cl | Cl | t-Bu | Cl | CH₃ | Br | t-Bu | Br | F | Cl |
| Me | Cl | F | Cl | n-Pr | Cl | Cl | Cl | Me | Br | F | Br |
| Et | Cl | F | Cl | n-Bu | Cl | Cl | Cl | Et | Br | F | Br |
| i-Pr | Cl | F | Cl | s-Bu | Cl | Cl | Cl | i-Pr | Br | F | Br |
| t-Bu | Cl | F | Cl | i-Bu | Cl | Cl | Cl | t-Bu | Br | F | Br |
| Me | Br | Br | Cl | Me | Br | F | Cl | Me | Br | Cl | Cl |
| Et | Br | Br | Cl | Et | Br | F | Cl | Et | Br | Cl | Cl |
| i-Pr | Br | Br | Cl | i-Pr | Br | F | Cl | i-Pr | Br | Cl | Cl |
| t-Bu | Br | Br | Cl | t-Bu | Br | F | Cl | t-Bu | Br | Cl | Cl |
| Me | Br | Br | Br | Me | Br | F | Br | Me | Br | Cl | Br |
| Et | Br | Br | Br | Et | Br | F | Br | Et | Br | Cl | Br |
| i-Pr | Br | Br | Br | i-Pr | Br | F | Br | i-Pr | Br | Cl | Br |
| t-Bu | Br | Br | Br | t-Bu | Br | F | Br | t-Bu | Br | Cl | Br |
| Me | Br | I | Cl | Me | Br | Cl | Cl | Me | Br | Br | Cl |
| Et | Br | I | Cl | Et | Br | Cl | Cl | Et | Br | Br | Cl |
| i-Pr | Br | I | Cl | i-Pr | Br | Cl | Cl | i-Pr | Br | Br | Cl |
| t-Bu | Br | I | Cl | t-Bu | Br | Cl | Cl | t-Bu | Br | Br | Cl |
| Me | Br | I | Br | Me | Br | Cl | Br | Me | Br | Br | Br |
| Et | Br | I | Br | Et | Br | Cl | Br | Et | Br | Br | Br |
| i-Pr | Br | I | Br | i-Pr | Br | Cl | Br | i-Pr | Br | Br | Br |
| t-Bu | Br | I | Br | t-Bu | Br | Cl | Br | t-Bu | Br | Br | Br |
| Me | Br | F | Cl | Me | Br | I | Cl | Me | Br | CH₃ | Cl |
| Et | Br | F | Cl | Et | Br | I | Cl | Et | Br | CH₃ | Cl |
| i-Pr | Br | F | Cl | i-Pr | Br | I | Cl | i-Pr | Br | CH₃ | Cl |
| t-Bu | Br | F | Cl | t-Bu | Br | I | Cl | t-Bu | Br | CH₃ | Cl |
| Me | Br | F | Br | Me | Br | I | Br | Me | Br | CH₃ | Br |
| Et | Br | F | Br | Et | Br | I | Br | Et | Br | CH₃ | Br |
| i-Pr | Br | F | Br | i-Pr | Br | I | Br | i-Pr | Br | CH₃ | Br |
| t-Bu | Br | F | Br | t-Bu | Br | I | Br | t-Bu | Br | CH₃ | Br |
| Me | Br | Cl | Cl | Me | Br | Br | Cl | Me | Br | I | Cl |
| Et | Br | Cl | Cl | Et | Br | Br | Cl | Et | Br | I | Cl |
| i-Pr | Br | Cl | Cl | i-Pr | Br | Br | Cl | i-Pr | Br | I | Cl |
| t-Bu | Br | Cl | Cl | t-Bu | Br | Br | Cl | t-Bu | Br | I | Cl |
| Me | Br | Cl | Br | Me | Br | Br | Br | Me | Br | I | Br |
| Et | Br | Cl | Br | Et | Br | Br | Br | Et | Br | I | Br |
| i-Pr | Br | Cl | Br | i-Pr | Br | Br | Br | i-Pr | Br | I | Br |
| t-Bu | Br | Cl | Br | t-Bu | Br | Br | Br | t-Bu | Br | I | Br |

TABLE 22

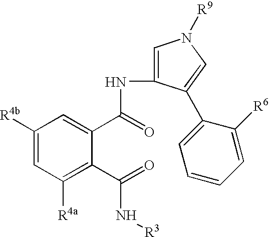

| R⁹ is CHF₂ | | | | R⁹ is CH₂CF₃ | | | | R⁹ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | H | Cl |
| Et | CH₃ | H | Cl | Et | CH₃ | H | Cl | Et | CH₃ | H | Cl |
| i-Pr | CH₃ | H | Cl | i-Pr | CH₃ | H | Cl | i-Pr | CH₃ | H | Cl |
| t-Bu | CH₃ | H | Cl | t-Bu | CH₃ | H | Cl | t-Bu | CH₃ | H | Cl |
| Me | CH₃ | H | Br | Me | CH₃ | H | Br | Me | CH₃ | H | Br |
| Et | CH₃ | H | Br | Et | CH₃ | H | Br | Et | CH₃ | H | Br |
| i-Pr | CH₃ | H | Br | i-Pr | CH₃ | H | Br | i-Pr | CH₃ | H | Br |
| t-Bu | CH₃ | H | Br | t-Bu | CH₃ | H | Br | t-Bu | CH₃ | H | Br |
| Me | CH₃ | F | Cl | Me | CH₃ | F | Cl | Me | CH₃ | F | Cl |
| Et | CH₃ | F | Cl | Et | CH₃ | F | Cl | Et | CH₃ | F | Cl |
| i-Pr | CH₃ | F | Cl | i-Pr | CH₃ | F | Cl | i-Pr | CH₃ | F | Cl |
| t-Bu | CH₃ | F | Cl | t-Bu | CH₃ | F | Cl | t-Bu | CH₃ | F | Cl |
| Me | CH₃ | F | Br | Me | CH₃ | F | Br | Me | CH₃ | F | Br |
| Et | CH₃ | F | Br | Et | CH₃ | F | Br | Et | CH₃ | F | Br |
| i-Pr | CH₃ | F | Br | i-Pr | CH₃ | F | Br | i-Pr | CH₃ | F | Br |
| t-Bu | CH₃ | F | Br | t-Bu | CH₃ | F | Br | t-Bu | CH₃ | F | Br |
| Me | CH₃ | Cl | Cl | Me | CH₃ | Cl | Cl | Me | CH₃ | Cl | Cl |
| Et | CH₃ | Cl | Cl | Et | CH₃ | Cl | Cl | Et | CH₃ | Cl | Cl |
| i-Pr | CH₃ | Cl | Cl | i-Pr | CH₃ | Cl | Cl | i-Pr | CH₃ | Cl | Cl |
| t-Bu | CH₃ | Cl | Cl | t-Bu | CH₃ | Cl | Cl | t-Bu | CH₃ | Cl | Cl |
| Me | CH₃ | Cl | Br | Me | CH₃ | Cl | Br | Me | CH₃ | Cl | Br |
| Et | CH₃ | Cl | Br | Et | CH₃ | Cl | Br | Et | CH₃ | Cl | Br |
| i-Pr | CH₃ | Cl | Br | i-Pr | CH₃ | Cl | Br | i-Pr | CH₃ | Cl | Br |
| t-Bu | CH₃ | Cl | Br | t-Bu | CH₃ | Cl | Br | t-Bu | CH₃ | Cl | Br |
| Me | CH₃ | Br | Cl | Me | CH₃ | Br | Cl | Me | CH₃ | Br | Cl |
| Et | CH₃ | Br | Cl | Et | CH₃ | Br | Cl | Et | CH₃ | Br | Cl |
| i-Pr | CH₃ | Br | Cl | i-Pr | CH₃ | Br | Cl | i-Pr | CH₃ | Br | Cl |
| t-Bu | CH₃ | Br | Cl | t-Bu | CH₃ | Br | Cl | t-Bu | CH₃ | Br | Cl |
| Me | CH₃ | Br | Br | Me | CH₃ | Br | Br | Me | CH₃ | Br | Br |
| Et | CH₃ | Br | Br | Et | CH₃ | Br | Br | Et | CH₃ | Br | Br |
| i-Pr | CH₃ | Br | Br | i-Pr | CH₃ | Br | Br | i-Pr | CH₃ | Br | Br |
| t-Bu | CH₃ | Br | Br | t-Bu | CH₃ | Br | Br | t-Bu | CH₃ | Br | Br |
| Me | CH₃ | I | Cl | Me | CH₃ | I | Cl | Me | CH₃ | I | Cl |
| Et | CH₃ | I | Cl | Et | CH₃ | I | Cl | Et | CH₃ | I | Cl |
| i-Pr | CH₃ | I | Cl | i-Pr | CH₃ | I | Cl | i-Pr | CH₃ | I | Cl |
| t-Bu | CH₃ | I | Cl | t-Bu | CH₃ | I | Cl | t-Bu | CH₃ | I | Cl |
| Me | CH₃ | I | Br | Me | CH₃ | I | Br | Me | CH₃ | I | Br |
| Et | CH₃ | I | Br | Et | CH₃ | I | Br | Et | CH₃ | I | Br |
| i-Pr | CH₃ | I | Br | i-Pr | CH₃ | I | Br | i-Pr | CH₃ | I | Br |
| t-Bu | CH₃ | I | Br | t-Bu | CH₃ | I | Br | t-Bu | CH₃ | I | Br |
| Me | CH₃ | CF₃ | Cl | Me | CH₃ | CF₃ | Cl | Me | CH₃ | CF₃ | Cl |
| Et | CH₃ | CF₃ | Cl | Et | CH₃ | CF₃ | Cl | Et | CH₃ | CF₃ | Cl |
| i-Pr | CH₃ | CF₃ | Cl | i-Pr | CH₃ | CF₃ | Cl | i-Pr | CH₃ | CF₃ | Cl |
| t-Bu | CH₃ | CF₃ | Cl | t-Bu | CH₃ | CF₃ | Cl | t-Bu | CH₃ | CF₃ | Cl |
| Me | CH₃ | CF₃ | Br | Me | CH₃ | CF₃ | Br | Me | CH₃ | CF₃ | Br |
| Et | CH₃ | CF₃ | Br | Et | CH₃ | CF₃ | Br | Et | CH₃ | CF₃ | Br |
| i-Pr | CH₃ | CF₃ | Br | i-Pr | CH₃ | CF₃ | Br | i-Pr | CH₃ | CF₃ | Br |
| t-Bu | CH₃ | CF₃ | Br | t-Bu | CH₃ | CF₃ | Br | t-Bu | CH₃ | CF₃ | Br |
| n-Pr | CH₃ | Cl | Cl | Me | Cl | F | Br | Me | Cl | H | Br |
| n-Bu | CH₃ | Cl | Cl | Et | Cl | F | Br | Et | Cl | B | Br |
| s-Bu | CH₃ | Cl | Cl | i-Pr | Cl | F | Br | i-Pr | Cl | B | Br |
| i-Bu | CH₃ | Cl | Cl | t-Bu | Cl | F | Br | t-Bu | Cl | H | Br |
| Me | Cl | F | Cl | Me | Cl | F | Cl | Me | Cl | H | Cl |
| Et | Cl | F | Cl | Et | Cl | F | Cl | Et | Cl | H | Cl |
| i-Pr | Cl | F | Cl | i-Pr | Cl | F | Cl | i-Pr | Cl | B | Cl |
| t-Bu | Cl | F | Cl | t-Bu | Cl | F | Cl | i-Pr | Cl | H | Cl |
| Me | Cl | F | Br | Me | Cl | Cl | Br | Me | Cl | I | Br |
| Et | Cl | F | Br | Et | Cl | Cl | Br | Et | Cl | I | Br |
| i-Pr | Cl | F | Br | i-Pr | Cl | Cl | Br | i-Pr | Cl | I | Br |
| t-Bu | Cl | F | Br | t-Bu | Cl | Cl | Br | t-Bu | Cl | I | Br |
| Me | Cl | Cl | Cl | Me | Cl | Cl | Cl | Me | Cl | I | Cl |
| Et | Cl | Cl | Cl | Et | Cl | Cl | Cl | Et | Cl | I | Cl |
| i-Pr | Cl | Cl | Cl | i-Pr | Cl | Cl | Cl | i-Pr | Cl | I | Cl |
| t-Bu | Cl | Cl | Cl | t-Bu | Cl | Cl | Cl | t-Bu | Cl | I | Cl |
| Me | Cl | H | Br | Me | Cl | H | Br | Me | Cl | F | Br |
| Et | Cl | H | Br | Et | Cl | H | Br | Et | Cl | F | Br |
| i-Pr | Cl | H | Br | i-Pr | Cl | H | Br | i-Pr | Cl | F | Br |
| t-Bu | Cl | H | Br | t-Bu | Cl | H | Br | t-Bu | Cl | F | Br |
| Me | CL | H | Cl | Me | Cl | H | Cl | Me | Cl | F | Cl |
| Et | Cl | H | Cl | Et | Cl | H | Cl | Et | Cl | F | Cl |
| i-Pr | Cl | H | Cl | i-Pr | Cl | H | Cl | i-Pr | Cl | F | Cl |
| t-Bu | Cl | H | Cl | t-Bu | Cl | H | Cl | t-Bu | Cl | F | Cl |
| Me | Cl | Br | Br | Me | Cl | Br | Br | Me | Cl | CF₃ | Br |
| Et | Cl | Br | Br | Et | Cl | Br | Br | Et | Cl | CF₃ | Br |
| i-Pr | Cl | Br | Br | i-Pr | Cl | Br | Br | i-Pr | Cl | CF₃ | Br |
| t-Bu | Cl | Br | Br | t-Bu | Cl | Br | Br | t-Bu | Cl | CF₃ | Br |
| Me | Cl | Br | Cl | Me | Cl | I | Cl | Me | Cl | CF₃ | Cl |
| Et | Cl | Br | Cl | Et | Cl | I | Cl | Et | Cl | CF₃ | Cl |
| i-Pr | Cl | Br | Cl | i-Pr | Cl | I | Cl | i-Pr | Cl | CF₃ | Cl |
| t-Bu | Cl | Br | Cl | t-Bu | Cl | I | Cl | t-Bu | Cl | CF₃ | Cl |
| Me | Cl | I | Br | Me | Cl | I | Br | Me | Br | F | Cl |
| Et | Cl | I | Br | Et | Cl | I | Br | Et | Br | F | Cl |
| i-Pr | Cl | I | Br | i-Pr | Cl | I | Br | i-Pr | Br | F | Cl |
| t-Bu | Cl | I | Br | t-Bu | Cl | I | Br | t-Bu | Br | F | Cl |
| Me | Cl | I | Cl | Me | Cl | CF₃ | Cl | Me | Br | F | Br |
| Et | Cl | I | Cl | Et | Cl | CF₃ | Cl | Et | Br | F | Br |
| i-Pr | Cl | I | Cl | i-Pr | Cl | CF₃ | Cl | i-Pr | Br | F | Br |
| t-Bu | Cl | I | Cl | t-Bu | CL | CF₃ | Cl | t-Bu | Br | F | Br |
| Me | Cl | CF₃ | Br | Me | Cl | CF₃ | Br | Me | Br | Cl | CL |
| Et | Cl | CF₃ | Br | Et | Cl | CF₃ | Br | Et | Br | Cl | Cl |
| i-Pr | Cl | CF₃ | Br | i-Pr | Cl | CF₃ | Br | i-Pr | Br | Cl | Cl |
| t-Bu | Cl | CF₃ | Br | t-Bu | Cl | CF₃ | Br | t-Bu | Br | Cl | Cl |
| Me | Cl | CF₃ | Cl | n-Pr | Cl | Cl | Cl | Me | Br | Cl | Br |
| Et | Cl | CF₃ | Cl | n-Bu | Cl | Cl | Cl | Et | Br | Cl | Br |
| i-Pr | Cl | CF₃ | Cl | s-Bu | Cl | Cl | Cl | i-Pr | Br | Cl | Br |
| t-Bu | Cl | CF₃ | Cl | i-Bu | Cl | Cl | Cl | t-Bu | Br | Cl | Br |
| Me | Br | F | Cl | Me | Br | F | Cl | Me | Br | Br | Cl |
| Et | Br | F | Cl | Et | Br | F | Cl | Et | Br | Br | Cl |
| i-Pr | Br | F | Cl | i-Pr | Br | F | Cl | i-Pr | Br | Br | Cl |
| t-Bu | Br | F | Cl | t-Bu | Br | F | Cl | t-Bu | Br | Br | Cl |
| Me | Br | F | Br | Me | Br | F | Br | Me | Br | Br | Br |
| Et | Br | F | Br | Et | Br | F | Br | Et | Br | Br | Br |
| i-Pr | Br | F | Br | i-Pr | Br | F | Br | i-Pr | Br | Br | Br |
| t-Bu | Br | F | Br | t-Bu | Br | F | Br | t-Bu | Br | Br | Br |
| Me | Br | Cl | Cl | Me | Br | Cl | Cl | Me | Br | I | Cl |
| Et | Br | Cl | Cl | Et | Br | Cl | Cl | Et | Br | I | Cl |
| i-Pr | Br | Cl | Cl | i-Pr | Br | Cl | Cl | i-Pr | Br | I | Cl |
| t-Bu | Br | Cl | Cl | t-Bu | Br | Cl | Cl | t-Bu | Br | I | Cl |
| Me | Br | Cl | Br | Me | Br | Cl | Br | Me | Br | I | Br |
| Et | Br | Cl | Br | Et | Br | Cl | Br | Et | Br | I | Br |
| i-Pr | Br | Cl | Br | i-Pr | Br | Cl | Br | i-Pr | Br | I | Br |
| t-Bu | Br | Cl | Br | t-Bu | Br | Cl | Br | t-Bu | Br | I | Br |
| Me | Br | Br | Cl | Me | Br | Br | Cl | Me | Br | CF₃ | Cl |
| Et | Br | Br | Cl | Et | Br | Br | Cl | Et | Br | CF₃ | Cl |
| i-Pr | Br | Br | Cl | i-Pr | Br | Br | Cl | i-Pr | Br | CF₃ | Cl |
| t-Bu | Br | Br | Cl | t-Bu | Br | Br | Cl | t-Bu | Br | CF₃ | Cl |
| Me | Br | Br | Br | Me | Br | Br | Br | Me | Br | CF₃ | Br |
| Et | Br | Br | Br | Et | Br | Br | Br | Et | Br | CF₃ | Br |
| i-Pr | Br | Br | Br | i-Pr | Br | Br | Br | i-Pr | Br | CF₃ | Br |
| t-Bu | Br | Br | Br | t-Bu | Br | Br | Br | t-Bu | Br | CF₃ | Br |
| Me | Br | I | Cl | Me | Br | I | Cl | Me | Cl | Cl | Br |
| Et | Br | I | Cl | Et | Br | I | Cl | Et | Cl | Cl | Br |
| i-Pr | Br | I | Cl | i-Pr | Br | I | Cl | i-Pr | Cl | Cl | Br |
| t-Bu | Br | I | Cl | t-Bu | Br | I | Cl | t-Bu | Cl | Cl | Br |
| Me | Br | I | Br | Me | Br | I | Br | Me | Cl | Cl | Cl |
| Et | Br | I | Br | Et | Br | I | Br | Et | Cl | Cl | Cl |
| i-Pr | Br | I | Br | i-Pr | Br | I | Br | i-Pr | Cl | Cl | Cl |
| t-Bu | Br | I | Br | t-Bu | Br | I | Br | t-Bu | Cl | Cl | Cl |

TABLE 23

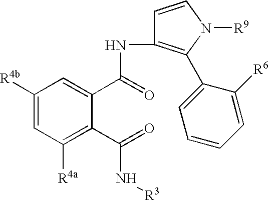

| R⁹ is CHF₂ | | | | R⁹ is CH₂CF₃ | | | | R⁹ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | H | Cl |
| Et | CH₃ | H | Cl | Et | CH₃ | H | Cl | Et | CH₃ | H | Cl |
| i-Pr | CH₃ | H | Cl | i-Pr | CH₃ | H | Cl | i-Pr | CH₃ | H | Cl |
| t-Bu | CH₃ | H | Cl | t-Bu | CH₃ | H | Cl | t-Bu | CH₃ | H | Cl |
| Me | CH₃ | H | Br | Me | CH₃ | H | Br | Me | CH₃ | H | Br |
| Et | CH₃ | H | Br | Et | CH₃ | H | Br | Et | CH₃ | H | Br |
| i-Pr | CH₃ | H | Br | i-Pr | CH₃ | H | Br | i-Pr | CH₃ | H | Br |
| t-Bu | CH₃ | H | Br | t-Bu | CH₃ | H | Br | t-Bu | CH₃ | H | Br |
| Me | CH₃ | F | Cl | Me | CH₃ | F | Cl | Me | CH₃ | F | Cl |
| Et | CH₃ | F | Cl | Et | CH₃ | F | Cl | Et | CH₃ | F | Cl |
| i-Pr | CH₃ | F | Cl | i-Pr | CH₃ | F | Cl | i-Pr | CH₃ | F | Cl |
| t-Bu | CH₃ | F | Cl | t-Bu | CH₃ | F | Cl | t-Bu | CH₃ | F | Cl |
| Me | CH₃ | F | Br | Me | CH₃ | F | Br | Me | CH₃ | F | Br |
| Et | CH₃ | F | Br | Et | CH₃ | F | Br | Et | CH₃ | F | Br |
| i-Pr | CH₃ | F | Br | i-Pr | CH₃ | F | Br | i-Pr | CH₃ | F | Br |
| t-Bu | CH₃ | F | Br | t-Bu | CH₃ | F | Br | t-Bu | CH₃ | F | Br |
| Me | CH₃ | Cl | Cl | Me | CH₃ | Cl | Cl | Me | CH₃ | Cl | Cl |
| Et | CH₃ | Cl | Cl | Et | CH₃ | Cl | Cl | Et | CH₃ | Cl | Cl |
| i-Pr | CH₃ | Cl | Cl | i-Pr | CH₃ | Cl | Cl | i-Pr | CH₃ | Cl | Cl |
| t-Bu | CH₃ | Cl | Cl | t-Bu | CH₃ | Cl | Cl | t-Bu | CH₃ | Cl | Cl |
| Me | CH₃ | Cl | Br | Me | CH₃ | Cl | Br | Me | CH₃ | Cl | Br |
| Et | CH₃ | Cl | Br | Et | CH₃ | Cl | Br | Et | CH₃ | Cl | Br |
| i-Pr | CH₃ | Cl | Br | i-Pr | CH₃ | Cl | Br | i-Pr | CH₃ | Cl | Br |
| t-Bu | CH₃ | Cl | Br | t-Bu | CH₃ | Cl | Br | t-Bu | CH₃ | Cl | Br |
| Me | CH₃ | Br | Cl | Me | CH₃ | Br | Cl | Me | CH₃ | Br | Cl |
| Et | CH₃ | Br | Cl | Et | CH₃ | Br | Cl | Et | CH₃ | Br | Cl |
| i-Pr | CH₃ | Br | Cl | i-Pr | CH₃ | Br | Cl | i-Pr | CH₃ | Br | Cl |
| t-Bu | CH₃ | Br | Cl | t-Bu | CH₃ | Br | Cl | t-Bu | CH₃ | Br | Cl |
| Me | CH₃ | Br | Br | Me | CH₃ | Br | Br | Me | CH₃ | Br | Br |
| Et | CH₃ | Br | Br | Et | CH₃ | Br | Br | Et | CH₃ | Br | Br |
| i-Pr | CH₃ | Br | Br | i-Pr | CH₃ | Br | Br | i-Pr | CH₃ | Br | Br |
| t-Bu | CH₃ | Br | Br | t-Bu | CH₃ | Br | Br | t-Bu | CH₃ | Br | Br |
| Me | CH₃ | I | Cl | Me | CH₃ | I | Cl | Me | CH₃ | I | Cl |
| Et | CH₃ | I | Cl | Et | CH₃ | I | Cl | Et | CH₃ | I | Cl |
| i-Pr | Cil3 | I | Cl | iPr | CH₃ | I | Cl | i-Pr | CH_{3 I} | Cl | |
| t-Bu | CH₃ | I | Cl | t-Bu | CH₃ | I | Cl | t-Bu | CH_{3 I} | Cl | |
| Me | CH₃ | I | Br | Me | CH₃ | I | Br | Me | CH₃ | I | Br |
| Et | CH₃ | I | Br | Et | CH₃ | I | Br | Et | CH₃ | I | Br |
| i-Pr | CH₃ | I | Br | i-Pr | CH₃ | I | Br | i-Pr | CH₃ | I | Br |
| t-Bu | CH₃ | I | Br | t-Bu | CH₃ | I | Br | t-Bu | CH₃ | I | Br |
| Me | CH₃ | CF₃ | Cl | Me | CH₃ | CF₃ | Cl | Me | CH₃ | CF₃ | Cl |
| Et | CH₃ | CF₃ | Cl | Et | CH₃ | CF₃ | Cl | Et | CH₃ | CF₃ | Cl |
| i-Pr | CH₃ | CF₃ | Cl | i-Pr | CH₃ | CF₃ | Cl | i-Pr | CH₃ | CF₃ | Cl |
| t-Bu | CH₃ | CF₃ | Cl | t-Bu | CH₃ | CF₃ | Cl | t-Bu | CH₃ | CF₃ | Cl |
| Me | CH₃ | CF₃ | Br | Me | CH₃ | CF₃ | Br | Me | CH₃ | CF₃ | Br |
| Et | CH₃ | CF₃ | Br | Et | CH₃ | CF₃ | Br | Et | CH₃ | CF₃ | Br |
| i-Pr | CH₃ | CF₃ | Br | i-Pr | CH₃ | CF₃ | Br | i-Pr | CH₃ | CF₃ | Br |
| t-Bu | CH₃ | CF₃ | Br | t-Bu | CH₃ | CF₃ | Br | t-Bu | CH₃ | CF₃ | Br |
| n-Pr | CH₃ | Cl | Cl | Me | Cl | F | Br | Me | Cl | H | Br |
| n-Bu | CH₃ | Cl | Cl | Et | Cl | F | Br | Et | Cl | H | Br |
| s-Bu | CH₃ | Cl | Cl | i-Pr | Cl | F | Br | i-Pr | Cl | H | Br |
| z-Bu | CH₃ | Cl | Cl | t-Bu | Cl | F | Br | t-Bu | Cl | H | Br |
| Me | Cl | F | Cl | Me | Cl | F | Cl | Me | Cl | H | Cl |
| Et | Cl | F | Cl | Et | Cl | F | Cl | Et | Cl | H | Cl |
| i-Pr | Cl | F | Cl | i-Pr | Cl | F | Cl | i-Pr | Cl | H | Cl |
| t-Bu | Cl | F | Cl | t-Bu | Cl | F | Cl | i-Pr | Cl | H | Cl |
| Me | Cl | F | Br | Me | Cl | Cl | Br | Me | Cl | I | Br |
| Et | Cl | F | Br | Et | Cl | Cl | Br | Et | Cl | I | Br |
| i-Pr | Cl | F | Br | i-Pr | Cl | Cl | Br | i-Pr | Cl | I | Br |
| t-Bu | Cl | F | Br | t-Bu | Cl | Cl | Br | t-Bu | Cl | I | Br |
| Me | Cl | Cl | Cl | Me | Cl | Cl | Cl | Me | Cl | I | Cl |
| Et | Cl | Cl | Cl | Et | Cl | Cl | Cl | Et | Cl | I | Cl |
| i-Pr | Cl | Cl | Cl | i-Pr | Cl | Cl | Cl | i-Pr | Cl | I | Cl |
| t-Bu | Cl | Cl | Cl | t-Bu | Cl | Cl | Cl | t-Bu | Cl | I | Cl |
| Me | Cl | H | Br | Me | Cl | H | Br | Me | Cl | F | Br |
| Et | Cl | H | Br | Et | Cl | H | Br | Et | Cl | F | Br |
| i-Pr | Cl | H | Br | i-Pr | Cl | H | Br | i-Pr | Cl | F | Br |
| t-Bu | Cl | H | Br | t-Bu | Cl | H | Br | t-Bu | Cl | F | Br |
| Me | Cl | H | Cl | Me | Cl | H | Cl | Me | Cl | F | Cl |
| Et | Cl | H | Cl | Et | Cl | H | Cl | Et | Cl | F | Cl |
| i-Pr | Cl | H | Cl | i-Pr | Cl | H | Cl | i-Pr | Cl | F | Cl |
| t-Bu | Cl | H | Cl | t-Bu | Cl | H | Cl | t-Bu | Cl | F | Cl |
| Me | Cl | Br | Br | Me | Cl | Br | Br | Me | Cl | CF₃ | Br |
| Et | Cl | Br | Br | Et | Cl | Br | Br | Et | Cl | CF₃ | Br |
| i-Pr | Cl | Br | Br | i-Pr | Cl | Br | Br | i-Pr | Cl | CF₃ | Br |
| t-Bu | Cl | Br | Br | t-Bu | Cl | Br | Br | t-Bu | Cl | CF₃ | Br |
| Me | Cl | Br | Cl | Me | Cl | I | Cl | Me | Cl | CF₃ | Cl |
| Et | Cl | Br | Cl | Et | Cl | I | Cl | Et | Cl | CF₃ | Cl |
| i-Pr | Cl | Br | Cl | i-Pr | Cl | I | Cl | i-Pr | Cl | CF₃ | Cl |
| t-Bu | Cl | Br | Cl | t-Bu | Cl | I | Cl | t-Bu | Cl | CF₃ | Cl |
| Me | Cl | I | Br | Me | Cl | I | Br | Me | Br | F | Cl |
| Et | Cl | I | Br | Et | Cl | I | Br | Et | Br | F | Cl |
| i-Pr | Cl | I | Br | i-Pr | Cl | I | Br | i-Pr | Br | F | Cl |
| t-Bu | Cl | I | Br | t-Bu | Cl | I | Br | t-Bu | Br | F | Cl |
| Me | Cl | I | Cl | Me | Cl | CF₃ | Cl | Me | Br | F | Br |
| Et | Cl | I | Cl | Et | Cl | CF₃ | Cl | Et | Br | F | Br |
| i-Pr | Cl | I | Cl | i-Pr | Cl | CF₃ | Cl | i-Pr | Br | F | Br |
| t-Bu | Cl | I | Cl | t-Bu | Cl | CF₃ | Cl | t-Bu | Br | F | Br |
| Me | Cl | CF₃ | Br | Me | Cl | CF₃ | Br | Me | Br | Cl | Cl |
| Et Cl | CF₃ | Br | Et | Cl | CF₃ | Br | Et | Br | Cl | Cl | |
| i-Pr | Cl | CF₃ | Br | i-Pr | Cl | CF₃ | Br | i-Pr | Br | Cl | Cl |
| t-Bu | Cl | CF₃ | Br | t-Bu | Cl | CF₃ | Br | t-Bu | Br | Cl | Cl |
| Me | Cl | CF₃ | Cl | n-Pr | Cl | Cl | Cl | Me | Br | Cl | Br |
| Et | Cl | CF₃ | Cl | n-Bu | Cl | Cl | Cl | Et | Br | Cl | Br |
| i-Pr | Cl | CF₃ | Cl | s-Bu | Cl | Cl | Cl | i-Pr | Br | Cl | Br |
| t-Bu | Cl | CF₃ | Cl | i-Bu | Cl | Cl | Cl | t-Bu | Br | Cl | Br |
| Me | Br | F | Cl | Me | Br | F | Cl | Me | Br | Br | Cl |
| Et | Br | F | Cl | Et | Br | F | Cl | Et | Br | Br | Cl |
| i-Pr | Br | F | Cl | i-Pr | Br | F | Cl | i-Pr | Br | Br | Cl |
| t-Bu | Br | F | Cl | t-Bu | Br | F | Cl | t-Bu | Br | Br | Cl |
| Me | Br | F | Br | Me | Br | F | Br | Me | Br | Br | Br |
| Et | Br | F | Br | Et | Br | F | Br | Et | Br | Br | Br |
| i-Pr | Br | F | Br | i-Pr | Br | F | Br | i-Pr | Br | Br | Br |
| t-Bu | Br | F | Br | t-Bu | Br | F | Br | t-Bu | Br | Br | Br |
| Me | Br | Cl | Cl | Me | Br | Cl | Cl | Me | Br | I | Cl |
| Et | Br | Cl | Cl | Et | Br | Cl | Cl | Et | Br | I | Cl |
| i-Pr | Br | Cl | Cl | i-Pr | Br | Cl | Cl | i-Pr | Br | I | Cl |
| t-Bu | Br | Cl | Cl | t-Bu | Br | Cl | Cl | t-Bu | Br | I | Cl |
| Me | Br | Cl | Br | Me | Br | Cl | Br | Me | Br | I | Br |
| Et | Br | Cl | Br | Et | Br | Cl | Br | Et | Br | I | Br |
| i-Pr | Br | Cl | Br | i-Pr | Br | Cl | Br | i-Pr | Br | I | Br |
| t-Bu | Br | Cl | Br | t-Bu | Br | Cl | Br | t-Bu | Br | I | Br |
| Me | Br | Br | Cl | Me | Br | Br | Cl | Me | Br | CF₃ | Cl |
| Et | Br | Br | Cl | Et | Br | Br | Cl | Et | Br | CF₃ | Cl |
| i-Pr | Br | Br | Cl | i-Pr | Br | Br | Cl | i-Pr | Br | CF₃ | Cl |
| t-Bu | Br | Br | Cl | t-Bu | Br | Br | Cl | t-Bu | Br | CF₃ | Cl |
| Me | Br | Br | Br | Me | Br | Br | Br | Me | Br | CF₃ | Br |
| Et | Br | Br | Br | Et | Br | Br | Br | Et | Br | CF₃ | Br |
| i-Pr | Br | Br | Br | i-Pr | Br | Br | Br | i-Pr | Br | CF₃ | Br |
| t-Bu | Br | Br | Br | t-Bu | Br | Br | Br | t-Bu | Br | CF₃ | Br |
| Me | Br | I | Cl | Me | Br | I | Cl | Me | Cl | Cl | Br |
| Et | Br | I | Cl | Et | Br | I | Cl | Et | Cl | Cl | Br |
| i-Pr | Br | I | Cl | i-Pr | Br | I | Cl | i-Pr | Cl | Cl | Br |
| t-Bu | Br | I | Cl | t-Bu | Br | I | Cl | t-Bu | Cl | Cl | Br |
| Me | Br | I | Br | Me | Br | I | Br | Me | Cl | Cl | Cl |
| Et | Br | I | Br | Et | Br | I | Br | Et | Cl | Cl | Cl |
| i-Pr | Br | I | Br | i-Pr | Br | I | Br | i-Pr | Cl | Cl | Cl |
| t-Bu | Br | I | Br | t-Bu | Br | I | Br | t-Bu | Cl | Cl | Cl |

TABLE 24

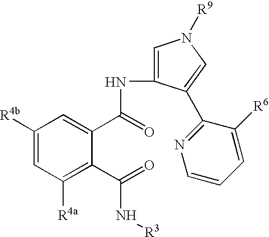

| R⁹ is CHF₂ | | | | R⁹ is CH₂F₃ | | | | R⁹ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | Br | Cl |
| Et | CH₃ | H | Cl | Et | CH₃ | H | Cl | Et | CH₃ | Br | Cl |
| i-Pr | CH₃ | H | Cl | i-Pr | CH₃ | H | Cl | i-Pr | CH₃ | Br | Cl |
| t-Bu | CH₃ | H | Cl | t-Bu | CH₃ | H | Cl | t-Bu | CH₃ | Br | Cl |
| Me | CH₃ | H | Br | Me | CH₃ | H | Br | Me | CH₃ | Br | Br |
| Et | CH₃ | H | Br | Et | CH₃ | H | Br | Et | CH₃ | Br | Br |
| i-Pr | CH₃ | H | Br | i-Pr | CH₃ | H | Br | i-Pr | CH₃ | Br | Br |
| t-Bu | CH₃ | H | Br | t-Bu | CH₃ | H | Br | t-Bu | CH₃ | Br | Br |
| Me | CH₃ | F | Cl | Me | CH₃ | Br | Cl | Me | CH₃ | I | Cl |
| Et | CH₃ | F | Cl | Et | CH₃ | Br | Cl | Et | CH₃ | I | Cl |
| i-Pr | CH₃ | F | Cl | i-Pr | CH₃ | Br | Cl | i-Pr | CH₃ | I | Cl |
| t-Bu | CH₃ | F | Cl | t-Bu | CH₃ | Br | Cl | t-Bu | CH₃ | I | Cl |
| Me | CH₃ | F | Br | Me | CH₃ | Br | Br | Me | CH₃ | I | Br |
| Et | CH₃ | F | Br | Et | CH₃ | Br | Br | Et | CH₃ | I | Br |
| i-Pr | CH₃ | F | Br | i-Pr | CH₃ | Br | Br | i-Pr | CH₃ | I | Br |
| t-Bu | CH₃ | F | Br | t-Bu | CH₃ | Br | Br | t-Bu | CH₃ | I | Br |
| Me | CH₃ | Cl | Cl | Me | CH₃ | F | Cl | Me | CH₃ | CF₃ | Cl |
| Et | CH₃ | Cl | Cl | Et | CH₃ | F | Cl | Et | CH₃ | CF₃ | Cl |
| i-Pr | CH₃ | Cl | Cl | i-Pr | CH₃ | F | Cl | i-Pr | CH₃ | CF₃ | Cl |
| t-Bu | CH₃ | Cl | Cl | t-Bu | CH₃ | F | Cl | t-Bu | CH₃ | CF₃ | Cl |
| Me | CH₃ | Cl | Br | Me | CH₃ | F | Br | Me | CH₃ | CF₃ | Br |
| Et | CH₃ | Cl | Br | Et | CH₃ | F | Br | Et | CH₃ | CF₃ | Br |
| i-Pr | CH₃ | Cl | Br | i-Pr | CH₃ | F | Br | i-Pr | CH₃ | CF₃ | Br |
| t-Bu | CH₃ | Cl | Br | t-Bu | CH₃ | F | Br | t-Bu | CH₃ | CF₃ | Br |
| Me | CH₃ | Br | Cl | Me | CH₃ | Cl | Cl | Me | CH₃ | Cl | Cl |
| Et | CH₃ | Br | Cl | Et | CH₃ | Cl | Cl | Et | CH₃ | Cl | Cl |
| i-Pr | CH₃ | Br | Cl | i-Pr | CH₃ | Cl | Cl | i-Pr | CH₃ | Cl | Cl |
| t-Bu | CH₃ | Br | Cl | t-Bu | CH₃ | Cl | Cl | t-Bu | CH₃ | Cl | Cl |
| Me | CH₃ | Br | Br | Me | CH₃ | Cl | Br | Me | CH₃ | Cl | Br |
| Et | CH₃ | Br | Br | Et | CH₃ | Cl | Br | Et | CH₃ | Cl | Br |
| i-Pr | CH₃ | Br | Br | i-Pr | CH₃ | Cl | Br | i-Pr | CH₃ | Cl | Br |
| t-Bu | CH₃ | Br | Br | t-Bu | CH₃ | Cl | Br | t-Bu | CH₃ | Cl | Br |
| Me | CH₃ | I | Cl | Me | CH₃ | I | Cl | Me | CH₃ | H | Cl |
| Et | CH₃ | I | Cl | Et | CH₃ | I | Cl | Et | CH₃ | H | Cl |
| i-Pr | CH₃ | I | Cl | i-Pr | CH₃ | 1 | Cl | i-Pr | CH₃ | H | Cl |
| t-Bu | CH₃ | I | Cl | t-Bu | CH₃ | I | Cl | t-Bu | CH₃ | H | Cl |
| Me | CH₃ | I | Br | Me | CH₃ | I | Br | Me | CH₃ | H | Br |
| Et | CH₃ | I | Br | Et | CH₃ | I | Br | Et | CH₃ | H | Br |
| i-Pr | CH₃ | I | Br | i-Pr | CH₃ | I | Br | i-Pr | CH₃ | H | Br |
| t-Bu | CH₃ | I | Br | t-Bu | CH₃ | I | Br | t-Bu | CH₃ | H | Br |
| Me | CH₃ | CF₃ | Cl | Me | CH₃ | CF₃ | Cl | Me | CH₃ | F | Cl |
| Et | CH₃ | CF₃ | Cl | Et | CH₃ | CF₃ | Cl | Et | CH₃ | F | Cl |
| i-Pr | CH₃ | CF₃ | Cl | i-Pr | CH₃ | CF₃ | Cl | i-Pr | CH₃ | F | Cl |
| t-Bu | CH₃ | CF₃ | Cl | t-Bu | CH₃ | CF₃ | Cl | t-Bu | CH₃ | F | Cl |
| Me | CH₃ | CF₃ | Br | Me | CH₃ | CF₃ | Br | Me | CH₃ | F | Br |
| Et | CH₃ | CF₃ | Br | Et | CH₃ | CF₃ | Br | Et | CH₃ | F | Br |
| i-Pr | CH₃ | CF₃ | Br | i-Pr | CH₃ | CF₃ | Br | i-Pr | CH₃ | F | Br |
| t-Bu | CH₃ | CF₃ | Br | t-Bu | CH₃ | CF₃ | Br | t-Bu | CH₃ | F | Br |
| n-Pr | CH₃ | Cl | Cl | Me | Cl | H Br | Me | Cl | Cl | Br | |
| n-Bu | CH₃ | Cl | Cl | Et | Cl | H | Br | Et | Cl | Cl | Br |
| s-Bu | CH₃ | Cl | Cl | i-Pr | Cl | H | Br | i-Pr | Cl | Cl | Br |
| z-Bu | CH₃ | Cl | Cl | t-Bu | Cl | H | Br | t-Bu | Cl | Cl | Br |
| Me | Cl | I | Br | Me | Cl | H | Cl | Me | Cl | Cl | Cl |
| Et | Cl | I | Br | Et | Cl | H | Cl | Et | Cl | Cl | Cl |
| i-Pr | Cl | I Br | i-Pr | Cl | H | Cl | i-Pr | Cl | Cl | Cl | |
| t-Bu | Cl | I Br | t-Bu | Cl | H | Cl | t-Bu | Cl | Cl | Cl | |
| Me | Cl | I | Cl | Me | Cl | Cl | Br | Me | Cl | I | Br |
| Et | Cl | I | Cl | Et | Cl | Cl | Br | Et | Cl | I | Br |
| i-Pr | Cl | I | Cl | i-Pr | Cl | Cl | Br | i-Pr | Cl | I | Br |
| t-Bu | Cl | I | Cl | t-Bu | Cl | Cl | Br | t-Bu | Cl | I | Br |
| Me | Cl | H | Br | Me | Cl | Cl | Cl | Me | Cl | I | Cl |
| Et | Cl | H | Br | Et | Cl | Cl | Cl | Et | Cl | I | Cl |
| i-Pr | Cl | H | Br | i-Pr | Cl | Cl | Cl | i-Pr | Cl | I | Cl |
| t-Bu | Cl | H | Br | t-Bu | Cl | Cl | Cl | t-Bu | Cl | I | Cl |
| Me | Cl | H | Cl | Me | Cl | F | Br | Me | Cl | F | Br |
| Et | Cl | H | Cl | Et | Cl | F | Br | Et | Cl | F | Br |
| i-Pr | Cl | H | Cl | i-Pr | Cl | F | Br | i-Pr | Cl | F | Br |
| t-Bu | Cl | H | Cl | t-Bu | Cl | F | Br | t-Bu | Cl | F | Br |
| Me | Cl | CF₃ | Br | Me | Cl | F | Cl | Me | Cl | F | Cl |
| Et | Cl | CF₃ | Br | Et | Cl | F | Cl | Et | Cl | F | Cl |
| i-Pr | Cl | CF₃ | Br | i-Pr | Cl | F | Cl | i-Pr | Cl | F | Cl |
| t-Bu | Cl | CF₃ | Br | t-Bu | Cl | F | Cl | t-Bu | Cl | F | Cl |
| Me | Cl | CF₃ | Cl | Me | Cl | Br | Br | Me | Cl | H | Br |
| Et | Cl | CF₃ | Cl | Et | Cl | Br | Br | Et | Cl | H | Br |
| z-Pr | Cl | CF₃ | Cl | i-Pr | Cl | Br | Br | i-Pr | Cl | H | Br |
| t-Bu | Cl | CF₃ | Cl | t-Bu | Cl | Br | Br | t-Bu | Cl | H | Br |
| Me | Cl | Br | Br | Me | Cl | I | Cl | Me | Cl | H | Cl |
| Et | Cl | Br | Br | Et | Cl | I | Cl | Et | Cl | H | Cl |
| i-Pr | Cl | Br | Br | i-Pr | Cl | I | Cl | i-Pr | Cl | H | Cl |
| t-Bu | Cl | Br | Br | t-Bu | Cl | I | Cl | i-Pr | Cl | H | Cl |
| Me | Cl | Br | Cl | Me | Cl | I | Br | Me | Cl | CF₃ | Br |
| Et | Cl | Br | Cl | Et | Cl | I | Br | Et | Cl | CF₃ | Br |
| i-Pr | Cl | Br | Cl | i-Pr | Cl | I | Br | i-Pr | Cl | CF₃ | Br |
| t-Bu | Cl | Br | Cl | i-Bu | Cl | I | Br | t-Bu | Cl | CF₃ | Br |
| Me | Cl | F | Br | Me | Cl | CF₃ | Cl | Me | Cl | CF₃ | Cl |
| Et | Cl | F | Br | Et | Cl | CF₃ | Cl | Et | Cl | CF₃ | Cl |
| i-Pr | Cl | F | Br | i-Pr | Cl | CF₃ | Cl | i-Pr | Cl | CF₃ | Cl |
| t-Bu | Cl | F | Br | t-Bu | Cl | CF₃ | Cl | t-Bu | Cl | CF₃ | Cl |
| Me | Cl | Cl | Cl | Me | Cl | CF₃ | Br | Me | Br | F | Cl |
| Et | Cl | Cl | Cl | Et | Cl | CF₃ | Br | Et | Br | F | Cl |
| i-Pr | Cl | Cl | Cl | i-Pr | Cl | CF₃ | Br | i-Pr | Br | F | Cl |
| t-Bu | Cl | Cl | Cl | t-Bu | Cl | CF₃ | Br | t-Bu | Br | F | Cl |
| Me | Cl | F | Cl | n-Pr | Cl | Cl | Cl | Me | Br | F | Br |
| Et | Cl | F | Cl | n-Bu | Cl | Cl | Cl | Et | Br | F | Br |
| i-Pr | Cl | F | Cl | s-Bu | Cl | Cl | Cl | i-Pr | Br | F | Br |
| t-Bu | Cl | F | Cl | i-Bu | Cl | Cl | Cl | t-Bu | Br | F | Br |
| Me | Br | Br | Cl | Me | Br | F | Cl | Me | Br | Cl | Cl |
| Et | Br | Br | Cl | Et | Br | F | Cl | Et | Br | Cl | Cl |
| i-Pr | Br | Br | Cl | i-Pr | Br | F | Cl | i-Pr | Br | Cl | Cl |
| t-Bu | Br | Br | Cl | t-Bu | Br | F | Cl | t-Bu | Br | Cl | Cl |
| Me | Br | Br | Br | Me | Br | F | Br | Me | Br | Cl | Br |
| Et | Br | Br | Br | Et | Br | F | Br | Et | Br | Cl | Br |
| i-Pr | Br | Br | Br | i-Pr | Br | F | Br | i-Pr | Br | Cl | Br |
| t-Bu | Br | Br | Br | t-Bu | Br | F | Br | t-Bu | Br | Cl | Br |
| Me | Br | I | Cl | Me | Br | Cl | Cl | Me | Br | Br | Cl |
| Et | Br | I | Cl | Et | Br | Cl | Cl | Et | Br | Br | Cl |
| i-Pr | Br | I | Cl | i-Pr | Br | Cl | Cl | i-Pr | Br | Br | Cl |
| t-Bu | Br | I | Cl | t-Bu | Br | Cl | Cl | t-Bu | Br | Br | Cl |
| Me | Br | I | Br | Me | Br | Cl | Br | Me | Br | Br | Br |
| Et | Br | I | Br | Et | Br | Cl | Br | Et | Br | Br | Br |
| i-Pr | Br | I | Br | i-Pr | Br | Cl | Br | i-Pr | Br | Br | Br |
| t-Bu | Br | I | Br | t-Bu | Br | Cl | Br | t-Bu | Br | Br | Br |
| Me | Br | F | Cl | Me | Br | I | Cl | Me | Br | CF₃ | Cl |
| Et | Br | F | Cl | Et | Br | I | Cl | Et | Br | CF₃ | Cl |
| i-Pr | Br | F | Cl | i-Pr | Br | I | Cl | i-Pr | Br | CF₃ | Cl |
| t-Bu | Br | F | Cl | t-Bu | Br | I | Cl | t-Bu | Br | CF₃ | Cl |
| Me | Br | F | Br | Me | Br | I | Br | Me | Br | CF₃ | Br |
| Et | Br | F | Br | Et | Br | I | Br | Et | Br | CF₃ | Br |
| i-Pr | Br | F | Br | i-Pr | Br | I | Br | i-Pr | Br | CF₃ | Br |
| t-Bu | Br | F | Br | t-Bu | Br | I | Br | t-Bu | Br | CF₃ | Br |
| Me | Br | Cl | Cl | Me | Br | Br | Cl | Me | Br | I | Cl |
| Et | Br | Cl | Cl | Et | Br | Br | Cl | Et | Br | I | Cl |
| i-Pr | Br | Cl | Cl | i-Pr | Br | Br | Cl | i-Pr | Br | I | Cl |
| t-Bu | Br | Cl | Cl | t-Bu | Br | Br | Cl | t-Bu | Br | I | Cl |
| Me | Br | Cl | Br | Me | Br | Br | Br | Me | Br | I | Br |
| Et | Br | Cl | Br | Et | Br | Br | Br | Et | Br | I | Br |
| i-Pr | Br | Cl | Br | i-Pr | Br | Br | Br | i-Pr | Br | I | Br |
| t-Bu | Br | Cl | Br | t-Bu | Br | Br | Br | t-Bu | Br | I | Br |

TABLE 25

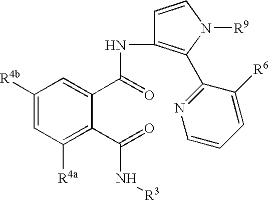

| R⁹ is CHF₂ | | | | R⁹ is CH₂F₃ | | | | R⁹ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | Br | Cl |
| Et | CH₃ | H | Cl | Et | CH₃ | H | Cl | Et | CH₃ | Br | Cl |
| i-Pr | CH₃ | H | Cl | i-Pr | CH₃ | H | Cl | i-Pr | CH₃ | Br | Cl |
| t-Bu | CH₃ | H | Cl | t-Bu | CH₃ | H | Cl | t-Bu | CH₃ | Br | Cl |
| Me | CH₃ | H | Br | Me | CH₃ | H | Br | Me | CH₃ | Br | Br |
| Et | CH₃ | H | Br | Et | CH₃ | H | Br | Et | CH₃ | Br | Br |
| i-Pr | CH₃ | H | Br | i-Pr | CH₃ | H | Br | i-Pr | CH₃ | Br | Br |
| t-Bu | CH₃ | H | Br | t-Bu | CH₃ | H | Br | t-Bu | CH₃ | Br | Br |
| Me | CH₃ | F | Cl | Me | CH₃ | Br | Cl | Me | CH₃ | I | Cl |
| Et | CH₃ | F | Cl | Et | CH₃ | Br | Cl | Et | CH₃ | I | Cl |
| i-Pr | CH₃ | F | Cl | i-Pr | CH₃ | Br | Cl | i-Pr | CH₃ | I | Cl |
| t-Bu | CH₃ | F | Cl | t-Bu | CH₃ | Br | Cl | t-Bu | CH₃ | I | Cl |
| Me | CH₃ | F | Br | Me | CH₃ | Br | Br | Me | CH₃ | I | Br |
| Et | CH₃ | F | Br | Et | CH₃ | Br | Br | Et | CH₃ | I | Br |
| i-Pr | CH₃ | F | Br | i-Pr | CH₃ | Br | Br | i-Pr | CH₃ | I | Br |
| t-Bu | CH₃ | F | Br | t-Bu | CH₃ | Br | Br | t-Bu | CH₃ | I | Br |
| Me | CH₃ | Cl | Cl | Me | CH₃ | F | Cl | Me | CH₃ | CF₃ | Cl |
| Et | CH₃ | Cl | Cl | Et | CH₃ | F | Cl | Et | CH₃ | CF₃ | Cl |
| i-Pr | CH₃ | Cl | Cl | i-Pr | CH₃ | F | Cl | i-Pr | CH₃ | CF₃ | Cl |
| t-Bu | CH₃ | Cl | Cl | t-Bu | CH₃ | F | Cl | t-Bu | CH₃ | CF₃ | Cl |
| Me | CH₃ | Cl | Br | Me | CH₃ | F | Br | Me | CH₃ | CF₃ | Br |
| Et | CH₃ | Cl | Br | Et | CH₃ | F | Br | Et | CH₃ | CF₃ | Br |
| i-Pr | CH₃ | Cl | Br | i-Pr | CH₃ | F | Br | i-Pr | CH₃ | CF₃ | Br |
| t-Bu | CH₃ | Cl | Br | t-Bu | CH₃ | F | Br | t-Bu | CH₃ | CF₃ | Br |
| Me | CH₃ | Br | Cl | Me | CH₃ | Cl | Cl | Me | CH₃ | Cl | Cl |
| Et | CH₃ | Br | Cl | Et | CH₃ | Cl | Cl | Et | CH₃ | Cl | Cl |
| i-Pr | CH₃ | Br | Cl | i-Pr | CH₃ | Cl | Cl | i-Pr | CH₃ | Cl | Cl |
| t-Bu | CH₃ | Br | Cl | t-Bu | CH₃ | Cl | Cl | t-Bu | CH₃ | Cl | Cl |
| Me | CH₃ | Br | Br | Me | CH₃ | Cl | Br | Me | CH₃ | Cl | Br |
| Et | CH₃ | Br | Br | Et | CH₃ | Cl | Br | Et | CH₃ | Cl | Br |
| i-Pr | CH₃ | Br | Br | i-Pr | CH₃ | Cl | Br | i-Pr | CH₃ | Cl | Br |
| t-Bu | CH₃ | Br | Br | t-Bu | CH₃ | Cl | Br | t-Bu | CH₃ | Cl | Br |
| Me | CH₃ | I | Cl | Me | CH₃ | I | Cl | Me | CH₃ | H | Cl |
| Et | CH₃ | I | Cl | Et | CH₃ | I | Cl | Et | CH₃ | H | Cl |
| i-Pr | CH₃ | I | Cl | i-Pr | CH₃ | I | Cl | i-Pr | CH₃ | B | Cl |
| t-Bu | CH₃ | I | Cl | t-Bu | CH₃ | I | Cl | t-Bu | CH₃ | H | GI |
| Me | CH₃ | I | Br | Me | CH₃ | I | Br | Me | CH₃ | B | Br |
| Et | CH₃ | I | Br | Et | CH₃ | I | Br | Et | CH₃ | H | Br |
| i-Pr | CH₃ | I | Br | i-Pr | CH₃ | I | Br | i-Pr | CH₃ | H | Br |
| t-Bu | CH₃ | I | Br | t-Bu | CH₃ | I | Br | t-Bu | CH₃ | H | Br |
| Me | CH₃ | CH₃ | Cl | Me | CH₃ | CH₃ | Cl | Me | CH₃ | F | Cl |
| Et | CH₃ | CH₃ | Cl | Et | CH₃ | CF₃ | Cl | Et | CH₃ | F | Cl |
| i-Pr | CH₃ | CH₃ | Cl | i-Pr | CH₃ | CH₃ | Cl | i-Pr | CH₃ | F | Cl |
| t-Bu | CH₃ | CH₃ | Cl | t-Bu | CH₃ | CH₃ | Cl | t-Bu | CH₃ | F | Cl |
| Me | CH₃ | CH₃ | Br | Me | CH₃ | CF₃ | Br | Me | CH₃ | F | Br |
| Et | CH₃ | CH₃ | Br | Et | CH₃ | CF₃ | Br | Et | CH₃ | F | Br |
| i-Pr | CH₃ | CF₃ | Br | i-Pr | CH₃ | CF₃ | Br | i-Pr | CH₃ | F | Br |
| t-Bu | CH₃ | CF₃ | Br | t-Bu | CH₃ | CF₃ | Br | t-Bu | CH_{3 F} | Br | |
| n-Pr | CH₃ | Cl | Cl | Me | Cl | B | Br | Me | Cl | Cl | Br |
| n-Bu | CH₃ | Cl | Cl | Et | Cl | H | Br | Et | Cl | Cl | Br |
| s-Bu | CH₃ | Cl | Cl | i-Pr | Cl | H | Br | i-Pr | Cl | Cl | Br |
| i-Bu | CH₃ | Cl | Cl | t-Bu | Cl | H | Br | t-Bu | Cl | Cl | Br |
| Me | Cl | I | Br | Me | Cl | H | Cl | Me | Cl | Cl | Cl |
| Et | Cl | I | Br | Et | Cl | H | Cl | Et | Cl | Cl | Cl |
| i-Pr | Cl | I | Br | i-Pr | Cl | H | Cl | i-Pr | Cl | Cl | Cl |
| t-Bu | Cl | I | Br | t-Bu | Cl | H | Cl | t-Bu | Cl | Cl | Cl |
| Me | Cl | I | Cl | Me | Cl | Cl | Br | Me | Cl | I | Br |
| Et | Cl | I | Cl | Et | Cl | Cl | Br | Et | Cl | I | Br |
| i-Pr | Cl | I | Cl | i-Pr | Cl | Cl | Br | i-Pr | Cl | I | Br |
| t-Bu | Cl | I | Cl | t-Bu | Cl | Cl | Br | t-Bu | Cl | I | Br |
| Me | Cl | H | Br | Me | Cl | Cl | Cl | Me | Cl | I | Cl |
| Et | Cl | B | Br | Et | Cl | Cl | Cl | Et | Cl | I | GL |
| i-Pr | Cl | B | Br | i-Pr | Cl | Cl | Cl | i-Pr | Cl | I | Cl |
| t-Bu | Cl | H | Br | t-Bu | Cl | Cl | Cl | t-Bu | Cl | I | Cl |
| Me | Cl | H | Cl | Me | Cl | F | Br | Me | Cl | F | Br |
| Et | Cl | H | Cl | Et | Cl | F | Br | Et | Cl | F | Br |
| i-Pr | Cl | H | Cl | i-Pr | Cl | F | Br | i-Pr | Cl | F | Br |
| t-Bu | Cl | H | Cl | t-Bu | Cl | F | Br | t-Bu | Cl | F | Br |
| Me | Cl | CF₃ | Br | Me | Cl | F | Cl | Me | Cl | F | Cl |
| Et | Cl | CF₃ | Br | Et | Cl | F | Cl | Et | Cl | F | Cl |
| i-Pr | Cl | CF₃ | Br | i-Pr | Cl | F | Cl | i-Pr | Cl | F | Cl |
| t-Bu | Cl | CF₃ | Br | t-Bu | Cl | F | Cl | t-Bu | Cl | F | Cl |
| Me | Cl | CF₃ | Cl | Me | Cl | Br | Br | Me | Cl | H | Br |
| Et | Cl | CF₃ | Cl | Et | Cl | Br | Br | Et | Cl | H | Br |
| i-Pr | Cl | CF₃ | Cl | i-Pr | Cl | Br | Br | i-Pr | Cl | H | Br |
| t-Bu | Cl | CF₃ | Cl | t-Bu | Cl | Br | Br | t-Bu | Cl | H | Br |
| Me | Cl | Br | Br | Me | Cl | I | Cl | Me | Cl | H | Cl |
| Et | Cl | Br | Br | Et | Cl | I | Cl | Et | Cl | H | Cl |
| i-Pr | Cl | Br | Br | i-Pr | Cl | I | Cl | i-Pr | Cl | H | Cl |
| t-Bu | Cl | Br | Br | t-Bu | Cl | I | Cl | i-Pr | Cl | H | Cl |
| Me | Cl | Br | Cl | Me | Cl | I | Br | Me | Cl | CF₃ | Br |
| Et Cl | Br | Cl | Et | Cl | I | Br | Et | Cl | CF₃ | Br | |
| i-Pr | Cl | Br | Cl | i-Pr | Cl | I | Br | i-Pr | Cl | CF₃ | Br |
| t-Bu | Cl | Br | Cl | t-Bu | Cl | I | Br | t-Bu | Cl | CF₃ | Br |
| Me | Cl | F | Br | Me | Cl | CF₃ | Cl | Me | Cl | CF₃ | Cl |
| Et | Cl | F | Br | Et | Cl | CF₃ | Cl | Et | Cl | CF₃ | Cl |
| i-Pr | Cl | F | Br | i-Pr | Cl | CF₃ | Cl | i-Pr | Cl | CF₃ | Cl |
| t-Bu | Cl | F | Br | t-Bu | Cl | CF₃ | Cl | t-Bu | Cl | CF₃ | Cl |
| Me | Cl | Cl | Cl | Me | Cl | CF₃ | Br | Me | Br | F | Cl |
| Et | Cl | Cl | Cl | Et | Cl | CF₃ | Br | Et | Br | F | Cl |
| i-Pr | Cl | Cl | Cl | i-Pr | Cl | CF₃ | Br | i-Pr | Br | F | Cl |
| t-Bu | Cl | Cl | Cl | t-Bu | Cl | CF₃ | Br | t-Bu | Br | F | Cl |
| Me | Cl | F | Cl | n-Pr | Cl | Cl | Cl | Me | Br | F | Br |
| Et | Cl | F | Cl | n-Bu | Cl | Cl | Cl | Et | Br | F | Br |
| i-Pr | Cl | F | Cl | s-Bu | Cl | Cl | Cl | i-Pr | Br | F | Br |
| t-Bu | Cl | F | Cl | i-Bu | Cl | Cl | Cl | t-Bu | Br | F Br | |
| Me | Br | Br | Cl | Me | Br | F | Cl | Me | Br | Cl | Cl |
| Et | Br | Br | Cl | Et | Br | F | Cl | Et | Br | Cl | Cl |
| i-Pr | Br | Br | Cl | i-Pr | Br | F | Cl | i-Pr | Br | Cl | Cl |
| t-Bu | Br | Br | Cl | t-Bu | Br | F | Cl | t-Bu | Br | Cl | Cl |
| Me | Br | Br | Br | Me | Br | F | Br | Me | Br | Cl | Br |
| Et | Br | Br | Br | Et | Br | F | Br | Et | Br | Cl | Br |
| i-Pr | Br | Br | Br | i-Pr | Br | F | Br | i-Pr | Br | Cl | Br |
| t-Bu | Br | Br | Br | t-Bu | Br | F | Br | t-Bu | Br | Cl | Br |
| Me | Br | I | Cl | Me | Br | Cl | Cl | Me | Br | Br | Cl |
| Et | Br | I | Cl | Et | Br | Cl | Cl | Et | Br | Br | Cl |
| i-Pr | Br | I | Cl | i-Pr | Br | Cl | Cl | i-Pr | Br | Br | Cl |
| t-Bu | Br | I | Cl | t-Bu | Br | Cl | Cl | t-Bu | Br | Br | Cl |
| Me | Br | I | Br | Me | Br | Cl | Br | Me | Br | Br | Br |
| Et | Br | I | Br | Et | Br | Cl | Br | Et | Br | Br | Br |
| i-Pr | Br | I | Br | i-Pr | Br | Cl | Br | i-Pr | Br | Br | Br |
| t-Bu | Br | I | Br | t-Bu | Br | Cl | Br | t-Bu | Br | Br | Br |
| Me | Br | F | Cl | Me | Br | I | Cl | Me | Br | CF₃ | Cl |
| Et | Br | F | Cl | Et | Br | I | Cl | Et | Br | CF₃ | Cl |
| i-Pr | Br | F | Cl | i-Pr | Br | I | Cl | i-Pr | Br | CF₃ | Cl |
| t-Bu | Br | F | Cl | t-Bu | Br | I | Cl | t-Bu | Br | CF₃ | Cl |
| Me | Br | F | Br | Me | Br | I | Br | Me | Br | CF₃ | Br |
| Et | Br | F | Br | Et | Br | I | Br | Et | Br | CF₃ | Br |
| i-Pr | Br | F | Br | i-Pr | Br | I | Br | i-Pr | Br | CF₃ | Br |
| t-Bu | Br | F | Br | t-Bu | Br | I | Br | t-Bu | Br | CF₃ | Br |
| Me | Br | Cl | Cl | Me | Br | Br | Cl | Me | Br | I | Cl |
| Et | Br | Cl | Cl | Et | Br | Br | Cl | Et | Br | I | Cl |
| i-Pr | Br | Cl | Cl | i-Pr | Br | Br | Cl | i-Pr | Br | I | Cl |
| t-Bu | Br | Cl | Cl | t-Bu | Br | Br | Cl | t-Bu | Br | I | Cl |
| Me | Br | Cl | Br | Me | Br | Br | Br | Me | Br | I | Br |
| Et | Br | Cl | Br | Et | Br | Br | Br | Et | Br | I | Br |
| i-Pr | Br | Cl | Br | i-Pr | Br | Br | Br | i-Pr | Br | I | Br |
| t-Bu | Br | Cl | Br | t-Bu | Br | Br | Br | t-Bu | Br | I | Br |

Formulation/Utility

Compounds of this invention will generally be used as a formulation or composition with an agriculturally suitable carrier comprising at least one of a liquid diluent, a solid diluent or a surfactant. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts of active ingredient, diluent and surfactant within the following approximate ranges that add up to 100 percent by weight.

| | Weight Percent | | |
|---|---|---|---|
| | Active | | |
| | Ingredient | Diluent | Surfactant |
| Water-Dispersible and Water- | 5-90 | 0-94 | 1-15 |
| soluble Granules, Tablets and | | | |
| Powders. | | | |
| Suspensions, Emulsions, | 5-50 | 40-95 | 0-15 |
| Solutions (including | | | |
| Emulsifiable Concentrates) | | | |
| Dusts | 1-25 | 70-99 | 0-5 |
| Granules and Pellets | 0.01-99 | 5-99.99 | 0-15 |
| High Strength Compositions | 90-99 | 0-10 | 0-2 |

Typical solid diluents are described in Watkins, et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon 's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxy-ethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, propylene carbonate, dibasic esters, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol, benzyl and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and PCT Publication WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food—Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th Ed., Blackwell Scientific Publications, Oxford, 1989.

In the following Examples, all percentages are by weight and all formulations are prepared in conventional ways. Compound numbers refer to compounds in Index Table A.

Example A

| Wettable Powder | |
|---|---|
| Compound 6 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

Example B

| | |
|---|---|
| Granule | |
| Compound 6 | 10.0% |
| attapulgite granules (low volatile matter, | 90.0%. |
| 0.71/0.30 mm; U.S.S. No. 25-50 sieves) | |

Example C

| | |
|---|---|
| Extruded Pellet | |
| Compound 6 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

Example D

| | |
|---|---|
| Emulsifiable Concentrate | |
| Compound 6 | 20.0% |
| blend of oil soluble sulfonates | 10.0% |
| and polyoxyethylene ethers | |
| isophorone | 70.0%. |

Compounds of this invention are characterized by favorable metabolic and/or soil residual patterns and exhibit activity controlling a spectrum of agronomic and non-agronomic invertebrate pests. (In the context of this disclosure “invertebrate pest control” means inhibition of invertebrate pest development (including mortality) that causes significant reduction in feeding or other injury or other damage caused by the pest; related expressions are defined analogously.) As referred to in this disclosure, the term “invertebrate pest” includes arthropods, gastropods and nematodes of economic importance as pests. The term “arthropod” includes insects, mites, spiders, scorpions, centipedes, millipedes, pill bugs and symphylans. The term “gastropod” includes snails, slugs and other Stylommatophora. The term “nematode” includes all of the helminths, such as: roundworms, heartworms, and phytophagous nematodes (Nematoda), flukes (Tematoda), Acanthocephala, and tapeworms (Cestoda). Those skilled in the art will recognize that not all compounds are equally effective against all pests. Compounds of this invention display activity against economically important agronomic, forest, greenhouse, nursery, ornamentals, food and fiber, public and animal health, domestic and commercial structure, household, and stored product pests. These include larvae of the order Lepidoptera, such as armyworms, cutworms, loopers, and heliothines in the family Noctuidae (e.g., fall armyworm (Spodoptera fugiperda J. E. Smith), beet armyworm (Spodoptera exigua Hübner), black cutworm (Agrotis epsilon Hufnagel), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworm (Herpetogramma licarsisalis Walker)); leafrollers, budworms, seed worms, and fruit worms in the family Tortricidae (e.g., codling moth (Cydia pomonella Linnaeus), grape berry moth (Endopiza viteana Clemens), oriental fruit moth (Grapholita molesta Busck)); and many other economically important lepidoptera (e.g., diamondback moth (Plutella xylostella Linnaeus), pink bollworm (Pectinophora gossypiella Saunders), gypsy moth (Lymantria dispar Linnaeus)); nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fabricius)); foliar feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera virgifera LeConte)); chafers and other beetles from the family Scaribaeidae (e.g., Japanese beetle (Popillia japonica Newman) and European chafer (Rhizotrogus majalis Razoumowsky)); carpet beetles from the family Dermestidae; wireworms from the family Elateridae; bark beetles from the family Scolytidae and flour beetles from the family Tenebrionidae. In addition it includes: adults and larvae of the order Dermaptera including earwigs from the family Forficulidae (e.g., European earwig (Forficula auricularia Linnaeus), black earwig (Chelisoches morio Fabricius)); adults and nymphs of the orders Hemiptera and Homoptera such as, plant bugs from the family Miridae, cicadas from the family Cicadidae, leafhoppers (e.g. Empoasca spp.) from the family Cicadellidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, cinch bugs (e.g., Blissus spp.) and other seed bugs from the family Lygaeidae, spittlebugs from the family Cercopidae squash bugs from the family Coreidae, and red bugs and cotton stainers from the family Pyrrhocoridae. Also included are adults and larvae of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)), flat mites in the family Tenuipalpidae (e.g., citrus flat mite (Brevipalpus lewisi McGregor)), rust and bud mites in the family Eriophyidae and other foliar feeding mites and mites important in human and animal health, i.e. dust mites in the family Epidermoptidae, follicle mites in the family Demodicidae, grain mites in the family Glycyphagidae, ticks in the order Ixodidae (e.g., deer tick (Ixodes scapularis Say), Australian paralysis tick (Ixodes holocyclus Neumann), American dog tick (Dermacentor variabilis Say), lone star tick (Amblyomma americanum Linnaeus) and scab and itch mites in the families Psoroptidae, Pyemotidae, and Sarcoptidae; adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria Linnaeus), house cricket (Acheta domesticus Linnaeus), mole crickets (Gryllotalpa spp.)); adults and immatures of the order Diptera including leafminers, midges, fruit flies (Tephritidae), frit flies (e.g., Oscinella frit Linnaeus), soil maggots, house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera; adults and immatures of the order Thysanoptera including onion thrips (Thrips tabaci Lindeman) and other foliar feeding thrips; insect pests of the order Hymenoptera including ants (e.g., red carpenter ant (Camponotus ferrugineus Fabricius), black carpenter ant (Camponotus pennsylvanicus De Geer), Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster), odorous house ant (Tapinoma sessile Say)), bees (including carpenter bees), hornets, yellow jackets and wasps; insect pests of the order Isoptera including the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder) and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus). Activity also includes members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e. root knot nematodes in the genus Meloidogyne, lesion nematodes in the genus Pratylenchus, stubby root nematodes in the genus Trichodorus, etc.) and animal and human health pests (i.e. all economically important flukes, tapeworms, and roundworms, such as Strongylus vulgaris in horses, Toxocara canis in dogs, Haemonchus contortus in sheep, Dirofilaria immitis Leidy in dogs, Anoplocephala perfoliata in horses, Fasciola hepatica Linnaeus in ruminants, etc.).

Compounds of the invention show particularly high activity against pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guenee (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Hübner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermüller (grape berry moth), Pectinophora gossypiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamondback moth), Spodoptera exigua Hübner (beet armyworm), Spodoptera litura Fabricius (tobacco cutworm, cluster caterpillar), Spodoptera frugiperda J. E. Smith (fall armyworm), Trichoplusia ni Hübner (cabbage looper) and Tuta absoluta Meyrick (tomato leafminer)). Compounds of the invention also have commercially significant activity on members from the order Homoptera including: Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stål (rice leafhopper), Nilaparvata lugens Stål (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla). These compounds also have activity on members from the order Hemiptera including: Acrosternum hilare Say (green stink bug), Anasa tristis De Geer (squash bug), Blissus leucopterus leucopterus Say (chinch bug), Corythuca gossypii Fabricius (cotton lace bug), Cyrtopeltis modesta Distant (tomato bug), Dysdercus suturellus Herrich-Schäffer (cotton stainer), Euchistus servus Say (brown sink bug), Euchistus variolarius Palisot de Beauvois (one-spotted stink bug), Graptosthetus spp. (complex of seed bugs), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the invention include Thysanoptera (e.g., Frankliniella occidentalis Pergande (western flower thrip), Scirthothrips citri Moulton (citrus thrip), Sericothrips variabilis Beach (soybean thrip), and Thrips tabaci Lindeman (onion thrip); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

Compounds of this invention can also be mixed with one or more other biologically active compounds or agents including insecticides, fungicides, nematocides, bactericides, acaricides, growth regulators such as rooting stimulants, chemosterilants, semiochemicals, repellents, attractants, pheromones, feeding stimulants, other biologically active compounds or entomopathogenic bacteria, virus or fungi to form a multi-component pesticide giving an even broader spectrum of agricultural utility. Thus compositions of the present invention can further comprise a biologically effective amount of at least one additional biologically active compound or agent. Examples of such biologically active compounds or agents with which compounds of this invention can be formulated are: insecticides such as abamectin, acephate, acetamiprid, avermectin, azadirachtin, azinphos-methyl bifenthrin, binfenazate, buprofezin, carbofuran, chlorfenapyr, chlorfluazuron, chlorpyrifos, chlorpyrifos-methyl chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, oxamyl, parathion, parathion-methyl, permethrin, phorate, phosalone, phosmet, phosphamidon, pirimicarb, profenofos, pymetrozine, pyridalyl, pyriproxyfen, rotenone, spinosad, sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflumuron; fungicides such as acibenzolar, azoxystrobin, benomyl, blasticidin-S, Bordeaux mixture (tribasic copper sulfate), bromuconazole, carpropamid, captafol, captan, carbendazim, chloroneb, chlorothalonil, copper oxychloride, copper salts, cyflufenamid, cymoxanil cyproconazole, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(phenylamino)-4H-imidazol-4-one (RP 407213), dimethomorph, dimoxystrobin, diniconazole, diniconazole-M, dodine, edifenphos, epoxiconazole, famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metomino-strobin/fenominostrobin (SSF-126), myclobutanil, neo-asozin (ferric methanearsonate), oxadixyl, penconazole, pencycuron, probenazole, prochloraz, propamocarb, propiconazole, pyrifenox, pyraclostrobin, pyrimethanil, pyroquilon, quinoxyfen, spiroxamine, sulfur, tebuconazole, tetraconazole, thiabendazole, thifluzamide, thiophanate-methyl, thiram, tiadinil, triadimefon, triadimenol, tricyclazole, trifloxystrobin, triticonazole, validamycin and vinclozolin; nematocides such as aldicarb, oxamyl and fenamiphos; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis including ssp. aizawai and kurstaki, Bacillus thuringiensis delta endotoxin, baculovirus, and entomopathogenic bacteria, virus and fungi.

A general reference for these agricultural protectants is The Pesticide Manual, 12th Edition, C. D. S. Tomlin, Ed., British Crop Protection Council, Farnham, Surrey, U.K., 2000.

Of note are combinations of a compound of Formula 1d with the biologically active compounds above.

Preferred insecticides and acaricides for mixing with compounds of this invention include pyrethroids such as cypermethrin, cyhalothrin, cyfluthrin and beta-cyfluthrin, esfenvalerate, fenvalerate and tralomethrin; carbamates such as fenothicarb, methomyl, oxamyl and thiodicarb; neonicotinoids such as clothianidin, imidacloprid and thiacloprid, neuronal sodium channel blockers such as indoxacarb, insecticidal macrocyclic lactones such as spinosad, abamectin, avermectin and emamectin; γ-aminobutyric acid (GABA) antagonists such as endosulfan, ethiprole and fipronil; insecticidal ureas such as flufenoxuron and triflumuron, juvenile hormone mimics such as diofenolan and pyriproxyfen; pymetrozine; and amitraz. Preferred biological agents for mixing with compounds of this invention include Bacillus thuringiensis and Bacillus thuringiensis delta endotoxin as well as naturally occurring and genetically modified viral insecticides including members of the family Baculoviridae as well as entomophagous fungi. Of note are combinations of a compound of Formula 1d with the preferred insecticides and acaricides above.

Most preferred mixtures include a mixture of a compound of this invention with cyhalothrin; a mixture of a compound of this invention with beta-cyfluthrin; a mixture of a compound of this invention with esfenvalerate; a mixture of a compound of this invention with methomyl; a mixture of a compound of this invention with imidacloprid; a mixture of a compound of this invention with thiacloprid; a mixture of a compound of this invention with indoxacarb; a mixture of a compound of this invention with abamectin; a mixture of a compound of this invention with endosulfan; a mixture of a compound of this invention with ethiprole; a mixture of a compound of this invention with fipronil; a mixture of a compound of this invention with flufenoxuron; a mixture of a compound of this invention with pyriproxyfen; a mixture of a compound of this invention with pymetrozine; a mixture of a compound of this invention with amitraz; a mixture of a compound of this invention with Bacillus thuringiensis and a mixture of a compound of this invention with Bacillus thuringiensis delta endotoxin.

In certain instances, combinations with other invertebrate pest control compounds or agents having a similar spectrum of control but a different mode of action will be particularly advantageous for resistance management. Thus, compositions of the present invention can further comprise an biologically effective amount of at least one additional invertebrate pest control compounds or agents having a similar spectrum of control but a different mode of action. Contacting a plant genetically modified to express a plant protection compound (e.g., protein) or the locus of the plant with a biologically effective amount of a compound of invention can also provide a broader spectrum of plant protection and be advantageous for resistance management.

Invertebrate pests are controlled and protection of agronomic, horticultural and specialty crops, animal and human health is achieved by applying one or more of the compounds of this invention, in an effective amount, to the environment of the pests including the agronomic and/or nonagronomic locus of infestation, to the area to be protected, or directly on the pests to be controlled. Thus, the present invention further comprises a method for the control of foliar- and soil-inhabiting invertebrates and protection of agronomic and/or nonagronomic crops, comprising contacting the invertebrates or their environment with a biologically effective amount of one or more of the compounds of the invention, or with a composition comprising at least one such compound or a composition comprising at least one such compound and an effective amount of at least one additional biologically active compound or agent. A preferred method of contact is by spraying. Alternatively, a granular composition comprising a compound of the invention can be applied to the plant foliage or the soil. Compounds of this invention are effective in delivery through plant uptake by contacting the plant with a composition comprising a compound of this invention applied as a soil drench of a liquid formulation, a granular formulation to the soil, a nursery box treatment or a dip of transplants. Other methods of contact include application of a compound or a composition of the invention by direct and residual sprays, aerial sprays, seed coats, microencapsulations, systemic uptake, baits, eartags, boluses, foggers, fumigants, aerosols, dusts and many others.

The compounds of this invention can be incorporated into baits that are consumed by the invertebrates or within devices such as traps and the like. Granules or baits comprising between 0.01-5% active ingredient, 0.05-10% moisture retaining agent(s) and 40-99% vegetable flour are effective in controlling soil insects at very low application rates, particularly at doses of active ingredient that are lethal by ingestion rather than by direct contact.

The compounds of this invention can be applied in their pure state, but most often application will be of a formulation comprising one or more compounds with suitable carriers, diluents, and surfactants and possibly in combination with a food depending on the contemplated end use. A preferred method of application involves spraying a water dispersion or refined oil solution of the compounds. Combinations with spray oils, spray oil concentrations, spreader stickers, adjuvants, other solvents, and synergists such as piperonyl butoxide often enhance compound efficacy.

The rate of application required for effective control (i.e. “biologically effective amount”) will depend on such factors as the species of invertebrate to be controlled, the pest's life cycle, life stage, its size, location, time of year, host crop or animal, feeding behavior, mating behavior, ambient moisture, temperature, and the like. Under normal circumstances, application rates of about 0.01 to 2 kg of active ingredient per hectare are sufficient to control pests in agronomic ecosystems, but as little as 0.0001 kg/hectare may be sufficient or as much as 8 kg/hectare may be required. For nonagronomic applications, effective use rates will range from about 1.0 to 50 mg/square meter but as little as 0.1 mg/square meter may be sufficient or as much as 150 mg/square meter may be required One skilled in the art can easily determine the biologically effective amount necessary for the desired level of invertebrate pest control.

The following TESTS demonstrate the control efficacy of compounds of this invention on specific pests. “Control efficacy” represents inhibition of arthropod development (including mortality) that causes significantly reduced feeding. The pest control protection afforded by the compounds is not limited, however, to these species. See Index Tables A-B for compound descriptions. The following abbreviations are used in the Index Tables which follow: Me is methyl, i-Pr is isopropyl, Ph is phenyl. The abbreviation “dec” indicates that the compound appeared to decompose on melting. The abbreviation “Ex.” stands for “Example” and is followed by a number indicating in which example the compound is prepared.

INDEX TABLE A

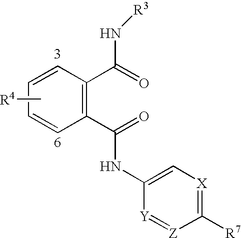

| Compound | R³ | R⁴ | R⁷ | X | Y | Z | m.p. ° C. |
|---|---|---|---|---|---|---|---|
| 1 (Ex. 1) | i-Pr | 3-I | OCH₂CF₃ | CH | CH | N | 220-225 |
| 2 (Ex. 1) | i-Pr | 6-I | OCH₂CF₃ | CH | CH | N | 200-203 |
| 3 | i-Pr | 3-Me | OCH₂CF₃ | CH | CH | N | 205-210 |
| 4 | i-Pr | 6-Me | OCH₂CF₃ | CH | CH | N | 193-196 |

INDEX TABLE B

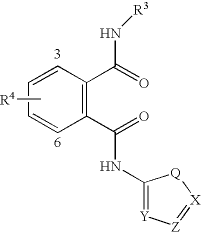

| Com- | | | | | | | |
|---|---|---|---|---|---|---|---|
| pound | R³ | R⁴ | Q | X | Y | Z | m.p. ° C. |
| 5 | i-Pr | 3-I | NPh | N | CH | CMe | 193-194 |
| 6 | i-Pr | 6-I | NPh | N | CH | CMe | 216-218 |
| 7 | i-Pr | 3-I | NMe | N | CH | CMe | 220-222 |
| 8 | i-Pr | 6-I | NMe | N | CH | CMe | 233-234 |
| 9 | i-Pr | 3-I | NMe | N | CH | C-cyclopropyl | 222-224 |
| 10 | i-Pr | 6-I | NMe | N | CH | C-cyclopropyl | 215-217 |
| 11 | i-Pr | 6-I | N(2-ClPh) | N | CH | CCF₃ | 234-235 |
| (Ex. 2) | | | | | | | |
| 12 | i-Pr | 3-I | N(2-ClPh) | N | CH | CCF₃ | 226-228 |
| (Ex. 2) | | | | | | | |

### BIOLOGICAL EXAMPLES OF THE INVENTION

### Test A

For evaluating control of diamondback moth (Plutella xylostella) the test unit consisted of a small open container with a 12-14-day-old radish plant inside. This was pre-infested with 10-15 neonate larvae on a piece of insect diet by use of a core sampler to remove a plug from a sheet of hardened insect diet having many larvae growing on it and transfer the plug containing larvae and diet to the test unit. The larvae moved onto the test plant as the diet plug dried out.

Test compounds were formulated using a solution containing 10% acetone, 90% water and 300 ppm X-77® Spreader Lo-Foam Formula non-ionic surfactant containing alkylarylpolyoxyethylene, free fatty acids, glycols and isopropanol (Loveland Industries, Inc.), unless otherwise indicated. The formulated compounds were applied in 1 mL of liquid through a SUJ2 atomizer nozzle with ⅛ JJ custom body (Spraying Systems Co.) positioned 1.27 cm (0.5 inches) above the top of each test unit. All experimental compounds in this screen were sprayed at 50 ppm and replicated three times. After spraying of the formulated test compound, each test unit was allowed to dry for 1 hour and then a black, screened cap was placed on top. The test units were held for 6 days in a growth chamber at 25° C. and 70% relative humidity. Plant feeding damage was then visually assessed.

Of the compounds tested, the following provided excellent levels of plant protection (10% or less feeding damage): 1, 2, 3, 4, 6, 7, 9, 10.

### Test B

For evaluating control of fall armyworm (Spodoptera fugiperda) the test unit consisted of a small open container with a 4-5-day-old corn (maize) plant inside. This was pre-infested with 10-15 1-day-old larvae on a piece of insect diet by use of a core sampler as described for Test A.

Test compounds were formulated and sprayed at 50 ppm as described for Test A. The applications were replicated three times. After spraying, the test units were maintained in a growth chamber and then visually rated as described for Test A.

Of the compounds tested, the following provided excellent levels of plant protection (10% or less feeding damage): 1, 9.

### Test C

For evaluating control of tobacco budworm (Heliothis virescens) the test unit consisted of a small open container with a 6-7 day old cotton plant inside. This was pre-infested with 8 2-day-old larvae on a piece of insect diet by use of a core sampler as described for Test A.

Test compounds were formulated and sprayed at 50 ppm as described for Test A. The applications were replicated three times. After spraying, the test units were maintained in a growth chamber and then visually rated as described for Test A.

Of the compounds tested, the following provided excellent levels of plant protection (10% or less feeding damage): 1, 3, 7, 9.

What is claimed is:

1. A compound of Formula I and N-oxides and agriculturally suitable salts thereof 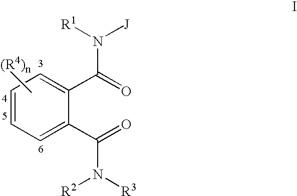
wherein
J is selected from the group consisting of J-1, J-2, J-3, J-4, J-5, J-6, J-7 and J-8 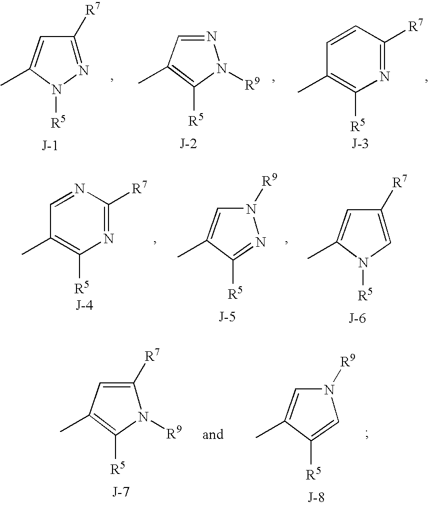
R¹ is H, C₁-C₆ alkyl, C₂-C₆ alkoxycarbonyl or C₂-C₆ alkylcarbonyl;
R² is H or C₁-C₆ alkyl;
R³ is H; C₁-C₆ alkyl, C₂-C₆ alkenyl, C₂-C₆ alkynyl, C₃-C₆ cycloalkyl, or C₄-C₈ cycloalkylalkyl, each optionally substituted with one or more substituents selected from the group consisting of halogen, CN, NO₂, hydroxy, C₁-C₄ alkyl, C₁-C₄ alkoxy, C₁-C₄ haloalkoxy, C₁-C₄ alkylthio, C₁-C₄ alkylsulfinyl, C₁-C₄ alkylsulfonyl, C₂-C₆ alkoxycarbonyl or C₂-C₆ alkylcarbonyl;
one R⁴ group is attached to the phenyl ring at the 3-position or 6-position, and said R⁴ is C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, or C₁-C₄ haloalkylsulfonyl; and
an optional second R⁴ is H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₁-C₄ alkoxyalkyl, C₁-C₄ hydroxyalkyl, C(O)R¹⁰, CO₂R¹⁰, C(O)NR¹⁰R¹¹, NR¹⁰R¹¹, N(R¹¹)COR¹⁰, N(R¹¹)CO₂R¹⁰ or C₃-C₆ trialkylsilyl;
R⁵ is H, C₁-C₄ alkyl, C₁-C₄ haloalkyl, or 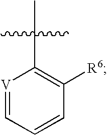
V is N, CH, CF, CCl, CBr or CI;
each R⁶ and R⁷ is independently H, C₁-C₆ alkyl, C₃-C₆ cycloalkyl, C₁-C₆ haloalkyl, halogen, CN, C₁-C₄ alkoxy, C₁-C₄ haloalkoxy or C₁-C₄ haloalkylthio;
R⁹ is H, C₁-C₆ alkyl, C₁-C₆ haloalkyl, C₃-C₆ alkenyl, C₃-C₆ haloalkenyl, C₃-C₆ alkynyl or C₃-C₆ haloalkynyl; provided R⁷ and R⁹ are not both H;
R¹⁰ is H or C₁-C₄ alkyl or C₁-C₄ haloalkyl;
R¹¹ is H or C₁-C₄ alkyl; and
n is 1 or 2.

2. The compound of claim 1 wherein V is N.

3. The compound of claim 1 wherein V is CH, CF, CCl or CBr.

4. The compound of claim 2 or claim 3 wherein
R¹ and R² are both H;
R³ is C₁-C₄ alkyl optionally substituted with halogen, CN, OCH₃, S(O)ₚCH₃;
one R⁴ group is attached to the phenyl ring at the 3-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁷ is H, CH₃, CF₃, OCHF₂ or halogen; and
p is 0, 1 or 2.

5. The compound of claim 4 wherein
J is J-1;
R³ is C₁-C₄ alkyl;
one R⁴ group is attached to the phenyl ring at the 3-position and said R⁴ is CH₃, Cl, Br or I;
a second R⁴ is H, F, Cl, Br, I or CF₃;
R⁶ is Cl or Br; and
R⁷ is halogen or CF₃.

6. The compound of claim 5 wherein
V is N;
R³ is methyl, ethyl, isopropyl or tertiary butyl;
one R⁴ group is attached to the phenyl ring at the 3-position and said R⁴ is CH₃ or I;
R⁶ is Cl or Br; and
R⁷ is Br, Cl or CF₃.

7. The compound of claim 6 selected from the group consisting of:
N¹-[1-(3-chloro-2-pyridinyl)-3-(trifluoromethyl)-1H-pyrazol-5-yl]-3-methyl-N²-(1-methylethyl)-1,2-benzenedicarboxamide,
N¹-[1-(3-bromo-1-(3-chloro-2-pyridinyl)-1H-pyrazol-5-yl]-3-methyl-N²-(1-methylethyl)-1,2-benzenedicarboxamide,
N¹-[1-(3-chloro-2-pyridinyl)-3-(trifluoromethyl)-1H-pyrazol-5-yl]-3-iodo-N²-(1-methylethyl)-1,2-benzenedicarboxamide, and
N¹-[1-(3-bromo-1-(3-chloro-2-pyridinyl)-1H-pyrazol-5-yl]-3-iodo-N²-(1-methylethyl)-1,2-benzenedicarboxamide.

8. The compound of claim 4 wherein
J is J-2;
R³ is C₁-C₄ alkyl;
one R⁴ group is attached to the phenyl ring at the 3-position and said R⁴ is CH₃, Cl, Br or I;
a second R⁴ is H, F, Cl, Br, I or CF₃;
R⁶ is Cl or Br; and
R⁹ is CF₃, CHF₂, CH₂CF₃, CF₂CHF₂.

9. The compound of claim 4 wherein
J is J-3;
R³ is C₁-C₄ alkyl;
one R⁴ group is attached to the phenyl ring at the 3-position and said R⁴ is CH₃, Cl, Br or I;
a second R⁴ is H, F, Cl, Br, I or CF₃;
R⁶ is Cl or Br; and
R⁷ is halogen or CF₃.

10. The compound of claim 4 wherein
J is J-4;
R³ is C₁-C₄ alkyl;
one R⁴ group is attached to the phenyl ring at the 3-position and said R⁴ is CH₃, Cl, Br or I;
a second R⁴ is H, F, Cl, Br, I or CF₃;
R⁶ is Cl or Br; and
R⁷ is CF₃.

11. The compound of claim 4 wherein
J is J-5;
R³ is C₁-C₄ alkyl;
one R⁴ group is attached to the phenyl ring at the 3-position and said R⁴ is CH₃, Cl, Br or I;
a second R⁴ is H, F, Cl, Br, I or CF₃;
R⁶ is Cl or Br; and
R⁹ is CF₃, CHF₂, CH₂CF₃, CF₂CHF₂.

12. The compound of claim 4 wherein
J is J-6;
R³ is C₁-C₄ alkyl;
one R⁴ group is attached to the phenyl ring at the 3-position and said R⁴ is CH₃, Cl, Br or I;
a second R⁴ is H, F, Cl, Br, I or CF₃;
R⁶ is Cl or Br; and
R⁷ is halogen or CF₃.

13. The compound of claim 4 wherein
J is J-7;
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br;
R⁷ is H, halogen or CF₃ and
R⁹ is H, CF₃, CHF₂, CH₂CF₃, CF₂CHF₂.

14. The compound of claim 4 wherein
J is J-8;
R³ is C₁-C₄ alkyl;
one R⁴ group is attached to the phenyl ring at the 3-position and said R⁴ is CH₃, Cl, Br or I;
a second R⁴ is H, F, Cl, Br, I or CF₃;
R⁶ is Cl or Br;
R⁷ is H, halogen or CF₃.and
R⁹ is H, CF₃, CHF₂, CH₂CF₃, CF₂CHF₂.

15. A composition for controlling an invertebrate pest comprising a biologically effective amount of a compound of claim 1 and at least one additional component selected from the group consisting of a surfactant, a solid diluent or a liquid diluent.

16. The composition of claim 15 further comprising an effective amount of at least one additional biologically active compound or agent.

17. The composition of claim 16 wherein at least one additional biologically active compound or agent is selected from arthropodicides of the group consisting of pyrethroids, carbamates, neonicotinoids, neuronal sodium channel blockers, insecticidal macrocyclic lactones, γ-aminobutyric acid (GABA) antagonists, insecticidal ureas and juvenile hormone mimics.

18. The composition of claim 16 wherein at least one additional biologically active compound or agent is selected from insecticide, nematocide, acaricide or biological agents in the group consisting of abamectin, acephate, acetamiprid, avermectin, azadirachtin, azinphos-methyl, bifenthrin, binfenazate, buprofezin, carbofuran, chlorfenapyr, chlorfluazuron, chlorpyrifos, chlorpyrifos-methyl chromafenozide, clothianidin, cyfluthrin, beta-cyfluthrin, cyhalothrin , lambda-cyhalothrin, cypermethrin cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, oxamyl, parathion, parathion-methyl, permethrin, phorate, phosalone, phosmet, phosphamidon, pirimicarb, profenofos, pymetrozine, pyridalyl, pyriproxyfen, rotenone, spinosad, sulprofos, tebufenozide, teflubenzuron, tefluthrin terbufos, tetrachlorvinphos, thiacloprid, thiamethoxam, thiodicarb, thiosultap-sodium, tralomethrin, trichlorfon and triflumuron, aldicarb, oxamyl, fenamiphos, amitraz, chinomethionat, chlorobenzilate, cyhexatin, dicofol, dienochlor, etoxazole, fenazaquin fenbutatin oxide, fenpropathrin, fenpyroximate, hexythiazox, propargite, pyridaben, tebufenpyrad; Bacillus thuringiensis i, Bacillus thuringiensis delta endotoxin, baculovirus, and entomopathogenic bacteria, virus and fungi.

19. The composition of claim 18 wherein at least one additional biologically active compound or agent is selected from insecticide, nematocide, acaricide or biological agents in the group consisting of cypermethrin, cyhalothrin, cyfluthrin and beta-cyfluthrin, esfenvalerate, fenvalerate, tralomethrin, fenothicarb, methomyl, oxamyl, thiodicarb, clothianidin, imidacloprid, thiacloprid, indoxacarb, spinosad, abamectin, avermectin, emamectin, endosulfan, ethiprole, fipronil, flufenoxuron, triflumuron, diofenolan, pyriproxyfen, pymetrozine, amitraz, Bacillus thuringiensis, Bacillus thuringiensis delta endotoxin and entomophagous fungi.

20. A method for controlling an invertebrate pest comprising contacting the invertebrate pest or its environment with a biologically effective amount of a compound of claim 1 or a composition of claim 17.
